(19) United States
(12) Patent Application Publication
(10) Pub. No.: US 2011/0238495 A1
(43) Pub. Date: Sep. 29, 2011

(54) KEYWORD-ADVERTISEMENT METHOD USING META-INFORMATION RELATED TO DIGITAL CONTENTS AND SYSTEM THEREOF

(76) Inventor: Min Soo Kang, Seoul (KR)

(21) Appl. No.: 12/933,529

(22) PCT Filed: Mar. 24, 2009
(86) PCT No.: PCT/KR2009/001480

§ 371 Date: Apr. 27, 2011

(30) Foreign Application Priority Data
Mar. 24, 2008 (KR) 10-2008-0027086
Mar. 25, 2008 (KR) 10-2008-0027531
Apr. 18, 2008 (KR) 10-2008-0036397
Jun. 10, 2008 (KR) 10-2008-0054104
Jul. 16, 2008 (KR) 10-2008-0069293
Feb. 13, 2009 (KR) 10-2009-0012082

(51) Int. Cl. G06Q 30/00

(52) U.S. Cl. 705/14.49

(57) ABSTRACT

This invention relates to a keyword-advertisement method using meta-information related to digital contents such as multimedia contents and a system thereof. The present invention discloses a method and a system for executing a keyword-advertisement by using meta-information such as tags included in multimedia contents such as a moving picture, an image, a sound and so on. According to the invention, producers, providers, and distributors of multimedia contents are able to make a profit from an advertisement through a service for multimedia contents including keyword-advertisement contents. A user is able to use the multimedia contents free of charge or at a low cost. In addition, convenient web-surfing to correspondent contents is enabled for a user through informative keyword-advertisement contents related to the currently-used multimedia contents and allows the user to acquire additional information. An advertiser enables a targeted advertisement for the users who listen to or watch the multimedia contents so that the advertiser may induce more traffic to the target website/webpage or other target advertisement contents. This invention can be utilized in a wired/wireless online advertisement industry, a multimedia contents industry, an information communication service industry, a visual industry such as a film, image, or music industry and so on.

### TECHNICAL FIELD

The present invention relates to a method and a system for a keyword advertisement by using meta information related to a digital content. More particularly, the present invention relates to an advertisement method using meta information related to a digital content including a multimedia content, etc., and an advertisement system for the advertisement method.

### BACKGROUND ART

According to the advent of the age of web 2.0, internet traffic with respect to UCC (User Created Contents) directly generated by a user, PCC (Professional Created contents) moving pictures, pictures, or the like has explosively increased. Especially, www.youtube.com is famous worldwide for the sharing of the UCC, and every country has multiple internet sites allowing the user to search for and watch the UCC. Further, photograph sites, such as www.flickr.com, enable the user to search for a picture or image and view the searched images.

The search for a multimedia content including a moving picture, a picture, or an image in multimedia content sites, such as www.youtube.com or www.flickr.com, sharing a moving picture, a picture, an image is basically based on text. Typically, multimedia content generators use various means so as to expose their multimedia contents to multiple people. The representative means includes giving a title, attaching at least one tag, or attaching an explanation to a multimedia content of a multimedia content generator, or selecting or inputting at least one category of a multimedia content of a multimedia content generator. With regard to this, the title, the tag, the explanation, or the category has a text type and the text can be stored as an index through an indexing or stored as it is in a DB without an indexing. At this time, when a search word has been obtained from the user, the multimedia content site inquires of the index or the DB about the search word and a search engine or the DBMS outputs a multimedia content corresponding to the search word as a search result. With regard to this, when the server of the multimedia content site obtains selection information on a specific multimedia content from the user computer, the server transmits the selected multimedia content to the user computer. That is, in a case of a moving picture, the server of the multimedia content site transmits the moving picture to the user computer in a streaming scheme or a file transmission scheme. Further, in a case of a picture or an image, the server of the multimedia content site transmits a normal size of a picture or image to the user computer.

In the meantime, the multimedia contents, such as a moving picture, a picture, or an image, has a larger file size than the text-type contents, so that a very large storage capacity and network bandwidth are required so as to smoothly provide the service. The high-capacity computer power and bandwidth result in the excessive service maintenance expense. Further, the multimedia content service sites have attempted to gain advertisement sale profits through inserting an image advertisement, which is not related to the moving picture, but the advertisement sale profits of the multimedia content service sites is far lower than the site maintenance expense.

FIGS. 1, 3, and 5 illustrate how information of a moving picture, a picture, etc. is provided in www.youtube.com, www.youtube.co.kr, and www.flickr.com.

As can be seen in FIGS. 1, 3, and 5, these sites provide meta information, such as title information, tag information, explanation information, category information, etc. of the multimedia content, but do not provide an advertisement content based on the meta information.

In the meantime, the keyword advertisement content services of www.google.com or www.overture.com have currently taken a position as the most leading profit mode on internet. The keyword advertisement content services also refers to a search advertisement service, in which when a search word inputted by the user corresponds to or is highly related to a corresponding advertisement keyword of an advertiser, the service provides the advertisement of the advertiser together with a search result, and when the user clicks the advertisement content, a predetermined advertising fee is charged to the advertiser. At this time, the search word inputted by the user corresponds to the advertisement keyword of the advertiser so that the advertising effect is great, thereby gaining popularity.

In this respect, the present invention provides an advertisement method and an advertisement system, which combines text information with a keyword advertisement by using the text information, such as meta information, capable of being included in or obtained from the multimedia content stored in the multimedia content service sites, so that it is possible to improve the profits of the multimedia content service sites.

In the meantime, an existing content syndication causes a severe trouble between a content producer aiming at the gains from the content itself and a user desiring to freely use the content. A representative example of such a trouble is the rise and fall of www.napster.com. Though the service of www.itunes.com of Apple, Inc. was a success, the number of users who pay to use this service is immensely small in proportion to a quantity of contents existing in the world and is nothing but a greatly basic field in the content syndication. Therefore, an introduction of a win-win model of the content syndication, which can accommodate the demands of the free users and simultaneously create gains for the content producers, content circulators, and content distributors, has been keenly demanded.

### DISCLOSURE

### Technical Problem

Accordingly, the present invention has been made to solve the above-mentioned problems occurring in the prior art.

First, an object of the present invention is to provide a method and a system for providing a keyword advertisement service based on meta information included in multimedia content information by a multimedia content providing system in a disintermediation model scheme.

Second, another object of the present invention is to provide a method and a system for providing a keyword advertisement service based on meta information included in multimedia content information by a meta information-based keyword advertisement intermediation system in an intermediation model scheme.

Third, another object of the present invention is to provide a method and a system for providing a keyword advertisement service based on meta information included in multimedia content information by a keyword advertisement content providing system.

Fourth, another object of the present invention is to provide a method and a system for providing a keyword advertisement service based on meta information included in multimedia content information by a keyword advertisement content providing system.

Fifth, another object of the present invention is to provide a method and a system for providing a keyword advertisement service based on meta information included in multimedia content information based on a user installed computer program, and a method and a system for providing a keyword advertisement service based on meta information included in multimedia content information based on a recording medium recording a user installed computer program.

Sixth, another object of the present invention is to provide a method and a system for providing a keyword advertisement service based on meta information included in multimedia content information by a multimedia content providing system in a combination model scheme.

Seventh, another object of the present invention is to provide a method for generating, managing, and transmitting various kinds of commercial tags, such as a time dependent commercial tag or a real-time commercial tag, or a method for utilizing the commercial tags in the keyword advertisement by a commercial tag set generation system.

Eighth, another object of the present invention is to provide a method and a system for providing a keyword advertisement service based on meta information by using a commercial tag set generation system.

Ninth, another object of the present invention is to provide an advertisement method in a real-time multimedia service system, a broadcasting service system, a content syndication system, a media service system, an electronic book system, a document program for processing a document, such as a pdf file, and programs for the aforementioned systems by using a commercial tag.

Tenth, another object of the present invention is to provide a content syndication method and system using a commercial tag in a content producer system, a content circulator system, a content distributor system, and a user computer.

Eleventh, another object of the present invention is to provide a method and a system for providing a keyword advertisement service, which manages various user's actions, such as storage, reservation, and click, with respect to a commercial tag and a keyword advertisement called by a commercial tag during where the users view a multimedia content including a moving picture, etc. through a user computer including a bidirectional digital TV, such as the IPTV.

Twelfth, another object of the present invention is to provide a method and a system for providing a keyword advertisement service, which manages various users' actions, such as storage, reservation, and click, with respect to a commercial tag and a keyword advertisement called by a commercial tag in a media service system.

Thirteenth, another object of the present invention is to provide a method and a system for providing a keyword advertisement by using a commercial tag in a digital publication service system, such as a document (e.g. pdf file) program, a document publication service system, an electronic book system, an article publication service system, a news publication service system.

Fourteenth, another object of the present invention is to provide a method and a system for providing a keyword advertisement by using a commercial tag in a broadcasting service system providing a broadcasting content service or a real-time multimedia content service system.

### Technical Solution

In accordance with an aspect of the present invention, there is provided a method for providing a keyword advertisement service based on meta information included in multimedia content information by a multimedia content service system, which includes a multimedia content service server transmitting moving picture information of a moving picture selected by a user to a user computer, the method including: obtaining selection information of a moving picture to be transmitted to the user computer from the user computer; obtaining text type meta information of the selected moving picture; transmitting a keyword advertisement target text generated based on the meta information to a keyword advertisement content providing server; receiving at least one keyword advertisement content from the keyword advertisement content providing server; and transmitting the moving picture information and the keyword advertisement content to the user computer, in which the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the keyword advertisement target text transmitted from the multimedia content service system from the keyword advertisement content DB and transmits the obtained keyword advertisement content to the multimedia content service server.

In accordance with another aspect of the present invention, there is provided a multimedia content service system providing a keyword advertisement service based on meta information included in multimedia content information, the multimedia content service system including a multimedia content service server transmitting moving picture information of a moving picture selected by a user to a user computer, the multimedia content service system including: a multimedia content DB including at least one moving picture content; a multimedia content transmission module for transmitting a selected moving picture content when selection information of a moving picture content is received from the user computer; a meta information obtainment module for obtaining meta information of the selected moving picture; a keyword advertisement target text generation module for generating at least one keyword advertisement target text based on the meta information obtained from the meta information obtainment module; a keyword advertisement content obtainment module for obtaining at least one keyword advertisement content corresponding to a keyword advertisement target text generated by the keyword advertisement target text generation module from a keyword advertisement content providing server; and a keyword advertisement display module for displaying a keyword advertisement content obtained by the keyword advertisement content obtainment module on a preset location, which is discriminated from a moving picture area reproducing and displaying the moving picture, in which the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to a keyword advertisement target text transmitted from the keyword advertisement content DB and transmits the obtained keyword advertisement content to the multimedia content service server.

In accordance with another aspect of the present invention, there is provided a method for providing a keyword advertisement service based on meta information included in multimedia content information by a multimedia content service system, the multimedia content service system including a multimedia content service server transmitting moving picture information of a moving picture selected by a user to a user computer, the method including: obtaining selection information of a moving picture to be transmitted to the user computer from the user computer; obtaining text type meta information of the selected moving picture; transmitting the obtained meta information to a meta information-based keyword advertisement intermediation system; receiving at least one keyword advertisement content; and transmitting the moving picture information and the keyword advertisement content to the user computer, in which the meta information-based keyword advertisement intermediation system includes a meta information-based keyword advertisement intermediation server, and the meta information-based keyword advertisement intermediation server includes a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generation module to a keyword advertisement content generation server and obtaining at least one keyword advertisement content from the keyword advertisement content providing server, and a keyword advertisement content transmission module for transmitting the obtained keyword advertisement content to the multimedia content service system, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to a keyword advertisement target text received from the meta information-based keyword advertisement intermediation server from the keyword advertisement content DB and transmits the obtained keyword advertisement content to the meta information-based keyword advertisement intermediation server.

In accordance with another aspect of the present invention, there is provided a method for providing a keyword advertisement service based on meta information included in multimedia content information by a multimedia content service system, the multimedia content service system including a multimedia content service server transmitting moving picture information of a moving picture selected by a user to a user computer, the method including: obtaining selection information of a moving picture to be transmitted to the user computer from the user computer; obtaining text type meta information of the selected moving picture; transmitting the obtained meta information to a meta information-based keyword advertisement intermediation system; receiving at least one keyword advertisement content from a keyword advertisement content providing server; and transmitting the moving picture information and the keyword advertisement content to the user computer, in which the meta information-based keyword advertisement intermediation system includes a meta information-based keyword advertisement intermediation server, wherein the meta information-based keyword advertisement intermediation server includes a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generation module to a keyword advertisement content generation server and obtaining at least one keyword advertisement content from the keyword advertisement content providing server, and a keyword advertisement content transmission module for transmitting the obtained keyword advertisement content to the multimedia content service system, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server receives keyword advertisement target text from the meta information-based keyword advertisement intermediation server and information on the multimedia content service system including the keyword advertisement target text, obtains at least one keyword advertisement content corresponding to the received keyword advertisement target text from the keyword advertisement content DB and transmits the obtained keyword advertisement content to the multimedia content service system or the user computer.

In accordance with another aspect of the present invention, there is provided a multimedia content service system providing a keyword advertisement service based on meta information included in multimedia content information, the multimedia content service system including a multimedia content service server transmitting moving picture information of a moving picture selected by a user to a user computer, the system including: a multimedia content DB including at least one moving picture content; a multimedia content transmission module for, transmitting a selected moving picture content when selection information of a moving picture content is received from the user computer; a meta information obtainment module for obtaining meta information of the selected moving picture; a meta information transmission module for transmitting the obtained meta information to a meta information based keyword advertisement intermediation system; a keyword advertisement content reception module for receiving at least one keyword advertisement content related to the meta information from the meta information based keyword advertisement intermediation system; and a keyword advertisement display module for displaying a keyword advertisement content received by the keyword advertisement content reception module on a preset location, which is discriminated from a moving picture area reproducing and displaying the moving picture, in which the meta information-based keyword advertisement intermediation system includes a meta information-based keyword advertisement intermediation server, and the meta information-based keyword advertisement intermediation server includes a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generated by the keyword advertisement target text generation module to a keyword advertisement content providing server and obtaining at least one keyword advertisement content from the keyword advertisement content providing server, and a keyword advertisement content transmission module for transmitting the obtained keyword advertisement content to the multimedia content service system, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the meta information-based keyword advertisement intermediation server.

In accordance with another aspect of the present invention, there is provided a multimedia content service system providing a keyword advertisement service based on meta information included in multimedia content information, the multimedia content service system including a multimedia content service server transmitting moving picture information of a moving picture selected by a user to a user computer, the system including: a multimedia content DB including at least one moving picture content; a multimedia content transmission module for transmitting a selected moving picture content when selection information of a moving picture content is received from the user computer; a meta information obtainment module for obtaining meta information of the selected moving picture; a meta information transmission module for transmitting the obtained meta information to a meta information based keyword advertisement intermediation system; a keyword advertisement content reception module for receiving at least one keyword advertisement content related to the meta information transferred to the meta information based keyword advertisement intermediation system from a keyword advertisement content providing server; and a keyword advertisement display module for displaying a keyword advertisement content received by the keyword advertisement content reception module on a preset location, which is discriminated from a moving picture area reproducing and displaying the moving picture, in which the meta information-based keyword advertisement intermediation system includes a meta information-based keyword advertisement intermediation server, and the meta information-based keyword advertisement intermediation server includes a meta information reception module for receiving the meta information, a keyword advertisement target text generation module for generating a keyword advertisement target text by using the meta information obtained by the meta information reception module, a keyword advertisement content providing server-side text obtainment module for transmitting a keyword advertisement target text generated by the keyword advertisement target text generation module to a keyword advertisement content providing server and receiving a text from the keyword advertisement content providing server, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the multimedia content service system.

In accordance with another aspect of the present invention, there is provided a method for providing a keyword advertisement service based on meta information included in multimedia content information by a meta information-based keyword advertisement intermediation system, which receives meta information from a multimedia content service system including a multimedia content service server transmitting moving picture information of a moving picture selected by a user to a user computer, the method including: obtaining text type meta information from the multimedia content service system; transmitting a keyword advertisement target text generated based on the obtained meta information to a keyword advertisement content providing server; receiving at least one keyword advertisement content from the keyword advertisement content providing server; and transmitting the received keyword advertisement content to the multimedia content service system, in which the meta information-based keyword advertisement intermediation system includes a meta information-based keyword advertisement intermediation server, and the meta information-based keyword advertisement intermediation server includes a meta information reception module for receiving the meta information, a keyword advertisement target text transmission module for transmitting a keyword advertisement target text generated based on the meta information to a keyword advertisement content providing server, a keyword advertisement content obtainment module for obtaining at least one keyword advertisement content from the keyword advertisement content providing server, a keyword advertisement content transmission module for transmitting the obtained keyword advertisement content to the multimedia content service system, the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the meta information-based keyword advertisement intermediation server, and the multimedia content service system transmits the moving picture information and the received keyword advertisement content to the user computer.

In accordance with another aspect of the present invention, there is provided a method for providing a keyword advertisement service based on meta information included in multimedia content information by a meta information-based keyword advertisement intermediation system, which receives meta information from a multimedia content service system including a multimedia content service server transmitting moving picture information of a moving picture selected by a user to a user computer, the method including: obtaining text type meta information from the multimedia content service system; transmitting a keyword advertisement target text generated based on the obtained meta information to a keyword advertisement content providing server; and receiving click generation information of the keyword advertisement content from the multimedia content service system, in which the meta information-based keyword advertisement intermediation system includes a meta information-based keyword advertisement intermediation server, and the meta information-based keyword advertisement intermediation server includes a meta information reception module for receiving the meta information, a keyword advertisement target text generation module for generating a keyword advertisement target text by using the meta information obtained by the meta information reception module, and a keyword advertisement target text transmission module for transmitting a keyword advertisement target text generated by the keyword advertisement target text generation module to a keyword advertisement content providing server, the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the multimedia content service system, and the multimedia content service system receives at least one keyword advertisement content from the keyword advertisement content providing server and transmits the moving picture and the obtained keyword advertisement content to the user computer.

In accordance with another aspect of the present invention, there is provided a meta information-based keyword advertisement intermediation system providing a keyword advertisement service based on meta information included in multimedia content information, the meta information-based keyword advertisement intermediation system receiving meta information from a multimedia content service system including a multimedia content service server transmitting moving picture information of a moving picture selected by a user to a user computer, receiving at least one keyword advertisement content corresponding to the received meta information from a keyword advertisement content providing server, and transmitting the received keyword advertisement content to the multimedia content service system, the meta information-based keyword advertisement intermediation system including: a meta information reception module for obtaining text type meta information from the multimedia content service system; a keyword advertisement target text generation module for generating at least one keyword advertisement target text by using the received meta information; a keyword advertisement target text transmission module for transmitting a keyword advertisement target text generated by the keyword advertisement target text generation module to the keyword advertisement content providing server; a keyword advertisement content obtainment module for obtaining at least one keyword advertisement content corresponding to the keyword advertisement target text from the keyword advertisement content providing server; and a keyword advertisement content transmission module for transmitting the obtained keyword advertisement content to the multimedia content service system, in which the meta information-based keyword advertisement intermediation system includes a meta information-based keyword advertisement intermediation server, and the meta information-based keyword advertisement intermediation server includes a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generation module to a keyword advertisement content providing server and obtaining at least one keyword advertisement content from the keyword advertisement content providing server, a keyword advertisement content transmission module for transmitting the obtained keyword advertisement content to the multimedia content service system, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, the keyword advertisement content providing server obtains at least one keyword advertisement content corresponding to the keyword advertisement target text received from the meta information-based keyword advertisement intermediation server from the keyword advertisement content DB and transmits the obtained keyword advertisement content to the meta information-based keyword advertisement intermediation server, and the multimedia content service system transmits the moving picture information and the keyword advertisement content to the user computer.

In accordance with another aspect of the present invention, there is provided a method for providing a keyword advertisement service based on meta information included in multimedia content information by a multimedia content service system, the multimedia content service system including a multimedia content service server transmitting moving picture information of a moving picture selected by a user to a user computer, the method including: obtaining selection information of a moving picture to be transmitted to the user computer from the user computer; obtaining text type meta information of the selected moving picture; transmitting the obtained meta information to a keyword advertisement content providing system; receiving at least one keyword advertisement content from the keyword advertisement content providing system; and transmitting the moving picture information and the keyword advertisement content to the user computer, in which the keyword advertisement content providing system includes a meta information-based keyword advertisement providing server and a keyword advertisement content providing server, and the meta information-based keyword advertisement providing server includes a meta information reception module and a keyword advertisement control module, the meta information reception module obtains meta information from the multimedia content service system, the keyword advertisement control module generates a keyword advertisement target text by using the meta information, and the meta information-based keyword advertisement providing server generates at least one keyword advertisement target text by using the meta information obtained from the multimedia content service system and transmits the generated keyword advertisement target text to the keyword advertisement content providing server, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the received keyword advertisement target text from the keyword advertisement content DB, and the keyword advertisement content providing system transmits the obtained keyword advertisement content to the multimedia content service server.

In accordance with another aspect of the present invention, there is provided a system providing a keyword advertisement service based on meta information included in multimedia content information, including a multimedia content DB including at least one moving picture content; a multimedia content transmission module for, when selection information of a moving picture content is received from the user computer, transmitting the selected moving picture content; a meta information obtainment module for obtaining meta information of the selected moving picture; a meta information transmission module for transmitting the obtained meta information to a keyword advertisement content providing system; a keyword advertisement content reception module for receiving at least one keyword advertisement content from the keyword advertisement content providing system; and a keyword advertisement display module for displaying the keyword advertisement content received by the keyword advertisement content reception module on a preset location, which is discriminated from a moving picture area reproducing and displaying the moving picture, in which the keyword advertisement content providing system includes a meta information-based keyword advertisement providing server and a keyword advertisement content providing server, the meta information-based keyword advertisement providing server includes a meta information reception module and a keyword advertisement control module, the meta information reception module obtains meta information from the multimedia content service system, and the keyword advertisement control module generates a keyword advertisement target text by using the meta information, and the meta information-based keyword advertisement providing server generates at least one keyword advertisement target text by using the meta information obtained from the multimedia content service system and transmits the generated keyword advertisement target text to the keyword advertisement content providing server, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the received text from the keyword advertisement content DB, and the keyword advertisement content providing system transmits the obtained keyword advertisement content to the multimedia content service server.

In accordance with another aspect of the present invention, there is provided a method for providing a keyword advertisement service based on meta information included in multimedia content information by a keyword advertisement content providing system, which receives meta information included in moving picture information from at least one outside server and provides at least one keyword advertisement content based on the meta information, the method including: obtaining text type meta information from the outside server; transmitting a keyword advertisement target text generated based on the obtained meta information to a keyword advertisement content providing server; receiving at least one keyword advertisement content from the keyword advertisement content providing server; and transmitting the received keyword advertisement content to the outside server or to a user computer reproducing the moving picture, in which the outside server includes the multimedia content service system, which includes a multimedia content service server transmitting moving picture information of a moving picture selected by the user to the user computer, or a third server, which receives meta information included in moving picture information from the multimedia content service system and transmits the received meta information to the keyword advertisement content providing system, the keyword advertisement content providing system includes a meta information-based keyword advertisement providing server and the keyword advertisement content providing server, the meta information-based keyword advertisement providing server generates at least one keyword advertisement target text by using the meta information obtained from the outside server and transmits the generated keyword advertisement target text to the keyword advertisement content providing server, the keyword advertisement content providing system obtains at least one keyword advertisement content corresponding to the received keyword advertisement target text and directly transmits the keyword advertisement content to the multimedia content service system or transmits the keyword advertisement content to the multimedia content service system via the third server or a preset server, the keyword advertisement content providing server includes a keyword advertisement content providing server-side text obtainment module for receiving a text, a keyword advertisement content DB including at least one advertisement content, and a keyword advertisement content transmission module for transmitting the keyword advertisement content to an outside server of the keyword advertisement content transmission module, and obtains at least one keyword advertisement content corresponding to the received keyword advertisement target text from the keyword advertisement content DB, the keyword advertisement content providing system transmits the obtained keyword advertisement content to the outside server, and the user computer obtains moving picture information from the outside server.

In accordance with another aspect of the present invention, there is provided a keyword advertisement content providing system providing a keyword advertisement service based on meta information included in multimedia content information, the keyword advertisement content providing system receiving meta information included in moving picture information from at least one outside server and providing at least one keyword advertisement content based on the meta information, the keyword advertisement content providing system including: a meta information-based keyword advertisement providing server for obtaining meta information from the outside server and providing a keyword advertisement based on the meta information; and a keyword advertisement content providing server for obtaining at least one keyword advertisement content based on the meta information, the keyword advertisement content providing system receives meta information related to the moving picture from the outside server, obtains at least one keyword advertisement content corresponding to the received meta information, and transmits the keyword advertisement content to the outside server or a user computer reproducing the moving picture in a direct manner or via the third server or a preset server, and the meta information-based keyword advertisement providing server includes: a meta information reception module for receiving text type meta information from the outside server; a keyword advertisement target text generation module for generating at least one keyword advertisement target text by using the received meta information; a keyword advertisement content obtainment module for obtaining at least one keyword advertisement content corresponding to the keyword advertisement target text; and a keyword advertisement content transmission module for transmitting the obtained keyword advertisement content to the outside server, in which the outside server includes the multimedia content service system including a multimedia content service server transmitting moving picture information of a moving picture selected by the user to the user computer or a third server receiving meta information included in moving picture information from the multimedia content service system and transmitting the received meta information to the keyword advertisement content providing system, the keyword advertisement content providing system includes the meta information-based keyword advertisement providing server and the keyword advertisement content providing server, the meta information-based keyword advertisement providing server generates at least one keyword advertisement target text by using the meta information obtained from the outside server and transmits the generated keyword advertisement target text to the keyword advertisement content providing server, the keyword advertisement content providing server includes a text obtainment module for receiving a keyword advertisement target text and a keyword advertisement content DB including at least one advertisement content, obtains at least one keyword advertisement content corresponding to the keyword advertisement target text from the keyword advertisement content DB, the keyword advertisement content providing system transmits the obtained keyword advertisement content to the outside server, and the user computer obtains moving picture information from the outside server.

In accordance with another aspect of the present invention, there is provided a method for providing a keyword advertisement service based on meta information included in multimedia content information by a computer program recorded in a recording medium, the computer program being capable of providing a user computer with a keyword advertisement content based on moving picture information transmitted from a user computer, the method including: obtaining text type meta information corresponding to the moving picture from web-page information including moving picture information transmitted to the user computer from a multimedia content service system; transmitting a keyword advertisement target text generated using the obtained meta information to a keyword advertisement content providing server; receiving at least one keyword advertisement content from the keyword advertisement content providing server; and displaying the received keyword advertisement content before or after a reproduction of the moving picture on the user computer during a reproduction of the moving picture, in which the computer program includes a meta information obtainment module for obtaining meta information from the moving picture information, a keyword advertisement target text generation module for generating the keyword advertisement target text by using the meta information, a keyword advertisement content obtainment module for obtaining a keyword advertisement content from the keyword advertisement content providing server, and a keyword advertisement display module for displaying a keyword advertisement content obtained by the keyword advertisement content obtainment module on a preset location, which is discriminated from a moving picture area reproducing and displaying the moving picture, the keyword advertisement display module includes a keyword advertisement insertion module for inserting the keyword advertisement content to the received web page information, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and obtains at least one keyword advertisement content corresponding to the received keyword advertisement target text from the keyword advertisement content DB, and transmits the obtained keyword advertisement content to the multimedia content service server.

In accordance with another aspect of the present invention, there is provided a recording medium recording a computer program, which provides a user computer with a keyword advertisement content based on moving picture information transmitted from the user computer, so as to provide a keyword advertisement service based on meta information included in multimedia content information, the recording medium including: a web page information analysis module for analyzing web page information including moving picture information transmitted to the user computer; a meta information obtainment module for obtaining meta information of the moving picture from the web page information analysis module; a keyword advertisement target text generation module for generating at least one keyword advertisement target text by using the meta information obtained from the meta information obtainment module; a keyword advertisement content obtainment module for obtaining at least one keyword advertisement content corresponding to a keyword advertisement target text generated by the keyword advertisement target text generation module from a keyword advertisement content providing server; and a keyword advertisement display module for displaying a keyword advertisement content obtained by the keyword advertisement content obtainment module on a preset location, which is discriminated from a moving picture area reproducing and displaying the moving picture; in which the keyword advertisement display module further includes a keyword advertisement insertion module for inserting the keyword advertisement content to a preset location of the web page, the web page information analysis module analyzes a web page including the received moving picture information and extracting meta information from the moving picture information, the keyword advertisement insertion module binds the obtained keyword advertisement content with the web page transmitted to the user computer, corrects the web page so as to arrange the keyword advertisement content on a preset location and generates a corrected web page, and displays the corrected web page on the user computer, and the keyword advertisement content providing server includes a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and obtains at least one keyword advertisement content corresponding to the received keyword advertisement target text from the keyword advertisement content DB and transmits the obtained keyword advertisement content to the multimedia content service server.

In accordance with another aspect of the present invention, there is provided a method for generating a commercial tag set for a moving picture by a commercial tag set generation system which generates at least one commercial tag set for a moving picture, the method including: (a) obtaining information of the moving picture; (b) receiving at least one commercial tag candidate corresponding to the moving picture; (c) inquiring if a keyword advertisement content corresponding to the commercial tag candidate can be provided; (d) generating a commercial tag set including at least one commercial tag selected among the commercial tag candidates corresponding to the transmittable keyword advertisement content; and (e) corresponding the commercial tag set to the moving picture information and storing the inputted commercial tag set.

In accordance with another aspect of the present invention, there is provided a keyword advertisement method using a commercial tag set by a multimedia content service system including a multimedia content service server transmitting moving picture information selected by a user, the keyword advertisement method including: transmitting moving picture information to a commercial tag set generation system; obtaining a commercial tag set corresponding to the moving picture information from the commercial tag set generation system; corresponding the commercial tag set to the moving picture and storing the commercial tag set; receiving selection information of a moving picture to be transmitted to the user computer from the user computer; receiving a keyword advertisement content corresponding to at least one commercial tag included in the commercial tag set related to the moving picture corresponding to the received selection information; and transmitting the moving picture and the keyword advertisement content to the user computer.

The meta information is obtained from at least one of title information, tag information, and explanation information of the moving picture included in the moving picture information.

The tag information is commercial tag information.

The tag information includes time dependent commercial tag information including time zone information.

The meta information is determined by a meta information selection policy of a keyword advertisement control policy DB, and the keyword advertisement control policy DB includes a keyword advertisement control policy, and the keyword advertisement control policy includes information of a selection reference of meta information.

The selection reference of the meta information includes at least one of (a) when tag information is included in obtained meta information, first selecting the tag information, (b) when tag information is included in obtained meta information, selecting both the tag information and title information, (c) when tag information is not included in obtained meta information, selecting title information, and (d) when tag information is not included in obtained meta information, selecting both title information and explanation information.

Commercial tag information is included in the tag information, the commercial tag information is selected as meta information.

The method of generating at least one keyword advertisement target text by using the selected meta information includes at least one of, when the meta information is title information, (a) a method of generating a word included in an advertisement keyword DB among words of the title information, as a keyword advertisement target text, (b) a method of natural language processing and analyzing a word included in the title information, extracting at least one name, and generating an extracted name as a keyword advertisement target text, and (c) a method of generating only names corresponding to words included in the advertisement keyword DB among the names extracted by the method (b), as a keyword advertisement target text, when the meta information is tag information, (a) a method of generating a tag included in an advertisement keyword DB among at least one tag included in the tag information as a keyword advertisement target text, (b) a method of generating all tags included in the tag information as keyword advertisement target texts, (c) when the tag information includes multiple tags, a method of generating only a tag within a preset rank as a keyword advertisement target text, and (d) when the tag information includes multiple tags, a method of randomly selecting a tag from the multiple tags, and when the meta information is explanation information, (a) a method of generating a word included in an advertisement keyword DB among words included in the explanation information as a keyword advertisement target text, (b) a method of natural language processing and analyzing words included in the explanation information, extracting at least one name, and generating an extracted name as a keyword advertisement target text, (c) a method of generating a name corresponding to a word included in the advertisement keyword DB among the names extracted by the method of (b) as a keyword advertisement target text, and (d) a method of calculating a frequency of the names extracted by the (b) method and generating only a name within a preset rank based on an order of a maximal frequency as a keyword advertisement target text, and the advertisement keyword DB is a DB compiling keywords used for an advertisement serving as a target of the keyword advertisement, and the name consists of at least one word and includes at least one attribute among a product name, a service name, a list of advertisement keywords received from the keyword advertisement content providing server, a list of advertisement keyword obtained from a third person, a self-generated advertisement keyword list, a list of keyword advertisement target text generating an advertising profit, a company name, a domain name, a noun, a slogan, and a brand.

The generation of at least one keyword advertisement target text by using the selected meta information includes the steps of a first step of generating a keyword advertisement target text candidate and a second step of inquiring of the keyword advertisement content providing server or an advertisement keyword DB about the generated keyword advertisement target text candidate, referring to an inquiry result, and generating a keyword advertisement target text only with the keyword advertisement target text candidate satisfying a preset reference.

The first step of generating the keyword advertisement target text candidate includes at least one of, when the meta information is title information, (a) a method of generating a word included in an advertisement keyword DB among words of the title information, as a keyword advertisement target text candidate, (b) a method of natural language processing and analyzing words included in the title information, extracting at least one name, and generating an extracted name as a keyword advertisement target text candidate, and (c) a method of generating only a name corresponding to words included in the advertisement keyword DB among the names extracted by the method (b) as a keyword advertisement target text, when the meta information is tag information, (a) a method of generating a tag included in an advertisement keyword DB among at least one tag included in the tag information as a keyword advertisement target text candidate, (b) a method of generating all tags included in the tag information as keyword advertisement target text candidates, (c) when the tag information includes multiple tags, a method of generating only a tag within a preset rank as a keyword advertisement target text candidate, and (d) when the tag information includes multiple tags, a method of randomly selecting a tag from the multiple tags, and when the meta information is explanation information, (a) a method of generating a word included in an advertisement keyword DB among words included in the explanation information as a keyword advertisement target text candidate, (b) a method of natural language processing and analyzing words included in the explanation information, extracting at least one name, and generating an extracted name as a keyword advertisement target text candidate, (c) a method of generating a name corresponding to a word included in the advertisement keyword DB among the names extracted by the method of (b) as a keyword advertisement target text candidate, and (d) a method of calculating a frequency of the name extracted by the (b) method and generating only a name within a preset rank based on an order of a maximal frequency as a keyword advertisement target text candidate, and the advertisement keyword DB is a DB compiling keywords used for an advertisement serving as a target of the keyword advertisement, and the name consists of at least one word and includes at least one attribute among a product name, a service name, a company name, a domain name, a noun, a slogan, and a brand.

Generating of at least one keyword advertisement target text with the selected meta information further includes a third step of identifying of whether the inquiry result of the keyword advertisement content providing server conforms to a policy of the keyword advertisement control policy DB, wherein the identifying of whether the inquiry result conforms to a policy of the keyword advertisement control policy DB is to obtain at least one of (a) information on whether a keyword advertisement content corresponding to the keyword advertisement target text candidate is included in the keyword advertisement content providing server, (b) information on a maximum number of transmittable keyword advertisement contents, (c) information on an advertisement unit price of at least one keyword advertisement content within a preset or higher rank, and (d) information on an expected click rate in comparison with an exposure of at least one keyword advertisement content, and refer to a policy reference of the keyword advertisement control policy DB corresponding to any one of information (a), (b), (c), and (d) obtained from the keyword advertisement content providing server, the keyword advertisement control policy DB includes a keyword advertisement control policy and the keyword advertisement control policy includes information on a reference for a keyword advertisement target text generation.

The referring to the inquiry result includes transmitting a keyword advertisement target text corresponding to each of the keyword advertisement target text candidates or a keyword advertisement target text candidate in a preset group unit to the keyword advertisement content providing server and obtaining confirmation information on existence of a keyword advertisement content corresponding to the keyword advertisement target text candidate from the keyword advertisement content providing server.

The transmitting generated keyword advertisement target text to the keyword advertisement content providing server includes at least one of (a) a method of transmitting all of the generated keyword advertisement target texts to the keyword advertisement content providing server and (b) a method of discriminating the generated keyword advertisement target text based on a kind of meta information on which the generated keyword advertisement target text is based and transmitting the keyword advertisement target text based on at least one selected kind of the meta information.

When a number of keyword advertisement target texts are more than one, the transmitting generated keyword advertisement target text to the keyword advertisement content providing server includes at least one of, (a) a method of transmitting the generated multiple keyword advertisement target texts at one time, (b) a method of individually transmitting the generated multiple keyword advertisement target texts one by one, and (c) a method of dividing the multiple keyword advertisement target texts into at least two groups and transmitting the multiple keyword advertisement target texts in a group unit, but in a case where there are multiple numbers of keyword advertisement target texts included in a same group, applying any one between the method (a) and the method (b).

The method further includes granting a management number to the generated keyword advertisement target text, and mapping the generated keyword advertisement target text to a keyword advertisement content received from the keyword advertisement content providing server on a basis of the management number and storing the keyword advertisement content.

The method further includes, when a number of the keyword advertisement target texts are more than one and the keyword advertisement target texts are managed in the unit of at least one group, granting a management number to each of the group and each of the keyword advertisement target texts included in the group, and mapping the keyword advertisement target text included in the group to a keyword advertisement content received from the keyword advertisement content providing server on a basis of the management number and storing the keyword advertisement content.

The method further includes, when a number of the transmitted or received keyword advertisement contents are more than one, selecting at least one keyword advertisement content to be transmitted to the user computer among the keyword advertisement contents on a basis of a specific time.

In the selecting keyword advertisement content, it is selected keyword advertisement contents equal to or less than a preset number, serving as a maximal value, of keyword advertisement contents among the keyword advertisement contents received from the keyword advertisement content providing server.

The selecting the keyword advertisement content is to select the keyword advertisement content according to a kind of meta information on which the keyword advertisement target text is based, and the keyword advertisement content is obtained from the keyword advertisement content providing server through inquiring of the keyword advertisement content providing server about each of the keyword advertisement contents.

In the selecting the keyword advertisement content, when a number of keyword advertisement contents transmitted from the keyword advertisement content providing server are more than one, a number of keyword advertisement contents to be transmitted to the user computer on a basis of a specific time has been set, and a number of keyword advertisement contents is larger than the number of keyword advertisement contents to be transmitted to the user computer on a basis of a specific time, the keyword advertisement contents are divided into at least two groups and the keyword advertisement contents included in the groups are selected based on each group, and a number of keyword advertisement contents included in each of the groups is equal to or less than the number of keyword advertisement contents to be transmitted to the user computer on a basis of the specific time.

The transmitting the moving picture information and the keyword advertisement content to the user computer includes one of (a) a method of discriminating between an area of the reproduced moving picture information and an area of the keyword advertisement content, generating an information unit to be transmitted to the user computer, and synchronizing the area of the reproduced moving picture information and the area of the keyword advertisement content, to transmit the reproduced moving picture information and the keyword advertisement content to the user computer, and (b) a method of discriminating between an area of the reproduced moving picture information and an area of the keyword advertisement content, generating an information unit to be transmitted to the user computer, and asynchronizing the area of the reproduced moving picture information and the area of the keyword advertisement content, to transmit the reproduced moving picture information and the keyword advertisement content to the user computer, respectively.

In the method (b), at least one keyword advertisement content to be transmitted to the area of the keyword advertisement content is varied according to a passage of time.

The time is a preset time range.

The preset time range is determined by at least one variable selected from (a) a number of keyword advertisement contents received from the keyword advertisement content providing server, (b) a number of keyword advertisement contents selected among the keyword advertisement contents received from the keyword advertisement content providing server, (c) a number of keyword advertisement contents to be transmitted to the user computer based on a specific time, and (d) a reproduction time of the moving picture.

The program transmitted to the user computer includes a program measuring a click generation and a time, and the program further includes recording a time of receiving at least one keyword advertisement content, monitoring if a click for the keyword advertisement content is generated by a preset time, and when click generation information of the keyword advertisement content has not been obtained by the preset time, making a request of additional keyword advertisement content to a server that has been transmitted the keyword advertisement content.

The information transmitted to the user computer includes a program, and the program includes a program measuring a click generation and a time, and further includes recording a time of receiving at least one keyword advertisement content, and monitoring if a click for a keyword advertisement content is generated by a preset time, and when click generation information for the specific keyword advertisement content has been obtained by the preset time, the program does not change the keyword advertisement content transmitted to the user computer from the time of receiving the click generation information to a preset second time.

The program further includes, when additional click generation information for the keyword advertisement content transmitted to the user computer has not been obtained by the preset second time, transmitting a preset number of keyword advertisement contents selected from the keyword advertisement contents received from the keyword advertisement content providing server, excluding the keyword advertisement contents which have been transmitted to the user computer, to the user computer.

The information transmitted to the user computer includes a program, and the program includes a program measuring a click generation and a time, and further includes recording a time of receiving at least one keyword advertisement content, and monitoring if a click for a keyword advertisement content is generated by a preset time, and when click generation information for the specific keyword advertisement content has been obtained by the preset time, making a request of a keyword advertisement content related to the keyword advertisement content corresponding to the click generation to a server that has transmitted the keyword advertisement content to the user computer.

The moving picture includes at least one of a real photographed moving picture, a non-real moving picture, an UCC moving picture, a movie, a flash moving picture, a real-time broadcasting, and a recorded broadcasting including text type meta information.

In accordance with another aspect of the present invention, there is provided a method for information processing by a commercial tag set generation system, which generates at least one commercial tag set corresponding to a digital content, so as to provide a keyword advertisement service based on meta information, the method including: (A) obtaining at least one commercial tag candidate for the digital content; (B) obtaining commerciality information of the commercial tag candidate; (C) generating at least one commercial tag set including at least one commercial tag candidate corresponding to received selection information among the commercial tag candidates, for the digital content; and (D) corresponding the obtained commercial tag set to identification information of the digital content and storing the commercial tag set, or transmitting the commercial tag set to a preset system together with the identification information, in which the commercial tag set information is information related to a commercial tag set, and the commercial tag set consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through the keyword advertisement content providing system by using the commercial tag, and the tag includes at least one text string of a product name, a service name, a proper noun, and a keyword registered in the keyword advertisement content providing system by an advertiser, and when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of the advertiser corresponding to a keyword registered by the advertiser.

The preset system subject to receiving the commercial tag set in the (D) includes at least one of a content producer system, a content circulator system, a content distributor system, the keyword advertisement content providing system, the user computer, a preset program executed in the user computer, a multimedia content service system, a broadcasting service system providing the user computer with a broadcasting content, a digital publication service system providing the user computer with a digital publication, a media service system providing the user computer with a media service, and a content syndication system involving distribution or transference of a digital content.

The method includes, after the (B) and prior to the (C), transmitting at least one commercial tag candidate including the commerciality information to a computer of a person desiring to generate a commercial tag set by using a commercial tag set generation system; and receiving selection information of at least one commercial tag candidate from a computer of a person desiring to generate a commercial tag set by using a commercial tag set generation system.

The method further includes additionally receiving at least one of rank information, time information, and condition information applied to at least one commercial tag candidate from a computer of a person desiring to generate a commercial tag set by using a commercial tag set generation system.

In the (C), the commercial tag set is generated through corresponding a commercial tag candidate corresponding to the received selection information to the received rank information, time information, and condition information and storing the commercial tag set.

In the (A) of obtaining at least one commercial tag candidate for the digital content, when a text content is included in the digital content, the text context is analyzed, at least one commercial tag candidate is extracted from the analyzed text context, and the extracted commercial tag candidate is obtained.

The commercial tag set generation system belongs to one of a content producer system of a producer producing the digital content, a content circulator system of a circulator circulating the digital content, a content distributor system for distributing the digital content to a user computer, a digital content service system providing the user computer with a digital content, the keyword advertisement content providing system, a content syndication system for managing transference of the digital content, the user computer, and a preset program executed in the user computer, and the commercial tag set generation system is independent of the content producer system, the content circulator system, the content distributor system, the digital content service system, the keyword advertisement content providing system, the content syndication system, the user computer, and the preset program executed in the user computer, and is wired/wirelessly connected with them, and the digital content service system includes at least one of a multimedia content service system providing the user computer with a multimedia content, a broadcasting service system providing the user computer with a broadcasting content, a digital publication service system providing the user computer with a digital publication, and a media service system providing the user computer with a media service.

The commercial tag constituting the commercial tag set is used for the obtaining of a keyword advertisement content, and the keyword advertisement content is exposed on a user computer together with the digital content, and a method of exposing the digital content with the keyword advertisement content on the user computer includes at least one of 1) a first method of transmitting the commercial tag set to the keyword advertisement content providing system in a direct manner or via a third system, obtaining at least one keyword advertisement content from the keyword advertisement content providing system in a direct manner or via the third system, and then transmitting the digital content and the obtained keyword advertisement content to the user computer, by at least one of the commercial tag generation system, the content producer system of a producer producing the digital content, the content circulator system of the circulator circulating the digital content, the content distributor system for distributing the digital content to a user computer, the digital content service system providing the user computer with a digital content, the keyword advertisement content providing system, the content syndication system for managing transference of the digital content, the user computer, and the preset program executed in the user computer, 2) a second method of, by at least one of the commercial tag generation system, the content producer system of a producer producing the digital content, the content circulator system of a circulator circulating the digital content, the content distributor system for distributing the digital content to a user computer, the digital content service system providing the user computer with a digital content, the keyword advertisement content providing system, the content syndication system for managing transference of the digital content, the user computer, and a preset program executed in the user computer, transmitting a program having a function of obtaining the commercial tag set and a keyword advertisement content from the keyword advertisement content providing system by using the commercial tag set to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the keyword advertisement content on the user computer, 3) a third method of, by at least one of the commercial tag generation system, the content producer system of a producer producing the digital content, the content circulator system of a circulator circulating the digital content, the content distributor system for distributing the digital content to a user computer, the digital content service system providing the user computer with a digital content, the keyword advertisement content providing system, the content syndication system for managing transference of the digital content, the user computer, and a preset program executed in the user computer, transmitting a program having a function of obtaining a keyword advertisement content from the keyword advertisement content providing system by using the commercial tag set and a function of obtaining a commercial tag set corresponding to the digital content to the user computer, and by the program, obtaining the commercial tag set corresponding to the digital content, transmitting the obtained commercial tag set to the keyword advertisement content providing system in a direct manner or via the third system, obtaining at least one keyword advertisement content from the keyword advertisement content providing system in a direct manner or via the third system, and exposing the keyword advertisement content on the user computer, and 4) a fourth method of, by at least one of a commercial tag generation system, the content producer system of a producer producing the digital content, the content circulator system of a circulator circulating the digital content, the content distributor system for distributing the digital content to a user computer, the digital content service system providing the user computer with a digital content, the keyword advertisement content providing system, the content syndication system for managing transference of the digital content, the user computer, and a preset program executed in the user computer, including a program having a function of obtaining a keyword advertisement content from the keyword advertisement content providing system by using the commercial tag set and a function of obtaining a commercial tag set corresponding to the digital content in the digital content and transmitting the program to the user computer, and by the program, obtaining the commercial tag set corresponding to the digital content, transmitting the obtained commercial tag set to the keyword advertisement content providing system in a direct manner or via the third system, receiving the commercial tag set from the keyword advertisement content providing system in a direct manner or via the third system, and exposing the keyword advertisement content on the user computer.

In accordance with another aspect of the present invention, there is provided a method for information processing by a content syndication system which participates in a transference of a digital content by using a wired/wireless network, so as to provide a keyword advertisement service based on meta information by using a commercial tag set, the method including: (A) obtaining request information of at least one commercial tag set information corresponding to at least one digital content information from a preset first system; (B) obtaining the commercial tag set information corresponding to the digital content information; and (C) transmitting the commercial tag set information to a preset second system, in which the commercial tag set information is information related to a commercial tag set, and the commercial tag set consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through a keyword advertisement content providing system by using the commercial tag, and the tag includes at least one text string of a product name, a service name, a proper noun, and a keyword registered in the keyword advertisement content providing system by an advertiser, and when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of an advertiser corresponding to a keyword registered by the advertiser.

The commercial tag set is generated using a commercial tag set generation system, and the commercial tag set generation system provides at least one between existence information of a keyword advertisement content corresponding to the tag and commerciality information of the tag.

The digital content information includes at least one of physical digital content data, digital content identification information capable of identifying the physical digital content data, and digital content location information capable of accessing the physical digital content data through a wired/wireless network, and the commercial tag set information includes at least one of physical commercial tag set data, commercial tag set identification information capable of identifying the physical commercial tag set data, and commercial tag set location information capable of accessing the physical commercial tag set data through a wired/wireless network.

The first system and the second system include at least one of the digital content service system providing a user computer with a digital content, the content syndication system, the keyword advertisement content providing system, the user computer, and a preset program executed in the user computer, and the digital content service system includes at least one of the multimedia content service system providing the user computer with a multimedia content, the broadcasting service system providing the user computer with a broadcasting content, a digital publication system providing the user computer with a digital publication, and a media service system providing the user computer with a media service.

The content belongs to one of a content producer system of the producer producing the digital content, the content circulator system of a circulator circulating the digital content, the content distributor system for distributing the digital content to a user computer, the digital content service system providing a user computer with a digital content, the keyword advertisement content providing system, the user computer, and a preset program executed in the user computer, the content syndication system is independent of the content producer system, the content circulator system, the content distributor system, the digital content service system, the keyword advertisement content providing system, the user computer, and the preset program executed in the user computer and is wired/wirelessly connected with them, and the digital content service system includes at least one of the multimedia content service system providing the user computer with a multimedia content, the broadcasting service system providing the user computer with a broadcasting content, the digital publication system providing the user computer with a digital publication, and the media service system providing the user computer with a media service.

The first system is the content syndication system, the content syndication system binds the digital content information with the obtained commercial tag set information prior to performing the (C), and in the (C) process, the content syndication system transmits the digital content information to the second system together with the commercial tag set information.

In the binding the digital content information with the obtained commercial tag set information, the digital content information including at least one of the physical digital content data, the digital content identification information for identifying the physical digital content data, and the digital content location information for accessing the physical digital content data through a wired/wireless network with the commercial tag set information including at least one of the physical commercial tag set data, the commercial tag set identification information capable of identifying the physical commercial tag set data, and the commercial tag set location information capable of accessing the physical commercial tag set data through a wired/wireless network.

The binding of the digital content information with the obtained commercial tag set information includes at least one of a first method of connecting digital content information with the commercial tag set information and storing the connected digital content information and commercial tag set information, a second method of using a same key value for the digital content information and the commercial tag set information so as to connect the digital content information with the commercial tag set information, a third method of using identification information of one between the digital content information and the commercial tag set information serving as a key value for another information so as to connect the digital content information with the commercial tag set information, and a fourth method of calling, by one information between the digital content information and the commercial tag set information, another information, so as to connect the digital content information with the commercial tag set information.

The generating the commercial tag set for the digital content by the commercial tag set generation system includes: (a1) obtaining at least one commercial tag for the digital content; (a2) obtaining commerciality information of the commercial tag candidate; (a3) generating at least one commercial tag set including at least one commercial tag candidate corresponding to the received selection information among the commercial tag candidates for the digital content; and (a4) corresponding the generated commercial tag set to identification information of the digital content and storing the commercial tag set and identification information, or transmitting the commercial tag set to a preset system together with the identification information.

The commercial tag set includes at least one of rank information, time information, and condition information applied to at least one commercial tag constituting the commercial tag set.

The commercial tag constituting the commercial tag set is used for the obtaining of a keyword advertisement content, the keyword advertisement content is exposed on a user computer together with the digital content, and a method of exposing of the digital content and the keyword advertisement content on the user computer includes; 1) a first method of, by one of the content syndication system, the first system, and the second system, transmitting the commercial tag set to the keyword advertisement content providing system in a direct manner or via a third system, receiving at least one keyword advertisement content from the keyword advertisement content providing system in a direct manner or via the third system, and then transmitting the digital content and the received keyword advertisement content to the user computer; 2) a second method of, by one of the content syndication system, the first system, and the second system, transmitting a program having a function of obtaining the commercial tag set and a keyword advertisement content by using the commercial tag set from the keyword advertisement content providing system to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the keyword advertisement content on the user computer; 3) a third method of, by one of the content syndication system, the first system, and the second system, transmitting a program having a function of obtaining a keyword advertisement content by using the commercial tag set from the keyword advertisement content providing system and a function of obtaining a commercial tag set corresponding to the digital content to the user computer, and by the program, obtaining the commercial tag set corresponding to the digital content by the program, transmitting the obtained commercial tag set to the keyword advertisement content providing system in a direct manner or via the third system, receiving at least one keyword advertisement content from the keyword advertisement content providing system in a direct manner or via the third system, and exposing the keyword advertisement content on the user computer; and 4) a fourth method of, by one of the content syndication system, the first system, and the second system, including a program having a function of obtaining a keyword advertisement content by using the commercial tag set from the keyword advertisement content providing system and a function of obtaining a commercial tag set corresponding to the digital content in the digital content and transmitting the program to the user computer, and by the program, obtaining the commercial tag set corresponding to the digital content by the program, transmitting the obtained commercial tag set to the keyword advertisement content providing system in a direct manner or via the third system, receiving at least one keyword advertisement content from the keyword advertisement content providing system in a direct manner or via the third system, and exposing the keyword advertisement content on the user computer.

In accordance with another aspect of the present invention, there is provided a method for providing a keyword advertisement service based on meta information by an exposed keyword management server including an exposed keyword advertisement management server, which manages information of at least one commercial tag set and at last one keyword advertisement content exposed on a user computer, the method including: performing at least one of exposing at least one commercial tag set and exposing at least one keyword advertisement content on the user computer; when the commercial tag set is exposed on the user computer, providing a commercial tag set storage means for storing the commercial tag set exposed on the user computer, and when the keyword advertisement content is exposed on the user computer, providing a keyword advertisement content reservation means for reserving the keyword advertisement content exposed on the user computer and reproducing the reserved keyword advertisement content again upon a request; performing at least one of receiving selection information of the commercial tag set storage means from the user computer and storing the commercial tag set corresponding to the received selection information, and receiving selection information of the keyword advertisement content reservation means from the user computer and storing the keyword advertisement content corresponding to the received selection information; and performing at least one of exposing at least one of at least one stored commercial tag set and at least one keyword advertisement content corresponding to the stored commercial tag set on the user computer, and exposing the reserved keyword advertisement content on the user computer, the commercial tag set is generated by a commercial tag set generation system and consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through a keyword advertisement content providing system by using the commercial tag, and the tag includes at least one text string of a product name, a service name, a proper noun, and a keyword registered in the keyword advertisement content providing system by an advertiser, the commercial tag set generation system provides at least one of existence of a keyword advertisement content corresponding to the tag and commerciality information of the tag, and when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of the advertiser corresponding to a keyword registered by the advertiser.

The exposed keyword management server performs at least one of: (1) a first method of performing the steps of claim 67 while the exposed keyword management server is included in a preset system including or using the exposed keyword advertisement management server; and (2) a second method of transmitting a program having a function of the exposed keyword advertisement management server to the user computer by a preset system including or using the exposed keyword advertisement management server performs, and performing the steps of claim 67 in connection with the system by the program executed in the user computer, and the system includes one of the multimedia content service system providing the user computer with a multimedia content while being in connected with the keyword advertisement content providing system, the content syndication system managing distribution of the multimedia content while being in connected with the keyword advertisement content providing system, the commercial tag set generation system generating the commercial tag set while being in connected with the keyword advertisement content providing system, and the keyword advertisement content providing system.

The commercial tag set and the keyword advertisement content are changed in connection with a reproduction time point and a reproduction section of a multimedia content exposed on the user computer, and in the performing at least one of the storing of the commercial tag set corresponding to the received selection information and the storing of the keyword advertisement content corresponding to the received selection information, the commercial tag set and the keyword advertisement content includes information of the reproduction time point and the reproduction section of the multimedia content corresponding to a time of receiving the selection information, to be stored.

In the performing of at least one of the exposing at least one of the stored commercial tag set and the keyword advertisement content corresponding to the stored commercial tag set on the user computer and the exposing the reserved keyword advertisement content on the user computer includes at least one of: 1) a first method of exposing screen information of the multimedia content corresponding to the time of receiving selection information of the storage of the commercial tag set and the reservation of the keyword advertisement content on the user computer, and 2) a second method of arranging the stored commercial tag set, a keyword advertisement content corresponding to the stored commercial tag set, and the reserved keyword advertisement content in order of a time of receiving selection information of the storage of the commercial tag set and the reservation of the keyword advertisement content.

In accordance with another aspect of the present invention, there is provided a method for information processing by a broadcasting service system including a keyword advertisement content, the broadcasting service system providing a user computer with at least one audio broadcasting content or audio-visual broadcasting content through a wired/wireless network, so as to provide a keyword advertisement service based on meta information, the method including: obtaining at least one commercial tag set corresponding to the broadcasting content, the commercial tag set being generated by the broadcasting service system by using a commercial tag generation system; corresponding the obtained commercial tag set to a broadcasting content identifier corresponding to the broadcasting content and storing the commercial tag set and broadcasting content identifier; and exposing the broadcasting content and at least one keyword advertisement content called through a keyword advertisement content providing system in a direct manner or via a third system by using the commercial tag set on the user computer, wherein the commercial tag set is generated by a commercial tag set generation system, and the commercial tag set consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through the keyword advertisement content providing system by using the commercial tag, and the tag includes at least one text string of a product name, a service name, a proper noun, and a keyword registered in the keyword advertisement content providing system by an advertiser, and the commercial tag set generation system provides at least one between existence information of a keyword advertisement content corresponding to the commercial tag and commerciality information of the commercial tag, when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of the advertiser corresponding to a keyword registered by the advertiser.

The broadcasting provided from the broadcasting service system is a real-time broadcasting, a commercial tag set generated by the commercial tag generation system is a real-time commercial tag set generated during real time broadcasting, and the exposed keyword advertisement content is exposed on the user computer during broadcasting of the real-time broadcasting.

The commercial tag set is generated by at least one of: 1) a first method of directly inputting the commercial tag set to the commercial tag generation system by a person operating or managing the broadcasting service system, a person progressing the real-time broadcasting, or an entrusted person of the person operating or managing the broadcasting service system; 2) a second method of analyzing text information included in a continuity included in the broadcasting content and extracting at least one commercial tag by the commercial tag generation system, and receiving a selection of a commercial tag set from a person operating or managing the broadcasting service system, a person progressing the real-time broadcasting, or an entrusted person of the person operating or managing the broadcasting service system; and 3) a third method of recognizing voice information included in the broadcasting content, analyzing text information included in the voice information, and extracting at least one commercial tag by the commercial tag generation system, and receiving a selection of a commercial tag set from a person operating or managing the broadcasting service system, a person progressing the real-time broadcasting, or an entrusted person of the person operating or managing the broadcasting service system.

In the corresponding the obtained commercial tag set to a broadcasting content identifier corresponding to the broadcasting content and the storing the commercial tag set and broadcasting content identifier, time information corresponding to the commercial tag set is included and stored.

The exposing of the broadcasting content and the keyword advertisement content on the user computer includes at least one of: 1) a first method of, by the broadcasting service system, transmitting a program requesting obtainment of a keyword advertisement content in a preset time interval to the user computer; receiving a transmission request of a keyword advertisement content in a preset time interval through the program executed in the user computer; transmitting the commercial tag set to the keyword advertisement content providing system in a direct manner or via the third system and receiving at least one keyword advertisement content from a keyword advertisement content providing system in a direct manner or via the third system; and transmitting the received keyword advertisement content to the user computer; 2) a second method of, by the broadcasting service system, transmitting a program having a function of obtaining the commercial tag set and a keyword advertisement content by using the commercial tag set from the keyword advertisement content providing system to the user computer; and by the program, transmitting the commercial tag set to the keyword advertisement content providing system in a direct manner or via the third system, receiving at least one keyword advertisement content from the keyword advertisement content providing system in a direct manner or via the third system, and exposing the received keyword advertisement content on the user computer; 3) a third method of by the broadcasting service system, transmitting a program having a function of obtaining a keyword advertisement content by using the commercial tag set from the keyword advertisement content providing system and making a request of a commercial tag set corresponding to the broadcasting content to the broadcasting service system in a preset time interval and obtaining the commercial tag set to the user computer; and by the program, obtaining the commercial tag set corresponding to the broadcasting content; transmitting the obtained commercial tag set to the keyword advertisement content providing system in a direct manner or via the third system; receiving at least one keyword advertisement content from the keyword advertisement content providing system in a direct manner or via the third system, and exposing the received keyword advertisement content on the user computer; and 4) a fourth method of by the broadcasting service system, including a program having a function of obtaining a keyword advertisement content from the keyword advertisement content providing system by using the commercial tag set and making a request of a commercial tag set corresponding to the broadcasting content to the broadcasting service system in a preset time interval and obtaining the commercial tag set corresponding to the broadcasting content from the broadcasting service system in the broadcasting content when the broadcasting content is initially transmitted to the user computer and transmitting the program to the user computer; and by the program, obtaining the commercial tag set corresponding to the broadcasting content; transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer.

In the first method, when the broadcasting service is a real-time broadcasting, the broadcasting service system obtains the keyword advertisement content by using a commercial tag set corresponding to the time point of receiving the transmission request of the keyword advertisement content from the user computer, and the commercial tag set corresponding to the time point of receiving the transmission request of the keyword advertisement content is a commercial tag set generated just before a time of receiving the transmission request of the keyword advertisement content, in the second method, when the broadcasting service is a real-time broadcasting, the commercial tag set is generated before the real-time broadcasting and further includes time zone information used for obtainment of a keyword advertisement content by using the commercial tag set, and the program further has a function capable of selecting a commercial tag set used for obtainment of a keyword advertisement content with reference to information of a current time point of the reproduction of the broadcasting content, and in one of the third method and the fourth method, when the broadcasting service is a real-time broadcasting, the broadcasting service system transmits a commercial tag set corresponding to the time point of receiving the transmission request of the commercial tag set from the user computer, to the user computer, and the transmitted commercial tag set is a commercial tag set generated just before a time of receiving the transmission request of the commercial tag set.

In accordance with another aspect of the present invention, there is provided a method for information processing by a media service system, which provides multiple user computers accessing through a wired/wireless network with at least one content and at least one online service, so as to provide a keyword advertisement service based on meta information, the method including: allowing a content manager managing at least one content by using a media service system to use a commercial tag generation system and obtaining at least one commercial tag set corresponding to at least one content managed by the content manager by using the commercial tag generation system from the content manager; corresponding the obtained commercial tag set to a content identifier corresponding to the content and storing the commercial tag set; obtaining request information of a content managed by the content manager from at least one user computer; obtaining the commercial tag set corresponding to a content corresponding to the received request information; and exposing the content corresponding to the received request information and at least one keyword advertisement content called through a keyword advertisement content providing system in a direct manner or a third system by using the commercial tag set on the user computer, and the commercial tag set is generated by a commercial tag set generation system and consists of at least one commercial tag belonging to a category of a tag, and the commercial tag guarantees an existence of at least one keyword advertisement content corresponding to the commercial tag in at least one time point between a generation time point of the commercial tag or a calling time point of the keyword advertisement through a keyword advertisement content providing system by using the commercial tag, and the tag includes at least one text string of a product name, a service name, a proper noun, and a keyword registered in the keyword advertisement content providing system by an advertiser, and the commercial tag set generation system provides at least one between existence information of a keyword advertisement content corresponding to at least one tag and commerciality information of at least one tag, and when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of an advertiser corresponding to a keyword registered by the advertiser.

The media service system provides at least one of a blog service, a community service, a social network service, and one person media service including a one-person broadcasting, and the content manager is a person generating and managing a digital type content consisting of at least one of texts, images, moving pictures, and sounds by using the blog service, a café service, the community service, the social network service.

The tag subjected to the provision of information of the existence of the keyword advertisement content and the commerciality information of the tag is generated by at least one of: 1) a first method of directly inputting the commercial tag by the content manager; 2) a second method of extracting at least one commercial tag for the content by the commercial tag generation system; and 3) a third method of extracting at least one commercial tag for the content by the commercial tag generation system and receiving a selection of the tag from the content manager.

A number of tags are more than one, the commercial tag generation system receives selection information of at least one tag among multiple tags from the content manager.

The content is a content including at least one of a sound and a moving picture requiring a time for a reproduction of a content, and the commercial tag corresponding to a content requiring a time for a reproduction is a time dependent commercial tag additionally including at least one time information.

The exposing of the keyword advertisement content on the user computer includes at least one of: 1) a first method of, by the media service system, transmitting the commercial tag set to the keyword advertisement content providing system in a direct manner or via the third system, receiving at least one keyword advertisement content from the keyword advertisement content providing system in a direct manner or via the third system, and transmitting the content and the received keyword advertisement content to the user computer; 2) a second method of, by the media service system, transmitting a program having a function of obtaining the commercial tag set and a keyword advertisement content by using the commercial tag set from the keyword advertisement content providing system to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the received keyword advertisement content on the user computer; and 3) a third method of, by the media service system, transmitting a program having a function of obtaining a keyword advertisement content from the keyword advertisement content providing system by using the commercial tag set and a function of obtaining a commercial tag set corresponding to the content to the user computer, and by the program, obtaining the commercial tag set corresponding to the content, transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer.

In accordance with another aspect of the present invention, there is provided a method for information processing by a digital publication service system, which directly or indirectly provides a user computer with at least one digital publication content through a wired/wireless network, so as to provide a keyword advertisement service based on meta information, the method including: obtaining at least one commercial tag set corresponding to the digital publication content, the commercial tag set being generated by the digital publication service system using the commercial tag generation system; corresponding the obtained commercial tag set to a digital publication content identifier corresponding to the digital publication content and storing the commercial tag set and digital publication content identifier; and exposing the digital publication content and at least one keyword advertisement content called through a keyword advertisement content providing system in a direct manner or via a third system on the user computer by using the commercial tag set, the commercial tag set is generated by a commercial tag set generation system and consists of at least one commercial tag belonging to a category of a tag, and the commercial tag guarantees an existence of at least one keyword advertisement content corresponding to the commercial tag in at least one time point between a generation time point of the commercial tag or a calling time point of the keyword advertisement through a keyword advertisement content providing system by using the commercial tag, the tag includes at least one text string of a product name, a service name, a proper noun, and a keyword registered in the keyword advertisement content providing system by an advertiser, the commercial tag set generation system provides at least one between existence information of a keyword advertisement content corresponding to at least one tag and commerciality information of at least one tag, when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of the advertiser corresponding to a keyword registered by the advertiser

The digital publication service system provides at least one of a news publication service for publishing an on-line news, an article publication service for publishing an on-line article, an electronic book publication service for publishing an on-line digital type book or magazine, and a document publication service for publishing an on-line digital type document file, and the digital publication content consists of at least one of digital type texts, images, moving pictures, and sounds.

The digital publication service system provides the electronic book publication service, the electronic book publication consists of at least two partial electronic book publications and the commercial tag set is generated and stored in accordance with the partial electronic book publication constituting the electronic book publication, and at least two partial electronic book publications belong to any one of a type including a commercial tag set corresponding to the partial electronic book publication and a type not including a commercial tag set corresponding to the partial electronic book publication.

The digital publication service system provides the news publication service, the news publication consists of at least two unit news publications and the commercial tag set is generated and stored in accordance with a unit news publication constituting the news publication, and at least two unit news publications belong to any one of a type including a commercial tag set corresponding to the unit news publication and a type not including a commercial tag set corresponding to the unit news publication, and when the digital publication service system provides the article publication service, the article publication consists of at least two unit article publications and the commercial tag set is generated and stored in accordance with a unit article publication constituting the article publication, and at least two unit article publications belong to any one of a type including a commercial tag set corresponding to the unit article publication and a type not including a commercial tag set corresponding to the unit article publication, and when the digital publication service system provides the document publication service, the document publication consists of at least two document pages and the commercial tag set is generated and stored in accordance with a document page constituting the document publication, and at least two document pages belong to any one of a type including a commercial tag set corresponding to the document page and a type not including a commercial tag set corresponding to the document page.

The tag subjected to the provision of at least one of information of the existence of the keyword advertisement content and the commerciality information of the tag is generated by at least one of: 1) a first method of directly inputting the commercial tag by a person operating or managing the digital publication service system or generating the digital publication content; 2) a second method of analyzing text information included in the digital publication content and extracting at least one commercial tag for the digital publication content by the commercial tag generation system; and 3) a third method of analyzing the digital publication content and extracting at least one commercial tag for the digital publication content by the commercial tag generation system, and receiving a selection of the tag from a person operating or managing the digital publication service system or generating the digital publication content.

The commerciality information of the tag includes at least one of, with respect to the tag, 1) a total number of exposures/a total number of calls, 2) an increase/decrease rate of the total number of exposures/calls, 3) a total number of advertisers, 4) an average advertisement unit price, 5) a highest advertisement unit price, 6) a lowest advertisement unit price, 7) an average number of advertisers, 8) an average number of keyword advertisement contents, 9) an increase/decrease rate of the average number of advertisers, and 10) an increase/decrease rate of the average advertisement unit price, and with respect to the keyword advertisement contents corresponding to the tag, 11) a number of exposures, 12) a click generation rate of a keyword advertisement content with respect to exposure, 13) a total number of clicks, 14) a generated advertisement profit, 15) an increase/decrease rate of the number of exposures, 16) an increase/decrease rate of a click generation rate with respect to exposures, 17) an increase/decrease rate of a total number of clicks, 18) an increase/decrease rate of a generated advertisement profit, and at least one preset function value using at least one of the 1) to 18).

The digital publication content is a content including at least one of a sound and a moving picture requiring a time point for a reproduction of a content, and the commercial tag corresponding to a content requiring a time point for a reproduction is a time dependent commercial tag additionally including at least one time information.

The exposing the digital publication content and the keyword advertisement content on the user computer includes at least one of: 1) a first method of, by the digital publication service system, transmitting the commercial tag set to the keyword advertisement content providing system in a direct manner or via the third system, receiving at least one keyword advertisement content from the keyword advertisement content providing system in a direct manner or via the third system, and transmitting the digital publication content and the received keyword advertisement content to the user computer; 2) a second method of by the digital publication service system, transmitting a program having a function of obtaining the commercial tag set and a keyword advertisement content by using the commercial tag set from the keyword advertisement content providing system to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the received keyword advertisement content on the user computer; 3) a third method of, by the digital publication service system, transmitting a program having a function of obtaining a keyword advertisement content by using the commercial tag set from the keyword advertisement content providing system and a function of a commercial tag set corresponding to the digital publication content to the user computer, and by the program, obtaining the commercial tag set corresponding to the digital publication content, transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer; and 4) a fourth method of, by the digital publication service system, including a program having a function of obtaining a keyword advertisement content by using the commercial tag set from the keyword advertisement content providing system and a function of obtaining a commercial tag set corresponding to the digital publication content in the digital publication content and transmitting the program to the user computer, and by the program, obtaining the commercial tag set corresponding to the broadcasting content, transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer.

In accordance with another aspect of the present invention, there is provided a system for providing a keyword advertisement service based on meta information, including: a multimedia content ID DB unit including multimedia content identifier information capable of identifying the multimedia content; a commercial tag DB unit including commercial tag set identifier information capable of identifying the commercial tag set; and a content syndication control unit including at least one of a commercial tag set obtainment module for obtaining the commercial tag set corresponding to the multimedia content, a commercial tag set binding module for corresponding the obtained commercial tag set to the multimedia content, a commercial tag set providing module for providing a requestor of the commercial tag set with information on the commercial tag set, and a commercial tag set call module for calling a commercial tag set by using the multimedia content identifier information, in which at least one commercial tag constituting the commercial tag set is a text type tag transmitted to a keyword advertisement content providing system and used for obtainment of at least one keyword advertisement content from the keyword advertisement content providing system, and when the keyword advertisement content providing system receives the commercial tag, the keyword advertisement content providing system inquires of a keyword advertisement content DB about the commercial tag and obtains at least one keyword advertisement content, and the keyword advertisement content DB stores at least one keyword advertisement content corresponding to a text-type commercial tag of at least one advertiser.

In accordance with another aspect of the present invention, there is provided a method for providing a keyword advertisement service based on meta information by a content syndication system, which participates in transferring at least one multimedia content to a user computer in a direct manner or via a third system through a wired/wireless network on a network, the method including: (A) obtaining multimedia content identifier information capable of identifying the multimedia content; (B) obtaining at least one of the commercial tag set corresponding to the multimedia content and commercial tag set identifier information capable of identifying the commercial tag set; (C) corresponding the multimedia content identifier information to at least one of the commercial tag set and the commercial tag set identifier information and storing; (D) obtaining multimedia content identifier information capable of identifying the multimedia content from at least one of the user computer and a third computer; and (E) obtaining at least one of the commercial tag set and the commercial tag set identifier information corresponding to the multimedia content identifier information stored in the (C) by using the multimedia content identifier information obtained from at least one of the user computer and the third computer in the (D), in which at least one commercial tag constituting the commercial tag set is a text type tag transmitted to a keyword advertisement content providing system and used for obtainment of at least one keyword advertisement content from the keyword advertisement content providing system, and when the keyword advertisement content providing system receives the commercial tag, the keyword advertisement content providing system inquires of a keyword advertisement content DB about the commercial tag and obtains at least one keyword advertisement content, and the keyword advertisement content DB stores at least one keyword advertisement content corresponding to the text type commercial tag of at least one advertiser.

### Advantageous Effects

The present invention has the following effects.

First, a businessman running a multimedia content service system can obtain advertisement gains through a multimedia content service including a keyword advertisement content.

Second, a businessman running a meta information-based advertisement intermediation system can obtain advertisement gains through intermediating of a keyword advertisement content.

Third, a businessman running a keyword advertisement content providing system can obtain advertisement gains through providing a keyword advertisement content.

Fourth, a businessman providing a user computer installation program can obtain advertisement gains through exposing a keyword advertisement content on a user computer.

Fifth, the user can easily access information provided by an advertiser through a keyword advertisement content having information that is related to a multimedia content being in contact with the user so that the user can obtain additional information on his/her interest field.

Sixth, an advertiser can create more traffic on a site/web-page to be advertised.

Seventh, a person who participates in the commercial tag generation can obtain gains as a compensation for the participation, and when the person provides a keyword advertisement by using a commercial tag, it is possible to create more advertisement gains in relation to the same multimedia content.

Eighth, a person running or using a commercial tag set generation system can generate or use a commercial tag capable of calling a keyword advertisement of large gains, so that the person can expect the advertisement gains or service usage gains.

Ninth, those who run a content producer system, a content circulator system, and a content distributor system participating in a content syndication or a person participating in a content syndication can obtain large keyword advertisement gains, so that they can circulate a content at a relatively low price or for free, and thus the users can enjoy the content with a low expense or for free.

Tenth, a person running a media service system can obtain advertisement gains through providing a media content including a keyword advertisement content. Further, content managers of multiple blogs, communities, etc. participating in the media service system can receive a part of the advertisement gains related to the content generated or managed by the content manager, so that the person can be benefited from the advertisement gains.

Eleventh, those who run a digital publication service system, such as a document (e.g. pdf file) program, a document publication service system, an electronic book system, an article publication service system, or a news publication service system can obtain advertisement gains through providing a digital publication content including a keyword advertisement content. Therefore, electronic books, documents, news, and articles can be circulated at a low price so that readers can use the digital publication content including the electronic books, documents, news, or articles for free or with a small expense.

Twelfth, a person running a broadcasting service system providing a broadcasting content service or a real-time multimedia content service system can obtain advertisement gains through providing a media content service including a keyword advertisement content.

Thirteenth, specialists, such as an advertisement specialist participating in the generation of a commercial tag set for a specific content, receives a compensation for the contribution to the generation of the commercial tag set utilized in the high-gain advertisement.

### BRIEF DESCRIPTION OF THE DRAWINGS

FIG. 1 is a view illustrating a conventional moving picture reproduction web-page screen without an application of the present invention;

FIG. 2 is a view illustrating a moving picture reproduction web-page screen according to a keyword advertisement content service method based on meta information of the present invention, and shows a keyword advertisement content corresponding to the text “printer” included in tag information as meta information;

FIG. 3 is a view illustrating a conventional moving picture reproduction web-page screen served in the Korean language without an application of the present invention;

FIG. 4 is a view illustrating a moving picture reproduction web-page screen according to a keyword advertisement content service method based on meta information of the present invention, and shows a keyword advertisement content corresponding to the text “refill ink” included in tag information as meta information;

FIG. 5 is a view illustrating a web-page screen providing a conventional image service without an application of the present invention;

FIG. 6 is a view illustrating a web-page screen providing an image service according to a keyword advertisement content service method based on meta information of the present invention, and shows a keyword advertisement content corresponding to the text “refill” included in tag information as meta information;

FIG. 7 is a view illustrating a provision of a keyword advertisement content based on another meta info during a reproduction of a moving picture in FIG. 4, in which the keyword advertisement content can be changed. Especially, FIG. 7 shows an example in which when meta information is divided into two groups and click information of a keyword related to the text “refill ink” in the ink-related group by a user is obtained, a keyword advertisement based on meta information of a group, to which the text “refill ink” belongs, is provided;

FIG. 8 is a view illustrating another keyword advertisement content provided on a user computer when a click is not generated from a user or a predetermined time has passed according to an embodiment of the present invention, in which a keyword advertisement content corresponding to a tag, “multifunction apparatus” is provided;

FIG. 9 illustrates a view, in which a keyword advertisement target text, ‘ink jet’ is extracted from explanation information in meta information and a keyword advertisement content corresponding to the text ‘ink jet’ is provided according to an embodiment of the present invention;

FIG. 10 is a diagram illustrating the construction of a system providing a keyword advertisement service based on meta information in a disintermediation model scheme according to an embodiment of the present invention;

FIG. 11 illustrates an information flow between elements of a system providing a keyword advertisement service based on meta information in a disintermediation model scheme according to an embodiment of the present invention;

FIG. 12 is a flowchart illustrating a method for providing a keyword advertisement service based on meta information in a multimedia content providing system in a disintermediation model scheme according to an embodiment of the present invention;

FIG. 13 is a diagram illustrating the construction of a system providing a keyword advertisement service based on meta information in an intermediation model scheme according to an embodiment of the present invention;

FIG. 14 illustrates an information flow between elements of a system providing a keyword advertisement service based on meta information in an intermediation model scheme according to an embodiment of the present invention;

FIG. 15 is a flowchart illustrating a method for providing a keyword advertisement service based on meta information in a multimedia content providing system in an intermediation model scheme according to an embodiment of the present invention;

FIG. 16 is a flowchart illustrating a method for providing a keyword advertisement service based on meta information in a multimedia content providing system in an intermediation model scheme according to another embodiment of the present invention;

FIG. 17 is a flowchart illustrating a method for providing a keyword advertisement service based on meta information by a system providing a keyword advertisement service based on meta information in an intermediation model scheme according to another embodiment of the present invention;

FIG. 18 is a diagram illustrating the construction of a keyword advertisement content providing system for providing a keyword advertisement service based on meta information according to an embodiment of the present invention;

FIG. 19 illustrates an information flow between elements of a keyword advertisement content providing system for providing a keyword advertisement service based on meta information according to an embodiment of the present invention;

FIG. 20 is a flowchart illustrating a method for providing a keyword advertisement service based on meta information by a keyword advertisement content providing system according to an embodiment of the present invention;

FIG. 21 is a diagram illustrating the construction of a system for providing a keyword advertisement based on meta information through an installation program of a user computer according to an embodiment of the present invention;

FIG. 22 illustrates an information flow between elements of a system for providing a keyword advertisement based on meta information through an installation program of a user computer according to an embodiment of the present invention;

FIG. 23 is a flowchart illustrating a method for providing a keyword advertisement service based on meta information through an installation program of a user computer according to an embodiment of the present invention;

FIG. 24 is a diagram illustrating the construction of elements of a system for providing a keyword advertisement based on meta information in a combination model scheme according to an embodiment of the present invention;

FIG. 25 is a flowchart illustrating a method for providing a keyword advertisement content based on meta information by a multimedia content providing system in a combination model scheme according to an embodiment of the present invention;

FIG. 26 is a flowchart illustrating a method for providing a keyword advertisement service based on meta information through an installation program of a user computer according to another embodiment of the present invention;

FIG. 27 is a diagram illustrating the construction of a commercial tag set generation system according to another embodiment of the present invention;

FIG. 28 is a diagram illustrating the construction of a commercial tag set generation module of a commercial tag set generation system according to another embodiment of the present invention;

FIG. 29 is a flowchart illustrating a method for generating a commercial tag set by a commercial tag set generation system according to another embodiment of the present invention;

FIG. 30 is a flowchart illustrating a method for a keyword advertisement service by a multimedia content service system by using a commercial tag set by a commercial tag set generation system according to an embodiment of the present invention;

FIGS. 31 and 32 are views illustrating a broadcasting service system 13000 using a commercial tag according to an embodiment of the present invention;

FIGS. 33 to 35 are views and flowcharts illustrating an information flow in a broadcasting service system 13000 according to an embodiment of the present invention;

FIGS. 36 and 37 are views illustrating a TV broadcasting (including a broadcasting image screen) and a radio broadcasting (not including a broadcasting image screen) through a wired/wireless bidirectional network according to an embodiment of the present invention;

FIG. 38 is a view illustrating a multimedia content audio-visible interface displayed on a user computer according to an embodiment of the present invention;

FIG. 39 is a view illustrating a screen managing keyword advertisement content information when a keyword advertisement content is exposed on a user computer 9000, is clicked, or is corresponding to an action (reservation, etc) of a user, according to an embodiment of the present invention;

FIG. 40 is a flowchart illustrating an information processing when reservation, storage, click, etc. for a user keyword advertisement content or a commercial tag of the exposed keyword advertisement management server is not created;

FIG. 41 is a flowchart illustrating an information processing when the exposed keyword advertisement management module 13210 is installed in the user computer 9000;

FIG. 42 is a flowchart illustrating an information processing by the exposed keyword advertisement management server when a user selection information for a keyword advertisement content or a commercial tag (reservation, storage, click, etc) is generated;

FIG. 43 is a flowchart illustrating an information processing method by the exposed keyword advertisement management module 13210 installed in the user computer 9000 when a user selection information for a keyword advertisement content or a commercial tag (reservation, storage, click, etc) is generated;

FIG. 44 is a diagram illustrating the construction of a multimedia content service system 1000 providing a real-time generated multimedia content in a real-time broadcasting, and a description of the construction corresponds to FIG. 31, in which the broadcasting service system 1300 providing a real-time broadcasting content to the user computer 9000 is described;

FIG. 45 is a diagram illustrating a method of a conventional content syndication method;

FIG. 46 is a diagram illustrating a content syndication model of the present invention;

FIG. 47 is a diagram illustrating the construction of a content syndication system according to an embodiment of the present invention;

FIG. 48 is a diagram illustrating a method of a content syndication method based on a scheme in which a commercial tag set is first combined with a content in a content circulator system 16000 and the commercial tag set combined with the content is transmitted to the multimedia content service system 1000 according to an embodiment of the present invention;

FIG. 49 is a diagram illustrating an independent route model of a content syndication of the present invention;

FIG. 50 is a diagram illustrating a content syndication method in which a content syndication system performs a role of a content circulator system 16000 according to an embodiment of the present invention;

FIG. 51 is a diagram illustrating the construction of the typical aforementioned independent route model according to an embodiment of the present invention;

FIG. 52 is a diagram illustrating the construction of the aforementioned independent route model according to another embodiment of the present invention;

FIG. 53 is a diagram illustrating the construction of the aforementioned independent route model according to another embodiment of the present invention;

FIG. 54 is a diagram illustrating the construction of a media service system according to an embodiment of the present invention;

FIG. 55 is a diagram illustrating an information processing method in a media service system according to an embodiment of the present invention;

FIG. 56 is a flowchart illustrating an information processing method of a commercial tag generation system according to an embodiment of the present invention;

FIG. 57 is a flowchart illustrating an information processing method of a commercial tag generation system, in which selection information for at least one commercial tag candidate is obtained from a computer of a person desiring to generate a commercial tag set by using a commercial tag set generation system according to another embodiment of the present invention;

FIG. 58 is a flowchart illustrating an information processing method of a content syndication system according to an embodiment of the present invention;

FIG. 59 is a flowchart illustrating an information processing method of a content syndication system, in which digital content information is combined with an obtained commercial tag set information according to an embodiment of the present invention;

FIG. 60 is a flowchart illustrating an information processing method of an exposed keyword advertisement server according to an embodiment of the present invention;

FIG. 61 is a flowchart illustrating an information processing method of a broadcasting service system according to an embodiment of the present invention;

FIG. 62 is a flowchart illustrating an information processing method of a media service system according to an embodiment of the present invention;

FIG. 63 is a flowchart illustrating an information processing method of a digital publication service system according to an embodiment of the present invention; and

FIG. 64 is a diagram illustrating the construction of a digital publication service system according to an embodiment of the present invention.

### BEST MODE

Hereinafter, preferred embodiments of the present invention will be described with reference to the accompanying drawings. In the following description, the same elements will be designated by the same reference numerals although they are shown in different drawings. In the following description, a detailed explanation of known related functions and constitutions may be omitted to avoid unnecessarily obscuring the subject manner of the present invention.

Hereinafter, the present invention will be described in more detail with reference to the drawings.

Entire Construction

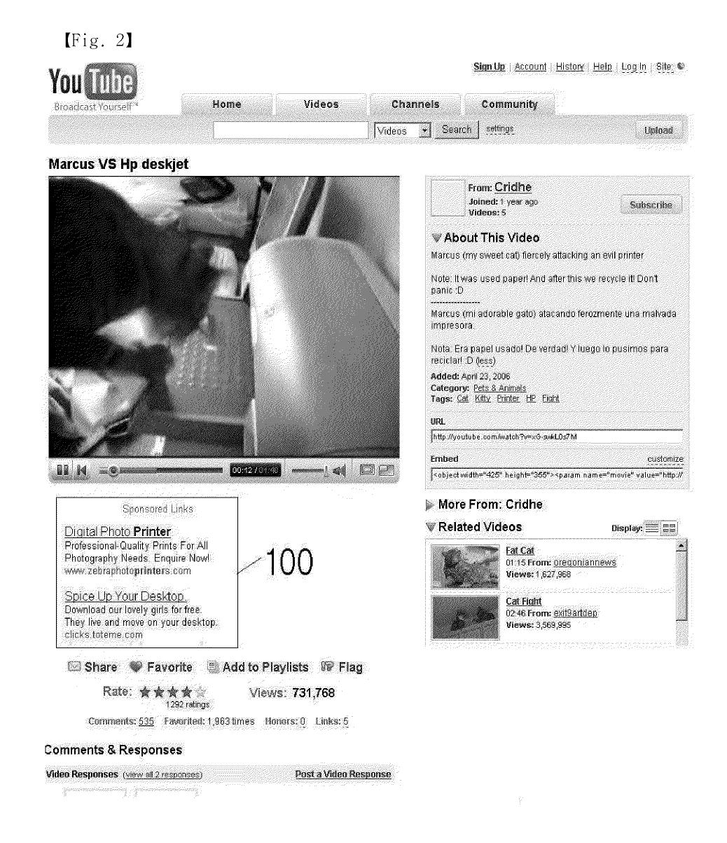

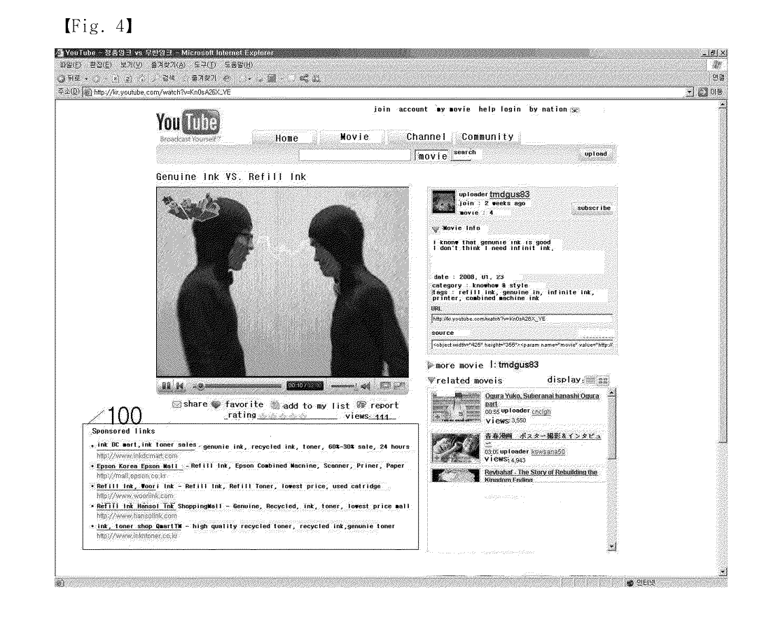

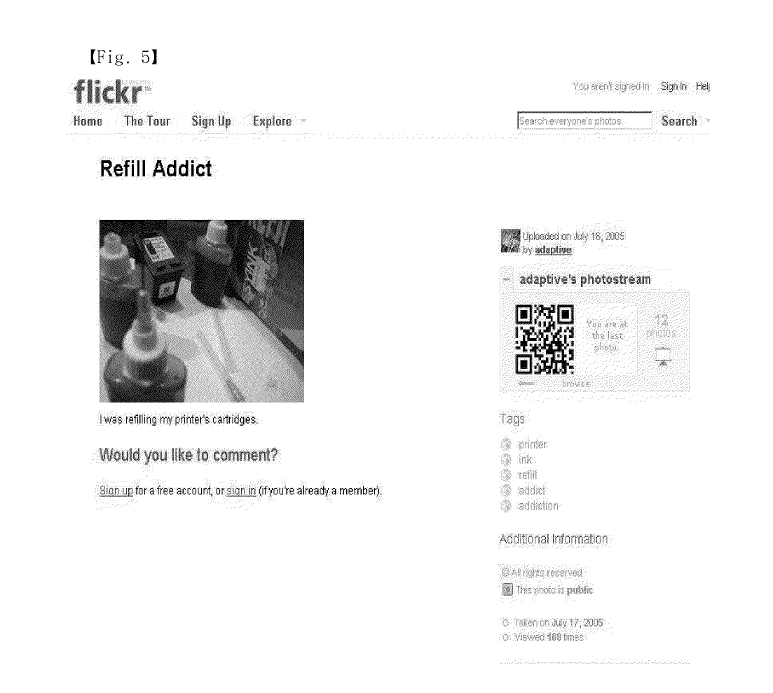

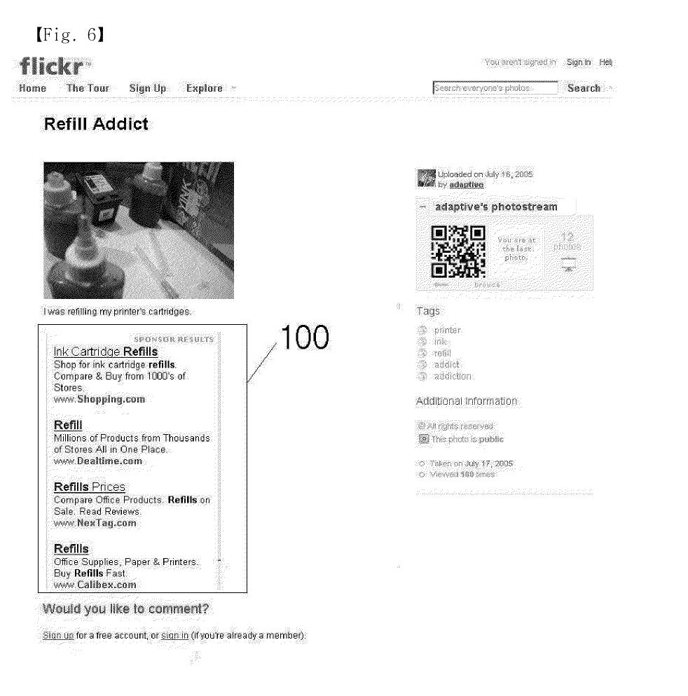

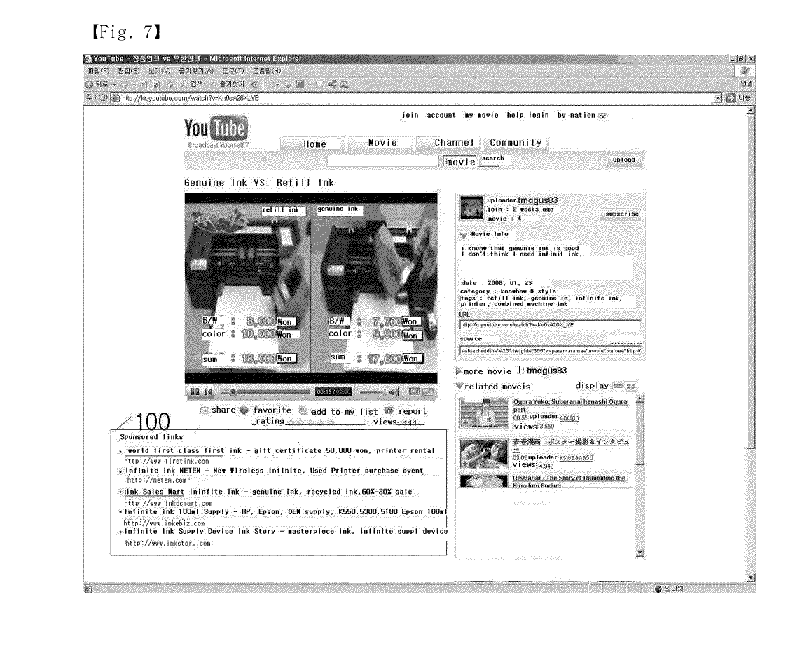

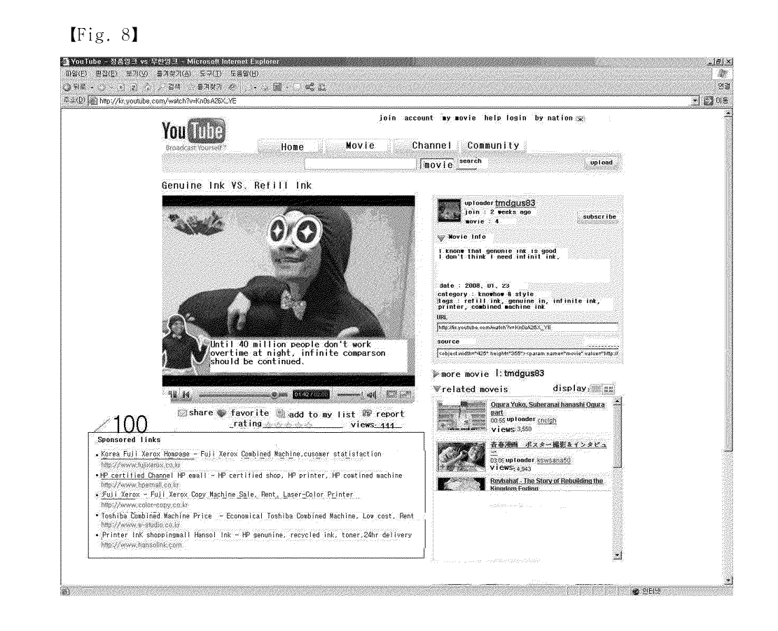

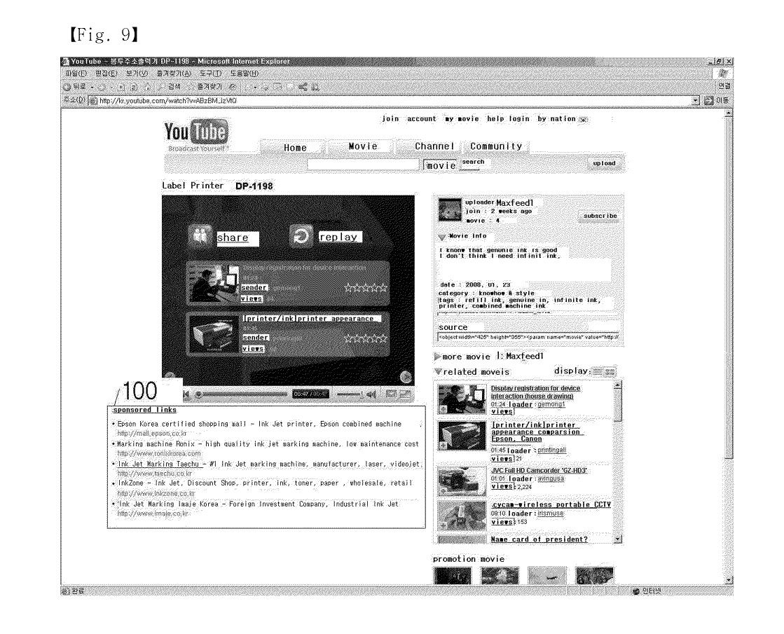

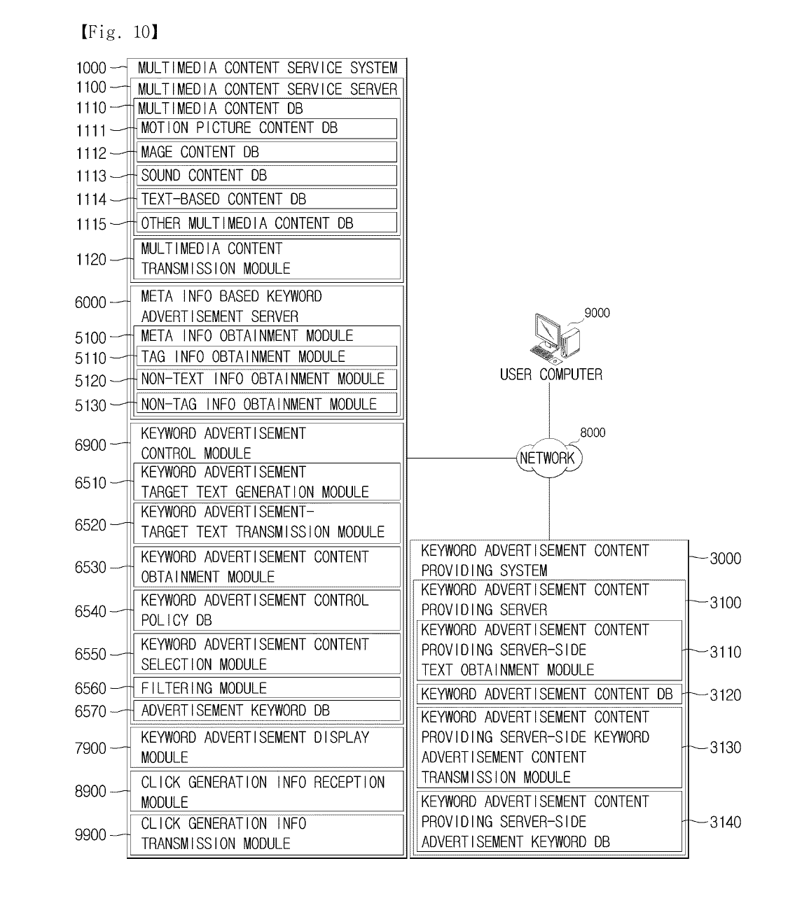

FIGS. 2, 4, 6, 7, 8, and 9 illustrate a keyword advertisement service method based on meta information included in moving picture information by a moving picture multimedia content service system according to an embodiment of the present invention. Further, FIGS. 10, 13, 18, and 21 illustrate the entire construction and the detailed construction of each element of the moving picture multimedia content service system so as to execute the keyword advertisement service method based on meta information included in moving picture information.

The present invention necessarily includes a user computer 9000, a multimedia content service system 1000, a keyword advertisement content providing system 3000, and a wired/wireless network 8000, and includes at least one meta information-based keyword advertisement intermediation system 2000 depending on occasions.

Hereinafter, systems, servers included in the systems, function modules included in the systems and/or servers, and databases (DB) will be described, respectively.

Keyword Advertisement Content Providing System 3000 and Keyword Advertisement Content Providing Server 3100

The keyword advertisement content providing server 3100 is included in the keyword advertisement content providing system 3000. The keyword advertisement content providing server 3100 includes an outside keyword advertisement content providing server type existing at an outside of the multimedia content service system 1000 and an inside keyword advertisement content providing server type existing at an inside of the multimedia content service system 1000. The existence of the keyword advertisement content providing server 3100 in the multimedia content service system 1000 means that an identification or relation is confirmed between an operation subject of the multimedia content service system 1000 and an operation subject of the keyword advertisement content providing server 3100. However, the existence of the keyword advertisement content providing server 3100 in the outside of the multimedia content service system 1000 means that an identification or relation is weak or there is only cooperation between an operation subject of the multimedia content service system 1000 and an operation subject of the keyword advertisement content providing server 3100.

However, according to an aspect of the present invention, there is no great meaning in the discrimination of the inside and the outside, and the inside and the outside are discriminated so as to prevent the confusion in representing the inclusion relation in the entire system or a construction drawing of the service. Most of online businessmen do not have their own keyword advertisement content providing server 3100. The famous sites operating the keyword advertisement content providing server 3100 are Google, Inc. operating www.google.com, Yahoo, Inc. operating www.overture.com, etc. The extra-large sites, such as www.google.com, provide a keyword advertisement content, as well as a multimedia content, that has a combination type, in which the keyword advertisement content providing system 3000 is included in the site in an aspect of the multimedia content service system 1000 included in www.google.com. Such a type of www.google.com is referred to as a combination model type in the present specification.

Conventionally, a person running the keyword advertisement content providing server 3100 directly or indirectly holds an advertiser network. The advertisers register their at least one keyword advertisement content (an advertisement title, an advertisement explanation, URL or URI, an advertisement target image, other advertisement target text, non-text content (multimedia content including an image, a moving picture, sound)) in the keyword advertisement content providing server 3100 based on at least one keyword or together with various keywords. When the keyword advertisement content providing server 3100 receives an input of a specific keyword, etc., or an input keyword, the keyword advertisement content providing server 3100 can extract and transmit a keyword advertisement content corresponding to the keyword, etc. Further, the keyword advertisement content providing server 3100 transmits the extracted keyword advertisement content to a preset virtual space (e.g. the multimedia content service system 1000) through a network, so as to finally expose the keyword advertisement content on the user computer 9000. When an advertisement effect is generated through a click of the keyword advertisement content by the users or an exposure of the keyword advertisement content, the operator of the keyword advertisement content providing server 3100 directly (deduction from an advertisement costs account of an advertiser, etc.) or indirectly (through an advertisement agency, etc.) demands the advertisement costs for the keyword advertisement content from the advertisers. The keyword advertisement content providing server 3100 establishes keywords registered from the advertisers, titles of advertisements, explanations of advertisements, or other contents of text type keyword advertisement contents as a DB or a search index, inquires of a DBMS (DataBase Management System) (or the search engine) about the obtained text inquiry (keyword inquiry, etc.), extracts a keyword advertisement content corresponding to an inquiry result, and provides an inquirer (computer) with the entire extracted keyword advertisement content or the keyword advertisement satisfying a preset reference on.

With regard to the extraction of the keyword advertisement content, when a keyword registered by the advertiser is corresponding to an inquiry, a keyword advertisement content of the advertiser corresponding to the keyword is typically extracted, and when a keyword registered by the advertiser is not corresponding to an inquiry, an appropriate keyword advertisement content is extracted using another matching method.

The present invention discusses a keyword advertisement content among advertisement contents. The keyword advertisement content refers to an advertisement content related to, searched by, or called by a search word/inquiry word or other text-type (including tag and explanation) keywords among the advertisement contents. According to the present invention, it is a matter of course that a corresponding keyword advertisement content is called by a keyword corresponding to a keyword registered by an advertiser. The keyword advertisement content is generally a text type, but can be an image type, such as a banner. Further, the keyword advertisement content does not exclude a picture type, a sound type, etc., and may be a combination of the text, image, picture and/or sound.

When the keyword advertisement content providing server 3100 receives a text string including at least one text from a specific server/client (for example, the user computer 9000 or a specific program or code installed in the user computer 9000), the keyword advertisement content providing server 3100 processes the received text string (at least one keyword advertisement target text in the present invention) and retrieves a keyword advertisement content corresponding to the text string. When the keyword advertisement content corresponding to the text string is included, the keyword advertisement content providing server 3100 provides the server/client with the keyword advertisement content.

The keyword advertisement content providing server 3100 includes a keyword advertisement content providing server-side text obtainment module 3110 (hereinafter, referred to as a text obtainment module 3110 or a keyword advertisement content providing server-side text obtainment module 3110, which is totally different from a non-tag text obtainment module 5130 of a meta information obtainment module 5100) obtaining a text and/or a keyword advertisement target text, a keyword advertisement content DB 3120 storing keyword advertisement contents, and a keyword advertisement content providing server-side keyword advertisement content providing module 3130 transmitting a keyword advertisement content, which has been obtained from the keyword advertisement content DB 3120, corresponding to the obtained text and/or keyword advertisement target text. The keyword advertisement content providing server-side keyword advertisement content providing module 3130 logically or physically transmits a keyword advertisement content to an outside server. Further, a keyword advertisement content transmission module, such as the keyword advertisement content providing server-side keyword advertisement content providing module 3130, performs the same function regardless of a logical or physical position, and performs a function identical to that of a keyword advertisement content transmission module 8800 to be described later of a meta information-based keyword advertisement intermediation server 2100. Those keyword advertisement content transmission modules have only a difference in a higher concept to which one belongs, but their performing function is the same.

At this time, the keyword advertisement content providing server-side text obtainment module and the keyword advertisement content providing server-side keyword advertisement content transmission module can be physically or functionally unified as one module. In the general synchronous communication, a keyword obtainment module and an advertisement content transmission module are not separated and one module performs both the reception function and the transmission function. According to a characteristic of the HTTP protocol, when a client establishes a connection with a server and in this state, the client makes a request of a keyword to the server, the server generates an advertisement content corresponding to the keyword in a connection maintained state, transmits the generated advertisement content to the client, and interrupts the connection. However, if the keyword obtainment module and the advertisement content transmission module are physically or functionally identical, their performing functions (reception and transmission target information) are different, it is more reasonable to conceptually classify the keyword obtainment module and the advertisement content transmission module. An asynchronous communication (a reception module is separated from a transmission module) is used when it takes a long time for processing or it is not necessary to immediately receive a response.

A method of extracting an appropriate keyword advertisement content corresponding to the received text and/or keyword advertisement subject text generally includes a method using a DBMS and a method using a search engine. The keyword advertisement content includes a keyword registered by an advertiser, a title of an advertisement, an explanation of an advertisement, a URL (a keyword advertisement content URL stored in the keyword advertisement content providing server 3100, a URL of an advertiser related to a keyword advertisement content, and other relevant URLs), various texts including other texts, etc., and number and/or symbol type information, and the information is an inquiry target in a query of the DBMS or can be indexed by an indexer. The keyword advertisement content URL represents a URL of a server having a function of obtaining click information from the multimedia content service system 1000 or the keyword advertisement content providing server 3100 and redirecting click information to an actual page when the keyword advertisement content URL is clicked. Further, the actual URL is a web-page address of an actual advertiser obtaining click information from the server, processing the obtained click information, and finally exposing the keyword advertisement content to a user computer.

For example, in a case in which the URL of the keyword advertisement content is http://keyadserver.com/redirect?id=49382& . . . and the URL of the web-page of the actual advertiser is http://pradabag.co.kr, keyword advertisement content information to be transmitted to the user computer includes the URL of the keyword advertisement content (the URL of the keyword advertisement content is generally hidden to the user). When the user clicks the URL of the keyword advertisement content, the URL http://pradabag.co.kr of the web-page of the advertiser is redirected and web-page information of the URL http://pradabag.co.kr of the web-page of the advertiser is transmitted to the user computer.

The fact that at least one multimedia content and various information of the multimedia contents are established as the DB and necessary information is obtained from the DB through the DBMS in a query scheme, and the various information are established as an index and when a search query word is obtained, the query word is searched using a searcher, etc. is obvious to those skilled in the art, so that its detailed description will be omitted. It is a matter of course that the keyword advertisement content DB 3120 can include information of an advertiser who registers a keyword advertisement content corresponding to a specific advertisement keyword and information of an advertisement keyword registered by an advertiser. The keyword advertisement content DB 3120 includes at least one of information of an advertisement unit price (the advertisement unit price may be fluctuated in real time), information of an advertisement costs incurring condition, information of an advertisement balance of an advertiser, information of an advertisement expenditure of an advertiser, information of advertisement incurring management, information of an advertisement operation policy, information of an advertisement costs distribution policy, and information of an illegal advertisement exclusion policy and terms. When the DBMS is used, it is preferable to use the speedy DB, such as a memory DB, so as to improve a search speed in the DB. Further, the use of the search engine is more efficient than the use of the DBMS. It can be considered that the search engine indexes an increment or a fluctuation of the DB serving as a data source.

Multimedia Content Service System 1000 and Multimedia Content Service Server 1100

The multimedia content service system 1000 includes a multimedia content service server 1100 providing a multimedia content service, and the multimedia content service server 1100 includes a multimedia content DB 1110. The multimedia content DB 1110 includes at least one of a moving picture content DB 1111 including moving picture contents, an image content DB 1112 including a picture or other image type contents, a sound content DB 1113 including music, songs, sound effects, or other sound contents, a text-based content DB 1114 including a text-based content, such as articles or news, and other multimedia content DB 1115. The multimedia content DB 1110 further includes at least one multimedia content file, meta information of the multimedia content file, address information capable of calling the multimedia content file (actually, a multimedia file is included in another system and the multimedia content service server 1100 has the address information capable of calling the multimedia content file, and when the multimedia content service server 1100 provides the user computer with the address information, the user computer can receive the multimedia file or streaming data of the file by using the address information), and other management information of the multimedia content file. The multimedia content service system 1000 provides the user computer 9000 accessing the multimedia content service system 1000 with the multimedia content and services related to other multimedia contents through the wired/wireless network 8000. At this time, if the multimedia content service system 1000 provides the service through a web scheme (a web browser is installed on the user computer 9000 and the user computer 9000 accesses the multimedia content service system 1000 through the web browser), a web server is required. Further, an exclusive program, such as Windows Media Player or GOM Player, capable of reproducing a multimedia content is installed on the user computer 9000 and the exclusive program downloads and reproduces the multimedia content through accessing the multimedia content service system 1000 or receives and reproduces streaming data of the multimedia content, a server capable of performing the data communication with the exclusive program is definitely required. When the user computer 9000 is a mobile terminal, such as a mobile phone, and provides a multimedia content in a third scheme (e.g. a scheme, such as a WAP scheme, optimized to other mobile terminal), it is apparent to those skilled in the art that a server corresponding to the third scheme is required. The description of the present invention is given based on the web scheme, but it is only for the convenience of description. Further, it is a matter of course that the web scheme is one example of the communication schemes and other wired/wireless internet/non-internet communication scheme can be applied to the present invention. Those skilled in the art is necessary to consider the fact that the multimedia content including an image is provided by a file download scheme through a web server, the multimedia content including a moving picture and music provided by a streaming scheme requires a streaming server, and the web server is conceptually discriminated from the streaming server, but actually can be simultaneously implemented in one server, and the multimedia content service server 1100 of the multimedia content service system 1000 can include the web server or the streaming server according to the function, so that the description of the servers are not discriminated according to each multimedia content file.

Meta Information of Multimedia Content

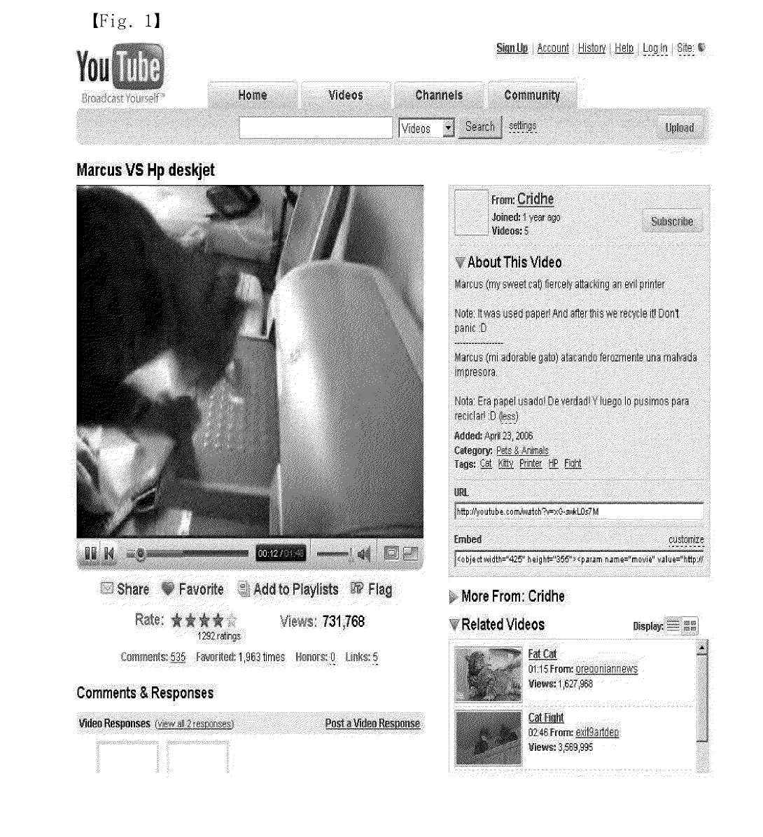

Meta information included in the multimedia content includes, serving as meta information related to contents of the multimedia content, includes at least one of an Identifier (ID), a title, a tag, a category (classification information), and explanation information of the multimedia content, and other processing information (e.g. commercial tag set information to be described later) of the multimedia content service system 1000. FIG. 1 represents an example of the meta information included in the multimedia content. The meta information of the multimedia content file includes at least one of a file size, a reproduction time, a file location, and an obtainment time of the multimedia content file, log information of the multimedia content file, such as a number of search times, a search time, etc. of the multimedia content file, the log information being generated based on the relation between the multimedia content file and the user, and a derived content, such as a reply of a user with respect to the multimedia content file. The meta information included in the multimedia content can be identified in Table 1. Table 1 is an example of the multimedia content DB 1110, which includes various meta information of the multimedia content.

TABLE 1

| | | | | File | | Reproduction |
|---|---|---|---|---|---|---|
| ID | Title | Tag | Category | route | Explanation | time |
| #1 | A ghost | Office | Movie & | . . . /Z74HJQY_t8Q | Experience | 1 min |
| | also | worker, | animation | | of | and 30 |
| | exists in a | Ghost, | | | one new | seconds |
| | printer. | Printer, | | | worker, | |
| | | New worker, | | | and | |
| | | Refill ink | | | there is | |
| | | | | | no ghost | |
| | | | | | anywhere . . . | |
| | | | | | Disappear | |
| | | | | | the | |
| | | | | | refill | |
| | | | | | ink | |
| #2 | Verbal | Kyung Jun | News & | . . . /7nCBiSaZeJA | Defender | 3 mins |
| | evidence | Kim, | politics | | “one | and 20 |
| | of Kyung | Jae Kyung | | | printer | seconds |
| | Jun Kim, | Choi, | | | in the | |
| | lawyer | Jae Won Oh, | | | BBK | |
| | | Myung Bak | | | office | |
| | | Lee, | | | is an | |
| | | BBK | | | ink-jet | |
| | | | | | printer”. | |
| | | | | | Prosecutor | |
| | | | | | “There | |
| | | | | | has been | |
| | | | | | no ink- | |
| | | | | | jet | |
| | | | | | printer | |
| | | | | | since | |
| | | | | | the | |
| | | | | | office | |
| | | | | | moved”. | |
| #3 | Authenticated | Refill ink, | Know-how | . . . /Kn0sA26X_YE | I have | 5 mins |
| | ink | Authenticated | & style | | recognized | and 10 |
| | VS | ink, | | | that | seconds |
| | Unlimited | Unlimited | | | the | |
| | ink | ink, | | | authenticated | |
| | | Printer, | | | ink is | |
| | | Multifunction | | | good . . . but | |
| | | apparatus | | | could | |
| | | | | | not | |
| | | | | | expect | |
| | | | | | such | |
| | | | | | difference | |

Although it is not represented in Table 1, at least one commercial tag to be described later can correspond to the multimedia content, and the commercial tag can be stored in the multimedia content DB 1110 in relation with the ID of the multimedia content. The screen related to a moving picture of FIG. 2 is corresponding to multimedia content ID#3 of Table 1.

When the multimedia content service system 1000 directly generates a multimedia content, the multimedia content service system 1000 writes the meta information. However, multimedia content producers provide (upload, file, or transfer) the multimedia content service system 1000 with a multimedia content, the producers may provide a title, a tag, explanation information, etc. of the multimedia content. Further, when the generator selects at least one category of his/her multimedia content according to a preset classification reference, information of the selected category can be included in meta information. Meanwhile, when the multimedia content service system 1000 allows users, other than the producers, to provide or add a title, a tag, explanation information, a category, etc. of the multimedia content provided by the generator, such a tag, explanation information, etc. can be included in the meta information. FIGS. 2, 4, 6, and 7 to 9 illustrate examples of the meta information.

Kinds of Multimedia Content

The multimedia content includes a moving picture multimedia content based on moving pictures, an image multimedia content based on images, a sound multimedia content based on sounds, a text multimedia content based on texts, and other multimedia contents including at least one of the texts, images, sounds, and moving pictures. The present invention describes the spirit of the present invention based on the moving picture multimedia content, but it is obvious that the spirit of the present invention is not limited to the moving picture multimedia content. The conventional method of providing the moving picture multimedia content includes a method of transmitting, by a server, a moving picture multimedia content file to the user computer 9000 in the streaming scheme, etc., and a method of transmitting the moving picture multimedia content file to the user computer as it is. Both methods are identically applied to a sound multimedia content. The spirit of the present invention has been described based on the first method, but can be applied to the latter method.

With regard to this, in order to transmit the moving picture multimedia content file in the streaming scheme, etc., the multimedia content service server 1100 may include a multimedia content transmission module 1120. Conventionally, with respect to the image multimedia content file, the multimedia content service server 1100 transmits the image multimedia content file itself to the user computer 9000 without consideration of the concept of the reproduction. However, in this case, there are many cases in which a file format of the image multimedia content file generated by a multimedia content generator cannot be visually displayed on the user computer 9000, so that the multimedia content service server 1100 may generally convert the image multimedia content file generated by the multimedia content generator to a file format capable of being visually displayed on a typical browser. The conversion may be applied to the moving picture multimedia content or the sound multimedia content. Further, the multimedia content service server 1100 may generate a thumbnail image, etc. for the multimedia content file generated by the multimedia content generator and the thumbnail image, etc. may be outputted as a multimedia content search result for the user with respect to the multimedia content.

Meta Information Based Keyword Advertisement Server 6000

A meta information based keyword advertisement server 6000 of the present invention will be described with reference to FIG. 10 in more detail. The meta information based keyword advertisement server 6000 includes a meta information obtainment module 5100 for obtaining meta information of a multimedia content, a keyword advertisement control module 6900 for controlling a keyword advertisement, and a keyword advertisement display module 7900 for displaying an obtained keyword advertisement content in various methods.

Meta Information Obtainment Module 5100

The meta information obtainment module 5100 includes a tag information obtainment module 5110 for obtaining at least one text type tag information included in the multimedia content, a non-text information obtainment module 5120, and a non-tag text obtainment module 5130 for obtaining non-tag text information. Reproduction time information of a multimedia content is important for information obtained by the meta information obtainment module 5100. The non-tag text obtainment module 5130 obtains all text information, except for tag information, among the multimedia content information.

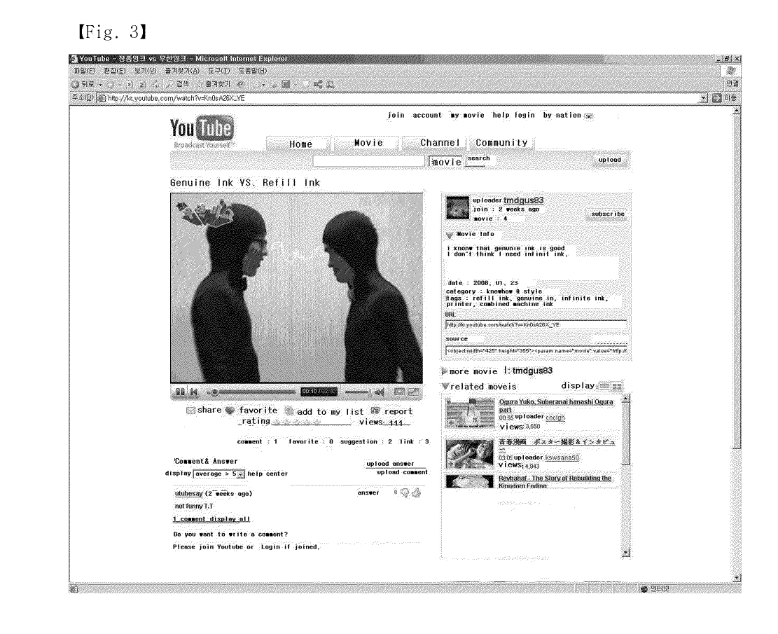

For example, referring to FIG. 3 and ID#3 of Table 1, tags of the multimedia content are “refill ink, authenticated ink, unlimited ink, printer, multifunction apparatus, and ink”. The tag information obtainment module 5110 of the meta information obtainment module 5100 receives “refill ink, authenticated ink, unlimited ink, printer, multifunction apparatus, and ink”. The non-tag text obtainment module 5130 obtains a title of a moving picture, “Authenticated ink VS unlimited ink”, and an explanation, “I have recognized that the authenticated ink is good . . . but did not know such difference”. At this time, when the tag information obtainment module 5110 obtains at least one tag information, the non-tag text obtainment module 5130 may not function. That is, the tag information obtainment module 5110 and the non-tag text obtainment module 5130 may simultaneously obtain the meta information. However, the tag information obtainment module 5110 first tries to obtain the meta information, and then when the tag information obtainment module 5110 obtains no information or information obtained by the tag information obtainment module 5110 does not satisfy a preset reference (whether to create a situation where it is impossible to generate a keyword advertisement target text with tag information obtained by the tag information obtainment module 5110), the non-tag text obtainment module 5130 is operated later.

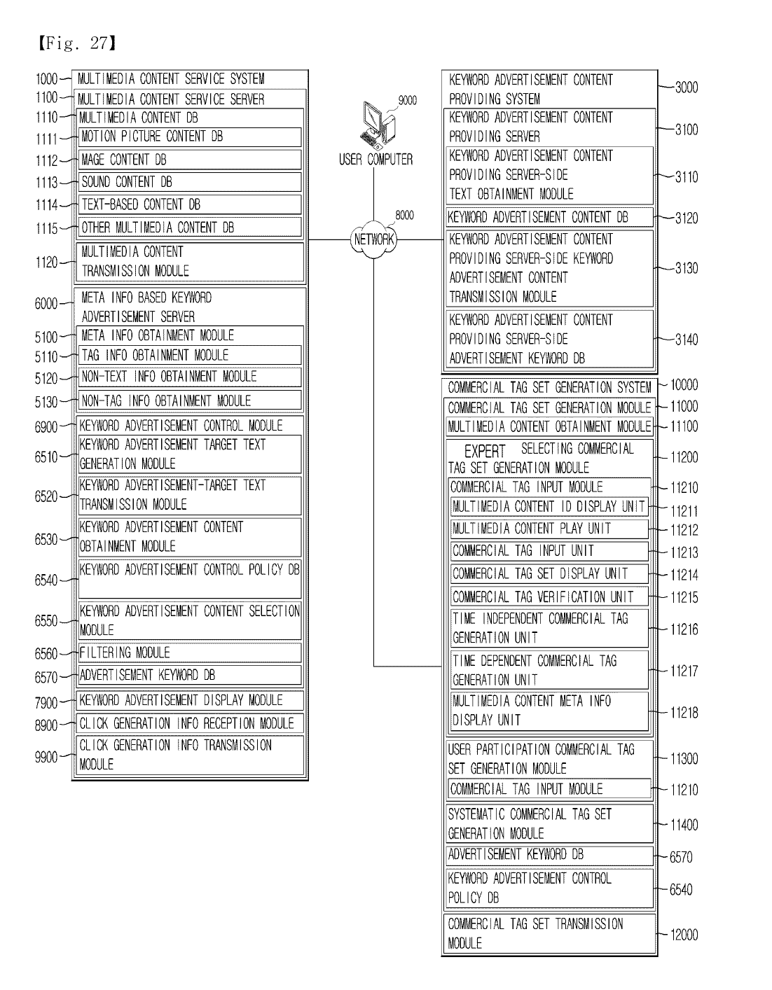

When there is a commercial tag, the tag information obtainment module 5110 can obtain the commercial tag as one kind of tag. A commercial tag set obtainment module 5140 professionally obtains the commercial tag and is aptly illustrated in FIG. 27. The commercial tag set obtainment module 5140 is a special type of the tag information obtainment module and is a subordinate conceptual module operated when a commercial tag exists. The functions performed by the commercial tag set obtainment module 5140 are included in those of the tag information obtainment module 5110, and tag information obtained by the tag information obtainment module 5110 may be commercial tag information. When a commercial tag set is included in moving picture information of the multimedia content DB, the tag information obtainment module 5110 and the commercial tag set obtainment module 5140 first obtain a commercial tag included in the commercial tag set before obtaining a conventional tag. Further, when both a time dependent commercial tag and a time independent commercial tag are included in the commercial tag set, the tag information obtainment module 5110 and the commercial tag set obtainment module 5140 synchronize a reproduction time of the moving picture to first obtain the time dependent commercial tag during the reproduction time, or first obtain the time independent commercial tag when the reproduction time is expired. Hereinafter, the methods of processing a commercial tag or information of a commercial tag set are identical or equivalent to each other, so that a repetitive description will be omitted. In the meantime, when a commercial tag is included, it is preferred that the tag information obtainment module 5110 first obtains the commercial tag than a tag inputted by a common user.

Obtainment of Meta Information Included in Selected Multimedia Content

When the multimedia content service server 1100 receives selection information for at least one multimedia content from the user computer 1100, the multimedia content service server 1100 obtains selection information for the multimedia content and/or meta information of the multimedia content from the multimedia content DB 1110 and transfers the meta information to the meta information based keyword advertisement server 6000. The meta information obtainment module of the meta information based keyword advertisement server 6000 receives meta information of the selected multimedia content. The meta information can be obtained by 1) a scheme in which the meta information based keyword advertisement server 6000 receives the meta information from the multimedia content service server 1100 or 2) a scheme in which the meta information based keyword advertisement server 6000 receives an ID of the selected multimedia content, inquires of the multimedia content DB 1110 with the ID of the multimedia content, and obtains the meta information.

When the meta information based keyword advertisement server 6000 easily accesses the multimedia content DB 1110 (the multimedia content DB 1110 is included in the same system or the server of the same businessman, or access and data reception/transmission is allowed in a specific way, such as the SOA or web service), the latter scheme 2) is preferable. However, the former scheme 1) can be fully considered because a quantity of data transmitted is small. When the meta information based keyword advertisement server 6000 cannot access the multimedia content DB 1110 due to a problem of security or data integrity, the former scheme 1) is preferable. The tag information obtainment module 5110 obtains tag information included in the meta information of the multimedia content.

At this time, when the tag information is not included in the multimedia content, the non-tag information obtainment module 5130 obtains text information from the meta information and processes the obtained text information. The non-tag information obtainment module 5130 selectively obtains text information from the meta information regardless of the existence of the tag information of the multimedia content. The non-tag information obtainment module 5130 will be described later in detail.

Keyword Advertisement Control Module 6900

The keyword advertisement control module 6900 generates an advertisement target text with meta information obtained from the meta information obtainment module, inquires of the keyword advertisement content providing server 3100 about the advertisement target text, receives a keyword advertisement content from the keyword advertisement content providing server 3100 in a direct manner or via a third server, processes the keyword advertisement content, and displays the keyword advertisement content on the user computer 9000.

Construction of Keyword Advertisement Control Module 6900

The keyword advertisement control module 6900 includes a keyword advertisement target text generation module 6510 for generating an advertisement target text with meta information of the obtained multimedia content, a keyword advertisement target text transmission module for transmitting the keyword advertisement target text to the keyword advertisement content providing server 3100, a keyword advertisement control policy DB 6540 storing a policy for operating the keyword advertisement control module 6900, a keyword advertisement content obtainment module 6530 for receiving a keyword advertisement content from the keyword advertisement content providing server 3100, and a keyword advertisement content selection module 6550 for selecting a keyword advertisement content to be displayed on the user computer 9000 among the obtained keyword advertisement contents. The keyword advertisement control module 6900 receives meta information obtained by the meta information obtainment module 5100. When the keyword advertisement control module 6900 includes the tag obtained by the tag information obtainment module 5110, the keyword advertisement control module 6900 grants a code to n tags (herein, n is a natural number) and stores the n tags. For example, when the keyword advertisement control module 6900 includes six tags, “refill ink, authenticated ink, unlimited ink, printer, multifunction apparatus, and ink” obtained from a specific multimedia content, the keyword advertisement control module 6900 sequentially grants a code to the tags, tag 1, tag 2, . . . , and tag 6 and stores them.

Keyword Advertisement Target Text Generation Module 6510

The keyword advertisement target text generation module 6510 of the keyword advertisement target text control module 6900 generates a keyword advertisement target text with reference to the keyword advertisement control policy DB 6540. Under a keyword advertisement control policy of the keyword advertisement control policy DB 6540 in which only a tag obtained by the tag information obtainment module 5110 is generated as a keyword advertisement target text, the keyword advertisement target text generation module 6510 of the keyword advertisement target text control module 6900 generates a keyword advertisement target text only with the tag. Further, under a keyword advertisement control policy of the keyword advertisement control policy DB 6540 in which all of the tags are generated as keyword advertisement target texts, the keyword advertisement target text generation module 6510 of the keyword advertisement target text control module 6900 can generate keyword advertisement target texts with every tag information among the obtained meta information. In this case, the generation of the keyword advertisement target text is to make the tag obtained by the tag information obtainment module 5110 be a keyword advertisement target text. That is, the keyword advertisement target text generation module 6510 treats the tag obtained by the tag information obtainment module 5110 as a keyword advertisement target text without a separate processing. In the meantime, there may a case where the user partially uses a sentence, not a word, or several sequential nouns for a tag. Therefore, when the tag information obtained by the tag information obtainment module 5110 does not consist of only a noun, it is preferred that the keyword advertisement target text generation module 6510 extracts a noun by using a morpheme analyzer.

Therefore, this case is conceptually discriminated based on an information processing step, but the meta information obtained by the tag information obtainment module 5110 serves as a keyword advertisement target text as it is. Therefore, it can be understood that, based on the function, the meta information obtainment module 5100 (or the tag information obtainment module 5110) and the keyword advertisement target text generation module 6510 are the same module, the meta information obtainment module 5100 is included in the keyword advertisement target text generation module 6510, and the keyword advertisement target text generation module 6510 is included in the meta information obtainment module 5100. However, if the treatment of the meta information obtained by the meta information obtainment module 5100 (the tag information obtainment module 5110) as the keyword advertisement target text can be considered as one function of the keyword advertisement target text generation module 6510, the meta information obtainment module 5100 and the keyword advertisement target text generation module 6510 can be recognized as a functionally independent module, as well as a conceptually independent module. At this time, when the keyword advertisement target text generation module 6510 selects at least one among the obtained n tags or changes a sequence of the tag, the meta information obtainment module 5100 and the keyword advertisement target text generation module 6510 may be different modules.

In the meantime, at least one keyword advertisement target text generated by the keyword advertisement target text generation module 6510 in relation to a specific moving picture content (by using an ID of the moving picture content as a key value) is stored in the moving picture content DB 1111, at least one keyword advertisement target text generated by the keyword advertisement target text generation module 6510 in relation to a specific image content (by using an ID of the image content as a key value) is stored in the image content DB 1112, and at least one keyword advertisement target text generated by the keyword advertisement target text generation module 6510 in relation to a specific sound content (by using an ID of the sound content as a key value) is stored in the sound content DB 1113. Further, it is preferred that at least one commercial tag set generated by a commercial tag set generation system 10000 of the present invention in relation to a specific moving picture content (by using an ID of the moving picture content as a key value) is stored in the moving picture content DB 1111, at least one commercial tag set generated by a commercial tag set generation system 10000 of the present invention in relation to a specific image content (by using an ID of the image content as a key value) is stored in the image content DB 1112, and at least one commercial tag set generated by a commercial tag set generation system 10000 of the present invention in relation to a specific sound content (by using an ID of the sound content as a key value) is stored in the sound content DB 1113. That is, it is preferable to store the generated keyword advertisement target text or commercial tag set corresponding to a specific multimedia content together with the multimedia content or in relation to the multimedia content. The keyword advertisement target text and/or the commercial tag set corresponding to a specific multimedia content are one kind of meta information of the multimedia content. Commercial tags constituting the keyword advertisement target text and the commercial tag set can be rightly used for the calling of the keyword advertisement content. Therefore, when a keyword advertisement target text or a commercial tag set stored in relation to a specific multimedia content is included in the DB, in order to obtain a keyword advertisement content, the keyword advertisement control module 6900 controls the keyword advertisement target text transmission module so as to transmit the stored keyword advertisement target text or commercial tag set to a preset system or sever.

The keyword advertisement target text generation module 6510 divides the obtained n tags into at least two groups. For example, when the keyword advertisement target text generation module 6510 selects all of six tags information, “refill ink, authenticated ink, unlimited ink, printer, multifunction apparatus, and ink”, the keyword advertisement target text generation module 6510 divides the six tags into 3 groups, in which one group includes “refill ink, authenticated ink, unlimited ink, and ink” including “ink” among the six tags, another group includes the “printer”, and the other group includes the “multifunction apparatus”, and transmits the tags in the unit of a group.

However, when the number of tags is equal to or less than a preset number, e.g. two or three, the keyword advertisement target text generation module 6510 groups the tags into one group to process the tags regardless of the relation, etc.

There are several policies for grouping the tags, among which one policy is to collect the tags including a common word/phrase/vocabulary and another policy is to group the tags with reference to a thesaurus DB, a WordNet DB, or other synonym/related terms dictionary DB.

Further, the keyword advertisement target text generation module 6510 can generate concurrent tag groups including concurrent tags which are concurrent with each other through an association analysis of entire tag information of text sources of other newspaper/magazine, which have been processed through a morpheme analysis processing, based on co-occurrence. Further, the keyword advertisement target text generation module 6510 may determine a total number of concurrent tag groups and elements to be included in the concurrent tag groups by a support value and a confidence value. The association analysis method is typical data mining technology, so that its detailed description will be omitted. That is, in a case where there are a very large number of tag groups, there is a tag string (including a commercial tag, in which the commercial tag may be separately treated from a conventional tag) corresponding to a specific multimedia content, and there is a tag group to which the tags constituting the tag string commonly belong, the tags having the commonness can be generated in one group.

The former policy has been above described. According to the latter policy, the keyword advertisement target text transmission module 6520 inquires of the thesaurus DB or other synonym/related terms dictionary DB about the “printer” and “multifunction apparatus” and determines that the “printer” and “multifunction apparatus” are of the same kind, the “printer” and “multifunction apparatus” can be grouped in a “printer and multifunction apparatus” group.

The grouping has the advantages of 1) showing advertisements related to a single concept/same kind to a user at one time, 2) easily replacing an advertisement when there is no click for an advertisement exposed to the user, 3) providing various advertisements corresponding to the tags included in the group when a click for one group is generated, etc. That is, when a keyword advertisement content among m keyword advertisement contents provided by the keyword advertisement content providing server 3100 is in the higher rank, its advertisement unit price is higher and its click rate is higher in comparison with the exposure, so that it further contributes to the generation of the advertisement gains. At this time, in relation to the advantage 1) when the keyword advertisement content providing server 3100 groups the “refill ink, authenticated ink, unlimited ink, and ink” and processes it at one time, the keyword advertisement content providing server 3100 can select a higher keyword advertisement content having a higher average advertisement unit price or a higher click rate in comparison with the exposure in correspondence with the four keyword advertisement target texts. With regard to the advantage 2) when a user is not interested in an advertisement of the ink, it is necessary to replace a keyword advertisement content. When an action, such as a click for a keyword advertisement content has not been generated for a predetermined time after the exposure of the keyword advertisement content, it is necessary to provide a keyword advertisement content included in the second group. At this time, if the group unit is not adopted, the keyword advertisement contents corresponding to the “refill ink, authenticated ink, unlimited ink, and ink” may be continuously provided to the user and there is the high possibility in that a click, etc. is not created in the keyword advertisement contents, so that the expectation of the generation of the advertisement gains is much more decreased. With regard to the advantage 3), when a user clicks a keyword advertisement content group m1 exposed to the user in relation to the “refill ink, authenticated ink, unlimited ink, and ink”, there is the high possibility in that the user is interested in the “ink”, so that the keyword advertisement content providing server 3100 provides the keyword advertisement contents corresponding to the “refill ink, authenticated ink, unlimited ink, and ink” through replacing the keyword advertisement content group m1 with a keyword advertisement content group m2, which has been exposed to fewer users, or rolling to the group m2. The average expected advertisement gains for the keyword advertisement content group m2 corresponding to the “refill ink, authenticated ink, unlimited ink, and ink” may be possible to be lower than those of the keyword advertisement content group m1. However, when a click is generated in the keyword advertisement content group m1, it can be guessed that the average expected advertisement gains in the keyword advertisement content group m2 related with the keyword advertisement content group m1 are higher than the tag, “multifunction apparatus” or “printer”. It is a matter of course that in the grouping of the tags, a group identifier, such as a group ID, can be further combined with the keyword advertisement target text. Whether a click is generated for the keyword advertisement content transmitted to the user is identified through a click generation information reception module 8900 or a click generation information transmission module 9900. At this time, whether to generate a keyword advertisement target text in the unit of the group follows the keyword advertisement control policy of the present invention, and the keyword advertisement control policy is stored in the keyword advertisement control policy DB 6540.

When the keyword advertisement target text generation module 6510 obtains a commercial tag, the keyword advertisement target text generation module 6510 may previously treat the commercial tag in comparison with a general tag. Especially, when a score function to be described later in relation to at least one commercial tag is higher or there is information passing a verification standard by a high difference in the generation of a commercial tag, the keyword advertisement target text generation module 6510 may grant higher weight to the commercial tag. Further, when there is duplication between the commercial tag and at least one of 1) general user input tag and 2) title information, the keyword advertisement target text generation module 6510 may grant higher priority or higher weight to the commercial tag, than other commercial tags.

Keyword Advertisement Target Text Transmission Module 6520

There are in general two schemes for inquiring of the keyword advertisement content providing server 3100 by the keyword advertisement target text transmission module 6520 of the keyword advertisement control module 6900 about the generated keyword advertisement target text. One scheme is an one time transmission scheme in which the keyword advertisement target text transmission module 6520 inquires the entire generated keyword advertisement target texts at one time, and the other scheme is a multiple group transmission scheme in which the keyword advertisement target text transmission module 6520 divides the entire generated keyword advertisement target texts into multiple groups and inquires the keyword advertisement target texts in the unit of the group. For example, the group unit inquiry transmission scheme is to transmit the generated keyword advertisement target texts one by one by the keyword advertisement target text transmission module 6520. At this time, when the keyword advertisement content providing server 3100 does not accept multiple keyword advertisement target texts, the keyword advertisement target text transmission module 6520 should adopt the scheme of the transmitting of the generated keyword advertisement target texts one by one in the latter scheme, instead of the former scheme.

When the keyword advertisement content providing server 3100 has a preset interface reference in a web service or SOA scheme or adopts a unique API (Application Programming Interface), the keyword advertisement control module 6900 processes a query including the keyword advertisement target text generated by the keyword advertisement target text generation module 6510 so that the query is adapted to the preset interface reference or a scheme according to the API. At this time, the received keyword advertisement content is preferably an XML scheme. The keyword advertisement target text transmission module 6520 of the keyword advertisement control module 6900 is necessary to include an address of a network 8000, which is to receive an IP or keyword advertisement content data of the meta information-based keyword advertisement server 6000, in query transmission request data to be transmitted to the keyword advertisement content providing server 3100. Especially, when the module is asynchronous or the reception/transmission modules have different addresses or are located in the different servers, the keyword advertisement target text transmission module 6520 of the keyword advertisement control module 6900 should include network information of the advertisement content obtainment module in query transmission request data. However, in the synchronous scheme, the keyword advertisement target text is transmitted and obtained in a state in which a client has been connected with a server, so that it is not necessary to include the IP or information, such as an address of a network in the query transmission request data. In this respect, the synchronous scheme is preferable because it is simpler than the asynchronous scheme.

At this time, the keyword advertisement target text transmission module 6520 of the keyword advertisement control module 6900 may further include the number of maximum requested keyword advertisement contents for each transmission unit based on a single or multiple keyword advertisement target texts constituting the transmission unit in the query transmission request data. When the keyword advertisement content providing server 3100 provides information, such as an advertisement unit price upon the click or exposure of a keyword advertisement content and/or an expected click rate in comparison with an exposure, it is more preferable to include the information in the query transmission request data. In the meantime, when the keyword advertisement content providing server 3100 separately processes multiple keyword advertisement target texts, matches each keyword advertisement target text with a keyword advertisement content, and transmits the matched keyword advertisement content, the meta information-based keyword advertisement server 6000 is more preferable to transmit multiple keyword advertisement target texts at one time, rather than to individually transmit the keyword advertisement target texts one by one to the keyword advertisement content providing server 3100.

Next, a method of obtaining a keyword advertisement content through an individual transmission and a group-based transmission according to a computer program will be described.

A code of transmitting a keyword advertisement target text by using the API or web service (including the SOA) interface provided from the keyword advertisement content providing system 3000 and receiving and processing the XML including the keyword advertisement content as a result is represented as the followings.

Variables are defined as the following:
API class provided from the keyword advertisement content providing system 3000: KeywordAdContentsService
Method of accessing a web service of the keyword advertisement content providing system 3000, transferring a keyword advertisement target text, and receiving the XML of a keyword advertisement content corresponding to the keyword advertisement target text: String sendRequest (String keyword advertisement target text, the maximum number of keyword advertisement contents desired to be received)

First, an information process of the one time transmission scheme (grouping the keyword advertisement target texts and once receiving and processing a keyword advertisement content list corresponding to the keyword advertisement target texts) will be described. The exemplary codes are first represented:

```
    1: String result =
KeywordAdContentsService.sendRequest(“refill ink,
authenticated ink, unlimited ink, printer, multifunction
apparatus, ink”, 3);
    2: XMLParserBean p = new XMLParserBean( );
    3: Collection<Element> v = p.parse(result);
    4: // advertisement content processing
```

Next, a line attached with a number will be described.

Line 1: Transmit all of the tags once through the sendRequest method and receive the keyword advertisement content corresponding to the tags. 3) in the end of the line 1 represents to request a maximum of three advertisement contents as a result. KeywordAdContentsService is one example of a name of the keyword advertisement content providing system-side web service.

The original text of the keyword advertisement content corresponding to “refill ink, authenticated ink, unlimited ink, printer, multifunction apparatus, and ink” received from KeywordAdContentsService, i.e. a string content stored in a variable, result, after performing line 1 is to follow. In the following code, ABC.com is one example of the keyword advertisement content providing system 3000 and 3100.

```
    <?XML version=“1.0” encoding=“UTF-8”?>
    <ResultSet XMLns:xsi=“http://www.w3.org/2001/XMLSchema-
instance” XMLns=“urn:ABC:search” xsi:schemaLocation=
“urn:ABC:searchhttp://api.search.ABC.com/WebSearchService/V1/
WebSearchResponse.xsd”type=“web” totalResultsAvailable=
“3060” totalResultsReturned=“3” firstResultPosition=“1”>
    <Result>
    <Title>::: specialized ink and toner, unlimited ink reliable
shopping mall&amp;gt;</Title>
    <Summary>authenticated ink. recycled ink. refill ink.
authenticated toner. recycled toner. color authenticated toner.
Toner for copy machine. toner for EPSON. Toner for HP. printer
bundle. Bulk ink. CD LABEL. Label for distribution administration.
Label for media. Label for barcode. Label for classification
indication... HP-C6280 multifunction apparatus+unlimited ink
\ 230,000. Samsung printer toner SCX-4725 ...</Summary>
    <Url>http://www.yesink.co.kr/</Url>
    <ClickUrl>http://uk.wrs.ABC.com/_ylt=
A0Je5hEj62pIw.4AOF3dmMwF;_ylu=X3oDMTB2cXVjNTM5BG
NvbG8DdwRsA1dTMQRwb3MDMQRzZWMDc3IEdnRpZAM-/SIG=
11c1aoupq/EXP=1215052963/**http%3A//www.yesink.co.kr/</ClickUrl>
    <DisplayUrl>www.yesink.co.kr/</DisplayUrl>
    <ModificationDate>1214377200</ModificationDate>
    <MimeType>text/html</MimeType>
    </Result>
    <Result>
    <Title> to be a leader of ink, toner, computing expendables,
and computer peripheral devices: leaders one:</Title>
    <Summary> search for printer model. HP Printer. Samsung Printer.
EPSON Printer. Canon Printer. Sambo Printer. Printer ink.
authenticated ink. recycled ink. unlimited ink. refill ink original.
Recharge refill kit. Recharge refill tools... C7280 multifunctional
apparatus +unlimited ink supplier set. 290,000 KRW. HP Photo Smart
C7280 multifunctional apparatus. 260,000 ...</Summary>
    <Url>http://leaders1.com/shop/goods/
goods_list.php?category=002003</Url>
    <ClickUrl>http://uk.wrs.ABC.com/_ylt=
A0Je5hEj62pIw.4AO13dmMwF;_ylu=X3oDMTB2ZjQ4dDEx
BGNvbG8DdwRsA1dTMQRwb3MDMgRzZWMDc3IEdnRpZAM-
/SIG=12jd9hm0a/EXP=1215052963/**http%3A//leaders1.com/shop/
goods/goods_list.php%3Fcategory=002003</ClickUrl>
    <DisplayUrl>leaders1.com/shop/goods/goods_list.php?category=
002003</DisplayUrl>
    <ModificationDate>1212476400</ModificationDate>
    <MimeType>text/html</MimeType>
    </Result>
    <Result>
    <Title>Meongmyeongi ::</Title>
    <Summary> one article corresponding to authenticated ink”. Leak
refill ink, recycled ink, unlimited ink. Leak refill ink, recycled
ink, unlimited ink. Leak refill ink, recycled ink, unlimited ink. In
the used printer or multifunctional apparatus ... TAG refill ink,
unlimited ink, recycled ink, authenticated ink. Non-classified
things : Trackback. : Comment. ...</Summary>
    <Url>http://www.mongmonge.co.kr/tag/63</Url>
    <ClickUrl>http://uk.wrs.ABC.com/_ylt=
A0Je5hEj62pIw.4APl3dmMwF;_ylu=X3oDMTB2M3MzdmZoBG
NvbG8DdwRsA1dTMQRwb3MDMwRzZWMDc3IEdnRpZAM-/SIG=
11lejfvu5/EXP=1215052963/**http%3A//www.mongmonge.co.kr/tag/
63</ClickUrl>
    <DisplayUrl>www.mongmonge.co.kr/tag/63</DisplayUrl>
    <ModificationDate>1214290800</ModificationDate>
    <MimeType>text/html</MimeType>
    </Result>
    </ResultSet>
```

Line 2: Generate an object in order to parse the keyword advertisement content formed in the XML

Line 3: Parse the keyword advertisement content and store the parsed keyword advertisement content in a variable, Collection

Line 4: Perform selection or filtering of the parsed keyword advertisement content stored in the variable, Collection, and then transmit the selected or filtered keyword advertisement content to the user computer

Group transmission scheme (collect and transmit the keyword advertisement target texts based on a group, and collect and process a list of each group-based keyword advertisement target texts)

```
      1: String result1 =
KeywordAdContentsService.sendRequest(“refill ink,
authenticated ink, unlimited ink, ink”, 3);
    2: XMLParserBean p1 = new XMLParserBean( );
    3: Collection<Element> v1 = p1.parse(result);
    4: // advertisement content process
    5: String result2 =
KeywordAdContentsService.sendRequest(“printer
multifunction apparatus”, 3);
    6: XMLParserBean p2 = new XMLParserBean( );
    7: Collection<Element> v2 = p2.parse(result);
    8: // advertisement content process
    9: // content process based on a group
```

Line 1: Collect and transmit tags of the ink group and receive a keyword advertisement content corresponding to the ink group

The original text of the keyword advertisement content corresponding to the group “refill ink, authenticated ink, unlimited ink, printer, multifunction apparatus, ink” received from KeywordAdContentsService, i.e. a string content stored in a variable, result1, after performing line 1 is to follow. A service provided from ABC.com is used.

```
    <?XML version=“1.0” encoding=“UTF-8”?>
    <ResultSet
XMLns:xsi=“http://www.w3.org/2001/XMLSchema-instance”
XMLns=“urn:ABC:search”
xsi:schemaLocation=“urn:ABC:search
http://api.search.ABC.com/WebSearchService/V1/
WebSearchResponse.xsd” type=“web” totalResultsAvailable=“4110”
totalResultsReturned=“3” firstResultPosition=“1”>
    <Result>
    <Title>To be a leader of an ink, toner, computing
expendables and computer peripheral devices: Leaders
one:</Title>
    <Summary>authenticated ink. recycled ink. unlimited
ink. refill ink original. recharge refill kit. recharge
refill tools. printer laser toner. authenticated toner.
recycled toner. paper. General paper. Photographic
paper. Memory. USB memory... black 100ml refill
ink(paints) Leaders one. 1,600 KRW. EPSON T073270 bluish
green unlimited ink ORIGINAL 100ML colors ...</Summary>
    <Url>http://www.leaders1.com/</Url>
    <ClickUrl>http://uk.wrs.ABC.com/_ylt=
A0Je5Ve27WpISkQB9BvdmMwF;_ylu=
X3oDMTB2cXVjNTM5BGNvbG8DdwRsA1dTMQRwb3MDMQRzZWMDc3IEdnRpZAM-
/SIG=11c0k7i0e/EXP=1215053622/**http%3A//www.leaders1.com/
</ClickUrl>
    <DisplayUrl>www.leaders1.com/</DisplayUrl>
    <ModificationDate>1213858800</ModificationDate>
    <MimeType>text/html</MimeType>
    </Result>
    <Result>
    <Title>::: ink, toner special, unlimited ink
reliable shopping mall &amp;gt;</Title>
    <Summary>authenticated ink. recycled ink. refill
ink. authenticated toner. recycled toner. color
authenticated toner. duplicator toner. Toner for Epson.
Toner for HP. Printer bundle. Bulk ink. CD label. Logics
label. Media label. Barcode label ... Canon black
authenticated ink PG-40. 20,000 KRW. HP laser toner HP-
Q7553A(3K) 80,000 KRW ...</Summary>
    <Url>http://www.yesink.co.kr/</Url>
    <ClickUrl>http://uk.wrs.ABC.com/_ylt=
A0Je5Ve27WpISkQB9xvdmMwF;_ylu=
X3oDMTB2ZjQ4dDExBGNvbG8DdwRsA1dTMQRwb3MDMgRzZWMDc3IEdnRpZAM-
/SIG=11cgpuro6/EXP=1215053622/**http%3A//www.yesink.co.kr/
</ClickUrl>
    <DisplayUrl>www.yesink.co.kr/</DisplayUrl>
    <ModificationDate>1214377200</ModificationDate>
    <MimeType>text/html</MimeType>
    </Result>
    <Result>
    <Title>ink, toner lowest price shopping mall ~
Welcome to Ink line.</Title>
    <Summary>authenticated ink. recycled ink. ink
bundle set. Refill kit. authenticated toner. recycled
toner. toner bundle set. authenticated toner. recycled
toner. toner bundle set. authenticated toner. Domestic
(compatible)toner. unlimited ink SET. unlimited ink
supplier... unlimited ink refill ink 6 colors set. Ink
line. 38,000 KRW. 380. number. Unlimited refill photo
ink. BJ1000 ...</Summary>
    <Url>http://goinkline.co.kr/shop/list.htm?c=740</Url>
    <ClickUrl>http://uk.wrs.ABC.com/_ylt=A0Je5Ve27WpISk
QB.hvdmMwF;_ylu=X3oDMTB2M3MzdmZoBGNvbG8DdwRsA1dTMQRwb3MD
MwRzZWMDc3IEdnRpZAM-
/SIG=12044bg2q/EXP=1215053622/**http%3A//goinkline.co.kr/
shop/list.htm%3Fc=740</ClickUrl>
    <DisplayUrl>goinkline.co.kr/shop/list.htm?c=740</DisplayUrl>
    <ModificationDate>1212822000</ModificationDate>
    <MimeType>text/html</MimeType>
    </Result>
    </ResultSet>
```

Line 2: Generate an object in order to parse the keyword advertisement content form in the XML

Line 3: Parse the keyword advertisement content and store the parsed keyword advertisement content in a variable, Collection

Line 4: Process the parsed keyword advertisement content stored in the variable, Collection

Lines 5 through 8: Search and process a keyword advertisement content corresponding to a printer group

The original text of the keyword advertisement content corresponding to the group “printer, multifunction apparatus” received from KeywordAdContentsService, i.e. a string content stored in a variable, result2, after performing line 5 is to follow.

```
    <?XML version=“1.0” encoding=“UTF-8”?>
    <ResultSet
XMLns:xsi=“http://www.w3.org/2001/XMLSchema-instance”
XMLns=“urn:ABC:search”
xsi:schemaLocation=“urn:ABC:search
http://api.search.ABC.com/WebSearchService/V1/
WebSearchResponse.xsd” type=“web” totalResultsAvailable=“3580000”
totalResultsReturned=“3” firstResultPosition=“1”>
    <Result>
    <Title>HP  printer  &amp;amp;  multifunctional
apparatus</Title>
    <Summary>HP provides all of the apparatuses and
expendables required for the capture, writing, copying
or transmission of a document or a picture to be
shared. ... printer &amp;amp; multifunctional apparatus.
PDA &amp;amp; calculator. monitor. scanner. digital
photography. Digital entertainment. storage. server.
Option, expendables &amp;amp; auxiliary devices.
networking. software product...</Summary>
    <Url>http://welcome.hp.com/country/kr/ko/prodserv/
printing_multifunction.html</Url>
    <ClickUrl>http://uk.wrs.ABC.com/_ylt=A0Je5hH37mpIm_{—}
AAfz3dmMwF;_ylu=X3oDMTB2cXVjNTM5BGNvbG8DdwRsA1dTMQRwb3MD
MQRzZWMDc3IEdnRpZAM-
/SIG=12semh12k/EXP=1215053943/**http%3A//welcome.hp.com/
country/kr/ko/prodserv/printing_multifunction.html</Click
Url>
    <DisplayUrl>welcome.hp.com/country/kr/ko/prodserv/
printing_multifunction.html</DisplayUrl>
    <ModificationDate>1213858800</ModificationDate>
    <MimeType>text/html</MimeType>
    </Result>
    <Result>
    <Title>printer/Digital multifunctional
apparatus/fax SAMSUNG</Title>
    <Summary>... printer ...  printer/Digital
multifunctional apparatus/fax. Ink-jet multifunctional
apparatus. SCX-1760. black and white laser printer. ML-
2450DK. color laser printer. CLP ... multifunctional
apparatus. CLX-8380ND. fax. CF-375TP. news. Samsung
printer prosumer ‘Prinity panel ’ 2^{nd} group starting.
Samsung printer, laser ...</Summary>
    <Url>http://www.samsung.com/sec/consumer/type/type.
do?group=printersmultifunction&amp;type=printersmultifunction
</Url>
    <ClickUrl>http://uk.wrs.ABC.com/_ylt=A0Je5hH37mpIm_{—}
AAgj3dmMwF;_ylu=X3oDMTB2ZjQ4dDExBGNvbG8DdwRsA1dTMQRwb3MD
MgRzZWMDc3IEdnRpZAM-
/SIG=13vdi272j/EXP=1215053943/**http%3A//www.samsung.com
/sec/consumer/type/type.do%3Fgroup=printersmultifunction
%26type=printersmultifunction</ClickUrl>
    <DisplayUrl>www.samsung.com/sec/consumer/type/
type.do?group=printersmultifunction&amp;type=pr...</DisplayUrl>
    <ModificationDate>1214809200</ModificationDate>
    <MimeType>text/html</MimeType>
    </Result>
    <Result>
    <Title> solution - printer/Digital multifunctional
apparatus/fax SAMSUNG</Title>
    <Summary> function of storing a font, a  format, a
management tool capable or remotely managing
multifunctional apparatus and the general printer ...
SyncThruTM Web Service is a built-in server capable of
controlling Samsung printer and multifunctional
apparatus through a network by using the web
browser...</Summary>
    <Url>http://www.samsung.com/sec/consumer/solutions/
type/solutionsList.do?group=printersmultifunction&amp;
type=printersmultifunction&amp;subtype=solutions&amp;
subsubtype=outputmanagement</Url>
    <ClickUrl>http://uk.wrs.ABC.com/_ylt=A0Je5hH37mpIm_{—}
AAhT3dmMwF;_ylu=X3oDMTB2M3MzdmZoBGNvbG8DdwRsA1dTMQRwb3MD
MwRzZWMDc3IEdnRpZAM-
/SIG=164k2usp9/EXP=1215053943/**http%3A//www.samsung.com
/sec/consumer/solutions/type/solutionsList.do%3Fgroup=
printersmultifunction%26type=printersmultifunction%26subtype=
solutions%26subsubtype=outputmanagement</ClickUrl>
    <DisplayUrl>www.samsung.com/sec/consumer/solutions/
type/solutionsList.do?group=printersmu...</DisplayUrl>
    <ModificationDate>1213686000</ModificationDate>
    <MimeType>text/html</MimeType>
    </Result>
    </ResultSet>
```

Line 9: Perform selection or filtering of the keyword advertisement content corresponding to two groups and then transmit the selected or filtered keyword advertisement content to the user computer

Through the aforementioned schemes, it is possible to obtain at least one keyword advertisement content corresponding to at least one keyword advertisement target text from the keyword advertisement content providing system 3000.

Keyword Advertisement Content Obtainment Module 6530

When the keyword advertisement content providing server 3100 receives at least one keyword advertisement target text from the keyword advertisement target text transmission module 6520 and has at least one keyword advertisement content corresponding to the keyword advertisement target text, the keyword advertisement content providing server 3100 transmits the keyword advertisement content to the meta information-based keyword advertisement server 6000 in a preset manner. However, when the keyword advertisement content providing server 3100 does not have a keyword advertisement content corresponding to the keyword advertisement target text, the keyword advertisement content providing server 3100 transmits information of the nonexistence of the keyword advertisement content to the meta information-based keyword advertisement server 6000 and the meta information-based keyword advertisement server 6000 may transmit another keyword advertisement target text to the keyword advertisement content providing server 3100. At this time, when the keyword advertisement content obtainment module 6530 of the keyword advertisement control module 6900 of the meta information-based keyword advertisement server 6000 receives at least one keyword advertisement content from the keyword advertisement content providing server 3100, the keyword advertisement content obtainment module 6530 grants a code to the received keyword advertisement content and stores the keyword advertisement content.

Keyword Advertisement Content Selection Module 6550

The keyword advertisement content selection module 6550 selects keyword advertisement contents from among the received keyword advertisement contents with reference to the keyword advertisement control policy DB 6540. At this time, when there is one keyword advertisement content, only one keyword advertisement content is selected. However, when there are multiple keyword advertisement contents, a policy for the selection of a keyword advertisement content is more important. For example, under a policy by which a maximum of three front keyword advertisement contents are sequentially selected from among the received multiple keyword advertisement contents, when the number of selected keyword advertisement contents is equal to or less than three, all of the three keyword advertisement contents are selected, and when the number of selected keyword advertisement contents is larger than three, the front three selected keyword advertisement contents are selected.

Asynchronous Keyword Advertisement Content Transmission

When the keyword advertisement content selected by the keyword advertisement content selection module 6550 is transmitted to the multimedia content service server 1100, the multimedia content service server 1100 transmits the keyword advertisement content to the user computer 9000. There are two methods for transmitting the multimedia content. The first method is to construct a web page including the selected keyword advertisement content to be provided to the user computer 9000 together with a multimedia content and transmit the web page to the user computer 9000 through a web server. At this time, it is preferred that the web page is divided into a multimedia content area and a keyword advertisement content display area, and the two areas are operated in an asynchronous scheme (not that the areas are united for control, but that the areas are individually controlled by a script, etc. provided from a server, respectively). The asynchronous scheme refers to a scheme in which the multimedia content area and the keyword advertisement content area constituting a single page are independently controlled (data transmission/reception, etc. such as a server provides a code, such as a script, etc., the code is operated and makes a request of information to the server, and the server transmits the information). The asynchronous scheme is advantageously useful in a case where it takes much time for obtaining a keyword advertisement content from the keyword advertisement content providing server 3100 and providing the obtained keyword advertisement content to the user computer 9000, in a case of rolling the keyword advertisement content, or in a case of controlling the display of the keyword advertisement content according to whether to obtain action information of a user. For example, when a user selects a multimedia content, information of the multimedia content is first provided to the user computer 9000, a code (program), such as a script, included in the previously provided information is operated. Then, when the code (program) makes a request of a keyword advertisement content to the multimedia content service server 110, the keyword advertisement content providing server 3000, or a server providing other keyword advertisement content, the multimedia content service server 110 or a server providing other keyword advertisement content transmits the keyword advertisement content and the code (program) displays the keyword advertisement content on the keyword advertisement content area. It is a matter of course that data of the multimedia content area and the keyword advertisement content area is transmitted in the synchronous scheme, and the keyword advertisement content information can be first transmitted. That is, according to the spirit of the present invention, it is essentially understood that information of the multimedia content area and information of the keyword advertisement content area maintain the strong relation in their content, and a providing sequence and a providing scheme of each area may be various. In another scheme (an information processing scheme other than a mobile phone or other web scheme), other than the web scheme, data provided to the user computer 9000 is generated according to another scheme. The second method is to first provide the user computer 9000 with a web page related to a multimedia content and then transmit a keyword advertisement content selected in the keyword advertisement content selection module 6550 to the web page maintaining the connection. The second method is more effective in a case where the obtainment of a keyword advertisement to be provided to the user is slow or where a keyword advertisement content is transmitted after the user has watched a multimedia content for a predetermined time. It is preferable to use the asynchronous communication in the second method, which has been described in the description of the first method.

The keyword advertisement content display module 7900 generates a code/program, such as a script, which controls a scheme of displaying a keyword advertisement content on a browser, etc. of the user computer, with reference to the keyword advertisement control policy DB 6540 and includes the generated code (program) in information to be transmitted to the user computer, so that the code (program) displays a keyword advertisement on the user computer in a preset manner.

Conventionally, the server cannot directly control a web browser of the user computer, and a code (program), such as a script, etc. included in information transmitted to the browser or a program, such as a plug-in installed and executed in the user computer controls information represented on the user computer. When the web browser requests any page and receives a result in response to the request, the connection is interrupted, and there is difficulty in that the server has stored an address of the web browser of the user computer (client) 9000 and the web browser is connected later. That is, the client can be connected with the web browser only through the server, and after the web browser is once connected with the client, requests a page, and receives the response, the connection is interrupted. In this case, after the web browser receives the web page, the web browser requests and receives an advertisement content in the asynchronous scheme, such as the AJAX.

In the meantime, when it takes a short time from the request to the obtainment of the keyword advertisement content, it may be possible to adopt a method in which the keyword advertisement contents are obtained and inserted to the web page, and then displayed at one time, or a method in which the keyword advertisement contents are inserted and transmitted in a hidden type, and the keyword advertisement contents are periodically rolled on the user computer by a script included in the web page in the web browser. However, when it takes a long time from the request to the obtainment of the keyword advertisement content, it is a preferable method in which, after the web page is transmitted to the user computer without the keyword advertisement content, the script included in the web page once makes a request of the entire keyword advertisement contents to the keyword advertisement content providing server 3100 in the asynchronous scheme, such as the AJAX, or periodically makes a request of the continuous keyword advertisement content, so that the keyword advertisement content is displayed on the keyword advertisement display area 100 of the web page. Since the long time for the obtainment of the keyword advertisement content delays the loading of the multimedia content web page on the web browser of the user computer as long as the waiting time, the obtainment time of the keyword advertisement content serves as the reference for the method selection. In order to prevent the delay of the loading of the multimedia content web page, it is preferred that the web page is first transmitted without the keyword advertisement content and displayed, then the code (program) makes a request of the keyword advertisement content in the asynchronous scheme, and then the requested keyword advertisement content is displayed.

The multimedia content service server 1100 has stored additional keyword advertisement content in an area, such as a session or the DB, and when the script controlling the keyword advertisement display area 100 additionally requests the keyword advertisement content, the multimedia content service server 1100 can transmit the requested keyword advertisement content to the web browser of the user computer.

Keyword Advertisement Control Policy DB

Hereinafter, the keyword advertisement control policy and the keyword advertisement control policy DB 6540 will be described in more detail. The keyword advertisement control policy includes the following information and a circumstance and a method of processing the information by the meta information-based keyword advertisement server will also be described.

Keyword Advertisement Target Text Generation Reference Scope Policy Information

The first keyword advertisement content control policy is the keyword advertisement target text generation reference scope policy for determining whether to use only information obtained by the tag information obtainment module 5110 for information necessary for the generation of the keyword advertisement target text, or whether to use information obtained by the non-tag text obtainment module 5130 as well as the tag information obtainment module 5110. Variables included in the first policy information includes at least one of 1) the existence of a tag, 2) the number of tags, 3) the number of keyword advertisement contents based on a tag, 4) the total number of keyword advertisement contents, and 5) a reproduction time of a multimedia content. For example, when the number of tags is one, when there are many tags, but the number of keyword advertisement contents provided from the keyword advertisement content providing server 3100 in correspondence to the tags is none or less than a preset reference number, or when the number of keyword advertisement contents is small (e.g. three), but the reproduction time of the multimedia content is long, it may be necessary to generate an additional keyword advertisement target text in addition to the tag information. With regard to this, the

meta information-based keyword advertisement server 6000 obtains tag information corresponding to meta information included in a multimedia content included in the multimedia content service server 1100, and when the tag information is included, the meta information-based keyword advertisement server 6000 inquires the maximum number of keyword advertisement contents, which the meta information-based keyword advertisement server 6000 can obtain in correspondence with the tag information, in any one between the one time transmission scheme and the multiple groups transmission scheme. As a result of the inquiry, when the maximum number does not satisfy a preset condition, the meta information-based keyword advertisement server 6000 instructs the operation of the non-tag text obtainment module 5130. The operation of the non-tag text obtainment module 5130 will be described later. The preset condition includes 1) the absolute number of keyword advertisement contents, 2) the absolute number of keyword advertisement contents in comparison with a reproduction time of a multimedia content, 3) when information of advertisement costs for the keyword advertisement content is included in the keyword advertisement content, an absolute price of advertisement costs based on the keyword advertisement content, and 4) a click rate based on each of the keyword advertisement contents (wherein, interaction information, such as a click, of the user for the keyword advertisement content transmitted from the user computer 9000 is commonly named as a click, and the term of click does not exclude another interaction). That is, though the number of keyword advertisement contents is equal to or larger than a reference number, when the advertisement costs and/or the click rate for each keyword advertisement content is less than a preset reference and an expected advertisement earning rate is less than a reference value so that other keyword advertisement contents are required, it is necessary to generate additional keyword advertisement target text through the operation of the non-tag text obtainment module 5130 and obtain more keyword advertisement contents by the generated keyword advertisement target text. The keyword advertisement control policy includes information on various branch conditions, variables, references, equations, etc., and the branch conditions, variables, references, equations, etc. include the fluctuation possibility and can be stored as any one form of contents of a keyword advertisement control policy DB, a rule engine to be described later, a keyword advertisement control policy included in a rule engine, or rules of a rule engine. Further, the branch condition is, for example, 1) whether to include a keyword advertisement content, 2) whether to generate a click of a keyword advertisement content, 3) whether to group a keyword advertisement content. When the keyword advertisement content corresponding to a keyword advertisement target text obtained by the tag information obtainment module 5110 is not included in the keyword advertisement content providing server 3100, the non-tag text obtainment module 5130 is necessary to extract a text and make a request of a keyword advertisement content to the keyword advertisement content providing server 3100. A time included in a code (program), such as a script, included in web page information transmitted to the user computer can check a time and/or whether to generate a click for a specific keyword advertisement content or any one of keyword advertisement contents transmitted at a specific time. When the click has not been generated in a specific keyword advertisement group or a click for a keyword advertisement content corresponding to a keyword advertisement target text based on the tag information obtainment module 5110 has not been generated during a preset time (for example, a fixed time, such as 10 seconds or 30 seconds, a flexible time, such as 15% based on a reproduction time of a multimedia content), the code (program), such as the script, may make a request of keyword advertisement content included in another group to a server providing keyword advertisement contents, such as the multimedia content service server 1100. However, when the multimedia content service server 1100 does not include the keyword advertisement content based on the tag information any more, the multimedia content service server 1100 may provide the user computer 9000 with a keyword advertisement content according to the non-tag text obtainment module 5130. Typically, the server has difficulty to access the user computer because the web browser cannot receive the connection from an outside server, and a program, other than the web browser, has a firewall function included in most of the PCs according to the increase in attacks by virus or spyware so that it prohibits an outside server from accessing the user computer.

In order to realize the policy, it is possible to use a solution program, such as a rule engine. The rule engine sets rules defining a calculation method or a branch condition with respect to various input conditions, and when an input is generated, the rule engine calculates the input and returns a result. A part or entity of the keyword advertisement policy DB 6540 can be implemented through the rule engine.

Weight Policy Information

The second keyword advertisement content control policy is the weight policy. The multimedia content producers input or generate multiple tags, titles, and/or explanation information related to their multimedia contents as meta information so as for their multimedia contents to be easily searched and aptly explained. The tags are strongly related with the multimedia contents, but it is difficult to say that all of the multiple tags have the same weight with respect to the multiple contents. One of the reasons why a search keyword advertisement is more effective than a banner advertisement is the strong relation between a matter of interest (search word) of the user with an advertisement. From a commonsense standpoint, it is considered that the foremost tag represents the best multimedia content and a keyword advertisement target text, not a tag, extracted from title information, better represents a content of the multimedia content than that extracted from explanation information. Further, it can be considered that a keyword advertisement target text represented in both a title and a tag represents the best multimedia content. Therefore, the weight policy requires a reference for 1) the source of a text subject to a keyword advertisement target text, 2) a sequence of tags, 3) the number of keyword advertisement contents based on each keyword advertisement target text, and 4) expected gains of keyword advertisement content based on each keyword advertisement target text. The expected gains may include various gains, such as gains based on each exposure and gains based on each click, under the advertisement costs generation condition, and the gains based on each keyword advertisement content is a function in relation to a unit price based on each keyword advertisement content, whether to achieve the advertisement costs generation condition (exposure, click, etc.) Therefore, the keyword advertisement target text generation module 6510 of the meta information-based keyword advertisement server can generate a keyword advertisement target text with reference to the weight policy from a generation step of a keyword advertisement target text.

In the weight policy, for example, 1) when the source of the text subject to the keyword advertisement target text is i) a tag, the weight of which is 5, ii) a title, the weight of which is 3 or 8, iii) an explanation, the weight of which is 1, and iv) a category, the weight is 0.5. Further, the weight policy according to 2) the tag sequence includes, for example, i) granting of the same weight to every tag and ii) inputting a tag sequence in an independent variable (x) of a function based on a preset continuously or by-stages decreasing function, such as y=1/x and adopting of a calculated function value as a weight. When there are six tags and a function of y=1/x is used, weight of other tags except for the foremost tag, “refill ink”, is (1/1)*{1/(1/1+1/2+1/3+1/4+1/5+1/6)}. The weight model can be applied to the tag group. For example, a method of granting weight to the group includes a method of applying the i) method and ii) method to each group or a method of applying the ii) method, in which the number of tags included in the group is reflected in the weight of the group. Further, the weight policy according to 3) the number of keyword advertisement contents based on each keyword advertisement target text, for example, includes i) granting of the same weight, and ii) processing of the weight by y=f(x), wherein x is the number of keyword advertisement contents. Further, the weight policy according to 4) the expected gains of keyword advertisement content based on each keyword advertisement target text, for example, includes granting of weight according to expected gains of a keyword advertisement content. The expected gains of a keyword advertisement content are determined by a preset function, in which various variables of an advertisement gains generation possibility degree, such as a unit price of a keyword advertisement content, an advertisement costs division rate, and a click rate in comparison with exposures, are combined.

The meta information-based keyword advertisement server 6000 generates as many keyword advertisement target texts as possible and enables the keyword advertisement content selection module 6550 to select a keyword advertisement content to be provided to the user computer 9000 among the obtained keyword advertisement contents corresponding to each of the keyword advertisement target texts, while maintaining source information (tag, title, and/or explanation) of the generated keyword advertisement target texts. At this time, the keyword advertisement content selection module 6550 can select a predetermined number of keyword advertisement contents with reference to the weight policy information.

Keyword Advertisement Content Transmission Scheme Policy Information

The third keyword advertisement content control policy is the keyword advertisement content transmission scheme policy for determining how the meta information-based keyword advertisement server 6000 transmits the obtained keyword advertisement content to the user computer 9000. The keyword advertisement content transmission scheme policy includes 1) a policy on the number of advertisement contents and an advertising scope of a keyword advertisement content to be transmitted once, 2) a policy on renewal permission of the transmitted keyword advertisement content, 3) a policy on a renewal reference upon the renewal permission, and 4) a policy on maintenance of the transmitted keyword advertisement content.

Policy on the Number of Keyword Advertisement Contents for One Time Transmission

With regard to the number of keyword advertisement contents for one time transmission, three to five keyword advertisement contents can be exposed on an environment, e.g. a web screen operated in a PC screen, exposing a keyword advertisement content, but one and two keyword advertisement contents are appropriate for a small screen, such as a screen of a mobile phone. Further, the keyword advertisement control policy includes a policy that all information (advertisement title, advertisement explanation, URL to move upon the click, etc.) of the transmitted keyword advertisement content is exposed on the PC screen, but partial information among the advertisement title or advertisement explanation is provided to a screen of a mobile phone. At this time, when there is information (especially, size information and resolution information of a display) on the user computer 9000 accessing the multimedia content service server 1100, it requires a policy determining the number of keyword advertisement contents provided up to which advertisement range based on the information of the user computer 9000. In the meantime, the multimedia content service server 1100 can provide the same or equivalent multimedia content in a different resolution according to the user computer 9000 environment (PC or mobile phone). At this time, the meta information based keyword advertisement server obtains information on the user computer 9000 environment or information related to the computer from the multimedia content service server 1100, inquires of the keyword advertisement control policy about the obtained information, and provides the user computer 9000 with the optimum number of keyword advertisement contents and the keyword advertisement contents of the optimum advertisement scope. At this time, it is preferred that when the keyword advertisement contents are transmitted once and the keyword advertisement content is clicked, the clicked keyword advertisement content is replaced with another keyword advertisement content. This is appropriate for the keyword advertisement content transmission scheme in a mobile phone or a computer having a small display. In the meantime, the meta information based keyword advertisement server can obtain information of the user computer, such as resolution of a monitor, OS, and version, by the Java script, etc., so that when the meta information based keyword advertisement server transmits such information to a server, the server can be aware of the information. Therefore, when the resolution of the monitor is included with a preset range, the server can change the number of keyword advertisement contents to be transmitted once.

Keyword Advertisement Content Renewal Permission Policy

The keyword advertisement content renewal permission policy includes a policy regarding whether to permit the keyword advertisement content renewal, which replaces the first transmitted keyword advertisement content with another keyword advertisement content during the reproduction of the multimedia content, a policy regarding the condition by which the keyword advertisement content renewal is permitted, and a policy regarding the condition by which the transmitted keyword advertisement content renewal is maintained. When the first group including at least one keyword advertisement content is has been transmitted, the first transmitted keyword advertisement content may not be replaced with keyword advertisement contents of another group during the reproduction of the multimedia content, but may be totally replaced with prepared groups of the keyword advertisement contents in a unit of a preset time. At this time, the keyword advertisement content renewal permission policy based on a preset time unit includes, when it is assumed that the total reproduction time is T and the number of prepared keyword advertisement content groups is n, 1) a policy of, exposing each of the keyword advertisement content groups for the T/n time, and 2) a policy of exposing a keyword advertisement content group having the high weight for a time longer than T/n and exposing a keyword advertisement content group having the low weight for a time shorter than T/n. however, the minimum exposure time t of the keyword advertisement content is determined, the policies 1) and 2) are applied in a case where T/n is larger than t. However, when T/n is smaller than t, it is preferred that the minimum exposure time of the keyword advertisement content is t or T (where t>T). When the click generation information of the user for the specific keyword advertisement content has not been obtained from the user computer 9000, the multimedia content service server 1100 can change the content of the keyword advertisement content, which is to be transmitted to the user computer 9000, to keyword advertisement contents of another group after a preset time unit passes. At this time, the exposure time of the specific keyword advertisement content group, etc. and whether to generate the click can be a content of the keyword advertisement control policy with respect to the change reference. When the click generation information of the user for the specific keyword advertisement content has been obtained from the user computer 9000, the multimedia content service server 1100 can raise the weight of a keyword advertisement content related to a keyword advertisement content corresponding to the obtained click information. With regard to this, it is preferred that the exposure time of the keyword advertisement content related to the keyword advertisement content having the high weight is longer than the exposure of a keyword advertisement content related to a keyword advertisement content of which the click has not been generated. In the meantime, when the multimedia content consists of an image, the reproduction time T of the image multimedia content is 1) a time from the response to the specific image multimedia content to the user computer 9000 and the obtainment of selection information of additional image multimedia content from the user computer 9000, or 2) a time for maintaining a page of the specific image multimedia content in the user computer 9000. That is, during the maintaining of the page of the specific image multimedia content in the user computer 9000, the multimedia content service server 1100 can additionally transmit at least one keyword advertisement content to the keyword advertisement content area or renew the keyword advertisement content.

In the meantime, when the meta information based keyword advertisement server 6000 obtains the user click generation for the specific keyword advertisement content from the user computer 9000, the keyword advertisement control policy includes a policy regarding the selection between 1) maintaining a keyword advertisement content group to which the keyword advertisement content corresponding to the click generation belongs, and 2) changing of a content of a keyword advertisement content to be provided to the user, such as the replacing of the keyword advertisement content of the keyword advertisement content group to which the keyword advertisement content corresponding to the click generation belongs with keyword content group of another keyword advertisement content group. Even though the maintaining 1) has been adopted, when the meta information based keyword advertisement server 6000 does not obtain the click information of another keyword advertisement content of the keyword advertisement content group including the keyword advertisement content of which the click generation has been generated for a preset time, a policy of replacing the keyword advertisement content to a keyword advertisement content of another keyword advertisement content can be a keyword advertisement control policy. Further, the keyword advertisement control policy may include a policy of, when the maintaining 1) has been adopted and a click of at least one keyword advertisement content is generated, replacing only the keyword advertisement content corresponding to the click generation with another keyword advertisement content, or displaying only a title of the keyword advertisement content, or arranging the keyword advertisement content including only the title on the bottommost area or a corner of the keyword advertisement content area. Further, the keyword advertisement control policy may include a policy regarding selection between, when the changing 2) of the keyword advertisement content group has been adopted, i) selecting, by the keyword advertisement content selection module 6550, a next keyword advertisement content group regardless of the meta information of the keyword advertisement content corresponding to the click generation and ii) processing the meta information of the keyword advertisement content corresponding to the click generation and selecting a keyword advertisement content highly related with the meta information.

When the click of the specific keyword advertisement content is generated, the user may be very interested in the keyword advertisement content so that there is a high possibility in that the user clicks another keyword advertisement content having the high relation with the keyword advertisement content. Therefore, the keyword advertisement content selection module 6550 discriminates a keyword advertisement target text corresponding to the keyword advertisement content corresponding to the user click generation, selects a keyword advertisement content related to the discriminated keyword advertisement target text, and renews the keyword advertisement content transmitted to the user with the selected keyword advertisement content. For example, when the meta information-based keyword advertisement server 6000 obtains 10 keyword advertisement contents from the keyword advertisement content providing server 3100 for each of two tags “refill ink and authenticated ink”, divides each three keyword advertisement contents into a group, and alternately transmits the keyword advertisement content of the “refill ink” and the keyword advertisement content of the “authenticated ink” to the user computer 9000, and the user clicks any one of the keyword advertisement contents included in the second group of the “refill ink”, the meta information-based keyword advertisement server 6000 can transmit a keyword advertisement contents included in the third group of the “refill ink” in a next time, not in the keyword advertisement content group of the “authenticated ink”. At this time, in order to discriminate when the click of the click generation information is based on the keyword advertisement target text of the “refill ink” or “authenticated ink” by the keyword advertisement content selection module 6550, the meta information-based keyword advertisement server 6000 should match a keyword advertisement target text with each of keyword advertisement contents and store the keyword advertisement contents. For the matching, the meta information-based keyword advertisement server 6000 can match a keyword advertisement target text ID to a keyword advertisement content ID obtained from each of the keyword advertisement target texts.

In order to recognize which keyword advertisement garget text is related to the click generation information, it is preferred that the meta information-based keyword advertisement server 6000 inquires of the keyword advertisement content providing server 3100 about the obtained multiple tags or keyword advertisement target texts one by one, and maps the keyword advertisement content obtained based on each tag or keyword advertisement target text to the tag or keyword advertisement target text, and stores the keyword advertisement contents. Meanwhile, when multiple tags or keyword advertisement target texts are transmitted at one time, but the keyword advertisement content providing server 3100 does not combine and process each of the tags or keyword advertisement target texts, but generates a keyword advertisement content based on each tag or keyword advertisement target text and transmits the generated keyword advertisement content to the meta information-based keyword advertisement server 6000, the meta information-based keyword advertisement server 6000 can map and store the keyword advertisement content based on each tag or keyword advertisement target text. It is preferred that the meta information-based keyword advertisement server 6000 maintains order information or weight information of the tag or keyword advertisement target text in any method of this paragraph.

The meta information-based keyword advertisement server 6000 adds click-related meta information to content information and meta information of the obtained keyword advertisement content, generates a keyword advertisement content further including the click-related meta information, and transmits the generated keyword advertisement content to the user computer 9000. The content information of the keyword advertisement content includes at least one of an advertisement title, an advertisement explanation, a linked URL or link information, an image included in an advertisement, a sound included in the advertisement, a picture included in an advertisement, etc. of the obtained keyword advertisement content, and the meta information of the keyword advertisement content includes various information, such as an ID of the keyword advertisement content and information on the meta information-based keyword advertisement server 6000. The meta information is generally encrypted. The click-related meta information includes the keyword advertisement content ID based on the meta information-based keyword advertisement server 6000 and/or information for transferring click generation information to the meta information-based keyword advertisement server 6000 when the user clicks the keyword advertisement content. The meta information-based keyword advertisement server 6000 can receive the click generation information of the keyword advertisement content from the keyword advertisement content providing server 3100, in which when the meta information-based keyword advertisement server 6000 receives the click generation information of the keyword advertisement content in real time or within the reproduction time of the multimedia content, the meta information-based keyword advertisement server 6000 can renew the keyword advertisement content to be provided to the user computer 9000 by using the click generation information. In the meantime, it is relatively preferred that the keyword advertisement content providing system 3000 first obtains the click generation information and transfers the click generation information to the multimedia content service system 1000 or another relevant system (e.g. a meta information-based keyword advertisement intermediation system 2000). A circulation order of the click generation information is an additional element of the spirit of the present invention.

Policy Information of Keyword Advertisement Content Selection by Keyword Advertisement Content Selection Module 6550

The fourth keyword advertisement content control policy is a keyword advertisement content selection policy for selecting, by the keyword advertisement content selection module 6550, at least one keyword advertisement content, which is to be transmitted to the user computer 9000 at a specific time, among obtained multiple keyword advertisement contents. The multiple keyword advertisement contents have a transmission priority order in a unit of an individual keyword advertisement content or a keyword advertisement content group according to the keyword advertisement content selection policy before the user click is generated. A policy adopted for the selection of the keyword advertisement content by the keyword advertisement content selection module 6550 so as to determine the priority order can be included in the keyword advertisement control policy. The keyword advertisement control policy of the keyword advertisement content selection module 6550 generally includes 1) the source of a keyword advertisement target text, 2) the order of the selected keyword advertisement target text, 3) an expected advertisement gains of a keyword advertisement content, 4) the number of keyword advertisement contents to be transmitted at one time, and 5) a selection reference change of the keyword advertisement content selection module 6550 when a specific keyword advertisement content is clicked.

For example, when the keyword advertisement target text is generated in both the tag information and the title information, the highest weight is granted, when the keyword advertisement target text is generated in the tag information or the title information, the second weight is granted, and when the keyword advertisement target text is generated in the explanation information or the category name information, the lowest weight is granted. When multiple keyword advertisement target texts are included in the tag information, the higher weight can be granted to the foremost keyword advertisement target text based on an arrangement order of the keyword advertisement target texts. However, when the keyword advertisement content corresponding to the keyword advertisement target text is not included, the keyword advertisement target text may be excluded in the selection of the weight. When it is possible to estimate the advertisement gains for the keyword advertisement content, the estimated gains serve as the important weight. Further, when the number of keyword advertisement contents, which have to be transmitted at one time, is less than the number of obtained keyword advertisement contents corresponding to the keyword advertisement target text, all keyword advertisement contents are transmitted to the user computer 9000. When the click for the specific keyword advertisement content is generated, the weight of the keyword advertisement target text related to the specific keyword advertisement content is raised and the weight of the keyword advertisement content obtained by the weight-raised keyword advertisement target text is also raised. Therefore, in order to obtain the highest advertisement gains, the keyword advertisement content selection module of the meta information-based keyword advertisement server 6000 must 1) select a keyword advertisement content, which is expected to generate the most number of clicks of the user and 2) select a keyword advertisement content having the large gains based on the probability. Such a determination of the selection priority order of the keyword advertisement content is the weight policy. The variables affecting the expected advertisement gains include an advertisement unit price of the keyword advertisement content, an expected click rate of the keyword advertisement content, etc.

The click generation information is collected by the keyword advertisement content providing server 3100, and the keyword advertisement content providing server 3100 provides the collected click generation information to the multimedia content service server 1100, the meta information based keyword advertisement server 6000, the meta information based keyword advertisement intermediation server 2100, the meta information based keyword advertisement providing server 4000, etc. in real time or non-real time. Regardless of the server first receiving the click generation information, the click generation information can be provided to another server requiring the click generation information. A module for obtaining the click generation information refers to a click generation information reception module 8900 and a module for transmitting the click generation information refers to a click generation information transmission module 9900.

Query Unit

It is possible to generate r number of keyword advertisement target text combinations (the total number of the combinations is nCr), which is equal to or larger than 1 and less than n, with respect to n number of keyword advertisement target texts generated by the keyword advertisement target text generation module 6510, the generated combinations of the keyword advertisement target texts are transmitted to the keyword advertisement content providing server 3100 in a unit of a query transmission, and at least one keyword advertisement content corresponding to the combined keyword advertisement target texts from the keyword advertisement content providing server 3100. In this case, since the keyword advertisement content is highly possible to be related to all of two or more combined keyword advertisement target texts, the possibility of inducing the user click further increases. At this time, the combination of the keyword advertisement target texts can be made with only the keyword advertisement target texts generated from the multiple tag information. In this case, it is preferred that the combination includes multiple fore tags based on an arrangement order of the multiple tags is preferentially generated as the combination.

Keyword Advertisement Display Module 7900

Next, the keyword advertisement display module 7900 will be described. The keyword advertisement display module 7900 displays at least one obtained keyword advertisement content corresponding to the selected multimedia content on a preset keyword advertisement content display area 100 of the screen of the user computer 9000, on which at least one keyword advertisement content selected by the keyword advertisement content selection module 6550 and the multimedia content is displayed, in a preset scheme with reference to the keyword advertisement control policy DB 6540. It is preferred that the preset keyword advertisement content display area 100 is a bottom part or a side part of the multimedia content display area 38-1. When the number of keyword advertisement content displayed at one time is 1, it is preferred that the preset keyword advertisement content display area 100 is a lower part of the multimedia content display area 38-1 or a preset location of an outside frame (typically, a moving picture player displays moving picture reproduction information in an inner space of the outside frame) constituting the multimedia content display area 38-1. In this case, the keyword advertisement contents can be displayed in a flowing scheme (this refers to a scheme of displaying n number of keyword advertisement contents one by one at one time while flowing from the right to the left one by one, such as a scheme of providing stock price information according to a stock item in the bottommost area of a TV screen in the economy news broadcasting). In this case, it is preferred that a layer providing the multimedia content is separated from a layer providing the keyword advertisement content. The display scheme described in this paragraph is more appropriate for 1) the relatively small display device, such as a mobile terminal and 2) a case in which the user views the multimedia contents in a full screen mode. Next, the case 2) will be described. When the user selects the full screen mode, the moving picture is displayed on an entire screen, so that in order to display the keyword advertisement content, the method described in this paragraph must be observed. Therefore, when the keyword advertisement display module 7900 obtains information of the selection of the full screen mode in the user computer, a location and a display scheme of the keyword advertisement content display area 100 in the user computer 9000 should be changed to the scheme described in this paragraph.

The change of the location and the display scheme of the keyword advertisement content display area 100 is as follows. When the multimedia content service system 1000 provides the user computer 9000 with multimedia content information through a web, the multimedia content service system 1000 provides information constituting the web page with an event detection program (a kind of an event detection module (not shown)) detecting an event of the full screen mode selection, a layer activation program activating a layer, and a keyword advertisement content display scheme and location change program displaying a keyword advertisement content in a preset location of an activated layer. The event detection program detects the event of the full screen mode selection. When the event detection program detects the event of the full screen mode selection, the layer activation program activates a layer, the keyword advertisement content display scheme and location change program display the obtained keyword advertisement content on a preset location of the activated layer in a preset scheme. When the user changes the full screen mode to a normal screen mode, the event detection program detects the change, the layer activation program interrupts the function, and the keyword advertisement content display scheme and location change program displays the keyword advertisement content on the original preset keyword advertisement content display area 100. Further, when the event detection program detects a specific event, the event detection program provides the multimedia content service system 1000 with the event generation information, the multimedia content service system 1000 provides the user computer with a keyword advertisement content corresponding to the specific event, and the user computer 9000 exposes the keyword advertisement content in a desired scheme of the multimedia content service system 1000 through the layer activation program and the keyword advertisement content display scheme and location change program. In the above description, the web scheme has been described, but the exclusive program (Windows Media Player, Flash Player, GOM Player, etc.) is equivalently applied to the present invention, which is apparent to those who are skilled in the art. The event detection program, the layer activation program, the keyword advertisement content display scheme and location change program may be parts of the keyword advertisement display module 7900, and the keyword advertisement display module 7900 can be transmitted to the user computer, or a part or the entity of the keyword advertisement display module 7900 can be executed in the user computer. For example, the aforementioned programs may have a form of a Java script code.

The keyword advertisement display module 7900 transfers the selected keyword advertisement to the multimedia content service server 1100 and the multimedia content service server 1100 generates a web page including the selected multimedia content and transmits the web page data to the user computer 9000. Various script codes (programs), such as the Java script, can be included in information of generating the web page, and an operation scheme of the script codes can be determined by the keyword advertisement display module 7900. That is, the keyword advertisement display module 7900 generates a code controlling a display scheme and/or a display location of the desiring keyword advertisement content and includes the generated code to the code constructing the web page. In the meantime, the multimedia content service server 1100 specifies the area 100 in which the selected keyword advertisement content is to be displayed, on the user computer 9000, and generates a web page only with the selected multimedia content while including a script code (program) related to the display of the keyword advertisement content and transmits the web page to the user computer 9000. Next, the script code included in a browser installed in the user computer 9000 requests the keyword advertisement content, receives the selected keyword advertisement content, and displays the selected keyword advertisement content on the area 100.

Further, the multimedia content service server 1100 installs a specific program 9100 on the user computer 9000 in a plug-in scheme, etc., and the plug-in program 9100 receives data related to the selected keyword advertisement content from the keyword advertisement display module and displays the data on the area 100, in which a preset keyword advertisement content is to be displayed. That is, in order to display the selected keyword advertisement on the user computer 9000, the keyword advertisement display module 7900 transmits the selected keyword advertisement content to an outside server and displays the keyword advertisement content on a preset location in a preset scheme. The transmission of the selected keyword advertisement content by the keyword advertisement display module 7900 includes at least one method of 1) transmitting the selected keyword advertisement content to the multimedia content service server 1100 by the keyword advertisement display module 7900 and then transmitting the selected keyword advertisement content to the user computer 9000 by the multimedia content service server 1100 and 2) directly transmitting the selected keyword advertisement content to the user computer 9000 so as to display the selected keyword advertisement content on a preset area 100 of the user computer 9000 by the keyword advertisement display module 7900. In order to implement the method 2), a relevant operating program should be installed on the user computer 900 or a program (script, etc.) capable of communicating with the multimedia content service server 1100 and requesting information should be included in information of the web page transmitted to the browser of the user. The event detection program, the layer activation program, and the keyword advertisement content display scheme and location change program may be an example of the specific program 9100. It is a matter of course that the keyword advertisement display module 7900 itself may be an example of the specific program 9100 if it is transmitted to and installed in the user computer 9000.

In the meantime, a code for, when the user clicks the keyword advertisement content the transmitted keyword advertisement contents, displaying an image of an advertisement content of an advertiser in relation to the keyword advertisement content on a preset location can be inserted in a function (including a computing means for implementing a script code, program, or a control function) of the keyword advertisement display module 7900. The code may include edge coordinates information of the area on which the advertisement content is to be displayed or information for always displaying the advertisement content on the upper area. This may be more useful for the user computer having a large screen, such as an IPTV. The multimedia content service system 1000 inserts an event detection function to information of the web page transmitted to the user computer through a code, such as the Java script. When the event detection function receives selection information of a keyword advertisement content from the user computer 9000, the event detection function 1) locates a web page screen on which the moving picture is displayed on a left topmost end or a right lowermost end of a display device of the user computer 9000, 2) temporarily hides every information, except for a moving picture reproduction area, in the web page screen on which the moving picture is displayed and when selection information of the web page screen, on which the moving picture is displayed, is received again, recovering the hidden information to an original state, or 3) decreases a size of a web page screen (for example, a screen displayed on the IPTV, this is the same in another device) and displays the web page screen on a left topmost end or a right lowermost end. When at least one of 1) to 3) is executed, the advertisement content of the advertiser can be previously set to be separated farthest from the web page. When the keyword advertisement content is clicked after the reproduction of the moving picture, the event detection function may display the advertisement content (in the above and hereinafter, a specific image of the advertiser and information represented by the advertiser can be the advertisement content of the advertiser) of the advertiser on the screen on which the moving picture is displayed.

When the keyword advertisement content providing server 3100 or the meta information-based keyword advertisement intermediation system 2000 does not provide information capable of predicting the keyword advertisement gains corresponding to the selected keyword advertisement target text, such as an advertisement unit price and/or an expected click rate of the keyword advertisement target text, even though the keyword advertisement content selection module 6550 reasonably selects the keyword advertisement content with reference to the keyword advertisement control policy, it may select the keyword advertisement content of which the advertising effect is relatively low. In the meantime, there are many keyword advertisement target texts generated by the keyword advertisement target text generation module 6510 and the keyword advertisement target text generation module 6510 transmits all of the keyword advertisement target texts to the keyword advertisement content providing server 3100, it is possible to decrease the unnecessary loads in the keyword advertisement content providing server 3100. Therefore, the keyword advertisement target text generation module 6510 is necessary to filter the keyword advertisement target texts generated for the first and then transmits only the keyword advertisement target texts generated for the second, which pass a preset reference, to the keyword advertisement content providing server 3100, to obtain the corresponding keyword advertisement content.

Filtering Module 6560

The meta information-based keyword advertisement server 6000 can filter the keyword advertisement target texts before transmitting the keyword advertisement target texts to the keyword advertisement content providing server 3100. The filtering is required for the purpose of, when there are multiple keyword advertisement target texts, there is no guarantee in that every keyword advertisement target text has the keyword advertisement content and creates the advertisement gains, extracting a keyword advertisement target text by which a keyword advertisement content is changed or selecting a keyword advertisement target text having a possibility of more contributing to the advertisement gains. The filtering is implemented through the inquiring of the advertisement keyword DB 6570 about the keyword advertisement target text and extracting the keyword advertisement target text registered in the advertisement keyword DB 6570 or satisfying a preset condition by the filtering module 6560. The present condition is included in the keyword advertisement control policy DB 6540 and is inquired by the filtering module 6560 through inquiring of the keyword advertisement control policy DB 6540. At this time, only the keyword advertisement target text filtered by the filtering module 6560 is query-transmitted to the keyword advertisement content providing server 3100.

The advertisement keyword DB 6570 includes 1) name data of a product or a service, 2) an advertisement keyword list of an advertiser registered in and obtained from the advertisement keyword content providing server 3100, 3) an advertisement keyword target text verified to generate the advertisement gains through the implementation of the present invention, or 4) an advertisement keyword list generated by itself or obtained from the third person. The 1) name data of a product or a service refers to a name of a provider providing other people with a product or a service (e.g. Hyundai Construction), texts of an emblem content, such as a trademark consisting of texts, a character part in an emblem content, such as a trademark (e.g. a character part of an emblem content, such as a trademark in which texts are combined with a symbol, a figure, a three-dimensional shape, or color), a transliterated character of a sound part of an emblem content, such as a trademark, a character part corresponding to a transliterated mother tongue from an emblem content, such as a foreign language trademark (e.g. AI-BI-EM in the case of “IBM”, when the mother tongue is different, a separate transliteration is incurred, and when a transliteration is different, every transliterated mother tongue including the recognized correspondence is included, e.g. Mcdonald, Mcdoneld, etc. in the case of “McDonald”). The advertisement keyword list of the 2) or 4) refers to keywords for the advertisement registered by the advertisers so as for their advertisement to be searched. For example, when the users input the advertisement keyword through a search input formula in www.google.com or www.naver.com, advertisement contents of advertisers related to the advertisement keyword are output, as well as the search result of the search input formula. Therefore, the keyword advertisement lists registered by the advertisers are stored in the keyword advertisement content providing server 3100 and a part of an entity of the lists can be obtained. The 3) is accumulated according to the passage of time through the implementation of the present invention, and refers to a collection of keyword advertisement target texts related to keyword advertisement contents creating the advertisement gains through the actual click, etc. among the keyword advertisement contents exposed to the users. The content of the 4) is identical to that of the 2), and only the generation subject is different. The advertisement keywords registered in the keyword advertisement DB 6570 and/or the keyword advertisement content providing server-side advertisement keyword DB 3140 store several meta information, and the meta information can be renewed. The stored meta information corresponding to the advertisement keywords includes, during a preset time or apart from the time, with respect to the advertisement keyword, 1) the total number of exposures/the total number of callings, 2) an increase/decrease rate of the total number of exposures/the total number of callings, 3) the total number of advertisers, 4) an average advertisement unit price, 5) a highest advertisement unit price, 6) a lowest advertisement unit price, 7) the average number of advertisers, 8) the average number of keyword advertisement contents, 9) an increase/decrease rate of the average number of advertisers, 10) an increase/decrease rate of the average advertisement unit price, 11) the number of exposures calculated for keyword advertisement contents related to the advertisement keyword, 12) a click generation rate of a keyword advertisement content with respect to exposure, 13) the total number of clicks, 14) a generated advertisement gain, 15) an increase/decrease rate of the number of exposures, 16) an increase/decrease rate of a click generation rate in comparison with exposure, 17) an increase/decrease rate of the total number of clicks, and 18) an increase/decrease rate of the generated advertisement gain. When the filtering module filters the keyword advertisement target text, the relevant keyword advertisement control policy requires at least one of the 1) to 18) to satisfy a preset value range.

The keyword advertisement control policy includes policy information regarding the number of and which condition of keyword advertisement target texts to use among n keyword advertisement target texts. The filtering condition of the keyword advertisement target texts may be a satisfaction degree of at least one of the 1) to 18) with respect to the keyword advertisement target texts. For example, whether to select “refill ink” as the keyword advertisement target text can be determined by the satisfaction of the facts that a frequency of the “refill ink” in an entire document is equal to or larger than three times, and the 3) is equal to or larger than 5, and the 6) is equal to or larger than 200 won.

The determination of the keyword advertisement target text among the keyword advertisement target texts will be described in more detail. It is possible to adopt a difference function based on each condition. For example, the difference function of a frequency, dif_frequency=a frequency of a keyword advertisement target text i−a reference frequency, and a difference function of various conditions j, such as the 1) to 18), dif_condition_j=a condition value of a keyword advertisement target text i−a reference condition value. The frequency is more useful when the keyword advertisement target text is oriented from the explanation information. In the meantime, when only the title and the tag are considered, the keyword advertisement target text included in both the title and the tag is the important keyword advertisement target text.

At this time, for example, a score function of a keyword advertisement target text i may be the sum of {F(difference function)*weight for each difference function}. The weight of a condition, other than the 1) to 18), is 0 and F(x) may be x or x̂2 (wherein, F is an input variable and x is the difference function in this paragraph).

At this time, at least one keyword advertisement target text having the highest score function value can be selected as a keyword advertisement target text for each keyword advertisement target text i. In the meantime, it is apparent to those skilled in the art that it is possible to employ other functions using various obtainable variables of a keyword advertisement target text, other than the difference function, and other conditions, except for the frequency and the 1) to 18) can be used, the weight can be varied according to a weight policy of the keyword advertisement control policy DB 6540, and an equation of F(x) can be changed.

Further, it is a matter of course that the calculation of the score function of the keyword advertisement target text and the selection of the keyword advertisement target text based on the score function can be applied to at least one commercial tag candidate. That is, at least one preset reference is applied to a time independent commercial tag candidate or a time dependent commercial tag candidate, the score function is calculated, and a commercial tag having the high score function can be selected as a keyword advertisement target text. At this time, the score function may be a function for evaluating the commercial tag candidate of a commerciality of a commercial tag.

It is a matter of course that the control policy of the keyword advertisement control module 6900 can be utilized in the keyword advertisement content providing server 3100 of the keyword advertisement content providing system 3000. That is, when n keyword advertisement target texts are transmitted to the keyword advertisement content providing system 3000, the keyword advertisement content providing system 3000 selects at least one the keyword advertisement target text among the n keyword advertisement target texts, inquires of the keyword advertisement content DB 3120, obtains at least one keyword advertisement content corresponding to the selected keyword advertisement target text, and transmits the obtained keyword advertisement content to the server which has made an inquiry. Therefore, the keyword advertisement content providing system 3000 performs a function of the keyword advertisement control module 6900 regardless of the indication in the drawings, which will be described in a keyword advertisement content providing system 3000 oriented model in detail.

In the meantime, the communication module of the present invention transmits and receives internal or external data. It is apparent to those skilled in the art that the communication module may be included in each function module of the present invention and also included in the unit of a server or a system.

A network 8000 represents every communication means capable of transmitting/receiving data through the connection with the computer, such as the wired/wireless network 8000.

The user computer 9000 of the present invention includes a personal computer or a portable computer or server, such as a PC or a notebook, a mobile communication terminal supporting the voice/data communication, such as a mobile phone, a game device including a wired/wireless data communication function, a bi-directional TV, such as IPTV, (if a set-top box is not installed, the set-top box can be the user computer of the present invention, and in this case, the IPTV may be a display device), a portable TV, such as DMB, a display device additionally attached to a main product, such as a home appliance, and any device including a CPU, such as a PDA, a PMP, or a MP3/MP4 player, capable of wired/wirelessly communicating, obtaining a multimedia content, providing the user with multimedia content information.

Generation of Keyword Advertisement Target Text

The description of the spirit of the present invention is mainly focused on the provision of the keyword advertisement content to the user computer 9000 based on the meta information additionally included in the multimedia content. Further, the spirit of the present invention can extend up to the obtaining of the text information related to the multimedia content, the generating of the keyword advertisement target text based on the text information, and the providing of the keyword advertisement content based on the generated keyword advertisement target text to the user computer 9000. Therefore, the key point of the present invention is a method of obtaining the multimedia content itself or the text information from information related to the multimedia content and generating the keyword advertisement target text.

Hereinafter, the text obtainment module 3110 and the keyword advertisement target text generation module 6510 for obtaining a multimedia content itself or a text from information related to a multimedia content will be described in more detail. For the convenience of description, the text obtainment module 3110 and the keyword advertisement target text generation module 6510 will be described on the assumption of a disintermediation model executed in the meta information based keyword advertisement server 6000, but it is apparent that the spring of the present invention is applied to the intermediation model and the keyword advertisement content providing system 3000-based model.

Non-Tag Information Obtainment Module 5130

The text obtainment module 3110 directly or indirectly obtains text information, other than a tag, from the multimedia content. A multimedia content discussed in the present invention generally includes 1) a moving picture, 2) an image, and 3) a sound. The moving picture generally represents a picture file, such as an UCC moving picture, an UGC (User Generated Contents), an UMC (User Modified Contents), or a PCC moving picture. The image includes a picture, etc., and represents an image file, which typically belongs to an image category and can be visually recognized, and the sound represents a sound file, such as music, a sound, a song, and an effect sound, which can be auditorily recognized. The reproduction of the image represents the display of the image file on the user computer 9000 through reading the image file so as for the user to visually recognize the image. The reproduction time of the image represents a time during which a specific image has been displayed on the user computer 9000 so as for the user to visually recognize the image. Hereinafter, the description of the present invention will be given based on a moving picture, and when the description is specified only to an image or a sound, an additional description will be given.

A multimedia content provided from the multimedia content service system 1000 typically includes a title and/or at least one tag information, and also includes explanation information in many cases. At this time, the tag information mainly consists of a noun form, and typically a single noun or a single compound noun, and occasionally at least two nouns or compound nouns. The tag typically consists of a noun, so that when the tag information consists of a noun, it is not necessary to analyze the tag information by using the morpheme analyzer. However, a partial tag consists of a sentence or several connected nouns, other than a word, so that this tag must to analyze in the morpheme analyzer. The morpheme analyzer will be described later. Therefore, a text included in the tag information principally becomes an advertisement target text. Further, most of the names of classifications or categories are nouns so that this can be equally treated with the tag information.

In the meantime, it is necessary to analyze the title through the morpheme analyzer because the title includes other parts of speech, other than a noun, so as to construct a meaning unit in many cases. Especially, the title is selected by a multimedia content producer so as to aptly express his/her multimedia content, in contrast of the explanation information, so that a noun, etc. extracted from the title may be usefully used as an advertisement target text.

Further, the explanation information of the multimedia content is mostly formed in a sentence or a phrase type, so that the explanation information should be definitely analyzed through the morpheme analyzer. Text information generated by the multimedia content service system 1000 through voice recognition of the multimedia content should be preferably analyzed through the morpheme analyzer so as to extract a noun.

Non-Text Information Obtainment Module 5120

The non-text information obtainment module 5120 can obtain text information through voice recognition for voice data included in the multimedia content, in addition to the obtaining of text-type information. The voice recognition is implemented through reproduction of the multimedia content. A quality of the voice recognition is not greatly important because the keyword advertisement target text can use the advertisement keyword DB 6570, etc. as a filter. Even if plural incorrect text information is obtained through the voice recognition, only the texts included in the advertisement keyword DB 6570 among texts corresponding to the recognized voice are to be treated as a keyword advertisement target text, which will be described below.

Keyword Advertisement Target Text Generation Module 6510

The construction and function of the keyword advertisement target text generation module 6510, which generates a keyword advertisement target text from texts obtained by the text obtainment module 3110, will be described. The keyword advertisement target text generation module 6510 generates a keyword advertisement target text. A method of generating a keyword advertisement target text generally includes a method of generating a keyword advertisement target text from tag information and a method of generating a keyword advertisement target text from explanation information, etc.

The first method is to generate a keyword advertisement target text by using only tag information by the keyword advertisement target text generation module 6510. In the first method, the tag information mainly consists of a noun, so that it is possible to treat every obtained tag information as keyword advertisement target texts as it is or tag information, which have passed a preset filter, as keyword advertisement target texts. The commerciality of a commercial tag to be described later has been verified, so that the commercial tag can be a keyword advertisement target text. At this time, a preset filter may be a product/service name DB collecting names of products or services, and the product/service name DB may be one of the advertisement keyword DB 6570 of the present invention. That is, the keyword advertisement target text generation module receives all tag information included in meta information of the specific multimedia content from the text obtainment module 3110, inquires of the product/service name DB about the tag information, and selects only the tags included in the product/service name DB, to generate the tags as keyword advertisement target texts. Here, the preset filter may be an advertiser registering advertisement keyword DB registered by an advertiser or a third person and provided from the keyword advertisement content providing server 3100, and the advertiser registering advertisement keyword DB may be one of the advertisement keyword DB 6570. The advertiser registering advertisement keyword DB stores keywords for an advertisement registered by an advertiser so as to advertise a product or service of an advertiser. The keyword for advertisement may include an advertisement title and/or an advertisement explanation. In this case, the keyword advertisement target text generation module 6510 receives all tag information included in meta information of the specific multimedia content from the text obtainment module 3110, inquires of the advertiser registering advertisement keyword DB provided from the keyword advertisement content providing server 3100 about the tag information, and selects only the tags included in the advertiser registering advertisement keyword DB, to generate the selected tags as keyword advertisement target texts.

The second method is to generate a keyword advertisement target text by using title information and/or explanation information by the keyword advertisement target text generation module 6510. In this case, the text obtainment module 3110 obtains a text from the title information and/or explanation information of the multimedia content, analyzes the text by using the morpheme analyzer, and extracts a noun. At this time, a weight may be especially given to a noun extracted from title information and a low weight may be given to a noun extracted from the explanation information for treatment. At this time, when there is information automatically tagged from the explanation information, it is possible to use the automatically tagged tag. The automatic tagging refers to the automatic generation of tag information capable of representing a text string through analyzing or filtering a text string, such as a phrase, a clause, a sentence, and a paragraph, by using the morpheme analyzer or a preset filter. The filter may be the advertisement keyword DB 6570. At this time, the nouns which have passed at least one preset filter among the obtained nouns can be treated as keyword advertisement target texts.

The keyword advertisement target text generation module 6510 of the present invention consists of a keyword advertisement target text pre-processing engine, keyword advertisement target text extraction engine, and the advertisement keyword DB 6570. When it is necessary to pre-process, such as analyze a morpheme, the obtained process, the keyword advertisement target text pre-processing engine conducts pre-processing. When the obtained text has been extracted from the tag information, the text pre-processing engine can be skipped. The keyword advertisement target text extraction engine inquires of the advertisement keyword DB 6570 about the obtained text (including the pre-processed text) and filters the obtained text, extracts a text string corresponding to the filtered text in the advertisement keyword DB 6570, and generates the extracted text string as a keyword advertisement target text. For example, the advertisement keyword DB 6570 includes the product/service name DB collecting names of products or services or the advertiser registering advertisement keyword DB provided from the keyword advertisement content providing server 3100.

The keyword advertisement target text is a text receivable in the keyword advertisement content providing server 3100, and generally includes three types.

The first type is a name of a product or a service. The name of the product or service preferably has a noun or noun phrase type, e.g. Ipod, notebook, and flower delivery.

The second type is “search advertisement keywords” registered by search keyword advertisers operating a search keyword advertisement (an advertising form in which when an advertiser has registered a specific keyword and a searcher inputs the keyword or a keyword related to the registered keyword, a keyword advertisement content of the advertiser is output among a keyword advertisement content search result. The representative example is a search keyword advertisement executed in www.google.com and www.overture.com. Various search keyword advertisement products, such as a Plus Pro, are represented in www.naver.com.) The search advertisement keywords have been registered by the advertisers, and may be advertisement titles, advertisement explanations, and/or other text type keyword advertisement contents. For example, the search advertisement keywords includes various common nouns or proper nouns, such as a brand name (trademark), such as “Prada”, a name of a product or a service, a name of a place or a person, and additionally any text string registered by the advertisers.

The third type is text string information, such as a phrase, a clause, or a sentence. Plural search portals, such as www.google.com or www.naver.com, or a search keyword advertisement agent, such as www.overture.com, process inputted text string information and provide a search result including keyword advertisement contents corresponding or related to the search advertisement keywords registered by advertisers of the portals, as well as a search result including a keyword advertisement content. Therefore, in order to provide a search result including the keyword advertisement content through the inputted text, the keyword advertisement target text generation module 6510 processes the test in a preset unit (in the unit of a sentence, phrase, or clause) and extracts a keyword advertisement target text.

Next, a method of extracting the keyword advertisement target text by the keyword advertisement target text generation module 6510 will be described in more detail.

A method of extracting a keyword advertisement target text by the keyword advertisement target text generation module 6510 includes 1) a method of inquiring of the advertisement keyword DB 6570, which stores keyword advertisement target texts, included in the multimedia content service system 1000 about an inputted text and extracting the keyword advertisement target text and 2) a method of transmitting an inputted text to a preset intermediation server, processing the inputted text to extract a keyword advertisement target text, and transmitting the extracted keyword advertisement target text to the multimedia content service system 1000.

The advertisement keyword DB 6570 includes the name of the product or the service, the “search advertisement keywords” registered by the advertisers, etc. With regard to this, the intermediation server can extract the keyword advertisement target text through one's advertisement keyword DB 6570 or through a third server including the advertisement keyword DB 6570. It is possible to pre-process the inputted text prior to inquiring of the advertisement keyword DB 6570 by using the inputted text, and the pre-processing represents the performance of a syntax analysis or a morpheme analysis (including a disintegration of a compound noun). The pre-processing is performed by the keyword advertisement target text pre-processing engine.

When the inputted text is a noun or a noun phrase, it is easy to inquire of the advertisement keyword DB 6570 about the inputted text (in the English language, by using a stem analyzer, it is possible to simply process the plural form of a noun to the singular form). However, when a postpositional word is used in a case of the Korean language, etc., it may be necessary to separate a postpositional word through the morpheme analysis. Further, in the case of a verb, etc., the extraction of a noun related to the verb can be performed through the morpheme analysis, etc. (for example, “Yeohang” is separated from “Yeohanggada”). The extraction of a noun through the syntax analysis and the morpheme analysis from the inputted text is a publicly known art in natural word processing technology, so that its detailed description will be omitted. The pre-processing is performed in a system or a server including the advertisement keyword DB 6570. That is, if the multimedia content service system 100 includes the advertisement keyword DB 6570, the multimedia content service system 100 can extract a keyword advertisement target text from the inputted text (a name of a product or service, a proper noun, a common noun, a search advertisement keyword, etc.) and the intermediation server or the third server is the same as that. In the meantime, if the semantic extraction technology is used, it is possible to extract a keyword advertisement target text in more detail. The semantic extraction technology has been well known for those skilled in the art.

According to the descriptive expression, the extraction of the keyword advertisement target text, etc. are performed by the multimedia content service system 1000, but it does not exclude that any program 9100 operated in connection with the multimedia content service system 1000 performs the extraction, etc. That is, a module performing the obtaining and/or extracting of the keyword advertisement target text is related with the multimedia content service system 1000 in the cases where 1) both of the module performing the obtaining and/or extracting of the keyword advertisement target text and the multimedia content service system 1000 are included in the same entire program 9100 operated by the same operator, 2) the module performing the obtaining and/or extracting of the keyword advertisement target text and the multimedia content service system 1000 are operated by the same operator, but operated by separate programs 9100, and 3) the module performing the obtaining and/or extracting of the keyword advertisement target text and the multimedia content service system 1000 are operated by separate programs 9100 operated by different operators, but cooperate with each other through the communication with each other (the multimedia content service system 1000 has a control authority for a multimedia content, which is provided by the multimedia content service system 1000 in a streaming scheme, and provides the module with information obtained from a file controlled by the multimedia content service system 1000).

With regard to this, a problem of the voice recognition will be briefly described. The present invention is for the purpose of extracting a keyword advertisement target text by using a text (text information, title information, explanation information, category information, etc.) obtained from an audio-visual multimedia content and displaying a search result including an (advertisement-target) keyword advertisement content corresponding to the extracted keyword advertisement target text. It is on the assumption that when a voice track of the multimedia content is “An editor of a fashion magazine on the Fifth Street in New York carries a PRADA bag”, due to the improper voice recognition function, “fashion” is mis-recognized as “fasheon”, and “magazine” is mis-recognized as “megozine”, but “PRADA” is correctly recognized as “PRADA” and “bag”. In this case, when the “fasheon” and “megozine” are not included in the advertisement keyword DB 6570, the “fasheon” and “megozine” are excluded from the keyword advertisement target text, and when at least one of the tag “PRADA” and “bag” are included in the advertisement keyword DB 6570, the included keyword can be processed as a keyword advertisement target text. That is, even if the voice recognition system cannot recognize the mis-recognition, the multimedia content service system 1000 has only to process the texts included in the advertisement keyword DB 6570 among the recognition processed texts as the keyword advertisement target texts. It is not necessary to provide the search result including the keyword advertisement contents corresponding to all of the “fashion”, “magazine”, “PRADA”, and “bag”, so that there is no matter even if the search result including the keyword advertisement contents corresponding to only the correctly recognized text (e.g. the word included in the advertisement keyword DB 6570) were provided to the user. As such, even though the keyword advertisement target text is restrictively processed, the user can recognize only the exposed keyword advertisement contents, so that the voice recognition rate is advantageously considered substantially higher than the actual recognition rate. That is, in the above situation, the search result including the (advertisement-target) keyword advertisement contents corresponding to the tag “PRADA” and/or “bag” are provided to the user. When the extracted keyword advertisement target text is included in the advertisement keyword DB 6570, but the keyword advertisement content providing server 3100 cannot provide a search result including the keyword advertisement content corresponding to the extracted keyword advertisement target text, the keyword advertisement target text corresponding to the keyword advertisement content that cannot be provided from the keyword advertisement content providing server 3100 is excluded and the keyword advertisement target texts capable of normally obtaining the search result including the keyword advertisement content are exposed to the user.

If only the search result including the keyword advertisement content not for the advertisement is exposed, the possibility in the generation of the above problem is extremely low. However, when the search result including the advertisement target keyword advertisement content has to be exposed, a search word, which has not been registered as a search keyword advertisement by the advertiser, may be generated. In this case, under the policy, there is a method of exposing a search result including the keyword advertisement content not for the advertisement and a method of exposing only a search result including the advertisement target keyword advertisement content that can be normally obtained, but the latter method is preferable. This problem is reverted to a process problem of a case where multiple keyword advertisement target texts are generated, but an advertiser does not register the search keyword advertisement or there is no advertisement corresponding to the keyword advertisement target text.

In a case in which there are where multiple keyword advertisement target texts and the keyword advertisement target text transmission module 6520 transmits the multiple keyword advertisement target texts one by one to the keyword advertisement content providing server 3100, if there is an advertisement corresponding to the i−1^{th} keyword advertisement target text, but there is no advertisement corresponding to the i^{th} keyword advertisement target text, it is impossible to obtain the advertisement corresponding to the i^{th} keyword advertisement target text, so that the processing of the i^{th} keyword advertisement target text is skipped, the keyword advertisement content corresponding to the i−1^{th} keyword advertisement target text is continuously maintained or undergoes a preset processing, and the i+1^{th} keyword advertisement target text is transmitted to the keyword advertisement content providing server 3100. When multiple keyword advertisement target texts are divided into several groups and are transmitted to the keyword advertisement content providing server 3100 in the unit of the group, the above processes are performed for the i−1^{th} group and the i^{th} group based on the group unit. When multiple keyword advertisement target texts are transmitted at one time to the keyword advertisement content providing server 3100 and the multimedia content service system 1000 includes the keyword advertisement content transmitted from the keyword advertisement content providing server 3100, the multimedia content service system 1000 provides the user computer 9000 with the received keyword advertisement contents at one time or through rolling the keyword advertisement contents in a unit of several keyword advertisement contents (the rolling or the control of the keyword advertisement contents is implemented by a program, such as a script code or other plug-in, transmitted to a browser of the user computer 9000). For example, when the multimedia content service system 1000 receives 10 keyword advertisement contents from the keyword advertisement content providing server 3100 and the 10 keyword advertisement contents are processed based on every 2 keyword advertisement contents, a keyword advertisement content set including 2 different keyword advertisement contents is transmitted to the user computer 9000 five times. To this end, the script code (program), etc. can display the first 2 keyword advertisement contents on the multimedia content service system 1000 for a preset time in a preset scheme (rolling, etc.) and requests additional 2 keyword advertisement contents. When the multimedia content service system 1000 transmits the initial keyword advertisement content, the maximum number of the transmittable keyword advertisement contents is 10, and a script code including control information for transmitting two keyword advertisement contents at one time is provided, every two keyword advertisement contents are transmitted to the user computer 9000 during the execution of the script code. That is, the multimedia content service system 1000 transmits 10 keyword advertisement contents at one time and the 10 keyword advertisement contents are rolled by a script of the web browser of the user computer 9000. Otherwise, the multimedia content service system 1000 transmits only 2 keyword advertisement contents and stores 8 keyword advertisement contents in the session or DB, and when the additional request of the keyword advertisement contents is made, the multimedia content service system 1000 transmits the next two keyword advertisement contents. An example of a script code for the rolling will be represented below.

```
    Rolling (Java script)
    1: for (var i = 0; ; i++) {
    2:  setTimeout(“rollAd(“+i+”)”, 20*1000);
    3: }
    ...
    5: function rollAd(idx) {
    6:  document.getElementById(“adLayer”).innerHTML =
adContents[idx % adContets.length];
    7: }
    1: Unlimited repetition
    2: Call a function of rollAd every 20 seconds
    6: rollAd function displays a next advertisement on
an advertisement display area of adLayer.
```

Next, an example of a script additionally requesting keyword advertisement contents is represented.

```
    1: while (true) {
    2:  setTimeout(“nextAd( )”, 20*1000);
    3: }
    ...
    5: function nextAd( ) {
    6:  if (end == false) {
    7:  getAdByAJAX( );
    8:  }
    9:  document.getElementById(“adLayer”).innerHTML =
adContents[currentIdx % adContets.length];
    10:  if (currentIdx+1 >= adContents.length)
    11:  currentIdx = 0;
    12:  else
    13:  currentIdx++;
    14:  }
    1: Unlimited repetition
    2: Call a function of nextAD every 20 seconds
    6: Inquire a next keyword advertisement content by
using AJAX, and store a next keyword advertisement
content when a next keyword advertisement content is
included, or do not inquire a next keyword advertisement
content any more when a next keyword advertisement
content is not included
    9: Display a next advertisement on an advertisement
display area every time
    10: Change a location of the advertisement so as to
display a next advertisement in the next time
```

The advertisement keyword DB 6570 may include the name of the product or the service or search advertisement keywords for the search keyword advertisement registered by the advertisers. A method of generating and renewing the advertisement keyword DB 6570 will be described.

With regard to the name of the product or the service, a set of product name or/and service name can be generated based on a goods dictionary, a service name dictionary, an occupation name dictionary, a product electronic catalogue (including the international standard), a service electronic catalogue, or a noun dictionary (it is a matter of course that the name of the product or the service can be received from the outside third party), and the set of product name or/and service name can be stored as a DB. It is a matter of course that the set of product name or/and service name can be indexed for the search by the DBMS or the search engine. A search advertisement keyword set including the collected search advertisement keywords can be generated through receiving the search advertisement keywords from an operator of the search keyword advertisement (e.g. a portal executing the search keyword advertisement, such as www.google.com or www.naver.com, or a search keyword advertisement agent, such as www.overture.com). That is, through the communication between the server of the operator of the search keyword advertisement and the multimedia content service system 1000 periodically or in a preset time/condition unit, it is possible to obtain the search advertisement keyword set from the server of the operator of the search keyword advertisement and the advertisement keyword DB 6570 can be generated and updated (renewed) by the obtained search advertisement keyword set. The search advertisement keyword set can be obtained from an intermediation server functioning the intermediation between the multimedia content service system 1000 and the keyword advertisement content providing server 3100.

When the multimedia content service system 1000 does not include the advertisement keyword DB 6570 or includes the advertisement keyword DB 6570 but fails to properly function due to the shortage of the advertisement keyword DB 6570 (the multimedia content service system 1000 obtains the substantial number of text, but the advertisement keyword DB 6570 fails to generate a keyword advertisement target text, etc.), the aforementioned third scheme may be applied. According to the third scheme, the text string information, such as a phrase, clause, sentence, etc., is transmitted to multiple search portals, such as www.google.com or www.naver.com, the search keyword advertisement agent, such as www.overture.com, the search portal or the search keyword advertisement agent analyzes the text string (including the syntax analysis, morpheme analysis, etc., most of the portals receives an input of a phrase or clause type text and provides a search result including any type of keyword advertisement content corresponding to the text input) and generates a keyword advertisement target text, and transmits the search result including the keyword advertisement target text and/or the keyword advertisement content corresponding to the keyword advertisement target text to the multimedia content service system 1000. When the multimedia content service system 1000 receives only the keyword advertisement target text, the multimedia content service system 1000 transmits only the keyword advertisement target text to the keyword advertisement content providing server 3100 and receives a search result including the keyword advertisement content from the keyword advertisement content providing server 3100, and when the multimedia content service system 1000 receives the search result including the keyword advertisement content, the multimedia content service system 1000 displays the search result to the user. An intermediation server can intermediate the multimedia content service system 1000 and a server of the search portal or the search keyword advertisement agent. The performance, transmittable/receivable information, and each function of the multimedia content service system 1000 and a server of the search portal or the search keyword advertisement agent based on the intermediation server will be apparent to those skilled in the art, so that the detailed description will be omitted.

Hereinafter, a method of transmitting, by the multimedia content service system 1000, the keyword advertisement target text to at least one keyword advertisement content providing server 3100 capable of providing a search result including the keyword advertisement content will be described. When a text is obtained from the multimedia content through 1) a subtitle (caption), 2) a translated subtitle, and/or 3) voice recognition, in contrary to the UCC tag, the text is continuously obtained according to the transmission, such as the streaming, of the multimedia content (it is a matter of course that the multimedia content has previously been reproduced and the voice recognition has been done, and also the voice recognition is performed during the streaming and reproduction of the multimedia content). Therefore, the multimedia content service system 1000 can transmit the keyword advertisement target text to the keyword advertisement content providing server 3100 in the unit of 1) a preset time and/or 2) the preset number of keyword advertisement target texts (e.g. the new keyword advertisement target texts are not transmitted until the number of keyword advertisement target texts becomes three). When the text is obtained from UCC tag information, the time-based transmission of the multimedia content is independent of the obtainment of the text from the UCC tag information (irrelevant to each other, that is, a specific section of the multimedia content is not related with a text obtained from the UCC tag), so that the extraction of a keyword advertisement target text from the text obtained from the UCC tag and transmission of the extracted keyword advertisement target text to the keyword advertisement content providing server 3100 is independently performed from the transmission of the specific section of the multimedia content. Preferably, in a beginning section of the multimedia content, an ending section of the multimedia content, and/or the transmission process of the multimedia content, the keyword advertisement target text generation module 6510 transmits the keyword advertisement target text obtained from the UCC tag in a section, in which the number of keyword advertisement target texts extracted by the method 1), 2) and/or 3) is less than a preset number (there is little voice or subtitles in a specific section in the transmission of the multimedia content, so that it may be difficult to extract the text, or there may be created a section, in which the number of extracted keyword advertisement target texts are resultantly small due to other reasons). In the meantime, if the method 1), 2) and/or 3) is not available, it is possible to extract a text from the tag information, title information, explanation information, etc.

Next, the keyword advertisement content providing server 3100, which generates a search result including a keyword advertisement content for advertising corresponding to the keyword advertisement target text, will be described. According to an embodiment of the present invention, the keyword advertisement content providing server 3100 includes a search word obtainment unit obtaining a search word (query word) transmitted from an outside, a search word processing unit processing a search word obtained by the search word obtainment unit, an advertisement search engine unit performing the search by using a search word obtained by the search word obtainment unit or a search word processed by the search word processing unit, and a search result transmission unit transmitting a search result. The keyword advertisement content providing server 3100 may selectively include the search word processing unit, but it is preferable to include the search word processing unit. Especially, it is more preferable to include the search word processing unit when the processing of the keyword advertisement target text generated by the keyword advertisement target text generation module 6510 is necessary. This is because there are many cases in which the search keyword advertisement itself included in the keyword advertisement content providing server 3100 is generally different from a phrase inputted by the user. The advertisement search engine unit further includes an advertisement search unit directly performing the search and an advertisement target search index or a keyword advertisement content DB, of which the advertisement search unit inquires by a search query. At this time, when the search engine is used for the search, the existence and a location of a specific keyword advertisement content included in the keyword advertisement content DB is searched through the search index for advertising. In the meantime, a scheme may be adopted in which a DB query is directly inquired in the keyword advertisement content DB according to the DBMS or other schemes. At this time, in order to improve a query response speed, an index may be linked with at least one specific field in the keyword advertisement content DB. In this case, the keyword advertisement content DB is logically included in the keyword advertisement content providing server 3100, but may be included outside of the advertisement search engine unit. Further, keyword advertisement content providing server 3100 further includes an advertisement evaluation unit evaluating each advertisement and each of the keyword advertisement contents. How to evaluate an advertisement by the advertisement evaluation unit will be described based on the embodiment of an advertisement evaluation method with respect to the tags “PRADA” and “bag”.

When the keyword advertisement target text is transmitted to the keyword advertisement content providing server 3100 from the internal or external server, the keyword advertisement content providing server 3100 searches for the received keyword advertisement target text and generates a search result including a keyword advertisement content. At this time, the search result including the keyword advertisement content generated from the keyword advertisement content providing server 3100 does not exclude a search result including the keyword advertisement content for non-advertising, but preferably, is a search result including the keyword advertisement content for advertising. The search result including the keyword advertisement content for advertising includes a search keyword advertisement content of an advertiser in correspondence with a search keyword registered by the advertiser. The search keyword advertisement content of the advertiser can be a text type, such as a search advertising in www.google.com, but also be a non-text type image advertising (a non-text type advertising, such as a banner, multimedia content, and flash file). When the advertiser has made the non-text type keyword advertisement content correspond to the search keyword, it is possible to extract the non-text type keyword advertisement content corresponding to the search keyword.

In the above example, the tags “PRADA” and “bag” are transmitted to the keyword advertisement content providing server 3100, the keyword advertisement content providing server 3100 can generate a search result including a keyword advertisement content for advertising corresponding to the tag “PRADA” and “bag”. Typically, the search result including keyword advertisement contents for advertising may be keyword advertisement contents of the advertiser corresponding to the tag “PRADA” and “bag” under the condition of payment of a preset expense. The advertiser conducts the search keyword advertisement in a scheme of paying the cost of, when a searcher inputs the texts “PRADA” and “bag” as a search word, exposing his/her keyword advertisement contents, or exposing his/her keyword advertisement contents or a specific web site or web page linked with his/her keyword advertisement contents through receiving an action, such as a click after the exposure, of a searcher.

At this time, four problems may be generated in an aspect of the keyword advertisement content providing server 3100. First, the number of search results including the keyword advertisement content for advertising of the keyword advertisement content providing server 3100 may be at least two. In this case, the problem is whether to transmit all or a specific number of search results to the multimedia content service system 100, i.e. the number of keyword advertisement contents to be transmitted. The second problem is how many search results including the keyword advertisement contents corresponding to which tag to transmit when the search results including the keyword advertisement contents corresponding to both the texts “PRADA” and “bag” have to be provided at the same time. That is, the second problem is related to the distribution in response to the request of the multiple keyword advertisement texts. In more detail, when the multimedia content service system 1000 simultaneously makes a request of the search results including the keyword advertisement contents corresponding to both the texts “PRADA” and “bag” (or simultaneously makes a request of the search results within a specific time because the search results including the keyword advertisement contents may be replaced in the multimedia content service system 1000 in real time, but also may be replaced at minimum preset time intervals), the keyword advertisement content providing server 3100 has to decide 1) which search results including the keyword advertisement contents to preferentially provide and 2) the number of keyword advertisement contents included in the search results to be provided.

In order to solve the first and second problems, for example, first, the number of search results including the keyword advertisement contents requested by the multimedia content service system 1000 is set as a constraint and the number of search results should not excess the constraint. As a matter of course, the keyword advertisement content providing server 3100 can transmit the search results including the preset number of keyword advertisement contents in its own typical scheme and the multimedia content service system 1000 can control the number of the transmitted search results including the keyword advertisement contents to be exposed to the user by oneself.

The keyword advertisement content providing server 3100 recognizes, based on each obtained keyword advertisement target text, 1) an advertisement unit price with respect to the exposure and/or click of at least one keyword advertisement content of each advertiser and 2) a click rate with respect to the exposure when the keyword advertisement content is exposed. Therefore, the keyword advertisement content providing server 3100 can maximally obtain the advertisement profits in order of the high advertisement unit price when only 1) the advertisement unit price with respect to the exposure and/or click is applied, and in order of the high expectation (the multiplication of the advertisement unit price and the exposure for each advertiser) of the advertisement costs, when the advertisement is provided upon the click, when 1) the advertisement unit price with respect to the exposure and/or click and 2) the click rate with respect to the exposure are applied at the same time. Therefore, the keyword advertisement content providing server 3100 calculates the expectation of the advertisement costs for each search advertisement keyword with respect to at least one transmitted keyword advertisement target text, mixes the search results including the keyword advertisement contents 2) corresponding to at least two search advertisement keyword 1) based on each search advertisement keyword in order of the high expectations, and generates the search results including the keyword advertisement contents to be transmitted to the multimedia content service system 1000. As a matter of course, when the keyword advertisement content providing server 3100 transmits the keyword advertisement contents for each advertiser to the multimedia content service system 1000, the keyword advertisement content providing server 3100 can transmit information on the advertisement unit price of each keyword advertisement content and/or the click rate with respect to each keyword advertisement content, and the multimedia content service system 1000 can determine the exposure, the exposure rank, and the exposure time of each keyword advertisement content and exposes them to the user. The keyword advertisement content providing server 3100 can receive a keyword advertisement target text from the intermediation server (multimedia content service system 1000), processes the keyword advertisement target text, performs an advertisement search by using the processed keyword advertisement target text, evaluates keyword advertisement contents, grants rank information of the evaluated keyword advertisement contents, and transmits the keyword advertisement contents to the intermediation server (multimedia content service system 1000). At this time, the processing of the keyword advertisement target text can be omitted. The processing of the keyword advertisement target text represents that when the keyword advertisement target text is not a noun, such as a product or service name, or not a text string easily acceptable by the advertisement search server, the keyword advertisement target text is 1) changed to a text string that can be easily accepted by the advertisement search server or 2) replaced with a text string, which is not included in or corresponding to the keyword advertisement target text, but is highly related with the keyword advertisement target text, so as to perform the search by using the text string. For example, when a keyword advertisement target text, “The forecast is for very hot weather today” is received, the keyword advertisement content providing server 3100 processes the text of “very hot” in the sentence and generates a processed text, such as ice cream, related to the hot weather. The specific processing of the search word can be obtained from the research results of the natural word processing.

The example of the processing of the search word is represented in Table 2. It is assumed that the keyword advertisement target text/search advertisement keywords are the texts “PRADA” and “bag”. It is apparent to those skilled in the art that this is an exemplary model, and this model can be easily applied to various modifications of the number of the keywords.

| keyword adver- | | | | |
|---|---|---|---|---|
| tisement target | | | Click rate | Expectation/ |
| text/search | | Advertise- | with respect | expected |
| advertisement | | ment unit | to exposure | advertisement |
| keyword | Advertiser | price ($) | (%) | sale ($) |
| PRADA | A | 5 | 20 | 1.0 |
| PRADA | B | 4 | 10 | 0.4 |
| PRADA | C | 3 | 40 | 1.2 |
| PRADA | D | 2 | 15 | 0.3 |
| bag | E | 3 | 30 | 0.6 |
| bag | F | 2 | 20 | 0.4 |
| bag | G | 1 | 30 | 0.3 |
| bag | H | 0.5 | 20 | 0.1 |
| PRADA bag | I | 10 | 10 | 1.0 |
| PRADA bag | J | 7 | 20 | 1.4 |
| PRADA bag | K | 5 | 20 | 1.0 |
| PRADA bag | L | 3 | 25 | 0.75 |

In the above case, when the keyword advertisement target text/search advertisement keyword is the word “PRADA”, it is preferable to most preferentially expose a keyword advertisement content of advertiser C having the high expectation. When two keyword advertisement contents are necessary to be exposed, it is reasonable to select the keyword advertisement contents of advertisers A and C. It is a matter of course that if the keyword advertisement content having the high advertisement unit price has to be exposed according to the advertisement exposure policy of the keyword advertisement content providing server 3100, the keyword advertisements content should be exposed in order of the advertisers A, B, C and D. When the keyword advertisement contents are exposed through the mixing of the texts “PRADA” and “bag” and the number of keyword advertisement contents is set as three, it is reasonable to expose the keyword advertisement contents of advertisers C, A, and E. That is, the exposure of the keyword advertisement contents of the advertiser E corresponding to the text “bag’ is more reasonable than the exposure of the keyword advertisement contents of the advertiser B corresponding to the text “PRADA”.

If there are advertisers providing the keyword advertisement contents corresponding to the text “PRADA bag” and the keyword advertisement target text/search advertisement keyword are the texts “PRADA” and “bag”, it is preferable to most preferentially expose the keyword advertisement contents of the advertiser J. At this time, when it is necessary to include the keyword advertisement contents of any one of advertisers A, I, and K having the same expectation, the multimedia content service system 1000 confirms the internal policy (generally, it is preferable to expose the keyword advertisement contents of advertisers I and K having two identical search advertisement keywords, and the keyword advertisement contents of advertiser I may be exposed according to the policy) or calculatingly exposes the keyword advertisement contents of advertisers A, I, and K (other systems (multimedia content service system 1000 or meta information based keyword advertisement intermediation system 2000) including information, such as the advertisement unit price, the click rate with respect to the exposure, of the keywords “PRADA’, “bag”, and “PRADA bag” also can select the optimum keyword, as is selected by the keyword advertisement content providing system 3000).

When the multimedia content service system 1000 determines whether to expose the keyword advertisement content and the rank of the keyword advertisement contents, provides at least two keyword advertisement content providing servers 3100 with the keyword advertisement target text/search advertisement keyword, and shares the advertisement profits according to the exposure of the search results including the exposed keyword advertisement contents and the click of the search results including the exposed keyword advertisement contents, and each of the keyword advertisement content providing server 3100 has the different share rate of the profits, the multimedia content service system 1000 may select the exposure of the advertisement of the advertiser having the highest expectation value based on the multimedia content service system 1000, while also taking the profit share rate into consideration. That is, the multimedia content service system 1000 filters the keyword advertisement contents displays according to a preset reference and displays only the filtered keyword advertisement contents, instead of displaying all of the keyword advertisement contents before the exposure of the transmitted keyword advertisement content. The filtering reference is included in a keyword advertisement display module 7900.

The multimedia content service system 1000 exposing the search results including the keyword advertisement contents for advertising (the keyword advertisement display module 7900 included in the multimedia content service system 1000 can perform the exposure) can expose the received keyword advertisement contents to the user according to its own policy. That is, the present invention includes the exposure of the keyword advertisement contents based on the text, which can be obtained from the multimedia contents during the transmission of the multimedia content, so that when the multimedia content service system 1000 exposes the search results including the keyword advertisement contents, the number of obtained texts or search results including the keyword advertisement contents to be exposed may be short in a preset time (the reproduction of the multimedia contents in the user computer requires the passage of time, so that if the passage of time is recognized in an aspect of the time period or the time band, it is possible to determined the time zone) due to other reasons. With regard to this, the keyword advertisement display module 7900 included in the multimedia content service system 1000 can adopt a method of 1) combining the search results including the keyword advertisement contents of a previous time zone with the search results including the keyword advertisement contents of a current time zone and displaying the keyword advertisement contents, 2) pushing in order of the most past search results among the search results including the keyword advertisement contents of a previous time zone by using the search results including the keyword advertisement contents of a current time zone, and 3) filling the shortage of the search results including the keyword advertisement contents with the keyword advertisement contents related to the text based on the UCC tag because the keyword advertisement contents related to the text based on the UCC tag are not related to the reproduction time zone of the multimedia contents.

According to the descriptive expression, the display of the keyword advertisement contents, serving as the search results including the received keyword advertisement contents, is performed by the multimedia content service system 1000, but it does not exclude that the relevant function is performed by the keyword advertisement display module 7900 serving as a program 9100 combined with or linked with the multimedia content service system 1000. That is, the keyword advertisement display module 7900 is related with the multimedia content service system 1000 in a case where 1) both the keyword advertisement display module 7900 and the multimedia content service system 1000 are included (combined) in the same entire program 9100 operated by the same operator, 2) the keyword advertisement display module 7900 and the multimedia content service system 1000 are operated (linked) by separate programs 9100 operated by the same operator, and 3) the keyword advertisement display module 7900 and the multimedia content service system 1000 are operated by separate programs 9100 but cooperate with each other through communicating.

The function of the keyword advertisement display module 7900 of the multimedia content service system 1000 will be sequentially summarized. First, the keyword advertisement display module 7900 obtains keyword advertisement contents obtained from the keyword advertisement content providing server 3100, determines the number of keyword advertisement contents to be displayed according to a preset reference while considering the number of obtained keyword advertisement contents or the length of the keyword advertisement content, synchronizes or asynchronizes a multimedia content reproducing the keyword advertisement contents to be displayed, and transmits the keyword advertisement content to the user computer 9000. At this time, when meta information including additional information on an advertisement unit price (expense per click, etc.) of each of the keyword advertisement contents or the click rate with respect to the exposure is received from the keyword advertisement content providing server 3100, the keyword advertisement display module 7900 can filter the transmission of the keyword advertisement contents according to the preset reference (e.g. the advertisement unit price is equal to or larger then the maximum advertisement unit price, the click rate is equal to or larger than a reference value, the multiplication of the advertisement unit price and the click rate is equal to or larger than a reference value) based on the keyword advertisement content meta information.

It is most preferred that the text obtainment module 3110, the keyword advertisement target text generation module 6510, and the keyword advertisement display module 7900 are operated in the same subject. Such is more required in the text obtainment module 3110 and the keyword advertisement target text generation module 6510. It is preferred that an operation subject of the keyword advertisement display module 7900 and an operation subject of the multimedia content player is the same, but may be different. When an operation subject of the keyword advertisement display module 7900 is different from an operation subject of the multimedia content player, the keyword advertisement display module 7900 may serve as the ASP (Application Service Provider), which provides a person providing at least one multimedia content player service with its service. That is, the person operating the keyword advertisement display module 7900 can expose its service to the user through connecting the keyword advertisement display module 7900 with multiple multimedia content players. At this time, it is more preferable that the person providing the keyword advertisement display module 7900 provides the text obtainment module 3110 and the keyword advertisement target text generation module 6510 in the form of the ASP.

In the above description, it has been described on the assumption that the multimedia content is transmitted to the user computer 9000 in the streaming scheme, etc. by the multimedia content service system 1000. However, this is same in the play/reproduction of the multimedia content on the user computer 9000, which is apparent to those skilled in the art. That is, the multimedia content service system 1000 extracts text information, such as tag information, for the multimedia content provided to the user, combines a keyword advertisement content corresponding to the text information, and provides the user computer 9000 with the multimedia content and the keyword advertisement content. Therefore, the reproduction subject of the multimedia content is not that important in the spirit of the present invention, and the synchronization and asynchronization of the provision of the multimedia content and the keyword advertisement content is the additional issue. That is, when the multimedia content service system 1000 extracts text information from tag information, title information, explanation information, etc., synchronizes/asynchronizes the extracted text information with the keyword advertisement content, and provides the user computer 9000 with the multimedia content and the keyword advertisement content, it is not necessary to correspond the reproduction time of a specific frame of the moving picture to an exposure time of the keyword advertisement content. Therefore, in an aspect of the multimedia content service system 1000, it is only important that which multimedia content has been provided to the user computer 9000 and the connection (relation, matching) between texts included in and extracted from the provided multimedia content. When the multimedia content is an image file, such as a picture, the image file is mostly reproduced in the user computer 9000 (a thumbnail file is generally reproduced in the server of the system or even the thumbnail file is transmitted to the user computer 9000 so that it is viewed on the user computer 9000/the browser executed on the user computer 9000), so that when the multimedia content service system 1000 obtains the one-to-one correspondence between the meta information (tag information, etc.) connected with the image file and the multimedia file transmitted to the user, the multimedia content service system 1000 can execute the advertisement method of the present invention. That is, when the multimedia content service system 1000 generates a web page including information on a specific image file and transmits the generated web page to the browser of the user computer 9000, the multimedia content service system 1000 includes at least one keyword advertisement content based on text information obtained from the meta information, such as the tag information of the image file, in the generated web page and transmit the web page to a preset location of a screen of the user computer 9000, such as a lower area or a side on which the image file is to be displayed. It is apparent that the operation scheme of the multimedia content service system 1000 is identically applied to the transmission of the moving picture file.

Next, the synchronization in the provision of the reproducing of multimedia content and the keyword advertisement content based on text obtained from the multimedia content will be described. In order to induce a user attention and a user action, such as the click, for the keyword advertisement content, it is preferred to display a keyword advertisement content related to script information (including translated script information) or subtitle information displayed during the playing of a specific scene of the multimedia contents. Therefore, it is necessary to synchronize the script information or subtitle information that is changed every moment with the keyword advertisement content.

The synchronization can be achieved by any one of three methods.

The first method is that the multimedia content service system 1000 synchronizes the obtainment of the text with the search result including the keyword advertisement contents in real time. With respect to the multimedia content of which a specific time is played, the multimedia content service system 1000 obtains a text from a script or subtitle within a time section (or frame section) to which the specific time belongs, obtains a keyword advertisement target text from the obtained text, generates a search result including the keyword advertisement contents obtained through inquiring of at least one keyword advertisement content providing server 3100, which can provide a search result including the keyword advertisement contents, and displays the search result on a lower part, a left side, a right side, or a preset location of the player playing the multimedia content. From the obtainment of the keyword advertisement target text within the specific time section (or frame section) to the display of the search result including the keyword advertisement contents is the real time synchronization. According to the first method, a text can be obtained in real time by a voice recognition method, other than the script or the subtitle, so that it can be applied to the application of the voice recognition method, which is different from the second method to be described later.

The second method is that the multimedia content service system 1000 has previously obtained the text and obtained and stored the search result including the keyword advertisement contents, and when the obtained text is represented in the script or subtitle, the multimedia content service system 1000 displays the keyword advertisement content. With respect to the multimedia content of which a specific time is played, the multimedia content service system 1000 obtains a text from the script or subtitle within the section including the specific time prior to the time section (frame section) including the specific time, a keyword advertisement target text from the obtained text, and obtains and stores a search result including the keyword advertisement contents obtained through inquiring of at last one keyword advertisement content providing server 3100, which can provide a search result including the keyword advertisement contents corresponding to the obtained keyword advertisement target text. The stored keyword advertisement content is synchronized with the script or the subtitle information, to be displayed, in accordance with the time or the time section (frame section) in which a script or subtitle information related to the text should be displayed. At this time, it is preferred that the keyword advertisement content is stored with the time or the time section (or frame section). That is, it is preferred that the time or the time section (or frame section) is stored in the keyword advertisement content in a meta tag type or an information type capable of being recognized in the keyword advertisement display module 7900. It is preferred that the keyword advertisement content is displayed on a lower part, a left side, a right side, or a preset location of the player playing the multimedia content. The second method is different from the third method to be described later in that the difference between the obtainment time of the keyword advertisement content and the play time of a specific part of the multimedia content representing the script or subtitle related with the keyword advertisement content is not large (the former is slightly later than the latter, it is preferred to have a difference from one to ten time section (or frame section) units.

At this time, it may be more preferable to represent the keyword advertisement content later than the moving picture or the script as much as a preset time. Because if the advertisement is represented after the user listens about or views a product from the moving picture or the script, and then recognizes and comes to have interest in the product, the click probability is high. If the advertisement is shown as soon as a product is represented in the moving picture of the script, the user may be previously aware of a content of the advertisement, and the user has not become interest in or curious of the product, so that the click probability may decrease. This is identically applied to the input of the time dependent commercial tag, so that it is determined important that the advertisement display start time point should be inserted in an appropriate timing. There are two methods of displaying a time delay keyword advertisement content. One method is to insert a timer to a script (program), make a request of a keyword advertisement content to the multimedia content service system 1000 when it becomes a preset time set in the timer, and receive the keyword advertisement content from the multimedia content service system 1000, and display the keyword advertisement content. The other method is to previously receive a keyword advertisement content and display the keyword advertisement content when a preset time has passed.

The third method is that because the script or subtitle is a file type, the text included in every script or subtitle file is processed by the time section unit based on the time section unit (or frame unit) information included in the script or subtitle, the search results including the keyword advertisement contents corresponding to the texts are obtained in the time section unit, and the search results including the time section information are stored. At this time, when the multimedia content is displayed, the keyword advertisement display module 7900 synchronizes the time section information included in meta information of the multimedia content file that is displayed at a specific time with time section information included in meta information of the keyword advertisement content file and displays the keyword advertisement content.

The sites treating the UCC multimedia contents, such as www.youtube.com, and www.pandora.tv, allow the users to upload the multimedia contents of the UCC photographed, obtained, or generated by the users, transmit the uploaded multimedia contents in a streaming scheme, and reproduce the multimedia contents on the user computer. The length of the UCC multimedia contents is relatively shorter than that of movies, etc. Therefore, the following methods can be applied to the UCC multimedia contents.

When the sites obtain the texts included in the UCC included in the meta information of the UCC multimedia content file and displays the keyword advertisement contents based on the texts included in the UCC, they display the keyword advertisement content independently of the UCC multimedia content 1) in the start of the UCC multimedia content reproduction, 2) during the UCC multimedia content reproduction, and 3) after the completion of the UCC multimedia content reproduction. Especially, when the UCC multimedia content reproduction is completed, it is possible to collect and display the keyword advertisement contents one time.

The third method is most appropriate for the text-type script or subtitle file, but can be applied to the voice recognition method. However, in order to apply to the voice recognition method, the multimedia content to be displayed by the player should be pre-processed.

The pre-processing is to reproduce the multimedia content file, obtain texts from voice information of the reproduced multimedia content, select at least one of, with respect to the obtained texts, 1) the text itself, 2) a keyword advertisement target text obtained from the texts, and 3) a search result including the keyword advertisement content corresponding to the keyword advertisement target text, and store the selected one in accordance with reproduction time section information of the multimedia content. That is, in the pre-processing, with respect to the texts obtained by the player, at least one of 1) the text itself, 2) the keyword advertisement target text obtained from the texts, and 3) the search result including the keyword advertisement content corresponding to the keyword advertisement target text is selected by any one of the above methods and the keyword advertisement content synchronized with the multimedia content is finally displayed to the users.

In the pre-processing of the multimedia content, the multimedia content file itself may be pre-processed, and the multimedia content file itself may include the pre-processed 1) text itself, 2) keyword advertisement target text obtained from the texts, and 3) search result including the keyword advertisement content corresponding to the keyword advertisement target text. Further, when the multimedia content is played on the server by a web multimedia content player, the multimedia content has to be pre-processed before a web multimedia content player plays the multimedia content and transmits the multimedia content to the user in a streaming scheme, and the pre-processed 1) text itself, 2) keyword advertisement target text obtained from the texts, and 3) search result including the keyword advertisement content corresponding to the keyword advertisement target text should be stored in connection with the multimedia content file. It is preferable that the pre-processed texts and the keyword advertisement target text obtained from the pre-processed texts are stored in a single table and the keyword advertisement contents are stored in a separate table. An example of the texts obtained through the voice recognition, etc. and the table storing the keyword advertisement target text are represented in Table 3. At this time, there may be mis-recognized words, etc. If the texts obtained through the voice recognition, etc. and the table storing the keyword advertisement target text, e.g. the inquiring of the advertisement DB, etc. and filtering the texts through passing the product/service name DB, is performed, it is possible to generate a candidate group of the keyword advertisement target texts and select the keyword advertisement target texts among the keyword advertisement target text candidate group.

TABLE 3

| | | Pre-processed text | |
|---|---|---|---|
| Moving | | (after inquiry | keyword |
| picture | Voice recognized | of advertisement | advertisement |
| ID | text | keyword DB) | target text |
| 134738 | Fashion PRADA bag | PRADA bag shoes | PRADA bag |
| | magazine editer shoes | | |

Table 4 represents an example of data included in the keyword advertisement content DB 3120.

TABLE 4

| | Title (keyword | | | |
|---|---|---|---|---|
| Moving | for advertising/ | | | |
| picture | keyword advertise- | Content of | | |
| ID | ment target text) | advertisement | URL | . . . |
| 134738 | PRADA bag | Authenticated | http://www.overture.com/ | |
| | | PRADA Bag | adcon?id=2744& . . . | |
| | | brought for- | | |
| | | ward Product | | |
| | | sale | | |
| 134738 | Famous- | Famous brand | http://www.overture.com/ | |
| | brand bag | Tote bag, | adcon?id=5829& . . . | |
| | | Handbag, | | |
| | | wallet | | |

At this time, it is advantageous to store the relevant contents in a single table for the performance. However, it is possible to insert the relevant contents in zero or at least one column having a preset size in a single table, like the pre-processed text or the keyword advertisement target text. However, in a case in which zero or not-determined number of data, such as the keyword advertisement content corresponding to a single ID, has to be stored or the number of columns constituting a single data are more than one even though the number of data is determined, it is preferable to store the relevant contents in a different table. This is a basic principal in the design of the relational database table.

Next, an exemplary embodiment of the present invention will be described in more detail. First, the common elements will be summarized before the describing of the embodiment of the present invention. In order to implement the spirit of the present invention, the present invention necessarily includes 1) the text obtainment module 3110 extracting texts from multimedia contents, 2) the keyword advertisement target text generation module 6510 generating keyword advertisement target texts from the texts obtained by the text obtainment module 3100, 3) the keyword advertisement content providing server 3100 generating search results including keyword advertisement contents for advertising corresponding to the keyword advertisement target texts, 4) the multimedia content providing module streaming the multimedia contents to the users, and 5) the keyword advertisement display module 7900 controlling the exposure of keyword advertisement contents for advertising or generating a script or program for controlling the exposure of keyword advertisement contents for advertising.

The embodiments are variously implemented according to who, how, or when to operate the 1) to 3) and whether the operation subject is the same or not. The relation of the 4) and 5) has been described in the above so that the additional description will be omitted, other than the special case. The functions of the text obtainment module 3110, the keyword advertisement target text generation module 6510, and the keyword advertisement display module 7900 have been sufficiently described in the above, so that the present embodiment will be described mainly focused on the entire construction subject and the scope of the module included in each subject.

According to the above description, the keyword advertisement target text generation module 6510 generates keyword advertisement target texts in real time from meta information included in specific multimedia content information (especially, the moving picture content information) selected by a user. In the meantime, the keyword advertisement target text generation module 6510 1) obtains information of each of at least one multimedia content included in the multimedia content DB 1110 of the multimedia content service system 1000, 2) obtains meta information included in each of the multimedia content files, 3) selects one method among the methods of generating the keyword advertisement target text in real time, which have been described in the present specification, and previously generates keyword advertisement target texts for each of the multimedia contents by using the selected method, and 4) matches the generated keyword advertisement target text to the multimedia content and stores the multimedia contents. When the multimedia contents are provided to the user computer 9000, the information of the keyword advertisement target text, which has been previously generated and stored, are explicitly included or included in a hidden type in the multimedia contents. When the user selects the specific multimedia content through a click, etc., the keyword advertisement target text generation module 6510 inquires of the keyword advertisement content providing system 3000 with the keyword advertisement target text included in the selected multimedia content. The previously generated keyword advertisement target text can be another meta information in an aspect of the multimedia contents. Therefore, it can be interpreted that the meta information of the specific multimedia contents includes the previously generated keyword advertisement target text. When the previously generated keyword advertisement target text is utilized as meta information, the meta information obtainment module can obtain the previously generated keyword advertisement target text, and the keyword advertisement target text generation module 6510 does not function or authorizes without changing of the previously generated keyword advertisement target text, or when the difference between the previous generation time and the current time is equal to or larger than a preset degree or there is a new policy, modifies or changes the previously generated keyword advertisement target text.

With regard to this, there are two methods of querying the keyword advertisement target text included in the selected multimedia contents to the keyword advertisement content providing system 3000. The first method is, by the multimedia content service system 1000, obtaining selection information of the specific multimedia content, transmitting the stored keyword advertisement target texts corresponding to the multimedia content to the keyword advertisement content providing system 3000, and obtaining at least one keyword advertisement content from the keyword advertisement content providing system 3000. The second method is, in a state in which a script program, such as the JavaScript, and the previous generated keyword advertisement target text corresponding to the multimedia content are included in a page including the multimedia content to be transmitted to the user, by the JavaScript program, querying the keyword advertisement target text to the keyword advertisement content providing system 3000, obtaining keyword advertisement contents from the keyword advertisement content providing system 3000, and displaying the obtained keyword advertisement contents on a preset keyword advertisement content display area 100 around the multimedia content.

Hereinafter, the spirit of the present invention will be described in detail with reference to the drawings and the embodiments.

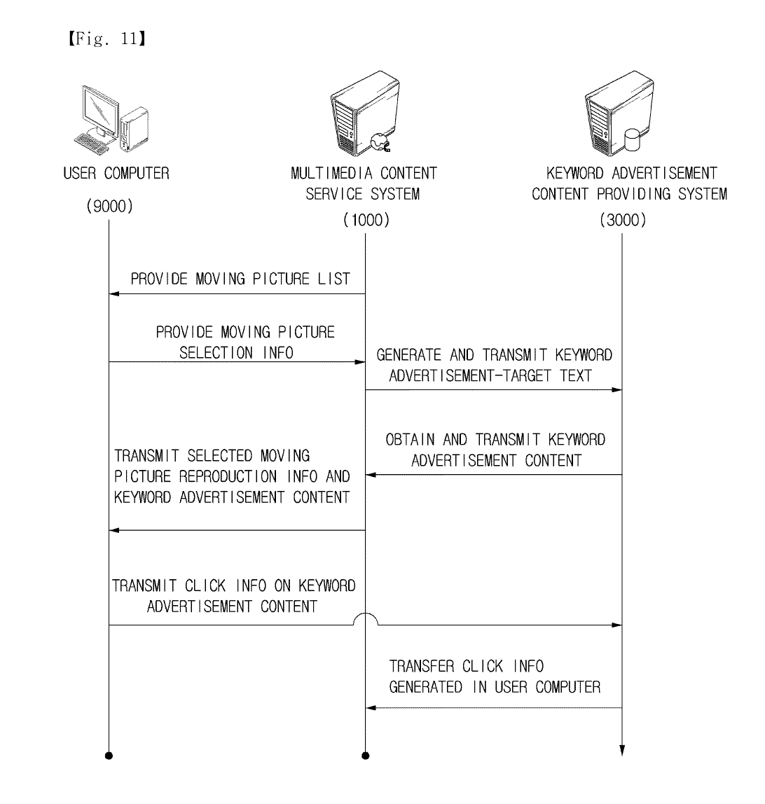

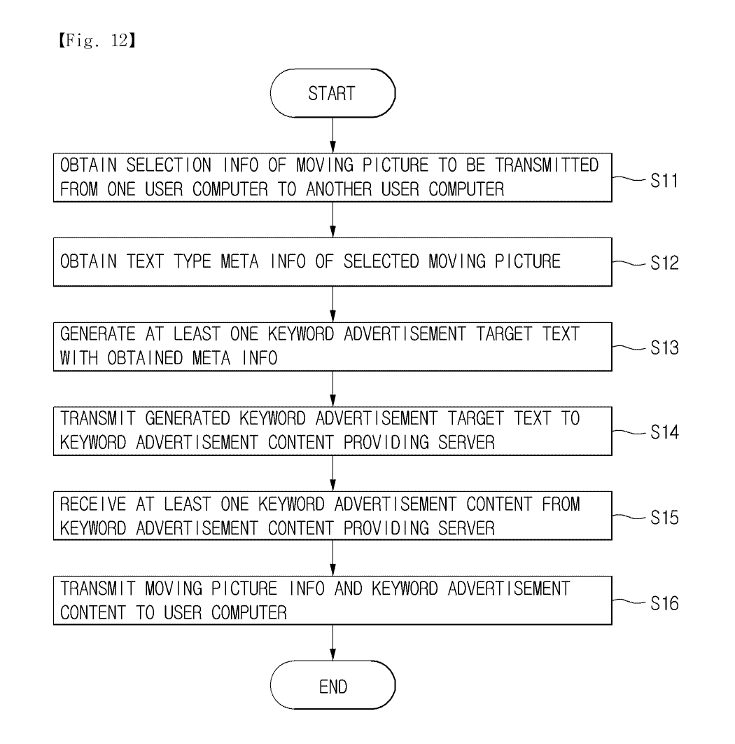

First, an embodiment of an operation of the multimedia content service system 1000 of the disintermediation model will be described with reference to FIGS. 10 to 12. The disintermediation model represents a model not including the meta information based keyword advertisement intermediation system 2000 for implementing the present invention, and the core of the present invention is the construction of the multimedia content service system 1000 and the information processing method, and is related to the keyword advertisement content providing system 3000 including the user computer 9000 and the keyword advertisement content providing server 3100.

The multimedia content service system 1000 including the multimedia content service server 1100, which transmits a moving picture selected by a user to the user computer 9000 in a streaming scheme, obtains selection information of a moving picture to be transmitted to the user computer 9000 from the user computer 9000 (S11), obtains text-type meta information of the selected moving picture (S12), generates at least one keyword advertisement target text from the obtained meta information (S13), transmits the generated keyword advertisement target text to the keyword advertisement content providing server 3100 (S14), receiving at least one keyword advertisement content from the keyword advertisement content providing server 3100 (S15), and transmits the moving picture information and the keyword advertisement content to the user computer 9000 (S16). The keyword advertisement content providing server 3100 includes the keyword advertisement content providing server-side text obtainment module 3110 receiving a text, the keyword advertisement content DB 3120 including at least one advertisement content, and the keyword advertisement content providing server-side keyword advertisement content transmission module 3130 transmitting the keyword advertisement content. The keyword advertisement content providing server 3100 obtains at least one keyword advertisement content corresponding to the keyword advertisement target text received from the multimedia content service system 1000 from the keyword advertisement content DB 3120 and transmits the obtained keyword advertisement content to the multimedia content service server 1100. The information obtained by the keyword advertisement content providing server-side text obtainment module 3110 is the text type. The text-type information includes tag information, title information, explanation information, and other text-type information. It is a matter of course that the text-type information includes the keyword advertisement target texts.

When the multimedia content service system 1000 obtains the meta information, it is preferred that the meta information includes at least one selected from title information, tag information, explanation information, and a commercial tag of the moving picture included in the moving picture information. It is preferred that the commercial tag set is generated by the commercial tag set generation system 10000. The commercial tag represents a tag, which guarantees the existence of at least one keyword advertisement content or undergoes the verification of the existence of at least one keyword advertisement content based on a specific time through inquiring about the existence of at least one keyword advertisement content. The selection of the meta information is determined by the meta information selection policy of the keyword advertisement control policy DB 6540, the keyword advertisement control policy DB 6540 includes the keyword advertisement control policy, and the keyword advertisement control policy preferably includes information on the selection reference of meta information. The content of the keyword advertisement control policy DB 6540 has been previously described.

The selection reference of the meta information is at least one of (a) when tag information is included in obtained meta information, first selecting the tag information, (b) when tag information is included in obtained meta information, selecting both tag information and title information, (c) when tag information is not included in obtained meta information, selecting title information, and (d) when tag information is not included in obtained meta information, selecting both tag information and title information.

The generating of at least one keyword advertisement target text based on the selected meta information includes at least one of, when the meta information is title information, (a) a method of generating words and phrases included in the advertisement keyword DB 6570 among words and phrases included in the title information as keyword advertisement target texts, (b) a method of analyzing words and phrases included in the title information through the natural language processing, extracting at least one product or service name, and generating the extracted names as keyword advertisement target texts, and (c) a method of generating only the names corresponding to the texts and phrases included in the advertisement keyword DB 6570 among the names extracted by the method (b) as keyword advertisement target texts, when the meta information is tag information, (a) a method of generating tags included in the advertisement keyword DB 6570 among at least one tag included in the tag information as keyword advertisement target texts, (b) a method of generating all tags included in the tag information as keyword advertisement target texts, (c) a method of, when multiple tags are included in the tag information, generating only tags within a preset rank as keyword advertisement target texts, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target texts, (b) a method of analyzing words and phrases included in the explanation information through the natural language processing, extracting at least one product or service name, and generating the extracted names as keyword advertisement target texts, (c) a method of generating only the names corresponding to the texts and phrases included in the advertisement keyword DB 6570 among the names extracted by the method (b) as keyword advertisement target texts, and (d) a method of calculating a frequency of the names extracted by the method (b) and generating only names within a preset rank in order of the highest frequency as keyword advertisement target texts. The advertisement keyword DB 6570 is the DB collecting the advertisement target keywords subjected to the keyword advertisement. The name consists of at least one word, and includes at least one of a product name, a service name, an advertisement keyword list received from the keyword advertisement content providing server 3100, an advertisement keyword list obtained from a third person, a self generated advertisement keyword list, a keyword advertisement target text list creating advertisement profits, a company name, a domain name, a noun, a slogan, and a brand.

The generation of at least one keyword advertisement target text with the selected meta information includes multiple steps of the first step of generating a keyword advertisement target text candidate and the second step of inquiring of the keyword advertisement content providing server 3100 about the generated keyword advertisement target text candidate and generating keyword advertisement target texts with reference to an inquiry result. This process is similar with that of the generation of the commercial tag. The commercial tag refers to a tag generated by a method, in which a commercial tag generator directly generates a commercial tag candidate independently of meta information, inquires of the advertisement keyword DB 6570 or the keyword advertisement content providing system 3000 about the generated tag candidate, and tags satisfying a preset reference or selected by the generator are generated as the commercial tags with reference to the inquiry result.

The first step of generating the keyword advertisement target text candidate includes at least one of, when the meta information is title information, (a) a method of generating words and phrases included in the advertisement keyword DB 6570 among words and phrases included in the title information as keyword advertisement target text candidates, (b) a method of analyzing words and phrases included in the title information through the natural language processing, extracting at least one product or service name, and generating the extracted names as keyword advertisement target text candidates, and (c) a method of generating only names corresponding to the texts and phrases included in the advertisement keyword DB 6570 among the names extracted by the method (b) as keyword advertisement target text candidates, when the meta information is tag information, (a) a method of generating tags included in the advertisement keyword DB 6570 among at least one tag included in the tag information as keyword advertisement target text candidates, (b) a method of generating all tags included in the tag information as a keyword advertisement target text candidates, (c) a method of, when multiple tags are included in the tag information, generating only tags within a preset rank as keyword advertisement target text candidates, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target text candidates, (b) a method of analyzing words and phrases included in the explanation information through the natural language processing, extracting at least one product or service name, and generating the extracted names as keyword advertisement target text candidates, (c) a method of generating only the names corresponding to the texts and phrases included in the advertisement keyword DB 6570 among the names extracted by the method (b) as keyword advertisement target text candidates, and (d) a method of calculating a frequency of the names extracted by the method (b) and generating only names within a preset rank in order of the highest frequency as keyword advertisement target text candidates. The advertisement keyword DB 6570 is the DB collecting the advertisement target keywords subjected to the keyword advertisement. The name consists of at least one word, and includes at least one of a product name, a service name, a company name, a domain name, a noun, a slogan, and a brand.

The generation of at least one keyword advertisement target text candidate based on the selected meta information by the keyword advertisement target text generation module 6510 further includes the third step of identifying of whether the inquiry result of the keyword advertisement content providing server 3100 satisfies the policy of the keyword advertisement control policy DB 6540. The identifying of whether the inquiry result of the keyword advertisement content providing server 3100 satisfies the policy of the keyword advertisement control policy DB 6540 includes obtaining, from the keyword advertisement content providing server 3100, at least one of, in relation to the keyword advertisement target text candidate, (a) information regarding whether keyword advertisement contents corresponding to the keyword advertisement target text candidate are included in the keyword advertisement content providing server 3100, (b) information of the maximum number of transmittable keyword advertisement contents, (c) information of a higher advertisement unit price of at least one keyword advertisement content within a preset rank, and (d) information of an expected click rate with respect to exposure of at least one keyword advertisement content, and inquiring of the keyword advertisement control policy DB 6540 about a policy reference corresponding to at least one of the (a), (b), (c), and (d) obtained from the keyword advertisement content providing server 3100. The keyword advertisement control policy DB 6540 includes the keyword advertisement control policy, and the keyword advertisement control policy preferably includes information on reference of the keyword advertisement target text generation.

It is preferred that the reference of the inquiry result includes, with respect to each of the keyword advertisement target text candidates or the keyword advertisement target candidate in the unit of a preset group, transmitting the keyword advertisement target text candidates to the keyword advertisement content providing server 3100 and obtaining identification information of the existence of the keyword advertisement contents corresponding to the keyword advertisement target text candidates from the keyword advertisement content providing server 3100.

The transmitting of the generated keyword advertisement target texts to the keyword advertisement content providing server 3100 includes at least one of (a) a method of transmitting all of the generated keyword advertisement target texts to the keyword advertisement content providing server 3100 and (b) a method of classifying the generated keyword advertisement target texts according to a type of meta information, on which the generated keyword advertisement target text is based, and transmitting the keyword advertisement target texts based on at least one selected type of the meta information to the keyword advertisement content providing server 3100.

The transmitting of the generated keyword advertisement target texts to the keyword advertisement content providing server 3100 includes at least one of, when the number of multiple keyword advertisement target texts are more than one, (a) a method of transmitting the generated multiple keyword advertisement target texts only at one time, (b) a method of separately transmitting of the generated multiple keyword advertisement target texts one by one, and (c) a method of dividing the generated multiple keyword advertisement target texts into at least two groups and transmitting of the keyword advertisement target texts in the unit of the group, but when there are multiple keyword advertisement target texts included in the same group, any one between the method (a) and the method (b) is applied.

Further, it is preferred that the transmitting of the generated keyword advertisement target texts to the keyword advertisement content providing server 3100 further includes a step of granting a management number to the generated keyword advertisement target texts and mapping the generated keyword advertisement target texts to the keyword advertisement contents obtained from the keyword advertisement content providing server 3100 based on the management number.

Further, it is preferred that the transmitting of the generated keyword advertisement target texts to the keyword advertisement content providing server 3100 further includes a step of, when the number of generated keyword advertisement target texts are more than one and the generated multiple keyword advertisement target texts are managed in the unit of at least one group, granting a management number to the group and each of the generated keyword advertisement target texts included in the groups, and mapping the keyword advertisement target texts included in the groups to the keyword advertisement contents obtained from the keyword advertisement content providing server 3100 based on the management number.

Further, it is preferred that the transmitting of the generated keyword advertisement target texts to the keyword advertisement content providing server 3100 further includes a step of, when the number of keyword advertisement contents received by the keyword advertisement content providing server 3100 are more than one, selecting at least one keyword advertisement content to be transmitted to the user computer 9000 based on a specific time among the keyword advertisement contents.

In the selection of the keyword advertisement contents, it is preferred that among multiple keyword advertisement contents received from the keyword advertisement content providing server 3100, a preset number of keyword advertisement contents is set as the maximum number and the keyword advertisement contents equal to or less than the preset number are selected.

In the selection of the keyword advertisement contents, the keyword advertisement contents are selected according to the type of the meta information on which the keyword advertisement target texts are based. It is preferable to inquire of the keyword advertisement content providing server 3100 about each of the keyword advertisement target texts and then obtain the keyword advertisement contents corresponding to each of the keyword advertisement target texts from the keyword advertisement content providing server 3100.

In the selection of the keyword advertisement contents, when the number of keyword advertisement contents received by the keyword advertisement content providing server 3100 are more than one, the number of keyword advertisement contents to be transmitted to the user computer 9000 based on a specific time has been set, and the number of keyword advertisement contents are larger than the number of keyword advertisement contents to be transmitted to the user computer 9000 based on the specific time, it is preferable to divide the multiple keyword advertisement contents into at least two groups and select the keyword advertisement contents included in the group in the unit of the group. It is preferred that the number of keyword advertisement contents included in each group is equal to or less than the number of keyword advertisement contents to be transmitted to the user computer 9000 based on the specific time.

The transmitting of the moving picture information and the keyword advertisement contents to the user computer 9000 includes at least one of (a) a method of dividing the moving picture information area and the keyword advertisement content area 100, generating an information unit to be transmitted to the user computer 9000, synchronizing the moving picture information area with the keyword advertisement content area 100, and transmitting of the moving picture information and the keyword advertisement contents to the user computer 9000 and (b) a method of dividing the moving picture information area and the keyword advertisement content area 100, generating an information unit to be transmitted to the user computer 9000, and asynchronizing the moving picture information area with the keyword advertisement content area 100, and transmitting the moving picture information and the keyword advertisement contents to the user computer 9000, respectively.

When the method (b) is selected, at least one keyword advertisement content to be transmitted to the keyword advertisement content area 100 is preferably changed according to the passage of time.

The time is preferably within a preset time range.

The time range is determined by at least one variable selected from (a) the number of selected keyword advertisement contents received from the keyword advertisement content providing server 3100, (b) the number of keyword advertisement contents selected from among the keyword advertisement contents received by the keyword advertisement content providing server 3100, (c) the number of keyword advertisement contents to be transmitted to the user computer 9000 based on a specific time, and (d) a reproduction time of the moving picture.

Further, the transmitting of the moving picture information and the keyword advertisement contents to the user computer 9000 further includes the steps of: recording a transmission time of at least one keyword advertisement content transmitted to the user computer 9000 by the multimedia content service server 1100; and monitoring click generation of the keyword advertisement content up to a preset time, and when click generation information of the keyword advertisement content has not been obtained by the preset time, transmitting a preset number of keyword advertisement contents selected from among keyword advertisement contents received by the keyword advertisement content providing server 3100, other than the keyword advertisement contents transmitted to the user computer 9000, to the user computer 9000.

Further, the transmitting of the moving picture information and the keyword advertisement contents to the user computer 9000 further includes the steps of: recording a transmission time of at least one specific keyword advertisement content transmitted to the user computer 9000 by the multimedia content service server 1100; and monitoring whether to generate the click for the specific keyword advertisement content up to a preset time, and it is preferred that when the multimedia content service server 1100 has obtained click generation information of the specific keyword advertisement content within the preset time, the keyword advertisement contents transmitted to the user computer 9000 are not changed from a time of obtaining the click generation information to a preset second time.

Further, the transmitting of the moving picture information and the keyword advertisement contents to the user computer 9000 further includes the steps of: when the multimedia content service server 1100 has not obtained additional click generation information of the keyword advertisement contents transmitted to the user computer 9000 by the second time, transmitting a preset number of keyword advertisement contents selected from among keyword advertisement contents received by the keyword advertisement content providing server 3100, other than the keyword advertisement contents transmitted to the user computer 9000, to the user computer 9000.

It is preferred that the transmitting of the moving picture information and the keyword advertisement contents to the user computer 9000 further includes the steps of: recording a transmission time of at least one specific keyword advertisement content transmitted to the user computer 9000 by the multimedia content service server 1100; and monitoring a generation of a click for the specific keyword advertisement content up to a preset time, and when click generation information of the specific keyword advertisement content has been obtained within the preset time, transmitting keyword advertisement contents related to the keyword advertisement content corresponding to the click generation to the user computer 9000.

The keyword advertisement contents related to the keyword advertisement content corresponding to the click generation refers to (a) other at least one keyword advertisement content among the keyword advertisement contents obtained when the specific keyword advertisement target text is transmitted to the keyword advertisement content providing server 3100 in a case where the keyword advertisement content corresponding to the click generation is the keyword advertisement content obtained through transmitting at least one specific keyword advertisement target text to the keyword advertisement content providing server 3100, (b) at least one keyword advertisement content obtained through transmitting another keyword advertisement target text obtained from the same meta information, on which the keyword advertisement target texts are based, to the keyword advertisement content providing server 3100 in a case where the keyword advertisement content corresponding to the click generation is the keyword advertisement content obtained through transmitting at least one specific keyword advertisement target text to the keyword advertisement content providing server 3100, (c) at least one keyword advertisement content obtained through transmitting the other keyword advertisement target texts to the keyword advertisement content providing server 3100, when the specific keyword advertisement target text is included in a specific group and other keyword advertisement target texts are included in the group in addition to the specific keyword advertisement target text in a case where the keyword advertisement content corresponding to the click generation is the keyword advertisement content obtained through transmitting at least one specific keyword advertisement target text to the keyword advertisement content providing server 3100.

It is preferred that the transmitting of the moving picture information and the keyword advertisement contents to the user computer 9000 further includes at least one step of obtaining click generation information of the keyword advertisement content transmitted to the user computer 9000; and transmitting click generation information of the keyword advertisement content transmitted to the user computer 9000. It is preferred that the click generation information is directly obtained from the user computer 9000 and/or obtained from the keyword advertisement content providing server 3100. It is preferred that the click generation information is transmitted to the keyword advertisement content providing server 3100 and/or a preset third server.

The moving picture includes at least one of a real photograph moving picture, a non-real photograph moving picture, a UCC moving picture, a movie, a flash moving picture, a real-time broadcasting, and a recorded broadcasting including text-type meta information.

Next, an exemplary embodiment of the construction of the multimedia content service system 1000 of the non-intermediation model will be described with reference to FIGS. 10 to 12.

The multimedia content service system including the multimedia content service server 1100, which transmits moving picture information of a moving picture selected by a user to the user computer 9000, includes a multimedia content DB including at least one moving picture contents, a multimedia content transmission module 1120 streaming the selected moving picture contents when selection information for the moving picture contents is received from the user computer 9000, a meta information obtainment module 5100 obtaining meta information of the selected moving picture, a keyword advertisement target text generation module 6510 generating at least one keyword advertisement target text based on meta information obtained from the meta information obtainment module 5100, a keyword advertisement content obtainment module 6530 obtaining at least one keyword advertisement content corresponding to the keyword advertisement target texts generated by the keyword advertisement target text generation module 6510 from the keyword advertisement content providing server 3100, and the keyword advertisement display module 7900 generating a program, such as a script code, controlling so as to display the keyword advertisement contents obtained by the keyword advertisement content obtainment module 6530 on a preset location that is discriminated from the moving picture area on which the moving picture is reproduced and displayed or directly controlling the display of the keyword advertisement contents in a preset scheme (operated in a file download scheme, and when the keyword advertisement display module is operated in an exclusive software reproducing the downloaded file, the direct control is possible). The keyword advertisement content providing server 3100 includes the keyword advertisement content providing server-side text obtainment module 3110 receiving the texts, the keyword advertisement content DB 3120 including at least one advertisement content, and keyword advertisement content providing server-side text transmission module 3130 transmitting the keyword advertisement contents. The keyword advertisement content providing server 3100 obtains at least one keyword advertisement content corresponding to the received text from the keyword advertisement content DB 3120 and transmits the obtained keyword advertisement content to the multimedia content service system 1100.

The meta information obtained by the meta information obtainment module 5100 includes at least one of title information, tag information, explanation information, and a commercial tag set of the moving picture included in the moving picture information. It is preferred that the commercial tag set is generated by the commercial tag generation system 10000 and the commercial tag generation system 10000 is included in the multimedia content service system 1000 or in an external side in a method of transmitting/receiving information in connection with the multimedia content service system 1000 and the wired/wireless network 8000. The multimedia content service system further includes the keyword advertisement control policy DB 6540 including the keyword advertisement control policy. The meta information is selected according to the meta information selection policy of the keyword advertisement control policy DB 6540, and the keyword advertisement control policy includes information of a selection reference of the meta information.

Intermediation Model

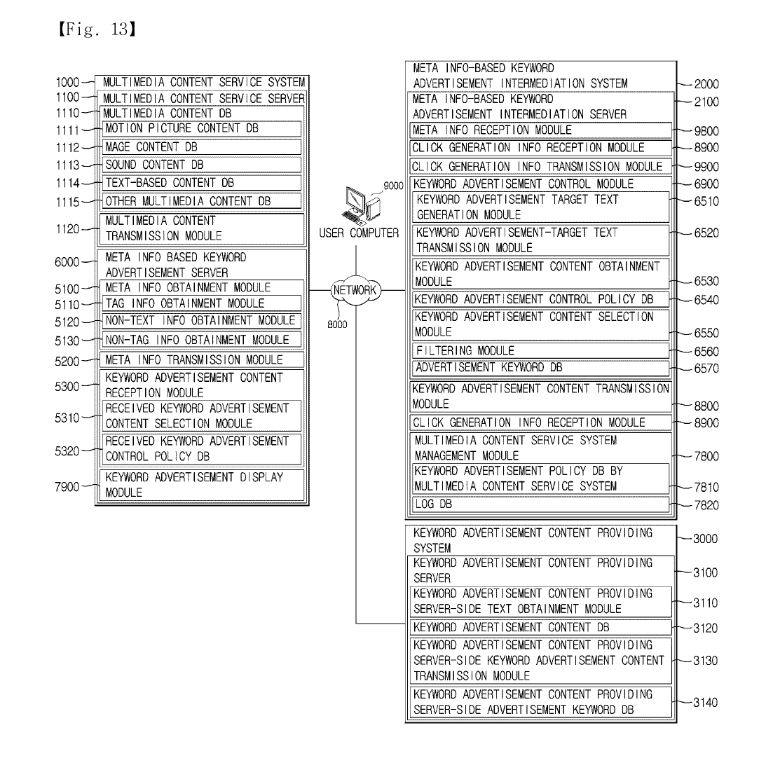

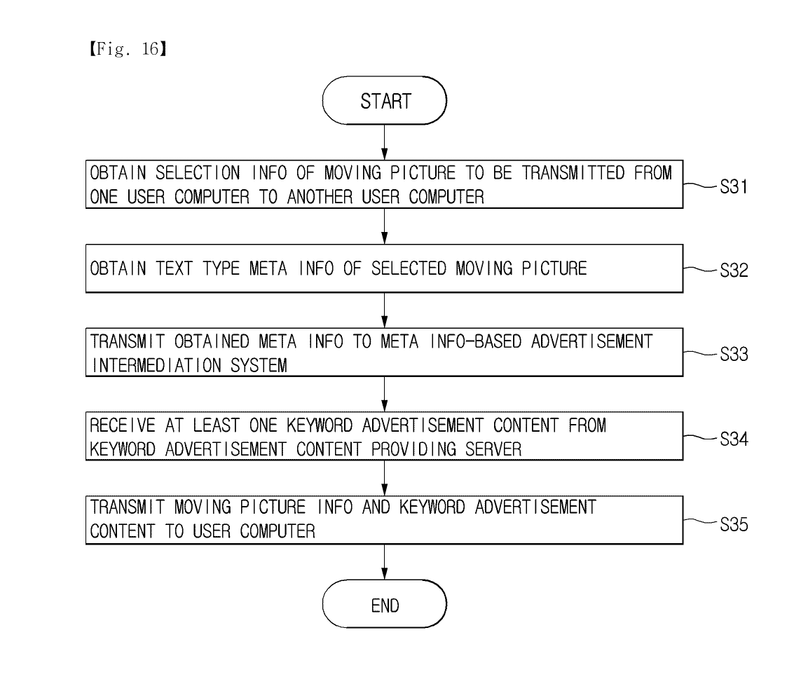

A method and system for providing a keyword advertisement service based on meta information included in moving picture information by a moving picture multimedia content service system of an intermediation model will be described with reference to FIGS. 13 to 17. In the above, the structure of the multimedia content service system 1000 including both the multimedia content service server 1100 and the meta information based keyword advertisement server 6000 has been described, such a construction refers to a disintermediation model. The multimedia content service server 1100 and the meta information based keyword advertisement server 6000 are not independently controlled, but conceptually one to one correspond to each other.

As shown in FIG. 13, the third independent system can perform a function of the meta information based keyword advertisement server 6000 for at least one multimedia content service system 1000. An entity or a part of the functions of the meta information based keyword advertisement server 6000, serving as internal elements of the multimedia content service system 1000, are located outside of the multimedia content service system 1000, and the third system can perform a function of the meta information based keyword advertisement server 6000 for at least one multimedia content service system 1000. The third system is named as a meta information based keyword advertisement intermediation system 2000 and a server performing the meta information based keyword intermediation in the meta information based keyword advertisement intermediation system 2000 is referred to as a meta information based keyword advertisement intermediation server 2100. The structure of the keyword advertisement service inducing the third intermediation system is referred to as the intermediation model. In the intermediation model, the multimedia content service system requires the meta information based keyword advertisement server 6000, which obtains and transmits meta information, and receives and/or display keyword advertisement contents.

Hereinafter, the intermediation model will be described in more detail.

Structure of the Intermediation Model

Three kinds of the intermediation model

There are three kinds of the intermediation model.

1) In the first kind of the intermediation model, the multimedia content service system 1000 including multimedia contents transmits non-processed meta information (tag, title) of multimedia contents or processed meta information (meta information in a level of a keyword advertisement target text or information including extracted tag information) to the meta information based keyword advertisement intermediation system 2000, the meta information based keyword advertisement intermediation system 2000 transmits keyword advertisement target texts to the internal or external keyword advertisement content providing server 3100, and keyword advertisement contents obtained by the keyword advertisement content providing server 3100 are transmitted to the multimedia content service system or the user computer 9000 through the meta information based keyword advertisement intermediation system 2000. In this model, when the meta information based keyword advertisement intermediation system 2000 directly or indirectly obtains click generation information of a specific keyword advertisement content from the user computer, it is necessary to transmit the click generation information to the multimedia content service system 1000 or the keyword advertisement content providing server 3100.

In Korea, there is a syndication company (which is not related to the content syndication to be described later) between an operator of the keyword advertisement content providing system 3000, www.overture.co.kr, and an agent (the multimedia content service system 1000 is a kind of agent), such as www.pandora.tv or www.naver.com. The syndication company obtains the meta information from the agent and processes the obtained meta information or transmits the meta information to the keyword advertisement content providing system 3000 as it is. The syndication agent is a special example of the operator of the meta information based keyword advertisement intermediation system 2000.

2) In the second kind of the intermediation model, the multimedia content service system 1000 transmits non-processed meta information (tag, title) of multimedia contents or processed meta information (meta information (in a level of a keyword advertisement target text) to the meta information based keyword advertisement intermediation system 2000, the meta information based keyword advertisement intermediation system 2000 transmits keyword advertisement target texts to the internal or external keyword advertisement content providing server 3100, and the keyword advertisement content providing server 3100 directly transmits the keyword advertisement contents to the multimedia content service system 1000.

In this model, the meta information based keyword advertisement intermediation system 2000 is necessary to directly or indirectly obtain click generation information of a specific keyword advertisement content in the user computer from the multimedia content service system 1000 or the keyword advertisement content providing server 3100.

3) In the third kind of the intermediation model, the multimedia content service system 1000 transmits non-processed meta information (tag, title) of multimedia contents or processed meta information (meta information (in a level of a keyword advertisement target text) to the keyword advertisement content providing server 3100, and the keyword advertisement content providing server 3100 transmits keyword advertisement contents to the multimedia content service system 1000 or the user computer 9000 through the meta information based keyword advertisement intermediation system 2000.

The first kind 1) of the intermediation model is the core intermediation model. However, when keyword advertisement contents are transmitted to the user through any route and the meta information based keyword advertisement intermediation system 2000 obtains click information of a user for a specific content advertisement content, serving as a reference of advertisement profits, the meta information based keyword advertisement intermediation system 2000 achieves the meta information based keyword advertisement intermediation, so that the second kind 2) and the third kind 3) of the intermediation model also definitely have the high business potential.

Hereinafter, the first kind of the intermediation model will be described in detail. When the meta information based keyword advertisement intermediation system 2000 adopts the second kind 2) of the intermediation model, it is necessary to receive information of keyword advertisement contents transmitted from the multimedia content service server 1100 or the keyword advertisement content providing server 3100, click generation information of the keyword advertisement contents, etc. in real time or non-real time. When the meta information based keyword advertisement intermediation system 2000 adopts the third kind 2) of the intermediation model, it is necessary to receive click generation information of the keyword advertisement contents from the multimedia content service server 1100 or the keyword advertisement content providing server 3100. In the meantime, when the keyword advertisement contents are transmitted to the multimedia content service server 1100 through the meta information based keyword advertisement intermediation system 2000, the meta information based keyword advertisement intermediation system 2000 can insert a code capable of automatically obtaining generation information, such as a click of the keyword advertisement contents, to the meta information based keyword advertisement intermediation system 2000.

Multimedia Content Service System 1000

In the intermediation model, the multimedia content service system 100 includes the multimedia content service server 1100 and the meta information based keyword advertisement server 6000. The meta information based keyword advertisement server 6000 in the intermediation model does not have a function of the keyword advertisement control module 6900 of the disintermediation model or includes only limited function module. The function of the multimedia content service server 1100 in the intermediation model is substantially identical to that of the keyword advertisement control module 6900 of the intermediation model. First, a description will be given based on the multimedia content service system 1000 of the intermediation model, which does not have a function of the keyword advertisement control module 6900 of the disintermediation model.

In the intermediation model, the multimedia contents are included in the multimedia content service system 1000, so that meta information of the multimedia contents is also included in the multimedia content service system 1000. At this time, meta information based keyword advertisement server 6000 of the multimedia content service system 1000 includes the meta information obtainment module 5100 and the keyword advertisement display module 7900 of the disintermediation model, and additionally includes a meta information transmission module 5200 and a keyword advertisement content reception module 5300. The meta information transmission module 5200 transmits obtained meta information to the meta information based keyword advertisement intermediation server 2100 of a third server. That is, in the disintermediation model, meta information obtained in the meta information obtainment module 5100 is transferred to the keyword advertisement control module 6900, but in the intermediation model, the meta information obtained in the meta information obtainment module 5100 is transferred to the meta information based keyword advertisement intermediation server 2100. At least one keyword advertisement content is transferred from the meta information based keyword advertisement intermediation server 2100 or the keyword advertisement content providing server 3100 depending on the occasions to the multimedia content service system 1000, and the keyword advertisement content reception module of the multimedia content service system 1000 receives the transmitted keyword advertisement content.

The processing of the received keyword advertisement content by the keyword advertisement display module 7900 in the intermediation model is identical to that in the disintermediation model.

All of the keyword advertisement content received in the keyword advertisement content reception module 5300 can be processed in the keyword advertisement display module 7900, but only the keyword advertisement contents satisfying a preset condition among the entire received keyword advertisement contents are selected and the keyword advertisement display module 7900 processes the selected keyword advertisement contents. In order to select the keyword advertisement contents, the multimedia content service system 100 includes a received keyword advertisement control policy DB 5320 and a received keyword advertisement content selection module 5310. The function of the received keyword advertisement content selection module 5310 is identical to that of the keyword advertisement content selection module 6550 in the disintermediation module. The received keyword advertisement control policy DB 5320 is entirely or partially identical to the keyword advertisement control policy DB 6540 in the disintermediation module 6540. The received keyword advertisement content selection module 5310 obtains meta information of the received keyword advertisement contents with reference to the received keyword advertisement control policy DB 5320 and selects keyword advertisement contents so as to maximize the entire advertisement profits. The specific embodiment of maximizing the entire advertisement profits with reference to the received keyword advertisement control policy DB 5320 by the received keyword advertisement content selection module 5310 is equivalent or identical to the description of the keyword advertisement content selection module 6550 and the keyword advertisement control policy DB 6540 of the disintermediation model.

The case in which the keyword advertisement target text generation module 6510 is included in the multimedia content service server 110 is the case where the meta information obtainment module 5100 of the multimedia content service server 110 obtains only tag information or tag information and transmits the tag information as meta information to the meta information based keyword advertisement intermediation server 2100. In this case, the keyword advertisement target text generation module 6510 of the meta information based keyword advertisement intermediation server 2100 is not necessary to perform other functions. In the extreme case, when the meta information based keyword advertisement intermediation server 2100 obtains and processes only the tag information, the keyword advertisement target text generation module 6510 is not included in the meta information based keyword advertisement intermediation server 2100 or the keyword advertisement target text generation module 6510 may perform only a simple pass function without performing an independent function. The premise of the extreme case is that the meta information based keyword advertisement intermediation server 2100 has to obtain only the tag information from every multimedia content service system 1000 which the meta information based keyword advertisement intermediation server 2100 accesses and process the tag information, and should not obtain information other than the tag information or process other information even if the meta information based keyword advertisement intermediation server 2100 receives other information. When one multimedia content service system 1000 obtains only tag information and another multimedia content service system 1000 obtains other text information other than tag information, the fact that the meta information based keyword advertisement intermediation server 2100 includes the keyword advertisement target text generation module 6510 is preferable to perform the meta information based keyword advertisement intermediation service with respect to the several multimedia content service systems 1000. Therefore, independent of the inclusion of the keyword advertisement target text generation module 6510 in the multimedia content service server 1100, it is preferable that the meta information based keyword advertisement intermediation server 2100 includes the keyword advertisement target text generation module 6510.

Next, the meta information based keyword advertisement intermediation system 2000, which is the core of the intermediation model, will be described in more detail. The meta information based keyword advertisement intermediation system 2000 intermediates so as to process meta information of at least one multimedia content received from the multimedia content service system 1000 and transmits at least one keyword advertisement content based on the meta information to the multimedia content service system 1000. The basic construction of the meta information based keyword advertisement intermediation system 2000 and the meta information based keyword advertisement intermediation server 2100 will be first described, and then a role division model of the meta information based keyword advertisement intermediation system 2000 and the multimedia content service server 1100 will be described.

Meta Information Based Keyword Advertisement Intermediation System 2000

The meta information based keyword advertisement intermediation system 2000 will be described in more detail with reference to FIG. 13. The meta information based keyword advertisement intermediation system 2000 includes the meta information based keyword advertisement intermediation server 2100 and other servers necessary for the smooth operation of the meta information based keyword advertisement intermediation server 2100. Other servers are apparent to those skilled in the art, so that their descriptions will be omitted in the specification. The meta information based keyword advertisement intermediation server 2100 includes a meta information reception module 9800 and/or the keyword advertisement control module 6900, and further includes a click generation information reception module 8900 and/or a multimedia content service system 1000 management module. The meta information based keyword advertisement intermediation server 2100 includes a keyword advertisement content transmission module 8800 receiving the keyword advertisement contents from the keyword advertisement content providing server 3100 and transmitting the keyword advertisement contents to the multimedia content service system 1000. The keyword advertisement content transmission module 8800 may receive keyword advertisement contents from the keyword advertisement content providing server 3100 and transmit the received keyword advertisement contents to the multimedia content service system 1000 without any filtering, but may transmit only keyword advertisement contents selected by the keyword advertisement content selection module 6550 to the multimedia content service system 1000 with reference to the keyword advertisement control policy DB 6540 of the keyword advertisement control module 6900.

It is not shown in the drawings, but the meta information based keyword advertisement intermediation system 2000 includes the keyword advertisement content providing system 3000 therein or may be operated therein. That is, in the IT system, each system or each server may be operated in other system, other server, a user computer, or a specific program of a user computer, and each system or each server may be operated in other system, other server, a user computer, or a specific program of a user computer may call and use at least one function. Therefore, there are many cases in which the systems and the servers of the present invention can be combined and the spirit of the present invention includes all of the combinations, but every description of all of the theoretically available combinations will be omitted for the convenience of description.

A method of recognizing the click generation by the keyword advertisement content providing server 3100 when a click of a specific keyword advertisement content is generated in the user computer 9000 will be described. The keyword advertisement content includes a target URL or URI (an address of a virtual space, such as a web site or web page to be finally shown to the user) and ID/identification information of the keyword advertisement content. In one method of recognizing the click generation by the keyword advertisement content providing server 3100, when a click of a specific keyword advertisement content is generated in the user computer 9000, the click generation is transmitted to a specific site, such as the keyword advertisement content providing server 3100, and the keyword advertisement content providing server 3100 redirects to the target URL or URI, the keyword advertisement content providing server 3100 can recognize click generation information of the user computer 9000, and the user computer 9000 can receive a content corresponding to the address of the virtual space of the target URL or URI because of the redirection. In the other method, a command (scripter, etc.) is included in the meta information of the keyword advertisement content so as to transmit click generation information to the specific server together with an ID/identifier information of the keyword advertisement content corresponding to the click generation when a click of a specific keyword advertisement content is generated. These methods are exemplary methods for obtaining the click generation information and it is a matter of course that the spirit of the present invention includes every method of obtaining the click generation information which is apparent to those skilled in the art.

The meta information based keyword advertisement intermediation server 2100 selectively further includes the click generation information reception module 8900. The click generation information reception module 8900 receives an operation, such as a user click, for a specific keyword advertisement content. The click generation information can be obtained from 1) the keyword advertisement content providing server 3100, 2) the multimedia content service server 1100, and 3) the user computer 9000 in a direct manner. The keyword advertisement content includes meta information, and it is preferred that the meta information based keyword advertisement intermediation server 2100 obtains a keyword advertisement content from the keyword advertisement content providing server 3100 and adds meta information to the obtained keyword advertisement content for the meta information based keyword advertisement intermediation server 2100 before transmitting of the keyword advertisement content to the multimedia content service server 1100. The meta information added by the meta information based keyword advertisement intermediation server 2100 includes data capable of directly or indirectly receiving click generation information of the keyword advertisement content in the meta information based keyword advertisement intermediation server 2100 when the keyword advertisement content is clicked. As described in the previous paragraph, the keyword advertisement content providing server 3100, the meta information based keyword advertisement intermediation server 2100, and the multimedia content service server 1100 can include a means capable of receiving click generation information of the keyword advertisement content in the keyword advertisement content providing server 3100, the meta information based keyword advertisement intermediation server 2100, and the multimedia content service server 1100. Further, the keyword advertisement content providing server 3100, the meta information based keyword advertisement intermediation server 2100, and the multimedia content service server 1100 can move the browser of the user computer 9000 to the final destination of the target URL or URI through themselves, so that they do not create inconvenience to the user, regardless of the obtainment of the click generation information. In the meantime, according to the contract, the keyword advertisement content providing server 3100, the meta information based keyword advertisement intermediation server 2100, and the multimedia content service server 1100 can transmit click generation information of the keyword advertisement content having a specific ID/identifier obtained by themselves to another server in real time or non-real time.

The keyword advertisement control module 6900 of the meta information based keyword advertisement intermediation server 2100 can utilize the click generation information obtained from the click generation information reception module 8900 in the intermediation model identically to the disintermediation model. Therefore, the keyword advertisement control module 6900 in the intermediation model can equally apply the keyword advertisement control policy related to the click generation information in the disintermediation model. The keyword advertisement control module 6900 in the disintermediation model targets a single multimedia content service system 1000, but conceptually targets n multimedia content service systems 1000 in the intermediation model. However, if the utilization of the click generation information targets n multimedia content service systems 1000, there is no essential change. Because the click generation information in n multimedia content service systems 1000 with respect to Ij keyword advertisement content corresponding to I keyword advertisement target texts is merely a sum total on a reference of the Ij keyword advertisement content. That is, the keyword advertisement control policy is equally applied to the case in which clicks of three people for the Ij keyword advertisement content are generated in a single multimedia content service system 1000 or the case in which one click for the Ij keyword advertisement content is generated in three multimedia content service system 1000, respectively.

The fact that the meta information based keyword advertisement intermediation server 2100 obtains the click generation information is important because the keyword advertisement content of the keyword advertisement content providing server 3100 corresponding to the keyword advertisement target text received from the meta information based keyword advertisement intermediation server 2100 can be transmitted 1) from the keyword advertisement content providing server 3100→to the meta information based keyword advertisement intermediation server 2100→to the multimedia content service server 1100→to the user computer 9000, but can be transmitted 2) from the keyword advertisement content providing server 3100→to the meta information based keyword advertisement intermediation server 2100→to the user computer 9000, 3) from the keyword advertisement content providing server 3100→to the multimedia content service server 1100→to the user computer 9000, or from the keyword advertisement content providing server 3100→to the user computer 9000. In this case, the meta information based keyword advertisement intermediation server 2100 and the multimedia content service server 1100 are necessary to transmit the keyword advertisement content to the user computer 9000 independently of the transmission route of the keyword advertisement content and obtain information of the advertisement effect generation, such as the user click or exposure to the user. Therefore, it is preferred that the click generation generated for the specific keyword advertisement content on the user computer 9000 has to be transmitted to the meta information based keyword advertisement intermediation server 2100 and the multimedia content service server 1100 through any route. That is, the click information is preferably transmitted to/from the user computer 9000→the multimedia content service server 1100 [symbol] the meta information based keyword advertisement intermediation server 2100 [symbol] the keyword advertisement content providing server 3100. The symbol [symbol] represents that the click information has to be transmitted through any route.

Multimedia Content Service System 1000 Management Module

The meta information based keyword advertisement intermediation server 2100 includes a keyword advertisement control policy DB 7810 based on each of the multiple multimedia content service systems 1000 or performs the meta information based keyword advertisement intermediation service based on each of the multiple multimedia content service systems 1000. At this time, each of the multiple multimedia content service systems 1000 can select various policies, such as various selections, conditions, and weights, included in the keyword advertisement control policy DB 7810 based on each of the multiple multimedia content service systems 1000. With regard to this, various policy selection information of the individual multimedia content service system 1000 are stored in the keyword advertisement control policy DB 7810 based on each of the multiple multimedia content service systems 1000 of the multimedia content service system management module 7800.

For example, the information included in the keyword advertisement control policy DB 7810 based on each of the multiple multimedia content service systems 1000 includes 1) a policy related to the weight or priority for the selection of keyword advertisement contents, 2) a policy related to a range of information for the generation of keyword advertisement target texts, 3) a policy related to a request range of meta information of keyword advertisement contents, 4) a policy related to a scheme for the transmission keyword advertisement content to the user computer 9000, and 5) a policy related to the selection of keyword advertisement contents to be provided to the user computer 9000 at a specific time. The specific content, the effect or background of the selection, the reasons, etc. of each policy have been fully explained in the description of the disintermediation model.

The multimedia content service system management module 7800 of the meta information based keyword advertisement intermediation server 2100 obtains selection information of the keyword advertisement control policy obtained from at least one multimedia content service system 1000 and stores the obtained selection information on the keyword advertisement control policy DB 7810 based on each of the multimedia content service systems 1000. When the keyword advertisement control module 6900 controls the keyword advertisement for the multimedia content service system 1000, the keyword advertisement control module 6900 preferentially inquires of the keyword advertisement control policy DB 7810 for each of the multimedia content service systems 1000. When the policy for each of the multimedia content service systems 1000 is included in the keyword advertisement control policy DB 7810, the keyword advertisement control module 6900 preferentially applies the policy, and when the policy for each of the multimedia content service systems 1000 is not included in the keyword advertisement control policy DB 7810, the keyword advertisement control module 6900 controls the keyword advertisement with reference to the keyword advertisement control policy DB 7810 for each of the multimedia content service systems 1000. The keyword advertisement content selection module and the filtering module can also be managed and operated based on each of the multimedia content service systems 1000 according to the keyword advertisement control policy DB 7810 for each of the multimedia content service systems 1000. Further, each of the multimedia content service systems 1000 can have the advertisement keyword DB 6570, which is managed in the multimedia content service system management module 7800.

Meanwhile, the reception and the transmission of all of the data with the multimedia content service system management module 7800 is managed by a log, and the log is stored in a log DB 7820 of the multimedia content service system management module 7800. It does not matter that the log is stored in a file type, not the DB type.

In the above, the intermediation model has been described. Each of the intermediation models can divide the roles with at least two servers and each of the servers can be operated by different subjects. That is, it may not be preferred in implementation, but a server a of a business subject A may operate the meta information reception module, a server b of a business subject B may receive the meta information from the server a and serve as the keyword advertisement control module 6900, and a server c of a business subject C may serve as the keyword advertisement content transmission module 8800. It is apparent to those skilled in the art that the spirit of the present invention includes a role division model based on each of the business subjects and also a role division model in other different servers of the same business subject. It is possible to theoretically combine an infinite number of role division models so that it is impossible to describe all of the role division models and is not necessary, so that the description for each of the role division models is omitted in the specification and an object is written in this paragraph.

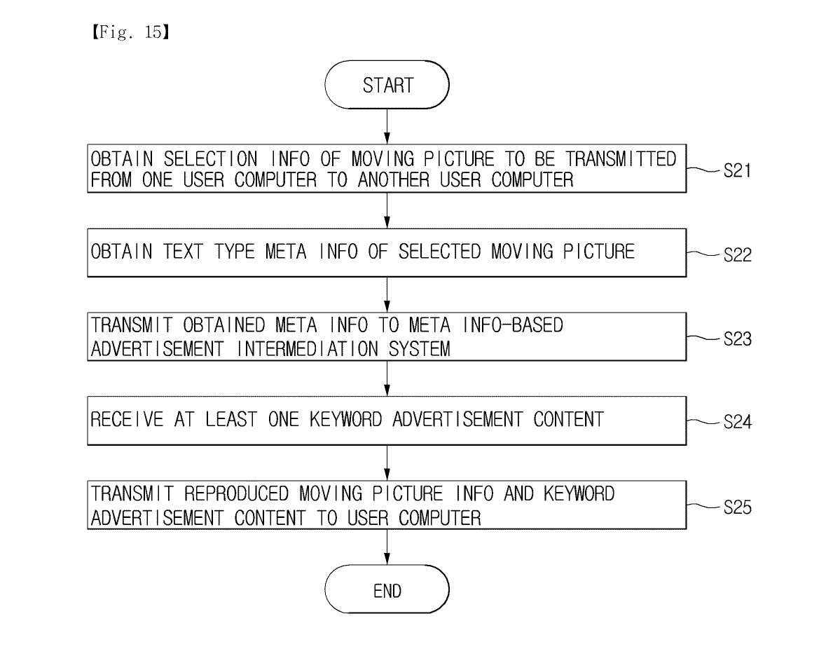

Next, two exemplary embodiments of a method of operating the multimedia content service system 1000 of the intermediation model will be described with reference to FIG. 15.

According to the first embodiment, the method of providing the keyword advertisement service by the multimedia content service system 1000 of the intermediation model, which includes the multimedia content service server 1100 transmitting moving picture information of a moving picture selected by the user to the user computer 9000 includes the steps of: obtaining selection information of a moving picture to be transmitted from a user computer 9000 to the user computer 9000 (S21); obtaining text-type meta information of the selected moving picture (S22); transmitting the obtained meta information to the meta information-based keyword advertisement intermediation system 2000 (S23); receiving at least one keyword advertisement content (S24); and transmitting the moving picture information and the keyword advertisement content to the user computer 9000 (S25). It is preferred that the meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, the keyword advertisement content obtainment module 6530 transmitting keyword advertisement target texts generated by the keyword advertisement target text generation module 6510 to the keyword advertisement content providing server 3100 and receiving at least one keyword advertisement content from the keyword advertisement content providing server 3100, and the keyword advertisement content transmission module 8800 transmitting the obtained keyword advertisement contents to the multimedia content service system 1000. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. It is preferred that the keyword advertisement content providing server 3100 obtains at least one keyword advertisement content corresponding to the keyword advertisement target texts received from the meta information-based keyword advertisement intermediation server 2100 from the keyword advertisement content DB 3120 and transmits the obtained keyword advertisement contents to the meta information-based keyword advertisement intermediation server 2100. The information obtained by the keyword advertisement content providing server 3100 is the text type. The text-type information includes tag information, title information, explanation information, and other text-type information. It is a matter of course that the text-type information includes the keyword advertisement target texts.

According to the second embodiment of the method of providing the keyword advertisement service by the multimedia content service system 1000 of the intermediation model, the method is characterized in that the keyword advertisement contents are directly transmitted from the keyword advertisement content providing server 3100 without passing the meta information-based keyword advertisement intermediation system 2000.

According to the second embodiment, the method of providing the keyword advertisement service by the multimedia content service system 1000 of the intermediation model, which includes the multimedia content service server 1100 transmitting moving picture information of a moving picture selected by the user to the user computer 9000 includes the steps of: obtaining selection information of a moving picture to be transmitted from a user computer 9000 to the user computer 9000 (S31); obtaining text-type meta information of the selected moving picture (S32); transmitting the obtained meta information to the meta information-based keyword advertisement intermediation system 2000 (S33); receiving at least one keyword advertisement content from the keyword advertisement content providing server 3100 (S34); and transmitting the moving picture information and the keyword advertisement content to the user computer 9000 (S35). The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, the keyword advertisement content obtainment module 6530 transmitting keyword advertisement target texts generated by the keyword advertisement target text generation module 6510 to the keyword advertisement content providing server 3100 and receiving at least one keyword advertisement content from the keyword advertisement content providing server 3100, and the keyword advertisement content transmission module 8800 transmitting the obtained keyword advertisement contents to the multimedia content service system 1000. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains the keyword advertisement target texts and information of the multimedia content service system generating the keyword advertisement target texts from the meta information-based keyword advertisement intermediation server 2100, obtains at least one keyword advertisement content corresponding to the received keyword advertisement target texts from the keyword advertisement content DB 3120, and transmits the obtained keyword advertisement contents to the multimedia content service system 1000 or the user computer 9000. It is preferred that when the click of the keyword advertisement content is generated, the multimedia content service system 1000 transmits the click generation information to the meta information-based keyword advertisement intermediation system 2000.

Next, the exemplary embodiment of the construction of the multimedia content service system 1000 of the intermediation model will be described with reference to FIG. 13. There are two types of the multimedia content service system 1000 of the intermediation model.

According to the first type, the multimedia content service system 1000 of the intermediation model, which includes the multimedia content service server 1100 transmitting moving picture information of a moving picture selected by the user to the user computer 9000, includes: the multimedia content DB 1110 including at least one moving picture content; the multimedia content transmission module 1120 for, when selection information of the moving picture content is received from the user computer 9000, streaming the selected moving picture content; the meta information obtainment module 5100 for obtaining meta information of the selected moving picture; the meta information transmission module 5200 for transmitting of the obtained meta information to the meta information-based keyword advertisement intermediation system 2000; the keyword advertisement content reception module 5300 for receiving at least one keyword advertisement content related to the meta information from the meta information-based keyword advertisement intermediation system 2000; and a keyword advertisement display module 7900 for displaying keyword advertisement contents received by the keyword advertisement content reception module 5300 on a preset location, which is discriminated from a moving picture area reproducing and displaying the moving picture. The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, the keyword advertisement content obtainment module 6530 transmitting keyword advertisement target texts generated by the keyword advertisement target text generation module 6510 to the keyword advertisement content providing server 3100 and receiving at least one keyword advertisement content from the keyword advertisement content providing server 3100, and the keyword advertisement content transmission module 8800 transmitting the obtained keyword advertisement contents to the multimedia content service system 1000. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the texts received from the meta information-based keyword advertisement intermediation server 2100 from the keyword advertisement content DB 3120 and transmits the obtained keyword advertisement content to the meta information-based keyword advertisement intermediation server 2100.

In contrast of the first type, the second type of the multimedia content service system 1000 of the intermediation model is characterized in that the keyword advertisement contents are directly transmitted to the keyword advertisement content providing server 3100 without passing the meta information-based keyword advertisement intermediation system 2000.

The multimedia content service system 1000 of the intermediation model, which includes the multimedia content service server 1100 transmitting moving picture information of a moving picture selected by the user to the user computer 9000, includes: the multimedia content DB 1110 including at least one moving picture content; the multimedia content transmission module 1120 for, when selection information of the moving picture content is received from the user computer 9000, streaming the selected moving picture content; the meta information obtainment module 5100 for obtaining meta information of the selected moving picture; the meta information transmission module 5200 for transmitting of the obtained meta information to the meta information-based keyword advertisement intermediation system 2000; the keyword advertisement content reception module 5300 for receiving at least one keyword advertisement content related to the meta information transmitted to the meta information-based keyword advertisement intermediation system 2000 from the keyword advertisement content providing server 3100; and the keyword advertisement display module 7900 for displaying keyword advertisement contents received by the keyword advertisement content reception module 5300 on a preset location, which is discriminated from a moving picture area reproducing and displaying the moving picture. The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, the keyword advertisement content providing server-side text obtainment module 3110 transmitting keyword advertisement target texts generated by the keyword advertisement target text generation module 6510 and receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the texts received from the meta information-based keyword advertisement intermediation server 2100 from the keyword advertisement content DB 3120 and transmits the obtained keyword advertisement content to the multimedia content service system 1000 or the user computer 9000.

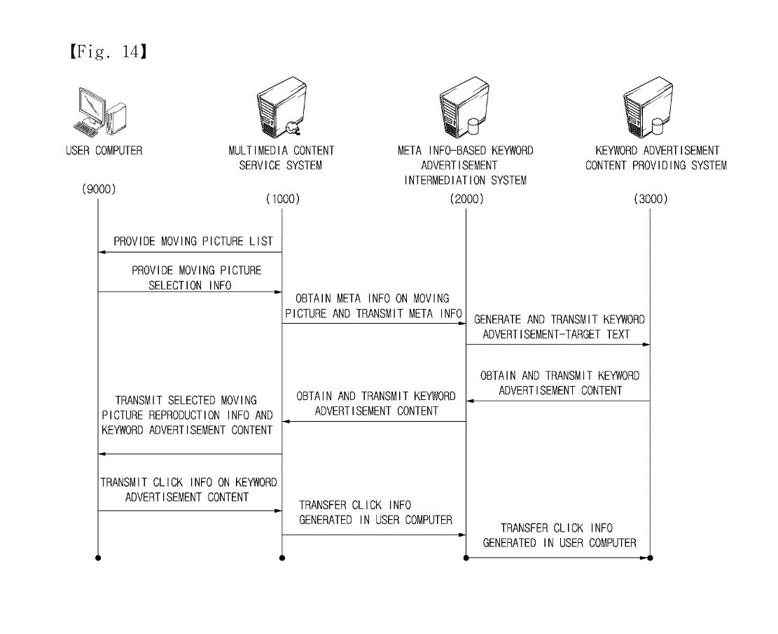

Next, an exemplary embodiment of a method of operating the meta information-based keyword advertisement intermediation system 2000 of the intermediation model will be described with reference to FIGS. 14 to 17. There are three types of operating methods, and herein the description will be given based on the first and second types.

First, the method of providing a keyword advertisement service by the meta information-based keyword advertisement intermediation system 2000 of the intermediation model, which receives meta information from the multimedia content service system 1000 including the multimedia content service server 1100 transmitting moving picture information of a moving picture selected by the user to the user computer 9000 includes the steps of: obtaining text-type meta information from the multimedia content service system 1000 (S41); generating at least one keyword advertisement target text from the obtained meta information (S42); transmitting the generated keyword advertisement target text to the keyword advertisement content providing server 3100 (S43); receiving at least one keyword advertisement content from the keyword advertisement content providing server 3100 (S44), and transmitting the received keyword advertisement content to the multimedia content service system 1000. The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, the keyword advertisement content transmission module 6520 transmitting the keyword advertisement target texts generated by the keyword advertisement target text generation module 6510 to the keyword advertisement content providing server 3100, the keyword advertisement content obtainment module 6530 receiving at least one keyword advertisement content from the keyword advertisement content providing server 3100, and the keyword advertisement content transmission module 8800 transmitting the obtained keyword advertisement contents to the multimedia content service system 1000. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the texts received from the meta information-based keyword advertisement intermediation server 2100 from the keyword advertisement content DB 3120 and transmits the obtained keyword advertisement content to the meta information-based keyword advertisement intermediation server 2100. The multimedia content service system 1000 transmits the moving picture information and the received keyword advertisement contents to the user computer 9000.

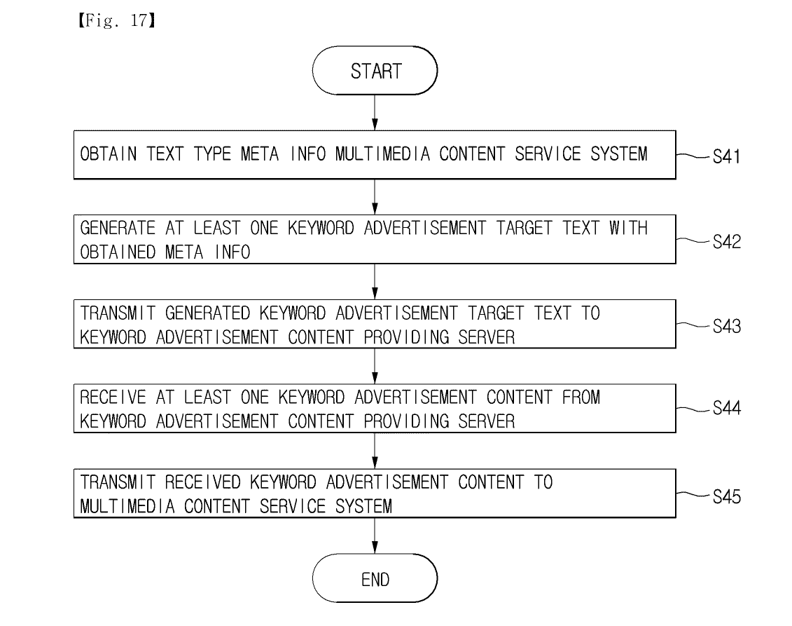

Second, the method of providing a keyword advertisement service by the meta information-based keyword advertisement intermediation system 2000 of the intermediation model, which receives meta information from the multimedia content service system 1000 including the multimedia content service server 1100 transmitting moving picture information of a moving picture selected by the user to the user computer 9000 includes the steps of: obtaining text-type meta information from the multimedia content service system 1000 (S41); generating at least one keyword advertisement target text from the obtained meta information (S42); and transmitting the generated keyword advertisement target text to the keyword advertisement content providing server 3100 (S43). The steps S41 to S43 of FIG. 17 are identical to those of the first type. The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, and the keyword advertisement content transmission module 6520 transmitting the keyword advertisement target texts generated by the keyword advertisement target text generation module 6510 to the keyword advertisement content providing server 3100. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the texts received from the meta information-based keyword advertisement intermediation server 2100 from the keyword advertisement content DB 3120 and transmits the obtained keyword advertisement content to the meta information-based keyword advertisement intermediation server 2100. The multimedia content service system 1000 transmits the moving picture information and the received keyword advertisement contents to the user computer 9000.

The method of providing a keyword advertisement service by the meta information-based keyword advertisement intermediation system 2000 of the intermediation model, which receives meta information from the multimedia content service system 1000 including the multimedia content service server 1100 transmitting moving picture information of a moving picture selected by the user to the user computer 9000 includes the steps of: obtaining text-type meta information from the multimedia content service system 1000; generating at least one keyword advertisement target text from the obtained meta information; transmitting the generated keyword advertisement target text to the keyword advertisement content providing server 3100; and obtaining click generation information of the keyword advertisement content contents from the multimedia content service system 1000. The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, and the keyword advertisement content transmission module 6520 transmitting the keyword advertisement target texts generated by the keyword advertisement target text generation module 6510 to the keyword advertisement content providing server 3100. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the texts received from the meta information-based keyword advertisement intermediation server 2100 from the keyword advertisement content DB 3120 and transmits the obtained keyword advertisement content to the multimedia content service system 1000. The multimedia content service system 1000 receives at least one keyword advertisement content from the keyword advertisement content providing server 3100 and transmits the moving picture information and the received keyword advertisement contents to the user computer 9000.

In the step of obtaining the meta information, the meta information includes at least one of title information, tag information, explanation information, and a commercial tag set of the moving picture included in the moving picture information. The commercial tag set is preferably generated by the commercial tag set generation system 10000.

The method further includes at least one of the steps of obtaining click generation information of the keyword advertisement content transmitted to the multimedia content service system 1000 and transmitting click generation information of the keyword advertisement content transmitted to the multimedia content service system 1000. The click generation information is obtained from the multimedia content service system 1000 and/or the keyword advertisement content providing server 3100. The click generation information is transmitted to the multimedia content service system 1000, the keyword advertisement content providing server 3100, and/or a preset third server.

The moving picture includes at least one of a real photograph moving picture, a non-real photograph moving picture, a UCC moving picture, a movie, a flash moving picture, an animation, a real-time broadcasting, and a recorded broadcasting including text-type meta information.

Hereinafter, an exemplary embodiment of the construction of the meta information-based keyword advertisement intermediation system 2000 of the intermediation model will be described with reference to FIG. 13.

The meta information-based keyword advertisement intermediation system 2000 of the intermediation model receives meta information from the multimedia content service system 1000 including the multimedia content service server 1100 transmitting moving picture information of a moving picture selected by the user to the user computer 9000, receives at least one keyword advertisement content corresponding to the received meta information from the keyword advertisement content providing server 3100, and transmits the received keyword advertisement content to the multimedia content service system 1000. The meta information-based keyword advertisement intermediation system 2000 of the intermediation model includes the meta information reception module 9800 receiving text-type meta information from the multimedia content service system 1000, the keyword advertisement target text generation module 6510 generating keyword advertisement target texts with the obtained meta information, the keyword advertisement content transmission module 6520 transmitting the keyword advertisement target texts generated by the keyword advertisement target text generation module 6510 to the keyword advertisement content providing server 3100, the keyword advertisement content obtainment module 6530 receiving at least one keyword advertisement content corresponding to the keyword advertisement target texts from the keyword advertisement content providing server 3100, and the keyword advertisement content transmission module 8800 transmitting the obtained keyword advertisement contents to the multimedia content service system 1000. The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, the keyword advertisement content obtainment module 6530 transmitting keyword advertisement target texts generated by the keyword advertisement target text generation module 6510 to the keyword advertisement content providing server 3100 and receiving at least one keyword advertisement content from the keyword advertisement content providing server 3100, and the keyword advertisement content transmission module 8800 transmitting the obtained keyword advertisement contents to the multimedia content service system 1000. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the texts received from the meta information-based keyword advertisement intermediation server 2100 from the keyword advertisement content DB 3120 and transmits the obtained keyword advertisement content to the meta information-based keyword advertisement intermediation server 2100. The multimedia content service system 1000 transmits the moving picture information and the received keyword advertisement contents to the user computer 9000.

Next, another exemplary embodiment of the construction of the meta information-based keyword advertisement intermediation system 2000 of the intermediation model will be described with reference to FIG. 13.

The meta information-based keyword advertisement intermediation system 2000 of the intermediation model receives meta information from the multimedia content service system 1000 including the multimedia content service server 1100 transmitting moving picture information of a moving picture selected by the user to the user computer 9000, receives at least one keyword advertisement content corresponding to the received meta information from the keyword advertisement content providing server 3100, and transmits the received keyword advertisement content to the multimedia content service system 1000. The meta information-based keyword advertisement intermediation system 2000 of the intermediation model includes the meta information reception module 9800 receiving text-type meta information from the multimedia content service system 1000, the keyword advertisement target text generation module 6510 generating keyword advertisement target texts with the obtained meta information, and the keyword advertisement content transmission module 6520 transmitting the keyword advertisement target texts generated by the keyword advertisement target text generation module 6510 to the keyword advertisement content providing server 3100. The meta information-based keyword advertisement intermediation system 2000 includes the meta information-based keyword advertisement intermediation server 2100. The meta information-based keyword advertisement intermediation server 2100 includes the meta information reception module 9800 receiving the meta information, the keyword advertisement target text generation module 6510 generating keyword advertisement target texts with meta information obtained by the meta information reception module 9800, and the keyword advertisement content obtainment module 6530 transmitting keyword advertisement target texts generated by the keyword advertisement target text generation module 6510 to the keyword advertisement content providing server 3100 and receiving at least one keyword advertisement content from the keyword advertisement content providing server 3100. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the texts received from the meta information-based keyword advertisement intermediation server 2100 from the keyword advertisement content DB 3120 and transmits the obtained keyword advertisement content to the meta information-based keyword advertisement intermediation server 2100. The multimedia content service system 1000 transmits the moving picture information and the received keyword advertisement contents to the user computer 9000.

The meta information-based keyword advertisement intermediation system 2000 includes at least one of the keyword advertisement content providing server 3100 and the multimedia content service system 1000 therein or at least one of the keyword advertisement content providing server 3100 and the multimedia content service system 1000 is commonly managed by a management subject identical to the management subject of the meta information-based keyword advertisement intermediation system 2000.

Keyword Advertisement Content Providing System 3000 Centered Model

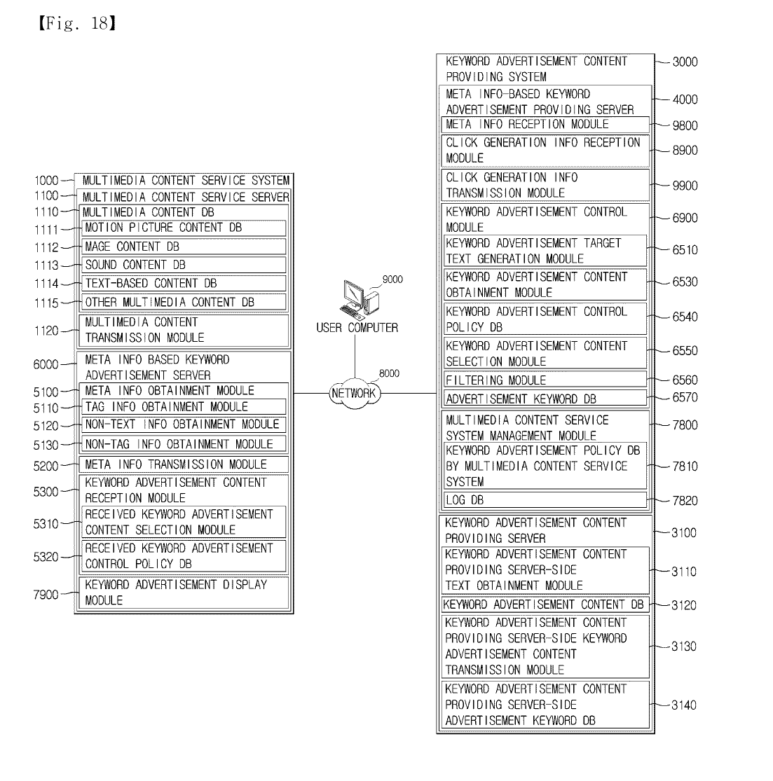

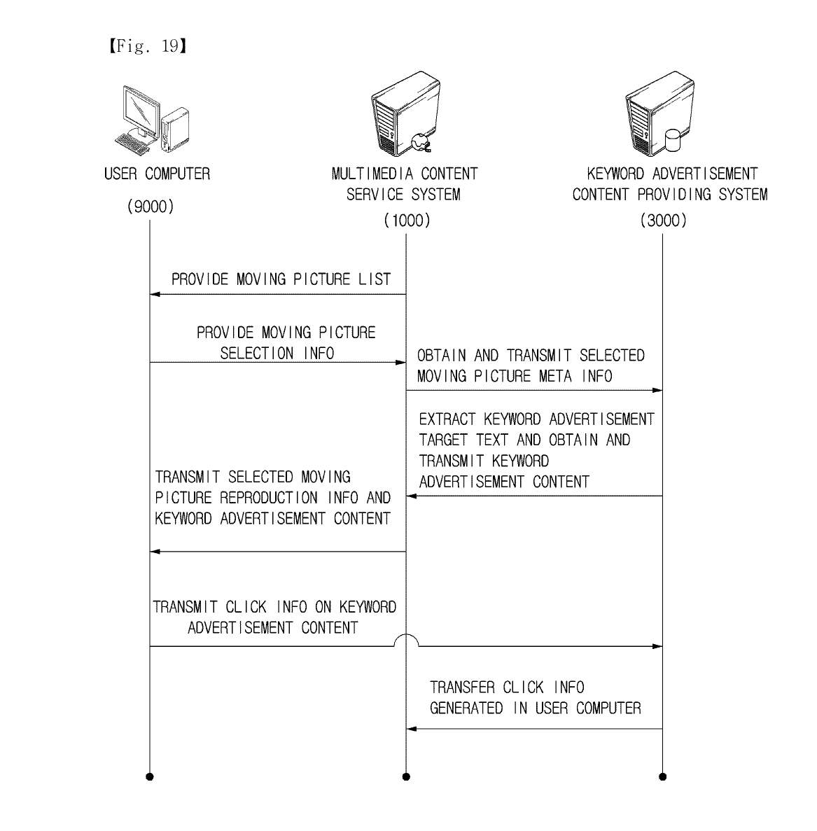

Next, the Keyword advertisement content providing system 3000 centered model will be described with reference to FIGS. 18 to 20. In the above description, the multimedia content service system 1000 has been described centered on the disintermediation model and the intermediation model. In the intermediation model illustrated in FIG. 18, the keyword advertisement content providing system 3000 including a meta information based keyword advertisement providing server 4000 that is another name of the meta information based keyword advertisement intermediation server 2100 and the keyword advertisement content providing server 3100 is the core construction of this model, which is referred to as the keyword advertisement content providing system centered model.

The keyword advertisement content providing system 3000 includes the meta information based keyword advertisement providing server 4000 and the keyword advertisement content providing server 3100. The function of the meta information based keyword advertisement providing server 4000 is identical to that of the meta information based keyword advertisement intermediation server 2100. However, the keyword advertisement content providing system 3000 is a producer of keyword advertisement contents, so that it is not essentially necessary to receive the keyword advertisement contents, but may receive keyword advertisement contents from an inside server of the keyword advertisement content providing system 3000, an outside server, or the third server. In the intermediation model, a third party receives keyword advertisement contents from the keyword advertisement content providing system 3000 that is an operation subject and transmits the received keyword advertisement content to the multimedia content service server 1100. However, in the keyword advertisement content providing system 3000 centered model, the keyword advertisement content providing system 3000 generates the keyword advertisement contents and transmits the generated keyword advertisement contents to the multimedia content service system 1000. At this time, the meta information based keyword advertisement providing server 4000 may include a keyword advertisement content providing server-side keyword advertisement content transmission module 3130, but it is preferred that the keyword advertisement content providing server 3100 performs the transmission of the keyword advertisement contents. Therefore, in the keyword advertisement content providing system 3000 centered model, the keyword advertisement content providing server 3100 extracts at least one keyword advertisement content to be transmitted to the multimedia content service server 1100 while exchanging data with the meta information based keyword advertisement providing server 4000 and transmitting the extracted keyword advertisement content to the multimedia content service server 1100, the third server, or the user computer 9000.

Next, an exemplary embodiment of a method for operating the multimedia content service system 1000 in the keyword advertisement content providing system 3000 centered model will be described with reference to FIG. 18.

The method for providing a keyword advertisement service by the multimedia content service system in the keyword advertisement content providing system 3000 centered model including the multimedia content service server 1100 transmitting moving picture information of a moving picture selected by the user to the user computer 9000 includes the steps of: obtaining selection information of a moving picture to be transmitted from a user computer 9000 to the user computer 9000; obtaining text type meta information of the selected moving picture; transmitting obtained meta information to the keyword advertisement content providing system 3000; receiving at least one keyword advertisement content from the keyword advertisement content providing system 3000; and transmitting the moving picture information and the keyword advertisement content to the user computer 9000. The keyword advertisement content providing system 3000 includes the meta information based keyword advertisement providing server 4000 and the keyword advertisement content providing server 3100. The meta information based keyword advertisement providing server 4000 includes a meta information reception module 9800 and the keyword advertisement control module 6900. The meta information reception module 9800 obtains meta information from the multimedia content service system 1000, and the keyword advertisement control module 6900 generates keyword advertisement target texts with the meta information. The meta information based keyword advertisement providing server 4000 generates at least one keyword advertisement target text with the meta information obtained from the multimedia content service system 1000 and transmits the generated keyword advertisement target text to the keyword advertisement content providing server 3100. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the received keyword advertisement target texts from the keyword advertisement content DB 3120 and the keyword advertisement content providing system 3000 transmits the obtained keyword advertisement content to the multimedia content service server 1100.

In the step of obtaining the meta information, the meta information includes at least one of title information, tag information, explanation information, and a commercial tag set of the moving picture included in the moving picture information. The commercial tag set is preferably generated by the commercial tag set generation system 10000.

The method further includes a step of when a number of keyword advertisement contents received from the keyword advertisement content providing server 3100 are more than one, selecting at least one keyword advertisement content to be transmitted to the user computer 9000 based on a specific time among the keyword advertisement contents.

In the selection of the keyword advertisement contents, when a number of keyword advertisement contents received from the keyword advertisement content providing server 3100 are more than one, a number of keyword advertisement contents to be transmitted to the user computer 9000 based on a specific time has been determined, and the number of keyword advertisement contents is larger than the number of keyword advertisement contents to be transmitted to the user computer 9000 based on a specific time, the multiple keyword advertisement contents are divided into at least two group and the keyword advertisement content included in the group is selected based on each of the groups. The number of keyword advertisement contents included in each of the groups is preferably equal to or less than the number of keyword advertisement contents to be transmitted to the user computer 9000 based on the specific time.

A method of transmitting the moving picture information and the keyword advertisement contents to the user computer 900 includes at least one of a method (a) of dividing the moving picture information area and the keyword advertisement content area 100, generating an information unit to be transmitted to the user computer 9000, synchronizing the moving picture information area with the keyword advertisement content area 100, and transmitting the moving picture information and the keyword advertisement contents to the user computer 9000, and (b) dividing the moving picture information area and the keyword advertisement content area 100, generating an information unit to be transmitted to the user computer 9000, asynchronizing the moving picture information area with the keyword advertisement content area 100, and transmitting the moving picture information and the keyword advertisement contents to the user computer 9000, respectively.

When the method (b) is selected, at least one keyword advertisement content transmitted to the keyword advertisement content area 100 is preferably changed according to the passage of time.

The time is preferably within a preset time range.

The time range is determined by at least one variable selected from (a) the number of keyword advertisement contents received by the keyword advertisement content providing server 3100, (b) the number of keyword advertisement contents selected from among the keyword advertisement contents received by the keyword advertisement content providing server 3100, (c) the number of keyword advertisement contents to be transmitted to the user computer 9000 based on a specific time, and (d) a reproduction time of the moving picture.

The method of the present invention further includes the steps of recording a transmission time of at least one specific keyword advertisement content transmitted to the user computer 9000 by the multimedia content service server 1100 and monitoring whether to generate the click for the specific keyword advertisement content up to a preset time, when click generation information of the specific keyword advertisement content has not been obtained within the preset time, transmitting a preset number of keyword advertisement contents selected from among keyword advertisement contents received by the keyword advertisement content providing server 3100, other than the keyword advertisement contents transmitted to the user computer 9000, to the user computer 9000.

The present invention further includes the steps of: recording a transmission time of at least one specific keyword advertisement content transmitted to the user computer 9000 by the multimedia content service server 1100; and monitoring a generation of a click for the specific keyword advertisement content up to a preset time. When click generation information of the specific keyword advertisement content has been obtained within the preset time, not changing the keyword advertisement contents transmitted to the user computer 9000 from a time of obtaining the click generation information to a preset second time.

When additional click generation information of the keyword advertisement contents transmitted to the user computer 9000 has not been obtained by the second time, the method of the present invention further includes a step of transmitting a preset number of keyword advertisement contents selected from among keyword advertisement contents received by the keyword advertisement content providing server 3100, other than the keyword advertisement contents transmitted to the user computer 9000, to the user computer 9000.

The method of the present invention further includes the steps of: recording a transmission time of at least one specific keyword advertisement content transmitted to the user computer 9000 by the multimedia content service server 1100; and monitoring a generation of a click for the specific keyword advertisement content up to a preset time, and when click generation information of the specific keyword advertisement content has been obtained within the preset time, transmitting keyword advertisement contents related to the keyword advertisement content corresponding to the click generation to the user computer 9000.

The keyword advertisement contents related to the keyword advertisement content corresponding to the click generation refers to (a) another at least one keyword advertisement content among the keyword advertisement contents obtained when the specific keyword advertisement target text is transmitted to the keyword advertisement content providing server 3100 in a case where the keyword advertisement content corresponding to the click generation is the keyword advertisement content obtained through transmitting at least one specific keyword advertisement target text to the keyword advertisement content providing server 3100, (b) at least one keyword advertisement content obtained through transmitting another keyword advertisement target text obtained from the same meta information, on which the keyword advertisement target texts are based, to the keyword advertisement content providing server 3100 in a case where the keyword advertisement content corresponding to the click generation is the keyword advertisement content obtained through transmitting at least one specific keyword advertisement target text to the keyword advertisement content providing server 3100, (c) at least one keyword advertisement content obtained through transmitting the other keyword advertisement target texts to the keyword advertisement content providing server 3100, when the specific keyword advertisement target text is included in a specific group and other keyword advertisement target texts are included in the group in addition to the specific keyword advertisement target text in a case where the keyword advertisement content corresponding to the click generation is the keyword advertisement content obtained through transmitting at least one specific keyword advertisement target text to the keyword advertisement content providing server 3100.

The method of the present invention further includes at least one step of obtaining click generation information of the keyword advertisement content transmitted to the user computer 9000 and transmitting click generation information of the keyword advertisement content transmitted to the user computer 9000. It is preferred that the click generation information is directly obtained from the user computer 9000 and/or obtained from the keyword advertisement content providing server 3100. It is preferred that the click generation information is transmitted to the keyword advertisement content providing server 3100 and/or the preset third server.

The moving picture includes at least one of a real photograph moving picture, a non-real photograph moving picture, a UCC moving picture, a movie, a flash moving picture, a real-time broadcasting, and a recorded broadcasting including text-type meta information.

Next, an exemplary embodiment of the construction of the keyword advertisement content providing system 3000 of the keyword advertisement content providing system 3000 centered model will be described with reference to FIG. 18.

The multimedia content service system 1000 of the keyword advertisement content providing system 3000 centered model includes the multimedia content DB 1110 including at least one moving picture content, the multimedia content transmission module 1120 for, when selection information of the moving picture content is received from the user computer 9000, streaming the selected moving picture content; the meta information obtainment module 5100 for obtaining meta information of the selected moving picture; the meta information transmission module 5200 for transmitting the obtained meta information to the keyword advertisement content providing system 3000; the keyword advertisement content reception module 5300 for receiving at least one keyword advertisement content from the keyword advertisement content providing system 3000; and a keyword advertisement display module 7900 for displaying keyword advertisement contents received by the keyword advertisement content reception module 5300 on a preset location, which is discriminated from a moving picture area reproducing and displaying the moving picture. The keyword advertisement content providing system 3000 includes the meta information based keyword advertisement providing server 4000 and the keyword advertisement content providing server 3100. The meta information based keyword advertisement providing server 4000 includes the meta information reception module 9800 and the keyword advertisement control module 6900. The meta information reception module 9800 obtains meta information from the multimedia content service system 1000, and the keyword advertisement control module 6900 generates keyword advertisement target texts with the meta information. The meta information based keyword advertisement providing server 4000 generates at least one keyword advertisement target text with the meta information obtained from the multimedia content service system 1000 and transmits the generated keyword advertisement target text to the keyword advertisement content providing server 3100. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the received keyword advertisement target texts from the keyword advertisement content DB 3120 and the keyword advertisement content providing system 3000 transmits the obtained keyword advertisement content to the multimedia content service server 1100.

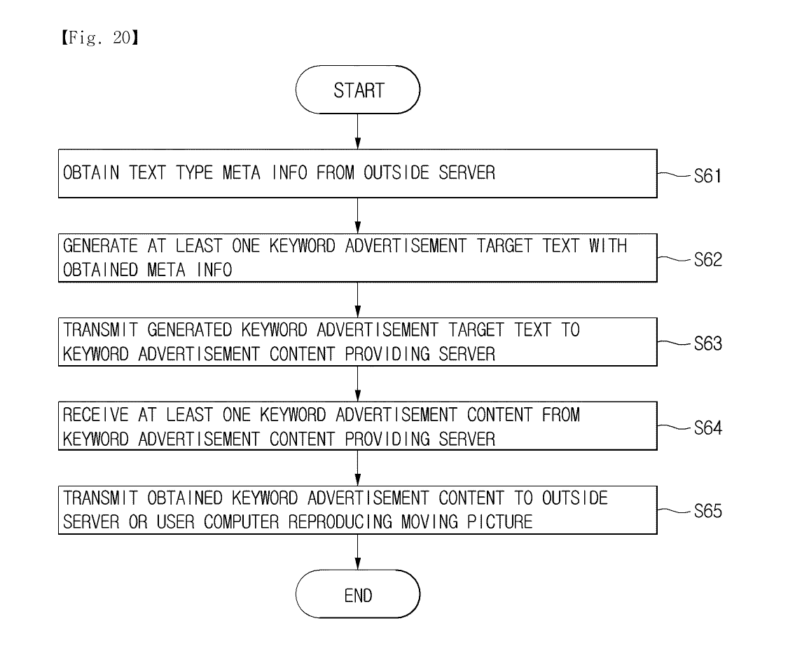

Next, the exemplary embodiment of a method for providing a keyword advertisement service by the keyword advertisement content providing system 3000 of the keyword advertisement content providing system 3000 centered model will be described with reference to FIG. 20.

The method for providing a keyword advertisement service by the keyword advertisement content providing system 3000 of the keyword advertisement content providing system 3000 centered model receiving at least one meta information included in moving picture information from at least one outside server and providing at least one keyword advertisement content based on the text information includes the steps of: obtaining text type meta information from the outside server (S61); generating at least one keyword advertisement target text with the obtained meta information (S62); transmitting the generated keyword advertisement target text to the keyword advertisement content providing server 3100 (S63); receiving at least one keyword advertisement content from the keyword advertisement content providing server 3100; and transmitting the obtained keyword advertisement content to the outside server or the user computer 9000 displaying the moving picture. The outside server includes the multimedia content service system 1000 including the multimedia content service server 1100 transmitting moving picture information of a moving picture selected by the user to the user computer 900 or a third server receiving meta information included in moving picture information from the multimedia content service system 1000 and transmitting the received meta information to the keyword advertisement content providing system 3000. The keyword advertisement content providing system 3000 includes the meta information-based keyword advertisement providing server 4000 and the keyword advertisement content providing server 3100. The meta information based keyword advertisement providing server 4000 generates at least one keyword advertisement target text with the meta information obtained from the outside server and transmits the generated keyword advertisement target text to the keyword advertisement content providing server 3100. The keyword advertisement content providing system 3000 obtains at least one keyword advertisement content corresponding to the received keyword advertisement target texts and directly transmits the keyword advertisement content to the multimedia content service system 1000 or transmits the keyword advertisement content to the multimedia content service system 1000 via the third server or a preset server. The keyword advertisement content providing server 3100 includes the keyword advertisement content providing server-side text obtainment module 3110 receiving the texts, the keyword advertisement content DB 3120 including at least one advertisement content, and a keyword advertisement content transmission module transmitting the keyword advertisement contents to the outside server. The keyword advertisement content providing server 3100 obtains at least one keyword advertisement content corresponding to the received keyword advertisement target texts from the keyword advertisement content DB 3120 and the keyword advertisement content providing system 3000 transmits the obtained keyword advertisement content to the outside server. The user computer 9000 obtains moving picture reproduction information from the outside server.

In the step of obtaining the meta information, the meta information includes at least one of title information, tag information, explanation information, and a commercial tag set of the moving picture included in the moving picture information. The commercial tag set is preferably generated by the commercial tag set generation system 10000.

The meta information selection is determined by the meta information selection policy included in the keyword advertisement control policy DB 6540, and the keyword advertisement control policy DB 6540 includes the keyword advertisement control policy, and the keyword advertisement control policy preferably includes information on the selection reference of meta information.

The selection reference of the meta information is at least one of (a) when tag information is included in obtained meta information, first selecting the tag information, (b) when tag information is included in obtained meta information, selecting both tag information and title information, (c) when tag information is not included in obtained meta information, selecting title information, and (d) when tag information is not included in obtained meta information, selecting both title information and explanation information.

The generating of at least one keyword advertisement target text with the selected meta information is implemented by at least one method of, when the meta information is title information, (a) a method of generating words and phrases included in the advertisement keyword DB 6570 among words and phrases included in the title information as keyword advertisement target texts, (b) a method of analyzing words and phrases included in the title information through the natural language processing, extracting at least one product or service name, and generating the extracted names as keyword advertisement target texts, and (c) a method of generating only the names corresponding to the words and phrases included in the advertisement keyword DB 6570 among the names extracted by the method (b) as keyword advertisement target texts, when the meta information is tag information, (a) a method of generating a tag included in the advertisement keyword DB 6570 among at least one tag included in the tag information as keyword advertisement target texts, (b) a method of generating all tags included in the tag information as keyword advertisement target texts, (c) a method of, when multiple tags are included in the tag information, generating only tags within a preset rank as keyword advertisement target texts, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target texts, (b) a method of analyzing words and phrases included in the explanation information through the natural language processing, extracting at least one product or service name, and generating the extracted names as keyword advertisement target texts, (c) a method of generating only the names corresponding to the words and phrases included in the advertisement keyword DB 6570 among the names extracted by the method (b) as keyword advertisement target texts, and (d) a method of calculating a frequency of the names extracted by the method (b) and generating only the names within a preset rank in order of the highest frequency as keyword advertisement target texts. The advertisement keyword DB 6570 is the DB collecting the advertisement target keywords subjected to the keyword advertisement. The name consists of at least one word, and includes at least one of a product name, a service name, an advertisement keyword list received from the keyword advertisement content providing server 3100, an advertisement keyword list obtained from a third person, a self generated advertisement keyword list, a keyword advertisement target text list creating advertisement gains, a company name, a domain name, a noun, a slogan, and a brand.

The generation of at least one keyword advertisement target text with the selected meta information includes multiple steps of the first step of generating a keyword advertisement target text candidate and the second step of inquiring of the keyword advertisement content providing server 3100 about the generated keyword advertisement target text candidate and generating keyword advertisement target texts with reference to an inquiry result.

The first step of generating the keyword advertisement target text candidate includes at least one method of, when the meta information is title information, (a) a method of generating words and phrases included in the advertisement keyword DB 6570 among words and phrases included in the title information as keyword advertisement target text candidates, (b) a method of analyzing words and phrases included in the title information through the natural language processing, extracting at least one product or service name, and generating the extracted names as keyword advertisement target text candidates, and (c) a method of generating only names corresponding to the words and phrases included in the advertisement keyword DB 6570 among the names extracted by the method (b) as keyword advertisement target text candidates, when the meta information is tag information, (a) a method of generating tags included in the advertisement keyword DB 6570 among at least one tag included in the tag information as keyword advertisement target text candidates, (b) a method of generating all tags included in the tag information as keyword advertisement target text candidates, (c) a method of, when multiple tags are included in the tag information, generating only tags within a preset rank as keyword advertisement target text candidates, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target text candidates, (b) a method of analyzing words and phrases included in the explanation information through the natural language processing, extracting at least one product or service name, and generating the extracted names as keyword advertisement target text candidates, (c) a method of generating only the names corresponding to the words and phrases included in the advertisement keyword DB 6570 among the names extracted by the method (b) as keyword advertisement target text candidates, and (d) a method of calculating a frequency of the names extracted by the method (b) and generating only names within a preset rank in order of the highest frequency as keyword advertisement target text candidates. The advertisement keyword DB 6570 is the DB collecting the advertisement target keywords subjected to the keyword advertisement. The name consists of at least one word, and includes at least one of a product name, a service name, a company name, a domain name, a noun, a slogan, and a brand.

The generation of at least one keyword advertisement target text candidate based on the selected meta information by the keyword advertisement target text generation module 6510 further includes the third step of identifying of whether the inquiry result of the keyword advertisement content providing server 3100 satisfies the policy of the keyword advertisement control policy DB 6540. In the identifying of whether the inquiry result of the keyword advertisement content providing server 3100 satisfies the policy of the keyword advertisement control policy DB 6540, there is obtained at least one of, in relation to the keyword advertisement target text candidate, (a) information regarding whether keyword advertisement contents corresponding to the keyword advertisement target text candidate are included in the keyword advertisement content providing server 3100, (b) information of the maximum number of transmittable keyword advertisement contents, (c) information of a higher advertisement unit price of at least one keyword advertisement content within a preset rank, and (d) information of an expected click rate with respect to exposure of at least one keyword advertisement content, from the keyword advertisement content providing server 3100. A policy reference corresponding to at least one of the (a), (b), (c), and (d) obtained from the keyword advertisement content providing server 3100 is inquired in the keyword advertisement control policy DB 6540. The keyword advertisement control policy DB 6540 includes the keyword advertisement control policy, and the keyword advertisement control policy preferably includes information on reference of the keyword advertisement target text generation.

It is preferred that the reference of the inquiry result includes, with respect to each of the keyword advertisement target text candidates or the keyword advertisement target candidate in the unit of a preset group, transmitting the keyword advertisement target text candidates to the keyword advertisement content providing server 3100 and obtaining identification information of the existence of the keyword advertisement contents corresponding to the keyword advertisement target text candidates from the keyword advertisement content providing server 3100.

The transmitting of the generated keyword advertisement target texts to the keyword advertisement content providing server 3100 includes at least one of (a) a method of transmitting all of the generated keyword advertisement target texts to the keyword advertisement content providing server 3100 and (b) a method of classifying the generated keyword advertisement target texts according to a type of meta information, on which the generated keyword advertisement target text is based, and transmitting the keyword advertisement target texts based on at least one selected type of the meta information to the keyword advertisement content providing server 3100.

The transmitting of the generated keyword advertisement target texts to the keyword advertisement content providing server 3100 includes at least one of, when the number of keyword advertisement target texts are more than one, (a) a method of transmitting the generated multiple keyword advertisement target texts only one time, (b) a method of separately transmitting the generated multiple keyword advertisement target texts one by one, and (c) a method of dividing the generated multiple keyword advertisement target texts into at least two groups and transmitting the keyword advertisement target texts in the unit of the group, but when there are multiple keyword advertisement target texts included in the same group, any one between the method (a) and the method (b) is applied.

Further, it is preferred that transmitting of the generated keyword advertisement target texts to the keyword advertisement content providing server 3100 further includes a step of granting a management number to the generated keyword advertisement target texts and mapping the generated keyword advertisement target texts to the keyword advertisement contents obtained from the keyword advertisement content providing server 3100 based on the management number.

Further, it is preferred that transmitting of the generated keyword advertisement target texts to the keyword advertisement content providing server 3100 further includes a step of, when the number of generated keyword advertisement target texts are more than one and the generated multiple keyword advertisement target texts are managed in the unit of at least one group, granting a management number to the group and each of the generated keyword advertisement target texts included in the groups, and mapping the keyword advertisement target texts included in the groups to the keyword advertisement contents obtained from the keyword advertisement content providing server 3100 based on the management number.

Further, it is preferred that transmitting of the generated keyword advertisement target texts to the keyword advertisement content providing server 3100 further includes a step of, when the number of keyword advertisement contents received by the keyword advertisement content providing server 3100 are more than one, selecting at least one keyword advertisement content to be displayed on the user computer 9000 based on a specific time among the keyword advertisement contents.

In the selection of the keyword advertisement contents, it is preferred that among multiple keyword advertisement contents received from the keyword advertisement content providing server 3100, a preset number of keyword advertisement contents is set as the maximum number and the keyword advertisement contents equal to or less than the preset number are selected.

In the selection of the keyword advertisement contents, the keyword advertisement contents are selected according to the type of the meta information, on which the keyword advertisement target texts are based, and the keyword advertisement contents are obtained according to each of the keyword advertisement target texts.

In the selection of the keyword advertisement contents, when the number of keyword advertisement contents received by the keyword advertisement content providing server 3100 are more than one, the number of keyword advertisement contents to be transmitted to the outside server based on a specific time has been set, and the number of keyword advertisement contents are larger than the number of keyword advertisement contents to be transmitted to the outside server based on the specific time, it is preferable to divide the multiple keyword advertisement contents into at least two groups and select the keyword advertisement contents included in the group in the unit of the group. It is preferred that the number of keyword advertisement contents included in each group is equal to or less than the number of keyword advertisement contents to be transmitted to the outside server based on the specific time.

The transmitting of the keyword advertisement contents to the outside server or the user computer 9000 displaying the moving picture includes at least one of (a) a method of transmitting the keyword advertisement contents corresponding to the moving picture to the outside server or the user computer 9000 only one time, (b) a method of, when the number of keyword advertisement contents are more than one, dividing the multiple keyword advertisement contents into at least two group and once or sequentially transmitting the keyword advertisement contents in the unit of the group.

When the outside server transmits information to the user computer 9000, the outside server divides the moving picture information area and the keyword advertisement content area 100, generates an information unit to be transmitted to the outside server, and asynchronizes the moving picture information area and the keyword advertisement content area 100. The keyword advertisement content area 100 obtains keyword advertisement contents through performing the asynchronization communication with the outside server or the keyword advertisement content providing system 3000.

The sequential transmission is preferably performed in the unit of a preset time range.

The time range is determined by at least one variable selected from (a) the number of keyword advertisement contents received by the keyword advertisement content providing server 3100, (b) the number of keyword advertisement contents selected from among the keyword advertisement contents received by the keyword advertisement content providing server 3100, (c) the number of keyword advertisement contents to be transmitted to the outside server based on a specific time, and (d) a reproduction time of the moving picture. When the (d) is selected, the keyword advertisement content providing server 3100 further obtains reproduction time information of the moving picture from the outside server.

The transmitting of the keyword advertisement contents to the outside server further includes the steps of: recording a transmission time of at least one keyword advertisement content transmitted to the outside server by the keyword advertisement content providing system 3000; and monitoring click generation of the keyword advertisement content up to a preset time, and when click generation information of the keyword advertisement content has not been obtained by the preset time, transmitting a preset number of keyword advertisement contents selected from among keyword advertisement contents received by the keyword advertisement content providing server 3100, other than the keyword advertisement contents transmitted to the user computer 9000, to the outside server.

The transmitting of the keyword advertisement contents to the outside server further includes the steps of: recording a transmission time of at least one specific keyword advertisement content transmitted to the outside server by the keyword advertisement content providing system 3000; and monitoring whether to generate the click of the specific keyword advertisement content up to a preset time, and it is preferred that when click generation information of the specific keyword advertisement content has been obtained within the preset time, the keyword advertisement contents transmitted to the outside server are not changed from a time of obtaining the click generation information to a preset second time.

The transmitting of the keyword advertisement contents to the outside server further includes the steps of: when additional click generation information of the keyword advertisement contents transmitted to the outside server has not been obtained by the second time, transmitting a preset number of keyword advertisement contents selected from among keyword advertisement contents received by the keyword advertisement content providing server 3100, other than the keyword advertisement contents transmitted to the outside server, to the outside server.

The transmitting of the keyword advertisement contents to the outside server further includes the steps of: recording a transmission time of at least one specific keyword advertisement content transmitted to the outside server by the keyword advertisement content providing system 3000; and monitoring a generation of a click of the specific keyword advertisement content up to a preset time, and when click generation information of the specific keyword advertisement content has been obtained within the preset time, transmitting keyword advertisement contents related to the keyword advertisement content corresponding to the click generation to the outside server.

The keyword advertisement contents related to the keyword advertisement content corresponding to the click generation refers to at least one of (a) another at least one keyword advertisement content among the keyword advertisement contents obtained together when the specific keyword advertisement target text is transmitted to the keyword advertisement content providing server 3100 in a case where the keyword advertisement content corresponding to the click generation is the keyword advertisement content obtained through transmitting at least one specific keyword advertisement target text to the keyword advertisement content providing server 3100, (b) at least one keyword advertisement content obtained through transmitting another keyword advertisement target text obtained from the same meta information, on which the keyword advertisement target texts are based, to the keyword advertisement content providing server 3100 in a case where the keyword advertisement content corresponding to the click generation is the keyword advertisement content obtained through transmitting at least one specific keyword advertisement target text to the keyword advertisement content providing server 3100, (c) at least one keyword advertisement content obtained through transmitting other keyword advertisement target texts to the keyword advertisement content providing server 3100 when the specific keyword advertisement target text is included in a specific group and other keyword advertisement target texts are included in the group in addition to the specific keyword advertisement target text in a case where the keyword advertisement content corresponding to the click generation is the keyword advertisement content obtained through transmitting at least one specific keyword advertisement target text to the keyword advertisement content providing server 3100.

The transmitting of the keyword advertisement contents to the outside server further includes at least one step of: obtaining click generation information of the keyword advertisement content transmitted to the outside server; and transmitting click generation information of the keyword advertisement content transmitted to the outside server. It is preferred that the click generation information is directly obtained from the outside server and/or obtained from the user computer. It is preferred that the click generation information is transmitted to the outside server and/or a preset third server.

The moving picture includes at least one of a real photograph moving picture, a non-real photograph moving picture, a UCC moving picture, a movie, a flash moving picture, a real-time broadcasting, and a recorded broadcasting including text-type meta information.

Next, an exemplary embodiment of the construction of the keyword advertisement content providing system 3000 of the keyword advertisement content providing system 3000 centered model will be described with reference to FIG. 18.

The keyword advertisement content providing system 3000 of the keyword advertisement content providing system 3000 centered model, which obtains meta information included in moving picture information from at least one outside server and provides at least one keyword advertisement content based on the meta information, includes the meta information based keyword advertisement providing server 4000 obtaining meta information from the outside server and providing a keyword advertisement based on the meta information and the keyword advertisement content providing server 3100 obtaining at least one keyword advertisement content based on the meta information. The keyword advertisement content providing system 3000 receives meta information related to the moving picture from the outside server, obtains at least one keyword advertisement content corresponding to the received meta information, and transmits the keyword advertisement content to the outside server or the user computer 9000 displaying the moving picture in a direct manner or through the third server or a preset server. The meta information based keyword advertisement providing server 4000 includes the meta information reception module 9800 receiving the text type meta information from the outside server, the keyword advertisement target text generation module 6510 generating at least one keyword advertisement target text with the obtained meta information, the keyword advertisement content obtainment module 6530 receiving at least one keyword advertisement content corresponding to the keyword advertisement target text, and the keyword advertisement content providing server-side text transmission module 3130 transmitting the obtained keyword advertisement contents to the outside server. The outside server includes the multimedia content service system 1000 including the multimedia content service server 1100 transmitting moving picture information of the moving picture selected by the user in the user computer 9000 to the user computer 9000 or a third server receiving meta information included in moving picture information from the multimedia content service system 1000 and transmitting the received meta information to the keyword advertisement content providing system 3000. The keyword advertisement content providing system 3000 includes the meta information based keyword advertisement providing server 4000 and the keyword advertisement content providing server 3100. The meta information based keyword advertisement providing server 4000 generates at least one keyword advertisement target text from the meta information obtained from the outside server and transmits the generated keyword advertisement target text to the keyword advertisement content providing server 3100. The keyword advertisement content providing server 3100 includes the text obtainment module 3110 receiving keyword advertisement target texts and the keyword advertisement content DB 3120 including at least one advertisement content. The keyword advertisement content providing server 3100 obtains at least one keyword advertisement corresponding to the keyword advertisement target text from the keyword advertisement content DB 3120, the keyword advertisement content providing system 3000 transmits the obtained keyword advertisement content to the outside server, and the user computer 9000 obtains moving picture reproduction information from the outside server.

The meta information obtained by the meta information reception module 9800 includes at least one of title information, tag information, explanation information, and a commercial tag set of the moving picture included in the moving picture information. The commercial tag set is preferably generated by the commercial tag set generation system 10000.

The keyword advertisement content providing system 3000 of the keyword advertisement content providing system 3000 centered model further includes the keyword advertisement control policy DB 6540 including the keyword advertisement control policy. The selection of the meta information is determined by the meta information selection policy of the keyword advertisement control policy DB 6540, and the keyword advertisement control policy preferably includes information on the selection reference of meta information.

The selection reference of the meta information is at least one of (a) when tag information is included in obtained meta information, first selecting the tag information, (b) when tag information is included in obtained meta information, selecting both tag information and title information, (c) when tag information is not included in obtained meta information, selecting title information, and (d) when tag information is not included in obtained meta information, selecting both title information and explanation information.

The generating of at least one keyword advertisement target text with the selected meta information by the keyword advertisement target text generation module 6510 includes at least one of, when the meta information is title information, (a) a method of generating words and phrases included in the advertisement keyword DB 6570 among words and phrases included in the title information as keyword advertisement target texts, (b) a method of analyzing words and phrases included in the title information through the natural language processing, extracting at least one product or service name, and generating the extracted names as keyword advertisement target texts, and (c) a method of generating only the names corresponding to the words and phrases included in the advertisement keyword DB 6570 among the names extracted by the method (b) as keyword advertisement target texts, when the meta information is tag information, (a) a method of generating tags included in the advertisement keyword DB 6570 among at least one tag included in the tag information as keyword advertisement target texts, (b) a method of generating all tags included in the tag information as keyword advertisement target texts, (c) a method of, when multiple tags are included in the tag information, generating only tags within a preset rank as keyword advertisement target texts, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target texts, (b) a method of analyzing words and phrases included in the explanation information through the natural language processing, extracting at least one product or service name, and generating the extracted names as keyword advertisement target texts, (c) a method of generating only the names corresponding to the words and phrases included in the advertisement keyword DB 6570 among the names extracted by the method (b) as keyword advertisement target texts, and (d) a method of calculating a frequency of the names extracted by the method (b) and generating only names within a preset rank in order of the highest frequency as keyword advertisement target texts. The advertisement keyword DB 6570 is the DB collecting the advertisement target keywords subjected to the keyword advertisement. The name consists of at least one word, and includes at least one of a product name, a service name, an advertisement keyword list received from the keyword advertisement content providing server 3100, an advertisement keyword list obtained from a third person, a self generated advertisement keyword list, a keyword advertisement target text list creating advertisement gains, a company name, a domain name, a noun, a slogan, and a brand.

The generation of at least one keyword advertisement target text with the selected meta information by the keyword advertisement target text generation module 6510 includes multiple steps including the first step of generating a keyword advertisement target text candidate and the second step of inquiring of the keyword advertisement content providing server 3100 about the generated keyword advertisement target text candidate and generating keyword advertisement target texts with reference to an inquiry result.

The first step of generating the keyword advertisement target text candidate by the keyword advertisement target text generation module 6510 includes at least one of, when the meta information is title information, (a) a method of generating words and phrases included in the advertisement keyword DB 6570 among words and phrases included in the title information as keyword advertisement target text candidates, (b) a method of analyzing words and phrases included in the title information through the natural language processing, extracting at least one product or service name, and generating the extracted names as keyword advertisement target text candidates, and (c) a method of generating only names corresponding to the words and phrases included in the advertisement keyword DB 6570 among the names extracted by the method (b) as keyword advertisement target text candidates, when the meta information is tag information, (a) a method of generating tags included in the advertisement keyword DB 6570 among at least one tag included in the tag information as keyword advertisement target text candidates, (b) a method of generating all tags included in the tag information as a keyword advertisement target text candidates, (c) a method of, when multiple tags are included in the tag information, generating only tags within a preset rank as keyword advertisement target text candidates, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target text candidates, (b) a method of analyzing words and phrases included in the explanation information through the natural language processing, extracting at least one product or service name, and generating the extracted names as keyword advertisement target text candidates, (c) a method of generating only the names corresponding to the words and phrases included in the advertisement keyword DB 6570 among the names extracted by the method (b) as keyword advertisement target text candidates, and (d) a method of calculating a frequency of the names extracted by the method (b) and generating only names within a preset rank in order of the highest frequency as keyword advertisement target text candidates. The advertisement keyword DB 6570 is the DB collecting the advertisement target keywords subjected to the keyword advertisement. The name consists of at least one word, and includes at least one of a product name, a service name, a company name, a domain name, a noun, a slogan, and a brand.

The generation of at least one keyword advertisement target text with the selected meta information by the keyword advertisement target text generation module 6510 further includes a third step of identifying of whether the inquiry result of the keyword advertisement content providing server 3100 satisfies the policy of the keyword advertisement control policy DB 6540. The identifying of whether the inquiry result of the keyword advertisement content providing server 3100 satisfies the policy of the keyword advertisement control policy DB 6540 includes obtaining, at least one of (a) information regarding whether keyword advertisement contents corresponding to the keyword advertisement target text candidate are included in the keyword advertisement content providing server 3100, (b) information of the maximum number of transmittable keyword advertisement contents, (c) information of a higher advertisement unit price of at least one keyword advertisement content within a preset rank, and (d) information of an expected click rate with respect to exposure of at least one keyword advertisement content, and inquiring a policy reference of the keyword advertisement control policy DB 6540 corresponding to at least one of the (a), (b), (c), and (d) obtained from the keyword advertisement content providing server 3100. The keyword advertisement control policy DB 6540 includes the keyword advertisement control policy, and the keyword advertisement control policy preferably includes information on reference of the keyword advertisement target text generation.

It is preferred that the reference of the inquiry result by the keyword advertisement target text generation module 6510 includes, with respect to each of the keyword advertisement target text candidates or the keyword advertisement target candidate in the unit of a preset group, transmitting the keyword advertisement target text candidates to the keyword advertisement content providing server 3100 and obtaining identification information of the existence of the keyword advertisement contents corresponding to the keyword advertisement target text candidates from the keyword advertisement content providing server 3100.

The keyword advertisement content providing system 3000 of the keyword advertisement content providing system 3000 centered model further includes the keyword advertisement content transmission module 6520 transmitting the generated keyword advertisement target texts to the keyword advertisement content providing server 3100. The transmitting of the generated keyword advertisement target texts to the keyword advertisement content providing server 3100 by the keyword advertisement content transmission module 6520 includes at least one of (a) a method of transmitting all of the generated keyword advertisement target texts to the keyword advertisement content providing server 3100 and (b) a method of classifying the generated keyword advertisement target texts according to a type of meta information, on which the generated keyword advertisement target text is based, and transmitting the keyword advertisement target texts based on at least one selected type of the meta information to the keyword advertisement content providing server 3100.

The keyword advertisement content providing system 3000 of the keyword advertisement content providing system 3000 centered model further includes the keyword advertisement content transmission module 6520 transmitting the generated keyword advertisement target texts to the keyword advertisement content providing server 3100. The transmitting of the generated keyword advertisement target texts to the keyword advertisement content providing server 3100 by the keyword advertisement content transmission module 6520 includes at least one of, when the number of keyword advertisement target texts are more than one, (a) a method of transmitting the generated multiple keyword advertisement target texts only one time, (b) a method of separately transmitting the generated multiple keyword advertisement target texts one by one, and (c) a method of dividing the generated multiple keyword advertisement target texts into at least two groups and transmitting the keyword advertisement target texts in the unit of the group, but when there are multiple keyword advertisement target texts included in the same group, any one between the method (a) and the method (b) is applied.

The keyword advertisement content providing system 3000 of the keyword advertisement content providing system 3000 centered model further includes the keyword advertisement content transmission module 6520 transmitting the generated keyword advertisement target texts to the keyword advertisement content providing server 3100. The keyword advertisement target text generation module 6510 grants a management number to the generated keyword advertisement target texts, to store the keyword advertisement target texts, the keyword advertisement content transmission module 6520 transmits the generated keyword advertisement target texts to the keyword advertisement content providing server 3100, and the keyword advertisement content obtainment module 6530 receives keyword advertisement contents corresponding to the generated keyword advertisement target texts and maps the keyword advertisement contents to the generated keyword advertisement target texts based on the management number, to store the keyword advertisement contents.

In the mapping of the keyword advertisement contents to the generated keyword advertisement target texts, when the number of generated keyword advertisement target texts are more than one and the generated multiple keyword advertisement target texts are managed in the unit of at least one group, it is preferable to grant a management number to the group and each of the generated keyword advertisement target texts included in the groups, map the keyword advertisement target texts included in the groups to the keyword advertisement contents obtained from the keyword advertisement content providing server 3100 based on the management number, and store the keyword advertisement contents.

The keyword advertisement content providing system 3000 of the keyword advertisement content providing system 3000 centered model further includes the keyword advertisement content selection module 6550 for selecting at least one keyword advertisement content to be transmitted to the outside server among the keyword advertisement contents based on a specific time when the number of keyword advertisement contents received by the keyword advertisement content providing server 3100 are more than one.

In the selection of the keyword advertisement contents by the keyword advertisement content selection module 6550, it is preferred that among multiple keyword advertisement contents received from the keyword advertisement content providing server 3100, a preset number of keyword advertisement contents is set as the maximum number and the keyword advertisement content selection module 6550 selects the keyword advertisement contents equal to or less than the preset number among the keyword advertisement contents received from the keyword advertisement content providing server 3100.

In the selection of the keyword advertisement contents by the keyword advertisement content selection module 6550, the keyword advertisement contents are selected according to the type of the meta information on which the keyword advertisement target texts are based. It is preferable to inquire of the keyword advertisement content providing server 3100 about each of the keyword advertisement target texts and then obtain the keyword advertisement contents corresponding to each of the keyword advertisement target texts from the keyword advertisement content providing server 3100.

In the selection of the keyword advertisement contents by the keyword advertisement content selection module 6550, when the number of keyword advertisement contents received by the keyword advertisement content providing server 3100 are more than one, the number of keyword advertisement contents to be transmitted to the outside server based on a specific time has been set, and the number of keyword advertisement contents are larger than the number of keyword advertisement contents to be transmitted to the outside server based on the specific time, it is preferable to divide the multiple keyword advertisement contents into at least two groups and select the keyword advertisement contents included in the group in the unit of the group. It is preferred that the number of keyword advertisement contents included in each group is equal to or less than the number of keyword advertisement contents to be transmitted to the outside server based on the specific time.

The transmitting of the keyword advertisement contents to the outside server or the user computer 9000 displaying the moving picture by the keyword advertisement content providing server-side text transmission module 3130 includes at least one of (a) a method of transmitting at least one keyword advertisement content corresponding to the moving picture at one time and (b) a method of, when the number of keyword advertisement contents are more than one, dividing the multiple keyword advertisement contents into at least two group and once or sequentially transmitting the keyword advertisement contents in the unit of the group, to the outside server or the user computer 9000 displaying the moving picture.

When the outside server transmits information to the user computer 9000, the outside server divides the moving picture information area and the keyword advertisement content area 100, generates an information unit to be transmitted to the outside server, and asynchronizes the moving picture information area and the keyword advertisement content area 100. The keyword advertisement content area 100 obtains keyword advertisement contents through performing the asynchronization communication with the outside server or the keyword advertisement content providing system 3000.

The sequential transmission is preferably performed in the unit of a preset time range.

The time range is determined by at least one variable selected from (a) the number of keyword advertisement contents received by the keyword advertisement content providing server 3100, (b) the number of keyword advertisement contents selected from among the keyword advertisement contents received by the keyword advertisement content providing server 3100, (c) the number of keyword advertisement contents to be transmitted to the outside server based on a specific time, and (d) a reproduction time of the moving picture. When the (d) is selected, the keyword advertisement content providing server 3100 further obtains reproduction time information of the moving picture from the outside server.

The keyword advertisement content providing system 3000 records a transmission time of at least one keyword advertisement content transmitted to the outside server and monitors click generation of the keyword advertisement content up to a preset time. When click generation information of the keyword advertisement content has not been obtained by the preset time, the keyword advertisement content providing system 3000 transmits a preset number of keyword advertisement contents selected from among keyword advertisement contents received by the keyword advertisement content providing server 3100, other than the keyword advertisement contents transmitted to the user computer 9000, to the outside server.

The keyword advertisement content providing system 3000 records a transmission time of at least one specific keyword advertisement content transmitted to the outside server and monitors whether to generate the click of the specific keyword advertisement content up to a preset time. When click generation information of the specific keyword advertisement content has been obtained within the preset time, it is preferred that the keyword advertisement content providing system 3000 does not change the keyword advertisement contents transmitted to the outside server from a time of obtaining the click generation information to a preset second time.

When additional click generation information of the keyword advertisement contents transmitted to the outside server has not been obtained by the second time, the keyword advertisement content providing system 3000 transmits a preset number of keyword advertisement contents selected from among keyword advertisement contents received by the keyword advertisement content providing system 3000, other than the keyword advertisement contents transmitted to the outside server, to the outside server.

The keyword advertisement content providing system 3000 records a transmission time of at least one specific keyword advertisement content transmitted to the outside server and monitors a generation of a click of the specific keyword advertisement content up to a preset time. When click generation information of the specific keyword advertisement content has been obtained within the preset time, the keyword advertisement content providing system 3000 transmits keyword advertisement contents related to the keyword advertisement content corresponding to the click generation to the outside server.

The keyword advertisement contents related to the keyword advertisement content corresponding to the click generation refers to (a) another at least one keyword advertisement content among the keyword advertisement contents obtained when the specific keyword advertisement target text is transmitted to the keyword advertisement content providing server 3100 in a case where the keyword advertisement content corresponding to the click generation is the keyword advertisement content obtained through transmitting at least one specific keyword advertisement target text to the keyword advertisement content providing server 3100, (b) at least one keyword advertisement content obtained through transmitting another keyword advertisement target text obtained from the same meta information, on which the keyword advertisement target texts are based, to the keyword advertisement content providing server 3100 in a case where the keyword advertisement content corresponding to the click generation is the keyword advertisement content obtained through transmitting at least one specific keyword advertisement target text to the keyword advertisement content providing server 3100, (c) at least one keyword advertisement content obtained through transmitting the other keyword advertisement target texts to the keyword advertisement content providing server 3100, when the specific keyword advertisement target text is included in a specific group and other keyword advertisement target texts are included in the group in addition to the specific keyword advertisement target text in a case where the keyword advertisement content corresponding to the click generation is the keyword advertisement content obtained through transmitting at least one specific keyword advertisement target text to the keyword advertisement content providing server 3100.

The keyword advertisement content providing system 3000 includes at least one of the click generation information reception module 8900 obtaining click generation information of the keyword advertisement contents transmitted to the user computer 9000 and a click generation information transmission module 9900 for transmitting the obtained click generation information to a preset server.

It is preferred that the click generation information is directly obtained from the user computer 9000 or the outside server, or directly obtained by the keyword advertisement content providing system 3000. It is preferred that the click generation information is transmitted to the outside server and/or a preset third server.

The moving picture includes at least one of a real photograph moving picture, a non-real photograph moving picture, a UCC moving picture, a movie, a flash moving picture, a real-time broadcasting, and a recorded broadcasting including text-type meta information.

Integration Model

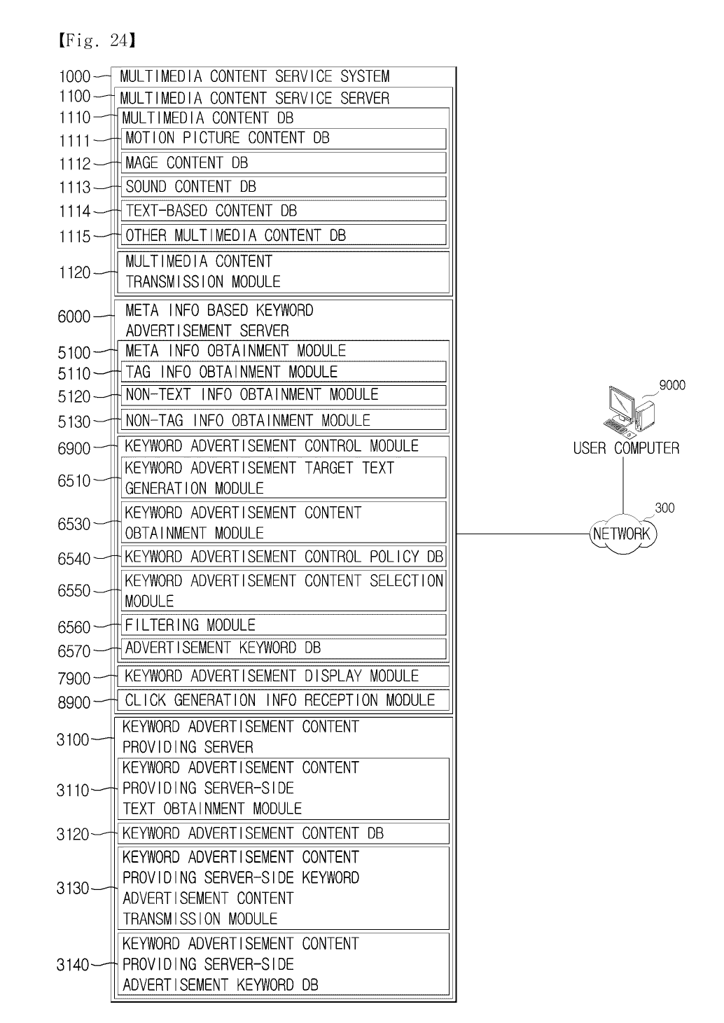

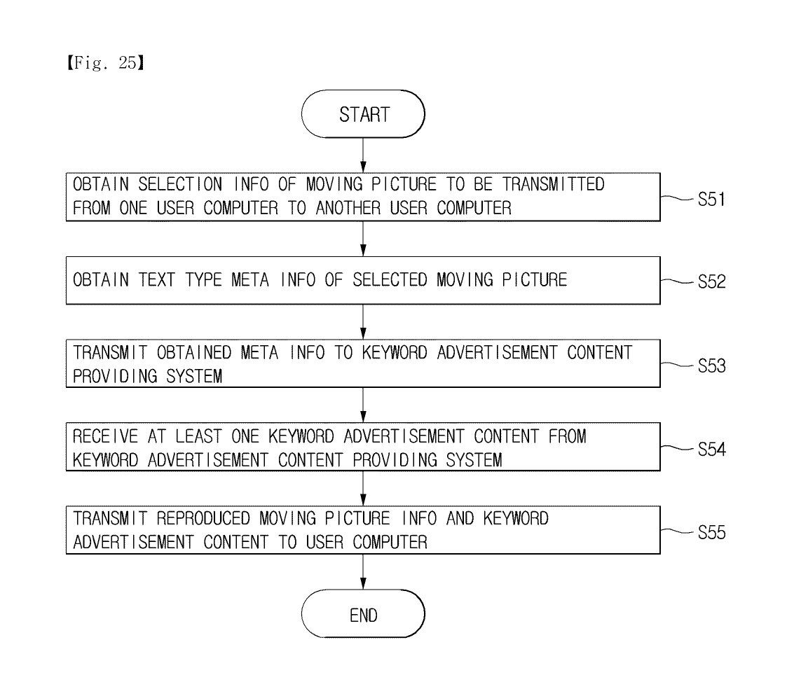

Hereinafter, the integration model will be described with reference to FIGS. 24 to 25. The integration model represents a type in which the multimedia content service system 1000 is integrated with the keyword advertisement content providing system 3000. The user preferentially recognizes the multimedia content service system 1000, so that it is described that the construction of the keyword advertisement content providing system 3000 is conceptually integrated to the multimedia content service system 1000. However, it is a matter of course that the present invention does not exclude the contrary case.

In the integration model, the data is transmitted/received between servers conceptually performing various functions, so that it is more relatively reasonable that the integration model includes modules related to the transmission/reception of the data, such as the meta information transmission module 5200, the keyword advertisement content reception module 530, and the meta information reception module 9800. However, unless a single meta information based keyword advertisement providing server 4000 manages multiple multimedia content service systems 1000, it is reasonable not to include the multimedia content service system 1000 management module in the integration model. However, in the integration model, if the multimedia content service system 1000 includes multiple multimedia content service servers 1100 and the multimedia content service servers 1100 provide different kinds of multimedia content services or the same kind of multimedia content services, but the multiple multimedia content service servers 1100, such as the different sites, are included and it is necessary to manage the multiple multimedia content service servers 1100, it is more reasonable to include the multimedia content service system management module 7800. It is a matter of course that it may be proper that the meaning of the multimedia content service system management module 7800 is equally used with that of the multimedia content service server 1100 management module according to its name, but its functions are substantially identical independently of the name.

Hybrid Model

In the meantime, there is a hybrid model in which the integration model is combined with the intermediation model. In the hybrid model, The multimedia content service system 1000 of the integration model includes the meta information based keyword advertisement intermediation server 2100 and provides the keyword advertisement content service for the multimedia content service system 1000, but further includes a second meta information based keyword advertisement providing server 4000 for at least one third multimedia content service server 1100. The meta information based keyword advertisement providing server 4000 extracts keyword advertisement contents based on meta information transmitted from the third multimedia content service server 1100 and transmits the extracted keyword advertisement content to the third multimedia content service server 1100.

User Computer Installed Program 9100 Model

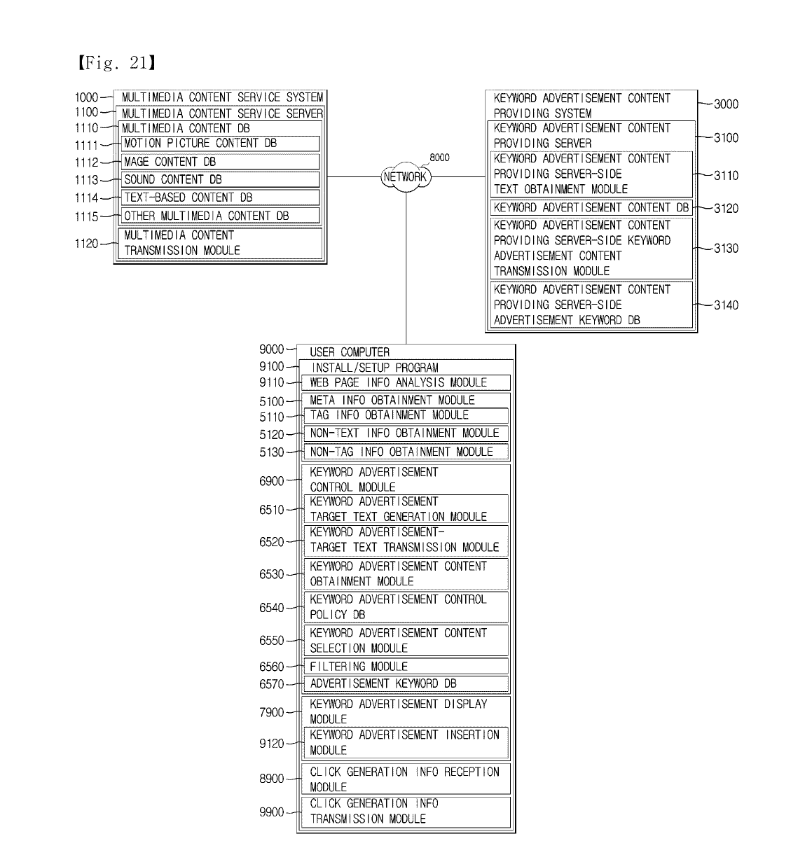

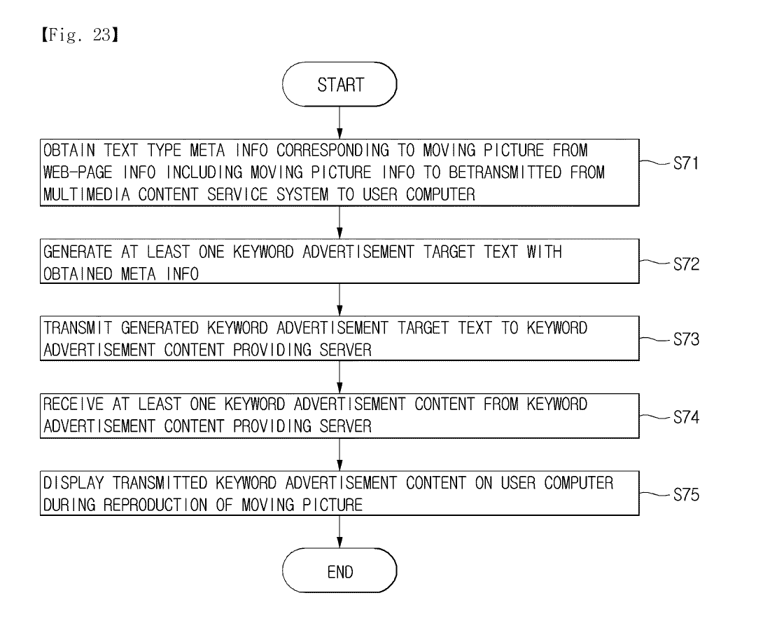

Next, the user computer installed program 9100 model will be described with reference to FIGS. 21 to 23.

A specific installation type program 9100 installed in the user computer 9000 may perform a function of the meta information obtainment module 5100, the keyword advertisement control module 6900, and the keyword advertisement display module 7900. For example, the installation type program 9100 includes at least one installation type program which a browser can utilize, at least one program (including a script code) executable in the browser, at least one program executable or usable in the browser provided by the multimedia content service system 1000, or an exclusive multimedia service program, such as Windows Media Player, a flash player, GOM Player, and GOM TV. That is, the installation type program 9100 may perform a function of the meta information obtainment module 5100 obtaining meta information of the multimedia content or transmit the obtained meta information to at least one preset keyword advertisement content providing server 3100. Further, the installation type program 9100 performs the function of at least one module included in the keyword advertisement control module 6900 (it is preferable to include the keyword advertisement target text generation module and the keyword advertisement content obtainment module 6530), transmits the keyword advertisement content to the preset keyword advertisement content providing server 3100, receives the keyword advertisement content from the preset keyword advertisement content providing server 3100, and displays the keyword advertisement content on the user computer 9000. At this time, the installation type program 9100 may display the received keyword advertisement content on a preset location of the user computer 9000. When the installation type program 9100 is generated by a person involving the multimedia content service server 1100, the installation type program 9100 can easily insert the received keyword advertisement content to page information of web page contents received from the multimedia content service server 1100. However, when the installation type program 9100 is generated by a person not involving the multimedia content service server 1100, the installation type program 9100 may optionally insert the received keyword advertisement content to page information of web page contents received from the multimedia content service server 1100 while residing in the user computer 9000, provide the keyword advertisement content in another transparent or semi-transparent layer, display the keyword advertisement content in a separate window, such as a pop-up, or display the keyword advertisement content at a preset location (more preferably, the bottommost location, a desk-bar side, a right-upper corner) of the user computer 9000.

In the above description, the description has been given on an assumption that the multimedia content service server 1100 streams the multimedia content selected by the user and provides the moving picture information to the user computer 9000. However, it is apparent to those skilled in that art that the spirit of the present invention can apply to the case in which the multimedia content service server 1100 only transmits the multimedia content selected by the user to the user computer 9000 and the program 9100 installed in the user computer 9000 reproduces the received multimedia content. At this time, the installed program 9100 must include the multimedia content transmission module 1120 capable of reproducing the multimedia content. It is preferred that when the multimedia content is transmitted, meta information of the multimedia content is also transmitted to the user computer 9000. The meta information may be included in the multimedia content file, or transmitted independently of the multimedia content file and the installed program 9100 processes the meta information in correspondence with the multimedia content file. The meta information includes the title information, tag information, explanation information, etc., but can also include subtitle information (including caption information as a matter of course). In the meantime, the subtitle information is preferably the SMI file type.

It is preferred that the installation type program 9100 includes a web page information analysis module 9110 analyzing web page information including moving picture information transmitted to the user computer 9000. The web page information analysis module 9110 analyzes received web page information related to the moving picture, obtains a preset area including meta information, and provides the meta information obtainment module 5100 with the area including the meta information, so that the meta information obtainment module 5100 can obtain the meta information. The keyword advertisement display module 7900 inserts keyword advertisement contents to the received web page so as to display the keyword advertisement contents on a preset location. At this time, a keyword advertisement insertion module 9120 inserts keyword advertisement contents to a preset location of the web page.

The keyword advertisement insertion module 9120 can provide the web page by a method of reconstructing the web page so as to include the keyword advertisement content and providing a browser of the user with the reconstructed web page. In order to execute the above method, the keyword advertisement display module 7900 obtains the transmitted web page, obtains a control authority for the web page, inserts the keyword advertisement content to a preset location of the web page of which the control authority has been obtained, generates a modified web page, and provides the browser of the user computer 9000 with the modified web page. It is a matter of course that when the keyword advertisement insertion module 9120 is operated in the exclusive multimedia reproduction program, the program can download and reproduce the multimedia content file (including meta information), so that it is not necessary to analyze the web page. In the meantime, when the area 100 in the web page to display the keyword advertisement content uses the asynchronous communication (ASAX, etc.) method, etc, the web page communicates with the keyword advertisement display module 7900, and the keyword advertisement display module 7900 provides the browser displaying the web page with the keyword advertisement content information, the browser can display the keyword advertisement content on a preset location.

When the user clicks a specific keyword advertisement content, the installation type program 9100 can include the click generation information reception module 8900 obtaining the click generation information. Further, when it is necessary to transmit the click generation information obtained by the click generation information reception module 8900 to the outside server, the installation type program 9100 can include the click generation information transmission module 9900.

The click generation information transmission module 9900 has been described in the installation-type program 9100. However, the click generation information transmission module 9900 performs a function of transmitting the obtained click generation information to a server of a relevant preset business operator, so that the click generation information transmission module 9900 is not limited to the installation type program 9100 and can be included in the multimedia content service system 1000/multimedia content service server 1100, the meta information based keyword advertisement server 6000, the meta information based keyword advertisement intermediation system 2000, the keyword advertisement content providing server 3100/keyword advertisement content providing system 3000, etc. as a matter of course. When the click generation information transmission module 9900 transmits the click generation information to a server of a relevant preset business operator, it is possible to immediately recognize the generated advertisement quantity and advertisement effects and accurately calculate the advertisement gains.

The above description has been given on the condition in which a single multimedia content is selected in the user computer 9000, but at least two multimedia contents can be simultaneously selected in the user computer 9000. At least two multimedia contents may be the identical kind (all of the selected multimedia contents are moving pictures) or the different kinds (one of the selected multimedia contents is a moving picture and another selected multimedia contents are images). At this time, there are three types of selected multimedia contents, to which the spirit of the present invention can be applied. The first type is granting a priority to a kind of multimedia contents and processing the multimedia contents. It is preferable to grant the higher priority to the moving picture multimedia content. That is, when the moving picture and the image are transmitted, the spirit of the present invention is preferentially applied to the moving picture. The second type is applying the spirit of the present invention to the multimedia content in order of the transmission when the multimedia contents are orderly transmitted to the user computer 9000. That is, when the user selects multiple moving pictures and the moving pictures are transmitted at time intervals, the spirit of the present invention can be applied to the currently transmitted moving picture based on the transmission time. The third type is, when the multiple multimedia contents are displayed on the user computer 9000 at the same time, applying the spirit of the present invention to each of the multimedia contents based on each of the multimedia contents of a location, on which each of the multimedia contents is located. That is, the multiple images are transmitted and displayed in parallel on the user computer 9000, so it is possible to arrange the keyword advertisement content based on the meta information extracted from each of the images under each of the multiple images.

The implementation of the spirit of the present invention by the program 9100 (e.g. the plug-in program) installed in the user computer 9000 has been described. Meanwhile, the current web technology includes the program execution technology that is somewhat different from the concept of the typical installation (recorded in the HDD and driven), for example, a program constituted by the script languages, such as a program constituted with the Java scripts. The program constituted by the script languages, such as the Java scripts, can be inserted in the entire code constituting the web page information and can be operated like the program 9100, such as the plug-in program, installed in the user computer 9000. The multimedia content service system 1000 transmitting the multimedia content to the user computer 9000 provides the user computer 9000 with information of the multimedia content (the image file itself when the image is transmitted) streamed for the user together with the script program including the Java script. The script program can perform most of the functions of the meta information obtainment module 5100 and the keyword advertisement control module 6900. That is, the script program can 1) obtain meta information from the multimedia content information, 2) communicate with the multimedia content service system 1000 or when contents of the keyword advertisement control policy DB 5320 are programmed in the script program, serve as the keyword advertisement target text generation module 6510 independently of the communication with the multimedia content service system 1000, 3) communicate with the keyword advertisement content providing system 3000 and obtain keyword advertisement content from the keyword advertisement content providing system 3000, to serve as the keyword advertisement content obtainment module 6530, 4) serve as the keyword advertisement content selection module 6550 in the same manner of 2), 5) serve as the keyword advertisement display module 7900, and 6) when the script program has an event detection function, obtain click information of a specific keyword advertisement content from the user computer 9000 and transmit the obtained click information to the multimedia content service system 1000 or the keyword advertisement content providing system 3000. It is apparent to those skilled in the art that the spirit of the present invention can be implemented through the program 9100 installed in the user computer 9000, but also can be implemented through a program that is not installed in the user computer 9000.

The above description has been mainly given to describe that the multimedia content service system 1000 inserts the script program in the moving picture information to be transmitted to the user computer 9000. The script program can be inserted in the moving picture information in the meta information based keyword advertisement intermediation system 2000 or the keyword advertisement content providing system 3000. The multimedia content service system 1000 receives the script from the meta information based keyword advertisement intermediation system 2000/keyword advertisement content providing system 3000, inserts the script in the web page provided from the multimedia content service system 1000, and transmits the web page to the user computer 9000, and the script communicates with the meta information based keyword advertisement intermediation system 2000/keyword advertisement content providing system 3000.

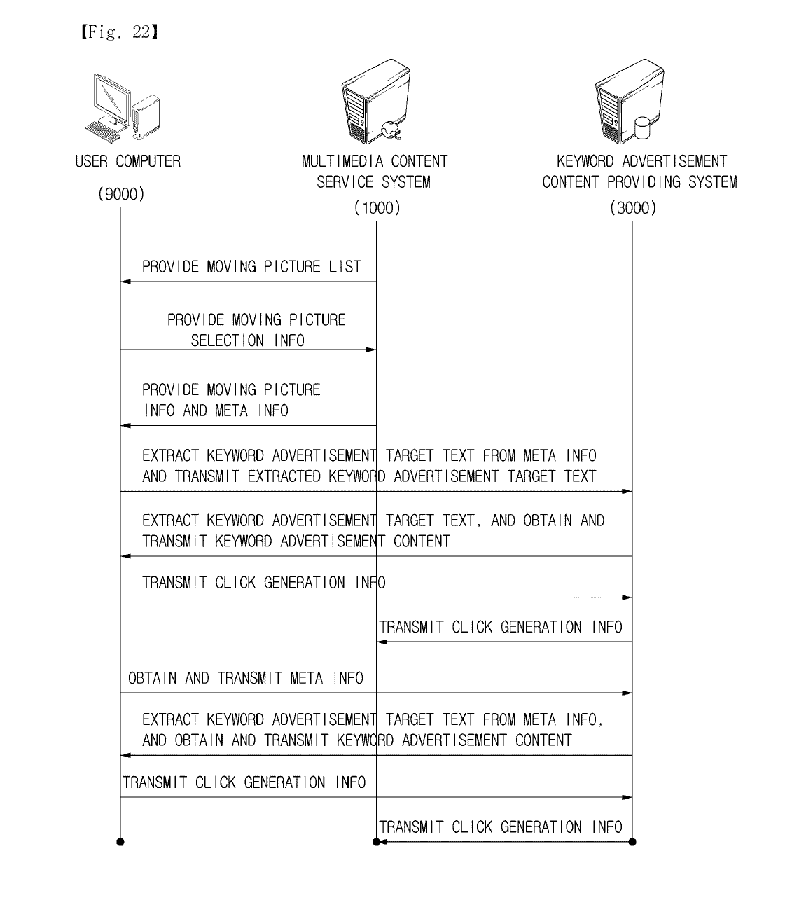

Next, an exemplary embodiment of a method of operating the program 9100 installed in a recording medium of the user computer 9000 of the user computer installed program 9100 model will be described with reference to FIG. 22.

The method for providing a keyword advertisement service by the computer program 9100 recorded in the recording medium capable of providing the user computer 9000 with a keyword advertisement content based on moving picture information transmitted from the user computer 9000 includes the steps of: obtaining meta information by any one method selected between (a) obtaining text type meta information corresponding to the moving picture from web page information including moving picture information transmitted from the multimedia content service system 1000 to the user computer 9000 (S71-a) and (b) obtaining meta information from a multimedia content file (including meta information) transmitted to the user computer 9000 (S71-b) (S71); generating at least one keyword advertisement target text with the obtained meta information (S72); transmitting the generated keyword advertisement target text to the keyword advertisement content providing server 3100 (S73); receiving at least one keyword advertisement content from the keyword advertisement content providing server 3100 (S74); and displaying the transmitted keyword advertisement content on the user computer 9000 during the reproduction of the moving picture (S75). The computer program 9100 includes the meta information obtainment module 5100 obtaining meta information from the moving picture information, the keyword advertisement target text generation module 6510 for generating a keyword advertisement target text with the meta information; and the keyword advertisement content obtainment module 6530 obtaining keyword advertisement contents from the keyword advertisement content providing server 3100. The computer program 9100 includes the keyword advertisement display module 7900 for displaying keyword advertisement contents received by the keyword advertisement content reception module 5300 on a preset location, which is discriminated from a moving picture area reproducing and displaying the moving picture. The keyword advertisement display module 7900 includes the keyword advertisement insertion module 9120 for inserting the keyword advertisement content to the received web page information. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the received keyword advertisement target texts from the keyword advertisement content DB 3120 and transmits the obtained keyword advertisement content to the multimedia content service server 1100.

Information obtained by the keyword advertisement content providing server-side text obtainment module 3110 is the text type. The text type information includes tag information, title information, explanation information, and other text type information. It is a matter of course that the text type information includes the keyword advertisement target texts.

In the step of obtaining the meta information, the meta information includes at least one of title information, tag information, explanation information, and a commercial tag set of the moving picture included in the moving picture information. The commercial tag set is preferably generated by the commercial tag set generation system 10000.

The selection of the meta information is determined by the meta information selection policy of the keyword advertisement control policy DB 6540, the keyword advertisement control policy DB 6540 includes the keyword advertisement control policy, and the keyword advertisement control policy preferably includes information on the selection reference of meta information.

The selection reference of the meta information is at least one of (a) when tag information is included in obtained meta information, first selecting the tag information, (b) when tag information is included in obtained meta information, selecting both tag information and title information, (c) when tag information is not included in obtained meta information, selecting title information, and (d) when tag information is not included in obtained meta information, selecting both title information and explanation information.

The generating of at least one keyword advertisement target text with the selected meta information includes at least one of, when the meta information is title information, (a) a method of generating words and phrases included in the advertisement keyword DB 6570 among words and phrases included in the title information as keyword advertisement target texts, (b) a method of analyzing words and phrases included in the title information through the natural language processing, extracting at least one product or service name, and generating the extracted names as keyword advertisement target texts, and (c) a method of generating only the names corresponding to the words and phrases included in the advertisement keyword DB 6570 among the names extracted by the method (b) as keyword advertisement target texts, when the meta information is tag information, (a) a method of generating tags included in the advertisement keyword DB 6570 among at least one tag included in the tag information as keyword advertisement target texts, (b) a method of generating all tags included in the tag information as keyword advertisement target texts, (c) a method of, when multiple tags are included in the tag information, generating only tags within a preset rank as keyword advertisement target texts, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target texts, (b) a method of analyzing words and phrases included in the explanation information through the natural language processing, extracting at least one product or service name, and generating the extracted names as keyword advertisement target texts, (c) a method of generating only the names corresponding to the words and phrases included in the advertisement keyword DB 6570 among the names extracted by the method (b) as keyword advertisement target texts, and (d) a method of calculating a frequency of the names extracted by the method (b) and generating only names within a preset rank in order of the highest frequency as keyword advertisement target texts. The advertisement keyword DB 6570 is the DB collecting the advertisement target keywords subjected to the keyword advertisement. The name consists of at least one word, and includes at least one of a product name, a service name, an advertisement keyword list received from the keyword advertisement content providing server 3100, an advertisement keyword list obtained from a third person, a self generated advertisement keyword list, a keyword advertisement target text list creating advertisement gains, a company name, a domain name, a noun, a slogan, and a brand.

The generation of at least one keyword advertisement target text with the selected meta information includes multiple steps of the first step of generating a keyword advertisement target text candidate and the second step of inquiring of the keyword advertisement content providing server 3100 about the generated keyword advertisement target text candidate and generating keyword advertisement target texts with reference to an inquiry result.

The first step of generating the keyword advertisement target text candidate includes at least one of, when the meta information is title information, (a) a method of generating words and phrases included in the advertisement keyword DB 6570 among words and phrases included in the title information as keyword advertisement target text candidates, (b) a method of analyzing words and phrases included in the title information through the natural language processing, extracting at least one product or service name, and generating the extracted names as keyword advertisement target text candidates, and (c) a method of generating only names corresponding to the words and phrases included in the advertisement keyword DB 6570 among the names extracted by the method (b) as keyword advertisement target text candidates, when the meta information is tag information, (a) a method of generating tags included in the advertisement keyword DB 6570 among at least one tag included in the tag information as keyword advertisement target text candidates, (b) a method of generating all tags included in the tag information as a keyword advertisement target text candidates, (c) a method of, when multiple tags are included in the tag information, generating only tags within a preset rank as keyword advertisement target text candidates, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target text candidates, (b) a method of analyzing words and phrases included in the explanation information through the natural language processing, extracting at least one product or service name, and generating the extracted names as keyword advertisement target text candidates, (c) a method of generating only the names corresponding to the words and phrases included in the advertisement keyword DB 6570 among the names extracted by the method (b) as keyword advertisement target text candidates, and (d) a method of calculating a frequency of the names extracted by the method (b) and generating only names within a preset rank in order of the highest frequency as keyword advertisement target text candidates. The advertisement keyword DB 6570 is the DB collecting the advertisement target keywords subjected to the keyword advertisement. The name consists of at least one word, and includes at least one of a product name, a service name, a company name, a domain name, a noun, a slogan, and a brand.

The generation of at least one keyword advertisement target text candidate based on the selected meta information further includes the third step of identifying of whether the inquiry result of the keyword advertisement content providing server 3100 satisfies the policy of the keyword advertisement control policy DB 6540. The identifying of whether the inquiry result of the keyword advertisement content providing server 3100 satisfies the policy of the keyword advertisement control policy DB 6540 includes obtaining, from the keyword advertisement content providing server 3100, at least one of, in relation to the keyword advertisement target text candidate, (a) information regarding whether keyword advertisement contents corresponding to the keyword advertisement target text candidate are included in the keyword advertisement content providing server 3100, (b) information of the maximum number of transmittable keyword advertisement contents, (c) information of a higher advertisement unit price of at least one keyword advertisement content within a preset rank, and (d) information of an expected click rate with respect to exposure of at least one keyword advertisement content, and inquiring of the keyword advertisement control policy DB 6540 about a policy reference corresponding to at least one of the (a), (b), (c), and (d) obtained from the keyword advertisement content providing server 3100. The keyword advertisement control policy DB 6540 includes the keyword advertisement control policy, and the keyword advertisement control policy preferably includes information on reference of the keyword advertisement target text generation.

It is preferred that the reference of the inquiry result includes, with respect to each of the keyword advertisement target text candidates or the keyword advertisement target candidate in the unit of a preset group, transmitting the keyword advertisement target text candidates to the keyword advertisement content providing server 3100 and obtaining identification information of the existence of the keyword advertisement contents corresponding to the keyword advertisement target text candidates from the keyword advertisement content providing server 3100.

The transmitting of the generated keyword advertisement target texts to the keyword advertisement content providing server 3100 includes at least one of (a) a method of transmitting all of the generated keyword advertisement target texts to the keyword advertisement content providing server 3100 and (b) a method of classifying the generated keyword advertisement target texts according to a type of meta information, on which the generated keyword advertisement target text is based, and transmitting the keyword advertisement target texts based on at least one selected type of the meta information to the keyword advertisement content providing server 3100. The transmitting of the generated keyword advertisement target texts to the keyword advertisement content providing server 3100 includes at least one of, when the number of keyword advertisement target texts are more than one, (a) a method of transmitting the generated multiple keyword advertisement target texts only one time, (b) a method of separately transmitting the generated multiple keyword advertisement target texts one by one, and (c) a method of dividing the generated multiple keyword advertisement target texts into at least two groups and transmitting the keyword advertisement target texts in the unit of the group, but when there are multiple keyword advertisement target texts included in the same group, any one between the method (a) and the method (b) is applied.

Further, it is preferred that the transmitting of the generated keyword advertisement target texts to the keyword advertisement content providing server 3100 further includes a step of granting a management number to the generated keyword advertisement target texts and mapping the generated keyword advertisement target texts to the keyword advertisement contents obtained from the keyword advertisement content providing server 3100 based on the management number to store the keyword advertisement contents.

Further, it is preferred that the transmitting of the generated keyword advertisement target texts to the keyword advertisement content providing server 3100 further includes a step of, when the number of generated keyword advertisement target texts are more than one and the generated multiple keyword advertisement target texts are managed in the unit of at least one group, granting a management number to the group and each of the generated keyword advertisement target texts included in the groups, and mapping the keyword advertisement target texts included in the groups to the keyword advertisement contents obtained from the keyword advertisement content providing server 3100 based on the management number and storing the keyword advertisement contents.

Further, it is preferred that the transmitting of the generated keyword advertisement target texts to the keyword advertisement content providing server 3100 further includes a step of, when the number of keyword advertisement contents received by the keyword advertisement content providing server 3100 are more than one, selecting at least one keyword advertisement content to be displayed on the user computer 9000 based on a specific time among the keyword advertisement contents.

In the selection of the keyword advertisement contents, it is preferred that among multiple keyword advertisement contents received from the keyword advertisement content providing server 3100, a preset number of keyword advertisement contents is set as the maximum number, and the keyword advertisement contents equal to or less than the preset number are selected.

In the selection of the keyword advertisement contents, the keyword advertisement contents are selected according to the type of the meta information on which the keyword advertisement target texts are based. It is preferable to inquire of the keyword advertisement content providing server 3100 about each of the keyword advertisement target texts and then obtain the keyword advertisement contents corresponding to each of the keyword advertisement target texts from the keyword advertisement content providing server 3100.

In the selection of the keyword advertisement contents, when the number of keyword advertisement contents received by the keyword advertisement content providing server 3100 are more than one, the number of keyword advertisement contents to be displayed on the user computer 9000 based on a specific time has been set, and the number of keyword advertisement contents are larger than the number of keyword advertisement contents to be displayed on the user computer 9000 based on the specific time, it is preferable to divide the multiple keyword advertisement contents into at least two groups and select the keyword advertisement contents included in the group in the unit of the group. It is preferred that the number of keyword advertisement contents included in each group is equal to or less than the number of keyword advertisement contents to be displayed on the user computer 9000 based on the specific time.

The displaying of the moving picture information and the keyword advertisement contents on the user computer 9000 includes at least one of (a) a method of dividing the moving picture information area and the keyword advertisement content area 100, generating an information unit to be displayed on the user computer 9000, synchronizing the moving picture information area with the keyword advertisement content area 100, and displaying the moving picture information and the keyword advertisement contents on the user computer 9000 and (b) a method of dividing the moving picture information area and the keyword advertisement content area 100, generating an information unit to be displayed on the user computer 9000, and asynchronizing the moving picture information area with the keyword advertisement content area 100, and displaying the moving picture information and the keyword advertisement contents on the user computer 9000, respectively.

When the method (b) is selected, at least one keyword advertisement content to be displayed on the keyword advertisement content area 100 is preferably changed according to the passage of time.

The time is preferably within a preset time range.

The time range is determined by at least one variable selected from (a) the number of keyword advertisement contents received by the keyword advertisement content providing server 3100, (b) the number of keyword advertisement contents selected from among the keyword advertisement contents received by the keyword advertisement content providing server 3100, (c) the number of keyword advertisement contents to be displayed on the user computer 9000 based on a specific time, and (d) a reproduction time of the moving picture.

The displaying of the moving picture information and the keyword advertisement contents on the user computer 9000 further includes the steps of: recording a display time of at least one keyword advertisement content displayed on the user computer 9000 by the computer program 9100; and monitoring click generation of the keyword advertisement content up to a preset time by the computer program 9100, and when the computer program 9100 has not obtained the click generation information of the keyword advertisement content by the preset time, displaying a preset number of keyword advertisement contents selected from among keyword advertisement contents received from the keyword advertisement content providing server 3100, other than the keyword advertisement contents displayed on the user computer 9000.

The displaying of the moving picture information and the keyword advertisement contents on the user computer 9000 further includes the steps of: recording a display time of at least one specific keyword advertisement content displayed on the user computer 9000 by the computer program 9100; and monitoring whether to generate the click for the specific keyword advertisement content up to a preset time by the computer program 9100, and when the computer program 9100 has obtained the click generation information of the specific keyword advertisement content within the preset time, not changing the keyword advertisement contents displayed on the user computer 9000 from a time of obtaining the click generation information to a preset second time.

Further, the displaying of the moving picture information and the keyword advertisement contents on the user computer 9000 further includes the steps of: when the computer program 9100 has not obtained additional click generation information of the keyword advertisement contents displayed on the user computer 9000 by the second time, displaying a preset number of keyword advertisement contents selected from among keyword advertisement contents received from the keyword advertisement content providing server 3100, other than the keyword advertisement contents displayed on the user computer 9000, to the user computer 9000.

It is preferred that the displaying of the moving picture information and the keyword advertisement contents on the user computer 9000 further includes the steps of: recording a display time of at least one specific keyword advertisement content transmitted on the user computer 9000 by the user computer 9100; and monitoring a generation of a click of the specific keyword advertisement content up to a preset time by the user computer 9100, and when the user computer 9100 has obtained the click generation information of the specific keyword advertisement content within the preset time, displaying keyword advertisement contents related to the keyword advertisement content corresponding to the click generation on the user computer 9000.

The keyword advertisement contents related to the keyword advertisement content corresponding to the click generation refers to at least one of (a) another at least one keyword advertisement content among the keyword advertisement contents obtained together when the specific keyword advertisement target text is transmitted to the keyword advertisement content providing server 3100 in a case where the keyword advertisement content corresponding to the click generation is the keyword advertisement content obtained through transmitting at least one specific keyword advertisement target text to the keyword advertisement content providing server 3100, (b) at least one keyword advertisement content obtained through transmitting another keyword advertisement target text obtained from the same meta information, on which the keyword advertisement target texts are based, to the keyword advertisement content providing server 3100 in a case where the keyword advertisement content corresponding to the click generation is the keyword advertisement content obtained through transmitting at least one specific keyword advertisement target text to the keyword advertisement content providing server 3100, (c) at least one keyword advertisement content obtained through transmitting other keyword advertisement target texts to the keyword advertisement content providing server 3100 when the specific keyword advertisement target text is included in a specific group and other keyword advertisement target texts are included in the group in addition to the specific keyword advertisement target text in a case where the keyword advertisement content corresponding to the click generation is the keyword advertisement content obtained through transmitting at least one specific keyword advertisement target text to the keyword advertisement content providing server 3100.

It is preferred that the displaying of the moving picture information and the keyword advertisement contents on the user computer 9000 further includes at least one step of: obtaining click generation information of the keyword advertisement content displayed on the user computer 9000; and transmitting click generation information of the keyword advertisement content displayed on to the user computer 9000 by the computer program 9100. It is preferred that the click generation information is directly obtained from the user computer 9000 and/or obtained from the keyword advertisement content providing server 3100. It is preferred that the click generation information is transmitted to the keyword advertisement content providing server 3100 and/or the preset third server.

The moving picture includes at least one of a real photograph moving picture, a non-real photograph moving picture, a UCC moving picture, a movie, a flash moving picture, a real-time broadcasting, and a recorded broadcasting including text-type meta information.

Next, two embodiment of the construction of the computer program 9100 installed in the recording medium of the user computer 9000 of the user computer installed computer program 9100 model will be described with reference to FIG. 22. According to the first embodiment, the keyword advertisement service is provided through receiving a web page streaming a multimedia content from the multimedia content service system 1000 and processing the multimedia content. According to the second embodiment, the keyword advertisement service is provided through downloading a multimedia content file itself including meta information from the multimedia content service system 1000 and producing the multimedia content file itself. The first embodiment of the construction of the computer program 9100 will be first described.

The computer program 9100 recorded in the recording medium capable of providing the user computer 9000 with a keyword advertisement content based on moving picture information transmitted from the user computer 9000 includes the web page information analysis module 9110 analyzing web page information including moving picture information transmitted to the user computer 9000, the meta information obtainment module 5100 obtaining meta information of the moving picture from the web page information analysis module 9110, the keyword advertisement target text generation module 6510 generating at least one keyword advertisement target text with the meta information obtained from the meta information obtainment module 5100, the keyword advertisement content obtainment module 6530 obtaining at least one keyword advertisement content corresponding to the keyword advertisement target text generated by the keyword advertisement target text generation module 6510 from the keyword advertisement content providing server 3100, and the keyword advertisement display module 7900 for displaying the keyword advertisement content received by the keyword advertisement content obtainment module 6530 on a preset location, which is discriminated from a moving picture area reproducing and displaying the moving picture. The keyword advertisement display module 7900 includes the keyword advertisement insertion module 9120 for inserting the keyword advertisement content in a preset location of the web page. The web page information analysis module 9110 analyzes the received web page including the moving picture information and extracts meta information from the moving picture information. The keyword advertisement insertion module 9120 combines the obtained keyword advertisement content with the web page transmitted to the user computer 9000, modifies the web page so as to arrange the keyword advertisement content on a preset location, generates the modified web page, and displays the modified web page on the user computer 9000. The keyword advertisement content providing server 3100 includes the keyword advertisement content providing server-side text obtainment module 3110 receiving the texts, the keyword advertisement content DB 3120 including at least one advertisement content, and the keyword advertisement content providing server-side text transmission module 3130 transmitting the keyword advertisement contents. The keyword advertisement content providing server 3100 obtains at least one keyword advertisement content corresponding to the received keyword advertisement target texts from the keyword advertisement content DB 3120 and transmits the obtained keyword advertisement content to the multimedia content service server 1100.

Next, the second embodiment of the construction of the program 9100 will be first described.

The computer program 9100 recorded in the recording medium capable of providing the user computer 9000 with a keyword advertisement content (corresponding to one example of multimedia contents) based on moving picture information transmitted from the user computer 9000 includes the meta information obtainment module 5100 obtaining meta information of the moving picture from the moving picture information transmitted to the user computer 9000, the keyword advertisement target text generation module 6510 generating at least one keyword advertisement target text with the meta information obtained from the meta information obtainment module 5100, the keyword advertisement content obtainment module 6530 obtaining at least one keyword advertisement content corresponding to the keyword advertisement target text generated by the keyword advertisement target text generation module 6510 from the keyword advertisement content providing server 3100, and the keyword advertisement display module 7900 for displaying the keyword advertisement content received by the keyword advertisement content obtainment module 6530 on a preset location, which is discriminated from a moving picture area reproducing and displaying the moving picture. The keyword advertisement display module 7900 further includes the keyword advertisement insertion module 9120 so as to display the keyword advertisement content on a preset location (a bottom side of a moving picture reproducing screen, or a specific layer generated on a moving picture reproducing screen) determined by the computer program 9100 or inserting the keyword advertisement content in a specific location.

Next, the commonality of the two embodiments will be described.

The meta information includes at least one of title information, tag information, explanation information, and a commercial tag set of the moving picture included in the moving picture information. The commercial tag set is preferably generated by the commercial tag set generation system 10000.

The computer program 9100 further includes the meta information selection policy of the keyword advertisement control policy DB 6540. The selection of the meta information is determined by the meta information selection policy of the keyword advertisement control policy DB 6540, and the keyword advertisement control policy preferably includes information on the selection reference of meta information.

The selection reference of the meta information is at least one of (a) when tag information is included in obtained meta information, first selecting the tag information, (b) when tag information is included in obtained meta information, selecting both tag information and title information, (c) when tag information is not included in obtained meta information, selecting title information, and (d) when tag information is not included in obtained meta information, selecting both title information and explanation information.

The generating of at least one keyword advertisement target text with the selected meta information by the keyword advertisement target text generation module 6510 includes at least one of, when the meta information is title information, (a) a method of generating words and phrases included in the advertisement keyword DB 6570 among words and phrases included in the title information as keyword advertisement target texts, (b) a method of analyzing words and phrases included in the title information through the natural language processing, extracting at least one good or service name, and generating the extracted names as keyword advertisement target texts, and (c) a method of generating only the names corresponding to the words and phrases included in the advertisement keyword DB 6570 among the names extracted by the method (b) as keyword advertisement target texts, when the meta information is tag information, (a) a method of generating tags included in the advertisement keyword DB 6570 among at least one tag included in the tag information as keyword advertisement target texts, (b) a method of generating all tags included in the tag information as keyword advertisement target texts, (c) a method of, when multiple tags are included in the tag information, generating only tags within a preset rank as keyword advertisement target texts, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target texts, (b) a method of analyzing words and phrases included in the explanation information through the natural language processing, extracting at least one good or service name, and generating the extracted names as keyword advertisement target texts, (c) a method of generating only the names corresponding to the words and phrases included in the advertisement keyword DB 6570 among the names extracted by the method (b) as keyword advertisement target texts, and (d) a method of calculating a frequency of the names extracted by the method (b) and generating only names within a preset rank in order of the highest frequency as keyword advertisement target texts. The advertisement keyword DB 6570 is the DB collecting the advertisement target keywords subjected to the keyword advertisement. The name consists of at least one word, and includes at least one of a good name, a service name, an advertisement keyword list received from the keyword advertisement content providing server 3100, an advertisement keyword list obtained from a third person, a self generated advertisement keyword list, a keyword advertisement target text list creating advertisement gains, a company name, a domain name, a noun, a slogan, and a brand.

The generation of at least one keyword advertisement target text with the selected meta information by the keyword advertisement target text generation module 6510 includes multiple steps of the first step of generating a keyword advertisement target text candidate and the second step of inquiring of the keyword advertisement content providing server 3100 about the generated keyword advertisement target text candidate and generating keyword advertisement target texts with reference to an inquiry result.

The first step of generating the keyword advertisement target text candidate by the keyword advertisement target text generation module 6510 includes at least one of, when the meta information is title information, (a) a method of generating words and phrases included in the advertisement keyword DB 6570 among words and phrases included in the title information as keyword advertisement target text candidates, (b) a method of analyzing words and phrases included in the title information through the natural language processing, extracting at least one good or service name, and generating the extracted names as keyword advertisement target text candidates, and (c) a method of generating only names corresponding to the words and phrases included in the advertisement keyword DB 6570 among the names extracted by the method (b) as keyword advertisement target text candidates, when the meta information is tag information, (a) a method of generating tags included in the advertisement keyword DB 6570 among at least one tag included in the tag information as keyword advertisement target text candidates, (b) a method of generating all tags included in the tag information as a keyword advertisement target text candidates, (c) a method of, when multiple tags are included in the tag information, generating only tags within a preset rank as keyword advertisement target text candidates, and (d) a method of, when multiple tags are included in the tag information, randomly selecting tags from the multiple tags, and when the meta information is explanation information, (a) a method of generating words and phrases included in the advertisement keyword DB 6570 among words and phrases included in the explanation information as keyword advertisement target text candidates, (b) a method of analyzing words and phrases included in the explanation information through the natural language processing, extracting at least one good or service name, and generating the extracted names as keyword advertisement target text candidates, (c) a method of generating only the names corresponding to the words and phrases included in the advertisement keyword DB 6570 among the names extracted by the method (b) as keyword advertisement target text candidates, and (d) a method of calculating a frequency of the names extracted by the method (b) and generating only names within a preset rank in order of the highest frequency as keyword advertisement target text candidates. The advertisement keyword DB 6570 is the DB collecting the advertisement target keywords subjected to the keyword advertisement. The name consists of at least one word, and includes at least one of a good name, a service name, a company name, a domain name, a noun, a slogan, and a brand.

The generation of at least one keyword advertisement target text with the selected meta information by the keyword advertisement target text generation module 6510 further includes a third step of identifying of whether the inquiry result of the keyword advertisement content providing server 3100 satisfies the policy of the keyword advertisement control policy DB 6540. The identifying of whether the inquiry result of the keyword advertisement content providing server 3100 satisfies the policy of the keyword advertisement control policy DB 6540 includes obtaining, from the keyword advertisement content providing server 3100, with respect to the keyword advertisement target text candidate, (a) information regarding whether keyword advertisement contents corresponding to the keyword advertisement target text candidate are included in the keyword advertisement content providing server 3100, (b) information of the maximum number of transmittable keyword advertisement contents, (c) information of a higher advertisement unit price of at least one keyword advertisement content within a preset rank, and (d) information of an expected click rate with respect to exposure of at least one keyword advertisement content, and inquiring a policy reference of the keyword advertisement control policy DB 6540 corresponding to at least one of the (a), (b), (c), and (d) obtained from the keyword advertisement content providing server 3100. The keyword advertisement control policy DB 6540 includes the keyword advertisement control policy, and the keyword advertisement control policy preferably includes information on reference of the keyword advertisement target text generation.

It is preferred that the reference of the inquiry result by the keyword advertisement target text generation module 6510 includes, with respect to each of the keyword advertisement target text candidates or the keyword advertisement target candidate in the unit of a preset group, transmitting the keyword advertisement target text candidates to the keyword advertisement content providing server 3100 and obtaining identification information of existence of the keyword advertisement contents corresponding to the keyword advertisement target text candidates from the keyword advertisement content providing server 3100.

The computer program 9100 further includes the keyword advertisement content transmission module 6520 transmitting the generated keyword advertisement target texts to the keyword advertisement content providing server 3100. The transmitting of the generated keyword advertisement target texts to the keyword advertisement content providing server 3100 by the keyword advertisement content transmission module 6520 includes at least one of (a) a method of transmitting all of the generated keyword advertisement target texts to the keyword advertisement content providing server 3100 and (b) a method of classifying the generated keyword advertisement target texts according to a type of meta information, on which the generated keyword advertisement target text is based, and transmitting the keyword advertisement target texts based on at least one selected type of the meta information to the keyword advertisement content providing server 3100.

The computer program 9100 further includes the keyword advertisement content transmission module 6520 transmitting the generated keyword advertisement target texts to the keyword advertisement content providing server 3100. The transmitting of the generated keyword advertisement target texts to the keyword advertisement content providing server 3100 by the keyword advertisement content transmission module 6520 includes at least one of, when the number of keyword advertisement target texts are more than one, (a) a method of transmitting the generated multiple keyword advertisement target texts only one time, (b) a method of separately transmitting the generated multiple keyword advertisement target texts one by one, and (c) a method of dividing the generated multiple keyword advertisement target texts into at least two groups and transmitting the keyword advertisement target texts in the unit of the group, but when there are multiple keyword advertisement target texts included in the same group, any one between the method (a) and the method (b) is applied.

The computer program 9100 further includes the keyword advertisement content transmission module 6520 transmitting the generated keyword advertisement target texts to the keyword advertisement content providing server 3100. The keyword advertisement target text generation module 6510 grants a management number to the generated keyword advertisement target texts, to store the keyword advertisement target texts, the keyword advertisement content transmission module 6520 transmits the generated keyword advertisement target texts to the keyword advertisement content providing server 3100, and the keyword advertisement content obtainment module 6530 receives keyword advertisement contents corresponding to the generated keyword advertisement target texts and mapping the keyword advertisement contents to the generated keyword advertisement target texts based on the management number, to store the keyword advertisement contents.

In the mapping of the keyword advertisement contents to the generated keyword advertisement target texts, when the number of generated keyword advertisement target texts are more than one and the generated multiple keyword advertisement target texts are managed in the unit of at least one group, it is preferable to grant a management number to the group and each of the generated keyword advertisement target texts included in the groups, map the keyword advertisement target texts included in the groups to the keyword advertisement contents obtained from the keyword advertisement content providing server 3100 based on the management number, and store the keyword advertisement contents.

The computer program 9100 further includes the keyword advertisement content selection module 6550 for selecting at least one keyword advertisement content to be transmitted to the user computer 9000 among the keyword advertisement contents based on a specific time when the number of keyword advertisement contents received by the keyword advertisement content providing server 3100 are more than one.

In the selection of the keyword advertisement contents by the keyword advertisement content selection module 6550, it is preferred that among multiple keyword advertisement contents received from the keyword advertisement content providing server 3100, a preset number of keyword advertisement contents is set as the maximum number and the keyword advertisement content selection module 6550 selects the keyword advertisement contents equal to or less than the preset number among the keyword advertisement contents received from the keyword advertisement content providing server 3100.

In the selection of the keyword advertisement contents by the keyword advertisement content selection module 6550, the keyword advertisement contents are selected according to the type of the meta information on which the keyword advertisement target texts are based. It is preferable to inquire of the keyword advertisement content providing server 3100 about each of the keyword advertisement target texts and then obtain the keyword advertisement contents corresponding to each of the keyword advertisement target texts from the keyword advertisement content providing server 3100.

In the selection of the keyword advertisement contents by the keyword advertisement content selection module 6550, when the number of keyword advertisement contents received by the keyword advertisement content providing server 3100 are more than one, the number of keyword advertisement contents to be displayed on the user computer 9000 based on a specific time has been set, and the number of keyword advertisement contents are larger than the number of keyword advertisement contents to be displayed on the user computer 9000 based on the specific time, it is preferable to divide the multiple keyword advertisement contents into at least two groups and select the keyword advertisement contents included in the group in the unit of the group. It is preferred that the number of keyword advertisement contents included in each group is equal to or less than the number of keyword advertisement contents to be transmitted to the outside server based on the specific time.

The displaying of the keyword advertisement content at a preset location, which is discriminated from the moving picture area reproducing and displaying keyword advertisement contents, by the keyword advertisement display module 7900 includes at least one of (a) dividing the moving picture information area and the keyword advertisement content area 100, generating an information unit to be displayed on the user computer 9000, synchronizing the moving picture information area and the keyword advertisement content area 100, and displaying the moving picture information and the keyword advertisement content on the user computer 9000, and (b) dividing the moving picture information area and the keyword advertisement content area 100, generating an information unit to be displayed on the user computer 9000, asynchronizing the moving picture information area and the keyword advertisement content area 100, and displaying the moving picture information and the keyword advertisement content on the user computer 9000, respectively.

When the method (b) is selected, at least one keyword advertisement content to be displayed on the keyword advertisement content area 100 is preferably changed according to the passage of time.

The time is preferably within a preset time range.

The time range is determined by at least one variable selected from (a) the number of keyword advertisement contents received by the keyword advertisement content providing server 3100, (b) the number of keyword advertisement contents selected from among the keyword advertisement contents received by the keyword advertisement content providing server 3100, (c) the number of keyword advertisement contents to be displayed on the user computer 9000 based on a specific time, and (d) a reproduction time of the moving picture.

When the number of keyword advertisement contents received from the keyword advertisement content providing server 3100 are more than one, the computer program 9100 further includes the keyword advertisement content selection module 6550 for selecting at least one keyword advertisement content to be displayed on the user computer 9000 among the keyword advertisement contents based on a specific time and the click generation information reception module 8900 obtaining click generation information of the keyword advertisement contents displayed on the user computer 9000. The computer program 9100 records a display time of at least one keyword advertisement content displayed on the user computer 9000 and monitors click generation of the keyword advertisement content up to a preset time through the click generation information reception module 8900. When click generation information of the keyword advertisement content has not been obtained by the preset time, it is preferable that the keyword advertisement content selection module 6550 selects a preset number of keyword advertisement contents selected from among keyword advertisement contents received from the keyword advertisement content providing server 3100, other than the keyword advertisement contents displayed on the user computer 9000, and the keyword advertisement display module 7900 displays the selected keyword advertisement content on the user computer 9000.

When the number of keyword advertisement contents received from the keyword advertisement content providing server 3100 are more than one, the computer program 9100 further includes the keyword advertisement content selection module 6550 for selecting at least one keyword advertisement content to be displayed on the user computer 9000 among the keyword advertisement contents based on a specific time and the click generation information reception module 8900 obtaining click generation information of the keyword advertisement contents displayed on the user computer 9000. The computer program 9100 records a display time of at least one keyword advertisement content displayed on the user computer 9000 and monitors click generation of the keyword advertisement content up to a preset time through the click generation information reception module 8900. When click generation information of the keyword advertisement content has been obtained within the preset time, the computer program 9100 does not change the keyword advertisement content displayed on the user computer 9000 from a time of obtaining the click generation information to a preset second time.

When additional click generation information of the keyword advertisement contents displayed on the user computer 9000 has not been obtained by the second time, it is preferable that the computer program 9100 displays a preset number of keyword advertisement contents selected from among keyword advertisement contents received from the keyword advertisement content providing system 3000, other than the keyword advertisement contents displayed on the user computer 9000, on the user computer 9000.

When the number of keyword advertisement contents received from the keyword advertisement content providing server 3100 are more than one, the computer program 9100 further includes the keyword advertisement content selection module 6550 for selecting at least one keyword advertisement content to be displayed on the user computer 9000 among the keyword advertisement contents based on a specific time and the click generation information reception module 8900 obtaining click generation information of the keyword advertisement contents displayed on the user computer 9000. The computer program 9100 records a display time of at least one specific keyword advertisement content displayed on the user computer 9000 and monitors click generation of the specific keyword advertisement content up to a preset time through the click generation information reception module 8900. When click generation information of the specific keyword advertisement content has not been obtained by the preset time through the click generation information reception module 8900, it is preferable that the computer program 9100 displays the keyword advertisement content related to the keyword advertisement content corresponding to the click generation on the user computer 9000.

The keyword advertisement contents related to the keyword advertisement content corresponding to the click generation refers to (a) other at least one keyword advertisement content among the keyword advertisement contents obtained when the specific keyword advertisement target text is transmitted to the keyword advertisement content providing server 3100 in a case where the keyword advertisement content corresponding to the click generation is the keyword advertisement content obtained through transmitting at least one specific keyword advertisement target text to the keyword advertisement content providing server 3100, (b) at least one keyword advertisement content obtained through transmitting another keyword advertisement target text obtained from the same meta information, on which the keyword advertisement target texts are based, to the keyword advertisement content providing server 3100 in a case where the keyword advertisement content corresponding to the click generation is the keyword advertisement content obtained through transmitting at least one specific keyword advertisement target text to the keyword advertisement content providing server 3100, (c) at least one keyword advertisement content obtained through transmitting the other keyword advertisement target texts to the keyword advertisement content providing server 3100, when the specific keyword advertisement target text is included in a specific group and other keyword advertisement target texts are included in the group in addition to the specific keyword advertisement target text in a case where the keyword advertisement content corresponding to the click generation is the keyword advertisement content obtained through transmitting at least one specific keyword advertisement target text to the keyword advertisement content providing server 3100.

The computer program 9100 includes at least one of the click generation information reception module 8900 obtaining click generation information of the keyword advertisement contents transmitted to the user computer 9000 and the click generation information transmission module 9900 for transmitting the obtained click generation information to a preset server. It is preferred that the click generation information is directly obtained from the user computer 9000, and the click generation information is transmitted to the keyword advertisement content providing server 3100 and/or a preset third server.

The moving picture includes at least one of a real photograph moving picture, a non-real photograph moving picture, a UCC moving picture, a movie, a flash moving picture, a real-time broadcasting, and a recorded broadcasting including text-type meta information.

Next, the computer program 9100 including the script program, such as Java script, according to the present invention will be described in more detail. The script program can be executed in relation with the browser. The present invention is described mainly based on the Java script, which is one of script languages, but the spirit of the present invention is not limited to the Java script. Further, if other type languages, other than the script language, can perform of the function according to the spirit of the present invention, a program written in such a language can be included in the spirit of the present invention as a matter of course.

The multimedia content service system 1000 can insert a Java script code, etc. in a program written in a preset language, such as HTML, making a web page, (including other type means, other than a web, capable of providing the user computer 9000 with multimedia contents through a wired/wireless network) transmitted to the user computer 9000). The Java script code can 1) obtain meta information from the multimedia content information, 2) serve as the keyword advertisement target text generation module 6510 independently of the communication with the multimedia content service system 1000 when the Java script code communicates with the multimedia content service system 1000 or contents of the keyword advertisement control policy DB 5320 is programmed in the script program, 3) serve as the keyword advertisement content obtainment module 6530 obtaining keyword advertisement contents from the keyword advertisement content providing server 3100 while communicating with the keyword advertisement content providing system 3000, 4) serve as the keyword advertisement content selection module 6550 in the same manner of 2), 5) serve as the keyword advertisement display module 7900, 6) when the script program has an event detection function, obtain click information of a specific keyword advertisement content from the user computer 9000 and transmit the obtained click information to the multimedia content service system 1000 or the keyword advertisement content providing system 3000, 7) check a time of various events (moving picture reproduction, click generation, etc.) generated in a browser of the user computer 9000 in a time-related program, such as a timer or a stop watch program, 8) display a preset number of keyword advertisement contents at a preset location in a preset manner, 9) when a link is connected to the Java script and the user clicks the link, execute the Java script connected with the link and perform a preset function, 10) when click information of a specific keyword advertisement content is obtained, detect the click event and temporarily stop the reproduction of the multiplayer content in a player, and 11) transmit/receive a data with a preset server. Especially, when the Java script code asynchronously communicates with the multimedia content service server 1100 or a preset server, it is possible to provide the user with a rich experience without incurring large loads to the server.

In general, when a certain time is set in the time, the Java script code can perform a predetermined operation (additional request of keyword advertisement content, etc.) after the set time. The Java script includes a function of setTimeout, so that the Java script code can perform such an operation. An example of using the function of setTimeout has been previously described.

In order to recognize an elapsed time of a certain event (click generation, etc.) from a specific time, it is necessary to make a stopwatch function, for which the following Java script should be used.

The stopwatch is started through calling a startStopWatch function and when a function of stopwatch.getTime( ) is called, an elapsed time from a starting time of the stopwatch to a present time is returned in the unit of milliseconds as shown below.

```
    var stopwatch;  // stopwatch object
    // stopwatch class
    function StopWatch( )  {
        this.startTime = new Date( );
        this.getTime = StopWatch_getTime;
    }
    // function of returning an elapsed time from a
starting time of the stopwatch to a present time in the
unit of milliseconds
    function StopWatch_getTime( )  {
        var currentTime = new Date( );
        return currentTime − this.startTime;
    }
    // function of generating and starting a stopwatch
object
    function startStopWatch( )  {
        stopwatch = new StopWatch( );
    }
```

The following code is an example of a code of displaying an advertisement content designated by an advertiser (web site, web page, or other advertisements of the advertiser) in a pop-up type while transmitting the past time to the server when an advertisement is clicked.

This is applied to 9). When the user clicks a keyword advertisement content link “PRADA bag”, a function of showAd is called.

```
    <a
onclick=”showAd(‘http://www.keyadserver.com/getad?id=37583
’)”>PRADA bag </a>
    function showAd(adurl) {
    var clickTime = stopwatch.getTime( );
    window.open(adurl+”&”+clicktime, “”);
    }
```

When the reproduction of the multimedia content is temporarily paused, the player transmits a signal so that the server interrupts the streaming of the multimedia contents. An example of 10) is to follow.

Player.pause( )

Most of the functions of the Java script code are essentially related to 1) the division of functions (especially, the control function) of the meta information based keyword advertisement server 6000/meta information based keyword advertisement intermediation server 2100/meta information based keyword advertisement providing server 4000, 2) the communication with the servers, and 3) the processing of the event generated in the user computer 9000. Since the user computer 9000 can communicate with the multimedia content service server 1100, the number of element combinations for the division of various functions is very large. If the combination is divided again according to the meta information based keyword advertisement server 6000/meta information based keyword advertisement intermediation server 2100/meta information based keyword advertisement providing server 4000, the number of combinations further increases. Therefore, for the convenience of description, the role division model will be described with the limitation on the important function based on the relation with the meta information based keyword advertisement server 6000, but the spirit of the present invention is not limited thereto. In the meantime, the Java script code can perform most of the functions of the meta information based keyword advertisement server 6000, which is equal to the function performed by the user computer 9000 installed program in the user computer 9000 installed program model. That is, the Java script code can obtain meta information included in a multimedia content transmitted to the user computer 9000, generate a keyword advertisement target text with meta information, transmit the generated keyword advertisement target text to the keyword advertisement content providing server 3100 to obtain a keyword advertisement content, display the keyword advertisement content at a preset location in a preset scheme, obtain various events, such as click generation, and transmit the obtained event to a preset server.

Hereinafter, each of functions performed by the Java script code based on the role division model will be described in more detail.

First, the Java script code performs a function of the keyword advertisement display module 7900. That is, the Java script code can determine a location, a scheme/action, and a reproduction time duration and display the obtained keyword advertisement content. For example, the arrangement of the keyword advertisement content on a lower end of the multimedia content is illustrated in the drawing, but it is only one example. The Java script code forms a layer on the multimedia content and displays the keyword advertisement content on the layer, rolls n keyword advertisements at a preset location in a preset time interval, and when a layer has already existed, makes the keyword advertisement content existing behind a multimedia content come before the multimedia content. Further, the Java script code can provide various animation effects, as well as control fonts, colors, etc. of a keyword advertisement content, such as display a keyword advertisement content in a large font first and gradually decrease a keyword advertisement content in a small font when a keyword advertisement content is displayed. Especially, the display of the keyword advertisement content on the layer is more meaningful in a case where a display area of a mobile phone, etc. is physically small. In the meantime, when the user clicks the keyword advertisement content or conducts a touch equivalent to a click and other actions, link information included in the keyword advertisement content is operated and an image desired by the advertiser is displayed to the user. At this time, the Java script code can obtain an event of the user click and transmit a command requesting a pause of the multimedia content to a module performing a multimedia content reproduction function, to pause the reproduction of the multimedia content. This is more useful in a case where a screen size, such as a mobile phone, is small or it is not allowed to open a page including contents of an advertiser linked with a keyword advertisement content in a type of a pop-up window. In the meantime, when the user computer 9000 uses two or more monitors or a large monitor, the Java script code preferably opens a page of the advertiser in a location, other than a location of the reproduction area of the multimedia content, independently of the pause of the multimedia content reproduction. To this end, the Java script code obtains location/coordinates information (each corner information of a square area) of the multimedia content reproduction area of the user computer 9000, considers the location/coordinates information and controls a location and a size of the pop-up window.

Second, the Java script code may include a timer function of checking a time. Since the timer can measure a time, the Java script code can 1) control a time duration of an exposure of a keyword advertisement content, 2) roll n keyword advertisement contents in a preset time interval one by one or in the unit of several keyword advertisement contents. Further, when a function of a stopwatch is used, the Java script code can 3) measure an exposure time of the keyword advertisement content without the click of the keyword advertisement content.

Third, the Java script code can obtain reproduction time information of the multimedia content and control an exposure order, an exposure time, and the number of keyword advertisement contents exposed in a specific exposure time zone of at least one keyword advertisement content once obtained or obtained multiple times during the reproduction time. When the Java script code determines that the exposure of the obtained keyword advertisement content is completed or the number of keyword advertisement contents is short (especially, in a case in which a reproduction time of a multimedia content is very long, etc.), in order to obtain additional keyword advertisement content, the Java script code requests at least one of the meta information based keyword advertisement server 6000, the meta information based keyword advertisement intermediation server 2100, and the meta information based keyword advertisement providing server 4000 to provide an additional keyword advertisement content, 2) transmits tag information, title information, and explanation information, which have not been used in the obtainment of an exposed keyword advertisement content, in meta information included in the multimedia content to at least one of the meta information based keyword advertisement server 6000, the meta information based keyword advertisement intermediation server 2100, and the meta information based keyword advertisement providing server 4000, and 3) re-exposes the previously transmitted and exposed keyword advertisement content. Because the obtained keyword advertisement content includes information of a keyword advertisement target text provided for the obtainment of the keyword advertisement content, the meta information that has not been used in the obtainment of an exposed keyword advertisement content refers to meta information, other than meta information related to the keyword advertisement target text. When meta information first used for the obtainment of a keyword advertisement content is tag information, the meta information that has not been used in the obtainment of an exposed keyword advertisement content corresponds to title information or explanation information, n−1 number of tag information are used among n tag information, the meta information that has not been used in the obtainment of an exposed keyword advertisement content corresponds to not-used tag information. Further, when keyword advertisement target texts extracted from n number of tag information, title information, or explanation information are managed in m groups and m−1 groups are used for the obtainment of the keyword advertisement content, the meta information that has not been used in the obtainment of an exposed keyword advertisement content corresponds to meta information corresponding to keyword advertisement target text included in a not-used group. In a case where a request of a keyword advertisement content is made to the keyword advertisement content providing server 3100 in a predetermined number/rank/order, when the number/rank/order of the first obtained keyword advertisement contents is n, the Java script code may make a request of the n+1 numbers/rank/order or higher of keyword advertisement contents to the keyword advertisement content providing server 3100. When the meta information based keyword advertisement server 6000, the meta information based keyword advertisement intermediation server 2100, the meta information based keyword advertisement providing server 4000, or the Java script code determines the number/rank/order for the obtainment of the keyword advertisement content, they may consider the reproduction time information of the multimedia content and control the number/rank/order so as to obtain more keyword advertisement contents when the reproduction time of the multimedia content is long. With regard to this, a method of obtaining a sufficient number of keyword advertisement contents includes at least one of 1) a method of dividing meta information according to a kind, such as tag, title, and explanation information and obtaining keyword advertisement contents, 2) a method of dividing the same kind of meta information into several times or several groups and making a request of the keyword advertisement to the keyword advertisement content providing server 3100, to obtain keyword advertisement contents, and 3) a method of generating multiple keyword advertisement target texts from title information, tag information, explanation information, etc. and inquiring each of keyword advertisement target texts or keyword advertisement target text groups, to obtain keyword advertisement contents. In the meantime, when the multimedia content includes a subtitle and the subtitle is processed as like the subtitle, it is possible to obtain keyword advertisement contents displayed in a specific time (smi-file type subtitle information, etc. has text type subtitles that have to be displayed in a specific time duration (from t1 to t2)), a specific time zone (from t1, t2, t3, . . . , until ti), or a specific time interval (during tj, etc.) That is, the meta information based keyword advertisement server 6000, the meta information based keyword advertisement intermediation server 2100, the meta information based keyword advertisement providing server 4000, or the Java script code can obtain subtitle information as meta information, process the obtained subtitle information, generate a keyword advertisement target text, and obtain keyword advertisement contents corresponding to the generated keyword advertisement target text from the keyword advertisement content providing server 3100. When the meta information based keyword advertisement server 6000, the meta information based keyword advertisement intermediation server 2100, the meta information based keyword advertisement providing server 4000, or the Java script code obtain the keyword advertisement content with meta information of the subtitle information, it is preferable that the keyword advertisement content is changed according to meta information, which serves as a source for the obtainment of the keyword advertisement target text, of a specific time duration. That is, it is preferable to obtain the keyword advertisement contents displayed between t1 and t2 with the keyword advertisement target texts generated by the subtitle of the smi file obtained between t1 and t2.

Fourth, the Java script code serves as the keyword advertisement content selection module 6550 through communicating with the multimedia content service system 1000 and inquires of/searches in the keyword advertisement control policy DB 5320, or independently of the communication with the multimedia content service system 1000 when the content of the keyword advertisement control policy DB 5320 is programmed in the Java script program.

Fifth, the Java script code serves as the keyword advertisement target text generation module 6510 through communicating with the multimedia content service system 1000 and inquiring of/searching in the advertisement keyword DB 6570 and/or the keyword advertisement control policy DB 5320, remotely calling the morpheme analyzer, etc. for use, or providing meta information and receiving a result generated in the morpheme analyzer. In the meantime, when the content of the advertisement keyword DB 6570 and/or the keyword advertisement control policy DB 5320 is programmed in the Java script program, the Java script code can serve as the keyword advertisement content selection module 6550 independently of the communication with the multimedia content service system 1000. To briefly describe the latter one, when various advertisement keywords included in the advertisement keyword DB are text string type or other type, the Java script code searches for the obtained meta information in the text string and extracts the corresponding text, to generate the extracted text as a keyword advertisement target text.

Sixth, the Java script code performs a function of the event detection and the transmission of event generation information. Contrary to the typical link, the link included in the Java script can drive a specific Java script related to the link when a user clicks or touches the link. With regard to this, the specific Java script can perform 1) the check of event generation of a click, 2) the transmission of click generation to a preset server, and 3) the connection to a content page of an advertiser related to the link. The Java script code entire event generation information related to the multimedia content reproduction transmitted in the streaming scheme, such as reproduction start, termination of the reproduction completion, and/or pause by a user, to transmit the entire event generation information to a preset server or use the entire event generation information for obtainment/display of a keyword advertisement content. For example, when the reproduction of the multimedia content is terminated, the Java script code can obtain no keyword advertisement content from a preset server any more, but can obtain or display the largest number of keyword advertisement contents at the time of the reproduction termination or the pause of the multimedia content reproduction by a user. It is a matter of course that the Java script code can perform only the communication function of obtaining only the event generation and transmitting the obtained event generation to a preset server, and the preset server can determine the number of keyword advertisement contents, the kind of keyword advertisement contents, and the way of displaying the keyword advertisement contents corresponding to the generated event. The combination of the role division model is very various so that every combination cannot be described for the reason as discussed above.

The following is an example of a code for obtaining keyword advertisement contents or stopping the obtainment of keyword advertisement contents according to a status of a multimedia content player.

```
if (Player.status ==“STOPPED”)
  stopGettingAdCons( );
else if (Player.status ==“PAUSED”)
  getMaxAdCons( );
else
  getMoreAdCons( );
```

Seventh, at least one of the Java script, the meta information based keyword advertisement server 6000, the meta information based keyword advertisement intermediation server 2100, and the meta information based keyword advertisement providing server 4000 collects user action information as a history, transmits the user action information to a preset third server, or statistically analyzes the user action information with respect to 1) a specific multimedia content, 2) a specific keyword advertisement target text, and 3) a specific keyword advertisement content. For example, it is possible to statistically analyze the user action information, such as 1) when n1 to ni keyword advertisement contents are exposed with respect to a specific multimedia content, the click rate of n2 keyword advertisement content with respect to an exposure during a preset time duration is the first rank and the click rate of n5 keyword advertisement content with respect to an exposure during a preset time duration is the second rank, or 2) when nj to n(j+k) keyword advertisement contents are exposed corresponding to a specific keyword advertisement target text or a keyword advertisement target text group, the click rate of n(j+1) keyword advertisement content is the highest and an average advertisement profit of n(j+k−1) keyword advertisement content is the highest, etc. Based on a result of the statistical analysis, it is possible to 1) put a rank of keyword advertisement contents expecting the most number of clicks and a rank of keyword advertisement contents expecting the highest advertisement profit in a specific multimedia content, and 2) a rank of keyword advertisement contents expecting the most number of clicks and a rank of keyword advertisement contents expecting the highest advertisement profit in correspondence with a specific keyword advertisement target text. When the Java script code obtains such the rank information or the meta information based keyword advertisement server 6000, the meta information based keyword advertisement intermediation server 2100, and the meta information based keyword advertisement providing server 4000 have the rank information, and when selection information for the specific multimedia content is obtained from a user or the specific advertisement target text is generated, the Java script code can consider the rank information and select keyword advertisement contents to be provided to the user computer 9000. However, when the Java script code, the meta information based keyword advertisement intermediation server 2100, or the meta information based keyword advertisement providing server 4000 have the rank information, but the relatively long time passes, and it is impossible to obtain the keyword advertisement content (stop/cancel the advertisement by the advertiser, etc.), an advertisement condition (advertisement costs expended by an advertiser per click of the advertisement) is change, and advertisement contents of an advertiser is changed, the Java script code may not use 100% of the rank information. However, there is low probability in that the rank information becomes ineffective during the relatively short time (especially, the advertisement contents are not often changed and the stop/cancellation of the advertisement is relatively less rare), so that the effectiveness of the rank information may be high.

Next, an exclusive multimedia reproduction program, which is a special type of the computer installation type program 9100 installed in the user computer 9000 will be briefly described. In the above description, the computer program 9100 in the type of the web browser is connected to the multimedia content service system 1000, etc. The web browser is an excusive web browser for a specific multimedia content service system 1000, but is typically a general-purpose browser.

Roles of the web browser according to the present invention are 1) obtaining multimedia contents through communication with the multimedia content service system 1000, 2) obtaining keyword advertisement contents, 3) processing event generated in the user computer 9000, and 4) other functions mentioned in the present specification. In the meantime, the functions of 1) to 4) can be executed in HDD of a user or other exclusive multimedia reproduction program (in a broad sense, the browser may correspond to a program to be installed) installed in a fixed memory means, not a temporal memory means.

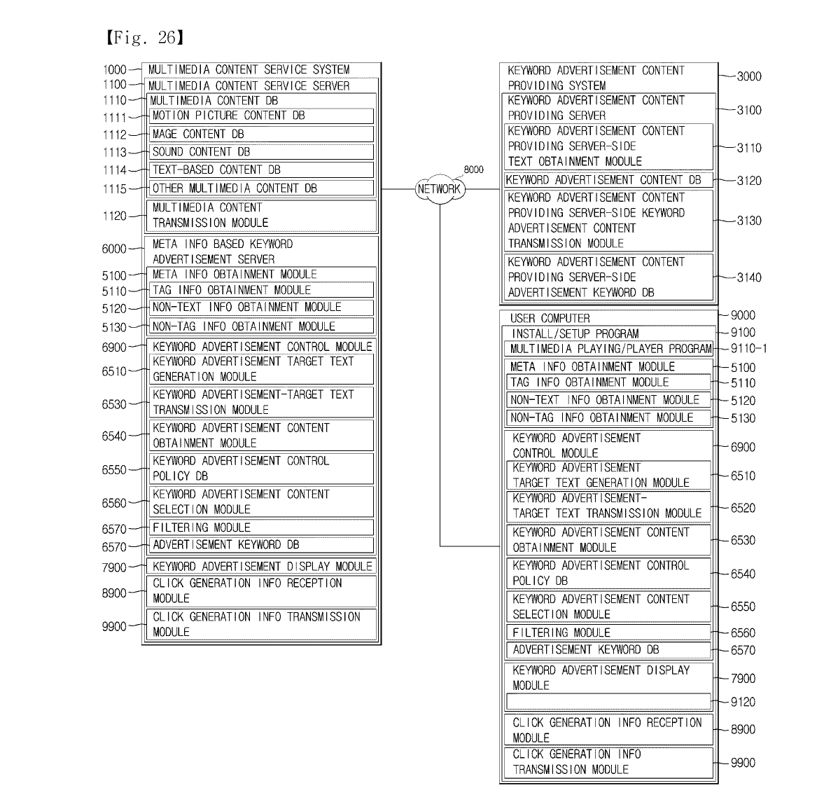

For example, the exclusive multimedia reproduction program 9110-1 is the Windows Media Player or Real Player provided by Microsoft Inc. or the GOM Player provided by the Korean company. There are many cases in which the exclusive multimedia reproduction program 9110-1 is installed on a set-top box of the IPTV, etc. Therefore, as shown in FIG. 26, it is preferable to execute the present invention through installing the exclusive multimedia reproduction program 9110-1 in the set-top box of the IPTV. If the construction of the exclusive multimedia reproduction program 9110-1 is expanded or changed or a function is added to the exclusive multimedia reproduction program 9110-1, the exclusive multimedia reproduction program 9110-1 can sufficiently perform a function of the (web) browser. If an attribute of information for the communication of the exclusive multimedia reproduction program 9110-1 with the multimedia content service system 1000 is the web page, the exclusive multimedia reproduction program 9110-1 can employ a scheme that has been described in the web browser scheme (scheme including the web page information analysis module). In the meantime, the case in which the exclusive multimedia reproduction program 9110-1 downloads a multimedia content file itself including meta information from the multimedia content service system 1000 and reproduces the multimedia content has been described in the second embodiment of the scheme next to the web browser scheme including the web page information analysis module. In the meantime, when the multimedia content service system 1000 separates meta information of the multimedia content file in another method (a certain method of a separate file, a separate web page, etc.) and transmits the meta information while downloading a multimedia content file itself, the meta information obtainment module obtains meta information and processes preset information.

Further, it is possible to add many additional functions to the exclusive multimedia reproduction program and the exclusive multimedia reproduction program can sufficiently use computer power (memory or CPU) of the user computer 9000, so that the exclusive multimedia reproduction program can process the function related to the voice recognition (when the multimedia content service system 1000 streams multimedia contents, in order to perform the voice recognition, the multimedia content service system 1000 or other server must reproduce multimedia contents. Further, the Java script included in the browser has difficulty in or cannot perform the voice recognition). In the meantime, the browser performs various functions through the script language, such as the Java script, but the exclusive multimedia reproduction program can use more powerful language than the script language, so that it is possible to more freely and variously perform various functions. That is, the conventional Java script cannot easily establish the mass advertisement keyword DB or have dictionary data for the morpheme analysis, but the exclusive multimedia reproduction program can do this without the large difficulty, to guarantee the freedom of the functions.

Especially, when the multimedia content service server 1100 obtains the multimedia content in the file transmission scheme, not in the streaming scheme, and produces and provides the multimedia content to the user, the Java script code or the exclusive multimedia reproduction program receives keyword advertisement contents from the multimedia content service server or the servers represented in the description of present invention at least one time independently of the satisfaction of a preset condition, while monitoring the multimedia content from a start time point to an ending time or a time after the ending time of a reproduction time, to display the keyword advertisement contents on a preset keyword advertisement content display area in a preset scheme.

The spirit of the present invention targets a multimedia content including meta information, and it is obvious to those skilled in the art that the multimedia content includes 1) a multimedia content combination in which at least two types of multimedia contents are combined, 2) a multimedia content combination in which multiple multimedia contents of at least one type are combined, or a multimedia content combination in which a text type content is combined with 1) and/or 2), as well as an identical type of a multimedia content (e.g. moving picture, image, and sound).

Next, a method of applying the spirit of the present invention to the IPTV will be described. The IPTV can be variously called as a bi-directional TV, an interactive TV, a digital TV, etc. and particularly refers to a TV that includes a device connectable to a bi-directional network, such as the Internet, or is externally combined with such a device. Generally, the TV is operated by a remote controller, etc. in contrary to the computer. In a viewpoint of the IPTV, the remote controller selects a specific content or operates through a TV screen, so that the remote controller equally performs at least one of a function of a pointing device, such as a mouse of a computer, and a function of a keyboard.

The IPTV combined with a network access control device, such as a set-top box, (hereinafter, referred to as a set-top box, but the spirit of the present invention is not limited to a specific type device), can perform the functions equal to a general personal computer connected with the Internet. Therefore, it is a matter of course that when a user, a producer of a moving picture, or a circulator inputs meta information, such as title information, tag information, explanation information related to the moving picture in the moving picture transmitted to the IPTV, the spirit of the present invention described in a viewpoint of the PC, not a peculiar TV, is applied to the IPTV/broadcasting station system. Hereinafter, a method of applying the present invention to the unique IPTV/broadcasting station system and the Internet broadcasting extended from the IPTV will be described, but the following descriptions will be applied to the multimedia content service system 1000 or the personal computer as a matter of course.

An image transmitted to the IPTV may further include a commercial tag. In general, most of the tags, etc. combined with the UCC moving picture, etc. are non-commercial tags combined by producers of the moving picture for the easiness of the search or the classification.

However, a moving picture obtained through a wired/wireless network in a bi-directional TV, such as the IPTV, (a broadcasting image is transmitted in a file download scheme or a streaming scheme so that the broadcasting image can be referred to as a moving picture, and a broadcasting station system or a moving picture circulator providing a moving picture for the IPTV is one of the multimedia content service system 1000 of the present invention. The broadcasting image is explained under the specific term of a broadcasting moving picture in relation to the IPTV, but the broadcasting moving picture is definitely one of the moving picture of the present invention) may be combined with the commercial tags by a producer, a circulator, and other value-added adders.

### MODE FOR INVENTION

Hereinafter, the commercial tag will be described in detail.

The commercial tag is a tag type, guarantees a calling of at least one keyword advertisement content based on a generation time or a use time, and is used for calling of a keyword advertisement. In order to guarantee the calling of at least one keyword advertisement content, the commercial tag should be 1) inquired in the keyword advertisement content providing system 3000, the meta information based keyword advertisement intermediation system, www.naver.com, www.google.com, etc. and is guaranteed the obtainment of at least one keyword advertisement content, 2) passed in the commerciality verification, or 3) directly attached by a person professionally attaching a tag while the person watches contents of a multimedia content. It is more preferable that the commercial tag passes all of 1), 2) and 3). Therefore, the commercial tag is a tag inquired in the keyword advertisement content providing system 3000 at least one time or has commerciality verification information. A tag of the conventional UCC moving picture is not guaranteed the calling of a keyword advertisement content based on a generation time of the UCC moving picture, so that the tag is not a commercial tag. A commercial tag set represents a tag set constituting only commercial tags. A tag set constituting n tags of the UCC moving picture is not a commercial tag set, but if the tag set passes 1) to 3), a part of tags can be commercial tags. 2) is the most important among 1) to 3), and a commercial tag in a narrow sense refers to a commercial passing 2). When the number of commercial tag candidates is n and each of n commercial tag candidates passes a commercial verification to be described later, it may be possible to select a commercial tag having the highest commerciality and the commercial tag comes to have commerciality verification information during this process. Hereinafter, the commercial tag will be described in more detail.

At least one commercial tag constituting a commercial tag set corresponding to a specific multimedia content includes a time independent commercial tag not-corresponding to time information, and a time dependent commercial tag corresponding to time information.

First, a data type and a data structure of a commercial tag constituting the commercial tag set will be described.

For example, when tags including information of 1) various goods, 2) places (including a real estate, a background, a photographing place, a specific service use place), and 3) clothes or accessories pass a commerciality verification, the tags are the time independent commercial tags. The time independent commercial tag includes at least one of 1) name information of a good, a place, or a service, 2) name information of a place, 3) brand information of a good or a service, and 4) numerical value or rank information of a good or a service, such as a size or a price of a good or a service.

The commercial tag may be stored in a file of the DB, but may have a data structure including a Markup tag that is a tag used in a Markup language, such as the XML, due to the circulation problem, etc. of a commercial tag set. According to a prior art, the data structure including the XML can correspond one-to-one to a corresponding DB structure.

It is assumed that an apartment and a bed are included in a single multimedia content. At this time, only name information of a good of a bed, such as 1) <good>bed</good> is generated as a commercial tag corresponding to the multimedia content. Herein, <good> and </good> are meta information representing a format or a kind of the Markup tag. At this time, the bed is a commercial tag and <good> and </good> are the Markup tags. A Markup tag is typically represented by a language expression capable of providing attribute information of an object. In this case, the Markup tag can provide attribute information of an object, so that it is one kind of meta information. When there is the Markup tag representing a format or a kind of various time independent commercial tags, it is possible to execute the present invention through selecting only commercial tag information corresponding to a specific format or a kind with the Markup tag. Further, it is possible to generate a commercial tag set including 1) a brand, such as <good>ACE BED</good>, 3) information of a size, etc., such as <good>King size bed</good>, and 4) place information, such as <photographing place>Dogok-dong Tower Palace</photographing place>, in addition to 1) name information of a good, such as <good>bed</good>. It is a matter of course that the meta information obtainment module 5100 obtains the time independent commercial tag, and the present invention can be executed through treating the obtained time independent commercial tag as the tag described in the spirit of the present invention. It is obvious to those skilled in the art that the spirit of the present invention can be implemented without information of a format or a kind of the tag. In the meantime, it is possible to grant a weight to a format or a kind of the tag. For example, it may be possible to grant the double weight to tag contents related to a good, than tag contents related to a place. The tag may have a hierarchical structure to be represented below and the meta information obtainment module 5100 conventionally recognizes the hierarchical structure through employing the XML parsing technology. The structures of the tags for goods and places are expressed below. It is general to represent the markup tags of the markup language, such as <goods>, <good>, and <good name> in English, such as <goods>, <good>, <good_name>, </goods>, </good>, and </good_name>, but are represented in Korean for the convenience of description. However, the Korean tags are not always processed.

```
<goods>
<good>
<good_name>bed</good_name>
<size>King size</size>
<brand>ACE<brand>
  </good>
<good>
<good_name>coffee</good_name>
<brand>Starbucks</brand>
  </good>
<goods>
<places>
<place>
<place_name>Dogok-dong Tower Palace</place_name>
<size>45 pyung</size>
<brand>Tower Palace</brand>
  </place>
```

With regard to this, when the tag is stored in the XML type, etc., the meta information, such as <good_name> or </good_name), is required. However, when the tag is stored in the field of the DB, the meta information, such as <good_name> or </good_name), may not be required. In this case, the tags are represented below.

1) bed, coffee, Tower Palace (in a case in which a tag field is completed with only the names of goods)

2) ACE bed, Starbucks coffee, Dogok-dong Tower Palace (in a case in which a tag field is completed with a brand name in addition to the names of goods)

It is a matter of course that it is possible to generate at least one commercial tag through combining 1) and 2). It is obvious to those skilled in the art that when a kind of the field of the DB is one, it is possible to store all commercial tags without discrimination of a place, a good, etc., but when the field of the DB is divided into a place field, a good field, a relevant good field, etc., the commercial tags can be divided according to the divided field and their field values can be inputted in the divided field.

Hereinafter, the construction of a tag set including meta information such as <good_name> or </good_name> will be described, but a tag set not including meta information will be included in the spirit of the present invention as a matter of course.

With regard to this, the meta information obtainment module 5100 may obtain only good's name information or place's name information serving as name information of a good, a place, and a service, but can further obtain other information related to the good, such as brand information or size information.

Prior to describing the time dependent commercial tag, an operation of a subtitle file in a movie, etc. will be first described. The subtitle file may have various file formats, but mainly has the smi file format. In the present invention, the smi subtitle file will be exemplarily described, but the spirit of the present invention is not limited to the smi file format. The smi file generally includes a specific subtitle and time zone information for displaying the specific subtitle.

For example, it is assumed that there is a file represented as below.

<SYNC Start=3103038><P Class=ENCC>
My Starbucks is ready.
<SYNC Start=3125091><P Class=ENCC>&nbsp; or
<SYNC Start=3103038><P Class=ENCC>
My Starbucks is ready.
</P></SYNC>
<SYNC Start=3125091><P Class=ENCC>
&nbsp;
</P></SYNC>

With regard to this, SYNC Start=3103038 represents that a subtitle of “My Starbucks is ready.” should be indicated between 3103038 milliseconds and 3125091 milliseconds (implying a subtitle of “My Starbucks is ready.” is indicated and a space (&nbsp;), instead of the subtitle, is shown at 3125091 milliseconds, to finish the subtitle).

Most of the image players can recognize such a subtitle file format and expose a specific subtitle set in a specific time zone on a specific location of a screen of a moving picture. Some countries including the USA ought to input subtitle information corresponding to voice information in video medium, such as movies and news, for a hearing-impaired person. In this case, when a subtitle of “My Starbucks is ready.” should be indicated between 3103038 milliseconds and 3125091 milliseconds and a subtitle (caption), etc. should be indicated for a hearing-impaired person, SYNC Start=3103038 represents that the subtitle (caption), etc. should be optimally indicated in a time section between 3103038 millisecond and 3125091 millisecond. In Korea, it is possible to view the TV news moving picture in a site, such as www.mbc.co.kr, operated by a broadcasting station. In this case, there are many cases in which a dialog or subtitle information is indicated next to the news moving picture during the streaming of the news moving picture.

Therefore, the time dependent commercial tag of the present invention further includes the commercial tags and information of a specific time or time zone related to the commercial tags.

For example, in a scene in which a hero and a heroine wake up in the king sized ACE bed in the morning in the Dogok-dong Tower Palace Apartment of 45 pyung at a specific time, the time dependent commercial tag has the following structure. The time dependent commercial tag of the present invention represents a tag including start time point information in which a specific time independent commercial tag has to be indicated and end time point information. For the convenience of description, the smi file format of the time dependent commercial tag is described, but an interpretation of the time dependent commercial tag is a matter of an interpreter and may be performed independently of the general smi file interpretation. That is, a typical moving picture player recognizes a smi subtitle file format having a file name identical to that of a moving picture as a subtitle tile file of the moving picture. An extension of a file related to the time dependent commercial tag may be smi, but also may be another extension (e.g. .xyz). When smi is used as a file extension and a typical smi file interpreter is used, “<tag_name>” or “</tag_name>” would be recognized and represented as a character, as well as contents, so that in this case, only a tag of “bed” should be inputted, other than <good_name>bed</good_name>.

```
<SYNC Start=3103038><P Class=KRCC>
<goods>
<good>
<good_name>bed </good_name>
<size>king size</size>
<brand>ACE</brand>
  </good>
<good>
<good_name>coffee</good_name>
<brand>Starbucks</brand>
  </good>
<goods>
<places>
<place>
<place_name>Dogok-dong Tower Palace</place_name>
<size>45 pyung</size>
<brand>Tower Palace</brand>
  </place>
</places>
</P></SYNC>
<SYNC Start=3125091><P Class=KRCC>&nbsp;
</P></SYNC>
```

In interpretation of the above time dependent commercial tag, it can be noted that a video image shown between 3103038 milliseconds and 3125091 milliseconds is related to a king sized ACE bed and the Dogok-dong Tower Palace of 45 pyung. At this time, in the time dependent commercial tag, a text string having an indication of < >, other than a general subtitle, is indicated next to the start time point information, so that the information of the time dependent commercial tag is differently processed from the general smi file.

The information of the time dependent commercial tag is represented in Table 2 for the easy understanding.

TABLE 5

| Commercial tag | Attribute | Time zone |
|---|---|---|
| bed | good | 3103038 ms~3125091 ms |
| king size | size | 3103038 ms~3125091 ms |
| ACE | brand | 3103038 ms~3125091 ms |
| coffee | good | 3103038 ms~3125091 ms |
| Starbucks | brand | 3103038 ms~3125091 ms |
| . . . | | |

```
<SYNC Start=3103038><P Class=KRCC>
<goods>
<good>
<good_name>bed</good_name>
<size>king size</size>
<brand>ACE</brand>
  </good>
<goods>
</P></SYNC>
<SYNC Start=3125091><P Class=KRCC>&nbsp;
<SYNC Start=3103038><P Class=KRCC>
<places>
<place>
<place_name>Dogok-dong Tower Palace</place_name>
<size>45 pyung</size>
<brand>Tower Palace</brand>
  </place>
</P></SYNC>
<SYNC Start=3147144><P Class=KRCC>
<goods>
<good>
<good_name>coffee</good_name>
<brand>Starbucks</brand>
  </good>
<goods>
</P></SYNC>
```

(the XML or a file indication representing the time dependent commercial tag is optionally set, and those skilled in the art can easily implement the spirit of the present invention through adjusting the tag to a specific file size appropriate to a specific interpreter in XML or smi.)

Table 5 shows that each kind of the time dependent commercial tags corresponds to a time zone. To investigate the time zone information, it can be identified that the Dogok-dong Tower Palace and the bed are indicated in the same time zone and the Starbucks coffee is indicated in another time zone.

That is, the time dependent commercial tag of the present invention includes 1) tag content information and 2) time zone information (e.g. start time point information and end time point information). The tag content information may be the time independent commercial tag of the present invention and its content may be related to a name of the good, place, or service as previously described.

<SYNC Start=3103038><P Class=KRCC> and <SYNC Start=3125091><P Class=KRCC>&nbsp; is only one example of the indications of time zone information, so that the time zone information can be sufficiently indicated in another scheme. For example, the time zone information may be indicated in a tag unit of each good. That is, information of multiple goods or places is indicated in a specific time zone, so that the goods or places may not be always exposed in the specific time zone at the same time. Therefore, the time zone information may be the same with the exemplary format in the unit of a separate good or a separate place or it may be possible to generate the time dependent commercial tag in a preset time zone information display method.]

It is preferred that the meta information obtainment module 5100 obtains a time dependent commercial tag corresponding to the time zone between 3103038 milliseconds and 3125091 milliseconds and the keyword advertisement control module 6900 exposes a keyword advertisement content obtained through processing the time dependent commercial tag during 3103038 milliseconds and 3125091 milliseconds. At this time, when a keyword advertisement content corresponding to the time dependent commercial tag related to a specific time zone (e.g. between 3103038 milliseconds and 3125091 milliseconds) is not included, the keyword advertisement control module 6900 may expose a keyword advertisement content corresponding to the time dependent commercial tag related at least one of a time zone before the specific time zone and a time zone after the specific time zone. If the time dependent commercial tag is related to a time zone before the specific time zone, the keyword advertisement control module 6900 may maintain a keyword advertisement content without changing, and if the time dependent commercial tag is related to a time zone after the specific time zone, the keyword advertisement control module 6900 may advance and expose a keyword advertisement content related to a time dependent commercial tag of a time zone after the specific time zone before displaying a video image related to a time zone after the specific time zone. With regard to this, a broadcasting moving picture is generally buffered so that a video image exposed in a specific time is obtained before a predetermined time, so that it is possible to advance and expose the keyword advertisement content.

Hereinafter, the construction of the time dependent commercial tag set will be described in more detail. The time dependent commercial tag set has a property of a set. A set includes a set itself as its element, so that the element of the time dependent commercial tag set includes 1) n number of time dependent commercial tags, 2) n number of time dependent commercial tag sets, and 3) whole range tags. A set can include a set as its element. A set constituting 1) is referred to as a first-type time dependent commercial tag set, a set constituting 2) is referred to as a second-type time dependent commercial tag set, and a set constituting 3) is referred to as a third-type time dependent commercial tag set. Therefore, any time dependent commercial tag set includes at least one of the first-type time dependent commercial tag set, the second-type time dependent commercial tag set, and the third-type time dependent commercial tag set.

For example, the first-type time dependent commercial tag set may have a format, the time dependent commercial tag set for #1 moving picture={(n tag sets 1: time range 1), . . . , and {(m tag sets i: time range i)}, wherein n and m are natural numbers, respectively. The ‘m tag sets i: time range i’ represents that the tag set i including n tags corresponds to the time range i. For example, the tag set i, [ACE bed, Starbucks coffee, Tower Palace} corresponds to the time range i, from 310000 milliseconds to 312000 milliseconds.

For example, the second-type time dependent commercial tag set may have a format, the time dependent commercial tag set for #2 moving picture={(first-type time dependent commercial tag set 1: condition set 1), . . . , and (first-type time dependent commercial tag set i: condition set i)} The condition set represents a set of conditions. A set of conditions includes 1) a property of a log-in user (adult (age), male/female, country/address, occupation, language, hobby, etc.) 2) dependence on a property or independence of a property (the common use regardless of the logging-in moving picture viewer is the independence of a property), 3) a kind of user computer 9000 (IPTV, mobile terminal, PC, display device size, etc.) 4) a moving picture display size (resolution), 5) time zone/term information (night, morning, from eight to ten o'clock, summer vacation season, etc.), etc. (It is a matter of course that the set of the conditions can be used in a time independent commercial tag or a time independent commercial tag set.)

When a moving picture viewer has a specific property logging in a system using the time dependent commercial tag set and there is a time dependent commercial tag set corresponding to the specific property, it is possible to use the time dependent commercial tag set corresponding to the specific property. However, when there is no time dependent commercial tag set corresponding to the specific property, it would be better to use a property-independent (commonly usable for any one) time dependent commercial tag set. For example, when a child logs in and there is no time dependent commercial tag set specialized for children, but only a time dependent commercial tag set specialized for adults and a property-independent time dependent commercial tag set, the use of the property-independent time dependent commercial tag set is the more reasonable selection.

In the meantime, when the user computer 9000 is a mobile terminal, it is reasonable that commercial tags constituting the time dependent commercial tag set have a property calling an advertisement of a high price even if the number of advertisements is small, and when the user computer 9000 is the IPTV or a PC, it is preferable to include many commercial tags capable of multiple keyword advertisement contents. Meanwhile, when a moving picture display size (resolution) is small, a size of the moving picture displayed is also generally small, so that it does not matter to expose multiple keyword advertisement contents. Therefore, the time dependent commercial tag set used in this case preferably includes multiple commercial tags having such a property.

Therefore, a system using the time dependent commercial tag set (a program executed in the multimedia content service system 1000 or the user computer 9000) recognizes 1) property information of a user logging-in the system, 2) time zone/term information, 3) resolution, and 4) a kind of user computer 9000, and when the system includes a time dependent commercial tag set corresponding to the recognized content, the system uses the time dependent commercial tag set. With regard to the use of the time dependent commercial tag set by the system, 1) the system directly uses the time dependent commercial tag set, 2) the system transmits only the time dependent commercial tag set corresponding to the recognized content to the user computer 9000, or 3) the system transmits information to the user computer 9000 so as for the user computer 9000 to use the time dependent commercial tag set corresponding to the recognized content.

The third-type time dependent commercial tag set includes the whole range tags. A case in which a time dependent commercial tag set corresponding to a specific content cannot correspond to a specific time zone of a moving picture is incurred. At this time, it would be better to call a keyword advertisement content by using a commercial tag corresponding to an entire content of the moving picture to provide the user computer 9000 with the called keyword advertisement content, rather than providing no keyword advertisement content. The tag used in this case represents the whole range tag.

There may be a case in which the single time dependent commercial tag set includes multiple keyword advertisement target text candidates. For example, king size ACE bed and Starbuck coffee are represented at the same time in the tag set of <good>. As such, the case in which multiple keyword advertisement target text candidates are included in the single time dependent commercial tag set can be processed identically to the case in which multiple tags are combined in a single moving picture. This has been previously described in the case where multiple tags for the ID 3 multimedia content are “refill ink, authenticated ink, unlimited ink, printer, multifunction apparatus, and ink”. The time dependent commercial tag is related to a specific time zone. With regard to this, when an image represented in the specific time zone is treated as a single small image, multiple keyword advertisement target text candidates (king size ACE bed, Starbucks coffee, Dogok-dong Tower Palace) within a time dependent commercial tag related to the small moving picture can employ the spirit of the invention described in the case in which multiple tags for the ID 3 multimedia content are “refill ink, authenticated ink, unlimited ink, printer, multifunction apparatus, ink” as it is. That is, a single broadcasting moving picture can be treated as a set of m small moving pictures in the unit of a time zone, and the unit of the time zone can be processed as start time point information and end time point information included in a time dependent commercial tag.

When n time dependent commercial tags are included in the single broadcasting moving picture, the system can collect only specific fields (e.g. fields of goods) among the n time dependent commercial tags and transmits the collected specific fields after reproducing the broadcasting moving picture, and when a user selects a specific field, the system processes a time dependent commercial tag related to a value of the selected field, obtains a keyword advertisement content, and provides the users with the obtained keyword advertisement content.

Meanwhile, the multimedia content service system 1000 (including a broadcasting station providing a broadcasting moving picture or a person transmitting a broadcasting moving picture to a computer of another user) can provide a screen including the broadcasting moving picture transmitted to the user computer with a time dependent commercial tag store interface in a preset icon/pattern/button/selection box type. For example, when the system displays a button indicating “store a tag related to a current scene” at a corner of a screen of a broadcasting moving picture and the user clicks the button on the user computer, it is possible to store a time dependent commercial tag at the time of the click generation. Further, when the user computer calls the time dependent commercial tag information after or during the reproduction of the broadcasting moving picture, the system can obtain a keyword advertisement content related to a specific field of the time dependent commercial tag or the time dependent commercial tag and expose the obtained keyword advertisement content on the user computer. It is a matter of course that when the system includes advertisement/promotion contents, such as an advertisement/promotion image or video image, related to the time dependent commercial tag, the system can provide the user computer with the advertisement/promotion contents. In the meantime, when the user computer is the IPTV, a pointing device for the IPTV is a remote controller, and the remote controller cannot conveniently shift a location of a specific button on a screen of the IPTV, a message of a button may be “press aaa button if you want to store a tag related to a current scene”. That is, with the remote controller, it is easy to press an appointed specific button. Even when the remote controller is a remote controller having a gyro function (the remote controller includes a gyro sensor so that a movement of the remote controller can be displayed on the screen of the IPTV) or other pointing functions are good, it is more preferable to press an appointed button of the remote controller. It is apparent to those skilled in the art that the message can include the more instinctive message, such as “press aaa button if you want to store a tag related to a current scene”.

In the meantime, the system can provide the user computer with keyword advertisement contents related to the highest frequent time dependent commercial tag or at least one specific time dependent commercial tag preset by a broadcasting station or other subject among the n time dependent commercial tags at a preset time, such as a time just after the completion of a broadcasting moving picture.

At least one time dependent commercial tag set can be allocated to a single broadcasting moving picture. The time dependent commercial tag set represents a set including elements of n time dependent commercial tags for a single broadcasting moving picture. In general, the longer the reproduction time of a specific broadcasting moving picture is, the more the goods or places appear, the more often the scene change is, the more the names of goods, places, or services are included in speeches, the more the number of time dependent commercial tags is. Further, when a single broadcasting moving picture is provided, an independent separate subject can generate m time dependent commercial tag sets and a specific time dependent commercial tag set can be selected according to a selection of a broadcasting company or a user. At this time, the multimedia content service system 1000 providing a specific broadcasting moving picture can receive a time dependent commercial tag set for the specific broadcasting moving picture from the inside of the multimedia content service system 1000 or at least one outside computer. With regard to this, when the multimedia content service system 1000 streams the specific broadcasting moving picture or transmits a file of the specific broadcasting moving picture, when the multimedia content service system 1000 synchronizes the specific broadcasting moving picture with the received time dependent commercial tag set and transmits the specific broadcasting moving picture, or transmits the specific broadcasting moving picture and then a player (an application capable of reproducing a moving picture) installed on the user computer synchronizes the specific broadcasting moving picture with the received time dependent commercial tag set and outputs the specific broadcasting moving picture on the user computer. As previously mentioned, each of the time dependent commercial tags constituting the time dependent commercial tag set includes time information and a time independent commercial tag set.

In the meantime, the time dependent commercial tags may have the simpler format, such as “time information+tag information”. Further, a method of displaying the time information is only a matching matter with an interpreter interpreting a displayed method, and the time information can be displayed in various formats, as well as the smi file format.

For example, when the time dependent commercial tag is a format of “start time point+tag contents+end time point”, the tag contents are related between the start time point and the end time point. For example, the time dependent commercial tag is as follows.

```
    1)  <SYNC Start=3105092><P
Class=KRCC>Starbucks</P></SYNC><SYNC Start=3305091><P
Class=KRCC>&nbsp; </P></SYNC>
    2)  <SYNC Start=3105092>Starbucks</SYNC><SYNC
Start=3305091>&nbsp; </SYNC>
    3) <SYNC Start=3305091 End=3305091>Starbucks</SYNC>
    4)  <SYNC  Start=3105092>Starbucks;  coffee;  Tower
Palace; ACE bed</SYNC><SYNC Start=3305091>&nbsp; </SYNC>
    5) <Start=3105092>Starbucks<SYNC End=3305091>
```

1) to 5) are only examples, 3) may be the most preferable, and 5) is slightly difficult to parse. 1) represents an example of a display method of tag information in a general smi file format, 2) represents an example not including a language indication part, 3) represents an example that a start time point and an end time point can be displayed in a specific appointment, such as Start and End, 4) represents an example of including multiple tag contents, and 5) represents an example of adopting an arbitrary appointed format, such as an arbitrary identification format “<Start”, for a sync identifier, such as <“Sync Start”.

For example, the following n time dependent commercial tags are linked with a specific moving picture #1 at a play time of 10 minutes. The format of the time dependent commercial tag adopts 4) for the convenience of description.

```
    <SYNC Start=000001>Starbucks; coffee <SYNC
Start=120000>&nbsp;
    <SYNC  Start=120001>Tower  Palace;  Xi  Apt  <SYNC
Start=180000>&nbsp;
    <SYNC Start=180001>ACE bed; Dunlop pillow; Bed
sheet<SYNC Start=3000000>&nbsp;
    <SYNC Start=300001>Haptic cellular phone;
photographing; bell sound<SYNC Start=500000>&nbsp;
    <SYNC Start=500001><SYNC Start=600000>&nbsp;
```

Otherwise, since a previous SYNC and a next SYNC is successive, the above format can be simplified as the following commercial tag format.

```
    SYNC Start=000001> Starbucks; coffee</SYNC>
    <SYNC Start=120001> Tower Palace; Xi Apt</SYNC>
    <SYNC Start=180001> ACE bed; Dunlop pillow; Bed
sheet</SYNC>
    <SYNC Start=300001> Haptic cellular phone;
photographing; bell sound</SYNC>
    <SYNC Start=500001></SYNC>
```

It can be noted that the moving picture #1 is linked with tag contents of “Starbucks; coffee” from a start to 120 seconds according to the first format, and the moving picture #1 is linked with tag contents of “Tower Palace; Xi Apt” from 120 seconds to 180 seconds according to the second format. Further, it is possible to allow no tag contents in a specific time zone, such as no tag contents between 500 seconds and 600 seconds.

Information of the time dependent commercial tags will be presented in Table 6 for the convenience of understanding. At this time, there may be no property information of a commercial tag. Further, when a commercial tag is generated, at least one of various commerciality information of the commercial tag can be added. The commercial tag set generation system 10000 can provide the commerciality information.

TABLE 6

| | | | | Expected |
|---|---|---|---|---|
| | | Advertise- | Click rate | advertise- |
| Commercial | Time zone | ment unit | with respect | ment sale |
| tag | (ms) | price (won) | to exposure | (won) |
| Starbucks | 000001~120000 | 1000 | 2% | 20 |
| Coffee | 000001~120000 | 500 | 2% | 10 |
| Tower | 120001~180000 | 300 | 3% | 9 |
| Palace | | | | |
| Xi Apt | 120001~180000 | 700 | 3% | 21 |
| ACE bed | 180001~300000 | 450 | 10% | 45 |
| Dunlop bed | 180001~300000 | 1500 | 5% | 75 |
| . . . | . . . | . . . | . . . | . . . |

It is obvious to those skilled in the art that information represented in the table is changed to the XML format and various information of the time dependent commercial tag set represented in the table can be generated, transmitted, distributed, and received in various computing data formats.

The data format representing a commercial tag has been described. Next, the generation of a commercial tag will be described in more detail.

The commercial tag has to essentially guarantee the obtainment of at least one keyword advertisement content. The obtainment can be sufficiently guaranteed if at least one keyword advertisement content is obtained at a specific generation time or a specific inquiry time. That is, if it is verified that at least one keyword advertisement content of advertisers corresponding to the commercial tag candidates is included in the system through inquiring in a preset DB about the commercial tag candidates, the commercial tag sets can be commercial tags.

At least one time dependent commercial tag can be previously inputted by an operator of the multimedia content service system 1000 providing the moving picture service or a person receiving an instruction of an operator of the multimedia content service system 1000 and then stored or be a stored time dependent commercial tag produced by a producer or a circulator of the moving picture. When the system receives a time dependent commercial tag related to the specific time or a time zone including the specific time from a computer reproducing the moving picture authenticated or independent of authentication, maps the received time dependent commercial tag with the moving picture, and stores the moving picture, and then a third user selects the moving picture, the system can provide the third user computer with keyword advertisement contents related to the time dependent commercial tag by using the received time dependent commercial tag. At this time, the system may provide the authenticated computer inputting the time dependent commercial tag with information of a preset monetary or non-monetary compensation (e.g. provide 1% of generated advertisement costs). At this time, when n users input the time dependent commercial tag for the specific moving picture #1, with respect to the time dependent commercial tag sets inputted by each of the n users, an operator of the multimedia content service system 1000 selects at least two time dependent commercial tag sets, applies the spirit of the present invention to the dependent commercial tag sets, and selects at least one higher-ranked or highest-ranked time dependent commercial tag set based on a preset reference, such as the total number of click generations or the total quantity of advertisement profits. At this time, when the third users select the moving picture #1, the multimedia content service system 1000 can transmit keyword advertisement contents obtained by using the selected time dependent commercial tag set to the third user computer.

It is necessary to synchronize the keyword advertisement content related to the time dependent commercial tags constituting the time dependent commercial tag set with the reproduction of the moving picture. That is, when a specific time or a specific section of a moving picture is indicated on the user computer (in a streaming scheme and/or a file downloading scheme), it is necessary to provide the user computer with the keyword advertisement content related to the time dependent commercial tag corresponding to the specific time or the specific section, so that the synchronization performs an important function in contents matching. The synchronization is identical or equivalent to the synchronization between the reproduced multimedia content and the keyword advertisement contents based on the texts obtained from the multimedia content. If the obtained text corresponds to a text included in the time dependent commercial tag, it is possible to sufficiently understand the synchronization of the present invention. The transmission of which keyword advertisement content with which tag information when there are multiple time dependent commercial tag information in a specific time or a specific section is identical or corresponding to the description of the case regarding the multiple tag information. It is a matter of course that when the moving picture includes a caption, the multimedia content service system 1000 or the user computer processes the time dependent commercial tag independently of the caption.

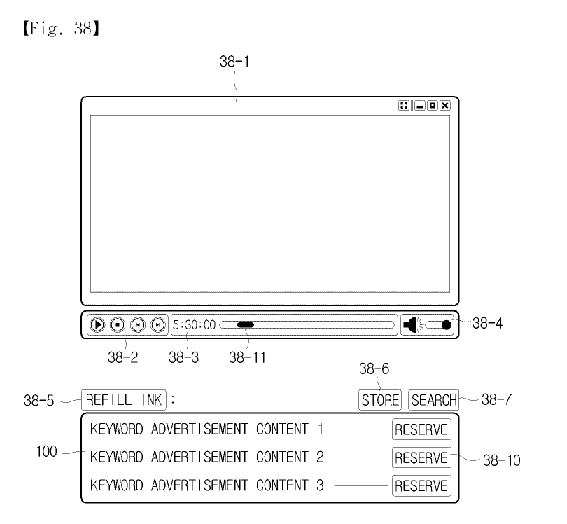

Hereinafter, three schemes of the synchronization of the reproduction of a moving picture and the time dependent commercial tag set will be described in more detail. In the first scheme, the synchronization is implemented in the user computer 9000. The meta information obtainment module 5100 provided to the user computer 9000 detects current reproduction time information of a moving picture transmitted to the user computer 9000 and obtains a time dependent commercial tag corresponding to the detected reproduction time information. The obtainment target time dependent commercial tag may have been previously provided to the user computer 9000 by the multimedia content service system 1000 or other systems storing the time dependent commercial tag. The calling of keyword advertisement contents by using the obtainment time dependent commercial tag has been described in the subject specification. The general reproduction means (players) provide a reproduction time/area display/control means 38-11 shown in FIG. 38. When the user shifts a reproduction time by using the reproduction time/area display/control means 38-11, the meta information obtainment module 5100 detects a shifted reproduction area and obtains a time dependent commercial tag corresponding to the detected reproduction time information.

In the second scheme, the synchronization is implemented in relation to the multimedia content service system 1000. When the user computer 9000 is always connected with the multimedia content service system 1000, such as a client/server scheme, the client and the server (the multimedia content service system 1000 can be a server of the client/server scheme) can be aware of reproduction time information of a moving picture currently reproduced in the client. In this case, the meta information obtainment module 51—of the multimedia content service system 1000 that is the client and/or the server detects current reproduction time information of a moving picture transmitted to the user computer 9000 and obtains a time dependent commercial tag corresponding to the detected reproduction time information.

In the third scheme, the synchronization is implemented during the reproduction of a downloaded moving picture file. The meta information obtainment module 5100 installed in or linked with a program reproducing the downloaded moving picture file detects current reproduction time information of the reproduced moving picture and obtains a time dependent commercial tag corresponding to the detected reproduction time information. The time dependent commercial tags may be provided together with the downloaded moving picture, but can be obtained from the multimedia content service system 1000 which has provided the moving picture file or a third system providing information of a time dependent commercial tag (set) corresponding to the moving picture file.

The multimedia content service system 1000 can previously generate multimedia content service system 1000 generating tag information through processing meta information included in the multimedia content. The multimedia content service system 1000 can 1) generate and store multimedia content service system 1000 generating tag information by the same method of generating keyword advertisement target texts by using the title or explanation information obtained by the multimedia content service system 1000 and 2) generate the time dependent commercial tag by using text information obtained from a subtitle or voice recognition and store the time dependent commercial tag. Since the method 1) has been described, the method 2) will be described in more detail. When a file format of the subtitle has start time point information for exposing a subtitle and a specific subtitle, and end time point information, such as the smi file, etc., the multimedia content service system 1000 generates keyword advertisement target texts or tags by using the subtitle and stores the keyword advertisement target texts or tags together with start time point information and end time point information of the exposed subtitle. However, start time point information and end time point information are not represented in the voice recognition, so that the multimedia content service system 1000 can uniformly or un-uniformly divide a time 1) in a preset time unit, such as one minute, 2) in the unit of a time of generating a predetermined number, e.g. one or three, of tags or keyword advertisement target texts, etc.

Next, the generation of the commercial tag will be described in more detail. A commercial tag can be generated on the multimedia content by a system (including at least one of a specific program, a program set, a medium recording a program, a medium executing a program, a server including a program, and a system executing a program), wherein the system is the commercial tag set generation system 10000.

The construction of the commercial tag set generation system 10000 is illustrated in FIG. 27. FIG. 27 illustrates the construction of the commercial tag set generation system 10000 corresponding to the disintermediation model, but the commercial tag set generation system 10000 can be applied to the intermediation model or the keyword advertisement content providing system 3000 based model as a matter of course. The meta information obtainment module 5100 includes a commercial tag set obtainment module 5140 obtaining a commercial tag set that is a set of at least one commercial tag generated and transmitted by the commercial tag set generation system 10000. Hereinafter, the commercial tag set generation system 10000 of the disintermediation model will be described.

First, the relation between the multimedia content service system 1000 and the commercial tag set generation system 10000 will be described. The commercial tag set generation system 10000 may be operated by an operation subject identical to or different from that of the multimedia content service system 1000. Further, the commercial tag set generation system 10000 may be structurally included in the multimedia content service system 1000 and independently included in a separate system through a wired/wireless network. The commercial tag set generation system 10000 receives a multimedia content from the multimedia content service system 1000 in a file download scheme or a streaming scheme, generates a commercial tag set for the multimedia content, stores the generated commercial tag set, and transmits the commercial tag set to the multimedia content service system 1000 through a commercial tag set transmission module 12000. The commercial tag set obtainment module 5140 of the meta information obtainment module 5100 of the multimedia content service system 1000 stores the transmitted commercial tag set in connection with the multimedia content. The meta information obtainment module 5100 can process the received commercial tag set equally to tag information obtained by the tag information obtainment module 5110. In the meantime, the keyword advertisement target text generation module 6510 can process the commercial tag set obtained by the commercial tag set obtainment module 5140 equally to tag information obtained by the tag information obtainment module 5110, but when the commercial tag set and the tag information coexist, the keyword advertisement target text generation module 6510 can grant the higher priority or a weight to the commercial tag set and the tag information and process them. At this time, the multimedia content can be managed by an identifier (ID) capable of identifying the multimedia content.

The commercial tag set generation system 10000 includes a commercial tag set generation server (not shown) and the commercial tag set generation server (not shown) includes a commercial tag set generation module 11000 and a commercial tag set transmission module 12000. There are three methods of generating a commercial tag set by the commercial tag set generation module 11000. First, a commercial tag set is generated by an expert while viewing the multimedia content, which is performed by an expert selecting commercial tag set generation module 11200. Second, a commercial tag set is systematically generated, which is performed by a systematic commercial tag set generation module 11400. Third, a commercial tag set is generated by the participation of unspecific multiple users, which is performed by a user participation commercial tag set generation module 11300 (commercial tag set obtainment module 5140). Next, the three methods will be sequentially described.

The expert selecting commercial tag set generation module 11200 is usually used when an expert generates a commercial tag set for a specific multimedia content. The expert selecting commercial tag set generation module 11200 provides an expert's computer with multimedia content information obtained or received by the multimedia content obtainment module 11100 from the multimedia content service system 1000, and receives and stores at least one time independent commercial tag or at least one time dependent commercial tag from the expert's computer. The multimedia content obtainment module 11100 may not be an essential element of the commercial tag set generation module 11000, but is preferably included in the commercial tag set generation module 11000. For example, when a time independent commercial tag for a specific multimedia content is generated, it is not necessary to add time information to a generated commercial tag, and it is enough to generate only a commercial tag set corresponding to the entire multimedia content.

With respect to at least one multimedia content especially having the high hit values, an operator of the multimedia content service system 1000 or a business connector of the multimedia content service system 1000 opens a commercial tag input module 11210 for inputting a commercial tag for the multimedia content, and inputs a time independent commercial tag/time dependent commercial tag related to the multimedia content in the multimedia content or stores a time independent commercial tag/time dependent commercial tag in correspondence to the multimedia content or an ID of the multimedia content, while viewing the multimedia content, in a scheme of downloading and reproducing the multimedia content, a scheme of receiving a streaming of the multimedia content from a web browser, etc. With regard to this, the commercial tag input module 11210 includes a multimedia content ID display unit 11211, a multimedia content play unit 11212 capable of playing multimedia contents (which includes a browser and plays a streamed multimedia content, or downloads a file of a multimedia content and plays the multimedia content), and a multimedia content meta information display unit 11218 displaying meta information of multimedia contents (title, tag, explanation, writer ID, hit values, etc.)

The commercial tag input module 11210 includes a commercial tag input unit 11213 for inputting a commercial tag or a commercial tag set display unit 11214 for displaying an obtained commercial tag set, and preferably further includes a commercial tag verification unit 11215 for verifying the commerciality of the inputted or obtained commercial tag (including a commercial tag candidate). The commercial tag verification unit 11215 inquires in the advertisement keyword DB 6570 and/or the keyword advertisement content providing server-side advertisement keyword DB 3140 of the keyword advertisement content providing system 3000 about a commercial tag (including a commercial tag candidate because a commercial tag has not been verified) and verifies the commerciality of the commercial tag. In order to realize the latter verification, it is a matter of course that the keyword advertisement content providing system 3000 should allow an outside server to partially or entirely access the keyword advertisement content providing server-side advertisement keyword DB 3140 by a method of opening the API, etc. When the meta information based keyword advertisement intermediation system 2000 has the advertisement keyword DB 6570, information of the number of searches/exposures/advertisers, the advertisement unit price, etc. for advertisement keywords (or search keywords), or other information (the properties of 1) to 18) etc.) capable of verifying the commerciality of the commercial tag, the commercial tag verification unit 11215 can inquire of the meta information based keyword advertisement intermediation system 2000 and verify the commerciality of commercial tag candidates.

The properties of 1) to 18) included in the advertisement keyword DB 6570 or the keyword advertisement content providing server-side advertisement keyword DB 3140 with respect to a specific advertisement keyword have been previously described. The commerciality can be verified through a satisfaction degree of the commercial tag serving as an advertisement keyword with any property of 1) to 18) and information of a weight and/or the score function of each property. The commercial tag verification unit 11215 1) calculates the 1) to 18) and/or a score function value of a selected single commercial tag or 2) calculates the 1) to 18) and/or a score function value of selected n commercial tags, and grants a rank to the commercial tag according to each reference or a preset equation (e.g. a specific score function). That is, an operator or a business connector of the multimedia content service system 1000 selects tag candidates for a selected specific multimedia content, verifies the tag candidates through the commercial tag verification unit 11215, and selects only tags passing a preset condition (e.g. the properties of 1) to 18) or a reference of a specific score function value) for a commercial tag set. At this time, specific tags may be registered in a commercial tag set without passing the commercial tag verification unit 11215 and some experts can generate a commercial tag set without using the commercial tag verification unit 11215 by their experience or other methods. One example of other methods is that the expert inquires of the search engine (www.naver.com or www.google.com) or the keyword advertisement content providing system 3000, such as www.overture.com about the tag candidate and identifies if keyword advertisement contents corresponding to the tag candidates are included in the search engine or the keyword advertisement content providing system 3000, or the advertisers or a degree of an advertising bidding price.

It is possible to verify a commercial tag set in a simple method by using the search engine and the keyword advertisement content providing system 3000, such as www.overture.com, because the search engine can identify an existence of a data value of a sponsor link area or other advertisement areas and/or the total number of advertisements (as the number of advertisers on a specific advertising area provided according to each search engine, other than a sponsor link area, is larger, an advertisement insertion competition is intense and an advertisement unit price is generally high), and www.overture.com can provide information of the advertisement competition of a specific keyword (information of a bidding price, etc.—if there is information of a bidding price, it means that there are advertisers, and the higher the bidding price is, the higher the advertisement insertion competition of advertisers is). The generation of a time independent commercial tag set for a specific single multimedia content is performed by the time independent commercial tag generation unit 11216.

The time independent commercial tag according to the present invention has been described, but it is a matter of course that the spirit of the present invention, such as the verification of the commerciality, has been applied to the time dependent commercial tag. Next, the time dependent commercial tag will be described in more detail. In order to generate a tag set of time dependent commercial tags, the time dependent commercial tag generation unit 11217 of the present invention has to include time information related to reproduction of the multimedia content for each commercial tag. To this end, the expert's computer or the commercial tag set generation module 11000 has to include 1) a reproduction function module, 2) a reproducing time display/section display module, and 3) a tag corresponding module, for a section for the multimedia content. The time display/section display module should designate a specific frame/time and a section between specific frames/times of the multimedia content and display a time corresponding to the designated section. That is, when the operator or the business connector designates a section and at least one commercial tag for the designated section, the time dependent commercial tag generation unit 11217 generates a time dependent commercial tag including commercial tag information and time information (start time point information and end time point information related to the commercial tag) with the commercial tag and the section/time information. At this time, the time dependent commercial tag generation unit 11217 verifies the obtained tag candidates by using the commercial tag verification unit and generates only the tags satisfying a preset reference as a time dependent commercial tag set.

A time dependent commercial tag generated by the time dependent commercial tag generation unit 11217 includes time zone information, so that the following problems, which are not incurred in the time independent commercial tag, are incurred. The first problem is selecting which policy to apply to a case in which the commerciality of a commercial tag obtained in a specific time zone decreases in comparison with a previous time zone or a next time zone. The second problem is the case in which an obtained commercial tag is not included in a specific time zone or an obtained commercial tag is included in a specific time zone, but the number of keyword advertisement contents obtained from the keyword advertisement DB 6570 in relation to the commercial tag is small. The third problem is that the time dependent commercial tag set is completely different according to a division manner of the time zone. These three problems are not big problems in the generation of the time independent commercial tag generation.

There are three methods of corresponding at least one time dependent commercial tag set according to at least one divided time zone to a specific multimedia content, especially, a broadcasting multimedia contents having a relatively long reproduction time. In the first method, when a commercial tag set for a specific time zone is inquired in the advertisement keyword DB 6570 and the keyword advertisement control policy DB and the inquiry result corresponds to the first problem or the second problem, 1) when the commerciality fails to satisfy a preset reference, a keyword advertisement is provided by using a commercial tag set in relation to a previous time zone or a next time zone of the specific time zone and 2) a keyword advertisement is provided using a combined commercial tag set which is generated through combining a commercial tag set in relation of a previous time zone or a next time zone and a commercial tag set in relation to the specific time zone.

In the second method, when it is possible to be aware of information of a scene number of a specific moving picture, a predetermined part of the moving picture corresponding to a specific scene number is treated as a single unit based on the scene number, so that a time dependent commercial tag set is generated in the unit of the part of the moving picture. In this case, the uniformity between the time dependent commercial tag set and a scene considered by a writer of the moving picture is the highest.

In the third method, a common tag or tags within the most frequent n^{th} rank are extracted from tags included in the commercial tag sets of at least two units of the time zones and a commercial tag set in relation to a specific time zone incurring the first and second problems is supplemented with the extracted most frequent tags, so that the keyword advertisement for the specific time zone is provided using the supplemented commercial tag set.

The goods (watch, ornaments, earrings, clothes, etc.) worn by a hero or a heroine are commonly represented in multiple units of time zones or multiple scenes. In this case, the problem is how to process commercial tag sets related to the commonly represented goods. The often represented goods generally have the high frequency in commercial tag sets. The high frequent commercial tags are utilized, such as, 1) the high frequent commercial tags are utilized throughout an entire time to continuously provide relevant keyword advertisement contents, 2) the relevant keyword advertisement contents are grouped and provided according to each of the high frequent commercial tag when the reproduction/transmission of the moving picture is completed (to this end, the most frequent commercial tag is extracted, the extracted tag is arranged, and a predetermined number of keyword advertisement contents are obtained and provided for each of the arranged most frequency commercial tags), 3) the high frequency commercial tags can concentrically supplement a specific time zone having a low commerciality of a commercial tag.

The commercial tag set is a conventional UCC tag set (including tags inputted by a person uploading the UCC), but it is preferable to store and manage the commercial tag set separated from a tag set for management (it may input a tag for the purpose of management independently of the commerciality). In the meantime, when the moving picture is provided, the commercial tag set may not be provided to the user computer, but may be provided on a side, a lower part, or a preset location of a general tag for satisfying user's demands of information. When click information for a commercial tag is obtained during the providing of the commercial tag to the user computer, the multimedia content service system 1000 searches for a moving picture sharing the commercial tag serving as a commercial tag by the commercial tag serving as a search word, processes the commercial tag like a general tag and include the commercial tag in the general tag, or provides a moving picture including meta information, such as title or explanation information as a search result.

The expert selection commercial tag set generation module is more effective for 1) a UCC moving picture having the high hit value, 2) a broadcasting moving picture of a drama, news, a documentary, a sitcom, a show program, an information program relating to tourism, restaurants, goods, services, and places, etc. having a relatively long play time, and 3) a movie (the extraction of a keyword advertisement target text from a subtitle or voice information is excluded in this paragraph, which will be described in the systematic commercial tag set generation module. It is a matter of course that experts can generate commercial tags while viewing subtitles or listening to voices.) A user uploading the UCC moving picture can provide a time independent commercial tag or a time dependent commercial tag together with the UCC moving picture. In this case, the multimedia content service system 1000 has to include a function of providing a commercial tag, independently of a conventional tag information input box, so as to allow the user to upload the UCC moving picture. Especially, the multimedia content service system 1000 has to provide a function of corresponding time information to each of the time dependent tags so as to allow the user to input a time dependent commercial tag. For example, the multimedia content service system 1000 provides “time information input box (start time point input box, end time point input box) vs. at least one commercial tag input box”. Especially, it is preferable that an operator of the multimedia content service system 1000 inputs a time dependent commercial tag or a time independent commercial tag for the UCC moving picture having the high hit values, and an operator of a broadcasting station, a producer or an editor of a broadcasting moving picture, or an entrusted expert of the operator or editor inputs a time dependent commercial tag or a time independent commercial tag.

It is a matter of course that the spirit of the present invention can be applied to the transmission of a live broadcasting to the user computer (including the IPTV). That is, an operator of the multimedia content service system 1000 (a broadcasting station, a cable TV business operator or a transmitter of the live broadcasting, and a system of an intermediary correspond to the multimedia content service system 1000) or an entrusted person of the operator can input at least one commercial tag for the live broadcasting image in real time through a commercial tag input module 11210, and the tag inputted in real time constitutes a time dependent tag set. At this time, the inputted commercial tag can pass the commercial tag verification unit 11215 as a matter of course. The inputted commercial tag is treated like the time dependent commercial tag of the present invention, so that the spirit of the present invention is applied to the inputted commercial tag as it is. However, in this case, the unit of the time zone corresponding to the time dependent tag set is preferably the unit designated by a person inputting the commercial tag in real time. In the meantime, when the commercial tags are inputted one by one or the commercial tags are processed in the unit of a tag set, a time duration in which a next tag is inputted or a next tag set unit is provided to the commercial tag input module 11210 may be a time zone corresponding to the single tag or the tag set unit.

Unlimited multiple users can input a commercial tag for a specific moving picture, as well as a specific expert group. When multiple users participate in the input of the commercial tag input, a time independent commercial tag set or a time dependent commercial tag set for a specific moving picture is generated for each of the users. At this time, the commercial tag set generation module 11000 can verify a tag set of each user through the commercial tag verification unit 11215 and select a commercial tag set of a specific user optimally satisfying the condition of the keyword advertisement control policy DB 6540, such as the properties of 1) to 18), the score function, etc. When the moving picture includes scene information or the commercial tag set generation module 11000 divides the time zone of the moving picture, the commercial tag set generation module 11000 can select a commercial tag set of another user in the unit of the scene information or in the unit of the time zone division. At this time, the commercial tag set generation module 11000 can transmit information on a compensation preset for the selected user to the user computer, and at this time, it is preferable to record compensation contents for the selected user in a compensation information table and provide the recorded compensation information. Further, the commercial tag set generation module 11000 provides a My page function so that it is possible to search for a compensation specification in the My page of a user.

Further, the commercial tag set generation module 11000 changes a using commercial tag set according to a passage of time, accumulates and analyzes a keyword advertisement effect (the total number of clicks, the total advertisement profits, etc.) for each commercial tag set according to the passage of time, and sophisticates the commercial tag set into a commercial tag set having the high keyword advertisement effect. This is more necessary for the time dependent tag set.

Next, the systematic commercial tag set generation module 11400 will be described. The function of the systematic commercial tag set generation module 11400 is equal to the process of generating a keyword advertisement target text with text information obtained by the non-tag text obtainment module by the keyword advertisement target text generation module 6510. The systematic commercial tag set generation module 11400 can exist outside of the multimedia content service system 1000, and receives text information obtained by the non-tag text obtainment module 5130 of the multimedia content service system 1000 and generates a time independent commercial tag or a time dependent commercial tag with the text information. Especially, when the multimedia content service system 1000 provides a moving picture including subtitles, such as a movie and news, the systematic commercial tag set generation module 11400 obtains and processes the subtitle information (the analysis of a morpheme, the extraction of a name of a good or a service, the passing of the commercial tag verification module including a filtering through the keyword DB, etc.), and transmits the process result to the multimedia content service system 1000 through the commercial tag set transmission module 12000.

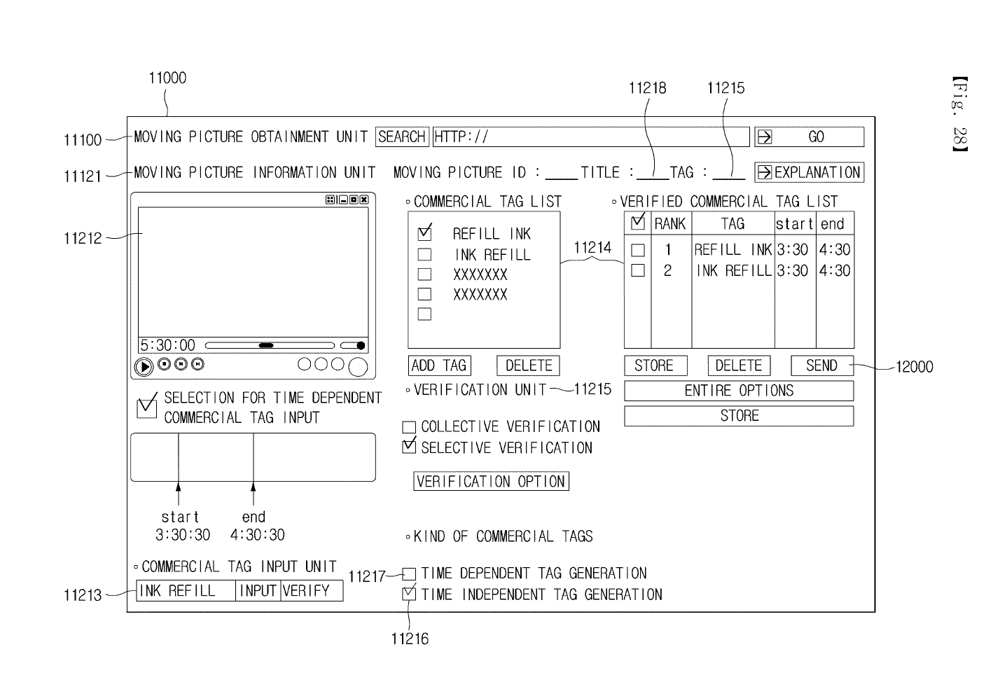

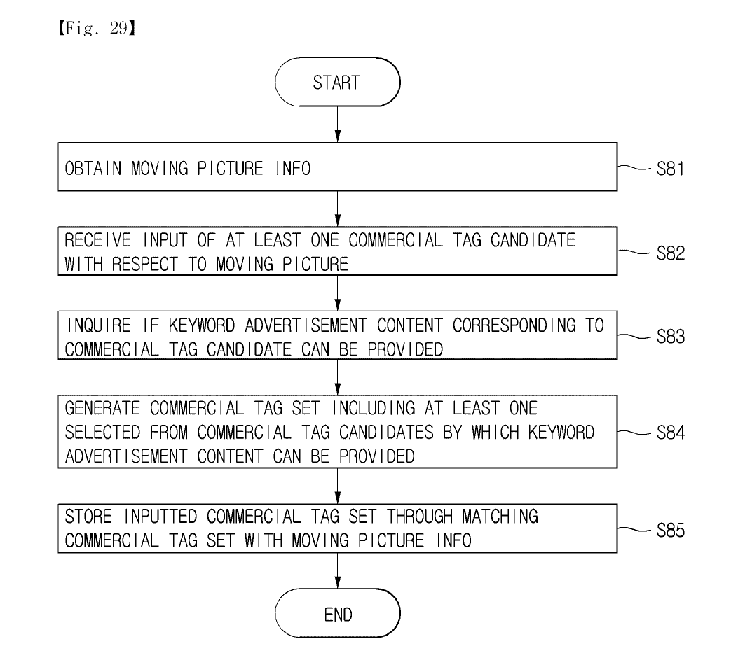

FIG. 28 illustrates the commercial tag set generation module 11000 according to an embodiment of the present invention. The commercial tag set generation module 11000 is included in the commercial tag set generation system 10000, so that an expert generating a commercial tag or a user participating in the generation of a commercial tag accesses the commercial tag set generation system 10000 and uses the commercial tag set generation module 11000 (the case in which various functions of the commercial tag set generation module 11000 are constructed in the Java script format and executed on the browser is included as a matter of course) or the commercial tag set generation module 11000 is downloaded from the commercial tag set generation system 10000 and installed on the user computer for use.

As shown in FIG. 28, the commercial tag set generation module 11000 includes the moving picture obtainment unit 11100, and when a search button is pressed, the commercial tag set generation module 11000 searches for the moving picture transmitted from the multimedia content service system 1000 or accesses the multimedia content service system 1000 to obtain moving picture information. It is a matter of course that through inputting the URL, URI, or UCI (Universal Content Identifier), the commercial tag set generation module 11000 can obtain moving picture information to be desired. For the easy access, it is preferable that the commercial tag set generation module 11000 searches for moving picture information by using conditions, such as at least a predetermined number of searching times or contents of a specific field, and obtains the moving picture information, and also displays a “commercial tag generation button” on a page displaying a moving picture only to a logging-in user with a commercial tag generator authority and opens a commercial tag generation window when a user clicks the “commercial tag generation button”.

The commercial tag set generation module 11000 includes the commercial tag input module 11210, and the commercial tag input module 11210 can be included in the user participation commercial tag set generation module 11300, as well as the expert selection commercial tag set generation module 11200. The expert selection commercial tag set generation module 11200 of the commercial tag set generation module 11000 includes a multimedia content ID display unit 11211, which is indicated as a moving picture information unit in the drawings and preferably includes a moving picture ID. The multimedia content meta information display unit 11218 displays a title, a tag, an explanation, etc. of the moving picture, and because the explanation is generally long, so that it is preferable to display the explanation when an explanation button is pressed.

In order to rapidly attach a commercial tag to a moving picture, etc., the commercial tag set generation module 11000 includes a content play unit 11212. In this case, an expert, etc. can advantageously easily input a commercial tag to the moving picture while viewing the moving picture played in the multimedia content play unit 11212. Further, a time selection unit for selecting two time points (start time point, end time point) is located under the multimedia content play unit 11212 for inputting a time dependent commercial tag. The time selection unit is preferably represented only when a time dependent tag generation is selected from kinds of commercial tags. When an expert, a participating user, or an operator of the multimedia content service system 1000 inputs a commercial tag, verifies the inputted commercial tag, and presses an input button, the commercial tag is registered in a commercial tag list. The verification of the commercial tag is preferably performed in the tag verification unit 11215. A commercial tag may be verified when a commercial tag is inputted in the commercial tag input unit 11213, but an entity or a part of at least one tag set registered in the commercial tag list also can be verified. Further, each, a selected part, or an entity of commercial tag lists (candidates) may be once verified or selectively verified. When a verification option button is pressed, the commercial tag set generation module 11000 presents verification references (the properties of 1) to 18), the score function, the difference function, etc. for an advertisement keyword) to be selected and verifies the commercial tag based on a selected reference. A verification result includes information of 1) whether to include the verified commercial tag in the verified commercial tag list and information of a rank (an order) of a commercial tag lists based on the selected reference. A commercial tag set indication unit 11214 can be divided into a commercial tag list candidate unit and a verified commercial tag list unit, but a single commercial tag list candidate unit is enough for implementing the spirit of the present invention.

When the time dependent commercial tag generation unit 11216 is operated, various commercial tags of the commercial tag list includes time zone information (start time point information, end time point information) corresponding to the commercial tag. When the user selects the time dependent tag generation (which may have been selected in default or may be only included) and selects/inputs time zone information, and a commercial tag is inputted through the commercial tag input unit 11213, the time dependent commercial tag generation unit 11216 stores both the commercial tag and the selected/inputted time zone information.

An embodiment of storing a commercial tag will be described below.

First, An example of a time dependent commercial tag table is represented in Table 7. It can be noted that different commercial tags and different time zones are stored for the same moving picture ID 103468.

TABLE 7

| Moving | | | | |
|---|---|---|---|---|
| picture | Scene | Start time | End time | Commercial |
| ID | No. | point | point | tag |
| 103468 | | 0:01:35.136 | 0:01:48.458 | Authenticated ink, refill ink |
| 103468 | | 0:01:49.000 | 0:05:10.000 | HP printer |
| 103479 | 17 | | | ACE bed, RENOMA |
| | | | | bedclothes, Livart furniture |

Table 8 represents an example of a time independent commercial tag table.

TABLE 8

| Moving picture ID | Commercial tag |
|---|---|
| 103468 | Authenticated ink, refill ink, HP, Epson, Cannon, |
| | Samsung, printer, multifunction apparatus |

Next, the commerciality information and commerciality verification information will be described. The commercial tag verification unit 11215 of the commercial tag set generation module 11000 generates commerciality information or commerciality verification information for commercial tags, such as “authenticated ink” and “refill ink” represented in table 8, subjected to the verification. Table 9 represents an example of the commerciality information and the commerciality verification information. The commercial tag verification unit 11215 may treat keyword advertisement target texts like commercial tags or commercial tag candidates, to identically generate commerciality information for each of the keyword advertisement target texts. In this case, a content appropriateness of Table 9 will be automatically calculated or inputted.

TABLE 9

| | Commercial | | | | | | | | |
|---|---|---|---|---|---|---|---|---|---|
| | tag ID | Commercial | | | | | | | |
| | (keyword | tag (keyword | | | | | | | |
| Moving | advertisement | advertisement | Advertisement | | | | | Commerciality | |
| picture | target | target | unit | | Score | | Content | (verification) | Application |
| ID | text ID) | text) | price | . . . | function i | . . . | appropriateness | information | rank |
| 103468 | 103468-1 | Authenticated | 200 | | 300 | | 70% | 210 | 5 |
| | | ink | | | | | | | |
| 103468 | 103468-2 | Refill | 500 | | 800 | | 90% | 720 | 1 |
| | | ink | | | | | | | |

The commercial tag verification unit 11215 of Table 9 generates commerciality verification information by the properties (property values) of 1) to 18), a function value of at least one score function i, etc. With regard to this, a person inputting a commercial tag (candidate) can input a content appropriateness, which is information of a relation degree between a multimedia content (including other contents) corresponding to the commercial tag and the commercial tag. For example, in Table 9, the commerciality verification information was generated by multiplying a value of the score function i of the commercial tag by a value of a content appropriateness. When there are n commercial tags or n commercial tag sets for a single moving picture or a single time zone (in a case of a time dependent commercial tag), the commercial tag verification unit 11215 can calculate an application rank of n commercial tags or n commercial tag sets to the moving picture or the time zone. For example, the application rank can be processed by commerciality verification information. When the n commercial tags or n commercial tag sets have the application ranks, the keyword advertisement control module 6900 considers the application rank and preferentially utilizes a commercial tag having the higher application rank for obtaining a keyword advertisement content. Table 9 is an example of the time independent commercial tag, but can be equally applied to the time dependent commercial tag, because the “time dependent commercial tag set” conceptually is the “time independent commercial tag set”+the “time zone information”. The time dependent commercial tag generation unit 11217 requires time zone information.

Any one of the multimedia content service system 1000, the meta information based keyword advertisement intermediation system 2000, and the keyword advertisement content providing system 3000 synchronizes the reproduction of the moving picture with a time dependent commercial tag including the time zone information and the indication of a keyword advertisement content corresponding to the time dependent commercial tag, to display the keyword advertisement content on the user computer. When the transmission button is pressed, the commercial tag set transmission module 12000 is operated and transmits the generated commercial tag set to any one of the multimedia content service system 1000, the meta information based keyword advertisement intermediation system 2000, and the keyword advertisement content providing system 3000 or a preset server.

Hereinafter, a method for generating a commercial tag set by the commercial tag set generation system 10000 will be described in more detail.

The method for generating a commercial tag set by the commercial tag set generation system 10000, which generates at least one commercial tag set for a moving picture, includes the steps of (A) obtaining moving picture information (S81), (B) receiving an input of at least one commercial tag candidate for the moving picture (S82), (C) inquiring if a keyword advertisement content corresponding to the commercial tag set can be provided (S83), (D) generating at least one commercial tag selected from the commercial tag candidates corresponding to the commercial tag set to be provided as a commercial tag set (S84), and (E) corresponding the generated commercial tag set to the moving picture information and storing the inputted commercial tag set (S85). It is preferred that the moving picture information includes ID information for a moving picture, the access to the moving picture file can be allowed by moving picture ID information, and the moving picture file can be downloaded or streamed.

In the step (C), the commercial tag set generation system 10000 inquires of at least one of the advertisement keyword DB 6570 and the keyword advertisement content providing server-side advertisement keyword DB 3140 of the keyword advertisement content providing system 3000. The advertisement keyword DB 6570 and the keyword advertisement content providing server-side advertisement keyword DB 3140 include at least one of 1) name data of a good or a service, 2) an advertisement keyword list of at least one advertiser obtained from the keyword advertisement content providing system and registered in the keyword advertisement content providing system, 3) a keyword advertisement target text list creating advertisement gains, and 4) a generated advertisement keyword list generated by the multimedia content service system 1000 or the keyword advertisement content providing system 3000 by itself or obtained from a third person. The advertisement keywords registered in the advertisement keyword DB 6570 and the keyword advertisement content providing server-side advertisement keyword DB 3140 correspond to at least one meta information. The meta information includes at least one selected from, with respect to the advertisement keywords, 1) the total number of exposures/the total number of calls, 2) an increase/decrease rate of the total number of exposures/calls, 3) the total number of advertisers, 4) an average advertisement unit price, 5) the highest advertisement unit price, 6) the lowest advertisement unit price, 7) the average number of advertisers, 8) the average number of keyword advertisement contents, 9) an increase/decrease rate of the average number of advertisers, 10) an increase/decrease rate of the average advertisement unit price, with respect to keyword advertisement contents related to the advertisement keyword, 11) the number of exposures, 12) a click generation rate of the relevant keyword advertisement content with respect to exposures, 13) the total number of clicks, 14) a generated advertisement profit, 15) an increase/decrease rate of the number of exposures, 16) an increase/decrease rate of a click generation rate with respect to exposures, 17) an increase/decrease rate of the total number of clicks, and 18) an increase/decrease rate of a generated advertisement profit. The expression of “properties of 1) to 18)” or “1) to 18)” of the present specification means the items of 1) to 18) of this paragraph unless it refers to the specific item.

The inquiry includes the verification. When the commercial tag candidate is included in the advertisement keyword DB 6570 and satisfies a preset reference of at least one of the meta information of 1) to 18) corresponding to the advertisement keyword of the advertisement keyword DB 6570, the commercial tag candidate is generated as a commercial tag set.

In the step (D), the commercial tag set generation system 10000 applies a score function of granting a score in a preset scheme to the commercial tag candidates, calculates a score function value, and selects a commercial tag having a preset score function value or higher.

In the step (C), the commercial tag set generation system 10000 inquires of a search system providing at least one preset search service. The reference of selection in the step (D) is whether at least one keyword advertisement content is included in a search result of the search system.

The commercial tag set includes at least one time independent commercial tag. The time independent commercial tag does not preferably include time information in information constituting the tag.

The commercial tag set includes at least one time dependent commercial tag. The time dependent commercial tag preferably includes time information in information constituting the tag.

The time information includes two kinds of time point information and the two kinds of time point information are start time point information and end time point information.

The commercial tag includes at least one of a name of a good or a service and a brand of a good or a service.

Tag information constituting commercial tags included in the commercial tag set include at least two fields and the tag information is stored in the unit of the field.

In the step (B), the commercial tag set generation system 10000 receives an input of at least one commercial tag candidate according to each of commercial tag input subjects and performs the step (C) for a commercial tag candidate according to each of commercial tag input subjects.

The method for generating a commercial tag set by the commercial tag set generation system 10000 includes a step of transmitting the commercial tag. The moving picture information is transmitted from the multimedia content service system 1000 and the commercial tag is transmitted to the multimedia content service system 1000. The commercial tag set generation system 10000 is included in the multimedia content service system 1000 or is connected with the multimedia content service system 1000 through a wired/wireless network.

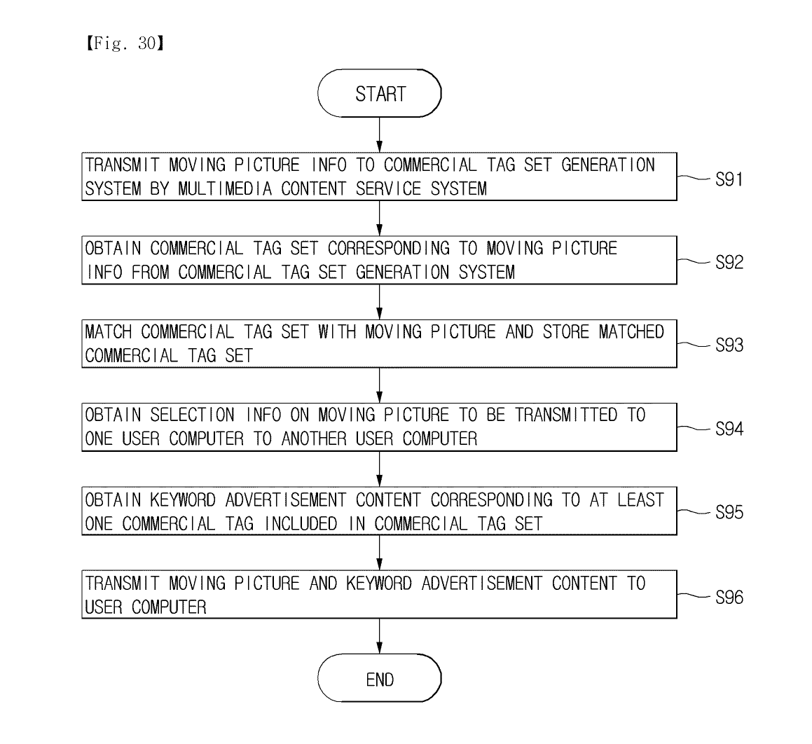

The method for providing a keyword advertisement service by the multimedia content service system 1000 using the commercial tag set generation system 10000 according to an embodiment of the present invention will be described with reference to FIG. 30.

The multimedia content service system 1000 including the multimedia content service server transmitting a moving picture selected by a user to the user computer 9000 includes the steps of: transmitting moving picture information to the commercial tag set generation system 10000 by the multimedia content service system 1000 (S91); receiving a commercial tag set corresponding to the moving picture information from the commercial tag set generation system 10000 (S92); corresponding the commercial tag set to the moving picture, to store the commercial tag set (S93); receiving selection information of a moving picture to be transmitted to the user computer 9000 from the user computer 9000 (S94); receiving a keyword advertisement content corresponding to at least one commercial tag included in the commercial tag set (S95); and transmitting the moving picture and the keyword advertisement content to the user computer 9000 (S96). The commercial tag set includes at least one time dependent commercial tag and the time dependent commercial tag includes time information in information constituting the tag.

The time information includes two kinds of time information of start time point information and end time point information. The keyword advertisement content corresponding to the time dependent commercial tag is displayed between the two time information related to the moving picture during the reproduction of the moving picture.

Verification of Commercial Tag Information

When the number of stored commercial tag information mapped/corresponding to a single moving picture are more than one, value of the commercial tags may be varied according to the passage of time. Therefore, multimedia content service system 1000 re-evaluates the commerciality of the commercial tags (an advertisement unit price, an expected profit rate, etc.) by 1) a scheme of inquiring of the advertisement keyword DB 6570 or the keyword advertisement providing system 3000 about the commercial tags in the unit of a preset time and 2) a scheme of inquiring of the advertisement keyword DB 6570 or the keyword advertisement providing system 3000 about the commercial tags when the moving picture is called by the user computer, and performs the spirit of the present invention by using at least one selected commercial tag serving as meta information based on the re-evaluated commerciality.

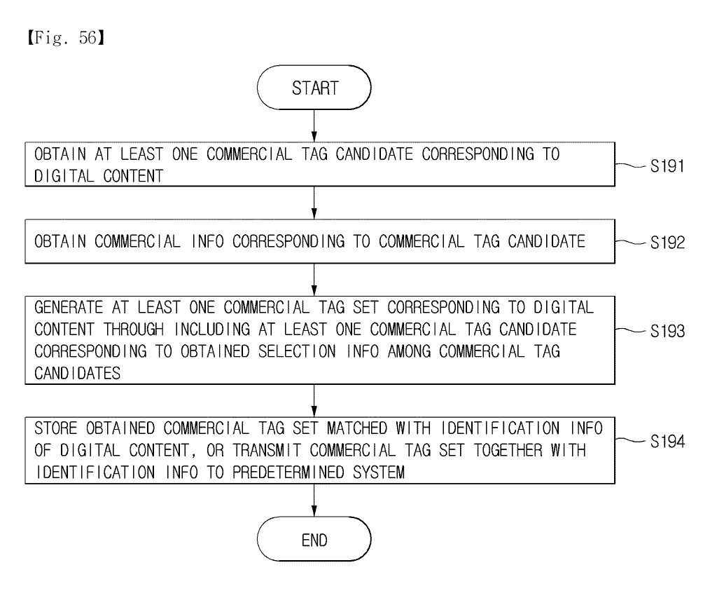

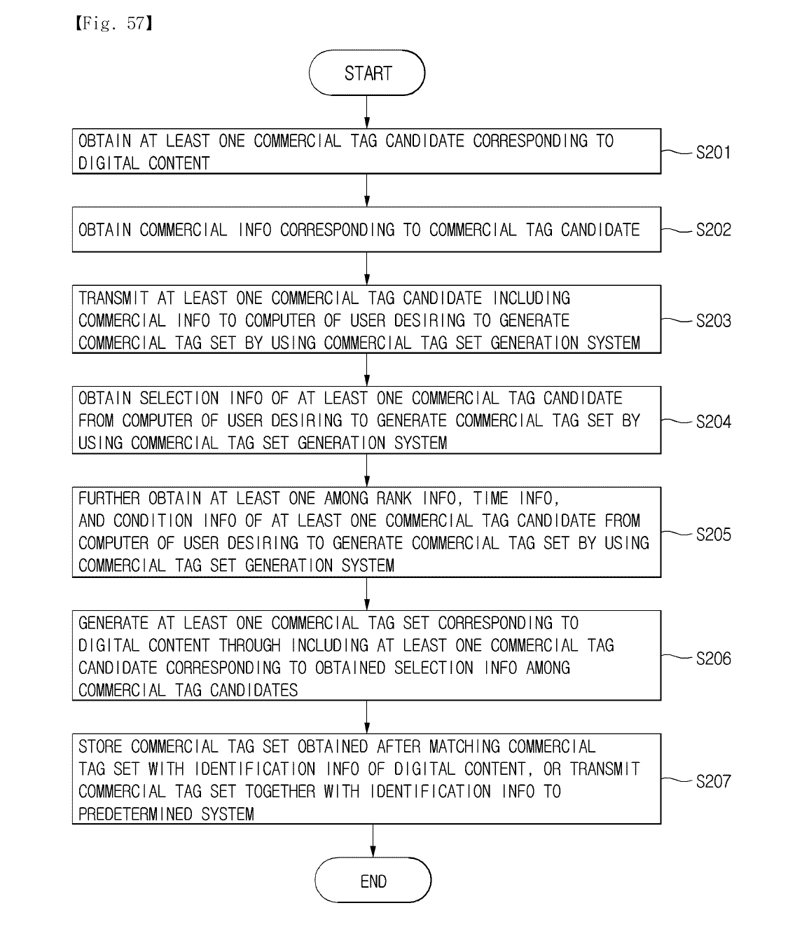

Next, a method of processing information of a general digital content by the commercial tag set generation system 10000 will be described with reference to FIGS. 56 and 57 in more detail. The commercial tag set generation system 10000 generates at least one commercial tag set for a digital content.

As can be noted in FIG. 56, a method of generating at least one commercial tag set corresponding to a digital content by the commercial tag set generation system 10000 includes the steps of (A) receiving at least one commercial tag candidate for the digital content (S191), obtaining commerciality information of the commercial tag candidate (S192), (C) generating at least one commercial tag set for the digital content including at least one commercial tag candidate corresponding to the received selection information among the commercial tag candidates (S193), and corresponding identification information of the digital content to the obtained commercial tag set, to store the commercial tag set, or transmitting the commercial tag set together with the identification information to a preset system (S194). The commercial tag set includes at least one commercial tag belonging to a category of a tag and the commercial tag guarantees an existence of at least one keyword advertisement content corresponding to the commercial tag at least one time of the commercial tag generation time or a time of calling a keyword advertisement with the commercial tag through the keyword advertisement content providing system 3000. The tag includes at least one text string from a name of a good, a service name, a proper noun, and a keyword registered in the keyword advertisement content providing system 3000 by an advertiser. The preset system subjected to receiving the commercial tag set in the step (D) includes the content producer system 15000, the content circulator system 16000, the content distributor system 1000-1, the keyword advertisement content providing system 3000, the user computer 9000, a preset program executed in the user computer 9000, the multimedia content service system 1000, a broadcasting service system 13000 for providing the user computer 9000 with a broadcasting content, a digital publication service system 32000 for providing the user computer 9000 with a digital publication, a media service system 31000 for providing the user computer 9000 with a media service, a content syndication system 20000 involving circulation or transference of a digital content, etc.

An information processing method by the commercial tag generation system 10000 will be described with reference to FIG. 57 in more detail.

The information processing method by the commercial tag generation system 10000 includes the steps of: receiving at least one commercial tag candidate for the digital content (S201); obtaining commerciality information for the commercial tag (S202); (B-1) transmitting at least one commercial tag candidate including the commerciality information to a computer to generate a commercial tag set (S203); (B-2) receiving selection information of at least one commercial tag set candidate from a computer to generate a commercial tag set (S204); and (B-3) additionally receiving at least one of rank information, time information, and condition information of at least one commercial tag set candidate from a computer to generate a commercial tag set (S205). Further, the information processing method by the commercial tag generation system 10000 further includes the steps of generating at least one commercial tag set for the digital content including at least one commercial tag candidate corresponding to the obtained selection information among the commercial tag candidates (S206) and corresponding identification information of the digital content to the obtained commercial tag set to store the commercial tag set, or transmitting the commercial tag set together with the identification information to a preset system (S194).

In the step (C), the commercial tag generation system 10000 generates the commercial tag set through corresponding commercial tag candidates corresponding to the obtained selection information to the obtained application rank information, application time zone information, and application condition information, and stores the commercial tag set. Further, in the step (A) of receiving at least one commercial tag candidate for the digital content, when a text content is included in the digital content, the commercial tag generation system 10000 analyzes the text content, extracts at least one commercial tag candidate from the text content, and obtains the extracted commercial tag candidate, so as to processes the information.

Change of Search Result Rank

Next, the multimedia contents are generally exposed to a user in a scheme, in which when a user first inputs a search word or clicks a tag, etc., the multimedia content corresponding to the search word or the tag serving as a search keyword is searched in a search engine established for multimedia content data or the DBMS for multimedia content data and the multimedia content satisfying an inquiry result is outputted. The user clicks the outputted search result of the multimedia content, so as to select the multimedia content. At this time, the total number of multimedia contents, multimedia contents exposed on the first page, and a rank of multimedia contents exposed on the same page are determined according to the large number of user clicks or a preset weight or rank policy selected by a person managing other multimedia content DB 1110.

With regard to this, in order to maximize the profits of the multimedia content service system 1000, the meta information based keyword advertisement intermediation system 2000, or the keyword advertisement content providing system 3000, it is helpful to preferentially arrange multimedia contents corresponding to a generated click of a keyword advertisement content, 2) multimedia contents corresponding to a generated click of a keyword advertisement content having a high advertisement unit price, and 3) multimedia contents related to a keyword advertisement content having a high click rate with respect to exposures. This is because the users often select multimedia contents arranged in a front part of the first page. Therefore, when multimedia contents having the high expected profitability are arranged on a rank/order/location/page having the high selection probability of the user, the users select and view the multimedia content and thus are highly possible to click the keyword advertisement content exposed on a preset location during the viewing or the completion of the multimedia content. Meanwhile, when multiple keyword advertisement contents are exposed, if the keyword advertisement contents having a high click rate with respect to exposures or a high expected profit rate based on the existing users are presented to the users, the possibility of the creation of the advertisement profit may be high.

To this end, the commercial tag generation system 10000 stores at least one of 1) a keyword advertisement content identifier corresponding to a generated click for each of specific multimedia contents and 2) a keyword advertisement target text or a keyword advertisement target text group corresponding to a generated click for each of specific multimedia contents, and when a keyword advertisement content for each of specific keyword advertisement target texts or keyword advertisement target text groups, or related to a specific multimedia content is exposed, 3) the total number of clicks of the keyword advertisement content, 4) the total advertisement profits of the keyword advertisement content, 5) a click rate in comparison with exposures of the keyword advertisement content, 6) an average profit in comparison with exposures of the keyword advertisement content, 7) an expected click rate in comparison with exposures of the keyword advertisement content (which may have the same value of 5)), and 8) an expected profit in comparison with exposures of the keyword advertisement content ((which may have the same value of 6)). The commercial tag generation system 10000 can calculate an expected profit of each of specific multimedia contents through processing at least one of 1) to 8) serving as a variable in a preset profit contribution function. For example, the profit contribution function f(i) for a specific multimedia content i represents the total advertisement profits for keyword advertisement contents corresponding to a specific advertisement target text j of a specific multimedia content i, the total number of clicks related to a specific multimedia content i in comparison with exposures of the specific multimedia content i, or the sum (an advertisement unit price of a keyword advertisement content jk corresponding to a specific advertisement target text j of a specific multimedia content i*a click rate in comparison with exposures of the specific multimedia content i). The sum represents the total. As such, through calculating an expected profit of each of the multimedia contents i, the commercial tag generation system 10000 preferentially exposes multimedia contents having a high value of the profit contribution function among search results of multimedia contents corresponding to the same search word input or satisfying the same tag as a search result, or uses a value of the profit contribution function for the determination of an exposure order/location/rank/page of the multimedia contents. That is, with respect to the same search keyword, the commercial tag generation system 10000 can 1) preferentially expose multimedia contents having the high expected profit as a search result, and 2) even if the search result includes multimedia contents corresponding to a search word included in a field of the lower weight, but the expected profit of the multimedia content is high (in general, in the case of the application of a field weight, when a search keyword corresponds to a title, the weight is high, and when a search keyword corresponds to an explanation, the weight is relatively low), reflect a degree of the profitability and adjust an exposure priority.

It has been verified again that the calculation of an expected profit of a specific multimedia content i and the determination of an exposure order of the multimedia content based on the expected profit are essentially different from the search keyword advertisement according to the spirit of the present invention. That is, the conventional search keyword advertisement has only the connection of the search word input with a specific content, but cannot accumulate an advertisement effect generated from a specific content, because the conventional search keyword advertisement arranges keyword advertisement contents on the same page of a specific content of a search result, so that it is difficult to set the profit contribution function between the keyword advertisement content and the specific content.

Next, a method and a system for syndicating (circulating) a content by using a commercial tag will be described. The method for syndicating a content by using a commercial tag of the present invention relates to an exposure of a keyword advertisement content related to the commercial tag to a user viewing the content by using a commercial tag of the present invention based on the conventional content syndication method.

Currently, the illegal circulation of contents, which does not pay a reasonable cost to a person including a copyright holder having a proper right for contents, on the Internet or through an off-line medium, such as DVD, has explosively increased. The sharing, transmission, copying of the illegal contents spread in on-line or off-line, as well as P2P so that it obstructs the legal circulation of the contents. In this respect, a lawful paying circulator of contents, as well as a creator of a content, cannot obtain the lawful profits, so that the development of the content industry is at a standstill.

Further, the user recognizes that the internet is free and is insensible to the use of the illegal content on on-line, and the services, such as www.google.com and www.youtube.com, allowing the free access to qualified contents, spreads, so that the user shows the severe rejection response to the payment of the reasonable amount for the contents use.

In this respect, the present invention aims to contribute to allowing the users to use the contents for free or at an extremely small cost through distribution of advertisement profits based on a commercial tag closely related to a content and activating the circulation of the contents. Therefore, the burden or cost of the user for using the contents is none or extremely small, so that the contents use will be activated and the content producer system 15000, a processor, a circulator, etc. can receive the reasonable profit according to the contribution of the content use.

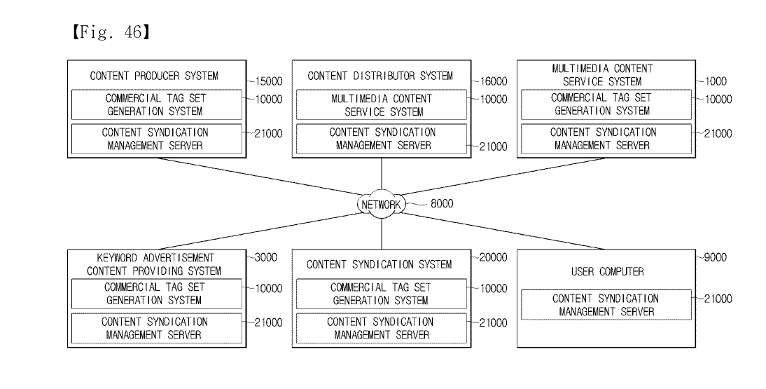

FIG. 46 illustrates the conventional content syndication model.

At least one of the content producer system 15000, the content circulator system 16000, and the content distributor system 1000-1 (The multimedia content service system 1000 of the present invention is a system for providing contents to the user computer 9000 so that it corresponds to the content distributor system 1000-1. The content distributor system 1000-1 is a higher concept of the multimedia content service system 1000. When the content distributor system 1000-1 distributes multimedia contents to the user computer 9000, the content distributor system 1000-1 and the multimedia content service system 1000 are of the same. Hereinafter, a reference number of the content distributor system 1000-1 is denoted as 1000-1 according to an extension of a reference number of the multimedia content service system 1000. The reference numbers of 1000 and 1000-1 of the present invention denote a system capable of providing the user computer 9000 with multimedia contents.) involves the transmission of a single content to the user computer 9000. For example, the content producer system 15000 includes a newspaper company when the content is news, a broadcasting system when the content is a broadcasting (an outside producing company when a broadcasting content is produced by an outside company or a broadcasting station providing a product produced by the outside producing company), a record company (a subject recording sounds, etc.) when the content is a music, an individual or a small group when the content is generated by an individual or a small group, such as UCC or PCC. A category of the content producer system 15000 includes a person adding additional information to contents, creating additional values, or generating an additional/dependent work/content, such as a person generating a second work with a content/work of another person or a person adding at least one meta information to a content/work of another person. The content circulator system 16000 represents a person circulating a content produced by at least one content producer system 15000 for the use of a third party, and the third party may be the content distributor system 1000-1. The content distributor system 1000-1 represents a person providing a terminal of a user with a content. The conventional content syndication model further includes a copyright relevant system in relation to the content circulation and a clearing system in relation to the conventional content syndication. However, the two systems are not important in the present invention, so that their descriptions will be omitted in the present invention, but the two systems are not excluded from the spirit of the present invention.

At least two of the content producer system 15000, the content circulator system 16000, and the content distributor system 1000-1 may be the same subject. If the content producer system 15000, the content circulator system 16000, and the content distributor system 1000-1 for the same content are different, they can be operated by the same object according to a circulation route of the content. For example, when a newspaper company (the content producer system 15000) running www.ABC.com directly provides the user computer 9000 with the news, www.ABC.com corresponds to both the content producer system 15000 and the content distributor system 1000-1. Further, when www.ABC.com provides the user computer 9000 with news published by another news company or provides contents generated by another content producer system 15000 through its site, www.ABC.com is the content distributor system 1000-1. Further, when www.ABC.com provides a portal site of www.AAA.com with a news article, www.ABC.com is the content circulator system 16000.

When a content is transferred from a producer, a circulator, and the distributor system 1000-1 to the user, a method of transferring a content of the present invention includes at least one method of 1) transferring a content data itself and 2) transferring point information of a content data. In the method 1) of transferring the content data itself, the content data is physically transmitted and the transmitted content data is stored. A side receiving the content data performs at least one of 1) and 2) from one's server system to another system/server. In the method 2) of transferring point information of the content data, the content data is not physically transmitted, but point information (location information, URL, URI, address information, etc.) capable of accessing the content data is transferred, and a system/server receiving the point information can access the content data through the received point information. For example, it is assumed that a single news content page transferred to the user computer 9000 includes text, a single image, and a single moving picture produced by a producer, circulated by a circulator, and distributed by the distributor system 1000-1 to the user computer 9000. With regard to this, each of the steps of transferring the text data, the image data, and the moving picture data includes at least one of 1) and 2). That is, when the text data is transferred to the circulator and the distributor system 1000-1, the image and the moving picture are left in a server of the producer, and the text data includes the point information (URL, etc.) of the server of the producer for the image and the moving picture, a browser of the user computer 9000 obtains the text from the distributor system 1000-1 and the image and the moving picture from the server of the producer, to constitute a single image and display the image to the user.

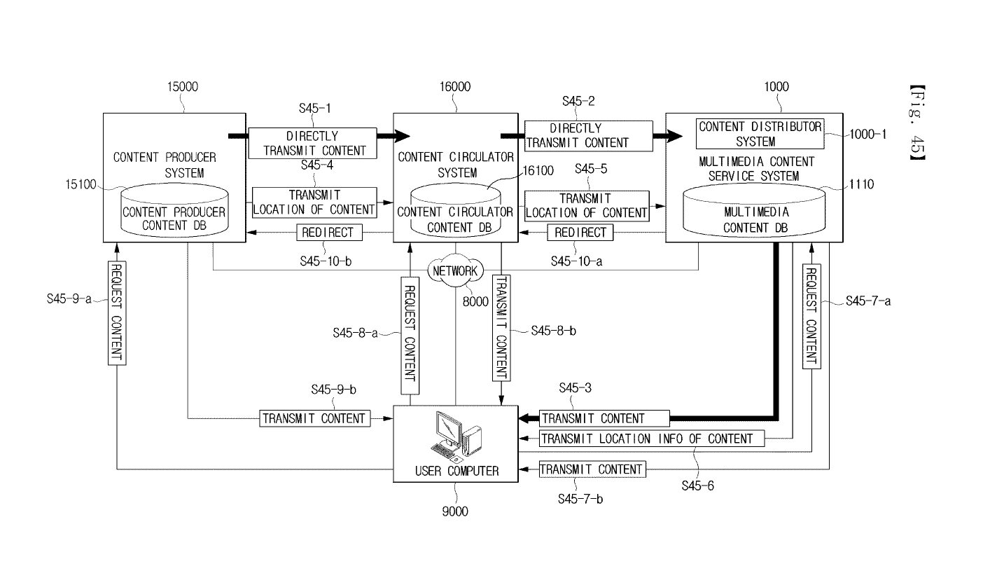

Next, the method of syndicating a content by using the commercial tag according to the present invention will be described with reference to FIG. 46. In order to implement the present invention, in addition to the construction of FIG. 45, the content syndication model further includes 1) the keyword advertisement content providing system 3000 necessary for obtaining keyword advertisement contents by using a commercial tag and 2) a content syndication system performing a content syndication function of the present invention in relation to a commercial tag (the content syndication system may include the content producer system 15000, the content circulator system 16000, and the content distributor system 1000-1, and the content syndication system distributes contents to the user computer 9000, so that the content distributor system 1000-1 is a representative example). The user computer 9000 and the keyword advertisement content providing system 3000 are not the existing content syndication system.

The content syndication system includes a dependent content syndication system included in the user computer 9000 and the keyword advertisement content providing system 3000 and an independent content syndication system independent of and separated from the user computer 9000 and the keyword advertisement content providing system 3000.

The method of the content syndication by using a commercial tag should consider 1) a management of a commercial tag (the management of the commercial tag mainly includes a method of including/connecting/linking a commercial tag in/to a multimedia content and a method of controlling a commercial tag) and 2) a clearing of an advertisement profit.

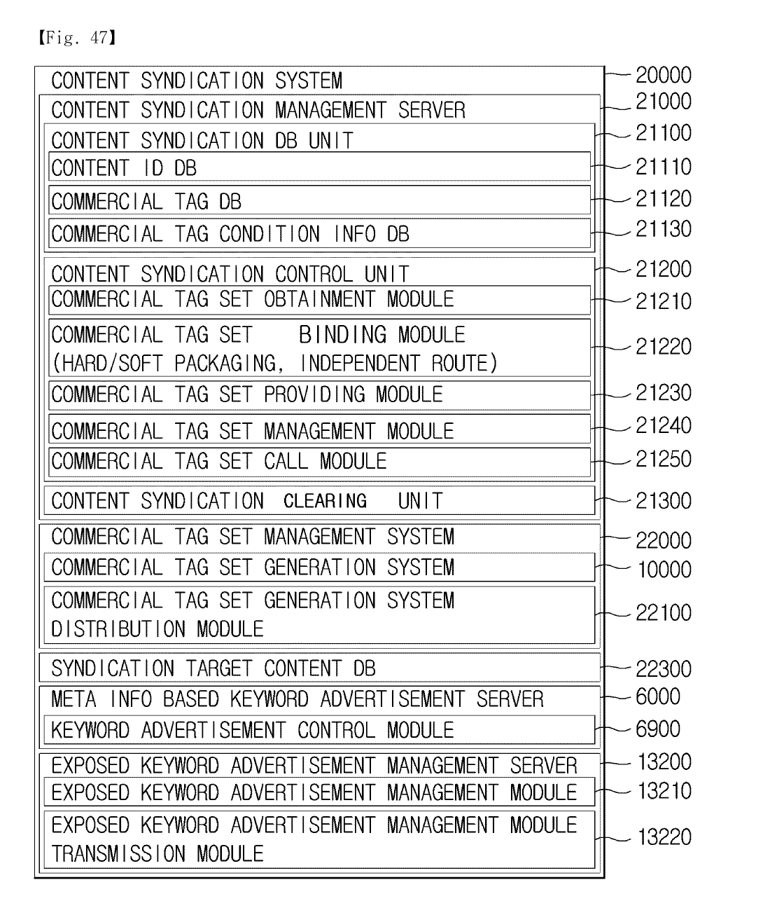

FIG. 47 illustrates the content syndication system according to an embodiment of the present invention. The content syndication system includes a content syndication management server 21000 for managing the content syndication. As can be noted in FIG. 46, the content producer system 15000, the content circulator system 16000, the multimedia content service system 1000, the user computer 9000, and the keyword advertisement content providing system 3000 can manage the content syndication, so that those systems may include the content syndication management server 21000 serving as their one element. The content syndication management server 21000 managing the content syndication includes a content syndication DB 211100 and a content syndication control unit 21200, and selectively includes a content syndication clearing unit 21300. The content syndication DB 211100 includes a commercial tag DB 21120 in relation to commercial tag data and further includes a content ID DB 21110 in relation to content ID data and a commercial tag condition information DB 21130 in relation to various conditions to which a commercial tag is applied. Commercial tag information stored in the commercial tag DB 21120 includes at least one of 1) n commercial tag set including at least one commercial tag (wherein n is a natural number), 2) location information of the commercial tag set data, and 3) various meta information (to be described later) of the commercial tag or the commercial tag set. Various data of 1) to 3) of the commercial tag DB 21120 can be one-to-one corresponded to a single specific content or a specific content set. A key value for calling individual information of 1) to 3) may be the content ID.

The content syndication control unit 21200 performs various controls related to the content syndication, and selectively further includes the following detailed function modules. The functions of the content syndication control unit 21200 will be described in several parts of the present specification in more detail.

The content syndication control unit 21200 further includes a commercial tag set calling obtainment module for obtaining calling/request information of a commercial tag set from an outside system. At this time, the commercial tag set calling obtainment module can receive a commercial tag set request through a content ID. At this time, the content syndication control unit 21200 inquires of the content syndication DB 211100 about the content ID and provides at least one commercial tag set corresponding to the content ID to the outside system (it is a matter of course that the content syndication control unit 21000 further includes the content ID or an identifier appointed with other outside systems and provides the commercial tag set). A commercial tag set providing module 21230 provides the commercial tag set. With regard to this, the content syndication control unit 21200 inquires of the commercial tag condition information DB 21130 about whether a special condition in relation to the content ID or the commercial tag set is added. When the specific condition information is added, the content syndication control unit 21200 includes the necessary condition information among the added condition information and provides the commercial tag set together with the necessary condition information to the outside system. When the content syndication control unit 21200 provides the commercial tag set, the content syndication control unit 21200 1) preferably includes information indicating that the commercial tag set is provided by the content syndication system, and 2) more preferably includes an identifier for each of the commercial tag sets or the commercial tags, and 3) preferably records and manages various log information related to a request of a commercial tag set from the outside system. Information, such as 1) to 3) may be required for several purposes of the clearing of an advertisement profit created when a keyword advertisement content related to the commercial tag is exposed or clicked, and the collection, measurement, and trace of an advertising effect.

The content syndication control unit 21200 further includes a commercial tag set binding module 21220. The commercial tag set binding module 21220 binds content information and commercial tag set information.

Content information subjected to the binding includes at least one of 1) content data itself, 2) a content ID, and 3) any data, such as content location information, related to a content provided for the purpose of binding. Commercial tag set information subjected to the binding includes at least one of 1) commercial tag set data itself, 2) a commercial tag set ID, 3) commercial tag set location information, and 4) various meta information related to a commercial tag set. Each of them can be bound with another one by one-to-one or one-to-n. The binding includes a soft binding and a hard binding, which will be described later. The commercial tag set binding module 21220 is more closely related with a package model of the content syndication model and may be partially used in an independent route model to be described later.

Circulation Model of Multimedia Content and Commercial Tag

A person connecting a commercial tag set to a single content corresponds to at least one of an operator of the content producer system 15000, the content circulator system 16000, or the content distributor system 1000-1 and a third party (advertisement expert) related with the operator. That is, at least one subject can connect/correspond a commercial tag set related to the multimedia content to the multimedia content during the circulation of the multimedia content. At this time, the multimedia content may be hard bound or softly bound with the commercial tag set. The hard binding means the multimedia content is mostly transmitted together with the commercial tag set during the information transmission after the connection/correspondence of the multimedia content and the commercial tag set, which is referred to as a package model (the transmission of the multimedia content together with the commercial tag set includes a first model of transmitting a multimedia content data together with a commercial tag set and a second model of transmitting multimedia content data location information capable of calling the multimedia content data together with commercial tag set data location information capable of calling the commercial tag set data). The soft binding means that the multimedia content and the commercial tag set are separately stored in an independent system or separately transmitted, which is referred to as an independent route model. The location information represents the URL, URI, address information or point information of data, etc., which can obtain specific information (data).

First, the package model will be described. A single multimedia content corresponds to at least one commercial tag and/or commercial tag set (a set includes oneself as an element according to the viewpoint of the set theory). With respect to a multimedia content and a commercial tag set (CTS=Commercial Tag Set, CT=Commercial Tag(s)), the multimedia content is packaged with the CT. According to the package model, when the multimedia content itself is transmitted or copied from the content producer system 15000 to the content circulator system 16000 and/or the content distributor system 1000-1, the commercial tag set is packaged with the multimedia content, to be transmitted/copied. The content producer system 15000 does not include a commercial tag, but the content circulator system 16000 first includes a commercial tag. In this case, the content circulator system 16000 first packages the multimedia content and a commercial tag. It is preferable to include a unique key value connecting the multimedia content and the commercial tag set for the packaging. It is apparent to those skilled in the art that the conventional technology related to the content syndication, such as DRM, is applied to the present invention, but this is not a characteristic of the present invention so that its description will be omitted.

Meanwhile, at least two subjects can independently include a commercial tag for a single multimedia content during the circulation of the multimedia content (the independent inclusion of the commercial tag includes the change of the existing commercial tag). For example, when the content producer system 15000 includes a commercial tag set CT1 in a multimedia content M and provides the multimedia content M to the content circulator system 16000, the content circulator system 16000 can include an independent commercial tag set CT2 in the multimedia content M, and further the content distributor system 1000-1 can include an independent commercial tag set CT3 in the multimedia content M.

A specific example of the package model will be described. When it is assumed that the content circulator system 16000, not the content producer system 15000, first corresponds a commercial tag to a multimedia content, the commercial tag and the multimedia content are first packaged by the content circulator system 16000. At this time, the packaged multimedia content and commercial tag are stored in the content circulator system 16000, the multimedia content and commercial tag stored in the content circulator system 16000 are transmitted to the content distributor system 1000-1, and the multimedia content is transmitted to the user computer 9000 through the content distributor system 1000-1 (e.g. a portal). Therefore, the commercial tag calling the keyword advertisement content is under the control of the content distributor system 1000-1 and the content distributor system 1000-1 can provide the keyword advertisement of the present invention by using the commercial tag.

The circulation of the content includes the transmission/copying the content data or the transmission/copying of location information of contents as a matter of course as described above. The package model of the present invention classifies into 1) a first package model circulating the bound content data and commercial tag data and 2) a second package model circulating bound location information of content data and location information of a commercial tag. When the second package model is used, at least one of 1) a method of controlling the advertisement method of the present invention by using the commercial tag the content distributor system 1000-1 and 2) a method of controlling the advertisement method of the present invention by using the commercial tag by a system storing the commercial tag is executed. For example, according to the method 1), the content distributor system 1000-1 provides a code (a code constituting a web page or a program including other scripts) to the user computer 9000, and inserts a program in the code, the program obtaining a commercial tag, transmitting the commercial tag to the keyword advertisement content providing system designated by the content distributor system 1000-1 and obtaining a keyword advertisement content, and exposing the obtained keyword advertisement content to the user computer 9000. For example, in the method 2), when the system accesses the stored commercial tag through a code provided from the content distributor system 1000-1 to the user computer 9000, the system storing the commercial tag provides a keyword advertisement content, which has been received through transmitting a commercial tag to the keyword advertisement content providing system 3000, not a commercial tag, to the user computer. That is, in the method 2), the system storing the commercial tag transmits the keyword advertisement content to the code, which has been provided from the content distributor system 1000-1 to the user computer 9000, and the code displays the received keyword advertisement content on a preset location of the user computer 9000 in a preset scheme.

In order to improve the efficiency of the circulation, it is preferable to process a content in a specific standard circulation format or a circulation format agreed upon between objects participating in the circulation. The construction of the package model according to an embodiment of the present invention will be described. The content package includes 1) content information+2) commercial tag information+3) information for management and information for circulation. It is preferably to be understood that the content information is conceptually included in the innermost side, the commercial tag information is included outside of the content information, and the information for management and information for circulation are included in the outermost side. When the content package is written in the XML format, with respect to a content part consisting of a multimedia content, such as a moving picture, a sound, or an image, not a text, location information capable of calling a content part including the multimedia content may be included as content information.

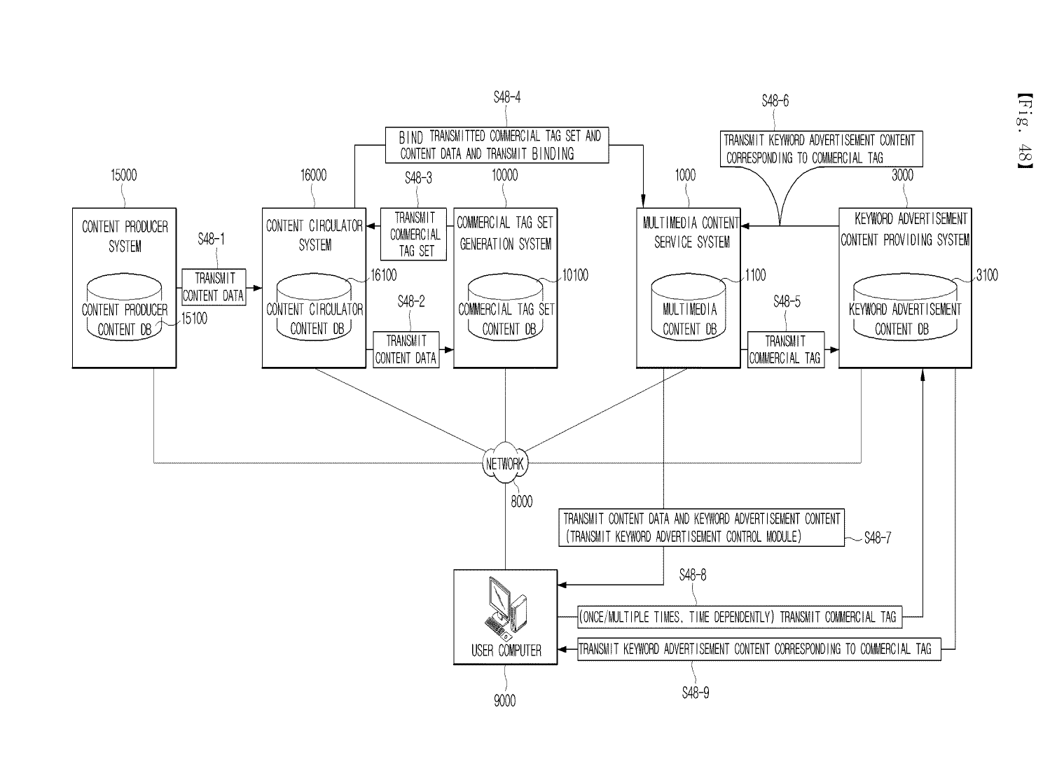

FIGS. 48 to 50 illustrate the package model according to the embodiment of the present invention.

Referring to FIG. 48, the content circulator system 16000 first binds commercial tag data and transfers the bound commercial tag data to the multimedia content service system 1000. FIG. 48 illustrates that the content circulator system 16000 and the multimedia content service system 1000 include the dependent content syndication system. It is important which system obtains a keyword advertisement content by using a commercial tag data. Who, when, how to obtain, transmit, and control a keyword advertisement content by using a commercial tag (or a keyword advertisement target text) have been variously described in the present specification, such as in the description of the role division model, and which is equally applied to the content syndication. The presentations of the drawings are merely an embodiment of the present invention. FIG. 48 exemplifies the binding of content data and commercial tag data, but it is only an example, and it is also possible to bind and circulate content address information and commercial tag set address information. At this time, the multimedia content service system 1000 or the user computer 9000 can obtain content data with the content address information and commercial tag data with the commercial tag set address information for use. The multimedia content service system 1000 obtains a keyword advertisement content and provides the user computer 9000 with the keyword advertisement content and a multimedia content. Otherwise, the user computer 9000 can obtain a keyword advertisement content by using a commercial tag data through the keyword advertisement content providing system 3000. The former model is more useful for the utilizing of the time independent commercial tag and the latter model is more useful for the utilizing of the time dependent commercial tag.

The second model is the independent route model. In the independent route model, the circulated multimedia content includes only location information storing a commercial tag capable of calling a corresponding commercial tag and a commercial tag is not physically and/or logically packaged with a multimedia content and independently exists. That is, regardless of the steps through which a multimedia content is circulated, when the independent route model is used, a commercial tag of a multimedia content is stored in at least one content syndication (independent content syndication or dependent content syndication) and the system using the multimedia content (the content producer system 15000, the content circulator system 16000, the content distributor system 1000-1 and/or the user computer 9000) can call a commercial tag corresponding to the multimedia content through the content syndication and use the commercial tag in the use of the multimedia content. If multiple subjects can correspond an independent commercial tag to a single multimedia content, at least one content syndication can be included in each of users (the content producer system 15000, the content circulator system 16000, and the content distributor system 1000-1) of contents corresponding to the independent commercial tag. It is preferable to circulate the first corresponded commercial tag corresponding to a single multimedia content for the convenience of management. It is a matter of course that as described above, the circulation of the content includes the transmission/copying of content data or the transmission/copying of location information of a content.

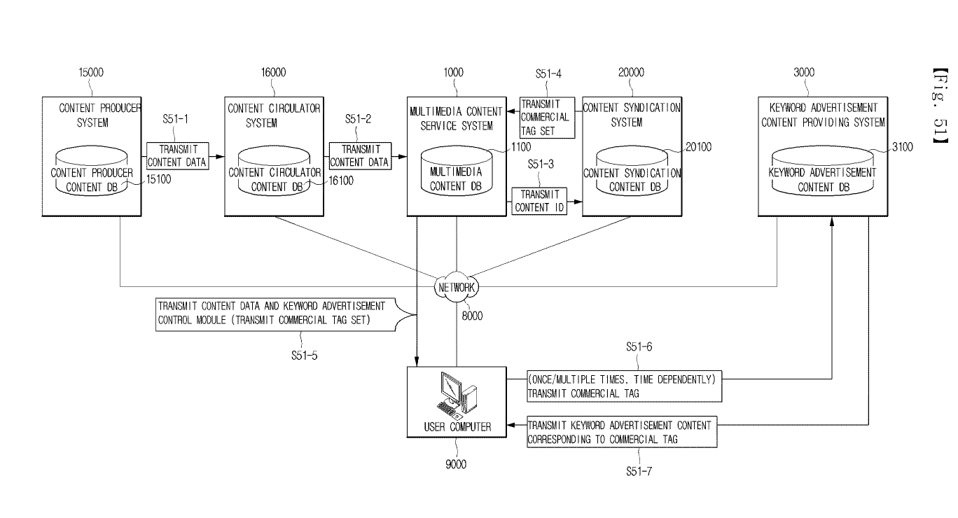

FIGS. 51 to 53 illustrate the independent route model according to an embodiment of the present invention, in which the user computer 9000 receives the commercial tag data from any one of the content producer system 15000, the content circulator system 16000, the multimedia content service system 1000, and the independent content syndication system when the user computer 9000 uses commercial tag data. For example, the user computer 9000 obtains information representing that location information of the commercial tag set data is a specific independent content syndication system from the multimedia content service system 1000 and obtains the commercial tag set data from the independent content syndication system by using the location information. At this time, the multimedia content data can be received from the content circulator system 16000, not from the multimedia content service system 1000. It has been described that the user computer 9000 obtains commercial tag set data from at least one of the content producer system 15000, the content circulator system 16000, the multimedia content service system 1000, and the independent content syndication system. However, in an equal principle, the multimedia content service system 1000 can obtain commercial tag set data from at least one of the content producer system 15000, the content circulator system 16000, and the independent content syndication system, and implement the spirit of the present invention.

Hereinafter, the independent route model will be described in more detail.

Descriptions will be given on several specific examples of the independent route model. The first example is assumed that the content circulator system 16000 (e.g. a broadcasting content circulation businessman), not the content producer system 1500, first corresponds a commercial tag to a multimedia content, a multimedia content is stored in the content producer system 15000 (e.g. a broadcasting station system), and the multimedia content is transmitted to the user computer 9000 through the content distributor system 1000-1 (e.g. a portal). When the user computer 9000 accesses the content distributor system 1000-1 and calls a specific multimedia content, the multimedia content is transmitted to the user computer 9000. For example, the content distributor system 1000-1 provides the user computer 9000 with a moving picture screen shot or a thumbnail, and when the user clicks the screen shot or the thumbnail, etc. having a link to the URL or URI capable of calling moving picture content, a browser of the user computer 9000 obtains moving picture content information according to the link. The moving picture can be obtained in a streaming scheme (a general name of a method of providing a moving picture piece in the unit of a piece by a server including moving picture data) or through the file download (a general name of a scheme of transmitting a moving picture file itself to the user computer 9000). At this time, when there exists information of a commercial tag corresponding to the multimedia content, the content distributor system 1000-1 can obtain a keyword advertisement content by using a commercial tag. The information of the commercial tag includes at least one of commercial tag data itself and location information of commercial tag data.

The multimedia content and the commercial tag can be independently controlled. A commercial tag is included in the content circulator system 16000 in this embodiment, so that an example of a method of obtaining a keyword advertisement content by using a commercial tag included in the content circulator system 16000 is the following. First, the content distributor system 1000-1 recognizing that the commercial tag is included in the content circulator system 16000 controls so as to obtain the commercial tag, transmit the obtained commercial tag to the keyword advertisement content providing system 3000, obtain a keyword advertisement content from the keyword advertisement content providing system 3000, and display the obtained keyword advertisement content on a preset location of the user computer 9000. The control can be performed through any one of or the combination of 1) a code (program) transmitted to the user computer 9000 by the content distributor system 1000-1 and 2) a method of first obtaining a keyword advertisement content, including the obtained keyword advertisement content in a screen page, constituting the screen page (e.g. a webpage) displaying the keyword advertisement content and a multimedia content, and transmitting the screen page to the user computer. When the commercial tag is a time dependent commercial tag, the control is preferably performed by the code 1). This is because when the time dependent commercial tag obtains a keyword advertisement content with a different type of a commercial tag according to the passage of time or uses the HTTP protocol, etc., the connection between the content distributor system 1000-1 and the user computer 9000 is interrupted after the content distributor system 1000-1 transmits requested information to the user computer 9000. It is a matter of course that the content distributor system 1000-1 uses a different protocol or once obtains keyword advertisement contents corresponding to all of the time dependent commercial tags, classifies the keyword advertisement contents according to each of the time dependent commercial tags (including each of the time zones), and transmits the classified keyword advertisement contents, a code (provided by the content distributor system 1000-1) executed in the user computer 9000 classifies the keyword advertisement contents according to each of the time zones and provides the user with the corresponding keyword advertisement content.

Second, both of the multimedia content data and the commercial tag corresponding to the multimedia content data are included in the content producer system 15000, but both are not packaged in a circulation unit. Likewise as in the first example, the multimedia content in the second example is processed in relation with the content producer system 15000 and the commercial tag is processed in relation with the content producer system 15000 in the same way of processing a commercial tag by the content circulator system 16000.

Third, both of the multimedia content data and the commercial tag corresponding to the multimedia content data are included in the content distributor system 1000-1. In this case, the content distributor system 1000-1 is equally treated with the multimedia content service system 1000 including commercial tag information, so that the construction of the content distributor system 1000-1 has been previously described in detail.

Circulation Control

Two issues regarding the circulation of the contents and the commercial tag are observed in the spirit of the present invention. The first issue is to circulate and control a commercial tag. The content syndication control unit 21200 of the content syndication system circulates and controls the commercial tag. The commercial tag corresponding to the circulated content can be stored in correspondence with the content during at least one process of the entire circulation processes, such as the production, circulation, distribution, etc. of the content. Further, the commercial tag itself may be a target of the circulation in relation to the corresponded content. The commercial tag can be circulated through 1) being packaged with a content or 2) independently of a content. Further, in the circulation of the commercial tag or the content, the commercial tag data itself or the content data itself may be transmitted/copied or location information (information indicating a predetermined location, such as URL and URI) of the commercial tag or the content may be circulated.

A subject of controlling the commercial tag is 1) the content distributor system 1000-1 or a code (program) provided by the content distributor system 1000-1, so that the content distributor system 1000-1 or the code (program) transmits the commercial tag to the keyword advertisement content providing system 3000, obtains a keyword advertisement content from the keyword advertisement content providing system 3000, and finally displays the keyword advertisement content on the user computer 9000. However, when a subject of controlling the commercial tag is another subject (the content producer system 15000, the content circulator system 16000), other than 1), the content distributor system 1000-1 or the code (program) obtains the keyword advertisement content from another subject, to finally display the keyword advertisement content on the user computer 9000.

In a special case, a subject of controlling the commercial tag may be a third system, e.g. the keyword advertisement content providing system 3000 or a system of a subject equivalent to a subject operating the keyword advertisement content providing system 3000. Further, for example, the third system is an independent content syndication system. The independent content syndication system is operated by a system independent of (logically separated from) the content producer system 15000, the content circulator system 16000, the content distributor system 1000-1, the user computer 9000, and the keyword advertisement content providing system 3000, and performs various functions related to the commercial tag of the present invention in connection with at least one of the content producer system 15000, the content circulator system 16000, the content distributor system 1000-1, the user computer 9000, and the keyword advertisement content providing system 3000.

The content producer system 15000, the content circulator system 16000, the content distributor system 1000-1, and the keyword advertisement content providing system 3000 may include a system, such as the independent content syndication system, performing various functions related to the commercial tag therein. Such an inside system is referred to as the dependent content syndication system. A management subject of the dependent content syndication system is identical to a management subject of the content producer system 15000, the content circulator system 16000, the content distributor system 1000-1, the user computer 9000, and the keyword advertisement content providing system 3000.

This will be described in the description of the advertisement profit distribution in more detail.

Advertisement Profit Distribution

The second issue is to distribute the advertisement profit. The spirit of the present invention related to the advertisement profit distribution will be described. According to the present invention, an advertisement content is transmitted from the keyword advertisement content providing system 3000 and the advertisement profit created by the keyword advertisement content transmitted from the keyword advertisement content providing system 3000 (an advertisement profit through the click or exposure of the keyword advertisement content (especially, when an advertisement moving picture is included in a keyword advertisement content, the exposure of the advertisement moving picture generates the important advertising effect)) will be treated. At this time, in the composition of two systems, such as the keyword advertisement content providing system 3000 and the multimedia content service system 1000, it is not complicated to process information for the profit distribution. However, the present invention requires the substantially complicated and varied models for the information process so as to clearly distribute the advertisement profit because 2) the circulation of the commercial tag has two models (the circulation through the transmission/copying of data, the circulation of location information), 2) a producer, a circulator, and a distributor of a commercial tag are different from the content producer system 15000, the content circulator system 16000, and a content distributor, and 3) the advertisement profit has to be distributed through the keyword advertisement content providing system 3000. In the meantime, when the keyword advertisement content providing system 3000 is identical to the content producer system 15000, the content circulator system 16000, and a content distributor or has the identical running subject of the content producer system 15000, the content circulator system 16000, and a content distributor, it is an internal issue, so that the relevant description will be omitted.

There are three profit distribution models. In the first profit distribution model, the content distributor has a control authority for the commercial tag. In the second profit distribution model, the content producer system 15000 or the content circulator system 16000, other than the content distributor, has a control authority for the commercial tag. In the third profit distribution model, the third system has a control authority for the commercial tag. Each of the three profit distribution models will be described.

When the content distributor has a control authority for the commercial tag, at least one of the content distributor system 1000-1 and the keyword advertisement content providing system 3000 manages at least one of a) an ID value of the content distributor system 1000-1, b) an ID value of each of the commercial tags, and c) an ID value of a keyword advertisement content transmitted from the content distributor system 1000-1 during at least one process of 1) the transmission of a commercial tag from the keyword advertisement content providing system 3000, 2) the obtainment of a keyword advertisement content from the keyword advertisement content providing system 3000, and 3) the processing of a click of a keyword advertisement content. It is preferred that the keyword advertisement content providing system 3000 performs those managements. It is a matter of course that, independently of the management purpose, when the content distributor system 1000-1 transmits at least one commercial tag, the content distributor system 1000-1 includes information of a receiver, to which the keyword advertisement content providing system 3000 intends to transmit a keyword advertisement content, in the commercial tag. In the process 1), the content distributor system 1000-1 includes at least one of a) and b) in the commercial tag and transmits the commercial tag to the keyword advertisement content providing system 3000. In the process 2), the keyword advertisement content providing system 3000 is necessary to include at least one information of a) to c) in each of keyword advertisement contents. The information a) can be recognized through an IP value or account information of the content distributor system 1000-1, and the b) can be first granted by the keyword advertisement content providing system 3000 (the content distributor system 1000-1 provides only the string or the array of at least one commercial tag and the keyword advertisement content providing system 3000 receives the string or the array and first grants an ID value to each of the commercial tags). Meanwhile, the keyword advertisement content has to include identification information (an ID value of a keyword advertisement content) of a keyword advertisement content transmitted at a specific time or a keyword advertisement content corresponding to a click generated at a specific time so as to conveniently transmit the keyword advertisement content, receive click information (including the reception through the redirect, etc.), and process click information. When the process 3) is performed in the keyword advertisement content providing system 3000, the keyword advertisement content providing system 3000 can recognize a keyword advertisement content corresponding to the click, etc. generated by the specific content distributor system 1000-1 with the ID value of the keyword advertisement content and identifier information of the content distributor system 1000-1, so that it is possible to measure a contribution portion of the content distributor system 1000-1 contributing to the advertising effect generation (when the process 3) is performed in the content distributor system 1000-1, the content distributor system 1000-1 has to transmit an ID of a keyword advertisement content corresponding to the generated click to the keyword advertisement content providing system 3000. At this time, the content distributor system 1000-1 can include its ID of an identifier of the content distributor system 1000-1. However, when the keyword advertisement content providing system 3000 has information capable of recognizing the identity of the content distributor system 1000-1 with an ID of a keyword advertisement content corresponding to the generated click, the content distributor system 1000-1 may not include the its identifier). At this time, the advertising effect of the keyword advertisement content called by using the commercial tag can be measured by the exposure, other than the click. The present invention can be applied to an advertisement method based on an exposure quantity, and in this case, the process 3) may not be necessary (that is, the transmission of a keyword advertisement content is determined that an advertisement has been already exposed). The process 3) can be implemented by a third organization (a syndication company, etc), other than an operator of the keyword advertisement content providing system 3000. The third organization exists between the content distributor system 1000-1 and the keyword advertisement content providing system 3000, to receive and transfer information, such as the click, and receive information, such as the click, from the keyword advertisement content providing system 3000 and process the information. In order to avoid the complexity of description, the third organization in this paragraph has been described in combination with the keyword advertisement content providing system 3000, but can exist as a separate and independent company in an actual application of the present invention. In this case, when a separate and independent company is actually operated according to the description of the functions of the keyword advertisement content providing system 3000, the keyword advertisement content providing system 3000 referred in the specification is reasonably interpreted as the separate and independent company.

For example, the content distributor system 1000-1 includes an ID value of the content distributor system 1000-1 in tag information and transmits the tag information to the keyword advertisement content providing system 3000, the keyword advertisement content providing system 3000 obtains a keyword advertisement content and includes at least one of an ID value of the content distributor system 1000-1, an ID value of a keyword advertisement content to be transmitted, and a third key value in the keyword advertisement content, to transmit the keyword advertisement content to the content distributor system 1000-1 (When the keyword advertisement content is clicked and redirection information of the keyword advertisement content is set as the keyword advertisement content providing system 3000, the first click is connected to the keyword advertisement content providing system 3000. At this time, the keyword advertisement content providing system 3000 can recognize that the third key value is a specific content distributor system 1000-1 or a keyword advertisement content related to a specific commercial tag of the specific content distributor system 1000-1 with the transmitted and received same key value in the keyword advertisement content providing system 3000. The ID value of the keyword advertisement content to be transmitted is the same).

For another example, the content distributor system 1000-1 includes its identifier serving as information of a receiver of a keyword advertisement content in at least one commercial tag and transmits at least one commercial tag to the keyword advertisement content providing system 3000 and the keyword advertisement content providing system 3000 includes an ID value of a keyword advertisement content in each of the commercial tags and transmits the commercial tags to the content distributor system 1000-1. At this time a click, etc. of a web page (a content page including the keyword advertisement content) transmitted by the content distributor system 1000-1 to the user is generated (the keyword advertisement content has redirect information), the keyword advertisement content providing system 3000 obtains click information of the keyword advertisement content and measures an advertising effect for the keyword advertisement content (the keyword advertisement content providing system 3000 can transmit a redirected advertisement page (including advertising contents of an advertiser) of an advertiser to the user computer).

The case in which the content distributor system 1000-1 has the control authority for the commercial tag (transmitting the commercial tag to the keyword advertisement content providing system 3000 and obtaining a keyword advertisement content) has been described. In this respect, it is possible to measure the transparent advertising effect and efficiently distribute the advertisement profit between the content distributor system 1000-1 and the keyword advertisement content providing system 3000. In this case, in order to efficiently implement the spirit of the present invention, the structure and the data flow based on the structure for the transparent profit distribution between the keyword advertisement content providing system 3000 and the content circulator system 16000, especially, the content producer system 15000, as well as the content distributor system 1000-1 are necessary. This case will be described.

A content distributed by the content distributor system 1000-1 includes a content ID and at least one commercial tag ID (a commercial tag set ID) corresponds to the content based on the content ID serving as a key value. Therefore, at least one keyword advertisement content ID is corresponded to the commercial tag ID and the keyword advertisement content providing system 3000 or the content distributor system 1000-1 can measure an advertising effect of the keyword advertisement content ID. The content distributor system 1000-1 can obtain information of the content producer system 15000 and the content circulator system 16000 related to the content with the content ID. Therefore, in order to measure the advertising effect, the content distributor system 1000-1 has to preliminarily store information of the content ID corresponding to the commercial tag ID. The content distributor system 1000-1 measures the advertising effect generated for the content ID and/or the commercial tag ID 1) by a direct method (the content distributor system 1000-1 obtains the exposure or the click generation of a keyword advertisement content called by a specific commercial tag. When the content distributor system 1000-1 first accesses the keyword advertisement content, the content distributor system 1000-1 is redirected to the keyword advertisement content providing system 3000, and the keyword advertisement content providing system 3000 is finally redirected to an advertisement page of an advertiser, the content distributor system 1000-1 can directly obtain the generated advertising effect from the user computer 9000) and 2) by an indirect method through obtaining an advertising effect from the keyword advertisement content providing system 3000 (the keyword advertisement content providing system 3000 accesses the keyword advertisement content, then is redirected to an advertisement page of an advertiser, and reports the advertising effect generation, such as a click, to the content distributor system 1000-1 in real time or in the preset unit). In the indirect method 2), a) when a commercial tag transmitted from the content distributor system 1000-1 includes a content ID or information of the content producer system 15000 or the content circulator system 16000, the keyword advertisement content providing system 3000 can measure or calculate a generation value of an advertising effect for each of the content IDs of the commercial tag, the content producer systems 15000, or the content circulator systems 16000. In the indirect method 2), when a commercial tag transmitted from the content distributor system 1000-1 does not include a content ID or information of the content producer system 15000 or the content circulator system 16000, the keyword advertisement content providing system 3000 transmits a generation value of an advertising effect measured based on a commercial tag ID to the content distributor system 1000-1. In the case b), the content distributor system 1000-1 corresponds the content ID to the commercial tag with the commercial tag ID serving as a key value, and corresponds the content circulator system 16000 with the content producer system 15000 with the content ID serving as a key value. At this time, when the content circulator system 16000 and the content producer system 15000 obtain a profit from the contents produced or circulated by themselves in a proportional amount system (% out of the generated advertisement costs, etc. the costs/profits distribution of the content is related to the advertising effect generation contribution), other than in a fixed amount system (a fixed amount for every 100 contents every year or a fixed amount for a single content, the costs/profits distribution of the content is not related to the advertising effect generation contribution), the content circulator system 16000 and the content producer system 15000 can clearly recognize the obtainable share, respectively.

For the clear content syndication based on a commercial tag, 1) the content distributor system 1000-1 definitely maps a content ID and a commercial tag ID related to the content and maps the commercial tag ID with a keyword advertisement content ID called based on the commercial tag or an advertising effect generation value based on the commercial tag, so that it clearly measures a contribution degree of each subject of the content syndication. Further, the following construction may be available. 1) The content distributor system 1000-1 measures, based on a specific content page (web page, etc.) including the content of the content distributor system 1000-1, an advertising effect through a click, etc. of a keyword advertisement content on the page, obtains a content ID included in the page with an ID of the page serving as a key value, and obtains information of the content producer system 15000 and the content circulator system 16000 through the content ID. That is, in addition to the methods 1) and 2), the content distributor system 1000-1 can a) recognize information of the content producer system 15000 and the content circulator system 16000 through the content ID serving as a key value and b) directly or indirectly (through the keyword advertisement content providing system 3000) obtain a generation value of an advertisement effect by using at least one of a content ID, a commercial tag ID, and a keyword advertisement content ID, and/or the specific content page (web page) corresponding to the generated click, etc. serving as a key value. Through the a) and b), it is possible to clearly distribute the advertisement profit between the content producer system 1500, the content circulator system 16000, the content distributor system 1000-1, and the keyword advertisement content providing system 3000.

The content distributor system 1000-1 according to the present invention is generally classified into two types. One type is that the content distributor system 1000-1 provides the user computer 9000 with a web page or a content receivable in another user computer 9000 in a content providing scheme (it may call a part of a program installed on the user computer 9000 and use the program) online, such as www.youtube.com. The other type is that the content distributor system 1000-1 provides the user computer 9000 with an installation-type program (GOM Player, iTunes, Windows Media Player) and provides the user computer with contents in a content transmission scheme, such as a file downloading or streaming scheme, through the installation-type program. The installation-type program is one of the systems connected to the network 8000 and can sufficiently perform the function of the content distributor system 1000-1. Various codes (programs) can be inserted in the web page provided by the content distributor system 1000-1 to the user computer 9000 as described above. The code may be understood as a part of the content distributor system 1000-1. That is, it is preferably understood that the content distributor system 1000-1 means not only a physical server but also a physical entity functioned over the physical server or exists on the network 8000 independent of the physical entity (e.g. a server providing a service of www.youtube.com).

Next, the case in which the content producer system 15000, the content circulator system 16000, or the third system (hereinafter, the description will be based on the content producer system 15000 and the content circulator system 16000, but it does not exclude the third system) has a control authority for the commercial tag (transmitting a commercial tag to the keyword advertisement content providing system 3000 and receiving a keyword advertisement content) will be described. In this case, the content producer system 15000 or the content circulator system 16000 binds a commercial tag to a content transmitted to an outside system or requested access of from an outside system and circulates the content or connects the commercial tag with a content so that the commercial tag can be called from an outside system receiving/accessing contents. This will be described in detail according to a detailed model.

The control authority for the commercial tag by the content producer system 15000 or the content circulator system 16000 can be obtained by 1) a method of obtaining a control authority for an area displaying a keyword advertisement content and 2) a method of transferring a commercial tag or a keyword advertisement content based on the commercial tag to the content distributor system 1000-1 or the user computer 9000 through the content producer system 15000 or the content circulator system 16000. The method 1) includes at least one of a) a method in which the content producer system 15000 or the content circulator system 16000 transmits a code distributed by the content producer system 15000 or the content circulator system 16000 to the content distributor system 1000-1 and the content distributer system 1000-1 uses the code in order to display the keyword advertisement content and 2) a method in which the content producer system 15000 or the content circulator system 16000 obtains a usage authority for an area displaying the keyword advertisement content in a lease manner, etc. and temporarily or continuously uses the area. The method 2) includes at least one of c) a method in which the content producer system 15000 or the content circulator system 16000 transmits a commercial tag to the keyword advertisement content providing system 3000 and the keyword advertisement content providing system 3000 receives a keyword advertisement content and transmits the received keyword advertisement content to the content distributor system 1000-1 or the user computer 9000 and d) a method in which the content producer system 15000 or the content circulator system 16000 directly communicates with a code (program) included in the user computer 9000 and displays a keyword advertisement content on the user computer. Each of the methods a) to d) includes i) a case in which the content producer system 15000 or the content circulator system 16000 has the commercial tag data itself and ii) a case in which the commercial tag data itself is included in another system and the content producer system 15000 or the content circulator system 16000 has an access authority or a usage authority for the commercial tag data itself. The cases i) and ii) can be applied to at least one of the package model or the independent route model. In the method a), when the content distributor system 1000-1 uses a code provided by the content producer system 15000 or the content circulator system 16000, the code used in the content distributor system 1000-1 obtains a keyword advertisement content by using a commercial tag and exposes the keyword advertisement content to the user computer under the control of the content producer system 15000 or the content circulator system 16000. In the method b), the content producer system 15000 or the content circulator system 16000 independently controls the area displaying the keyword advertisement content and the keyword advertisement content area and an area other than the keyword advertisement content area are combined and displayed only on the user computer 9000. Since the web page or each area of other screens can be independently controlled and contents exposed on each area can be obtained from a different server and combined with each other, to be displayed, the method b) can be performed. The bringing of the contents from an independent source, the combining of the contents with each other, and the displaying of the contents to the user belongs to the conventional technology. The former method of the method c) is partially inappropriate for the time dependent commercial tag, but is available. The latter method (transmitting the keyword advertisement content to the user computer 9000) is preferable for the time dependent commercial tag. In the latter case of the method c), an area displaying a multimedia content among areas of the user computer 9000 is related (in a case of the file download)/connected (in a case of the streaming) with the content distributor system 1000-1 and the keyword advertisement content display area receives a keyword advertisement content while communicating with the content producer system 15000 or the content circulator system 16000. In the method d), a partial code of the content distributor system 1000-1 transmitted to the user computer 9000 or a code installed by the third system accesses the content producer system 15000 or the content circulator system 16000 and receives a keyword advertisement content.

In the method of obtaining the control authority for the commercial tag by the content producer system 15000 or the content circulator system 16000, for the clear content syndication, the system having the control authority or a system (e.g. the keyword advertisement content providing system 3000) related to the system having the control authority has to directly or indirectly map a content ID with a commercial tag ID and a keyword advertisement content ID and quantitatively measure an advertising effect. The method for the mapping and the measuring of the advertising effect is equivalent to a method of obtaining the control authority for the commercial tag by the content distributor system 1000-1.

The specific method of corresponding/binding/connecting/relating the commercial tag to the multimedia content has been described in the above. Hereinafter, a method of independently including a commercial tag in a single multimedia content by at least two subjects during the circulation process of the multimedia content will be described (The independent including of the commercial tag includes the change of the existing commercial tag as a matter of course). For example, when the content producer system 15000 includes a commercial tag set CT1 in a multimedia content M and provides the multimedia content M to the content circulator system 16000, the content circulator system 16000 can include an independent commercial tag set CT2 in the multimedia content M and the content distributor system 1000-1 can include an independent commercial tag set CT3 in the multimedia content M. In this case, a commercial tag related to the multimedia content M is the CT1, CT2, and CT3. The relative or logical location relation among the CT1, CT2, and CT3 includes a case in which i) the CT1, CT2, and CT3 exist in parallel or in a row and ii) the CT1, CT2, and CT3 include hierarchical information. For example of the case i), it is assumed that the CT1, CT2, and CT3 are made in XML. In this case, the XML includes an information unit for the CT2+an information unit for the CT1+an information unit for the CT3. Each of the information units essentially includes a commercial tag of at least one group constituting a commercial tag set and producer information of a commercial tag (any one of the content producer system 15000, the content circulator system 16000, the content distributor system 1000-1, and the third system), and may further include various meta information of the commercial tag including various condition information of a commercial tag. In the case i), the CT1, CT2, and CT3 exist in parallel or in a row, but the CT1, CT2, and CT3 may have the priority order. With regard to the priority order, it is preferable to grant the top priority to a commercial tag generated by the content producer system 15000. In the meantime, it will be easy if the case ii) is understood as the package model. The content producer system 15000 first packages the multimedia content and information of the CT1 (the CT1 and/or various information of the CT1), the content circulator system 16000 includes information of the CT2 in the first packaged multimedia content and second packages the first packaged multimedia content with the information of the CT2, and the content distributor system 1000-1 includes information of the CT3 in the second packaged multimedia content. In the package model, the commercial tag set is strongly bound with the content, but in the independent route model, one of the content and the commercial tag set can include location information (it is possible to access the content through the location information) of only the other one. That is, with regard to the CT1, CT2, and CT3, the CT1 data may be stored together with the multimedia content, the CT2 data may be stored in a specific location of a preset server managed by the content circulator system 16000, and the CT3 may be stored in a specific location of a preset server managed by the content distributor system 1000-1.

When a single content includes at least two commercial tag sets, it incurs the following problems: 1) which commercial tag set is connected with a use condition, such as the priority order or use limitation condition; 2) when a predetermined commercial tag set is used, whether to receive an acceptance of a system having the control authority or the management authority for the commercial tag set; and 3) the problem of combining and using multiple commercial tag sets. With regard to the problem 1), the system having the control authority for the commercial tag set reads a priority order or a use limitation condition, determines the priority order or the use limitation condition, and uses the commercial tag set if the commercial tag set is determined to satisfy the priority order or the use limitation condition. With regard to the problem 2), the commercial tag by the content producer system 15000 or the content circulator system 16000 accesses the system having the control authority or the management authority for the commercial tag set and obtains agreement information. The problem 3) corresponds to a problem of preparatorily selecting which commercial tag or a commercial tag set among multiple commercial tags, which have been described in the keyword advertisement target text generation module of the present specification in detail.

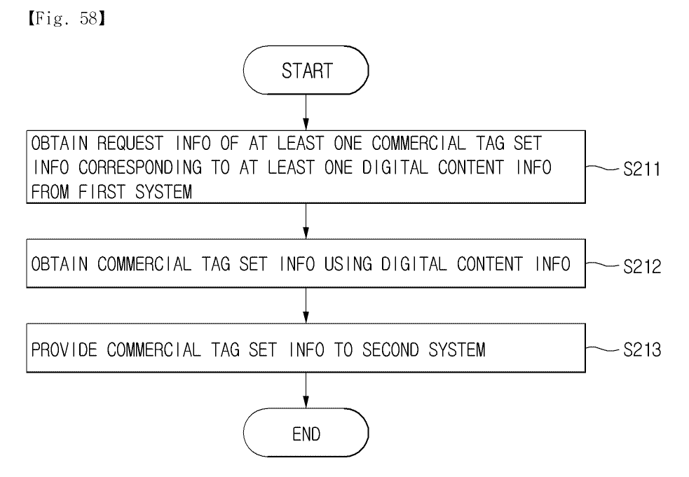

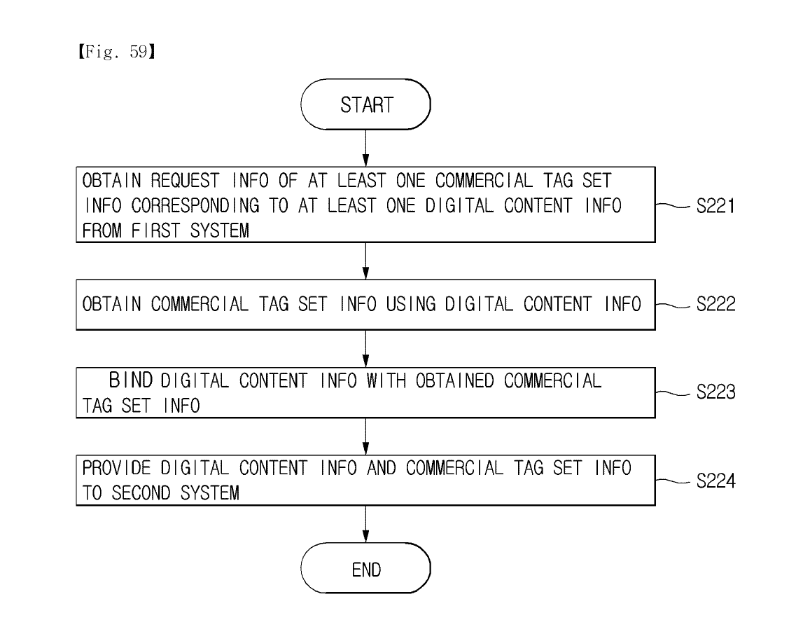

Hereinafter, a method of processing information by the content syndication system 20000 of the present invention will be described with reference to FIGS. 58 and 59 in more detail.

As illustrated in FIG. 58, the method of processing information by the content syndication system 20000 includes the steps of (A) obtaining request information of at least one commercial tag set information corresponding to at least one digital content information from a preset first system (S211), (B) obtaining the commercial tag set information with the digital content information (S212), and (C) providing a preset second system with the obtained commercial tag set information (S213). Further, the method of processing information by the content syndication system 20000 includes the steps of obtaining request information of at least one commercial tag set information corresponding to at least one digital content information from a preset first system (S221), obtaining the commercial tag set information with the digital content information (S222), combining the digital content information with the obtained commercial tag set information (S223), and providing a second system with both of the digital content information and the commercial tag set information (S224).

The digital content information includes at least one of physical digital content data, digital content identification information capable of identifying the physical digital content data, and digital content location information capable of accessing the physical digital content data through the wired/wireless network 8000. The commercial tag set information includes at least one of physical commercial tag set data, commercial tag set identification information capable of identifying the physical commercial tag set data, and commercial tag set location information capable of accessing the physical commercial tag set data through the wired/wireless network 8000.

The first system and the second system include any one of a digital content service system providing the user computer 9000 with digital contents, the content syndication system 20000, the keyword advertisement content providing system 3000, the user computer 9000, and a preset program executed in the user computer 9000. The digital content service system includes any one of the multimedia content service system 1000 providing the user computer 9000 with multimedia contents, a broadcasting service system providing the user computer 9000 with broadcasting contents, the digital publication service system 32000 providing the user computer 9000 with a digital publication, and the media service system 31000 providing the user computer 9000 with a media service.

The content syndication system 20000 belongs to any one of the content producer system 15000 of a person producing the digital contents, the content circulator system 16000 of a person circulating the digital contents, the content distributor system 1000-1 providing the user computer 9000 with the digital contents, the digital content service system providing the user computer 9000 with digital contents, the keyword advertisement content providing system 3000, the user computer 9000, and a preset program executed in the user computer 9000. Further, the content syndication system 20000 exists independently of the content producer system 15000, the content circulator system 16000, the content distributor system 1000-1, the digital content service system, the keyword advertisement content providing system 3000, the user computer 9000, and a preset program executed in the user computer 9000 and is connected with them through the wired/wireless network 8000. Further, the digital content service system includes any one of the multimedia content service system 1000 providing the user computer 9000 with a multimedia content, the broadcasting service system 13000 providing the user computer 9000 with a broadcasting content, the digital publication service system 32000 providing the user computer 900 with a digital publication, and the media service system 31000 providing the user computer 9000 with a media service.

In the meantime, in a special case, the content syndication system 20000 may serve as the first system. The method includes a step of (B-1) combining the digital content information and the obtained commercial tag set information prior to performing the step (C), and in the step (C), the content syndication system 20000 can transmit both of the digital content information and the commercial tag set information to the second system.

In the step (B-1) of combining the digital content information and the obtained commercial tag set information, digital content information including at least one of physical digital content data, digital content identification information capable of identifying the physical digital content data, and digital content location information capable of accessing the physical digital content data through the wired/wireless network 8000 is combined with commercial tag set information including at least one of physical commercial tag set data, commercial tag set identification information capable of identifying the physical commercial tag set data, and commercial tag set location information capable of accessing the physical commercial tag set data through the wired/wireless network 8000.

The digital content information can be combined with the obtained commercial tag set information by at least one of a first method of connecting digital content information with the commercial tag set information and storing the digital content information with the commercial tag set information, a second method of using an identical key value for the digital content information and the commercial tag set information so as to connect the digital content information with the commercial tag set information, a third method of using one identification information between the digital content information and the commercial tag set information as a key value for the other information so as to connect the digital content information with the commercial tag set information, and a fourth method of calling one information between the digital content information and the commercial tag set information by the other information so as to connect the digital content information with the commercial tag set information.

A commercial tag constituting the commercial tag set is used for obtaining a keyword advertisement content and the keyword advertisement content is exposed on the user computer 9000 together with the digital content. A method of exposing the digital content and the keyword advertisement content on the user computer 9000 includes at least one of 1) a first method of, by any one of the content syndication system 20000, the first system, and the second system, transmitting the commercial tag set to the keyword advertisement content providing system 3000 in a direct manner or via the third system, receiving at least one keyword advertisement content from the keyword advertisement content providing system 3000 in a direct manner or via the third system, and transmitting the digital content and the obtained keyword advertisement content to the user computer 9000, 2) a second method of transmitting, by any one of the content syndication system 20000, the first system, and the second system, a program performing a function of obtaining the commercial tag set and a keyword advertisement content from the keyword advertisement content providing system 3000 by using the commercial tag set to the user computer 9000, transmitting, by the program, the received commercial tag set to the keyword advertisement content providing system 3000 in a direct manner or via the third system, and obtaining, by the program, at least one keyword advertisement content from the keyword advertisement content providing system 3000 in a direct manner or via the third system and exposing the obtained keyword advertisement content on the user computer 9000, 3) a third method of transmitting, by any one of the content syndication system 20000, the first system, and the second system, a program performing a function of obtaining a keyword advertisement content from the keyword advertisement content providing system 3000 by using the commercial tag set and obtaining a commercial tag set corresponding to the digital content to the user computer 9000, obtaining, by the program, the commercial tag set corresponding to the digital content; and transmitting, by the program, the obtained commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content to the user computer 9000, 4) a fourth method of including, by any one of the content syndication system 20000, the first system, and the second system, a program performing a function of obtaining a keyword advertisement content from the keyword advertisement content providing system 3000 by using the commercial tag set and obtaining a commercial tag set corresponding to the digital content in the digital content and transmitting the digital content to the user computer 9000, obtaining, by the program, the commercial tag set corresponding to the digital content, and transmitting, by the program, the obtained commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content to the user computer 9000.

Method of Obtaining Additional Information of Advertisement Profit

Next, a method of clearly obtaining, by the content producer system 15000 and the content circulator system 16000, additional information of the advertisement profit in relation to the commercial tag with respect to the content produced or circulated by the content producer system 15000 and the circulator system 16000 will be described. For example, it is assumed that actual content data is stored in the content producer system 15000 and the commercial tag data is physically stored in the content circulator system 16000. At this time, the user computer 9000 preferentially receives a permission of at least one subject of the content distributor system 1000-1, the content circulator system 16000, and the content producer system 15000 so as to access the content data and the commercial tag data. The permission process means an access to a system allowing the access and the user computer 9000 has to provide the system allowing the access with a key value, such as a content ID and a commercial tag ID for the permission. The content data and the commercial tag data can be accessed by an independent code and an independent system (that is, a code unit (a first code unit) for using a multimedia content and a code unit (a second code unit) for using a commercial tag may be independently operated). For example, when the first code unit and the second code unit access the content distributor system 1000-1, the content distributor system 1000-1 provides the first code unit with 1) location information of the content circulator system 16000 or 2) location information of the content producer system 15000 when it is not necessary to pass the content circulator system 16000, so as to obtain the content data, and provides the second code unit with location information of the content circulator system 16000. In the case 1), the first code unit accessing the content circulator system 16000 can obtain location information of the content producer system 15000 from the content circulator system 16000 and the second code unit can obtain the commercial tag data from the content circulator system 16000. In the case 1), the first code unit can access the content producer system 15000 and obtain content data from the content producer system 15000. In the case 2), the first code unit can access the content producer system 15000 and obtain content data from the content producer system 15000, and the second code unit can obtain commercial tag data from the content circulator system 16000. When a request of content data, commercial tag data, location information of content data, and/or location information of commercial tag data is made with a content ID and/or a commercial tag ID serving as a key value, each of the systems stores and manages the request. At this time, when there is measurement information of an advertising effect of a keyword advertisement content related to the content ID or measurement information of an advertising effect of a keyword advertisement content related to the commercial tag ID, through processing the information, the content producer system 15000, the content circulator system 16000, the content distributor system 1000-1 can calculate information of the total advertising effect related to one's system. The calculated information of the advertising effect of the total contents and/or the total commercial tags produced, circulated, or distributed by the content producer system 15000, the content circulator system 16000, or the content distributor system 1000-1 includes information of total keyword advertisement contents corresponding to the click generation, total exposed keyword advertisement contents, the total number of clicks, or the total number of exposures, etc.

Advantage

The spirit of the present invention centered on the relative advantage of the method of circulating a content through including a commercial tag in a content with respect to the method of circulating a content through directly inserting an advertisement content in a content will be described.

First, most of the contents are time independent i.e. the contents are available in various time zones, as well as a specific time, but an advertisement contents are time dependent according to an advertisement strategy of an advertiser. Therefore, when a time dependent advertisement content is combined to a time independent content, the advertisement content may be valid at a specific time of combining the advertisement content, but the advertisement content is degenerated after the passage of a certain time from the specific time, so that the availability of the advertisement content is much deteriorated. However, a commercial tag can call a keyword advertisement content from the keyword advertisement content providing system 3000 and the keyword advertisement content providing system 3000 updates a keyword advertisement content according to the selection of an advertiser, so that a keyword advertisement content obtained through the commercial tag cannot be degenerated.

Second, the commercial tag has a strong medium independent property in the circulation of a content through a commercial tag. A specific type advertisement content tends to be combined only with a specific situation/medium. Therefore, a movie showing in a movie theater provides audiences with an advertisement of a specific company brand before showing the movie, but it is difficult to find an advertisement content advertising the specific company brand in a movie DVD assuming the existence of a circulation period or the possession. That is, a commercial tag has a strong time independent characteristic in comparison with the advertisement content itself, so that the commercial tag can be flexibly applied to various mediums as long as a device providing an advertisement content is connected with the network 8000. That is, when the movie DVD includes a commercial tag and the DVD player is a system, the IPTV, or a display device connected with a set-top box, etc., the commercial tag can call a keyword advertisement content providing by the keyword advertisement content providing system 3000 and display the keyword advertisement content on the system, the IPTV, a display device connected with the set-top box.

Third, the commercial tag may be relatively language independent. That is, it is assumed that a commercial tag, “Italian restaurant”, is included in a specific multimedia content generated in a first country (e.g. the USA), and the multimedia content is circulated in different countries using different languages/a second country (e.g. Korea). At this time, the commercial tag is mainly a word or a phrase so that when the commercial tag is translated by a translation machine, it is possible to substantially accurately translate the commercial tag as “Italian restaurant” in Korean, and when the “Italian restaurant” in Korean is inquired in the keyword advertisement content providing system 3000 adopting the main language of the Korean language, the keyword advertisement content providing system 3000 transmits a keyword advertisement content related to the “Italian restaurant” in Korean. Especially, when there are many multimedia contents, it is expected that the expected number of exposures per multimedia content is small, or a single multimedia content includes the substantially many commercial tags (e.g. the time dependent commercial tags), it is not efficient that a person translates the commercial tag in the language of the second country. Therefore, the machine translation of the commercial tag is more efficient in this case. When the machine translation does not correctly translate the commercial tag, it is difficult to call a keyword advertisement content from the keyword advertisement content providing system 3000 with the incorrect translation result so that a keyword advertisement content may not be displayed on the keyword advertisement content area. However, even though the keyword advertisement content is not displayed on the keyword advertisement content area, it may not incur the large damage to the users viewing the multimedia content.

Hereinafter, a problem of the machine translation of a commercial tag will be described in more detail. For example, it is assumed that a Korean user A mainly accesses www.youtube.com, which provides a service in English and includes English multimedia contents, and views English multimedia contents. At this time, when a keyword advertisement content is called by using a commercial tag (e.g. “Italian restaurant”) included in the multimedia content, a keyword advertisement content (e.g. an advertisement of a famous Italian chain restaurant in America, on the premise that the Korean users are the Americans, is relatively meaningless. Therefore, the multimedia content service system 1000, such as www.youtube.com, obtains locale information (KR) (because the locale is not En (US)) of a browser of the connector A, searches for a country or a language sharing district (Korea, Korean sharing district) mainly using the locale, and provides the Korean users with a keyword advertisement content corresponding to the locale language. In order to provide a keyword advertisement content corresponding to the language, the following methods can be used.

The multimedia content service system 1000, such as www.youtube.com can receive a keyword advertisement content 1) through using www.google.co.kr or www.overture.co.kr, which is a second country branch of the multimedia content service system 1000 when the multimedia content service system 1000 has the global network 8000, such as www.google.com or www.overture.com, or 2) through the cooperated keyword advertisement content providing system 3000 of the second country when the multimedia content service system 1000 has no second country branch. The multimedia content service system 1000 can receive a keyword advertisement content by 1) a method in which the multimedia content service system 1000 translates “Italian restaurant” in English into “Italian restaurant” in Korean, inquires of the keyword advertisement content providing system 3000 of the second country about “Italian restaurant” in Korean, obtains a keyword advertisement content with “Italian restaurant” in Korean, and transmits the received keyword advertisement content to the multimedia content service system 1000 and 2) a method in which the multimedia content service system 1000 transmits “Italian restaurant” in English, and the keyword advertisement content providing system 3000 of the second country translates “Italian restaurant” in English into its own language, obtains a keyword advertisement content corresponding to “Italian restaurant” in the translated language, and transmits the obtained keyword advertisement content to the multimedia content service system 1000.

Therefore, through using the machine translation of the commercial tag, the multimedia content service system 1000 of the second country having a predetermined authority for a multimedia content of the first country can implement the advertisement method of the present invention in a case where the multimedia content service system 1000 of the second country copies or receives (or mirrors) the large amount of multimedia contents of the first country and grants the control authority for the mirrored multimedia contents to the second country, accesses the multimedia contents with an interface of the second country through a medium of the second country, or transmits a multimedia content ID, a commercial tag, etc. and allows the second country to search for a multimedia content through the translation of the commercial tag, etc. in the second country (allows the second country to access the searched multimedia content). In general, when a brand, a proper noun, etc. is excluded in the second country, a commercial tag, etc., in the language of the first country may be difficult to be used in the calling of a keyword advertisement content or the unit price of an advertisement of a keyword advertisement content is extremely low, so that the exclusion of a brand, a proper noun, etc. may be ominous of failing to contribute the large advertisement profit of the second country.

When the first country includes a commercial tag in a multimedia content, the multimedia content service system 1000 can include a commercial tag set according to the language in a multimedia content, such as translating a commercial tag according to a language of each country (a commercial tag of the first country and a commercial tag of the second country are different in the language, but their contents are actually the same), or generating an independent commercial tag set according to a language of each country. In this case, the machine translation process may not be necessary. For example, when the multimedia content service system 1000 of the first country has generated the Korean commercial tag for the second country of Korea, the multimedia content service system 1000 can transmit a commercial tag to the keyword advertisement content providing system 3000 of the second country and obtain a keyword advertisement content for the second country from the keyword advertisement content providing system 3000. It is a matter of course that www.google.com or www.yahoo.com providing the global service can manage both of the keyword advertisement content providing system 3000 of the first country and the keyword advertisement content providing system 3000 of the second country in a single unified system. In this case, it is possible to conceptually discriminate the first country and the second country in the unified system, and thus the first country and the second country should be conceptually understood.

Pirated Moving Picture

Next, the spirit of the present invention based on a pirated moving picture, serving as a specific example, will be described. Now, the large numbers of illegal or not-permitted moving pictures, which have not received the permission of copyright holders, have been presently uploaded on www.youtube.com, etc., and the copyright holders have sued www.youtube.com for the infringement of the copyright. Auditude Inc., etc. has provided an advertisement platform including a function of identifying illegal moving pictures among uploaded moving pictures. When the identity is determined between the original and the uploaded moving picture, the advertisement platform provides original information including the moving picture and information of an online store in which the original moving picture can be purchased on the moving picture as an advertisement. In the meantime, www.google.com. etc. introduces a ‘video ID’ of a copyright identification system chasing unlicensed moving pictures and enables a copyright holder to select the blocking or the leaving of a moving picture or www.youtube.com to select whether to sell an advertisement using a corresponding content. Google, Inc. reported that at least 90% of copyright holders (companies) of pirated moving pictures uploaded on www.youtube.com in the end of August of 2009 selected the using of the YouTube copyright filter, to obtain an advertisement profit, instead of deleting moving pictures. However, the advertisement applied to www.youtube.com is not matched with the moving picture contents so that it is impossible to obtain the high profit, such as a keyword advertisement. Further, the users strongly tend to freely enjoy the contents in the scheme of Auditude, Inc., so that Auditude, Inc. cannot provide the copyright holder with the reasonable profit. The copyright identification system of Auditude, Inc. ignores information, such as a title or a tag of a moving picture, and combines a moving picture with its own database by using only audio and video data including in a moving picture clip.

The content distributor system 1000-1, e.g. www.youtube.com, having the authority identification system of the present invention can apply the spirit of the present invention to the illegal moving pictures through the following processes. The content distributor system 1000-1 makes a moving picture corresponding to obtained selection information or an uploaded moving picture to pass the copyright identification system and searches for a legal original moving picture in its systems, another content distributor system 1000-1, the content producer system 15000, and the content circulator system 16000. When the moving picture is illegal as a search result and the legally original moving picture is included in its systems, another content distributor system 1000-1, the content producer system 15000, and the content circulator system 16000, the content distributor system 1000-1 obtains information of at least one commercial tag set for the legal original moving picture from its systems, another content distributor system 1000-1, the content producer system 15000, and the content circulator system 16000 (information of the obtained commercial tag set is stored in relation to the moving picture or used for the obtaining of a keyword advertisement content). When the commercial tag set is included in its systems, another content distributor system 1000-1, the content producer system 15000, and the content circulator system 16000, the content distributor system 1000-1 obtains selection information of the moving picture from the user computer 9000, the content distributor system 1000-1 obtains commercial tag information related to the moving picture and provides the user computer 9000 with information of the moving picture in the file download scheme or the streaming scheme, or provides the user computer 9000 with a keyword advertisement content by using a commercial tag related to the moving picture while providing information of the original moving picture. That is, when an illegal moving picture is detected, the content distributor system 1000-1 searches for the legal original moving picture of the illegal moving picture, obtains commercial tag information of the legal original moving picture, and transfers the illegal moving picture or the legal original moving picture and a keyword advertisement content through the commercial tag to the user computer 9000. At this time, when the commercial tag is included, it is more preferable that the content distributor system 1000-1 provides the user computer 9000 with data related to the legal original moving picture. However, only when the existence of the legal original moving picture has been identified, but it is difficult to obtain the original moving picture and preliminary agreement information of a copyright property holder or a management authority holder of the legal original moving picture is preset, the content distributor system 1000-1 may provide the user computer 9000 with data for the illegal moving picture. When the spirit of the present invention is applied to the commercial tag, the content producer system 15000 producing a legal original content or a circulator of a legal original content can obtain the high advertisement profits from the pirated moving pictures. When the spirit of the present invention is applied to the illegal moving picture, the advertisement method based on the time dependent commercial tag can obtain relatively higher advertisement profits than that based on the time independent commercial tag.

In the spirit of the present invention, it does not matter to provide the user with the illegal moving picture, contrary to Auditude, Inc., because a producer of a legal original moving picture can sufficiently receive compensation through the high-profit keyword advertisement content. The producer of a legal original moving picture is necessary to preliminarily or later agree to the providing of the content distributor system 1000-1 with the illegal moving picture, instead of obtaining the profit through the implementing of the spirit of the present invention. It is more reasonable to provide a legal original moving picture in the general case, but it cannot exclude the case in which the illegal moving picture has to be provided instead of the original because the illegal moving picture is different from the original moving picture in a length, etc., or is the edited version of the original moving picture (e.g. an edition of interesting parts of the original movie). In this case, when the moving picture is the illegal moving picture and the corresponding original moving picture exists, the content distributor system 1000-1 1) provides the illegal moving picture, 2) provides the original moving picture, 3) notifies the user computer 9000 of the existence of the original moving picture, or 4) notifies the user computer 9000 of the difference (length information, etc.) between the illegal moving picture and the original moving picture, waits for the user selection, and provides the user computer 9000 with a moving picture selected by the user. In the meantime, when the illegal moving picture is related to n original moving pictures, the content distributor system 1000-1 can perform the 1) to 4) for each of the n original moving pictures. At this time, when each area of the illegal moving picture is corresponded to a specific original moving picture, the content distributor system 1000-1 preferably provides the user computer 9000 with a keyword advertisement content using a commercial tag for the corresponded original moving picture in a time section of reproducing the illegal moving picture.

When the existence of the original moving picture in relation to the illegal moving picture has been identified and it has been searched/researched that the commercial tag set related to the original moving picture does not exist, the conventional advertisement method (the insertion of an advertisement in a front part, a back part, or a middle part of a moving picture, the insertion of an advertisement in the highest layer of a moving picture, etc.) can be applied. When tag information for the illegal moving picture exists, it is possible to obtain a keyword advertisement content by using the tag information with respect to the illegal moving picture.

According to the spirit of the present invention, it is possible to transfer the contents for free or at an extremely small cost to the user computer 9000, thereby achieving an effect of decreasing the illegal moving pictures. Therefore, the spirit of the present invention with respect to the pirated illegal moving picture is especially useful 1) in a case where a commercial tag exists in a state in which the content producer system 15000 has not agreed to distribute the contents for free or at an extremely small cost (the illegality has been already committed and the content producer system 15000 receives the divided advertisement profit later for the committed illegality), and 2) in a case where a illegal moving picture of a second work or an edited work is circulated.

In the meantime, the scraping of various contents on the Internet has been widely spread. The scraping represents to copy and insert link information of a content of a specific site in the third virtual space (e.g. one's blog, etc.) At this time, the spirit of the present invention can be applied to the case in which the link information of the content is 1) a legal original moving picture or 2) an illegal moving picture. When the link information of the content is a legal original moving picture, the content distributor system 1000-1 can use a legal commercial tag, and when the link information of the content is an illegal moving picture, the spirit of the present invention with respect to the illegal moving picture may apply in this case.

Meta Information

A single commercial tag or a single commercial tag set further includes the following meta information, and the meta information is preferably the XML type. The following meta information can be applied to both the time dependent commercial tag or the time independent commercial tag.

First, the meta information is related to the commerciality of the commercial tag, and includes 1) the total number of exposures/the total number of calls, 2) an increase/decrease rate of the total number of exposures/calls, 3) the total number of advertisers, 4) an average advertisement unit price, 5) the highest advertisement unit price, 6) the lowest advertisement unit price, 7) the average number of advertisers, 8) the average number of keyword advertisement contents, 9) an increase/decrease rate of the average number of advertisers, 10) an increase/decrease rate of the average advertisement unit price, and with respect to keyword advertisement contents related to the advertisement keyword, 11) the number of exposures, 12) a click generation rate of the keyword advertisement content with respect to exposures, 13) the total number of clicks, 14) a generated advertisement profit, 15) an increase/decrease rate of the number of exposures, 16) an increase/decrease rate of a click generation rate with respect to exposures, 17) an increase/decrease rate of the total number of clicks, and 18) an increase/decrease rate of a generated advertisement profit. At least one of 1) to 18) is preferably assigned to each of the commercial tags. When the keyword advertisement providing system 3000 receives a commercial tag or a commercial tag candidate, the keyword advertisement providing system 3000 preferably provides information of 1) to 18) for the commercial tag or the commercial tag candidate.

Second, the meta information is the score function value of the commercial tag. The score function can be calculated by its own score function in a system generating a commercial tag, but the keyword advertisement providing system 3000 can provide a score function value.

Third, the meta information is a degree of the relation with a content to which at least one determination reference has been applied. The degree of the relation represents the numerically expressed, levelized, or categorized subjective determination of a person granting a commercial tag for a specific content. The relation includes 1) a contents relation, 2) a product/service relation, etc. The relation information is important because when the content and the commercial tag are circulated, the 1) to 18) information relate to a commercial tag itself and is not related to the content. That is, however high the commerciality of a commercial tag itself may be, when the commercial tag is not related with a content in the contents, a keyword advertisement content called by the commercial tag is not related to the content and the keyword advertisement content is only the level of a simple banner advertisement and cannot induce an active action of the user, such as the click, thereby decreasing an advertising effect. Therefore, a person generating a commercial tag for a specific content must necessarily store information of how strongly the commercial tag generated by him/herself is related with the specific content. In the meantime, when the number of the time independent commercial tag and the time independent commercial tag are more than one, the keyword advertisement target text generation module can select the predetermined number of commercial tags with the consideration of 1) to 18) and the relation information. The contents relation provides information on how strongly the commercial tag is related with contents of the content, and the product/service relation provides information on how strongly the name is related to the content when the commercial tags are various names, such as a product name, a service name, a company name, and a brand name. For example, when a specific content is a moving picture enjoyed by a specific product and a commercial tag includes a name of the specific product, it is possible to grant relation information of 100% to the relation between the specific product name and the moving picture. Further, when various accessories are required for more interestingly enjoying the specific product and the names of the accessories are the commercial tags, it may grant category information of <optional> as product relation information and a relation value of 50%.

Fourth, the meta information includes an attribute of at least one time dependent commercial tag or the time dependent commercial tag with respect to a specific single content. The attribute of the tag may include a theme, a genre, a language, a place, a company, a person, a brand, a product or service, and attribute information (adult, job group, country, hobby, etc.) of a logging-in moving picture viewer.

Fifth, the meta information is commerciality variation information of the commercial tag according to a condition. The condition affecting the commerciality includes information of 1) a time zone, 2) a date or a term, 3) a user age, 4) a country. For example, the keyword advertisement contents related to a specific commercial tag may have a high click rate after midnight, in a Christmas season, from adult men, or in a specific country. Therefore, the meta information including such information contributes to the generation of the most optimum commercial tag expecting the highest advertising effect by the keyword advertisement target text generation module or other function modules.

Sixth, the meta information includes preference information and evasion information. For example, the preference information and evasion information includes 1) an age, 2) religion, 3) a specific brand (especially, a brand of a competitor, for example, when a moving picture showing an exercising person wearing the NIKE sports shoes includes a commercial tag, “jogging shoes”, it may be awkward if the commercial tag, “jogging shoes”, calls a keyword advertisement content for selling products of REEBOK Inc. At this time, when the evasion information includes REEBOK, the keyword advertisement content providing system 3000 does not obtain keyword advertisement contents related to REEBOK or the multimedia content service system 1000 can filter keyword advertisement contents related to REEBOK), and 4) a specific company.

Seventh, the meta information includes information of a language, a country, a kind of terminals, a condition (contents resolution, a size of a display window), and a kind of advertisement keyword contents (text-type, moving picture including type). For example, when the user computer 9000 is the IPTV having a large screen, the obtainment of an image or a moving picture type keyword advertisement content may have the larger advertising effect than the obtainment of a simple text type advertisement content, and a text type advertisement content is more preferable in a compact display terminal, such as a mobile phone. Further, when the number of commercial tags are more than one, with respect to a commercial tag of an A group, an image or a moving picture may be effectively expose an advertisement, and with respect to a commercial tag of a B group, only a text-type keyword advertisement content may be an effective advertisement means.

Commercial Tag Application Target

There are two kinds of commercial tag application target contents according to the present invention. One is a content, such as a moving picture or a music/sound multimedia, having a sequential reproduction concept in which the passage of time is necessary for the reproduction of the content itself. The other is a content, such as an electronic book, text news, an image, a pdf file, and a document, having no sequential reproduction concept in which the passage of time is not necessary for the reproduction of the content. For example, it is possible to display several pages of the pdf document on a single screen as long as a size of the screen is allowed. Both the time independent commercial tag and the time dependent commercial tag can be granted to the content having the sequential reproduction concept, but only the time independent commercial tag can be granted to the content having no sequential reproduction concept. For example, when at least one commercial tag can be corresponded to each of the pages of an electronic book, but different commercial tag sets are corresponded to several pages, time-related information is not necessary for the commercial tags.

The spirit of the present invention using a commercial tag can be applied to a content transmitting only a sound, such as the music reproduction or the digital radio broadcasting. In this case, the screen of the user computer 9000 displays no video, a fixed content, a reserved content, a programmed content, or other contents expected not to visually provide meaningful information (e.g. an image displayed on a screen when the music is reproduced on Windows Media Player), and when only a sound is output through a speaker of a terminal, the screen of the computer 9000 may display a keyword advertisement content based on a commercial tag of the present invention. For example, it is assumed that in a live radio program, a guest and a host talk about the Apple iPod and the contents of the radio program are wirely/wirelessly transmitted to the user computer 9000. At this time, a commercial tag generator in a radio broadcasting station can generate a commercial tag, such as “Apple”, “iPod”, and “iPod nano”, even during the live radio broadcasting, and store the generated commercial tag in a radio broadcasting station system (the multimedia content service system 1000 of the present invention). When the spirit of the present invention is executed with the commercial tag, such as “Apple”, “iPod”, and “iPod nano”, it is possible to expose a keyword advertisement content related to the commercial tag on the user computer 9000.

Real Time Commercial Tag

Hereinafter, the spirit of the present invention will be described in detail based on the broadcasting. The broadcasting is generally divided into radio broadcasting and TV broadcasting, and a broadcasted content includes a live broadcast and a recorded broadcast. The broadcasting system can be understood as one of the multimedia content service system 1000 of the present invention for the easy understanding of the spirit of the present invention. The radio broadcasting is a sound-centered broadcasting and the TV broadcasting includes a video. Newspapers companies recently include images and moving pictures in addition to news articles in newspapers, and such a fusion-type broadcasting can be a broadcasting of the present invention. Further, the provision of a content including a sound and/or an image content to nonspecific people (accessing a broadcasting system of a one-person media broadcasting station or an individual) by a one-person media broadcasting station, such as www.aprica.com, or an individual may be the broadcasting. According to the development of the digital network 8000, a boundary of convergence of the communication and the broadcasting is factually degraded. For example, a controversy about whether video images provided in www.youtube.com are the broadcasting or the communication is related to the degradation of a classical boundary between the communication and the broadcasting.

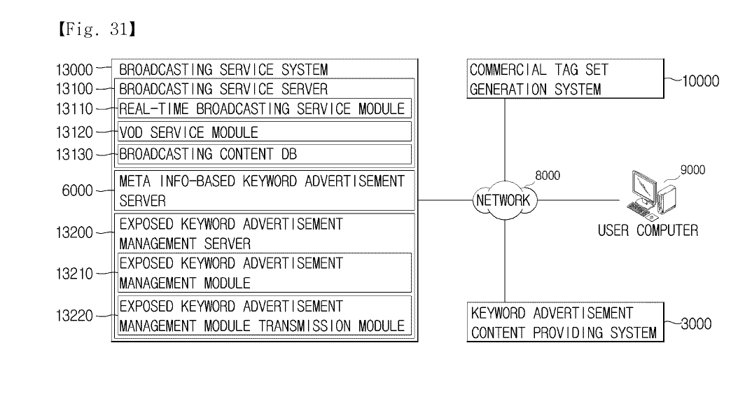

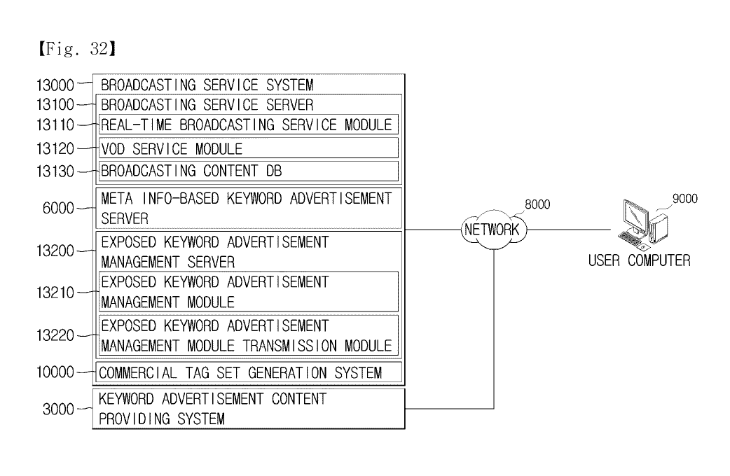

First, the radio broadcasting system and the TV broadcasting system will be described. The broadcasting system providing a broadcast by using the wired/wireless communication means according to the present invention transfers a broadcasting content to users through the IPTV, a website (e.g. www.kbs.co.kr), an exclusive broadcast viewing program (e.g. GomTV program) installed on the user computer 9000, or a multimedia reproduction program (e.g. Gom Player, Windows Media Player) installed on the user computer 9000. When the spirit of the present invention is applied to the broadcasting system during the transference of the broadcasting content to the user computer 9000, a keyword advertisement content based on a commercial tag for the broadcasting content is exposed on the user computer 9000. A commercial tag based on the broadcasting content is generated by the commercial tag set generation system 10000. Hereinafter, the broadcasting service system 13000 and the commercial tag set generation system 10000 will be described with reference to FIGS. 31 and 32 in more detail.

FIG. 31 illustrates the broadcasting service system 13000 according to an embodiment of the present invention. The broadcasting service system 13000 includes a broadcasting service server 13100 providing a broadcast on the internet and the meta information based keyword advertisement server 6000 obtaining a keyword advertisement content based on a commercial tag serving as meta information and processing the obtained keyword advertisement content. The commercial tag set generation system 10000 can be included in the broadcasting service system 13000 as shown in FIG. 32 and also included outside of the broadcasting service system 13000 as shown in FIG. 31. The broadcasting service system 13000 further includes at least one of a real-time broadcasting service module 13110 charging in the real-time broadcasting and a VOD service module 13120 providing the VOD service. With regard to this, the broadcasting service server 13100 may further include a broadcasting content DB 13130. The broadcasting content DB 13130 is necessary when the broadcasting service system 13000 includes the VOD service module 13120, but the broadcasting service server 13100 preferably includes the broadcasting content DB 13130 when the broadcasting service system 13000 includes only the real-time broadcasting service module 13110 (the broadcasting content DB 13130 is necessary for the VOD of a rebroadcast content and a real-time broadcasting content). A keyword advertisement target text processed by the meta information based keyword advertisement server 6000 in the broadcasting service system 13000 corresponds to a commercial tag. In the internal commercial tag set generation system 10000, a person in connection with a broadcasting station or a person designated by a person in connection with a broadcasting station generates a commercial tag for his/her own broadcasting, and in the external commercial tag set generation system 10000, at least one advertisement expert or the third person related to the broadcasting station generates a commercial tag by using the commercial tag set generation system 10000.

There are three kinds of broadcastings to which the spirit of the present invention is applied. The first one is a real-time broadcasting, such as a sports live relay, the second one is a recorded broadcasting or a non-real time broadcasting of an edited broadcasting content, and the third one is a VOD broadcasting of an previously broadcasted contents and other broadcasting contents. In relation to the broadcasting, a commercial tag for the first kind of the broadcasting is generated in real time, and a commercial tag for the second kind of the broadcasting 1) is generated during the progress of the broadcasting and/or 2) is previously generated prior to the progress of the broadcasting. The third kind of the broadcasting is preferable to use the previously generated commercial tag when the commercial tag for the second kind of the broadcasting has been generated, because the VOD has been already once broadcasted. However, in a special case in which there is no generated commercial tag or people demanding a specific VOD suddenly increase, the commercial tag for the third kind of the broadcasting can be generated at an initial time of providing the VOD, a specific one time, every predetermined time unit, or every time. When the commercial tag set generation system 10000 has generated a commercial tag set only one time in the unit of the VOD, it is possible to use the previously generated commercial tag set in every transmission of the same VOD. When the time substantially passes, the advertisement environment may be changed, so that the commercial tag set generation system 10000 can re-generate a commercial tag set for the same VOD.

When a broadcasting, such as a real-time broadcasting, a recorded broadcasting, or a broadcasting of an edited content, is progressed, a person using the commercial tag set generation system 10000 can generate at least one commercial tag set corresponding to a specific broadcasting content while viewing the specific broadcasting content (generally referred to as a broadcasting program in a broadcasting business) (for example, a PD, an AD, or other people in connection with the broadcasting, a sponsor company, and a person of a one-person broadcasting can directly generate a commercial tag set). However, if the broadcasting is an edited broadcasting program, such as a recorded broadcasting or a drama, other than a live broadcasting, of which the edition has been already completed prior to the broadcasting time, a person using the commercial tag set generation system 10000 can previously generate the commercial tag set (preferably the time dependent commercial tag set) while viewing in advance the recorded broadcasting, which has been fully described in the description of the commercial tag set generation system 10000.

In the meantime, when a broadcasting is in real time or a commercial tag has not been previously generated, a commercial tag has to be generated at the same time or in a slight time delay with the transmission of a broadcasting content. A user of the commercial tag set generation system 10000 inputs multiple commercial tag candidates in the commercial tag set generation system 10000 while viewing the transmitted broadcasting content. At this time, the inputted commercial tag candidate is determined as a commercial tag without the verification or through the verification of its commerciality. The verification of the commerciality has been described.

When the commercial tag set in relation to the broadcasting program has been already generated (in a case in which a commercial tag set has been previously generated in the VOD and the recorded broadcasting/edited broadcasting program broadcasting), the commercial tag set can be transmitted to the user computer 9000 one time or in the predetermined unit (in the unit based on the change of commercial tag set contents, in the unit based on an exposure time, or a predetermined unit (e.g. in the unit of one minute). When the commercial tag set is transmitted at least one time, the user computer 9000 requests the commercial tag set according to a preset reference and the broadcasting service system 13000 transmits the commercial tag set in response to the request. The previously generated commercial tag set may be treated the same as the time dependent commercial tag in relation to the broadcasting program (time zone information may not be included in the commercial tag constituting the commercial tag set in an extreme case, but the general broadcasting is in the unit of several minutes, so that the time dependent commercial tag capable of being corresponded to broadcasting contents changed due to the large changed contents may be more preferable). Therefore, the module controlling the keyword advertisement of the present invention, such as the keyword advertisement control module 6900 of the user computer 9000 and the keyword advertisement control module 6900 of the meta information based keyword advertisement server 6000 included in the broadcasting service system 13000, uses the commercial tag corresponding to the time according to the passage of the time of the broadcasting program by using time zone information (including frame number information of an image, but the time zone information and the frame number information are interconvertable) related to the commercial tag, so as to implement the advertisement method of the present invention. Especially, when the user can optionally select a broadcasting section, such as the VOD, the module calculates time zone information corresponding to the selectable broadcasting section and uses a commercial tag corresponding to the time zone information. For example, when the selected section by the user is 10 minutes and 11 seconds based on a start time point, the module searches for and uses the time dependent commercial tag set corresponding to 10 minutes and 11 seconds (for example, when the commercial tag set #5 is assumed to correspond to from 10 minutes to 12 minutes and 30 seconds, the commercial tag set #5 is the time dependent commercial tag set corresponding to 10 minutes and 11 seconds). It is apparent to those skilled in the art that the spirit of the present paragraph can be applied to a movie or all of the moving pictures (excluding the on-the-spot broadcasting moving picture) capable of adopting the time scroll among the moving pictures of the multimedia content service system 1000, such as www.youtube.com.

In the meantime, when the commercial tag set is generated in real time according to the broadcasting passage in relation to the broadcasting program (when a commercial tag set is generated during the real-time broadcasting or the broadcasting of the recorded/edited broadcasting program), the commercial tag set generates n commercial tag sets according to the passage of time. At this time, the commercial tag set is generated in real time so that it cannot recognize a commercial tag set generated after a specific broadcasting time. In this case, there are three representative embodiments in relation to the transmission of the commercial tag set.

First, the commercial tag set is transmitted in a push type of the broadcasting service system 13000, in which when at least one commercial tag set has been generated, the broadcasting service system 13000 provides the user computer 9000 with the commercial tag set individually or in the unit of several commercial tag sets as soon as the commercial tag set is generated. The push type of the broadcasting service system 13000 can be applied to a case in which an exclusive player (Gom Player, Windows Media Player) is installed on the user computer 9000 and the exclusive player maintains the connection with the broadcasting service system 13000. However, in the conventional web scheme, a client requests information and receives the requested information, and then interrupts the connection, and it is not generally allowed to transmit connection request information to the client by a server side, so that there is a technical difficulty in applying the push type of the broadcasting service system 13000 to the conventional web scheme. However, in a push type of the broadcasting service system 13000, the broadcasting service system 13000 being aware of the generation time of the commercial tag set, not the user computer not being aware of the generation time of the commercial tag set, controls so that the push type can simply control the transmission of the commercial tag set.

Second, the commercial tag set is transmitted in a pull type of the user computer 9000, in which the user computer 9000 inquires of the broadcasting service system 13000 about the transmission of the commercial tag set according to each of the present references and the broadcasting service system 13000 responses to the inquiry, and when a transmission condition of a new commercial tag set is satisfied, transmits at least one commercial tag set to the user computer 9000. The pull type of the user computer 9000 is appropriate for a broadcasting program providing scheme through the conventional web, but it has a problem in that the user computer 9000 has to frequently inquire of the broadcasting service system 13000. In this case, there is a problem of the overload of the broadcasting service system 13000. For example, the user computer 9000 inquires of the broadcasting service system 13000 in the unit of 30 seconds, and the broadcasting service system 13000 responses to the inquiries in the unit of 30 seconds. The broadcasting service system 13000 transmits information representing that there is no commercial tag set to be newly transmitted when there is no commercial tag set to be newly transmitted. In this case, the user computer 9000 can implement the advertisement method of the present invention by using the commercial tag set obtained in the just previous time or in the past.

Second, the commercial tag set is transmitted in a hybrid type, in which a type in which the user computer 9000 inquires of the broadcasting service system 13000 in a preset time unit or a preset reference unit is combined with a type in which the broadcasting service system 13000 request an inquiry in a preset time unit or a preset reference unit (for example, in the unit of 30 seconds for a specific broadcasting program and in the unit of two minutes for another broadcasting programs) or a type in which the broadcasting service system 13000 provides the user computer 9000 with information for the request of the commercial tag set, such as information representing that a next commercial tag set has to be requested in one minute, while providing the first commercial tag set. Further, the commercial tag set is transmitted by using a time delay advertisement model, which intentionally delays the time of obtaining a keyword advertisement content with a commercial tag set by a preset time unit. When the user computer 9000 obtains a new commercial tag set, the user computer 9000 does not execute the advertisement method of the present invention with the commercial tag, but delays the implementation by a preset time unit, such as 30 seconds or one minute, or executes the advertisement method of the present invention with the previously obtained commercial tag set when it obtains a next commercial tag set from the broadcasting service system 13000. Therefore, the method of setting a slight time delay between the broadcasting contents and the advertisement contents can advantageously generate higher advertising effect, such as the higher click rate.

When the commercial tag set is generated in real time according to the broadcasting passage in relation to the broadcasting program, the commercial tag set includes time zone information. When the broadcasting service system 13000 transmits the commercial tag set related to the broadcasting of the broadcasting program to the user computer, it does not matter that the commercial tag set includes no time zone information, and even if the time zone information is included in the commercial tag set and is transmitted to the user computer 9000, there is no special advantage, except for a special case. However, in this case, the broadcasting service system 13000 can use such a broadcasting program for the VOD, the rebroadcasting, and other services related to the broadcasting program (the division, the edition of highlight parts, the uploading of the broadcasting program to another multimedia content service system 1000, etc.), so that it is advantageous to include time zone information in the generated commercial tag set and store the commercial tag set. The commercial tag in this case can be named as the real time commercial tag (real time CT).

The commercial tag set can be transmitted to the user computer 9000 one time or in the predetermined unit (in the unit based on the change of commercial tag set contents, in the unit based on an exposure time, or a predetermined unit (e.g. in the unit of one minute). When the commercial tag set is transmitted at least one time, the user computer 9000 requests the commercial tag set according to a preset reference and the broadcasting service system 13000 transmits the commercial tag set in response to the request. The previously generated commercial tag set may be treated the same as the time dependent commercial tag in relation to the broadcasting program (time zone information may not be included in the commercial tag constituting the commercial tag set in an extreme case, but the general broadcasting is in the unit of several minutes, so that the time dependent commercial tag capable of being corresponded to broadcasting contents changed due to the large changed contents may be more preferable). Therefore, the module controlling the keyword advertisement of the present invention, such as the keyword advertisement control module 6900 of the user computer 9000 and the keyword advertisement control module 6900 of the meta information based keyword advertisement server 6000 included in the broadcasting service system 13000, uses the commercial tag corresponding to the time according to the passage of the time of the broadcasting program by using time zone information (including frame number information of an image, but the time zone information and the frame number information are interconvertable) related to the commercial tag, so as to implement the advertisement method of the present invention. Especially, when the user can optionally select a broadcasting section, such as the VOD, the module calculates time zone information corresponding to the selectable broadcasting section and uses a commercial tag corresponding to the time zone information. For example, when the selected section by the user is 10 minutes and 11 seconds based on a start time point, the module searches for and uses the time dependent commercial tag set corresponding to 10 minutes and 11 seconds (for example, when the commercial tag set #5 is assumed to correspond to from 10 minutes to 12 minutes and 30 seconds, the commercial tag set #5 is the time dependent commercial tag set corresponding to 10 minutes and 11 seconds). It is apparent to those skilled in the art that the spirit of the present paragraph can be applied to a movie or all of the moving pictures (excluding the on-the-spot broadcasting moving picture) capable of adopting the time scroll among the moving pictures of the multimedia content service system 1000, such as www.youtube.com.

The broadcasting service system 13000 includes a web TV/internet TV providing a TV broadcasting through a web, and the IPTV, and a radio broadcasting provided through the web/internet. The spirit of the present invention is applied to the broadcasting program played on an exclusive program or a general web browser.

The general construction and operational method of the real-time multimedia content service system 14000 are corresponding to those of the broadcasting service system 13000. The real-time multimedia content service system 14000 includes a system, which cannot be named as a television broadcasting station or a radio broadcasting station, providing the user computer 9000 with multimedia contents in real time through the web/internet or in the wired/wireless scheme, such as a single-person media medium including www.aprica.com (even if this cannot be determined as the broadcasting, the medium is definitely the real-time multimedia content service system 14000), the providing of real time multimedia contents including images/voices by an on-line newspaper company, a blog, etc., and the on-the-spot broadcasting (mainly performed by a single person) of the sports or performances voluntarily performed by amateurs. The commercial tag can be used 1) without the time limitation or 2) in a specific time zone. It is assumed that a talk program about a trend product is currently broadcasted and a talk about the fashion of the iPod is represented in a specific time. At this time, the user of the commercial tag set generation system 10000 generates a first commercial tag, such as “Apple”, “iPod”, and “iPod nano”, and uses at least one of the generated commercial tags as a keyword advertisement target text, to expose a keyword advertisement content on the user computer 9000. At this time, the user of the commercial tag set generation system 10000 is necessary to determine an end time point of the use of the first commercial tag, such as “Apple”, “iPod”, and “iPod nano”. For example, when a talk about the fashion of eco-friendly automobiles is progressed after a time slightly passes, the first commercial tag, such as “Apple”, “iPod”, and “iPod nano” is not related to the currently broadcasted contents. Therefore, it is necessary the use of a second commercial, such as “Prius”, during the viewing of the broadcasting contents. At this time, the end time point of the use of the first commercial tag 1) is selected by the user of the commercial tag set generation system 10000 regardless of an input time of the second commercial tag, 2) is automatically determined when the second commercial tag has been input, 3) is compulsive by the user of the commercial tag set generation system 10000 or a broadcasting manager, or 4) is determined by combining the methods 1) to 3). When a broadcasting continuity, such as news, is finely composed and a broadcasting program is progressed according to the continuity, it is possible to know the end time point of a specific contents broadcasting (for example, when it is possible to know information that the talk about the “iPod” will be broadcasted for 2 minutes and 30 seconds), so that the method 1) is efficient. Especially, when the broadcasting is an edited broadcasting or a recorded broadcasting, the broadcasting manager (a PD, an AD, or a manager of a commercial tag-based broadcasting advertisement that may be created when the present invention would be implemented)) recognizes a valid limited time of the first commercial tag, so that the method 1) would be more efficient. The method 2) automatically stops the use of the first commercial tag and uses the second commercial tag when the second commercial tag is inputted or authorized, or a command of the use of the second commercial tag is inputted. The method 2) is especially efficient for the live broadcasting, but if the advertisement expert (e.g. the manager of a commercial tag-based broadcasting advertisement) inputs a commercial tag even though the broadcasting is an edited broadcasting or a recorded broadcasting, the method 2) would be efficient. In the method 1), the use of the first commercial tag is stopped as soon as the second commercial tag is inputted. Therefore, when an expected advertisement effect of the second commercial tag is smaller than that of the first commercial tag, the use of the commercial tag is changed in real time, so that it is disadvantageously difficult to return the use of the first commercial tag. In order to return to the use of the first commercial tag, it may be possible if a third commercial tag is identically set with the first commercial tag. If the keyword advertisement content display area is sufficiently large, the user computer 9000 can simultaneously expose a keyword advertisement content set related to the first commercial tag and a keyword advertisement content set related to the second commercial tag, which is identically applied to a keyword advertisement content set related to an n^{th} commercial tag. In this case, when the keyword advertisement content display area is too long, a scroll can be set in the keyword advertisement content display area, so that it is possible to view n independent keyword advertisement content sets related to a single broadcasting and also view the previous keyword advertisement content set after the completion of the broadcasting or during the broadcasting through the scrolling the area. At this time, it is preferred that the keyword advertisement content set related to currently broadcasted contents is anchored so as for the user to easily return to the current keyword advertisement content set if the user scrolls the area. The method 3) of the compulsive ending the use of the first commercial tag is used in the case i) where the number of keyword advertisement contents is too small, 2) where a keyword advertisement content violating a specific standard, such as the public attributes standard or the lasciviousness standard, is included, and iii) where the commerciality of the commercial tag to be compulsively ended is degraded. When the use of the specific commercial tag is compulsively ended, a keyword advertisement content based on the just previous commercial tag is preferably exposed on the user computer 9000. The display of all of n keyword advertisement content sets related to the first to n^{th} commercial tag exposed on the user computer 9000 in the scroll scheme is used in n keyword advertisement content sets using the time dependent commercial tag set for a specific multimedia content, as well as the broadcasting (at least one keyword advertisement content set for a single commercial tag or a single commercial tag set can be provided to the user computer 9000, but for the convenience of description, the one-to-one corresponding between the commercial tag or commercial tag set and the keyword advertisement content set would be described, but the one-to-n corresponding is not excluded), which will be described in more detail. For example, when 10 keyword advertisement content sets for a specific drama, a specific movie, or a long moving picture have been provided to the user computer 9000 and the provided n keyword advertisement content sets are scrolled, the user can scroll up and click the keyword advertisement content when the user is interested in the keyword advertisement content viewed in a previous time zone. The advertisement of the keyword advertisement content according to the present invention has the large contents relation with the multimedia content that the user viewed and information, so that the user can find the keyword advertisement content previously transmitted to the user's terminal. However, in a case in which the user desires to view the total n keyword advertisement content sets, when the user presses an entire view button between an expansion button and an entire view button included in the keyword advertisement content display area including the scroll, it is possible to provide a function of displaying all of the keyword advertisement content sets provided to the user computer 9000. All of the keyword advertisement content sets can be displayed by 1) a method processed in the user computer 9000, such as caching and storing the keyword advertisement content sets in the user computer 9000, 2) a method in which when an entire view is requested from the user computer 9000, the multimedia content service system 1000 retransmits all of the transmitted keyword advertisement content to the user computer 9000, and 3) a method of using a cookie. It is a matter of course that a program for the above function has to be installed on the user computer 9000 or a code providing the above function has to be provided from the multimedia content service system 1000, etc. to the user computer 9000. For example, it is necessary to store the transmitted n keyword advertisement content sets in a cache or a preset space of the user computer 9000 for the method 1), and when the user selects the entire view, the user computer 9000 can expose the stored n keyword advertisement content sets to the user. For example, in the method 2), the multimedia content service system 1000 (the broadcasting system) has recognized n commercial tag sets used for the calling of the keyword advertisement content, so that the multimedia content service system 1000 sequentially or once exposes the n keyword advertisement content sets corresponding to each of the n commercial tag sets to the user computer 9000 by using the n commercial tag sets. At this time, if the AJAX technology is used, it is possible to efficiently expose the entire n keyword advertisement content sets. For example, when the entire view is selected from the user computer 9000, the multimedia content service system 1000 transmits n commercial tag sets to the user computer 9000, sequentially obtains keyword advertisement content sets corresponding to the first commercial tag set through the n^{th} commercial tag set from the user computer 9000, and exposes the obtained keyword advertisement contents to be viewed as a single content to the user computer 9000. A code (program) performing such a function has to be installed on the user computer 9000. For example, when a cookie is used, such as in the method 3), it is possible to store various information in the cookie according to the setting by the multimedia content service system 1000 and store a commercial tag or the keyword advertisement content set in the cookie. It is apparent to those skilled in the art that the spirit of the invention described in this paragraph is applied not only the commercial tag, but also a general tag and meta information included in a multimedia content. The spirit of the invention is more useful when the viewer desires to view all of the advertisements related to the multimedia content after the reproduction of a relatively long multimedia content, such as a drama and a movie, is finished. Especially, when a special action, such as the book mark or the store and selection, for a specific keyword advertisement content set (including a specific commercial tag when a commercial tag corresponding to the keyword advertisement content set is exposed) is generated in the user computer 9000, it may display only the keyword advertisement content sets corresponding to the special action in the entire view. In this case, it is possible to store the keyword advertisement content sets corresponding to the special action (or the commercial tag corresponding to the keyword advertisement content sets) (it may store only the ID) and expose only the stored keyword advertisement content sets corresponding to the special action.

Especially, the spirit of the present invention is more efficient to the broadcasting system providing the radio broadcasting through the internet. The broadcasting system generally installs a special program for the radio broadcasting through the internet on the user computer 9000 or provides the radio broadcasting through a specially designed web page for the radio broadcasting. The radio is an auditory medium, so that the screen provided by the program or the web page for the radio broadcasting has the short number of variable contents of which the contents are changed in relation with the radio broadcasting. In this case, the change of the screen is little, so that the attention to the screen is decreased. At this time, when n keyword advertisement content sets in relation to the radio broadcasting contents are provided, 1) the attention to the screen is increased because the contents are not variable and 2) the advertisement does not much disturb the use of the multimedia content because the radio broadcasting is the auditory medium even if an advertisement content (a content advertised by an advertiser, such as a web page/website of an advertiser) of an advertiser is opened. That is, the users can visually search the advertisement content of the advertiser while listening to the radio. When the broadcasting is the visual medium, such as the TV broadcasting, the keyword advertisement content or an advertisement content of an advertiser may be visually overlapped. Therefore, when the user clicks the keyword advertisement content, it may take the measures of 1) decreasing a size of a broadcasting screen, 2) outputting only a sound in the broadcasting, or 3) temporally interrupting the broadcasting (especially, in the non-real-time broadcasting) (the real time broadcasting represents the currently broadcasted broadcasting, such as the on-air broadcasting, and the broadcasting currently transmitted on-air is the real-time broadcasting, regardless of the live broadcasting and the recorded broadcasting. Further, when the previously broadcasted and stored broadcasting content is broadcasted through the IPTV, such a broadcasting corresponds to the real time broadcasting).

Further, in the listening to the digital radio broadcasting (listening to the digitalized audio and audio broadcasting by using a device, such as a mobile phone, a digital radio device, a navigation, and a PMP), there are many cases in which the devices include the screen, so that it is possible to provide the screen with keyword advertisement contents related to a commercial tag of the present invention. To this end, a program for executing the spirit of the present invention has to be installed on the device, and the device has to be able to access the network 8000, which will be described in more detail. The broadcasting system providing the digital radio broadcasting can transmit not only an audio signal, but also a commercial tag or keyword advertisement contents based on a commercial tag to the device. The commercial tag or the keyword advertisement content may be transmitted in an additional data service scheme. The device can receive keyword advertisement contents by using the transmitted commercial tag, and display an advertisement content of an advertiser when the user clicks the keyword advertisement content.

In the meantime, the commercial tag of the present invention can be applied to contents produced for an electronic book or the distribution, which will be described in detail. The electronic book (e-book, e-magazine, a pdf book or document, etc.) is a book manufactured as an electronic medium and includes a page concept. Therefore, the commercial tag set can be generated in the unit of a page, in the unit of n pages (in a book, n pages constitutes an edition/chapter/paragraph and other pages may be the conceptual/physical division unit of a book), or in the unit of at least one paragraph within a single page. The paragraph unit is necessary because, when a screen of the electronic book is positioned at a center of a screen exposing a specific paragraph or stays at a specific paragraph for at least a preset time, and there is a commercial tag related to the paragraph, it is necessary to display at least one keyword advertisement content on a keyword advertisement content display area of the electronic book by using the commercial tag. In general, with taking a construction unit constituting contents of the electronic book, such as a page unit, a subject or section unit, a chapter unit, etc., into consideration, it is possible to generate and store at least one commercial tag set corresponding to each of the units or a bunch unit of the units. It is a matter of course that there is a unit or a bunch unit that does not correspond to the commercial tag set. At this time, when the electronic book is driven in only a special device (e.g. Amazon Kindle, to be strictly, a device in which a program capable of reproducing contents included in the electronic book is installed), the device has to provide the function of the user computer 9000, such as a function of obtaining a commercial tag from data of the electronic book, a function of obtaining a keyword advertisement content through the commercial tag, and a function of accessing an advertisement content of an advertisement when the user clicks the keyword advertisement content, so as to implement the spirit of the present invention. When the electronic book can be driven in a browser executed in the general user computer 9000 accessible to the network 8000 or in the widely usable program (the pdf viewer, etc.), a system of a person providing contents of the electronic book on the internet or the program is necessary to provide a function of obtaining a commercial tag from data of the electronic book, a function of obtaining a keyword advertisement content through the commercial tag, and a function of accessing an advertisement content of an advertisement when the user clicks the keyword advertisement content. A producer of the electronic book generates a commercial tag set corresponding to the contents of the electronic book by using the commercial tag set generation system 10000 of the present invention and 1) includes the generated commercial tag set in data constituting the electronic book or 2) stores the generated commercial tag set in a system of the producer of the electronic book (the multimedia content service system 1000 in a wide meaning), and the program driving the contents of the electronic book accesses the system of the producer of the electronic book and obtains the stored commercial tag (set). For the 2), information capable of calling the commercial tag stored in the system of the producer of the electronic book has to be included in a specific area of the contents of the electronic book. Especially, the doc file of the MS-Word appears in a new document format, such as an open document format, and the open document format includes the XML-type data structure. Therefore, the commercial tag (set) data can be effectively added to the XML-type data structure as a matter of course. At this time, the program, such as the MS Word or MS Office, may recognize the commercial tag data. That is, the meta information based keyword advertisement control server 6000 can be equipped in the program, such as the MS Word or MS Office.

In the meantime, the syndication method using the commercial tag of the present invention can be applied to the news content. The news content essentially includes 1) a text, and further includes 2) an image, 3) a moving picture, or 4) a sound. The user of the commercial tag set generation system 10000 generates at least one commercial tag set for the news content and relates the news content with the commercial tag, to store the news content and the commercial tag. The news content related with the commercial tag set can be a target content of the content syndication of the present invention. With regard to this, a pre-processing of the text-type news content for the generation of the commercial tag set will be described. The user of the commercial tag set generation system 10000 extracts multiple product names, service names, advertisement keywords, or brand names from the text type news content through passing the product/service name DB, an advertisement keyword DB, or a brand DB and verifies the commerciality of the extracted commercial tag candidates. The commercial tags verified in their commerciality may be stored together with the commercial verification information, as is the same in all of the commercial tags.

In the meantime, the syndication method using the commercial tag of the present invention can be applied to the article content. The article content essentially includes 1) a text, and further includes 2) an image, 3) a moving picture, or 4) a sound. The user of the commercial tag set generation system 10000 generates at least one commercial tag set for the article content and relates the article content with the commercial tag, to store the article content and the commercial tag. The article content related with the commercial tag set can be a target content of the content syndication of the present invention. With regard to this, a pre-processing of the text-type article content for the generation of the commercial tag set will be described. The user of the commercial tag set generation system 10000 extracts multiple product names, service names, advertisement keywords, or brand names from the text type article content through passing the product/service name DB, an advertisement keyword DB, or a brand DB and verifies the commerciality of the extracted commercial tag candidates. The commercial tags verified in their commerciality may be stored together with the commercial verification information, as is the same in all of the commercial tags.

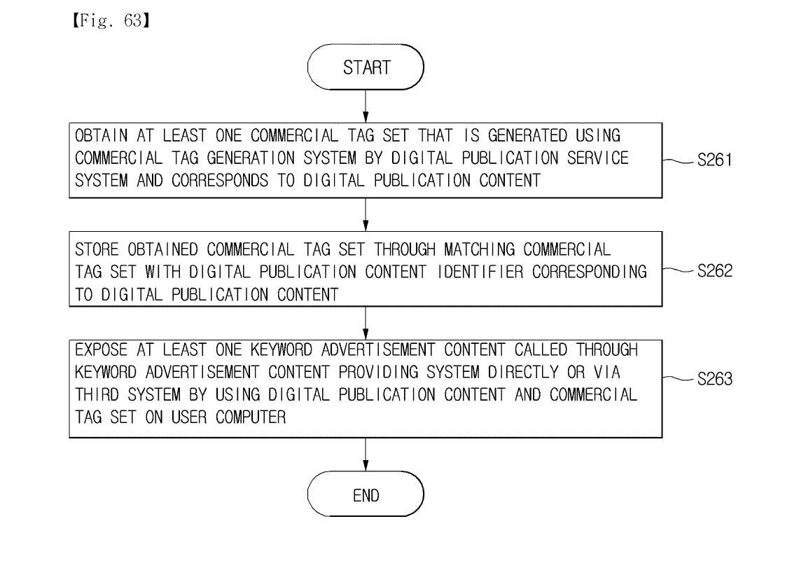

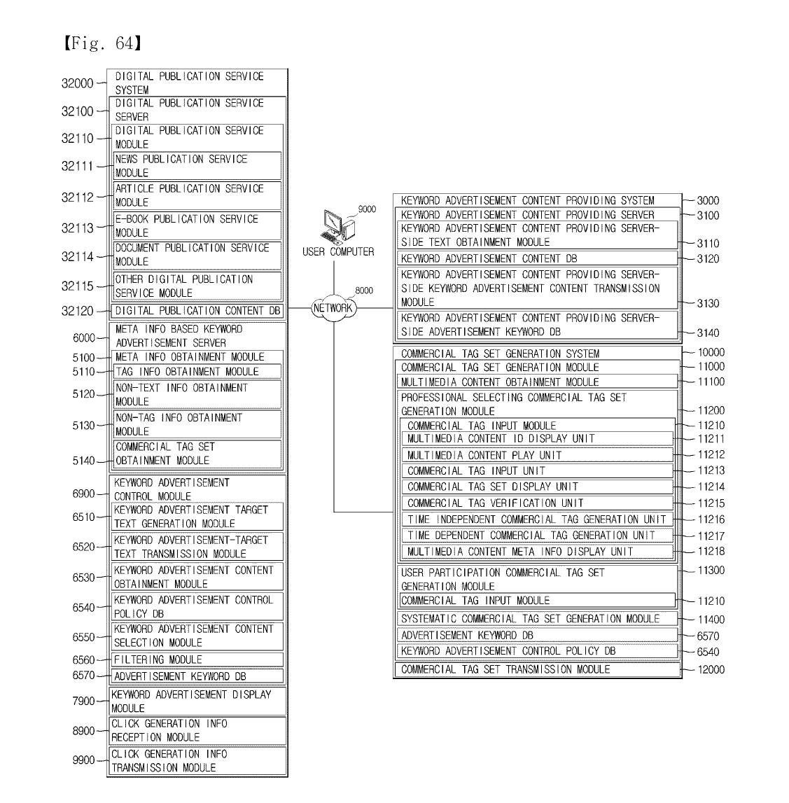

Next, the digital publication service system 32000 of the present invention will be comprehensively described with reference to FIGS. 63 and 64 in more detail. FIG. 64 illustrates the digital publication service system 32000 according to an embodiment of the present invention. The digital publication service system 32000 includes the digital publication service server 32100, and the digital publication service server 32100 includes a digital publication service module 32110 providing news, an article, an electronic book, a document, and other digital publication service and a digital publication content DB 32120 storing digital publication content data. The digital publication service module 32110 includes a news publication service module 32111 providing a news publication service, an article publication service module 32112 providing an article publication service, such as news articles, an electronic book publication service module 32113 providing an electronic book publication service, a document service module 32114 providing a document publication service, such as a pdf file, and an other digital publication service module 32115 providing an other digital publication service. The digital publication content DB 32120 may further include commercial tag set data stored in accordance with the digital publication. It is a matter of course that the commercial tag set data can be stored in a separate DB (not shown). When the digital publication service system 32000 provides only the digital publication service corresponding to the article, the digital publication service module 32110 includes only the article publication service module 32112 and the digital publication content DB 32120 mainly stores the article contents. This is the same in other digital publications. When the single digital publication service system 32000 treats two types of digital publications, the digital publication service module 32110 functions according to the treated types of the digital publications and the digital publication content DB 32120 stores the digital publication contents corresponding to the types.

The digital publication service system 32000 provides a content manager managing the digital publication contents with a function of the commercial tag set generation system 10000 which is included in or outside of the digital publication service system 32000 and provides the digital publication service system 32000 with a function. The content manager generates at least one commercial tag set (mainly the time independent commercial tag, but may be a time dependent commercial tag according to the managed content) for the managed content, such as a news article, news, an electronic book, and a document, by using a function of the commercial tag set generation system 10000. The digital publication service system 32000 stores the generated commercial tag set in the digital publication content DB 32120 based on each of the content managers in accordance with a preset storage unit. For example, the storage unit may be a content identifier, the content identifier is the URL or URI, and the dividable web page unit can be the storage unit. When multiple contents (e.g. the moving pictures and images, text-type contents) are included in the URL, the URI, or the dividable web page, the content unit can be the storage unit. The digital publication service system 32000 can allow the users (logging-in users, not-logging-in users) receiving one's service to access the digital publication managed by the content manager. The content manager can allow only the qualified user to access an entirety or a part of the digital publication content managed by the content manager and the users can access only the access-allowed digital publication content.

When the user calls a specific digital publication content (e.g. the browser, etc. if the user requests a specific URL or URI, or the dividable web page or opens a specific electronic book or a document file), the digital publication service system 32000 treats the called digital publication content like the multimedia content (moving picture) of the present invention and obtains at least one keyword advertisement content by using the commercial tag set, which has been generated by the content manager and stored in relation to the content, and exposes the obtained keyword advertisement content on the user computer 9000.

Hereinafter, a method of processing information by the digital publication service system 32000 of the present invention will be described with reference to FIG. 63 in more detail.

The method of processing information by the digital publication service system 32000 includes the steps of obtaining at least one commercial tag set corresponding to the digital publication content, the commercial tag set being generated by the digital publication service system 32000 using the commercial tag generation system, (S261), corresponding the obtained commercial tag set to a digital publication content identifier corresponding to the digital publication content and storing the commercial tag set and the digital publication content identifier (S262), and exposing the digital publication content and at least one keyword advertisement content called through the keyword advertisement content providing system 3000 by using the commercial tag set in a direct manner or via the third system on the user computer 9000 (S263).

The digital publication service system 32000 provides at least one of a news publication service publishing on-line news, an article publication service publishing an on-line article, an electronic book publication service publishing an on-line digital book or magazine, and a document publication service publishing an on-line digital document file. The digital publication content includes at least one of a digital type text, image, moving picture, and sound.

In the meantime, when the digital publication service system 32000 provides the electronic book publication service, the electronic book publication consists of at least two partial electronic book publications and the commercial tag set is generated and stored in accordance with the partial electronic book publication constituting the electronic book publication. Further, at least two partial electronic book publications belong to any one of a type including a commercial tag set corresponding to the partial electronic book publication and a type including no commercial tag set corresponding to the partial electronic book publication.

When the digital publication service system 32000 provides the news publication service, the news publication consists of at least two unit news publications and the commercial tag set is generated and stored in accordance with the unit news publication constituting the news publication. Further, at least two unit news publications belong to any one of a type including a commercial tag set corresponding to the unit news publication and a type including no commercial tag set corresponding to the unit news publication.

When the digital publication service system 32000 provides the article publication service, the article publication consists of at least two unit article publications and the commercial tag set is generated and stored in accordance with the unit article publication constituting the article publication. Further, at least two unit article publications belong to any one of a type including a commercial tag set corresponding to the unit article publication and a type including no commercial tag set corresponding to the unit article publication.

When the digital publication service system 32000 provides the document publication service, the document publication consists of at least two document pages and the commercial tag set is generated and stored in accordance with the document page constituting the document publication. Further, at least two document pages belong to any one of a type including a commercial tag set corresponding to the document page and a type including no commercial tag set corresponding to the document page.

At least one tag used for providing at least one of the existence of the keyword advertisement content and the commerciality information of the tag is generated by at least one of 1) a first method of directly inputting and generating the tag by a person operating or managing the digital publication service system 32000 or a person generating the digital publication content, 2) a second method of, with respect to the digital publication content, analyzing text information included in the digital publication content and extracting at least one tag by the commercial tag generation system, and 3) a third method of, with respect to the digital publication content, analyzing the digital publication content and extracting at least one tag by the commercial tag generation system, and receiving a selection of the tag by a person operating or managing the digital publication service system 32000 or a person generating the digital publication content.

The method of exposing the digital publication content and the keyword advertisement content on the user computer 9000 includes at least one of 1) a first method of transmitting, by the digital publication service system 32000, the commercial tag set to the keyword advertisement content providing system 3000 in a direct manner or via the third system, receiving at least one keyword advertisement content from the keyword advertisement content providing system 3000 in a direct manner or via the third system, and transmitting the digital publication content and the received keyword advertisement content to the user computer 9000, 2) a second method of transmitting, by the digital publication service system 32000, a program performing a function of obtaining the commercial tag set and a keyword advertisement content from the keyword advertisement content providing system 3000 by using the commercial tag set to the user computer 9000, transmitting, by the program, the received commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content on the user computer 9000, 3) a third method of transmitting, by the digital publication service system 32000, a program performing a function of obtaining a keyword advertisement content from the keyword advertisement content providing system 3000 by using the commercial tag set and obtaining a commercial tag set corresponding to the digital publication content to the user computer 9000, and by the program, obtaining the commercial tag set corresponding to the digital publication content, transmitting the obtained commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content to the user computer 9000, 4) a fourth method of including, by the digital publication service system 32000, a program performing a function of obtaining a keyword advertisement content from the keyword advertisement content providing system 3000 by using the commercial tag set and obtaining a commercial tag set corresponding to the digital publication content in the digital publication content and transmitting the digital publication content to the user computer 9000, and by the program, obtaining the commercial tag set corresponding to the digital publication content, transmitting the obtained commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content to the user computer 9000.

The spirit of the present invention using the commercial tag set generation system 10000 is applied to the media service system 31000 providing a service of a blog, a café, a community, one-person broadcasting, etc. The media service system 31000 can be determined as one of the multimedia content service system 1000 in a wide meaning (in this respect, the description of the function of the multimedia content service system 1000 can be applied) and provides a one-person media service, such as a blog, a community service, such as a café, a mailing service, etc. The conventional portal system is the media service system 31000 of the present invention. There is a manager (a host, an owner, or a manager, hereinafter referred to as a content manager) managing the blog or contents of the community in the blog or the community so that the content manager uploads a new content (writes a text, uploads an image including a picture, etc., attaches a moving picture) or edits his/her contents.

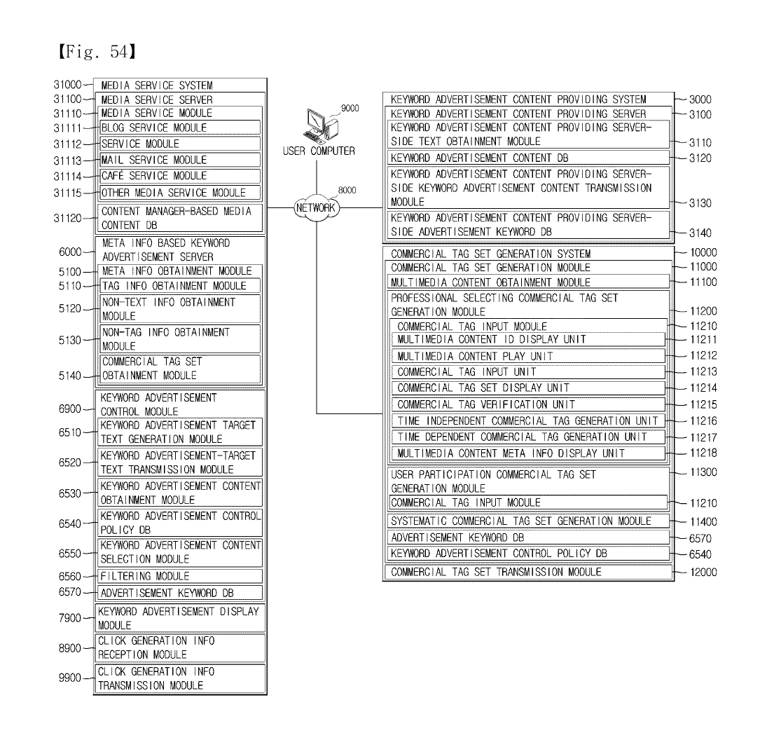

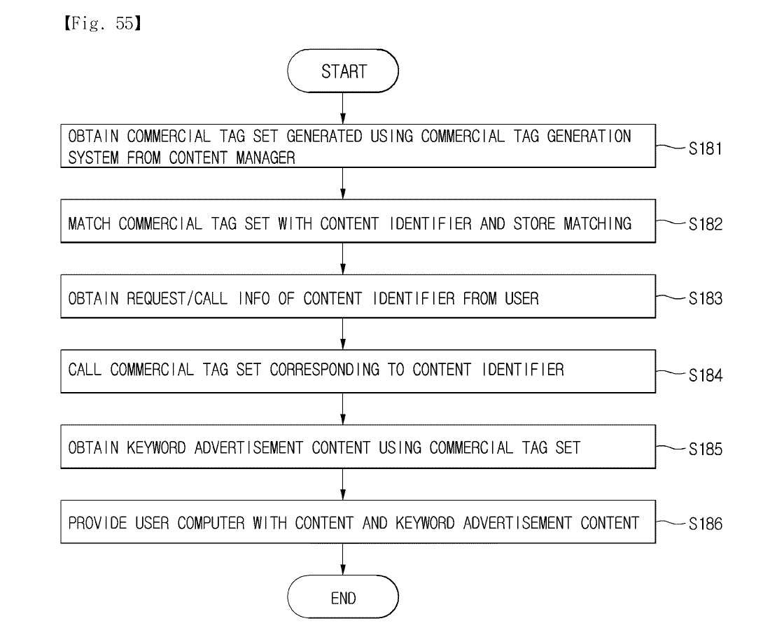

Hereinafter, the commercial tag set generation system 10000 used by the media service system 31000 will be described with reference to FIGS. 54 and 55. FIG. 54 illustrates the media service system 31000 according to an embodiment of the present invention. The media service system 31000 includes a media service server 31100, and the media service server 31100 includes a media service module 31110 providing a blog or community service and a content manager based media content DB 31120 storing content data based on each of the content managers. The media service server 31100 includes a blog service module 31111 providing a blog service, a community service module 31112 providing a community service, a mailing service module 31113 providing a mailing service, a café service module 31114 providing a café service, and other media service module 31115 providing other media services, such as a social network service and a one-person service. Further, the content manager based media content DB further includes commercial tag set data stored in accordance with the content. The commercial tag set data can be stored in a separated DB (not shown).

The media service system 31000 provides the content manager with a function of the commercial tag set generation system 10000 which is included in or outside of the media service system 31000 and provides the media service system 31000 with a function. The content manager generates at least one commercial tag set (mainly the time independent commercial tag, but may be a time dependent commercial tag according to the managed content) for the managed content, such as his/her blog, by using the function of the commercial tag set generation system 10000. The media service system 31000 stores the generated commercial tag set in the content manager based media content DB 31120 in accordance with a preset storage unit. For example, the storage unit may be a content identifier, the content identifier is the URL or URI, and the dividable web page unit can be the storage unit. When multiple contents (e.g. the moving pictures and images, text-type contents) are included in the URL, the URI, or the dividable web page, the content unit can be the storage unit. The media service system 31000 can allow the users (logging-in users, not-logging-in users) receiving one's service to access the content managed by the content manager. The content manager can allow only the qualified user to access an entirety or a part of the contents managed by the content manager and the users can access only the access-allowed content.

When the user calls a specific digital publication content (e.g. the browser, etc. of the user requests a specific URL or URI, or the dividable web page or opens a specific electronic book or a document file), the media service system 31000 treats the called content like the multimedia content (moving picture) of the present invention and obtains at least one keyword advertisement content by using the commercial tag set, which has been generated by the content manager and stored in relation to the content, and exposes the obtained keyword advertisement content to the user. In this respect, the media service system 31000 obtains an advertisement profit according to the exposure of the keyword advertisement content and a part or an entirety of the advertisement profit is provided to the content manager according to the policy of the media service system 31000.

The method of processing information by the media service system 31000 will be described with reference to FIG. 55. The method of processing information by the media service system 31000 includes the steps of obtaining at least one commercial tag set generated by using the commercial tag generation system from the content manager (S181), corresponding the obtained commercial tag set to a content identifier and storing the commercial tag set and the content identifier in the content manager based media content DB 31120 (S182), receiving request/call information for the content identifier and the content from the user computer (S183), calling the commercial tag set stored in the content manager based media content DB 31120 in accordance with the content identifier (S184), and providing the user computer with the content and the keyword advertisement content (S185).

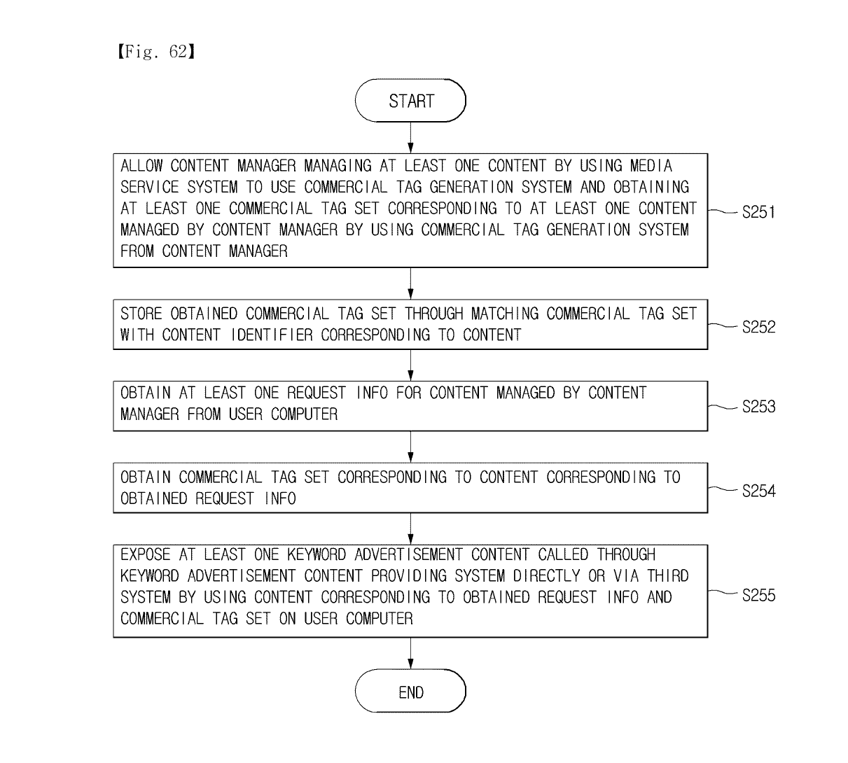

Next, the method of processing information by the media service system 31000 will be described with reference to FIG. 62 in more detail. The method of processing information by the media service system 31000 includes the steps of allowing a content manager managing at least one content to use the commercial tag generation system and obtaining at least one commercial tag set corresponding to at least one content managed by the content manager by using the commercial tag generation system from the content manager (S251), corresponding the obtained commercial tag set to a content identifier and storing the commercial tag set and the content identifier (S252), obtaining request information for the content managed by the content manager from the user computer 9000 (S253), obtaining the commercial tag set corresponding to the content corresponding to the obtained request information (S254), and exposing the content corresponding to the obtained request information and at least one keyword advertisement content called through the keyword advertisement content providing system 3000 by using the commercial tag set in a direct manner or via the third system on the user computer 9000 (S255).

The media service system 31000 provides at least one of a blog service, a community service, a social network service, and a one-person media service including a one-person broadcasting. The content manager generates and manages digital-type contents consisting of at least one of a text, an image, a moving picture, and a sound by using the blog service, the café service, the community service, and the social network service.

At least one tag used for providing at least one of the existence of the keyword advertisement content and the commerciality information of the tag is generated by at least one of 1) a first method of directly inputting and generating the tag by the content manager, 2) a second method of, with respect to the content, extracting at least one tag by the commercial tag generation system, and 3) a third method of, with respect to the digital publication content, extracting at least one tag by the commercial tag generation system, and receiving a selection of the tag from the content manager.

When the number of the tags are more than one, the commercial tag generation system preferably obtains selection information of at least one of the multiple tags from the content manager.

The method of exposing the digital publication content and the keyword advertisement content on the user computer 9000 includes at least one of 1) a first method of transmitting, by the media service system 31000, the commercial tag set to the keyword advertisement content providing system 3000 in a direct manner or via the third system, receiving at least one keyword advertisement content from the keyword advertisement content providing system 3000 in a direct manner or via the third system, and transmitting the content and the received keyword advertisement content to the user computer 9000, 2) a second method of transmitting, by the media service system 31000, a program performing a function of obtaining the commercial tag set and a keyword advertisement content from the keyword advertisement content providing system 3000 by using the commercial tag set to the user computer 9000, and transmitting, by the program, the received commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content on the user computer 9000, and 3) a third method of transmitting, by the media service system 31000, a program performing a function of obtaining a keyword advertisement content from the keyword advertisement content providing system 3000 by using the commercial tag set and obtaining a commercial tag set corresponding to the content to the user computer 9000, and by the program, obtaining the commercial tag set corresponding to the content, transmitting the obtained commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content to the user computer 9000.

When the contents, etc. included in the blog are transmitted to the third user computer 9000 or the third account for viewing in the content syndication method, such as the RSS, the media service system 31000 1) includes the keyword advertisement content obtained by using the commercial tag set in the transmitted content and transmits the content and the keyword advertisement content to the user computer 9000 or 2) includes a program performing the function of the meta information based keyword advertisement server 6000 capable of calling the commercial tag set and a keyword advertisement content by using the commercial tag set in the transmitted content or a code, etc. so as to call a program performing the function of the meta information based keyword advertisement server 6000 in the transmitted content and transmits the content to the user computer 9000.

Next, a mail, that is a special example of the content generated or managed by the content manager, will be described. A writer of the mail can correspond a commercial tag set to the mail by using the commercial tag set generation system 10000 provided by the media service system 31000. The media service system 31000 includes a keyword advertisement content obtained by using the commercial tag set in the mail and transmits the mail and the keyword advertisement content to the user computer 9000 or 2) includes a program performing the function of the meta information based keyword advertisement server 6000 so as to call the commercial tag set and a keyword advertisement content by using the commercial tag set in the transmitted mail or a code, etc. capable of calling a program performing the function of the meta information based keyword advertisement server 6000 in the transmitted mail and transmits the mail to the user computer 9000.

Next, the function of the commercial tag set generation system with respect to multiple commercial tag candidates will be described. It has been described that the commerciality can be calculated for each of the commercial tag candidates. In this respect, a commercial tag candidate is mapped with commerciality information. In this regard, the commercial tag set generation system 10000 receives a content relation score representing the degree of the relation between all of the commercial tag candidates or the selected commercial tag candidates having the commerciality equal to or higher than a preset rank/reference as a result of the mapping and the content, from the user of the commercial tag set generation system 1000, independently of the mapping. Then, the commercial tag set generation system 10000 calculates commerciality information of the commercial tag candidate including the content relation score by using a preset equation. For example, the equation is commerciality score based on the commerciality information*a content relation score or commerciality scorê2 based on the commerciality information*a content relation score. At this time, the commerciality score based on the commerciality information and the content relation score are preferably normalized. If the commerciality score based on the commerciality information and the content relation score are not normalized, a distortion may be generated when they are calculated by the equation.

Through the content syndication method by using the commercial tag according to the present invention, it is possible to circulate the content for free or at an extremely low cost and increase the circulation quantity of the contents. At this time, the commercial tag may include license information of the commercial tag set connected with the circulated content. For example, the license includes the CCL (Creative Common License). The commercial tag set can include a generator indication, the indication of whether to use for the profit purpose, and/or contents on change prohibition.

Next, as a special type of the content circulator system 16000, a commercial tag based content circulation platform system providing another application with contents, such as a moving picture, will be described.

Now, technology for multiple systems, such as the ASP, the web service, and the SOA, in related to the internet information service has been developed. Google Map, etc. has been recently developed as a platform providing another application with one's contents, services, functions, or information. Further, www.youtube.com has tried to be changed as a platform allowing another application (e.g. a specific media player, etc. reproducing a moving picture, Gom Player or Windows Media Player, distributes the enormous moving picture contents of www.youtube.com and a channel-user views the moving picture of www.youtube.com by using the program, such as, Gom Player or Windows Media Player) to access and providing the application with moving pictures.

In the commercial tag based content circulation platform system of the present invention, 1) the application is treated as a content distributor system 1000-1, 2) the commercial tag is generated by the content circulator system 16000 or the content producer system 15000, and 3) the content circulator system 16000 or the content producer system 15000 has the control authority of the commercial tag. The content circulator system 16000 or the content producer system 15000 can divide generated advertisement profits with a provider of the application. That is, the user can search for at least one content circulated or stored in the commercial tag based content circulation platform system and view the contents recommended by the commercial tag based content circulation platform system through the application. Hereinafter, the commercial tag based content circulation platform system will be described with reference to FIGS. 31 and 32 in more detail.

FIGS. 31 and 32 illustrate the broadcasting service system 13000 using the commercial tag according to an embodiment of the present invention.

The broadcasting content is one of the multimedia contents and the real-time broadcasting is one of the transmission methods of the multimedia content, so that the broadcasting service system 13000 is preferably treated as a special type of the multimedia content service system 1000. Especially, in order to emphasize the feature that the broadcasting service system 13000 is a special type of the multimedia content service system 1000, the broadcasting service system 13000 further includes the real-time broadcasting service module 13110, but the real-time broadcasting service module 13110 is not excluded in the general multimedia content service system 1000 (for example, when the multimedia content service system 1000, such as www.aprica.com provides a real-time one-person broadcasting service, such a service is one type of the multimedia content service system 1000). Therefore, the matters not referred to in this description correspond to the previous description of the multimedia content service system 1000 so as to help the understanding of the spirit of the present invention.

The broadcasting service system 13000 transmits a real-time broadcasting or VOD to the user computer 9000. The user computer 9000 includes the digital TV including the IPTV capable of accessing the network 8000, and includes various devices (a personal computer, a mobile terminal, etc.) The real-time broadcasting refers to the providing of a broadcasting program equal to contents broadcasted in real time in an on-air TV, a cable (wire) TV, or a radio based on a specific time to the user computer 9000 in real time (including the generation of a slight time delay due to the technical problems, such as broadcasting technology, data conversion, data transmission scheme). FIGS. 31 and 32 have a difference in that the commercial tag set generation system 10000 is physically or logically included in the broadcasting service system 13000 (FIG. 32) and outside of the broadcasting service system 13000 (FIG. 31).

Hereinafter, the real-time broadcasting according to the spirit of the present invention will be described in more detail.

During the real-time broadcasting, a person operating the broadcasting service system 13000 can generate a commercial tag set for a current broadcasting content by using the commercial tag set generation system 10000. It is preferred that the generated commercial tag set consists of time dependent commercial tags including time zone information, because the general broadcasting is not finished within one or two minutes, but has a treatment unit of a substantially long time (e.g. the drama has the treatment unit of at least 50 minutes), and the contents (focus, subject, background, props, emphasizing point, place, etc.) of the broadcasting program constituting the single treatment unit may be highly different according to the time. Therefore, in this case, the generation of a commercial tag appropriate for the contents of the broadcasting program according to the time and the using of the generated commercial tag provides the user viewing the broadcasting program with the optimum contents-customized advertisement content.

A person using the commercial tag set generation system 10000 generates a commercial tag set to be used at a specific time zone (Ti through Tj) by using the commercial tag set generation system 10000 while viewing the program currently broadcasted by the broadcasting service system 13000. The commercial tag set is generated through 1) inputting n commercial tag target candidates in the commercial tag set generation system 10000, 2) providing commercial verification information for the commercial tag target candidates by the commercial tag set generation system 10000, and 3) selecting m commercial tags (m≦n) by the person using the commercial tag set generation system 10000 or according to a commercial tag selection policy (the policy contents have been described in the section of the commerciality verification of the present specification) stored in the commercial tag verification unit 11215 of the commercial tag set generation system 10000.

The commercial tag set generation system 10000 adds time zone information to the selected commercial tag set and stores the commercial tag set. When it is assumed that a completion time of the selection of the n^{th} commercial tag set is Tn, the time zone information is 1) Tn−1 through Tn, 2) Tn±a preset time (it is dynamically controlled so as not to exceed Tn+1 when Tn+a preset time, and not to be less than Tn−1 when Tn−a preset time), 3) Tn, and 4) Tn through Tn+1 (the generation of the time dependent commercial tag has to be mapped with a commercial tag and time zone information, so that 1) through 4) can be always used).

The method 1) can be effectively used when the real time broadcasting is recorded and provided through the VOD service. A user of the commercial tag set generation system 10000 generates the commercial tag set while viewing the broadcasting, so that Tn is always behind the start time point of a content unit of a broadcasting related to Tn. However, the VOD has an advantage of exposing a relevant keyword advertisement content from a start time point of the content. Based on the efficiency of the method 1) for the VOD service, it is preferred that the commercial tag set selection confirmation time Tn is an end time point (select the commercial tag set as slowly as possible) of relevant contents, but for the real time broadcasting, it is preferred that Tn is close to a start time point (select the commercial tag set as fast as possible) of relevant contents. However, it is preferred that the real time broadcasting adopts the 2) or 4) method and the VOD service adopts the method 1). It is a matter of course that the time zone information does not necessarily correspond to an exposure time of a keyword advertisement content of a commercial tag set corresponding to the time zone information, and the keyword advertisement control module 6900 of the meta information based keyword advertisement server 6000 can control the exposure of the keyword advertisement content with reference to the time zone information. That is, in a case where the commercial tag set is generated by the method 4) with respect to the real time broadcasting, when the real time broadcasting is recorded and provided through the VOD service, the keyword advertisement control module 6900 can control so as to adopt the method 1) (the availability of the VOD means that all of the commercial tag sets for the broadcasting content have been already determined so that it is free to advance or postpone the exposure/use time zone of the commercial tag set by a preset time). For example, when a selection of a specific commercial tag set CTSn is completed at Tn and a time corresponding to the CTS is the 2), the time range using the CTS for calling a keyword advertisement content may be before and after the 2).

The method of generating, by the broadcasting service system 13000, the VOD including time zone information based on a commercial tag set including the real time content information and time zone information generated by the commercial tag set generation system 10000 is the same as the aforementioned method of generating the time dependent commercial tag. Specifically, the commercial tag set and time zone information related to the commercial tag set can be stored 1) like the smi file for a subtitle including a start time point+a commercial tag set+an end time point, and 2) based on meta information of the commercial tag set including data of a start time point and an end time point (their key values can be a commercial tag set ID). In addition to the two methods, there are many more computing methods for storing the commercial tag set and time zone information related to the commercial tag set. At this time, the VOD content can be one to one corresponded to a set of the commercial tag sets related to the VOD content.

Next, FIG. 31 illustrates the commercial tag set generation system 10000 logically or physically included outside of the broadcasting service system 13000. The person using the commercial tag set generation system 10000 can generate a commercial tag set by using the commercial tag set generation system 10000 through receiving a broadcasting content from the broadcasting service system 13000 (the commercial tag set generation system 10000 includes an area receiving and displaying a broadcasting content (e.g. reference number 11212 of FIG. 28)) or viewing the broadcasting content like a general user (viewer). The generated commercial tag set is transmitted to the broadcasting service system 13000. The broadcasting service system 13000 can implement the advertisement method of the present invention by using the transmitted commercial tag set. In the commercial tag set generation system 10000 of FIG. 32, the broadcasting service system 13000 allows at least one allowed outside user to access the commercial tag set of the broadcasting service system 13000 and the outside user generates a commercial tag set by using the commercial tag set generation system 10000 logically or physically included in the broadcasting service system 13000.

The VOD service module 13120 of the broadcasting service system 13000 transmits a broadcasting program to the user computer 9000 in the VOD scheme, and is a special type (for broadcasting) of the multimedia content transmission module 1120 of the multimedia content service system 1000. The VOD content is stored in the broadcasting content DB 13130, which is a special type of the multimedia content DB of the general multimedia content service system 1000.

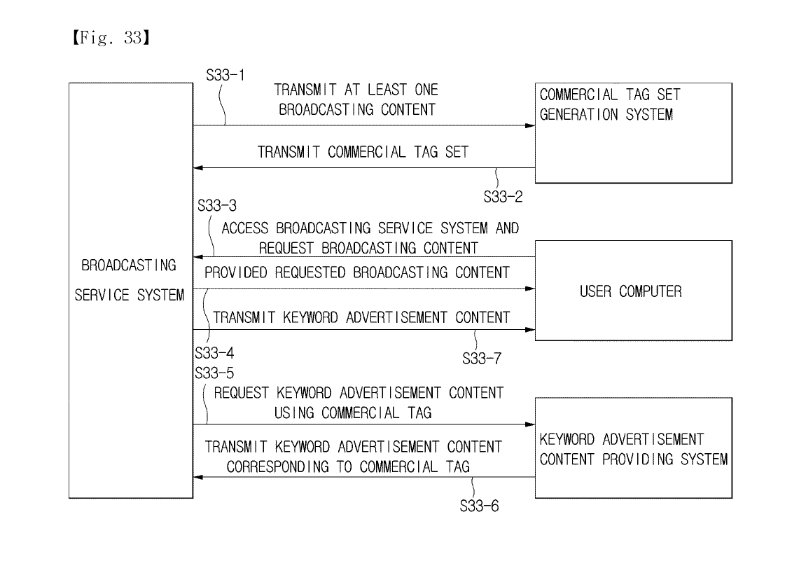

FIGS. 33 to 35 illustrate the method of processing information by the broadcasting service system 13000. The broadcasting service system 13000 transmits at least one broadcasting content to the commercial tag set generation system 10000 (S33-1), and the commercial tag set generation system 10000 transmits a commercial tag set to the broadcasting service system 13000 (S33-2). When the user computer 9000 accesses the broadcasting service system 13000 and makes a request of a broadcasting content (S33-3), the broadcasting service system 13000 provides the user computer 9000 with the requested broadcasting content (S33-4). At this time, when the broadcasting service system 13000 controls the keyword advertisement content, the broadcasting service system 13000 makes a request of a keyword advertisement content to the keyword advertisement content providing system 3000 with a commercial tag included in a commercial tag set (S33-5), receives a keyword advertisement content corresponding to the commercial tag from the keyword advertisement content providing system 3000 (S33-6), and transmits the received keyword advertisement content to the user computer 9000 (S33-7).

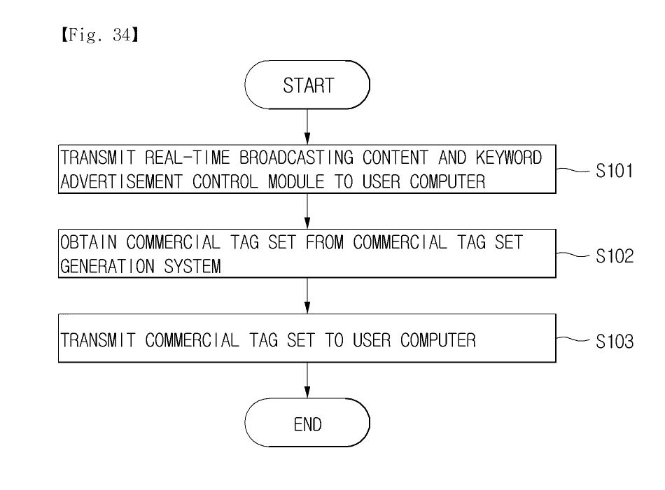

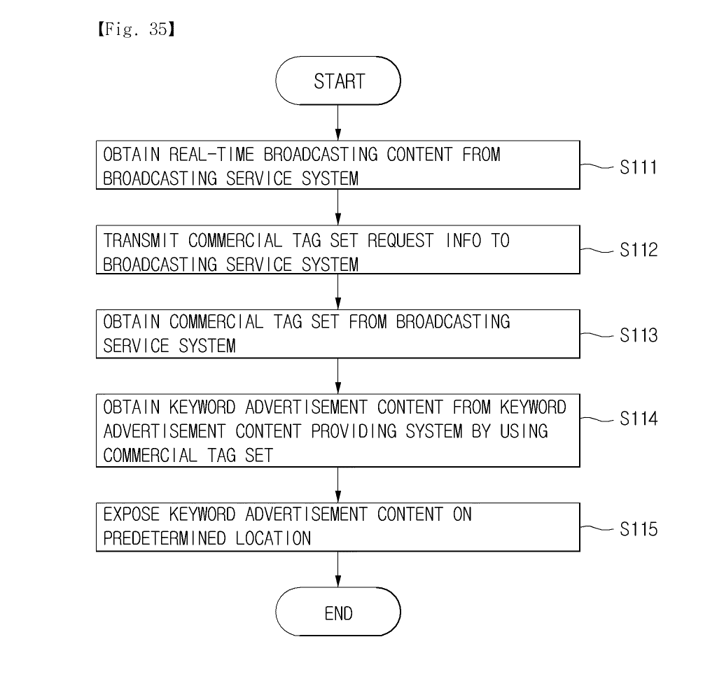

In the meantime, the keyword advertisement control module 6900 transmitted by the broadcasting service system 13000 is installed in the user computer 9000 or a program of the Java script, etc., is included in a web page provided by the broadcasting service system 13000 to the user computer 9000, so that the keyword advertisement control module 6900 or the program controls the keyword advertisement content. In the real time broadcasting, the keyword advertisement control module 6900 or the program inquires of the broadcasting service system 13000 about the existence of the commercial tag set CTSn related to the Tn in a preset time interval. The VOD includes information of all of the commercial tag sets so that the user computer 9000 can receive once all of the commercial tag sets. However, in the real time broadcasting, the user computer 9000 cannot recognize when the CTSn is generated, so that the user computer 9000 has to often inquire of the broadcasting service system 13000. When a new CTSn is generated in a special case (a case in which a broadcasting content is reproduced in an exclusive program and the exclusive program is always connected to the broadcasting service system 13000), the broadcasting service system 13000 may push the information to the user computer 9000, but due to reasons of security, etc. in the conventional web scheme, as long as the browser of the user computer 9000 does not inquire of/access the server, a method of pushing the information to the user computer 9000 by the server is hardly used. The broadcasting service system 13000 transmits the new CTSn to the user computer 9000, which is aptly illustrated in FIGS. 34 and 35. The method of transmitting a commercial tag set by the broadcasting service system 13000 includes the steps of transmitting a real time broadcasting content and the keyword advertisement control module 6900 to the user computer 9000 (S101), receiving the commercial tag set from the commercial tag set generation system 10000 (S102), and transmitting the commercial tag set to the user computer 9000 (S103). Further, the method of implementing the keyword advertisement of the present invention includes the steps of obtaining a real time broadcasting content from the broadcasting service system 13000 (S111), transmitting commercial tag set request information to the broadcasting service system 13000 (S112), receiving a commercial tag set from the broadcasting service system 13000 (S113), obtaining a keyword advertisement content from the keyword advertisement content providing system 3000 by using the commercial tag set (S114), and exposing the keyword advertisement content on a preset location (S115).

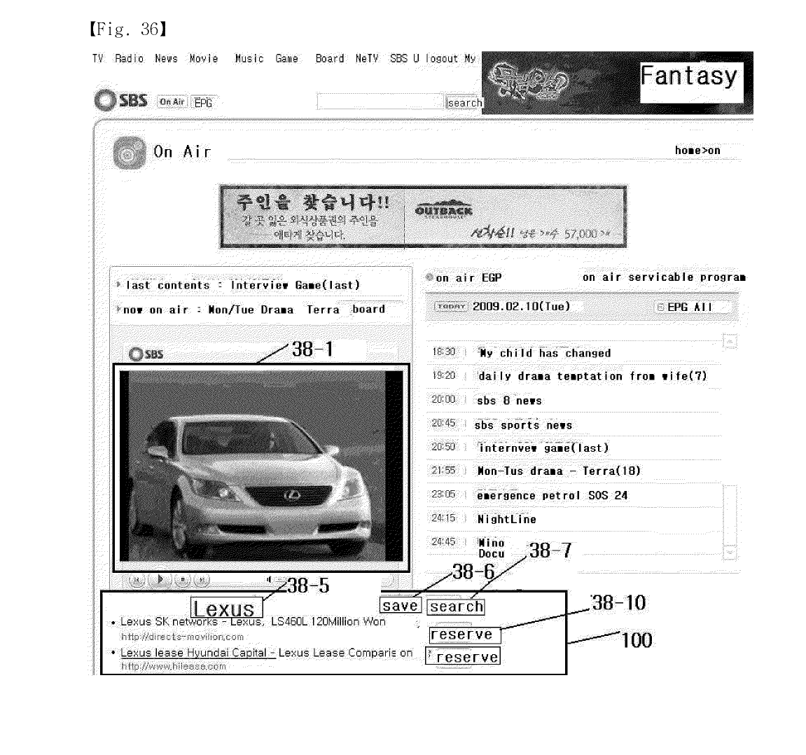

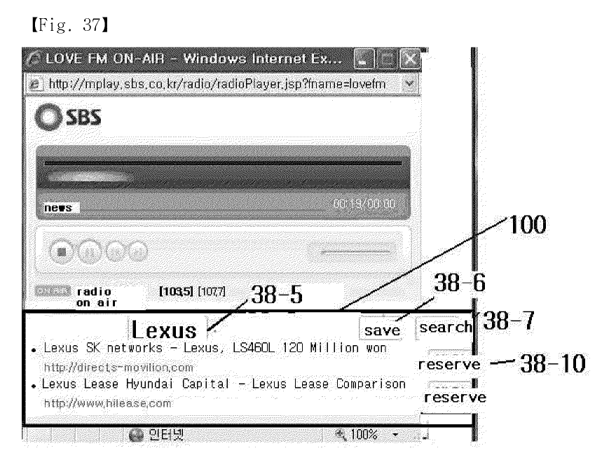

FIGS. 36 and 37 illustrate a TV broadcasting (displaying a broadcasting image) and a radio broadcasting (displaying no broadcasting image) through the wired/wireless bidirectional network according to an embodiment of the present invention. In FIG. 37, though the radio broadcasting has no broadcasting image, a user of the commercial tag set generation system 10000 can generate a commercial tag and a web page or an image for the radio broadcasting can be provided/generated/transmitted to the computer of a user listening to the radio broadcasting through the web, etc., so that it is possible to expose the keyword advertisement content of the present invention at a preset location of the web page or the screen. FIGS. 36 and 37 illustrate two keyword advertisement contents corresponding to a commercial tag “Lexus” displayed on the keyword advertisement content display area 100. When a content related to “Lexus” is transmitted in the broadcasting (e.g. a drama, a news broadcasting, a TV/radio broadcasting), a user inputs at least one keyword advertisement target text (e.g. Lexus, car, SUV, and sports car) by using the commercial tag set generation system 10000 in real time, at least one of the inputted keyword advertisement target texts is determined as a keyword advertisement target text (e.g. Lexus, and sports car), and the determined keyword advertisement target text is determined as a commercial tag (e.g. Lexus and sports car) or a commercial tag set (e.g. Lexus and sports car), so that any one of the commercial tags or commercial tag sets is used for calling the keyword advertisement content.

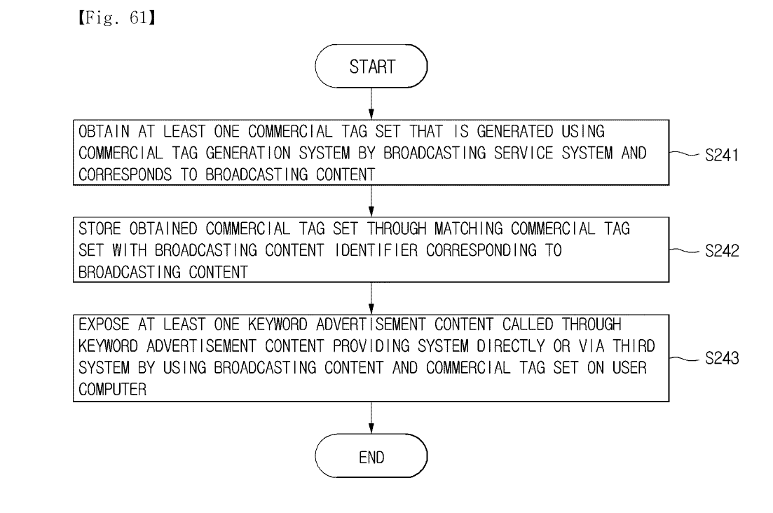

Next, a method for processing information by the broadcasting service system 13000 will be described with reference to FIG. 61 in more detail.

The method for processing information by the broadcasting service system 13000 includes the steps of obtaining at least one commercial tag set corresponding to the broadcasting content, the commercial tag set being generated by the broadcasting service system 13000 using the commercial tag generation system, (S241), corresponding the obtained commercial tag set to a broadcasting content identifier corresponding to the broadcasting content and storing the commercial tag set and the broadcasting content identifier (S242), and exposing the broadcasting content and at least one keyword advertisement content called through the keyword advertisement content providing system 3000 by using the commercial tag set in a direct manner or via the third system on the user computer 9000 (S243).

The broadcasting provided by the broadcasting service system 13000 is the real time broadcasting, the commercial tag set generated through the commercial tag generation system is a real time commercial tag set generated during the real time broadcasting, and the exposed keyword advertisement content is exposed on the user computer 9000 during the real time broadcasting.

The commercial tag set is generated by any one of 1) a first method of directly inputting a commercial tag set by a person operating or managing the broadcasting service system 13000, a person progressing the real time broadcasting, or a person entrusted by a person operating or managing the broadcasting service system 13000, 2) a second method of analyzing text information included in a continuity included in the broadcasting content and extracting at least one tag by the commercial tag generation system and receiving a selection of the tag from a person operating or managing the broadcasting service system 13000, a person progressing the real time broadcasting, or a person entrusted by a person operating or managing the broadcasting service system 13000, and 3) a third method of recognizing voice information included in the broadcasting content, analyzing text information included in the voice information, and extracting at least one tag by the commercial tag generation system and receiving a selection of the tag from a person operating or managing the broadcasting service system 13000, a person progressing the real time broadcasting, or a person entrusted by a person operating or managing the broadcasting service system 13000. In the step of corresponding the obtained commercial tag set to a broadcasting content identifier corresponding to the broadcasting content and storing the commercial tag set and the broadcasting content identifier, time zone information corresponding to the commercial tag set is included in the commercial tag set and stored.

The method of exposing the broadcasting content and the keyword advertisement content on the user computer 9000 includes at least one of 1) a first method of, by the broadcasting service system 13000, transmitting a program requesting the obtaining of a keyword advertisement content in a preset time interval to the user computer 9000, receiving a transmission request of a keyword advertisement content in a preset time interval through the program executed in the user computer 9000, transmitting the commercial tag set to the keyword advertisement content providing system 3000 in a direct manner or via the third system, receiving at least one keyword advertisement content from the keyword advertisement content providing system 3000 in a direct manner or via the third system, and transmitting the received keyword advertisement content to the user computer 9000, 2) a second method of transmitting, by the broadcasting service system 13000, a program performing a function of obtaining the commercial tag set and a keyword advertisement content from the keyword advertisement content providing system 3000 by using the commercial tag set to the user computer 9000, and transmitting, by the program, the received commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content on the user computer 9000, 3) a third method of transmitting, by the broadcasting service system 13000, a program performing a function of obtaining a keyword advertisement content from the keyword advertisement content providing system 3000 by using the commercial tag set, and making a request of a commercial tag set corresponding to the broadcasting content to the broadcasting service system 13000 in a preset time interval and obtaining the requested commercial tag set to the user computer 9000, and by the program, obtaining the commercial tag set corresponding to the broadcasting content, transmitting the obtained commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content to the user computer 9000, and 4) a fourth method of including, by the broadcasting service system 13000, a program performing a function of obtaining a keyword advertisement content from the keyword advertisement content providing system 3000 by using the commercial tag set, and making a request of a commercial tag set corresponding to the broadcasting content to the broadcasting service system 13000 in a preset time interval in the transmitted broadcasting content in the first transmission of the broadcasting content and transmitting the program to the user computer 9000, and by the program, obtaining the commercial tag set corresponding to the broadcasting content, transmitting the obtained commercial tag set to the keyword advertisement content providing system 3000 in a direct manner or via the third system, obtaining at least one keyword advertisement content from the keyword advertisement content providing system 3000 in a direct manner or via the third system, and exposing the obtained keyword advertisement content to the user computer 9000.

In the meantime, when the method 1) is used for the real time broadcasting, the broadcasting service system 13000 obtains the keyword advertisement content by using a commercial tag set corresponding to the time of obtaining a transmission request of the keyword advertisement content from the user computer 9000, and the commercial tag set corresponding to the time of obtaining a transmission request of the keyword advertisement content is preferably generated just before the time of obtaining a transmission request of the keyword advertisement content.

When the method 2) is used for the real time broadcasting, the commercial tag set is generated before the real time broadcasting, and further includes time zone information used for the obtaining of the keyword advertisement content by using the commercial tag set. The program further includes a function of selecting a commercial tag set used for the obtaining of the keyword advertisement content with reference to information of a current time at which the broadcasting content is reproduced.

When any one of the methods 3) and 4) is used for the real time broadcasting, the broadcasting service system 13000 transmits a commercial tag set corresponding to the time of obtaining a transmission request of the keyword advertisement content from the user computer 9000 to the user computer 9000 and the transmitted commercial tag set is preferably generated just before the time of obtaining a transmission request of the commercial tag set.

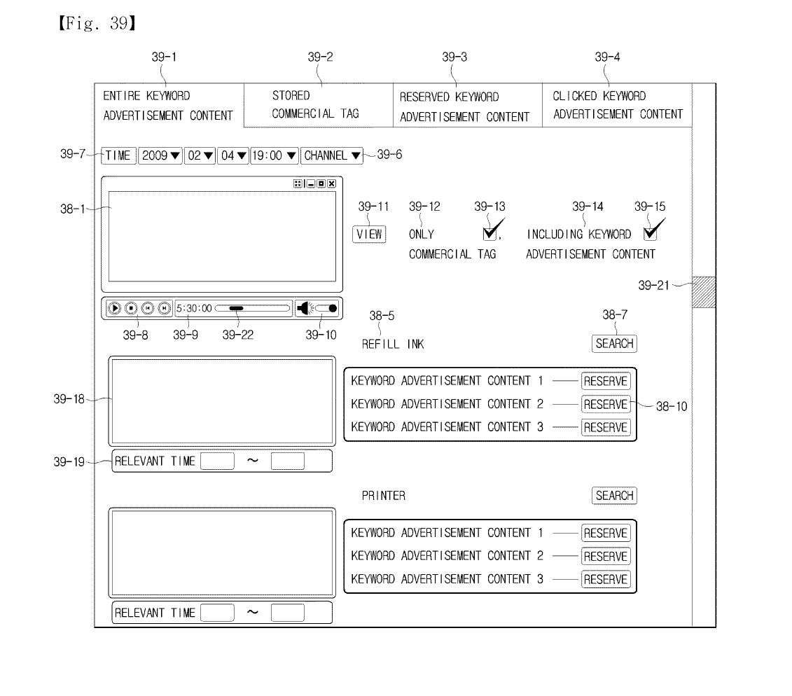

FIG. 38 illustrates a multimedia content visual interface provided by the multimedia content service system 1000 and displayed on the user computer 9000 according to an embodiment of the present invention. The multimedia content display area 38-1 is an area displaying a multimedia content. When the multimedia content is an auditory multimedia, such as radio broadcasting, music, and a sound, there may be no multimedia content display area or at least one preset image or a moving content can be displayed on the multimedia content display area 38-1. The multimedia content display area 38-1 includes a multimedia content reproduction control area 38-2 related to the reproduction of the multimedia content, a multimedia content reproduction time/section display/control area 38-3, and a sound size control area 38-4 in a lower part thereof. The multimedia content reproduction time/section display/control area 38-3 includes a reproduction location display means 38-11 indicating a location of a currently reproduced multimedia content. Further, the multimedia content display area 38-1 can further include at least one of a commercial tag display area 38-5, a commercial tag set storage means 38-6, the keyword advertisement content display area 100, and a keyword advertisement content reservation means 38-10. Further, the multimedia content display area 38-1 can further include a commercial tag using search means 38-7 for the convenience of a user. When the user clicks the commercial tag using search means 38-7, a commercial tag is transmitted to a preset searching service system (e.g. www.google.com, www.naver.com) by using commercial tag information displayed on the user computer and the search result is displayed on the user computer. At least one commercial tag or commercial tag set is displayed on the commercial tag display area 38-5. FIG. 38 illustrates the commercial tag of “refill ink”. Referring to FIG. 38, a storage button is provided as the commercial tag set storage unit 38-6, the keyword advertisement content display area 100 includes three keyword advertisement contents, and a reservation button serving as the keyword advertisement content reservation means 38-10 is provided for each of the keyword advertisement contents. When the commercial tag “refill ink” is stored, the interface and information as shown in FIG. 39 are represented.

FIGS. 39 to 43 illustrate a screen and a method for managing keyword advertisement content information exposed to the user, clicked, or corresponding to an action (reservation, etc.) from the user according to an embodiment of the present invention.

There are four methods of treating the keyword advertisement content of the present invention by the user viewing the multimedia content: 1) a first method of viewing an exposed commercial tag (including a keyword advertisement target text, as is the same hereinafter) and/or keyword advertisement content after viewing of the multimedia content; 2) a second method of storing a commercial tag capable of calling a keyword advertisement and calling the keyword advertisement content by the commercial tag later; 3) a third method of reserving a specific keyword advertisement content and exposing the reserved keyword advertisement content; and 4) a fourth method of viewing a clicked keyword advertisement content or a commercial tag related to the clicked keyword advertisement content.

For the methods 1) to 4), when the multimedia content is transmitted, it is necessary to expose a keyword advertisement content and a commercial tag related to the keyword advertisement content, add a reservation means (reservation button, etc) to each of the keyword advertisement contents, and add a storage means (storage button, etc.) next to or around the exposed commercial tag independently of the reservation means. When a search means (search button, etc) is added next to or around the commercial tag for the convenience of a user and the user clicks the search means, the multimedia content service system can 1000 transmit a commercial tag to at least one preset search engine, (e.g. www.google.com or www.naver.com) and transmit a search result to the user computer 9000.

FIG. 39 illustrates a screen for managing keyword advertisement content information exposed to the user computer 9000, clicked, or corresponding to an action (reservation, etc.) from the user according to an embodiment of the present invention. The screen of FIG. 39 is displayed on the user computer 9000 and information constituting the screen is generated by at least one of 1) the multimedia content service system 1000, 2) the Java script or other programs installed on or transmitted to the user computer 9000, 3) the content syndication system, and 4) the keyword advertisement content providing system 3000. The generation of the information is an issue of the control authority for an area displaying a keyword advertisement content, so that the generation of the information by the 1) to 4) considers that the keyword advertisement content is controlled in the multimedia content service system 1000, the user computer 9000, the content producer system 15000, the keyword advertisement content providing system 3000. The control is related to the recognition of user's actions, such as the exposure, storage, reservation, click, etc. of a commercial tag capable of calling a keyword advertisement content and the keyword advertisement contents, and time zone information (including a temporal/permanent identifier (ID), cookie information, etc.) of each of the actions.

A control system of the screen of FIG. 39 can be performed by the exposed keyword advertisement management module 13210 of the exposed keyword advertisement management server 13200 of FIGS. 31 and 32 in the broadcasting service system 13000 or the multimedia content service system 1000. The exposed keyword advertisement management module 13210 of the exposed keyword advertisement management server 13200 can be included in the content syndication system, as well as in the multimedia content service system 1000 and the multimedia content service system 1000. The exposed keyword advertisement management server 13200 can further include an exposed keyword advertisement management module transmission module 13220. The exposed keyword advertisement management module transmission module 13220 transmits the exposed keyword advertisement management module 13210 of the exposed keyword advertisement management server 13200 to the user computer 9000, to make the exposed keyword advertisement management module 13210 to perform an exposed keyword advertisement management function in the user computer 9000, which is related to the 2).

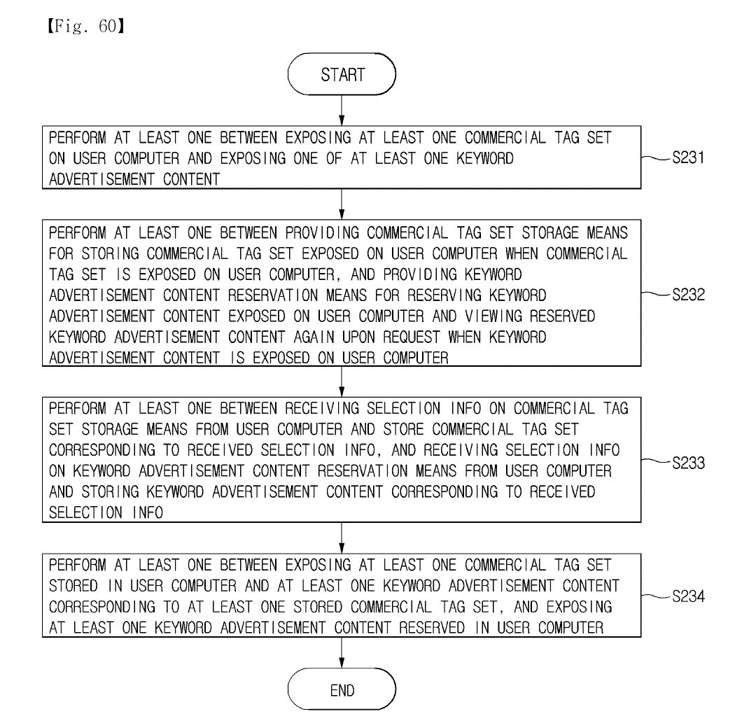

Next, a method of processing information by the exposed keyword advertisement management server 13200 will be described with reference to FIG. 60 in more detail.

The method of processing information by the exposed keyword advertisement management server 13200 includes the steps of performing at least one of exposing at least one commercial tag set on the user computer and exposing at least one keyword advertisement content (S231), performing at least one of, when the commercial tag set is exposed on the user computer 9000, providing a commercial tag set storage means storing the commercial tag set exposed on the user computer 9000, and when the keyword advertisement content is exposed on the user computer 9000, providing a keyword advertisement content reservation means which reserves the keyword advertisement content exposed on the user computer 9000 and provides the user with the reserved keyword advertisement content upon the request for the viewing (S232), performing at least one of receiving selection information of the commercial tag set storage means from the user computer 9000 and storing the commercial tag set corresponding to the received selection information, and receiving selection information of the keyword advertisement content reservation means from the user computer 9000 and storing the keyword advertisement content corresponding to the received selection information (S233), and performing at least one of exposing at least one of the stored commercial tag sets and at least one of the keyword advertisement contents corresponding to the stored commercial tag set on the user computer 9000, and exposing at least one of the reserved keyword advertisement contents on the user computer 9000 (S234).

The method of processing the information by the exposed keyword advertisement management server 13200 based on the commercial tag set and the keyword advertisement content will be described, respectively. First, the method of processing the information of the commercial tag set by the exposed keyword advertisement management server 13200 will be described. The method of processing the information of the commercial tag set by the exposed keyword advertisement management server 13200 includes the steps of exposing at least one commercial tag set on the user computer 9000, when the commercial tag set is exposed on the user computer 9000, providing a commercial tag set storage means storing the commercial tag set exposed on the user computer 9000, receiving selection information of the commercial tag set storage means from the user computer 9000 and storing the commercial tag set corresponding to the received selection information, and exposing at least one of the stored commercial tag sets and at least one keyword advertisement content corresponding to at least one of the stored commercial tag sets on the user computer 9000.

Next, the method of processing the information of the keyword advertisement content by the exposed keyword advertisement management server 13200 will be described. The method of processing the information of the keyword advertisement content by the exposed keyword advertisement management server 13200 includes the steps of exposing at least one keyword advertisement content on the user computer 9000, when the keyword advertisement content is exposed on the user computer 9000, providing the keyword advertisement content reservation means which reserves the keyword advertisement content exposed on the user computer 9000 and again provides the user with the reserved keyword advertisement content upon the request for the viewing, receiving selection information of the keyword advertisement content reservation means from the user computer 9000 and storing the keyword advertisement content corresponding to the received selection information, and exposing at least one of the reserved keyword advertisement contents on the user computer 9000.

(1) The exposed keyword advertisement management server 13200 included in a preset system processes the above steps or (2) a preset system including or using the exposed keyword advertisement management server 13200 transmits a program performing a function of the exposed keyword advertisement management server 13200 to the user computer 9000 and the program executed in the user computer 9000 performs the above steps in connection with the system. The system includes at least one of the multimedia content service system 1000 providing the user computer 9000 with multimedia contents in connection with the keyword advertisement content providing system 3000, the content syndication system 2000 managing the circulation of the multimedia contents in connection with the keyword advertisement content providing system 3000, the commercial tag set generation system 10000 generating the commercial tag set in connection with the keyword advertisement content providing system 3000, and the keyword advertisement content providing system 3000.

The commercial tag set and the keyword advertisement content are changed in connection with at least one of the reproduction time and the reproduction section of a multimedia content exposed on the user computer 9000. In the step of storing the commercial tag set corresponding to the received selection information and/or storing the keyword advertisement content corresponding to the received selection information, the exposed keyword advertisement management server 13200 includes and stores information of at least one of the reproduction time and the reproduction section of the multimedia content corresponding to the time of receiving the selection information.

In the step of exposing at least one of the stored commercial tag sets and at least one keyword advertisement content corresponding to at least one of the stored commercial tag sets on the user computer 9000 and exposing at least one of the reserved keyword advertisement contents on the user computer 9000, the method further includes at least one of 1) a first method of exposing screen information of the multimedia content corresponding to a time of storing the commercial tag set and receiving the selection information of the reservation of the keyword advertisement content on the user computer 9000 and 2) arranging at least one of the stored commercial tag sets, at least one of the keyword advertisement contents corresponding to the stored commercial tag sets, and at least one of the reserved keyword advertisement contents in order of a time of storing the commercial tag set and receiving the selection information of the reservation of the keyword advertisement content.

FIG. 39 illustrates the method of processing the information by the exposed keyword advertisement manager server 13200 according to an embodiment of the present invention. In the actual implementation, a part or a partial combination of the construction of the FIG. 39 can be implemented and other publicly known functions can be added to the part for the implementation. Hereinafter, the method of processing the information by the exposed keyword advertisement manager server 13200 will be described with reference to FIG. 39.

The screen of FIG. 39 includes four tabs, each of which is for the purpose of 1) the viewing of the entire exposed commercial tags and/or keyword advertisement contents after the viewing of the multimedia content, 2) the storing of a commercial tag capable of calling a keyword advertisement and the calling of the keyword advertisement content by the commercial tag later, 3) the reserving of a specific keyword advertisement content and the exposing of the reserved keyword advertisement content, and 4) the viewing of a clicked keyword advertisement content or a commercial tag related to the clicked keyword advertisement content. An entire keyword advertisement content tab 39-1 is related to the 1), a stored commercial tag content tab 39-2 is related to the 2), a reserved keyword advertisement content tab 39-3 is related to the 3), and a clicked keyword advertisement content tab 39-4 is related to the 4). The screen of FIG. 39 shows the 1), but the construction of the screen for the 2) to 4) is not much different from the screen for the 1), except for the displayed contents. That is, the screen for the 2) exposes only the keyword advertisement content related to the commercial tag stored by the user, other than the exposed entire commercial tags, the screen for the 3) exposes only the keyword advertisement content reserved by the user (for example, when the user reserves three keyword advertisement contents among five keyword advertisement contents corresponding to a specific commercial tag, only three keyword advertisement contents are exposed. In this case, it is necessary to expose the commercial tag related to the keyword advertisement contents), and the screen for the 4) exposes only the keyword advertisement content corresponding to the click generation in the same way of the 3). The 4) is necessary because the user clicks an interested keyword advertisement content during the viewing of the multimedia content, but the concentration to and the time consumption (directly connected with the advertising effect) for the advertisement content of the advertiser connected with the keyword advertisement content are high possibly low (the biggest interest of the user is the viewing and listening of the multimedia content so that there is a high possibility to return to the multimedia content and more so in the device having a small display screen). Therefore, it is necessary to separately manage the clicked keyword advertisement contents which are the directly expressed interest of the user.

In FIG. 39, the screen includes a time display means 39-7 and a channel display means 39-6 under the menu tab areas. Especially, when the multimedia content service system 1000 is the broadcasting service system 13000, the time display means 39-7 and the channel display means 39-6 are more necessary. Further, when the multimedia content service system 1000 maintains various channels and/or the subject system controlling the screen of FIG. 39 performs the advertisement method according to the present invention throughout a time duration (e.g. one day, one week, or over one year), the time display means 39-7 and the channel display means 39-6 are necessary. The time display means 39-7 and the channel display means 39-6 are more effective when they are included together with the multimedia content display area 38-1. For example, when a user watches a drama a of the broadcasting service system A 13000 at 7 p.m. on Feb. 3, 2009 and watches news a of the multimedia content service system B 1000 at 9 p.m. on Mar. 5, 2009, the subject system controlling the screen of FIG. 39 manages the time zone information, channel information (A, B), and multimedia content information (a, b). The multimedia content information may be a multimedia content data file itself, but is sufficient if information (e.g. URL, URI, a multimedia content ID, etc.) can call the multimedia content, because the information can call the multimedia content and display the multimedia content on the multimedia content display area 38-1. It is preferred that the multimedia content display area 38-1 further includes a stop/start button, a reproduction time/area display/control means 39-22, an interval movement means, and/or various publicly known functional means related to the reproduction and the control of the multimedia content. When the time and the channel are determined by the user, a single multimedia content to be represented on the multimedia content display area 38-1 is determined. It is assumed that a single multimedia content is determined in FIG. 39, but the exposed keyword advertisement management server 13200 of the present invention can expose n multimedia contents. It is not illustrated in FIG. 39, but with respect to n multimedia contents, a higher directory of a higher depth is generated on the screen and information of a single multimedia content as shown in FIG. 39 is arranged on a node (end node) of the directory. The higher directory is constructed by 1) a method of determining a time unit (n contents per year, m contents per month, a single content per day) and arranging k multimedia contents under a node of the time unit (watching k multimedia contents during one night), 2) arranging multimedia contents according to the type (multimedia contents are arranged according to a type of multimedia contents, such as the news, drama, sports, and each type includes multiple multimedia contents), and 3) arranging multimedia contents in a multistage tree structure according to a specific subject or a category when a multimedia content, such as a drama, has a continuity, and arranging multiple multimedia contents in an end node. When a single specific multimedia content is selected, the information of the multimedia content as shown in the screen of FIG. 39 can be provided. In a special case, it is possible to arrange commercial tag sets and keyword advertisement contents for multiple multimedia contents. For example, keyword advertisement contents related to all of the multimedia contents which the user watches during the evening of a day are provided.

The exposed keyword advertisement management server 13200 of the subject system controlling the screen of FIG. 39 provides keyword advertisement content related to the 1) to 4) and/or information of the commercial tag. At this time, the multimedia content display area 38-1 can include a view option means 39-11 by which the display of only a commercial tag 39-13 or the display of a commercial tag together with keyword advertisement contents 39-15 can be selected. When only the commercial tag is displayed, it is possible to display multiple commercial tags so that the space can be efficiently used. However, the keyword advertisement content is not directly displayed, so that a button (not shown) for calling the keyword advertisement content corresponding to the commercial tag has to be presented and then the user has to click the button for the display of the keyword advertisement content, thereby incurring the inconvenience. In the meantime, a relevant scene when a keyword advertisement content related to a specific commercial tag and/or the commercial tag is exposed and/or relevant time zone information of the relevant scene are displayed on a relevant scene display area 39-18 and a relevant time zone information display area 39-19, respectively (in which time zone information added to the time dependent commercial tag set and stored can be used). When such a relevant scene is displayed on the relevant scene display area 39-18, there is a high possibility in that the relevant scene is related with the commercial tag and the user can hit upon contents or scenes of the watched multimedia contents while watching the relevant scene, so that the advertising effect is promoted and the probability of the click of the keyword advertisement content increases (in general, the higher the relation degree between the keyword advertisement content and the contents of the multimedia contents is, the higher the click probability of the keyword advertisement content is). The relevant time zone information display area 39-19 includes the relevant time zone information, so that the user can watch the multimedia content again on the multimedia content display area 38-1 (the user can watch the desired multimedia content through moving close to the relevant time while scrolling the time by using the reproduction time/area display/control means 39-22). At this time, because the relevant scene includes the relevant time zone information, for the convenience of the user, when the user clicks the relevant scene, it is preferable to automatically move the scroll to a corresponding scene of the multimedia content. To this end, the scene displayed on the user computer 9000 includes the program of the Java script or other programs and the relevant scene includes multimedia content identifier information and relevant time zone information, so that the program obtains the relevant time zone information, adds reproduction time zone information so as to reproduce the multimedia content from the relevant time, and instructs the reproduction of the multimedia content. Such a function can be performed in the user computer 9000, but also can be performed in the exposed keyword advertisement management server 13200. In this case, the relevant scene has to include 1) a multimedia content identifier, 2) relevant time zone information, and 3) information making a request of the multimedia content reproduction to the exposed keyword advertisement management server 13200. The exposed keyword advertisement management server 13200 can make the user computer 9000 to transmit the multimedia content data to the user computer 9000 based on the relevant time zone information serving as reproduction time information (the exposed keyword advertisement management server 13200 can directly transmit the multimedia content to the user computer 9000 or make a request of the transmission of the multimedia content data to a server having the multimedia content data). When a single screen fails to display all of the contents, like the case of displaying the entire keyword advertisement contents, the user can view the contents through the scrolling using the scroll means 39-21.

Further, it is assumed that the user stores a tag of ‘refill ink’, does not store a tag of ‘printer’, reserves the first keyword advertisement content related to the printer, and clicks the second and third keyword advertisement contents. In this case, when the user presses the entire keyword advertisement contents tab 39-1, the keyword advertisement contents corresponding to both the refill ink and the printer are displayed as shown in FIG. 39. When the user selects the stored commercial tag content tab 39-2, only the keyword advertisement contents related to the refill ink are displayed (information of the commercial tag of ‘printer’ is not represented). When the user selects the reserved keyword advertisement content tab 39-3, only the first reserved keyword advertisement content related to the commercial tag of ‘printer’ is displayed. When the user selects the clicked keyword advertisement content tab 39-4, only the second and third reserved keyword advertisement contents related to the commercial tag of ‘printer’ are displayed.

The exposed keyword advertisement management server 13200 obtains 1) the commercial tag transmitted to the user computer 9000, 2) the keyword advertisement content transmitted to the user computer 9000, and 3) information of a user's action, such as storage, reservation, and click, of the commercial tag and/or the keyword advertisement content in a direct manner or via another server, and stores and manages them.

When the storage of the commercial tag or the reservation of the keyword advertisement content is generated in the user computer 9000, the exposed keyword advertisement management server 13200 may transmit information of the stored commercial tag or reserved keyword advertisement content to a main account of the user. The transmission of the screen like FIG. 39 to the mail account of the user is especially useful for a computer, such as a mobile terminal, having a small display, or a terminal, such as the IPTV, having an inconvenience in enabling the click function. It is necessary that the user registers the mail account in the exposed keyword advertisement management server 13200 or a preset system including, using, or connected with the exposed keyword advertisement management server 13200.

The exposed keyword advertisement management server 13200 manages the commercial tag set or keyword advertisement content exposed on the user computer 9000, and the exposed keyword advertisement management server 13200 can be physically or functionally/conceptually included in various locations. For example, the exposed keyword advertisement management server 13200 can be included in any one of the digital content service system providing the user computer 9000 with digital contents, the content syndication system 2000, the keyword advertisement content providing system 3000, the user computer 9000, and a preset program executed in the user computer 9000. The digital content service system can be included in at least one of the multimedia content service system 1000 providing the user computer 9000 with multimedia contents, the broadcasting service system 13000 providing the user computer 9000 with broadcasting contents, the digital publication service system 32000 providing the user computer 9000 with a digital publication, and the media service system providing the user computer 9000 with media services.

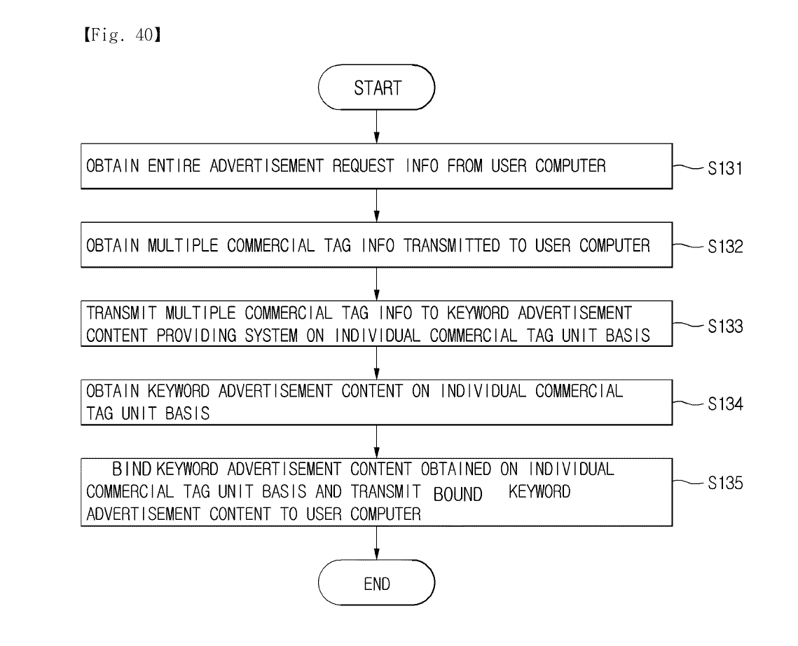

Next, FIGS. 40 to 43 illustrate a method of processing information by the exposed keyword advertisement management server 13200.

FIG. 40 illustrates the method of processing information by the exposed keyword advertisement management server 13200 when the user does not reserve, store, or click a keyword advertisement content or a commercial tag according to an embodiment of the present invention. The method of processing information by the exposed keyword advertisement management server 13200 includes the steps of receiving entire advertisement request information (entire commercial tags or entire keyword advertisement contents) transmitted from the user computer 9000 to the user computer 9000 (S131), receiving multiple commercial tag information transmitted to the user computer 9000 (S132), transmitting the multiple commercial tag information in a unit of an individual commercial tag to the keyword advertisement content providing system 3000 (S133), obtaining keyword advertisement contents in the unit of the individual commercial tag (S134), and combining and transmitting the keyword advertisement contents obtained in the unit of the individual commercial tag to the user computer 9000 (S135). At this time, in order to receive multiple commercial tag information transmitted to the user computer 9000 (S132), the exposed keyword advertisement management server 13200 is necessary to receive entire commercial tags transmitted from the user computer 9000 to the user computer 9000 (especially, when the number of commercial tags are more than one).

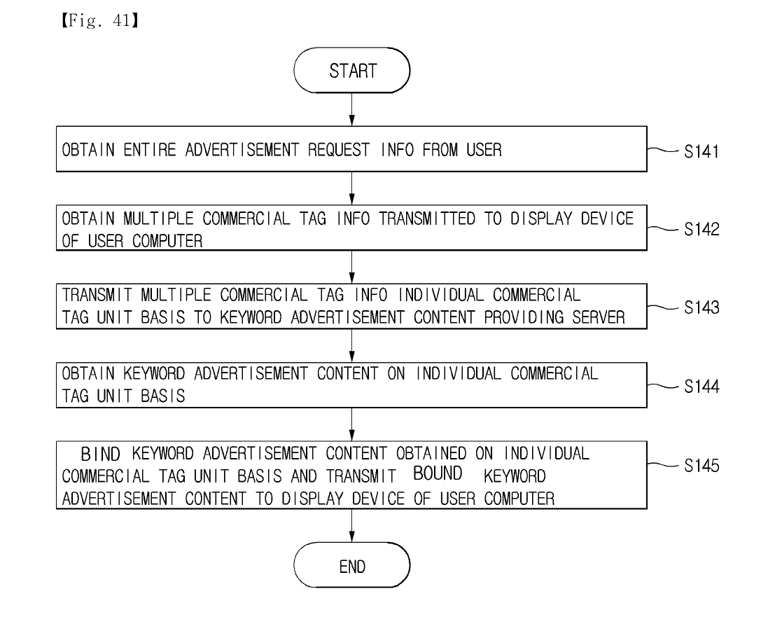

FIG. 41 illustrates the method of processing information by the exposed keyword advertisement management server 13200, which is installed on the user computer 9000. The method of processing information by the exposed keyword advertisement management server 13200 installed on the user computer 9000 includes the steps of receiving entire advertisement request information from the user (S141), obtaining multiple commercial tag information transmitted to a display device of the user computer 9000 (S142), transmitting the multiple commercial tag information in a unit of an individual commercial tag to the keyword advertisement content providing system 3000 (S143), obtaining keyword advertisement contents in the unit of the individual commercial tag from the keyword advertisement content providing system 3000 (S144), and combining and transmitting the keyword advertisement contents obtained in the unit of the individual commercial tag to the display device of the user computer 9000 (S145). At this time, the exposed keyword advertisement management server 13200 installed on the user computer 9000 has stored the keyword advertisement content transmitted to the user computer 9000 and provides the stored keyword advertisement content. However, the keyword advertisement content may be changed (the change of an advertiser, the change of a keyword advertisement content of an advertiser, the change of contents of a keyword advertisement content, the change of an exposure priority rank of a keyword advertisement content, etc.) between the storage time and a request time of the entire keyword advertisement contents by the user, so that the method described in this paragraph is more preferable. At this time, when the user requests the reserved keyword advertisement content, the clicked keyword advertisement content, the keyword advertisement content corresponding to the stored commercial tag, other than the entire advertisement contents, the method can be applied to each of them for the processing of the information. In order to process the information of the reserved keyword advertisement content or the clicked keyword advertisement content, the exposed keyword advertisement management server 13200 is more preferable to store information of the reserved keyword advertisement content or the clicked keyword advertisement content, because, in contrary to the reserved exposed keyword advertisement content, if a cost is charged per click when the exposed keyword advertisement management server 13200 presents the clicked keyword advertisement content again and the user clicks the keyword advertisement content again, there is a problem in that a single user spends the advertising costs corresponding to two times of the click of the keyword advertisement content. The exposed keyword advertisement management server 13200 installed on the user computer 9000 preferably transmits a part or an entirety of various information generated in the user computer 9000 (especially, it is important to transmit click generation information, information of the reservation and the storage of the commercial tag or the keyword advertisement content, etc.)

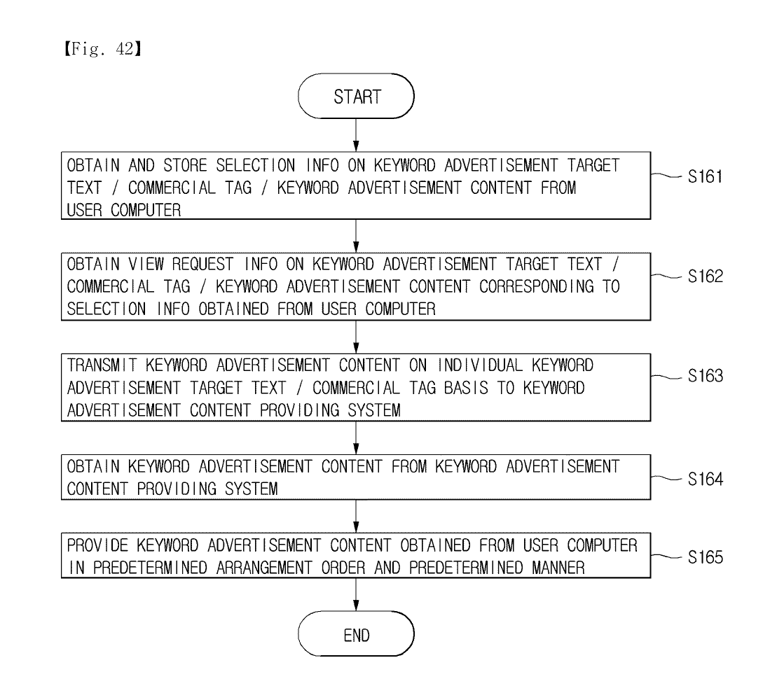

FIG. 42 illustrates a method of processing information by the exposed keyword advertisement management server 13200 when selection information (the reservation, the storage, the click, etc.) of a user for a keyword advertisement content or a commercial tag is generated, according to an embodiment of the present invention. The method of processing information by the exposed keyword advertisement management server 13200 when selection information of a user for a keyword advertisement content or a commercial tag is generated includes the steps of obtaining and storing selection information for a keyword advertisement target text/commercial tag/keyword advertisement content from the user computer 9000 (S161), obtaining view request information for the keyword advertisement target text/commercial tag/keyword advertisement content corresponding to the obtained selection information from the user computer 9000 (S162), transmitting the view request information to the keyword advertisement content providing system 3000 in a unit of an individual keyword advertisement target text/commercial tag (S163), obtaining a keyword advertisement content from the keyword advertisement content providing system 3000 (S164), and providing the user computer 9000 with the obtained keyword advertisement content in a preset arrangement order and in a preset scheme as illustrated in FIG. 39 (S165).

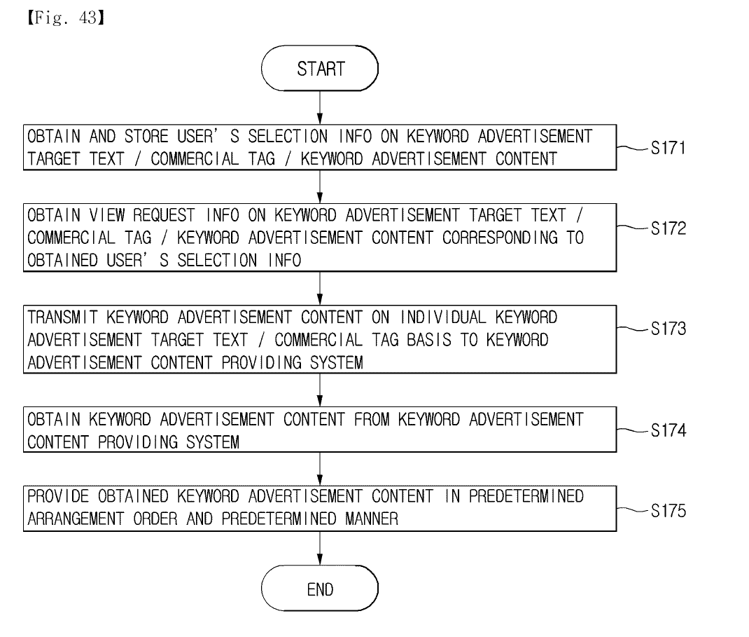

FIG. 43 illustrates a method of processing information by the exposed keyword advertisement management server 13200 installed in the user computer 9000 when selection information (the reservation, the storage, the click, etc.) of a user for a keyword advertisement content or a commercial tag is generated, according to an embodiment of the present invention. The method of processing information by the exposed keyword advertisement management server 13200 installed in the user computer 9000 when selection information of a user for a keyword advertisement content or a commercial tag is generated includes the steps of obtaining and storing selection information of a user for a keyword advertisement target text/commercial tag/keyword advertisement content (S171), obtaining view request information for the keyword advertisement target text/commercial tag/keyword advertisement content corresponding to the obtained selection information of the user (S172), transmitting the view request information to the keyword advertisement content providing system 3000 in a unit of an individual keyword advertisement target text/commercial tag (S173), obtaining a keyword advertisement content from the keyword advertisement content providing system 3000 (S174), and providing the obtained keyword advertisement content in a preset arrangement order and in a preset scheme as illustrated in FIG. 39 (S175).

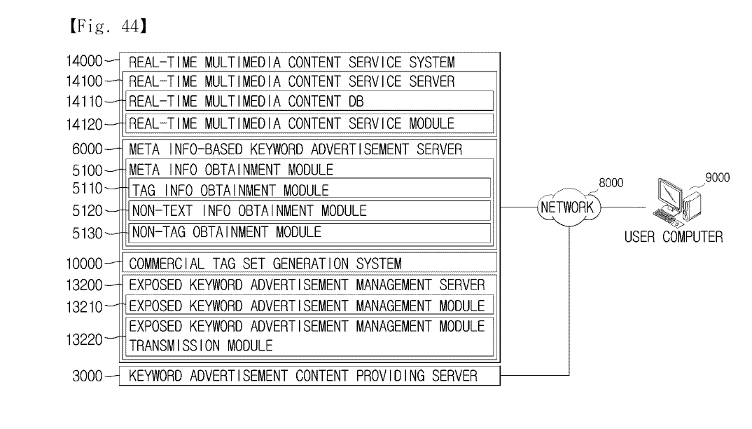

FIG. 44 illustrates real time broadcasting, and essentially the multimedia content service system 1000 providing multimedia contents generated in real time, which corresponds to the description of the broadcasting service system 13000 providing the user computer 9000 with real time broadcasting contents and is with reference to FIG. 31. However, although it is not shown in the drawings, the multimedia content service system 1000 can have the construction of FIG. 32 in which the commercial tag set generation system 1000 is outside of the real time multimedia content service system 14000. It is necessary to generate a commercial tag in real time when the multimedia content is the real time broadcasting. In the real time multimedia content service system 14000, the DB is a real time multimedia content DB 14110 and a real time multimedia content service module 14120 performing the publicly known functions for the real time multimedia content service is included.

FIGS. 45 to 53 illustrate the content syndication system and the content syndication method of the present invention. FIG. 45 illustrates the conventional content syndication method (a part related to the copyright clearing is not illustrated in FIG. 45 because of the complexity of the drawing and the part is the publicly known part, but the spirit of the present invention does not exclude the publicly known part). The thick line represents the flow of the direct transmission of a content file and a thin line represents the access of the user computer 9000 by using location information (URL, URI, etc.) The content producer system 15000, the content circulator system 16000, and/or the multimedia content service system 1000 can provide the user computer 9000 with location information of a content and the user computer 9000 can receive the content file through the location information. Each system can redirect an information request of the user computer 9000 accessing the system.

FIG. 46 illustrates the construction of the content syndication model according to an embodiment of the present invention. The content syndication model of the present invention includes a part or an entirety of the flow of various data, such as the transmission, the access, the redirect of the content data and the information processing. The content syndication model of the present invention is characterized in that the keyword advertisement content providing system 3000 and the content syndication system are further included in the conventional content syndication model. The content syndication system of the present invention may further include the commercial tag set generation system 10000 generating and/or managing a commercial tag set in relation with at least one internal or external system. The content syndication system of the present invention may further include the content syndication server managing the content syndication. The detailed construction of the content syndication system is illustrated in FIG. 47.

In the meantime, the content producer system 15000, the content circulator system 16000, the multimedia content service system 1000, the keyword advertisement content providing system 3000, and the content syndication system may further include the commercial tag set generation system and/or the content syndication server. That is, the content syndication of specific contents according to the present invention can be performed based on the content producer system 15000, and in this case, the content producer system 15000 includes the content syndication server for performing and managing the content syndication therein. When the content producer system 15000 performs the generation and the management of the commercial tag set, the content producer system 15000 can further include the commercial tag set generation system 10000. However, even if the content producer system 15000 further includes the commercial tag set generation system 10000, the content producer system 15000 can use another commercial tag set generation system 10000 located outside of the content producer system 15000. The multimedia content service system 1000 can perform and/or manage the content syndication with respect to another specific content, and in this case, the multimedia content service system 1000 may separately include the content syndication server. According to FIG. 46, 1) any system (including the user computer 9000, and the content syndication server included in the user computer 9000 which is constructed through the transmission of a program constituting the content syndication server from at least one of the systems connected with the user computer 9000) can perform and manage the content syndication, and thus any system includes the content syndication server, 2) even if any one system includes the content syndication server, another system related to the content syndication of the present invention can include a separated content syndication server, and 3) the 1) and 2) are identically applied to the commercial tag set generation system 10000. The simplest content syndication model is that the content producer system 15000, the content circulator system 16000, the multimedia content service system 1000, and the keyword advertisement content providing system 3000 do not include the commercial tag set generation system 10000 or the content syndication server, and access the outside content syndication system, respectively, so as to implement the present invention. The outside content syndication system includes the commercial tag set generation system 10000 and the content syndication server, to generate and manage the commercial tag set, and perform and manage the content syndication, respectively.

FIG. 47 illustrates the construction of the content syndication system according to an embodiment of the present invention. The content syndication system necessarily includes the content syndication server, and can selectively include the commercial tag set generation system 10000 or the meta information based keyword advertisement server 6000, and the content syndication target content related to the content syndication can be stored in a syndication target content DB 22300. The content syndication server may further include a content syndication DB unit 211100. The content syndication DB unit 211100 further includes a content syndication ID DB storing at least one identification (means), such as content syndication ID data or a content identifier (ID, URI, URL, location information, etc), related to the identification of contents, a commercial tag DB 21120 storing commercial tag set data related to a specific content, and/or a commercial tag condition information DB 21130 including information of conditions when there are special conditions for the use of the commercial tag. The content syndication server can store at least one commercial tag set corresponding to the content ID by using the content ID serving as a key value. At this time, when a special condition, such as a language, a time zone, a country, an age, and other restrictions, is applied to a commercial tag constituting a specific commercial tag set or the commercial tag set, the condition may be stored in the commercial tag condition information DB 21130. When the content syndication server transmits a commercial tag set to an outside system, the content syndication server determines if the commercial tag set to be transmitted satisfies the condition information related to the commercial tag set and then provides the commercial tag set satisfying the condition.

The content syndication control unit 21200 variously controls the commercial tag set or the commercial tag constituting the commercial tag set. The commercial tag set obtainment module 21210 of the content syndication control unit 21200 obtains and stores at least one commercial tag set corresponding to at least one content from the internal or external commercial tag set generation system 10000 of the content syndication system. When a commercial tag set calling module 21250 receives request information for a commercial tag set from an outside system, the commercial tag set calling module 21250 calls a commercial tag set stored in the commercial tag DB 21120 in accordance with the request information and provides the outside system with the called commercial tag set through a commercial tag set providing module 21230. The commercial tags stored in the commercial tag DB 21120 are managed by a commercial tag set management module 21240. When the content syndication system receives request information of a commercial tag set by using a content identifier, such as a content ID, from an outside system, the content syndication system inquires of the content ID DB 21110 about the content ID/content identifier and first identifies if the content ID/content identifier is an identifier of a content included in the content syndication system, and then inquires of the commercial tag DB 21120 about the content ID/content identifier and calls at least one commercial tag by using the commercial tag set calling module 21250.

Next, a commercial tag set binding module 21220 included in the content syndication control unit 21200 will be described. The commercial tag set binding module 21220 1) binds a content data file and a related commercial tag set and 2) binds the content ID/content identifier and a related commercial tag set. In relation to the 1), the commercial tag set binding module 21220 binds a content data file stored in the commercial tag set binding module 21220 with a related commercial tag set (the commercial tag set can be generated through the internal or external commercial tag set generation system 10000) or binds a content data file transmitted from an outside system with a related commercial tag set (the commercial tag set can be generated through the internal or external commercial tag set generation system 10000). Further, In relation to the 2), the commercial tag set binding module 21220 binds a content corresponding to the content ID/content identifier (including identification information) transmitted from an outside system or stored in the commercial tag set binding module 21220 with a relevant commercial tag set. A user of the internal or external commercial tag set generation system 10000 of the content syndication system obtains the internal or external content of the content syndication system by using the received content ID/content identifier and generates a commercial tag set corresponding to the obtained content. The commercial tag set obtainment module 21210 of the content syndication control unit 21200 obtains the generated commercial tag set and bins the commercial tag set with the content ID/content identifier. The binding includes a concept of the relation and the storage of the commercial tag set with the content ID/content identifier, and the scheme of the relation and the storage can adopt the conventional computing technology.

The content syndication clearing unit 21300 processes clearing information of a profit element and an expense element generated in relation with the performance of the content syndication method and/or the advertisement method of the present invention according to a preset clearing policy of operators of various systems related to the content syndication system. The clearing information includes 1) a profit element quantity and an expense element quantity, 2) basis data related to the clearing (log data, time information data, statistical data, analysis data, etc.), etc., with respect to each of the operators of the systems.

The content syndication system 20000 further includes a commercial tag set management system 22000 managing the inside commercial tag set. The commercial tag set management system 22000 may further include the commercial tag set generation system 10000, and a commercial tag set generation system distribution module 22100 distributing the commercial tag set generation system to the third system or the user computer 9000, so as to enable the commercial tag set generation system to function in the third system or the user computer 9000.

FIGS. 48 to 53 illustrate the content syndication model according to an embodiment of the present invention.

FIG. 48 illustrates the content syndication model according to the embodiment of the present invention, in which the content circulator system 16000 first binds a commercial tag and a content and transmits the content to the multimedia content service system 1000. FIG. 48 illustrates the combination of several content syndication models, each of which will be described. First, the content producer system 15000 transmits content data to the content circulator system 16000 (S48-1), and the content circulator system 16000 stores the content data. The content circulator system 16000 transmits the content data to the commercial tag set generation system 10000 so as to obtain a commercial tag set related to the content data (S48-2). The commercial tag set generation system 10000 transmits a commercial tag set to the content circulator system 16000 (S48-3), and the content circulator system 16000 binds the received commercial tag set with the content data and then transmits the bound commercial tag set and content data to the commercial tag set generation system 10000 (S48-4). At this time, the advertisement method using the commercial tag set of the present invention has been previously described, so that it will be simply described. First, 1) the commercial tag set generation system 10000 transmits the commercial tag to the keyword advertisement content providing system 3000 (S48-5), the keyword advertisement content providing system 3000 transmits a keyword advertisement content corresponding to the commercial tag to the commercial tag set generation system 10000 (S48-6), the commercial tag set generation system 10000 transmits the content data and the keyword advertisement content to the user computer 9000, and the user computer 9000 exposes the keyword advertisement content. 2) However, the commercial tag set generation system 10000 transmits the keyword advertisement control module 6900 together with the commercial tag set to the user computer 9000, or transmits the keyword advertisement control module 6900 to the user computer 9000 and the transmitted keyword advertisement control module 6900 makes a request of the commercial tag set to the multimedia content service system 1000 and receives the commercial tag set from the multimedia content service system 1000 (S48-7). The user computer 9000 receiving the keyword advertisement control module 6900 transmits the (time dependent) commercial tag to the keyword advertisement content providing system 3000 once or multiple times (S48-8), receives a keyword advertisement content corresponding to the commercial tag from the keyword advertisement content providing system 3000 (S48-9), and displays the received keyword advertisement content on the display of the user computer 9000. In FIG. 48, the content data is bound with the commercial tag set, to be transmitted, and the data constituting the commercial tag set and the content data are computerizably bound, which is one embodiment of the aforementioned content syndication package model.

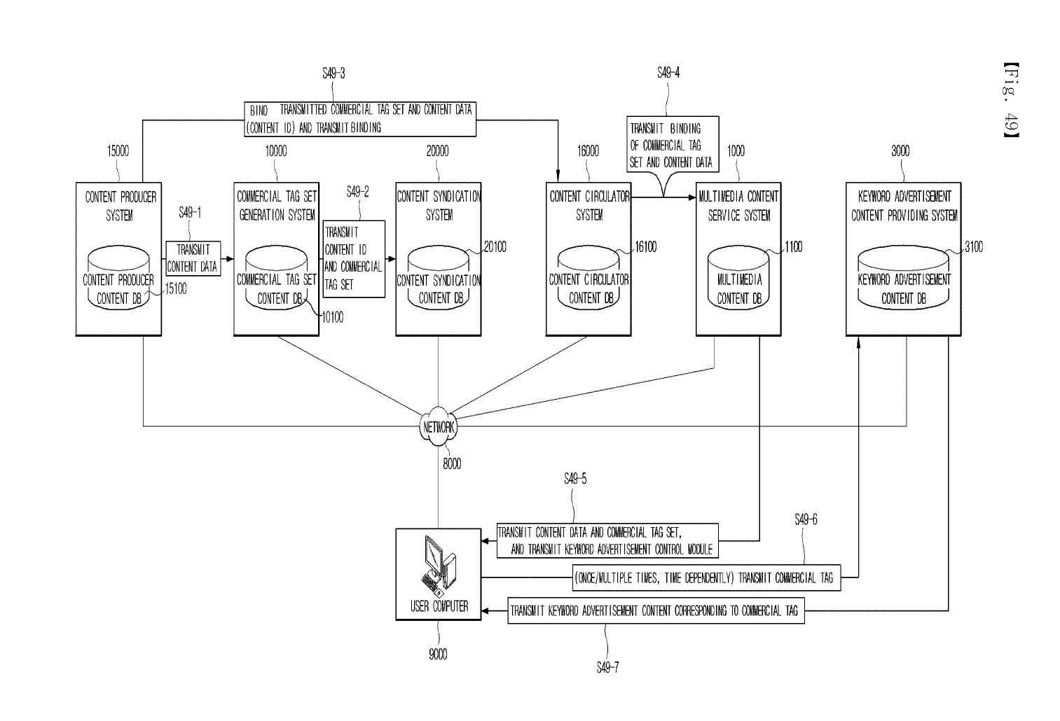

FIG. 49 illustrates the independent route model of the content syndication according to an embodiment of the present invention. The content producer system 15000 transmits content data to the commercial tag set generation system 10000 (S49-1), and the commercial tag set generation system 10000 generates a commercial tag set for the content data. The commercial tag set generation system 10000 can transmit the commercial tag to the content producer system 15000, but transmits location information or a content identifier/content ID and the commercial tag set to the content syndication system performing the syndication for the content (S49-2). At this time, the commercial tag set generation system 10000 transmits not the commercial tag set itself, but location information of a commercial tag set or a commercial tag set identifier/commercial tag set ID capable of calling the commercial tag set, and the third system can use the commercial tag set through the location information of the commercial tag set or the commercial tag set identifier/commercial tag set ID.

In a special case, the content producer system 15000 can transmit the content data to the content syndication system. The content syndication system stores the location information or the content identifier/content ID of the content data and the commercial tag set, so that when the third system makes a request of the commercial tag set to the content syndication system by using the location information or the content identifier/content ID of the content data, the content syndication system can transmit the commercial tag set corresponding to the location information or the content identifier/content ID of the content data to the third system.

The content producer system 15000 binds the received commercial tag set (the location information of the commercial tag set or the commercial tag set identifier/commercial tag set ID which is hereinafter referred to as commercial tag set location information) with the content data (the location information of the content or the content identifier/content ID which is hereinafter referred to as content location information), and transmits the bound commercial tag set and content data to the content circulator system 16000 (S49-3). The content circulator system 16000 transmits the bound commercial tag set (the location information of the commercial tag set or the commercial tag set identifier/commercial tag set ID) and content data (the location information of the content or the content identifier/content ID) to the multimedia content service system 1000 (S49-4). In a special case, when the content syndication system receives the request of the keyword advertisement content, the content syndication system may receive the keyword advertisement content from the keyword advertisement content providing system 3000 by using the commercial tag set and transmit the keyword advertisement content to the requesting third system.

The multimedia content service system 1000 transmits the keyword advertisement control module 6900 to the user computer 9000 (S49-5) and transmits at least one of the commercial tag set (the location information of the commercial tag set or the commercial tag set identifier/commercial tag set ID) and the content data (the location information of the content or the content identifier/content ID) to the user computer 9000. When the user computer 9000 receives the location information of the commercial tag set or the commercial tag set identifier/commercial tag set ID, the user computer 9000 can obtain the commercial tag set by using the received location information of the commercial tag set or commercial tag set identifier/commercial tag set ID. At this time, the user computer 9000 may transmit the commercial tag to the keyword advertisement content providing system 3000 (S49-6) and receive the keyword advertisement content from the keyword advertisement content providing system 3000 (S49-7). In a special case, the user computer 9000 transmits the location information of the commercial tag set or the commercial tag set identifier/commercial tag set ID to the keyword advertisement content providing system 3000, and the keyword advertisement content providing system 3000 obtains the commercial tag set from the content syndication system by using the location information of the commercial tag set or the commercial tag set identifier/commercial tag set ID, obtains a keyword advertisement content by using the obtained commercial tag set, and transmits the keyword advertisement content to the user computer 9000.

If the commercial tag set and the location information of the commercial tag set can be called/used through the network 8000, the commercial tag set and the location information of the commercial tag set can be computingly treated equally. Also, the content data and the location information of the content are computingly treated equally. When the content syndication is performed by several systems, which are the same kind, but have different subjects, the content and the commercial tag set is preferably circulated based on the location information of the content and the location information of the commercial tag set. The biggest advantage in this case is that, independently of the short period or the long period of the circulation period of the content, the commercial tag set is managed by a single subject, such as the commercial tag set generation system 1000 or the content syndication system, so that it is possible to maintain up-to-date commercial tags (through a single change, the commercial tag set changed in every system can be used), and thus it is possible to secure up-to-date keyword advertisement contents (the advertisers are always changed according to the passage of time).

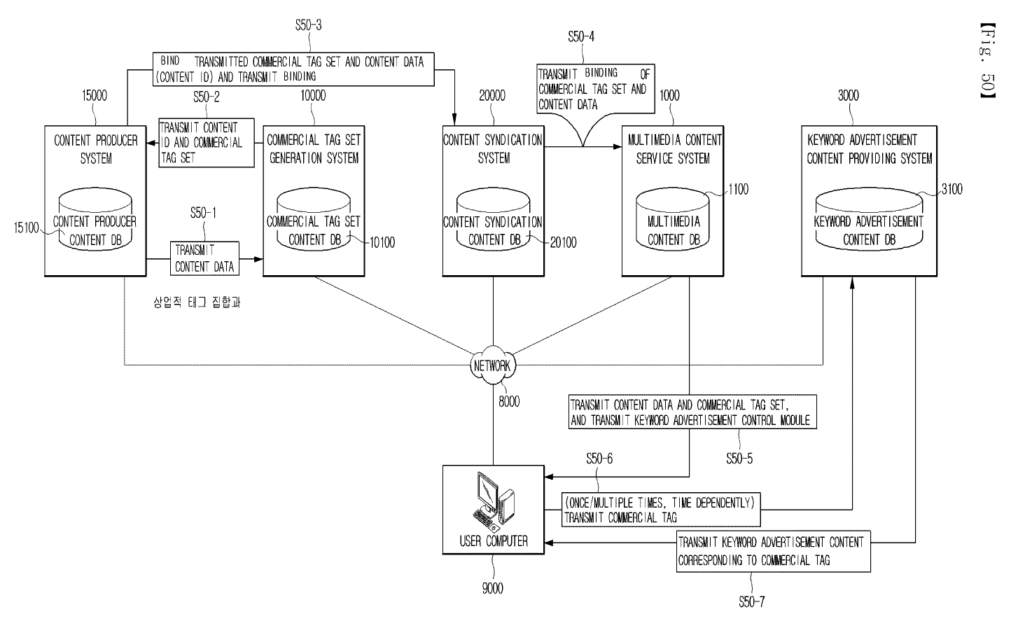

FIG. 50 illustrates the content syndication method by the content syndication system, which serves as the content circulator system 16000, according to an embodiment of the present invention.

In the content syndication model of FIG. 50, the content syndication system circulates content data and a commercial tag set, so that the content syndication system is the center of the content syndication. The content syndication system will be described in more detail. The content producer system 15000 transmits content data to the commercial tag set generation system 10000 (S50-1), the commercial tag set generation system 10000 transmits a content ID and a commercial tag set to the content producer system 15000 (S50-2), and the content producer system 15000 binds the received commercial tag set and content data (content location information) and transmits the bound commercial tag set and content data (content location information) to the content syndication system (S50-3). The content syndication system transmits the bound commercial tag set and content data to the multimedia content service system 1000 (S50-4) and the multimedia content service system 1000 transmits the content data, the commercial tag set, and the keyword advertisement control module 6900 to the user computer 9000 (S50-5). The user computer 9000 transmits the commercial tag to the keyword advertisement content providing system 3000 (once/multiple times, time dependently) (S50-6) and the keyword advertisement content providing system 3000 transmits the keyword advertisement content corresponding to the commercial tag to the user computer 9000 (S50-7).

The content syndication based on the package model (the independent route model is partially included) has been described with reference to FIGS. 48 to 50. Next, the content syndication based on the aforementioned independent route model according to an embodiment of the present invention will be described with reference to FIGS. 51 to 53.

FIG. 51 illustrates the construction of the typical independent route model of the content syndication according to an embodiment of the present invention. The content producer system 15000 transmits content data to the content circulator system 16000 (S51-1), the content circulator system 16000 transmits the content data to the multimedia content service system 1000 (S51-2), the multimedia content service system 1000 transmits a content ID to the content syndication system (S51-3), and the content syndication system transmits a commercial tag set to the multimedia content service system 1000 (S51-4). When the multimedia content service system 1000 transmits the content data and the keyword advertisement control module 6900 (the commercial tag set can be included) to the user computer 9000 (S51-5), the user computer 9000 transmits the commercial tag set to the keyword advertisement content providing system 3000 once/multiple times (S51-6). When the keyword advertisement content providing system 3000 transmits a keyword advertisement content corresponding to the commercial tag to the user computer 9000 (S51-7), the user computer 9000 displays the keyword advertisement content on a display device of the user computer 9000.

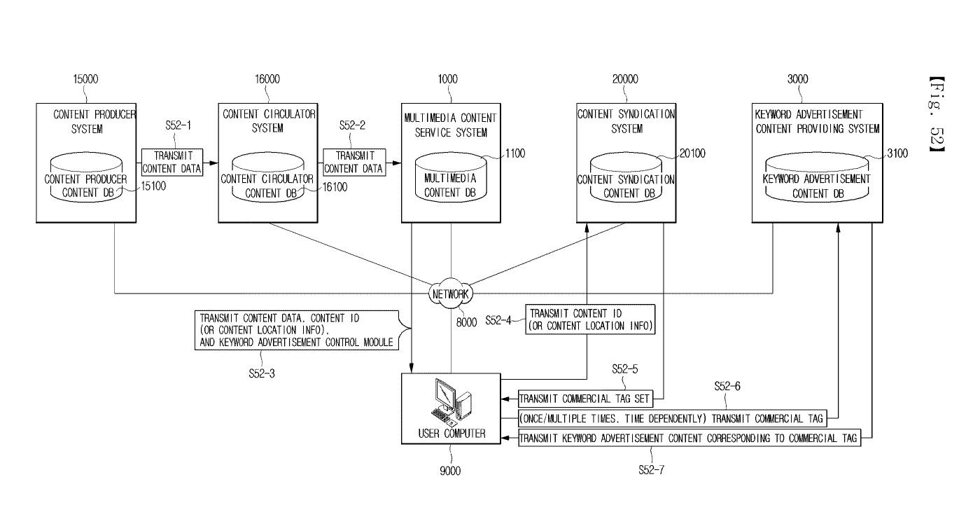

FIG. 52 illustrates the construction of the independent route model of the content syndication according to another embodiment of the present invention. The content producer system 15000 transmits content data to the content circulator system 16000 (S52-1), the content circulator system 16000 transmits the content data to the multimedia content service system 1000 (S52-2), the multimedia content service system 1000 transmits the content data (content location information) and the keyword advertisement control module 6900 to the user computer 9000 (S52-3), the user computer 9000 transmits the content location information to the content syndication system (S52-4), the content syndication system transmits the commercial tag set to the user computer 9000 (S52-5), and the user computer 9000 uses the commercial tag set.

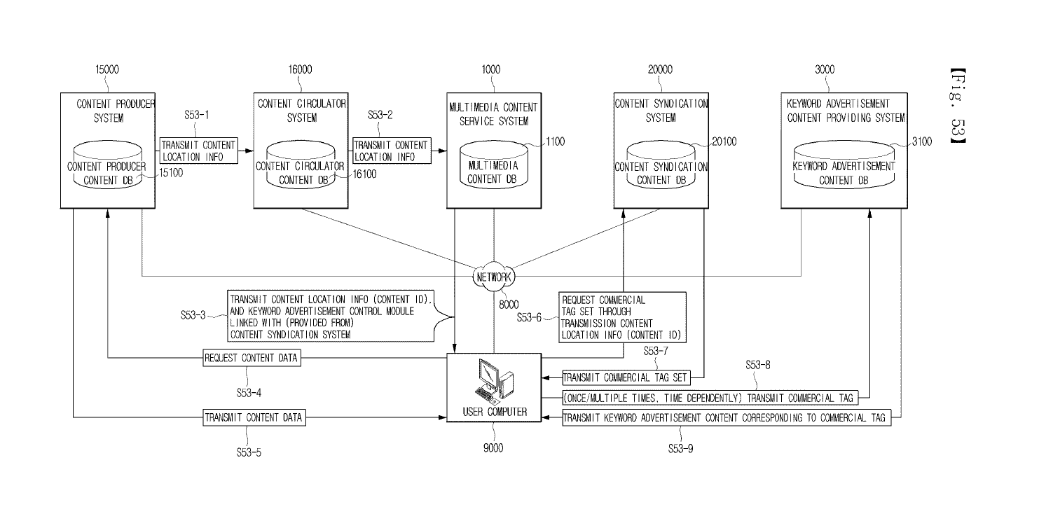

FIG. 53 illustrates the construction of the independent route model of the content syndication according to another embodiment of the present invention. The content producer system 15000 transmits content location information to the content circulator system 16000 (S53-1), the content circulator system 16000 transmits the content location information to the multimedia content service system 1000 (S53-2), and the multimedia content service system 1000 transmits the content location information and the keyword advertisement control module 6900, which is connectable to the content syndication system, to the user computer 9000 (S53-3). The user computer 9000 makes a request of content data to the content producer system 15000 by using the keyword advertisement control module 6900 (S53-4) and the content producer system 15000 transmits the content data to the user computer 9000 (S53-5). The user computer 9000 makes a request of a commercial tag set related to the content by using the content location information, etc. to the content syndication system (S53-6) and the content syndication system transmits the commercial tag set to the user computer 9000 (S53-7), so that the user computer 9000 can use the commercial tag set.

If the content syndication using the commercial tag is introduced, a portable phone allowing the user to watch the IPTV or the multimedia among the user computer can be the core device for the content syndication. That is, the user can watch the syndicated (distributed, circulated, etc.) high-quality contents for free or at the extremely low cost through the IPTV terminal at home and a portable terminal during the movement. Therefore, a company providing the wired/wireless network for the IPTV or a company providing a communication network for a portable phone can serve as a hub for the content syndication, beyond the communication network providing service. Further, through the present invention, a person possessing high-quality contents can circulate the contents in his/her country or another country through corresponding his/her contents with the commercial tags, so that the content circulation quantity would be greatly increased. Further, those who have knowledge and information attracting the user's interest can create the advertisement profit with the relevant commercial tag while providing their knowledge and information in a type of the moving picture, so that it is possible to promote the spread of highly-valuable knowledge and information which an individual possesses.

### INDUSTRIAL APPLICABILITY

The present invention can be applied to a wired/wireless online advertisement industry, a multimedia content industry, an information and communication service industry, a broadcasting industry, a news industry, an article industry, an electronic book industry, a document-relevant industry, a digital publication industry, a blog service industry, a community service industry, a media service industry, an online service industry, a contents industry, a video (including a movie) industry, an image industry, a music industry, a sound industry, etc.

1. A method for providing a keyword advertisement service based on meta information included in multimedia content information by a multimedia content service system, which includes a multimedia content service server transmitting moving picture information of a moving picture selected by a user to a user computer, the method comprising:
obtaining selection information of a moving picture to be transmitted to the user computer from the user computer;
obtaining text type meta information of the selected moving picture;
transmitting a keyword advertisement target text generated based on the meta information to a keyword advertisement content providing server;
receiving at least one keyword advertisement content from the keyword advertisement content providing server; and
transmitting the moving picture information and the keyword advertisement content to the user computer,
in which the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the keyword advertisement target text transmitted from the multimedia content service system from the keyword advertisement content DB and transmits the obtained keyword advertisement content to the multimedia content service server.

2. A multimedia content service system providing a keyword advertisement service based on meta information included in multimedia content information, the multimedia content service system comprising a multimedia content service server transmitting moving picture information of a moving picture selected by a user to a user computer, the multimedia content service system comprising:
a multimedia content DB including at least one moving picture content;
a multimedia content transmission module for transmitting a selected moving picture content when selection information of a moving picture content is received from the user computer;
a meta information obtainment module for obtaining meta information of the selected moving picture;
a keyword advertisement target text generation module for generating at least one keyword advertisement target text based on the meta information obtained from the meta information obtainment module;
a keyword advertisement content obtainment module for obtaining at least one keyword advertisement content corresponding to a keyword advertisement target text generated by the keyword advertisement target text generation module from a keyword advertisement content providing server; and
a keyword advertisement display module for displaying a keyword advertisement content obtained by the keyword advertisement content obtainment module on a preset location, which is discriminated from a moving picture area reproducing and displaying the moving picture,
in which the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to a keyword advertisement target text transmitted from the keyword advertisement content DB and transmits the obtained keyword advertisement content to the multimedia content service server.

3. A method for providing a keyword advertisement service based on meta information included in multimedia content information by a multimedia content service system, the multimedia content service system comprising a multimedia content service server transmitting moving picture information of a moving picture selected by a user to a user computer, the method comprising:
obtaining selection information of a moving picture to be transmitted to the user computer from the user computer;
obtaining text type meta information of the selected moving picture;
transmitting the obtained meta information to a meta information-based keyword advertisement intermediation system;
receiving at least one keyword advertisement content; and
transmitting the moving picture information and the keyword advertisement content to the user computer,
in which the meta information-based keyword advertisement intermediation system comprises a meta information-based keyword advertisement intermediation server, and the meta information-based keyword advertisement intermediation server comprises a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generation module to a keyword advertisement content generation server and obtaining at least one keyword advertisement content from the keyword advertisement content providing server, and a keyword advertisement content transmission module for transmitting the obtained keyword advertisement content to the multimedia content service system, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to a keyword advertisement target text received from the meta information-based keyword advertisement intermediation server from the keyword advertisement content DB and transmits the obtained keyword advertisement content to the meta information-based keyword advertisement intermediation server.

4. A method for providing a keyword advertisement service based on meta information included in multimedia content information by a multimedia content service system, the multimedia content service system comprising a multimedia content service server transmitting moving picture information of a moving picture selected by a user to a user computer, the method comprising:
obtaining selection information of a moving picture to be transmitted to the user computer from the user computer;
obtaining text type meta information of the selected moving picture;
transmitting the obtained meta information to a meta information-based keyword advertisement intermediation system;
receiving at least one keyword advertisement content from a keyword advertisement content providing server; and
transmitting the moving picture information and the keyword advertisement content to the user computer,
in which the meta information-based keyword advertisement intermediation system comprises a meta information-based keyword advertisement intermediation server, wherein the meta information-based keyword advertisement intermediation server comprises a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generation module to a keyword advertisement content generation server and obtaining at least one keyword advertisement content from the keyword advertisement content providing server, and a keyword advertisement content transmission module for transmitting the obtained keyword advertisement content to the multimedia content service system, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server receives keyword advertisement target text from the meta information-based keyword advertisement intermediation server and information on the multimedia content service system including the keyword advertisement target text, obtains at least one keyword advertisement content corresponding to the received keyword advertisement target text from the keyword advertisement content DB and transmits the obtained keyword advertisement content to the multimedia content service system or the user computer.

5. A multimedia content service system providing a keyword advertisement service based on meta information included in multimedia content information, the multimedia content service system comprising a multimedia content service server transmitting moving picture information of a moving picture selected by a user to a user computer, the system comprising:
a multimedia content DB including at least one moving picture content;
a multimedia content transmission module for, transmitting a selected moving picture content when selection information of a moving picture content is received from the user computer;
a meta information obtainment module for obtaining meta information of the selected moving picture;
a meta information transmission module for transmitting the obtained meta information to a meta information based keyword advertisement intermediation system;
a keyword advertisement content reception module for receiving at least one keyword advertisement content related to the meta information from the meta information based keyword advertisement intermediation system; and
a keyword advertisement display module for displaying a keyword advertisement content received by the keyword advertisement content reception module on a preset location, which is discriminated from a moving picture area reproducing and displaying the moving picture,
in which the meta information-based keyword advertisement intermediation system comprises a meta information-based keyword advertisement intermediation server, and the meta information-based keyword advertisement intermediation server comprises a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generated by the keyword advertisement target text generation module to a keyword advertisement content providing server and obtaining at least one keyword advertisement content from the keyword advertisement content providing server, and a keyword advertisement content transmission module for transmitting the obtained keyword advertisement content to the multimedia content service system, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the meta information-based keyword advertisement intermediation server.

6. A multimedia content service system providing a keyword advertisement service based on meta information included in multimedia content information, the multimedia content service system comprising a multimedia content service server transmitting moving picture information of a moving picture selected by a user to a user computer, the system comprising:
a multimedia content DB including at least one moving picture content;
a multimedia content transmission module for transmitting a selected moving picture content when selection information of a moving picture content is received from the user computer;
a meta information obtainment module for obtaining meta information of the selected moving picture;
a meta information transmission module for transmitting the obtained meta information to a meta information based keyword advertisement intermediation system;
a keyword advertisement content reception module for receiving at least one keyword advertisement content related to the meta information transferred to the meta information based keyword advertisement intermediation system from a keyword advertisement content providing server; and
a keyword advertisement display module for displaying a keyword advertisement content received by the keyword advertisement content reception module on a preset location, which is discriminated from a moving picture area reproducing and displaying the moving picture,
in which the meta information-based keyword advertisement intermediation system comprises a meta information-based keyword advertisement intermediation server, and the meta information-based keyword advertisement intermediation server comprises a meta information reception module for receiving the meta information, a keyword advertisement target text generation module for generating a keyword advertisement target text by using the meta information obtained by the meta information reception module, a keyword advertisement content providing server-side text obtainment module for transmitting a keyword advertisement target text generated by the keyword advertisement target text generation module to a keyword advertisement content providing server and receiving a text from the keyword advertisement content providing server, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the multimedia content service system.

7. A method for providing a keyword advertisement service based on meta information included in multimedia content information by a meta information-based keyword advertisement intermediation system, which receives meta information from a multimedia content service system comprising a multimedia content service server transmitting moving picture information of a moving picture selected by a user to a user computer, the method comprising:
obtaining text type meta information from the multimedia content service system;
transmitting a keyword advertisement target text generated based on the obtained meta information to a keyword advertisement content providing server;
receiving at least one keyword advertisement content from the keyword advertisement content providing server; and
transmitting the received keyword advertisement content to the multimedia content service system,
in which the meta information-based keyword advertisement intermediation system comprises a meta information-based keyword advertisement intermediation server, and the meta information-based keyword advertisement intermediation server comprises a meta information reception module for receiving the meta information, a keyword advertisement target text transmission module for transmitting a keyword advertisement target text generated based on the meta information to a keyword advertisement content providing server, a keyword advertisement content obtainment module for obtaining at least one keyword advertisement content from the keyword advertisement content providing server, a keyword advertisement content transmission module for transmitting the obtained keyword advertisement content to the multimedia content service system,
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the meta information-based keyword advertisement intermediation server, and
the multimedia content service system transmits the moving picture information and the received keyword advertisement content to the user computer.

8. A method for providing a keyword advertisement service based on meta information included in multimedia content information by a meta information-based keyword advertisement intermediation system, which receives meta information from a multimedia content service system comprising a multimedia content service server transmitting moving picture information of a moving picture selected by a user to a user computer, the method comprising:
obtaining text type meta information from the multimedia content service system;
transmitting a keyword advertisement target text generated based on the obtained meta information to a keyword advertisement content providing server; and
receiving click generation information of the keyword advertisement content from the multimedia content service system,
in which the meta information-based keyword advertisement intermediation system comprises a meta information-based keyword advertisement intermediation server, and the meta information-based keyword advertisement intermediation server comprises a meta information reception module for receiving the meta information, a keyword advertisement target text generation module for generating a keyword advertisement target text by using the meta information obtained by the meta information reception module, and a keyword advertisement target text transmission module for transmitting a keyword advertisement target text generated by the keyword advertisement target text generation module to a keyword advertisement content providing server,
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the text received from the meta information-based keyword advertisement intermediation server from the keyword advertisement content DB and transmits the obtained keyword advertisement content to the multimedia content service system, and
the multimedia content service system receives at least one keyword advertisement content from the keyword advertisement content providing server and transmits the moving picture and the obtained keyword advertisement content to the user computer.

9. A meta information-based keyword advertisement intermediation system providing a keyword advertisement service based on meta information included in multimedia content information, the meta information-based keyword advertisement intermediation system receiving meta information from a multimedia content service system comprising a multimedia content service server transmitting moving picture information of a moving picture selected by a user to a user computer, receiving at least one keyword advertisement content corresponding to the received meta information from a keyword advertisement content providing server, and transmitting the received keyword advertisement content to the multimedia content service system, the meta information-based keyword advertisement intermediation system comprising:
a meta information reception module for obtaining text type meta information from the multimedia content service system;
a keyword advertisement target text generation module for generating at least one keyword advertisement target text by using the received meta information;
a keyword advertisement target text transmission module for transmitting a keyword advertisement target text generated by the keyword advertisement target text generation module to the keyword advertisement content providing server;
a keyword advertisement content obtainment module for obtaining at least one keyword advertisement content corresponding to the keyword advertisement target text from the keyword advertisement content providing server; and
a keyword advertisement content transmission module for transmitting the obtained keyword advertisement content to the multimedia content service system,
in which the meta information-based keyword advertisement intermediation system comprises a meta information-based keyword advertisement intermediation server, and the meta information-based keyword advertisement intermediation server comprises a meta information reception module for receiving the meta information, a keyword advertisement target text generation module for generating a keyword advertisement target text by using the meta information obtained by the meta information reception module, a keyword advertisement content obtainment module for transmitting the keyword advertisement target text generation module to a keyword advertisement content providing server and obtaining at least one keyword advertisement content from the keyword advertisement content providing server, a keyword advertisement content transmission module for transmitting the obtained keyword advertisement content to the multimedia content service system, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, the keyword advertisement content providing server obtains at least one keyword advertisement content corresponding to the keyword advertisement target text received from the meta information-based keyword advertisement intermediation server from the keyword advertisement content DB and transmits the obtained keyword advertisement content to the meta information-based keyword advertisement intermediation server, and
the multimedia content service system transmits the moving picture information and the keyword advertisement content to the user computer.

10. A method for providing a keyword advertisement service based on meta information included in multimedia content information by a multimedia content service system, the multimedia content service system comprising a multimedia content service server transmitting moving picture information of a moving picture selected by a user to a user computer, the method comprising:
obtaining selection information of a moving picture to be transmitted to the user computer from the user computer;
obtaining text type meta information of the selected moving picture;
transmitting the obtained meta information to a keyword advertisement content providing system;
receiving at least one keyword advertisement content from the keyword advertisement content providing system; and
transmitting the moving picture information and the keyword advertisement content to the user computer,
in which the keyword advertisement content providing system comprises a meta information-based keyword advertisement providing server and a keyword advertisement content providing server, and
the meta information-based keyword advertisement providing server comprises a meta information reception module and a keyword advertisement control module, the meta information reception module obtains meta information from the multimedia content service system, the keyword advertisement control module generates a keyword advertisement target text by using the meta information, and
the meta information-based keyword advertisement providing server generates at least one keyword advertisement target text by using the meta information obtained from the multimedia content service system and transmits the generated keyword advertisement target text to the keyword advertisement content providing server, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the received keyword advertisement target text from the keyword advertisement content DB, and
the keyword advertisement content providing system transmits the obtained keyword advertisement content to the multimedia content service server.

11. A system providing a keyword advertisement service based on meta information included in multimedia content information, comprising
a multimedia content DB including at least one moving picture content;
a multimedia content transmission module for, when selection information of a moving picture content is received from the user computer, transmitting the selected moving picture content;
a meta information obtainment module for obtaining meta information of the selected moving picture;
a meta information transmission module for transmitting the obtained meta information to a keyword advertisement content providing system;
a keyword advertisement content reception module for receiving at least one keyword advertisement content from the keyword advertisement content providing system; and
a keyword advertisement display module for displaying the keyword advertisement content received by the keyword advertisement content reception module on a preset location, which is discriminated from a moving picture area reproducing and displaying the moving picture,
in which the keyword advertisement content providing system comprises a meta information-based keyword advertisement providing server and a keyword advertisement content providing server,
the meta information-based keyword advertisement providing server comprises a meta information reception module and a keyword advertisement control module, the meta information reception module obtains meta information from the multimedia content service system, and the keyword advertisement control module generates a keyword advertisement target text by using the meta information, and
the meta information-based keyword advertisement providing server generates at least one keyword advertisement target text by using the meta information obtained from the multimedia content service system and transmits the generated keyword advertisement target text to the keyword advertisement content providing server, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and the keyword advertisement content providing server obtains at least one keyword advertisement content corresponding to the received text from the keyword advertisement content DB, and
the keyword advertisement content providing system transmits the obtained keyword advertisement content to the multimedia content service server.

12. A method for providing a keyword advertisement service based on meta information included in multimedia content information by a keyword advertisement content providing system, which receives meta information included in moving picture information from at least one outside server and provides at least one keyword advertisement content based on the meta information, the method comprising:
obtaining text type meta information from the outside server;
transmitting a keyword advertisement target text generated based on the obtained meta information to a keyword advertisement content providing server;
receiving at least one keyword advertisement content from the keyword advertisement content providing server; and
transmitting the received keyword advertisement content to the outside server or to a user computer reproducing the moving picture,
in which the outside server includes the multimedia content service system, which comprises a multimedia content service server transmitting moving picture information of a moving picture selected by the user to the user computer, or a third server, which receives meta information included in moving picture information from the multimedia content service system and transmits the received meta information to the keyword advertisement content providing system,
the keyword advertisement content providing system comprises a meta information-based keyword advertisement providing server and the keyword advertisement content providing server,
the meta information-based keyword advertisement providing server generates at least one keyword advertisement target text by using the meta information obtained from the outside server and transmits the generated keyword advertisement target text to the keyword advertisement content providing server,
the keyword advertisement content providing system obtains at least one keyword advertisement content corresponding to the received keyword advertisement target text and directly transmits the keyword advertisement content to the multimedia content service system or transmits the keyword advertisement content to the multimedia content service system via the third server or a preset server,
the keyword advertisement content providing server comprises a keyword advertisement content providing server-side text obtainment module for receiving a text, a keyword advertisement content DB including at least one advertisement content, and a keyword advertisement content transmission module for transmitting the keyword advertisement content to an outside server of the keyword advertisement content transmission module, and obtains at least one keyword advertisement content corresponding to the received keyword advertisement target text from the keyword advertisement content DB,
the keyword advertisement content providing system transmits the obtained keyword advertisement content to the outside server, and
the user computer obtains moving picture information from the outside server.

13. A keyword advertisement content providing system providing a keyword advertisement service based on meta information included in multimedia content information, the keyword advertisement content providing system receiving meta information included in moving picture information from at least one outside server and providing at least one keyword advertisement content based on the meta information, the keyword advertisement content providing system comprising:
a meta information-based keyword advertisement providing server for obtaining meta information from the outside server and providing a keyword advertisement based on the meta information; and
a keyword advertisement content providing server for obtaining at least one keyword advertisement content based on the meta information,
the keyword advertisement content providing system receives meta information related to the moving picture from the outside server, obtains at least one keyword advertisement content corresponding to the received meta information, and transmits the keyword advertisement content to the outside server or a user computer reproducing the moving picture in a direct manner or via the third server or a preset server, and
the meta information-based keyword advertisement providing server comprises:
a meta information reception module for receiving text type meta information from the outside server;
a keyword advertisement target text generation module for generating at least one keyword advertisement target text by using the received meta information;
a keyword advertisement content obtainment module for obtaining at least one keyword advertisement content corresponding to the keyword advertisement target text; and
a keyword advertisement content transmission module for transmitting the obtained keyword advertisement content to the outside server,
in which the outside server includes the multimedia content service system comprising a multimedia content service server transmitting moving picture information of a moving picture selected by the user to the user computer or a third server receiving meta information included in moving picture information from the multimedia content service system and transmitting the received meta information to the keyword advertisement content providing system,
the keyword advertisement content providing system comprises the meta information-based keyword advertisement providing server and the keyword advertisement content providing server,
the meta information-based keyword advertisement providing server generates at least one keyword advertisement target text by using the meta information obtained from the outside server and transmits the generated keyword advertisement target text to the keyword advertisement content providing server,
the keyword advertisement content providing server comprises a text obtainment module for receiving a keyword advertisement target text and a keyword advertisement content DB including at least one advertisement content, obtains at least one keyword advertisement content corresponding to the keyword advertisement target text from the keyword advertisement content DB,
the keyword advertisement content providing system transmits the obtained keyword advertisement content to the outside server, and
the user computer obtains moving picture information from the outside server.

14. A method for providing a keyword advertisement service based on meta information included in multimedia content information by a computer program recorded in a recording medium, the computer program being capable of providing a user computer with a keyword advertisement content based on moving picture information transmitted from a user computer, the method comprising:
obtaining text type meta information corresponding to the moving picture from web-page information including moving picture information transmitted to the user computer from a multimedia content service system;
transmitting a keyword advertisement target text generated using the obtained meta information to a keyword advertisement content providing server;
receiving at least one keyword advertisement content from the keyword advertisement content providing server; and
displaying the received keyword advertisement content before or after a reproduction of the moving picture on the user computer during a reproduction of the moving picture,
in which the computer program comprises a meta information obtainment module for obtaining meta information from the moving picture information, a keyword advertisement target text generation module for generating the keyword advertisement target text by using the meta information, a keyword advertisement content obtainment module for obtaining a keyword advertisement content from the keyword advertisement content providing server, and a keyword advertisement display module for displaying a keyword advertisement content obtained by the keyword advertisement content obtainment module on a preset location, which is discriminated from a moving picture area reproducing and displaying the moving picture,
the keyword advertisement display module comprises a keyword advertisement insertion module for inserting the keyword advertisement content to the received web page information, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and obtains at least one keyword advertisement content corresponding to the received keyword advertisement target text from the keyword advertisement content DB, and transmits the obtained keyword advertisement content to the multimedia content service server.

15. A recording medium recording a computer program, which provides a user computer with a keyword advertisement content based on moving picture information transmitted from the user computer, so as to provide a keyword advertisement service based on meta information included in multimedia content information, the recording medium comprising:
a web page information analysis module for analyzing web page information including moving picture information transmitted to the user computer;
a meta information obtainment module for obtaining meta information of the moving picture from the web page information analysis module;
a keyword advertisement target text generation module for generating at least one keyword advertisement target text by using the meta information obtained from the meta information obtainment module;
a keyword advertisement content obtainment module for obtaining at least one keyword advertisement content corresponding to a keyword advertisement target text generated by the keyword advertisement target text generation module from a keyword advertisement content providing server; and
a keyword advertisement display module for displaying a keyword advertisement content obtained by the keyword advertisement content obtainment module on a preset location, which is discriminated from a moving picture area reproducing and displaying the moving picture;
in which the keyword advertisement display module further comprises a keyword advertisement insertion module for inserting the keyword advertisement content to a preset location of the web page,
the web page information analysis module analyzes a web page including the received moving picture information and extracting meta information from the moving picture information,
the keyword advertisement insertion module binds the obtained keyword advertisement content with the web page transmitted to the user computer, corrects the web page so as to arrange the keyword advertisement content on a preset location and generates a corrected web page, and displays the corrected web page on the user computer, and
the keyword advertisement content providing server comprises a keyword advertisement content providing server-side text obtainment module for receiving a text, a keyword advertisement content DB including at least one advertisement content, and a keyword advertisement content providing server-side keyword advertisement content transmission module for transmitting the keyword advertisement content, and obtains at least one keyword advertisement content corresponding to the received keyword advertisement target text from the keyword advertisement content DB and transmits the obtained keyword advertisement content to the multimedia content service server.

16. A method for generating a commercial tag set for a moving picture by a commercial tag set generation system which generates at least one commercial tag set for a moving picture, the method comprising:
(a) obtaining information of the moving picture;
(b) receiving at least one commercial tag candidate corresponding to the moving picture;
(c) inquiring if a keyword advertisement content corresponding to the commercial tag candidate can be provided;
(d) generating a commercial tag set including at least one commercial tag selected among the commercial tag candidates corresponding to the transmittable keyword advertisement content; and
(e) corresponding the commercial tag set to the moving picture information and storing the inputted commercial tag set.

17. A keyword advertisement method using a commercial tag set by a multimedia content service system comprising a multimedia content service server transmitting moving picture information selected by a user, the keyword advertisement method comprising:
transmitting moving picture information to a commercial tag set generation system;
obtaining a commercial tag set corresponding to the moving picture information from the commercial tag set generation system;
corresponding the commercial tag set to the moving picture and storing the commercial tag set;
receiving selection information of a moving picture to be transmitted to the user computer from the user computer;
receiving a keyword advertisement content corresponding to at least one commercial tag included in the commercial tag set related to the moving picture corresponding to the received selection information; and
transmitting the moving picture and the keyword advertisement content to the user computer.

18. The method as claimed in claim 1, wherein the meta information is obtained from at least one of title information, tag information, and explanation information of the moving picture included in the moving picture information.

19. The method as claimed in claim 18, wherein the tag information is commercial tag information.

20. The method as claimed in claim 19, wherein the tag information includes time dependent commercial tag information including time zone information.

21. The method as claimed in claim 18, wherein the meta information is determined by a meta information selection policy of a keyword advertisement control policy DB, and
the keyword advertisement control policy DB includes a keyword advertisement control policy, and the keyword advertisement control policy includes information of a selection reference of meta information.

22. The method as claimed in claim 21, wherein the selection reference of the meta information includes at least one of (a) when tag information is included in obtained meta information, first selecting the tag information, (b) when tag information is included in obtained meta information, selecting both the tag information and title information, (c) when tag information is not included in obtained meta information, selecting title information, and (d) when tag information is not included in obtained meta information, selecting both title information and explanation information.

23. The method as claimed in claim 22, wherein when commercial tag information is included in the tag information, the commercial tag information is selected as meta information.

24. The method as claimed in claim 2, wherein a method of generating at least one keyword advertisement target text by using the selected meta information includes at least one of, when the meta information is title information, (a) a method of generating a word included in an advertisement keyword DB among words of the title information, as a keyword advertisement target text, (b) a method of natural language processing and analyzing a word included in the title information, extracting at least one name, and generating an extracted name as a keyword advertisement target text, and (c) a method of generating only names corresponding to words included in the advertisement keyword DB among the names extracted by the method (b), as a keyword advertisement target text,
when the meta information is tag information, (a) a method of generating a tag included in an advertisement keyword DB among at least one tag included in the tag information as a keyword advertisement target text, (b) a method of generating all tags included in the tag information as keyword advertisement target texts, (c) when the tag information includes multiple tags, a method of generating only a tag within a preset rank as a keyword advertisement target text, and (d) when the tag information includes multiple tags, a method of randomly selecting a tag from the multiple tags,
and when the meta information is explanation information, (a) a method of generating a word included in an advertisement keyword DB among words included in the explanation information as a keyword advertisement target text, (b) a method of natural language processing and analyzing words included in the explanation information, extracting at least one name, and generating an extracted name as a keyword advertisement target text, (c) a method of generating a name corresponding to a word included in the advertisement keyword DB among the names extracted by the method of (b) as a keyword advertisement target text, and (d) a method of calculating a frequency of the names extracted by the (b) method and generating only a name within a preset rank based on an order of a maximal frequency as a keyword advertisement target text,
and the advertisement keyword DB is a DB compiling keywords used for an advertisement serving as a target of the keyword advertisement,
and the name consists of at least one word and includes at least one attribute among a product name, a service name, a list of advertisement keywords received from the keyword advertisement content providing server, a list of advertisement keyword obtained from a third person, a self-generated advertisement keyword list, a list of keyword advertisement target text generating an advertising profit, a company name, a domain name, a noun, a slogan, and a brand.

25. The method as claimed in claim 2, wherein the generation of at least one keyword advertisement target text by using the selected meta information comprises the steps of a first step of generating a keyword advertisement target text candidate and a second step of inquiring of the keyword advertisement content providing server or an advertisement keyword DB about the generated keyword advertisement target text candidate, referring to an inquiry result, and generating a keyword advertisement target text only with the keyword advertisement target text candidate satisfying a preset reference.

26. The method as claimed in claim 25, wherein the first step of generating the keyword advertisement target text candidate includes at least one of, when the meta information is title information, (a) a method of generating a word included in an advertisement keyword DB among words of the title information, as a keyword advertisement target text candidate, (b) a method of natural language processing and analyzing words included in the title information, extracting at least one name, and generating an extracted name as a keyword advertisement target text candidate, and (c) a method of generating only a name corresponding to words included in the advertisement keyword DB among the names extracted by the method (b) as a keyword advertisement target text,
when the meta information is tag information, (a) a method of generating a tag included in an advertisement keyword DB among at least one tag included in the tag information as a keyword advertisement target text candidate, (b) a method of generating all tags included in the tag information as keyword advertisement target text candidates, (c) when the tag information includes multiple tags, a method of generating only a tag within a preset rank as a keyword advertisement target text candidate, and (d) when the tag information includes multiple tags, a method of randomly selecting a tag from the multiple tags,
and when the meta information is explanation information, (a) a method of generating a word included in an advertisement keyword DB among words included in the explanation information as a keyword advertisement target text candidate, (b) a method of natural language processing and analyzing words included in the explanation information, extracting at least one name, and generating an extracted name as a keyword advertisement target text candidate, (c) a method of generating a name corresponding to a word included in the advertisement keyword DB among the names extracted by the method of (b) as a keyword advertisement target text candidate, and (d) a method of calculating a frequency of the name extracted by the (b) method and generating only a name within a preset rank based on an order of a maximal frequency as a keyword advertisement target text candidate,
and the advertisement keyword DB is a DB compiling keywords used for an advertisement serving as a target of the keyword advertisement,
and the name consists of at least one word and includes at least one attribute among a product name, a service name, a company name, a domain name, a noun, a slogan, and a brand.

27. The method as claimed in claim 25, wherein generating of at least one keyword advertisement target text with the selected meta information further comprises a third step of identifying of whether the inquiry result of the keyword advertisement content providing server conforms to a policy of the keyword advertisement control policy DB,
wherein the identifying of whether the inquiry result conforms to a policy of the keyword advertisement control policy DB is to obtain at least one of (a) information on whether a keyword advertisement content corresponding to the keyword advertisement target text candidate is included in the keyword advertisement content providing server, (b) information on a maximum number of transmittable keyword advertisement contents, (c) information on an advertisement unit price of at least one keyword advertisement content within a preset or higher rank, and (d) information on an expected click rate in comparison with an exposure of at least one keyword advertisement content, and refer to a policy reference of the keyword advertisement control policy DB corresponding to any one of information (a), (b), (c), and (d) obtained from the keyword advertisement content providing server, the keyword advertisement control policy DB includes a keyword advertisement control policy and the keyword advertisement control policy includes information on a reference for a keyword advertisement target text generation.

28. The method as claimed in claim 25, wherein the referring to the inquiry result comprises transmitting a keyword advertisement target text corresponding to each of the keyword advertisement target text candidates or a keyword advertisement target text candidate in a preset group unit to the keyword advertisement content providing server and obtaining confirmation information on existence of a keyword advertisement content corresponding to the keyword advertisement target text candidate from the keyword advertisement content providing server.

29. The method as claimed in claim 10, wherein the transmitting generated keyword advertisement target text to the keyword advertisement content providing server comprises at least one of (a) a method of transmitting all of the generated keyword advertisement target texts to the keyword advertisement content providing server and (b) a method of discriminating the generated keyword advertisement target text based on a kind of meta information on which the generated keyword advertisement target text is based and transmitting the keyword advertisement target text based on at least one selected kind of the meta information.

30. The method as claimed in claim 10, wherein when a number of keyword advertisement target texts are more than one, the transmitting generated keyword advertisement target text to the keyword advertisement content providing server comprises at least one of, (a) a method of transmitting the generated multiple keyword advertisement target texts at one time, (b) a method of individually transmitting the generated multiple keyword advertisement target texts one by one, and (c) a method of dividing the multiple keyword advertisement target texts into at least two groups and transmitting the multiple keyword advertisement target texts in a group unit, but in a case where there are multiple numbers of keyword advertisement target texts included in a same group, applying any one between the method (a) and the method (b).

31. The method as claimed in claim 1, further comprising granting a management number to the generated keyword advertisement target text, and mapping the generated keyword advertisement target text to a keyword advertisement content received from the keyword advertisement content providing server on a basis of the management number and storing the keyword advertisement content.

32. The method as claimed in claim 1, further comprising, when a number of the keyword advertisement target texts are more than one and the keyword advertisement target texts are managed in the unit of at least one group, granting a management number to each of the group and each of the keyword advertisement target texts included in the group, and mapping the keyword advertisement target text included in the group to a keyword advertisement content received from the keyword advertisement content providing server on a basis of the management number and storing the keyword advertisement content.

33. The method as claimed in claim 1, further comprising, when a number of the transmitted or received keyword advertisement contents are more than one, selecting at least one keyword advertisement content to be transmitted to the user computer among the keyword advertisement contents on a basis of a specific time.

34. The method as claimed in claim 33, wherein, in the selecting keyword advertisement content, it is selected keyword advertisement contents equal to or less than a preset number, serving as a maximal value, of keyword advertisement contents among the keyword advertisement contents received from the keyword advertisement content providing server.

35. The method as claimed in claim 33, wherein the selecting the keyword advertisement content is to select the keyword advertisement content according to a kind of meta information on which the keyword advertisement target text is based, and the keyword advertisement content is obtained from the keyword advertisement content providing server through inquiring of the keyword advertisement content providing server about each of the keyword advertisement contents.

36. The method as claimed in claim 33, wherein, in the selecting the keyword advertisement content, when a number of keyword advertisement contents transmitted from the keyword advertisement content providing server are more than one, a number of keyword advertisement contents to be transmitted to the user computer on a basis of a specific time has been set, and a number of keyword advertisement contents is larger than the number of keyword advertisement contents to be transmitted to the user computer on a basis of a specific time, the keyword advertisement contents are divided into at least two groups and the keyword advertisement contents included in the groups are selected based on each group, and a number of keyword advertisement contents included in each of the groups is equal to or less than the number of keyword advertisement contents to be transmitted to the user computer on a basis of the specific time.

37. The method as claimed in claim 1, wherein the transmitting the moving picture information and the keyword advertisement content to the user computer comprises one of (a) a method of discriminating between an area of the reproduced moving picture information and an area of the keyword advertisement content, generating an information unit to be transmitted to the user computer, and synchronizing the area of the reproduced moving picture information and the area of the keyword advertisement content, to transmit the reproduced moving picture information and the keyword advertisement content to the user computer, and (b) a method of discriminating between an area of the reproduced moving picture information and an area of the keyword advertisement content, generating an information unit to be transmitted to the user computer, and asynchronizing the area of the reproduced moving picture information and the area of the keyword advertisement content, to transmit the reproduced moving picture information and the keyword advertisement content to the user computer, respectively.

38. The method as claimed in claim 37, wherein, in the method (b), at least one keyword advertisement content to be transmitted to the area of the keyword advertisement content is varied according to a passage of time.

39. The method as claimed in claim 38, wherein the time is a preset time range.

40. The method as claimed in claim 39, wherein the preset time range is determined by at least one variable selected from (a) a number of keyword advertisement contents received from the keyword advertisement content providing server, (b) a number of keyword advertisement contents selected among the keyword advertisement contents received from the keyword advertisement content providing server, (c) a number of keyword advertisement contents to be transmitted to the user computer based on a specific time, and (d) a reproduction time of the moving picture.

41. The method as claimed in claim 1, wherein the program transmitted to the user computer comprises a program measuring a click generation and a time, and the program further comprises recording a time of receiving at least one keyword advertisement content, monitoring if a click for the keyword advertisement content is generated by a preset time, and when click generation information of the keyword advertisement content has not been obtained by the preset time, making a request of additional keyword advertisement content to a server that has been transmitted the keyword advertisement content.

42. The method as claimed in claim 1, wherein the information transmitted to the user computer includes a program, and the program comprises a program measuring a click generation and a time, and further comprises recording a time of receiving at least one keyword advertisement content, and monitoring if a click for a keyword advertisement content is generated by a preset time, and when click generation information for the specific keyword advertisement content has been obtained by the preset time, the program does not change the keyword advertisement content transmitted to the user computer from the time of receiving the click generation information to a preset second time.

43. The method as claimed in claim 42, wherein the program further comprises, when additional click generation information for the keyword advertisement content transmitted to the user computer has not been obtained by the preset second time, transmitting a preset number of keyword advertisement contents selected from the keyword advertisement contents received from the keyword advertisement content providing server, excluding the keyword advertisement contents which have been transmitted to the user computer, to the user computer.

44. The method as claimed in claim 1, wherein the information transmitted to the user computer comprises a program, and the program comprises a program measuring a click generation and a time, and further comprises recording a time of receiving at least one keyword advertisement content, and
monitoring if a click for a keyword advertisement content is generated by a preset time, and
when click generation information for the specific keyword advertisement content has been obtained by the preset time, making a request of a keyword advertisement content related to the keyword advertisement content corresponding to the click generation to a server that has transmitted the keyword advertisement content to the user computer.

45. The method as claimed in claim 1, wherein the moving picture includes at least one of a real photographed moving picture, a non-real moving picture, an UCC moving picture, a movie, a flash moving picture, a real-time broadcasting, and a recorded broadcasting including text type meta information.

46. A method for information processing by a commercial tag set generation system, which generates at least one commercial tag set corresponding to a digital content, so as to provide a keyword advertisement service based on meta information, the method comprising:
(A) obtaining at least one commercial tag candidate for the digital content;
(B) obtaining commerciality information of the commercial tag candidate;
(C) generating at least one commercial tag set including at least one commercial tag candidate corresponding to received selection information among the commercial tag candidates, for the digital content; and
(D) corresponding the obtained commercial tag set to identification information of the digital content and storing the commercial tag set, or transmitting the commercial tag set to a preset system together with the identification information,
in which the commercial tag set information is information related to a commercial tag set, and the commercial tag set consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through the keyword advertisement content providing system by using the commercial tag, and
the tag includes at least one text string of a product name, a service name, a proper noun, and a keyword registered in the keyword advertisement content providing system by an advertiser, and
when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of the advertiser corresponding to a keyword registered by the advertiser.

47. The method as claimed in claim 46, wherein the preset system subject to receiving the commercial tag set in the (D) includes at least one of a content producer system, a content circulator system, a content distributor system, the keyword advertisement content providing system, the user computer, a preset program executed in the user computer, a multimedia content service system, a broadcasting service system providing the user computer with a broadcasting content, a digital publication service system providing the user computer with a digital publication, a media service system providing the user computer with a media service, and a content syndication system involving distribution or transference of a digital content.

48. The method as claimed in claim 46, further comprising, after the (B) and prior to the (C),
transmitting at least one commercial tag candidate including the commerciality information to a computer of a person desiring to generate a commercial tag set by using a commercial tag set generation system; and
receiving selection information of at least one commercial tag candidate from a computer of a person desiring to generate a commercial tag set by using a commercial tag set generation system.

49. The method as claimed in claim 48, further comprising additionally receiving at least one of rank information, time information, and condition information applied to at least one commercial tag candidate from a computer of a person desiring to generate a commercial tag set by using a commercial tag set generation system.

50. The method as claimed in claim 49, wherein, in the (C), the commercial tag set is generated through corresponding a commercial tag candidate corresponding to the received selection information to the received rank information, time information, and condition information and storing the commercial tag set.

51. The method as claimed in claim 46, wherein, in the (A) of obtaining at least one commercial tag candidate for the digital content, when a text content is included in the digital content, the text context is analyzed, at least one commercial tag candidate is extracted from the analyzed text context, and the extracted commercial tag candidate is obtained.

52. The method as claimed in claim 46, wherein the commercial tag set generation system belongs to one of a content producer system of a producer producing the digital content, a content circulator system of a circulator circulating the digital content, a content distributor system for distributing the digital content to a user computer, a digital content service system providing the user computer with a digital content, the keyword advertisement content providing system, a content syndication system for managing transference of the digital content, the user computer, and a preset program executed in the user computer, and
the commercial tag set generation system is independent of the content producer system, the content circulator system, the content distributor system, the digital content service system, the keyword advertisement content providing system, the content syndication system, the user computer, and the preset program executed in the user computer, and is wired/wirelessly connected with them, and
the digital content service system includes at least one of a multimedia content service system providing the user computer with a multimedia content, a broadcasting service system providing the user computer with a broadcasting content, a digital publication service system providing the user computer with a digital publication, and a media service system providing the user computer with a media service.

53. The method as claimed in claim 46, wherein the commerciality information of the tag includes at least one of, with respect to the tag, 1) a total number of exposures/a total number of calls, 2) an increase/decrease rate of the total number of exposures/calls, 3) a total number of advertisers, 4) an average advertisement unit price, 5) a highest advertisement unit price, 6) a lowest advertisement unit price, 7) an average number of advertisers, 8) an average number of keyword advertisement contents, 9) an increase/decrease rate of the average number of advertisers, and 10) an increase/decrease rate of the average advertisement unit price, and with respect to the keyword advertisement contents corresponding to the tag, 11) a number of exposures, 12) a click generation rate of a keyword advertisement content with respect to exposure, 13) a total number of clicks, 14) a generated advertisement profit, 15) an increase/decrease rate of the number of exposures, 16) an increase/decrease rate of a click generation rate with respect to exposures, 17) an increase/decrease rate of a total number of clicks, 18) an increase/decrease rate of a generated advertisement profit, and at least one preset function value using at least one of the 1) to 18).

54. The method as claimed in claim 46, wherein the commercial tag constituting the commercial tag set is used for the obtaining of a keyword advertisement content, and the keyword advertisement content is exposed on a user computer together with the digital content, and
a method of exposing the digital content with the keyword advertisement content on the user computer comprises at least one of
1) a first method of transmitting the commercial tag set to the keyword advertisement content providing system in a direct manner or via a third system, obtaining at least one keyword advertisement content from the keyword advertisement content providing system in a direct manner or via the third system, and then transmitting the digital content and the obtained keyword advertisement content to the user computer, by at least one of the commercial tag generation system, the content producer system of a producer producing the digital content, the content circulator system of the circulator circulating the digital content, the content distributor system for distributing the digital content to a user computer, the digital content service system providing the user computer with a digital content, the keyword advertisement content providing system, the content syndication system for managing transference of the digital content, the user computer, and the preset program executed in the user computer,
2) a second method of, by at least one of the commercial tag generation system, the content producer system of a producer producing the digital content, the content circulator system of a circulator circulating the digital content, the content distributor system for distributing the digital content to a user computer, the digital content service system providing the user computer with a digital content, the keyword advertisement content providing system, the content syndication system for managing transference of the digital content, the user computer, and a preset program executed in the user computer, transmitting a program having a function of obtaining the commercial tag set and a keyword advertisement content from the keyword advertisement content providing system by using the commercial tag set to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the keyword advertisement content on the user computer,
3) a third method of, by at least one of the commercial tag generation system, the content producer system of a producer producing the digital content, the content circulator system of a circulator circulating the digital content, the content distributor system for distributing the digital content to a user computer, the digital content service system providing the user computer with a digital content, the keyword advertisement content providing system, the content syndication system for managing transference of the digital content, the user computer, and a preset program executed in the user computer, transmitting a program having a function of obtaining a keyword advertisement content from the keyword advertisement content providing system by using the commercial tag set and a function of obtaining a commercial tag set corresponding to the digital content to the user computer, and by the program, obtaining the commercial tag set corresponding to the digital content, transmitting the obtained commercial tag set to the keyword advertisement content providing system in a direct manner or via the third system, obtaining at least one keyword advertisement content from the keyword advertisement content providing system in a direct manner or via the third system, and exposing the keyword advertisement content on the user computer, and
4) a fourth method of, by at least one of a commercial tag generation system, the content producer system of a producer producing the digital content, the content circulator system of a circulator circulating the digital content, the content distributor system for distributing the digital content to a user computer, the digital content service system providing the user computer with a digital content, the keyword advertisement content providing system, the content syndication system for managing transference of the digital content, the user computer, and a preset program executed in the user computer, including a program having a function of obtaining a keyword advertisement content from the keyword advertisement content providing system by using the commercial tag set and a function of obtaining a commercial tag set corresponding to the digital content in the digital content and transmitting the program to the user computer, and by the program, obtaining the commercial tag set corresponding to the digital content, transmitting the obtained commercial tag set to the keyword advertisement content providing system in a direct manner or via the third system, receiving the commercial tag set from the keyword advertisement content providing system in a direct manner or via the third system, and exposing the keyword advertisement content on the user computer.

55. A method for information processing by a content syndication system which participates in a transference of a digital content by using a wired/wireless network, so as to provide a keyword advertisement service based on meta information by using a commercial tag set, the method comprising:
(A) obtaining request information of at least one commercial tag set information corresponding to at least one digital content information from a preset first system;
(B) obtaining the commercial tag set information corresponding to the digital content information; and
(C) transmitting the commercial tag set information to a preset second system,
in which the commercial tag set information is information related to a commercial tag set, and the commercial tag set consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through a keyword advertisement content providing system by using the commercial tag, and
the tag includes at least one text string of a product name, a service name, a proper noun, and a keyword registered in the keyword advertisement content providing system by an advertiser, and
when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of an advertiser corresponding to a keyword registered by the advertiser.

56. The method as claimed in claim 55, wherein the commercial tag set is generated using a commercial tag set generation system, and the commercial tag set generation system provides at least one between existence information of a keyword advertisement content corresponding to the tag and commerciality information of the tag.

57. The method as claimed in claim 55, wherein the digital content information includes at least one of physical digital content data, digital content identification information capable of identifying the physical digital content data, and digital content location information capable of accessing the physical digital content data through a wired/wireless network, and the commercial tag set information includes at least one of physical commercial tag set data, commercial tag set identification information capable of identifying the physical commercial tag set data, and commercial tag set location information capable of accessing the physical commercial tag set data through a wired/wireless network.

58. The method as claimed in claim 55, wherein the first system and the second system include at least one of the digital content service system providing a user computer with a digital content, the content syndication system, the keyword advertisement content providing system, the user computer, and a preset program executed in the user computer, and
the digital content service system includes at least one of the multimedia content service system providing the user computer with a multimedia content, the broadcasting service system providing the user computer with a broadcasting content, a digital publication system providing the user computer with a digital publication, and a media service system providing the user computer with a media service.

59. The method as claimed in claim 55, wherein the content syndication system belongs to one of a content producer system of the producer producing the digital content, the content circulator system of a circulator circulating the digital content, the content distributor system for distributing the digital content to a user computer, the digital content service system providing a user computer with a digital content, the keyword advertisement content providing system, the user computer, and a preset program executed in the user computer,
the content syndication system is independent of the content producer system, the content circulator system, the content distributor system, the digital content service system, the keyword advertisement content providing system, the user computer, and the preset program executed in the user computer and is wired/wirelessly connected with them, and
the digital content service system includes at least one of the multimedia content service system providing the user computer with a multimedia content, the broadcasting service system providing the user computer with a broadcasting content, the digital publication system providing the user computer with a digital publication, and the media service system providing the user computer with a media service.

60. The method as claimed in claim 55, wherein the first system is the content syndication system, the content syndication system binds the digital content information with the obtained commercial tag set information prior to performing the (C), and in the (C) process, the content syndication system transmits the digital content information to the second system together with the commercial tag set information.

61. The method as claimed in claim 60, wherein, in the binding the digital content information with the obtained commercial tag set information, the digital content information including at least one of the physical digital content data, the digital content identification information for identifying the physical digital content data, and the digital content location information for accessing the physical digital content data through a wired/wireless network with the commercial tag set information including at least one of the physical commercial tag set data, the commercial tag set identification information capable of identifying the physical commercial tag set data, and the commercial tag set location information capable of accessing the physical commercial tag set data through a wired/wireless network.

62. The method as claimed in claim 61, wherein the binding of the digital content information with the obtained commercial tag set information includes at least one of a first method of connecting digital content information with the commercial tag set information and storing the connected digital content information and commercial tag set information, a second method of using a same key value for the digital content information and the commercial tag set information so as to connect the digital content information with the commercial tag set information, a third method of using identification information of one between the digital content information and the commercial tag set information serving as a key value for another information so as to connect the digital content information with the commercial tag set information, and a fourth method of calling, by one information between the digital content information and the commercial tag set information, another information, so as to connect the digital content information with the commercial tag set information.

63. The method as claimed in claim 55, wherein the commerciality information of the tag includes at least one of, with respect to the tag, 1) a total number of exposures/a total number of calls, 2) an increase/decrease rate of the total number of exposures/calls, 3) a total number of advertisers, 4) an average advertisement unit price, 5) a highest advertisement unit price, 6) a lowest advertisement unit price, 7) an average number of advertisers, 8) an average number of keyword advertisement contents, 9) an increase/decrease rate of the average number of advertisers, and 10) an increase/decrease rate of the average advertisement unit price, and with respect to the keyword advertisement contents corresponding to the tag, 11) a number of exposures, 12) a click generation rate of a keyword advertisement content with respect to exposure, 13) a total number of clicks, 14) a generated advertisement profit, 15) an increase/decrease rate of the number of exposures, 16) an increase/decrease rate of a click generation rate with respect to exposures, 17) an increase/decrease rate of a total number of clicks, 18) an increase/decrease rate of a generated advertisement profit, and at least one preset function value using at least one of the 1) to 18).

64. The method as claimed in claim 55, wherein the generating the commercial tag set for the digital content by the commercial tag set generation system comprises:
(a1) obtaining at least one commercial tag for the digital content;
(a2) obtaining commerciality information of the commercial tag candidate;
(a3) generating at least one commercial tag set including at least one commercial tag candidate corresponding to the received selection information among the commercial tag candidates for the digital content; and
(a4) corresponding the generated commercial tag set to identification information of the digital content and storing the commercial tag set and identification information, or transmitting the commercial tag set to a preset system together with the identification information.

65. The method as claimed in claim 55, wherein the commercial tag set includes at least one of rank information, time information, and condition information applied to at least one commercial tag constituting the commercial tag set.

66. The method as claimed in claim 55, wherein the commercial tag constituting the commercial tag set is used for the obtaining of a keyword advertisement content, the keyword advertisement content is exposed on a user computer together with the digital content, and
a method of exposing of the digital content and the keyword advertisement content on the user computer comprises;
1) a first method of, by one of the content syndication system, the first system, and the second system, transmitting the commercial tag set to the keyword advertisement content providing system in a direct manner or via a third system, receiving at least one keyword advertisement content from the keyword advertisement content providing system in a direct manner or via the third system, and then transmitting the digital content and the received keyword advertisement content to the user computer;
2) a second method of, by one of the content syndication system, the first system, and the second system, transmitting a program having a function of obtaining the commercial tag set and a keyword advertisement content by using the commercial tag set from the keyword advertisement content providing system to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the keyword advertisement content on the user computer;
3) a third method of, by one of the content syndication system, the first system, and the second system, transmitting a program having a function of obtaining a keyword advertisement content by using the commercial tag set from the keyword advertisement content providing system and a function of obtaining a commercial tag set corresponding to the digital content to the user computer, and by the program, obtaining the commercial tag set corresponding to the digital content by the program, transmitting the obtained commercial tag set to the keyword advertisement content providing system in a direct manner or via the third system, receiving at least one keyword advertisement content from the keyword advertisement content providing system in a direct manner or via the third system, and exposing the keyword advertisement content on the user computer; and
4) a fourth method of, by one of the content syndication system, the first system, and the second system, including a program having a function of obtaining a keyword advertisement content by using the commercial tag set from the keyword advertisement content providing system and a function of obtaining a commercial tag set corresponding to the digital content in the digital content and transmitting the program to the user computer, and by the program, obtaining the commercial tag set corresponding to the digital content by the program, transmitting the obtained commercial tag set to the keyword advertisement content providing system in a direct manner or via the third system, receiving at least one keyword advertisement content from the keyword advertisement content providing system in a direct manner or via the third system, and exposing the keyword advertisement content on the user computer.

67. A method for providing a keyword advertisement service based on meta information by an exposed keyword management server comprising an exposed keyword advertisement management server, which manages information of at least one commercial tag set and at last one keyword advertisement content exposed on a user computer, the method comprising:
performing at least one of exposing at least one commercial tag set and exposing at least one keyword advertisement content on the user computer;
when the commercial tag set is exposed on the user computer, providing a commercial tag set storage means for storing the commercial tag set exposed on the user computer, and when the keyword advertisement content is exposed on the user computer, providing a keyword advertisement content reservation means for reserving the keyword advertisement content exposed on the user computer and reproducing the reserved keyword advertisement content again upon a request;
performing at least one of receiving selection information of the commercial tag set storage means from the user computer and storing the commercial tag set corresponding to the received selection information, and receiving selection information of the keyword advertisement content reservation means from the user computer and storing the keyword advertisement content corresponding to the received selection information; and
performing at least one of exposing at least one of at least one stored commercial tag set and at least one keyword advertisement content corresponding to the stored commercial tag set on the user computer, and exposing the reserved keyword advertisement content on the user computer,
the commercial tag set is generated by a commercial tag set generation system and consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through a keyword advertisement content providing system by using the commercial tag, and
the tag includes at least one text string of a product name, a service name, a proper noun, and a keyword registered in the keyword advertisement content providing system by an advertiser,
the commercial tag set generation system provides at least one of existence of a keyword advertisement content corresponding to the tag and commerciality information of the tag, and
when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of the advertiser corresponding to a keyword registered by the advertiser.

68. The method as claimed in claim 67, wherein the exposed keyword management server performs at least one of:
(1) a first method of performing the steps of claim 67 while the exposed keyword management server is included in a preset system including or using the exposed keyword advertisement management server; and
(2) a second method of transmitting a program having a function of the exposed keyword advertisement management server to the user computer by a preset system including or using the exposed keyword advertisement management server performs, and performing the steps of claim 67 in connection with the system by the program executed in the user computer,
and the system includes one of the multimedia content service system providing the user computer with a multimedia content while being in connected with the keyword advertisement content providing system, the content syndication system managing distribution of the multimedia content while being in connected with the keyword advertisement content providing system, the commercial tag set generation system generating the commercial tag set while being in connected with the keyword advertisement content providing system, and the keyword advertisement content providing system.

69. The method as claimed in 67, wherein the commercial tag set and the keyword advertisement content are changed in connection with a reproduction time point and a reproduction section of a multimedia content exposed on the user computer, and
in the performing at least one of the storing of the commercial tag set corresponding to the received selection information and the storing of the keyword advertisement content corresponding to the received selection information, the commercial tag set and the keyword advertisement content includes information of the reproduction time point and the reproduction section of the multimedia content corresponding to a time of receiving the selection information, to be stored.

70. The method as claimed in claim 67, wherein in the performing of at least one of the exposing at least one of the stored commercial tag set and the keyword advertisement content corresponding to the stored commercial tag set on the user computer and the exposing the reserved keyword advertisement content on the user computer comprises at least one of:
1) a first method of exposing screen information of the multimedia content corresponding to the time of receiving selection information of the storage of the commercial tag set and the reservation of the keyword advertisement content on the user computer, and
2) a second method of arranging the stored commercial tag set, a keyword advertisement content corresponding to the stored commercial tag set, and the reserved keyword advertisement content in order of a time of receiving selection information of the storage of the commercial tag set and the reservation of the keyword advertisement content.

71. A method for information processing by a broadcasting service system including a keyword advertisement content, the broadcasting service system providing a user computer with at least one audio broadcasting content or audio-visual broadcasting content through a wired/wireless network, so as to provide a keyword advertisement service based on meta information, the method comprising:
obtaining at least one commercial tag set corresponding to the broadcasting content, the commercial tag set being generated by the broadcasting service system by using a commercial tag generation system;
corresponding the obtained commercial tag set to a broadcasting content identifier corresponding to the broadcasting content and storing the commercial tag set and broadcasting content identifier; and
exposing the broadcasting content and at least one keyword advertisement content called through a keyword advertisement content providing system in a direct manner or via a third system by using the commercial tag set on the user computer,
wherein the commercial tag set is generated by a commercial tag set generation system, and the commercial tag set consists of at least one commercial tag belonging to a category of a tag, and the commercial tag guarantees an existence of at least one keyword advertisement content corresponding to the commercial tag in at least one time point between a generation time point of the commercial tag or a calling time point of a keyword advertisement through the keyword advertisement content providing system by using the commercial tag, and
the tag includes at least one text string of a product name, a service name, a proper noun, and a keyword registered in the keyword advertisement content providing system by an advertiser, and
the commercial tag set generation system provides at least one between existence information of a keyword advertisement content corresponding to the commercial tag and commerciality information of the commercial tag,
when the keyword advertisement content providing system receives a text string, the keyword advertisement content providing system inquires of a keyword advertisement content DB about an existence of the keyword advertisement content corresponding to the text string and obtains at least one keyword advertisement content, and
the keyword advertisement content DB stores a keyword advertisement content of the advertiser corresponding to a keyword registered by the advertiser.

72. The method as claimed in claim 71, wherein a broadcasting provided from the broadcasting service system is a real-time broadcasting, a commercial tag set generated by the commercial tag generation system is a real-time commercial tag set generated during a real time broadcasting, and the exposed keyword advertisement content is exposed on the user computer during broadcasting of the real-time broadcasting.

73. The method as claimed in claim 71, wherein the commercial tag set is generated by at least one of:
1) a first method of directly inputting the commercial tag set to the commercial tag generation system by a person operating or managing the broadcasting service system, a person progressing the real-time broadcasting, or an entrusted person of the person operating or managing the broadcasting service system;
2) a second method of analyzing text information included in a continuity included in the broadcasting content and extracting at least one commercial tag by the commercial tag generation system, and receiving a selection of a commercial tag set from a person operating or managing the broadcasting service system, a person progressing the real-time broadcasting, or an entrusted person of the person operating or managing the broadcasting service system; and
3) a third method of recognizing voice information included in the broadcasting content, analyzing text information included in the voice information, and extracting at least one commercial tag by the commercial tag generation system, and receiving a selection of a commercial tag set from a person operating or managing the broadcasting service system, a person progressing the real-time broadcasting, or an entrusted person of the person operating or managing the broadcasting service system.

74. The method as claimed in claim 71, wherein, in the corresponding the obtained commercial tag set to a broadcasting content identifier corresponding to the broadcasting content and the storing the commercial tag set and broadcasting content identifier, time information corresponding to the commercial tag set is included and stored.

75. The method as claimed in claim 71, wherein the commerciality information of the tag includes at least one of, with respect to the tag, 1) a total number of exposures/a total number of calls, 2) an increase/decrease rate of the total number of exposures/calls, 3) a total number of advertisers, 4) an average advertisement unit price, 5) a highest advertisement unit price, 6) a lowest advertisement unit price, 7) an average number of advertisers, 8) an average number of keyword advertisement contents, 9) an increase/decrease rate of the average number of advertisers, and 10) an increase/decrease rate of the average advertisement unit price, and with respect to the keyword advertisement contents corresponding to the tag, 11) a number of exposures, 12) a click generation rate of a keyword advertisement content with respect to exposure, 13) a total number of clicks, 14) a generated advertisement profit, 15) an increase/decrease rate of the number of exposures, 16) an increase/decrease rate of a click generation rate with respect to exposures, 17) an increase/decrease rate of a total number of clicks, 18) an increase/decrease rate of a generated advertisement profit, and at least one preset function value using at least one of the 1) to 18).

76. The method as claimed in claim 71, wherein the exposing of the broadcasting content and the keyword advertisement content on the user computer comprises at least one of:
1) a first method of, by the broadcasting service system, transmitting a program requesting obtainment of a keyword advertisement content in a preset time interval to the user computer; receiving a transmission request of a keyword advertisement content in a preset time interval through the program executed in the user computer; transmitting the commercial tag set to the keyword advertisement content providing system in a direct manner or via the third system and receiving at least one keyword advertisement content from a keyword advertisement content providing system in a direct manner or via the third system; and transmitting the received keyword advertisement content to the user computer;
2) a second method of, by the broadcasting service system, transmitting a program having a function of obtaining the commercial tag set and a keyword advertisement content by using the commercial tag set from the keyword advertisement content providing system to the user computer; and by the program, transmitting the commercial tag set to the keyword advertisement content providing system in a direct manner or via the third system, receiving at least one keyword advertisement content from the keyword advertisement content providing system in a direct manner or via the third system, and exposing the received keyword advertisement content on the user computer;
3) a third method of by the broadcasting service system, transmitting a program having a function of obtaining a keyword advertisement content by using the commercial tag set from the keyword advertisement content providing system and making a request of a commercial tag set corresponding to the broadcasting content to the broadcasting service system in a preset time interval and obtaining the commercial tag set to the user computer; and by the program, obtaining the commercial tag set corresponding to the broadcasting content; transmitting the obtained commercial tag set to the keyword advertisement content providing system in a direct manner or via the third system; receiving at least one keyword advertisement content from the keyword advertisement content providing system in a direct manner or via the third system, and exposing the received keyword advertisement content on the user computer; and
4) a fourth method of by the broadcasting service system, including a program having a function of obtaining a keyword advertisement content from the keyword advertisement content providing system by using the commercial tag set and making a request of a commercial tag set corresponding to the broadcasting content to the broadcasting service system in a preset time interval and obtaining the commercial tag set corresponding to the broadcasting content from the broadcasting service system in the broadcasting content when the broadcasting content is initially transmitted to the user computer and transmitting the program to the user computer; and by the program, obtaining the commercial tag set corresponding to the broadcasting content; transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer.

77. The method as claimed in 76, wherein, in the first method, when the broadcasting service is a real-time broadcasting, the broadcasting service system obtains the keyword advertisement content by using a commercial tag set corresponding to the time point of receiving the transmission request of the keyword advertisement content from the user computer, and the commercial tag set corresponding to the time point of receiving the transmission request of the keyword advertisement content is a commercial tag set generated just before a time of receiving the transmission request of the keyword advertisement content,
in the second method, when the broadcasting service is a real-time broadcasting, the commercial tag set is generated before the real-time broadcasting and further includes time zone information used for obtainment of a keyword advertisement content by using the commercial tag set, and the program further has a function capable of selecting a commercial tag set used for obtainment of a keyword advertisement content with reference to information of a current time point of the reproduction of the broadcasting content, and
in one of the third method and the fourth method, when the broadcasting service is a real-time broadcasting, the broadcasting service system transmits a commercial tag set corresponding to the time point of receiving the transmission request of the commercial tag set from the user computer, to the user computer, and the transmitted commercial tag set is a commercial tag set generated just before a time of receiving the transmission request of the commercial tag set.

78. A method for information processing by a media service system, which provides multiple user computers accessing through a wired/wireless network with at least one content and at least one online service, so as to provide a keyword advertisement service based on meta information, the method comprising:
allowing a content manager managing at least one content by using a media service system to use a commercial tag generation system and obtaining at least one commercial tag set corresponding to at least one content managed by the content manager by using the commercial tag generation system from the content manager;
corresponding the obtained commercial tag set to a content identifier corresponding to the content and storing the commercial tag set;
obtaining request information of a content managed by the content manager from at least one user computer;
obtaining the commercial tag set corresponding to a content corresponding to the received request information; and
exposing the content corresponding to the received request information and at least one keyword advertisement content called through a keyword advertisement content providing system in a direct manner or a third system by using the commercial tag set on the user computer, and
the commercial tag set is generated by a commercial tag set generation system and consists of at least one commercial tag belonging to a category of a tag, and
the commercial tag guarantees an existence of at least one keyword advertisement content corresponding to the commercial tag in at least one time point between a generation time point of the commercial tag or a calling time point of the keyword advertisement through a keyword advertisement content providing system by using the commercial tag, and
the tag includes at least one text string of a product name, a service name, a proper noun, and a keyword registered in the keyword advertisement content providing system by an advertiser, and
the commercial tag set generation system provides at least one between existence information of a keyword advertisement content corresponding to at least one tag and commerciality information of at least one tag, and
when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of an advertiser corresponding to a keyword registered by the advertiser.

79. The method as claimed in claim 78, wherein the media service system provides at least one of a blog service, a community service, a social network service, and one person media service including a one-person broadcasting, and the content manager is a person generating and managing a digital type content consisting of at least one of texts, images, moving pictures, and sounds by using the blog service, a café service, the community service, the social network service.

80. The method as claimed in claim 78, wherein the tag subjected to the provision of information of the existence of the keyword advertisement content and the commerciality information of the tag is generated by at least one of:
1) a first method of directly inputting the commercial tag by the content manager;
2) a second method of extracting at least one commercial tag for the content by the commercial tag generation system; and
3) a third method of extracting at least one commercial tag for the content by the commercial tag generation system and receiving a selection of the tag from the content manager.

81. The method as claimed in claim 78, wherein when a number of tags are more than one, the commercial tag generation system receives selection information of at least one tag among multiple tags from the content manager.

82. The method as claimed in claim 78, wherein the commerciality information of the tag includes at least one of, with respect to the tag, 1) a total number of exposures/a total number of calls, 2) an increase/decrease rate of the total number of exposures/calls, 3) a total number of advertisers, 4) an average advertisement unit price, 5) a highest advertisement unit price, 6) a lowest advertisement unit price, 7) an average number of advertisers, 8) an average number of keyword advertisement contents, 9) an increase/decrease rate of the average number of advertisers, and 10) an increase/decrease rate of the average advertisement unit price, and with respect to the keyword advertisement contents corresponding to the tag, 11) a number of exposures, 12) a click generation rate of a keyword advertisement content with respect to exposure, 13) a total number of clicks, 14) a generated advertisement profit, 15) an increase/decrease rate of the number of exposures, 16) an increase/decrease rate of a click generation rate with respect to exposures, 17) an increase/decrease rate of a total number of clicks, 18) an increase/decrease rate of a generated advertisement profit, and at least one preset function value using at least one of the 1) to 18).

83. The method as claimed in claim 78, wherein the content is a content including at least one of a sound and a moving picture requiring a time for a reproduction of a content, and the commercial tag corresponding to a content requiring a time for a reproduction is a time dependent commercial tag additionally including at least one time information.

84. The method as claimed in claim 78, wherein the exposing of the keyword advertisement content on the user computer comprises at least one of:
1) a first method of, by the media service system, transmitting the commercial tag set to the keyword advertisement content providing system in a direct manner or via the third system, receiving at least one keyword advertisement content from the keyword advertisement content providing system in a direct manner or via the third system, and transmitting the content and the received keyword advertisement content to the user computer;
2) a second method of, by the media service system, transmitting a program having a function of obtaining the commercial tag set and a keyword advertisement content by using the commercial tag set from the keyword advertisement content providing system to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the received keyword advertisement content on the user computer; and
3) a third method of, by the media service system, transmitting a program having a function of obtaining a keyword advertisement content from the keyword advertisement content providing system by using the commercial tag set and a function of obtaining a commercial tag set corresponding to the content to the user computer, and by the program, obtaining the commercial tag set corresponding to the content, transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer.

85. A method for information processing by a digital publication service system, which directly or indirectly provides a user computer with at least one digital publication content through a wired/wireless network, so as to provide a keyword advertisement service based on meta information, the method comprising:
obtaining at least one commercial tag set corresponding to the digital publication content, the commercial tag set being generated by the digital publication service system using the commercial tag generation system;
corresponding the obtained commercial tag set to a digital publication content identifier corresponding to the digital publication content and storing the commercial tag set and digital publication content identifier; and
exposing the digital publication content and at least one keyword advertisement content called through a keyword advertisement content providing system in a direct manner or via a third system on the user computer by using the commercial tag set,
the commercial tag set is generated by a commercial tag set generation system and consists of at least one commercial tag belonging to a category of a tag, and the commercial tag guarantees an existence of at least one keyword advertisement content corresponding to the commercial tag in at least one time point between a generation time point of the commercial tag or a calling time point of the keyword advertisement through a keyword advertisement content providing system by using the commercial tag,
the tag includes at least one text string of a product name, a service name, a proper noun, and a keyword registered in the keyword advertisement content providing system by an advertiser,
the commercial tag set generation system provides at least one between existence information of a keyword advertisement content corresponding to at least one tag and commerciality information of at least one tag,
when the keyword advertisement content providing system receives a text string, the keyword advertisement content providing system inquires of a keyword advertisement content DB about an existence of the keyword advertisement content corresponding to the text string and obtains at least one keyword advertisement content, and the keyword advertisement content DB stores a keyword advertisement content of the advertiser corresponding to a keyword registered by the advertiser

86. The method as claimed in claim 85, wherein the digital publication service system provides at least one of a news publication service for publishing an on-line news, an article publication service for publishing an on-line article, an electronic book publication service for publishing an on-line digital type book or magazine, and a document publication service for publishing an on-line digital type document file, and the digital publication content consists of at least one of digital type texts, images, moving pictures, and sounds.

87. The method as claimed in claim 86, wherein when the digital publication service system provides the electronic book publication service, the electronic book publication consists of at least two partial electronic book publications and the commercial tag set is generated and stored in accordance with the partial electronic book publication constituting the electronic book publication, and at least two partial electronic book publications belong to any one of a type including a commercial tag set corresponding to the partial electronic book publication and a type not including a commercial tag set corresponding to the partial electronic book publication.

88. The method as claimed in claim 86, wherein when the digital publication service system provides the news publication service, the news publication consists of at least two unit news publications and the commercial tag set is generated and stored in accordance with a unit news publication constituting the news publication, and at least two unit news publications belong to any one of a type including a commercial tag set corresponding to the unit news publication and a type not including a commercial tag set corresponding to the unit news publication, and
when the digital publication service system provides the article publication service, the article publication consists of at least two unit article publications and the commercial tag set is generated and stored in accordance with a unit article publication constituting the article publication, and at least two unit article publications belong to any one of a type including a commercial tag set corresponding to the unit article publication and a type not including a commercial tag set corresponding to the unit article publication, and
when the digital publication service system provides the document publication service, the document publication consists of at least two document pages and the commercial tag set is generated and stored in accordance with a document page constituting the document publication, and at least two document pages belong to any one of a type including a commercial tag set corresponding to the document page and a type not including a commercial tag set corresponding to the document page.

89. The method as claimed in claim 85, wherein the tag subjected to the provision of at least one of information of the existence of the keyword advertisement content and the commerciality information of the tag is generated by at least one of:
1) a first method of directly inputting the commercial tag by a person operating or managing the digital publication service system or generating the digital publication content;
2) a second method of analyzing text information included in the digital publication content and extracting at least one commercial tag for the digital publication content by the commercial tag generation system; and
3) a third method of analyzing the digital publication content and extracting at least one commercial tag for the digital publication content by the commercial tag generation system, and receiving a selection of the tag from a person operating or managing the digital publication service system or generating the digital publication content.

90. The method as claimed in claim 85, wherein the commerciality information of the tag includes at least one of, with respect to the tag, 1) a total number of exposures/a total number of calls, 2) an increase/decrease rate of the total number of exposures/calls, 3) a total number of advertisers, 4) an average advertisement unit price, 5) a highest advertisement unit price, 6) a lowest advertisement unit price, 7) an average number of advertisers, 8) an average number of keyword advertisement contents, 9) an increase/decrease rate of the average number of advertisers, and 10) an increase/decrease rate of the average advertisement unit price, and with respect to the keyword advertisement contents corresponding to the tag, 11) a number of exposures, 12) a click generation rate of a keyword advertisement content with respect to exposure, 13) a total number of clicks, 14) a generated advertisement profit, 15) an increase/decrease rate of the number of exposures, 16) an increase/decrease rate of a click generation rate with respect to exposures, 17) an increase/decrease rate of a total number of clicks, 18) an increase/decrease rate of a generated advertisement profit, and at least one preset function value using at least one of the 1) to 18).

91. The method as claimed in claim 85, wherein the digital publication content is a content including at least one of a sound and a moving picture requiring a time point for a reproduction of a content, and the commercial tag corresponding to a content requiring a time point for a reproduction is a time dependent commercial tag additionally including at least one time information.

92. The method as claimed in claim 85, wherein the exposing the digital publication content and the keyword advertisement content on the user computer comprises at least one of:
1) a first method of, by the digital publication service system, transmitting the commercial tag set to the keyword advertisement content providing system in a direct manner or via the third system, receiving at least one keyword advertisement content from the keyword advertisement content providing system in a direct manner or via the third system, and transmitting the digital publication content and the received keyword advertisement content to the user computer;
2) a second method of by the digital publication service system, transmitting a program having a function of obtaining the commercial tag set and a keyword advertisement content by using the commercial tag set from the keyword advertisement content providing system to the user computer, and by the program, transmitting the received commercial tag set to the keyword advertisement content providing system in a direct manner or via the third system, receiving at least one keyword advertisement content from the keyword advertisement content providing system in a direct manner or via the third system, and exposing the received keyword advertisement content on the user computer;
3) a third method of, by the digital publication service system, transmitting a program having a function of obtaining a keyword advertisement content by using the commercial tag set from the keyword advertisement content providing system and a function of a commercial tag set corresponding to the digital publication content to the user computer, and by the program, obtaining the commercial tag set corresponding to the digital publication content, transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer; and
4) a fourth method of, by the digital publication service system, including a program having a function of obtaining a keyword advertisement content by using the commercial tag set from the keyword advertisement content providing system and a function of obtaining a commercial tag set corresponding to the digital publication content in the digital publication content and transmitting the program to the user computer, and by the program, obtaining the commercial tag set corresponding to the broadcasting content, transmitting the obtained commercial tag set to the keyword advertisement content providing system in a direct manner or via the third system, receiving at least one keyword advertisement content from the keyword advertisement content providing system in a direct manner or via the third system, and exposing the received keyword advertisement content on the user computer.

93. A system for providing a keyword advertisement service based on meta information, comprising:
a multimedia content ID DB unit including multimedia content identifier information capable of identifying the multimedia content;
a commercial tag DB unit including commercial tag set identifier information capable of identifying the commercial tag set; and
a content syndication control unit comprising at least one of a commercial tag set obtainment module for obtaining the commercial tag set corresponding to the multimedia content, a commercial tag set binding module for corresponding the obtained commercial tag set to the multimedia content, a commercial tag set providing module for providing a requestor of the commercial tag set with information on the commercial tag set, and a commercial tag set call module for calling a commercial tag set by using the multimedia content identifier information,
in which at least one commercial tag constituting the commercial tag set is a text type tag transmitted to a keyword advertisement content providing system and used for obtainment of at least one keyword advertisement content from the keyword advertisement content providing system, and
when the keyword advertisement content providing system receives the commercial tag, the keyword advertisement content providing system inquires of a keyword advertisement content DB about the commercial tag and obtains at least one keyword advertisement content, and the keyword advertisement content DB stores at least one keyword advertisement content corresponding to a text-type commercial tag of at least one advertiser.

94. A method for providing a keyword advertisement service based on meta information by a content syndication system, which participates in transferring at least one multimedia content to a user computer in a direct manner or via a third system through a wired/wireless network on a network, the method comprising:
(A) obtaining multimedia content identifier information capable of identifying the multimedia content;
(B) obtaining at least one of the commercial tag set corresponding to the multimedia content and commercial tag set identifier information capable of identifying the commercial tag set;
(C) corresponding the multimedia content identifier information to at least one of the commercial tag set and the commercial tag set identifier information and storing;
(D) obtaining multimedia content identifier information capable of identifying the multimedia content from at least one of the user computer and a third computer; and
(E) obtaining at least one of the commercial tag set and the commercial tag set identifier information corresponding to the multimedia content identifier information stored in the (C) by using the multimedia content identifier information obtained from at least one of the user computer and the third computer in the (D),
in which at least one commercial tag constituting the commercial tag set is a text type tag transmitted to a keyword advertisement content providing system and used for obtainment of at least one keyword advertisement content from the keyword advertisement content providing system, and
when the keyword advertisement content providing system receives the commercial tag, the keyword advertisement content providing system inquires of a keyword advertisement content DB about the commercial tag and obtains at least one keyword advertisement content, and the keyword advertisement content DB stores at least one keyword advertisement content corresponding to the text type commercial tag of at least one advertiser.
